(19) United States
(12) Patent Application Publication
(10) Pub. No.: US 2016/0045841 A1
(43) Pub. Date: Feb. 18, 2016

(54) NEW AND IMPROVED SYSTEM FOR PROCESSING VARIOUS CHEMICALS AND MATERIALS

(71) Applicants: Allen KAPLAN, Miami Beach, FL (US); Randall BRADLEY, Ft. Lauderdale, FL (US); TRANSTAR GROUP, LTD., Wanchai, Hong Kong (CN)

(72) Inventors: Allen KAPLAN, Miami Beach, FL (US); Randall BRADLEY, Ft. Lauderdale, FL (US)

(73) Assignee: Transtar Group, Ltd., Wanchai, Hong Kong (CN)

(21) Appl. No.: 14/776,732

(22) PCT Filed: May 15, 2014
(86) PCT No.: PCT/US14/38290

§ 371 Date: Sep. 14, 2015

Related U.S. Application Data
(60) Provisional application No. 61/801,491, filed on Mar. 15, 2013.

(51) Int. Cl. B01D 3/06; C10G 57/00; C10G 45/00; C10G 33/00; C10G 7/06; C10G 11/18; C10L 9/10; C10J 3/72; C10G 1/00; C01B 17/027; C01B 17/74; B01J 6/00; B01J 2/00; B01J 19/24; B01D 53/48; B01D 53/62; C22B 9/00; F27B 17/00; C02F 1/00; C22B 7/00; B29B 17/00; B22F 3/10; B22F 9/00; C22B 21/00; C22B 15/00; C22B 13/00; H01M 8/00; H01M 10/54; H02K 55/02; H02K 7/09; B02C 23/00; B03C 1/00; C10G 7/00

(52) U.S. Cl. CPC B01D 3/06; C10G 7/00; C10G 57/00; C10G 7/003; C10G 45/00; C10G 33/00; C10G 7/06; C10G 11/18; C10L 9/10; C10J 3/72; C10G 1/00; C01B 17/027; C01B 17/74; B01J 6/008; B01J 2/00; B01J 19/24; B01D 53/48; B01D 53/62; C22B 9/00; F27B 17/00; C02F 1/00; C22B 7/00; B29B 17/00; B22F 3/10; B22F 9/00; C22B 21/00; C22B 15/00; C22B 13/00; H01M 8/00; H01M 10/54; H02K 55/02; H02K 7/09; B02C 23/00; B03C 1/00; C10L 2290/544; C10J 2300/093; C10J 2300/0946; B22F 2009/001

(57) ABSTRACT

Eco-friendly systems, methods and processes/processing (EFSMP) or an integrated Matrix encompasses stand-alone and/or interconnected modules for completely self-sustained, closed-loop, emission-free processing of multiple source feedstock that can include pretreatment, with poisoning materials isolated during pretreatment being further recycled to provide useful materials such as, for example, separated metals, carbon and fullerenes for production of nano materials, sulfur, water, sulfuric acid, gas, heat and carbon dioxide for energy production, and production of refined petroleum, at a highly-reduced cost over the best state-of-the-art refining methods/systems that meets new emissions standards as well as optimizes production output with new ultra-speed cycle times. By-products from the petroleum refining process which were previously discarded also now are recycled as renewable sources of energy (water, waste oil and rubber/coal derived pyrolyic (pyrolysis) oil, carbon gases and process gases), or recyclable resources, such as metals and precious metals, oxides, minerals, etc., can be obtained.

### FIELD OF THE INVENTION

The present invention relates to a matrix strategy of an all-encompassing or selective integrating of the petrochemical, metals, pharmaceutical, energy and power industry's processes and technologies for optimum energy and operational efficiency, new profitable product diversification and compliant cycled closed looped emissions free processing. The novel matrix strategy comprises the integration of cost effective, renewable hydrocarbon feedstocks such as coal, spent oil, terminated/expired/spent tires and batteries, heavy and/or light varieties of crude oil, spent and secondary metals refining, and internally generated liquid, supercritical phase fluids and drying process, solid and gaseous wastes streams. The novel matrix strategy can be located at major consuming market locations being typically interconnected through a direct system of land, sea and air access media both nationally and internationally. Direct transcontinental pipeline access is an added advantage. The matrix strategy is capable of being adapted for operation at remote subterranean, oceanic and terrestrial locations. The invention strategy can utilize domestic and foreign sourcing of feedstock and can provide a broad spectrum of production diversification. As a bonus, present government funding, land provisions, tax and other incentives can reduce startup costs, for such operations have been deemed independently or matrix collectively clean energy, renewable energy, green energy classified and carbon trading credit and carbon transfer worthy.

Cutting edge technology including, inter alia: 1) rapid cycle time, 2) no fugitive emissions; 3) a closed loop system; 4) water manufacture self-sufficiency; 5) utilization of novel super reactor technology; 6) cross industry technology applications; and 7) a safer technology; 8) negative carbon emission footprint; and 9) carbon credit exchange and trading; 10) a vertically integrated feedstock; 11) power self-sufficiency; and 12) coal material extraction including coal fines, charcoal, coal ash, actinides and coal combustion gases/fumes.

### SUMMARY OF THE INVENTION

The present integrated matrix encompasses interconnected modules including a starting feedstock module where feedstock from various sources is received and stored and/or directly routed to modules of the matrix system for processing. The matrix system can be comprised of pretreatment process modules from which an upstream feed can be pre-purified and then sent to the petroleum refining module with poisoning materials separated from the feedstock during pretreatment then being further recycled to provide useful materials such as, for example, separated metals, carbon and fullerenes for production of nano materials, sulfur, water, sulfuric acid, gas, heat and carbon dioxide for energy production. As a consequence of the matrix system, method and apparatus, by-products from the petroleum refining process which were previously discarded now can be recycled as a renewable source of energy (water, waste oil and rubber/coal derived pyrolyic (pyrolysis) oil, carbon gases and process gases) or recyclable resources such as metals and precious metals, oxides, minerals and others to the various modules of the present integrated matrix to provide useful end products. The matrix allows for the production of refined petroleum at a cost considerably below that of even the best current state-of-the-art presently used in petroleum refineries. The matrix system and method can minimize capital outlay in either retrofit or new build expenditures and can meet the new eminent emissions standards, optimize production output with new ultra-speed cycle times, and effectively vertically integrate feedstocks, expand on and or add profitable new product lines as well as significantly reduce existing technology upgrading and retrofit expenditures, operating costs, maintenance and repair downtime and process cycle time.

The general concept of the present system, method and apparatus is shown in block diagram form in FIG. 1. A feed matrix module is the module in which feed is received, stored and introduced into the processing matrix modules and the refinery matrix module. The feed can include: 1) oil pipeline feed; 1a) Crude Oil, 1b) Peat in various liquid forms, 1c) Shale Oil, 1d) Oil Sands, 1d) Tar Sands, 1e) waste industrial and utility company transformer oil 2) waste (spent) automotive oil; 3) terminated spent tires; 4) spent batteries in various forms and construction; 5) coal and; 6) carbon black. Waste (spent) oil is processed to remove impurities, including, inter alia, minerals, chemical additives, solvents, metals, carbon, grit, chlorine, sulfur, volatile organics, moisture, acids, ash, oxidants, PCBs, actinides, unspent fuel and other like contaminants. The pretreated material is sent to the refinery to be reprocessed in the refinery to petroleum, and to other modules such as, for example, advanced Nano, to provide composites, carbon fiber or ceramic materials, and other modules to provide fuels, lubricants or electrical and thermal energy products.

By-products from the refining process can be recycled through matrix modules to provide further products. Products from the present matrix system and process include, inter alia, 1) motor oil; 2) gasoline; 3) diesel and JP-4; 3b) JP fuels, 4) kerosene; 5) greases and lubricants; 6) LPG, propane, hydrogen, naphtha, nitrogen; 7) butane; 8) feedstock; 9) metals including precious metals; 10) metal oxides; 11) sulfuric acid and sulfur; 12) waxes; 13) ceramics; 14) activated carbon; fluff (from tires and used as component for growing nano tubes) 15) carbon black; 16) asphalt; 17) ammonia; 18) methane; 19) water; and 20) electric power; 21) carbon credits; 22) nano tubes; 23) advanced ceramics and; 24) advanced nano composites; 25) catalysts, additives, solvents, chemicals for recycle; 26) actinides, etc.

The matrix modules of the present system, method and apparatus perform processing, separation and recovery, reforming, recycling and manufacturing as well as producing products, energy and feedstock. The resulting benefits of the present process, apparatus and system include, for example, production of electrical energy, thermal energy, Nano tubes, sulfur extraction, nitrogen extraction, oxygen extraction, and extraction and collection of valuable minerals, pyrometalurgical and hydrometallurgical products, and sulfuric acid as well as water. Each of the numerous matrix modules which can be included in the present invention matrix, system and process will first be described individually and they will be further described as the integrated matrix modules.

The integrated matrix of the present invention can be comprised of various modules including, but not limited to, the following: receiving, storage and routing (tank farm) (FIG. 1); tire plant (FIGS. 2A and 2B); pre-pyrolysis (FIG. 26), purification, reduction, mix & treatment; pyrolysis (FIGS. 4A and 4B); battery plant (FIG. 5); sulfuric acid plant (FIG. 11); Nano plant (FIGS. 3A, 3B, 3C, and 3D), oil metal extraction (FIG. 75); refining (FIGS. 6A, 6B and 6C); asphalt plant (FIG. 7); steel foundry (FIGS. 17, 17A, 17B, 17C, and 17D); lead oxide (FIG. 18); lead smelter; aluminum smelter (FIGS. 19A, 19B, and 19C); precious metals smelter (FIG. 23) and catalyst recovery (Platinum, Gold, Silver and others); zinc smelter (copper smelter (FIGS. 20A and 20B)); sintering (FIGS. 21A and 21B); waste water treatment (FIGS. 14A, 14B, 14C, and 14D); water production plant; sour water stripper (FIG. 8C); power generation (FIGS. 9A and 9B); gas plants including hydrogen plant (FIG. 15); oxygen plant (FIG. 16); and nitrogen plant. Methane can also be produced from coal liquefaction and gasification, but there is no need for a separate module for methane production as it is converted to syngas in the matrix.

The invention process, system and apparatus gathers, integrates, recycles, renews, consumes and manufactures a diverse range of profitable fuels, including, for example, lube oils, electric energy, natural gas, hydrogen, metals and precious metals, oxides, zinc, asphalt, waxes, sulfur, ammonia, sulfuric acid and steam generation.

Technologies integrated into the invention process, system and apparatus include fuel cells, pyrolysis, distillation, refining, precipitation, thermal reaction and conversion.

External recyclables including, for example, waste oil, used tire generated black oil, spent batteries; external renewable lube oils including, for example, industrial, automotive, military, commercial oils; as well as crude oils (light, heavy and shale oil) are received and stored in the receiving and storage are of cell for routing to processing cells of the present invention.

Internal refinery spent feed-stocks, waste emissions and residues (slag, oxides, sulfuric acid, syngas, methane, condensate, waste, and sour and wastewater) are renewed for internal use and as new profitable products.

Should lithium battery technology replace lead acid batteries in the automotive industry, this present invention provides for a rapid recycling process change-over with little or no further investment. cell

The present invention comprises an integrated matrix (FIG. 27) encompassing processing steps and procedures as well as separation and recovery steps. The present integrated matrix encompasses recycling and manufacturing steps as well as the manufacturing and production of products. The present integrated matrix further encompasses one or more of, inter alia, 1.) receiving and routing of input materials into the process, system and apparatus such as in cell 1 (FIG. 1B); 2.) Cell 2 (FIG. 2B), Cell 4 (FIG. 4D) and FIG. 26 (pyrolysis) are one embodiment of tire plant modules for the processing of tires; 3.) Cell 26 provides for the pyrolysis of materials of the present system and apparatus; 4.) Cells 5 (FIG. 5) and 12 (FIG. 5) are battery plants for the processing of, e.g., lead batteries or lithium batteries; 5.) Cells 10 and 11 provide for sulfuric acid processing and manufacturing; 6.) Cell 25 is an oil metal extraction module; 7.) Cell 7 is an asphalt plant; 8.) Cell 17 is a steel foundry; 9.) Cells 12 (FIG. 12) and 18 (FIG. 18) provide for lead oxide production; 10.) Cells 12, 13, 18, 19 (FIGS. 19A, 19B and 19C) and 20 (FIGS. 20A and 20B) are cells for one or more of lead, aluminum, zinc, or copper smelting; 11.) Cells 23 (FIGS. 23A and 23B) and 25 (FIG. 25) provide for precious metal recovery; 12.) Cell 14 (FIG. 14D) provides for waste water treatment; 13.) Cell 16 (FIG. 16) provides for water production; 14.) Cells 9 (FIGS. 9A and 9B) and 14 provide for sour water stripping; 15.) Cell 9 provides for power generation; 16.) Cells 15, 3a, 3b and 24 are one or more of a hydrogen plant, a nano plant, or a nano processing module; and 17.) Cell 1 is a tank farm for storage of materials which are routed to the processing cells of the present invention. It should be understood that the present invention does not require the use of all cells, but rather the cells used can be chosen for the processes and products which are desired. The cell architecture can be chosen and arranged by the skilled of this art area.

Cell 1 and cell 5 provide inbound feedstock to the present integrated matrix including, inter alia and without limitation, waste oil, crude oil, lead acid and/or lithium batteries, Cell 2 provides spent tires, and coal is provided to the matrix from cell 5. Materials which may be produced from the batteries include, for example lead, acid, polypropylene, rubber, and lithium. Materials which may be produced from the tires include, for example, rubber, (processed in cell 17), polyester and rayon.

The embodiments in the present invention teach and incorporate directly, and by reference, but are not limited to either, ways to further advance a Renewable Clean Energy technology capable of attaining and sustaining imported oil independence at below market pricing while generating significant profit opportunities through the licensing control and/or direct use of such technology, and resulting in a negative Carbon Emission Footprint. Further, factories and other consumers of fuel can incorporate the modules, systems and technologies taught in the present invention to more efficiently utilize energy and become more compliant with Carbon Emission Reduction standards, polices and the like. It is the quintessential Ecologically—(i.e., Eco-)/Environmentally-Friendly (“EF”) invention.

As conventionally accessible supplies of light sweet crude have become more scarce and more difficult to extract, the Petroleum Industry has evolved to use a series of alternative access methods such as deep-well drilling, oil sand and shale oil extraction, and the processing of non-conventional extra heavy and sour oils.

Nationalized oil and gas reserves account for 65% of the total, and are operated by state-owned companies in Saudi Arabia, Venezuela, Bolivia, Iran, Iraq, Kuwait, Mexico, Russia, and soon Brazil—leaving only 7% of reserves that are available to private international companies to exercise dominion over. The remaining 28% of reserves are either in areas that are off-limits to development, under development, or mismanaged in such a fashion economically and politically as to make them de facto unavailable. The political situation in many petroleum-source countries is volatile, and this uncertainty contributes more than significantly to the price point—second only to demand, as an influence on price and market modulator.

The emerging economies of India and China have a voracious need for imported oil that will increase by 5.2% annually for the next five years—a massive 26% increase in consumption, with Middle Eastern refineries supplying 65% of their oil. These exports to India and China represent nearly 70% of total exports by these Middle Eastern refiners who have been able to position themselves to command and sustain higher prices to Asia as a result of their huge production capability one that easily can accommodate, or exceed, demand in Asian industries/population centers. They also have capital to invest in new refineries, to produce where the demand is located, shortening cycle time and substantially reducing their transportation costs. The entire petrochemical industry is entering a dramatically changed new era, tidally pushed and dictated to by global greenhouse gas reduction mandates, and oil spill disasters like the Exxon Valdez, as well as the Transocean Deepwater Horizon Mocondo Gulf Oil Well managed by BP. These are placing unprecedented demands upon the market for new and cutting-edge technological solutions to the problems created by unstable, and limited, sources of supply.

These new and developing technologies must maintain regulatory compliance (and comply with Sharia law in the Middle East), sustained corporate profitability, and ensure national security needs—all must be addressed, whilst companies are leveraging hydrocarbon resources with corporate assets due to tight credit.

There are other factors compounding energy problems: the global recession; permanently-changed consumer patterns, travel choices and values; a trend toward downsizing and sustainability; and the need to develop alternatives to oil by continuing to maintain the economic viability of those alternative technologies. Additionally, water shortages are already emerging as a global crisis, with most of the usable water now either brackish or saline, leaving energy providers, industry, agriculture, and human consumption requirements all competing for the dwindling supply. Impending food shortages have been reliably predicted from all corners of the globe and the economic universe. For this reason, ethanol and bio-fuels are being reevaluated because of significant water consumption required in growing the crops, and then the hydrocarbons necessary to process them into fuels, further complicated due to the diversion of crops from food, creating a corresponding human toll: increased food shortages and starvation.

The eco-friendly systems, methods and processes (“EFSMP”) of this invention covers, but is not limited to, the North American Industry Classification System (NAICS). It classifies the Petroleum and Coal Products Industry (NAICS 324 & 325) as including petroleum refineries that produce fuels and petrochemicals and manufacture lubricants, waxes, asphalt, and other petroleum, shale, bitumen, oil sands, tar sands, extra heavy oil, oil, shale oil, crude oil, petroleum, and coal products. NAICS 324110 petroleum refineries are defined as establishments primarily engaged in refining crude petroleum into refined petroleum.

This novel invention refers to liquid energy resources, since they represent the basic petroleum building blocks. In describing and understanding this invention, it is important to go beyond conventional oil and include non-conventional liquids such as condensates, natural gas liquids, tar sands, bitumen, extra heavy oil, oil shale, gas-to-liquids, and fossil fuels, also known as petroleum, coal, petrochemical, petrocarbon, carbon, hydrocarbon, coal residue, Natural Gas, Petroleum Gas, Bitumen, Shale, Shale Oil, Oil Sands, Peat and the like.

The EFSMP disclosed in the present invention includes not only permutations of variable Reactor sizes of lengths and widths, and traditional sources of used lubricant, as will be further described in this invention, but examples of feedstock can also include Crude Oil and other forms of streams of non-processed, processed, lubricants and Crude Oil, gases, diesel, and gasoline, from sources that may be non-descript. For example, PEMEX (the Mexican Petroleum Company) has had its Pipeline tapped into, and Crude Oil has crossed the border of Mexico without consent of the Mexican Government. Likewise, Venezuela has a vibrant gasoline and oil Black Market in which the products leave Venezuelan borders without the knowledge and approval of the Venezuelan government. Such methods include both land and sea. It is envisioned that collection on the open market of such products is not only possible, but a probable source of product.

Further, as different industries use different terms, though are specifically industry specific, but are yet terms that represent an equivalent product in other industries, there are times when such terms are referred to generically, yet are inclusive, and representative of a technologies, terms, systems, methods, products, procedures, and the like, in other industries that are integrated into the embodiment in the present invention. Examples of which are terms like ash. Ash is used in Mineralogy and Ore Mining. Char is an equivalent of Ash, and is used in Coal Processing. Slag is usually a term used in processes of the manufacture of metals from ore, as in Iron Ore, produces a slag. In the case of Coal gasification, the Ash is also referred to Slag.

Sintering is generally referred to as the separation of metals and other particulates, based upon temperature, within the coal industry, however it can also refer to an application of particulates to substrates, and whereas by further example a Sinter mix is a mixture of fines of iron ore, limestone, coke, dolomite and flue dust. An embodiment in the present application of a matrix of vertically integrated technologies, from a multiple discipline of industries, technologies are also interchangeable, and have different names, and provide similar or the same Ecologically- or Environmentally- (or Eco-) Friendly Systems, Methods, and Processes (EFSMP). Where the present application refers to Furnace, in one industry the SMP may be referred to as a Blast Furnace, yet in another it is a variation of an Autoclave. Sintering is also a SMP that is in one industry, oil for example, yet is used in coal processing as a term for liquefaction (whether direct or indirect). Reverberatory furnaces, kilns, and fluidized bed Reactors, distillation columns, even though are different equipment names for technologies that are used in completely different industries, they can be interchanged, in either industry as they perform the same function, yet use different names. One skilled in the art, regardless of the discipline, can understand that Reactors, as generally referred to in this EFSMP, include but are not limited to, Autoclaves, Carbon Fiber Systems and the like, and are also defined by function and name, for example as Harper's Hearths (www.harperintl.com), Blast Furnaces, Kilns, Smelting Furnaces, Carbon Fiber Furnaces, Pusher Tunnel Kilns for the electronics and advanced ceramics industries, complete turnkey Carbon Fiber Lines, specialized furnace systems for solar cell production and silicon melt furnaces, rotary kilns for the processing of refractory metals, and the calcining of specialty materials, Continuous Kilns, Roller Hearth Kilns, Mesh Belt Kilns, Car Tunnel Kilns, Walking Beam Kilns, Carpet Hearth Kilns, Harper Hearth Kilns and vertical gravity flow reactors, as well as a scope of supply for complete carbon fiber plants including: oxidation ovens, LT furnace systems, HT furnace systems, UHT furnace systems if required, surface treatment, drying incinerators with optional tensioning stands and winders, and are incorporated herein by reference, are also different types, permeations, combinations, hybrids, parallel units and like, that perform in a likewise manner. Additionally, the Reactors, as well as the EFSMP, can be vertical, horizontal, or diagonal, and in any permeation, combination, hybrid, parallel and the like, in position.

It is a further desire of the present invention to function, but without limitation, with such technologies as can also be employed in Reactors of variable lengths and widths, and capable of temperatures to 3500° C., excellent air flow uniformity, easy internal access to facilitate maintenance, coal, electric or gas fired, optimal temperature uniformity, operator isolation from effluent, highest energy efficiency, fastest line speeds, thermal recovery systems, surface treatment systems, multiple sizing agents, multiple electrolyte solutions, clean and hygienic, non-contact drying, flexible system designs, unique gases (i.e., Argon, Nitrogen, etc.), large capacities (multiple muffle systems), atmosphere control, reduced energy costs, excellent temperature uniformity, with features not limited to but that can include multiple temperature control zones, proven alternating cross flow design, adjustable louvers and diffuser plates for precise temperature adjustment, rigid roll stands, integrated brush roll assemblies, excellent float end seals for positive sealing, minimized infiltration of ambient atmosphere and improved temperature uniformity, aluminized steel construction, plug fans to facilitate maintenance, carburization resistant muffle, low profile muffle for gas flow control, process gas distribution and sampling system, proven purge chamber gas curtain technology, and the like. Such embodiments are encompassed in the modules of, e.g., Cells 12, 17, 18 and 23.

Additionally, the EFSMP disclosed in the present application utilizes, as necessary, multiple temperature and atmosphere control zones enabling specific temperature vs. atmosphere requirements. Multiple temperature control zones as well as control of temperatures above and below the load provide optimal temperature uniformity. Modular construction facilitates modification of the Reactor tunnel to accommodate adjustments in process or production rate as well as functions of delicate pressure control within the Reactor, and provides control of the atmosphere flow path in the Reactor, facilitating evacuation of volatiles and optimizing atmosphere uniformity. Reactor gas curtain technologies provide zone-to-zone atmosphere definition under specific conditions. Reactor stripping chamber design provides optimal isolation of internal tunnel Reactor chamber environment from ambient, as well as efficient purging of ambient atmosphere entrained within the load entering the Reactor without the use of mechanical doors and seals.

The EFSMP of the present invention in the embodiment as in Cells 6 and 14-16, for example, also include such technologies, reactors, permeations, combinations, hybrids, sections, parallel units and the like for but not limited to rotary reactor sealing systems, providing optimal rotary tube furnace atmosphere integrity with minimal gas consumption. Natural gas refinement and liquid petroleum gas refinement and the like, to convert this into a useable product, requires the initial separation of the mixture into gaseous and liquid components, such as Carbon, Sulfur, Oxygen, Hydrogen, Water, Carbon Dioxide, Nitrogen, Methane, Ethane, Propane, Butane, Pentane, Hexane, triethylene glycol, Potassium, Hydrocarbons and the like, and then the purifying and separation of the gaseous components. Such examples are presently being produced by, but are not limited to, those of Royal Dutch Shell in Qatar, dubbed Pearl, as well as those of Shell Todd Oil Services (STOS) in Australia, and they are referenced and incorporated herein by reference.

It is proposed that, anywhere in the EFSMP of the present invention that CO2 is vented off, it is reused, regenerated, recycled, captured and the like, in that it can also be processed into Advanced Carbon Fiber material, gases, Carbon Credits, Carbon Dioxide Gases, in any form whatsoever, for sale into the market, or for in-house use, either on an inter-campus location basis, or an intra-campus location basis.

Additionally, the EFSMP of the present application includes such technologies as those use by Sasol Ltd., a partly state-owned company that built several coal-to-liquids plants, including the ones at Secunda, and became the world's leading purveyor of coal-to-liquids technology. However, as those facilities are limited in scope to solely the processing of coal, that is a limitation not proposed in this invention.

The EFSMP disclosed in this application, for example in cells 6 and 26, embodies technologies that are structurally different from a typical refinery in that they are self-contained, enclosed, self-sufficient, and emission-free (beating global emissions standards), and are not limited to structures and applications that cover, include, and contain: modular components; aggregate and non-aggregate; swappable configurations; distillation; hydrogenation; isomerization; reactors and reactor chambers; bleed streams; coal conversion technologies; Syn-Gas production (from oil, coal, tires, rubber, coal gasification, methane reforming and the like); fugitive emissions; reforming (can be defined, for example as steam reforming); CO2 re-forming, partial oxidation re-forming, and the like; natural gas co-conversion; and coal and methane co-conversion.

The EFSMP of this invention such as in cell 5 utilizes a series of piping architectures, heaters, scrubber, turbines, furnaces and coolers. Modifications and upgrades, anticipated as the state of the art advances, are also incorporated by reference, including, but not limited to, the eventual enclosure of the EFSMP into a single Reactor, or Parallel Reactors, as the economy of the EFSMP and the scale of such requirements are desired. The management of the EFSMP is done either on-site, at-location, or remotely, as needed or required by the operator.

Communication between such operations is typical of a refinery, but does not have the total capacity of all of the EFSMP embodiments outlined in this application. Additionally, the EFSMP Reactor System of the present invention is similar to, but not limited in scope, breadth or any other capacity, to those of Harper International, in such that Harper International limits their technologies to individual Reactors of such types as Carbon Fiber Furnaces, Pusher Tunnel Kilns for the electronics and advanced ceramics industries, complete turnkey Carbon Fiber Lines, specialized furnace systems for solar cell production and silicon melt furnaces, rotary kilns for the processing of refractory metals and the calcining of specialty materials, and vertical gravity flow reactors and the like, but none of which are interconnected, work in tandem, are integrated, a system or matrix of different technologies running in tandem, nor related to the petroleum, coal and refining industries and the like, and furthermore, the Harper International equipment is limited in scope, from literature that is publicly available, to that of carbon fiber, graphite fiber, solar cells, silicon production, advanced lithium ion battery materials, fuel cells, nuclear fuel processing, bio fuel generation, silicon carbide sintering, rotary kilns, pusher kilns, vertical calciners, strip belt systems, mesh belt kilns, batch kilns, fluidized bed technology, and carbon fiber production systems, nano technology including Carbon nano tubes (e.g., Cell 3, 3a and 3b), inorganic chemical processing, as well as electronic components, thermodynamics, kinetics, morphology, of which the EFSMP detailed in the present application does not have such limitations, and as a function of technologies that comprise the EFSMP Reactors disclosed in the present application, does include and are inclusive of the super reactor, contained either as an individual unit, parallel series, hybrid, combination, enclosed or openly visible, and the like, as in the case of a typical oil refinery, and the like, is taught only in the present invention.

An EFSMP, as is the working embodiment of this invention, can be any stand-alone EFSMP or any combination of the above, in any permutation desired, without limitation and in any hybrid capacity.

Additionally, examples of the types of feed stock (also defined as any petroleum-based oil also known as a hydrocarbon oil and/or a petrochemical oil), in any form have a characteristic that is common, such that the molecular structure is stable, and that either in refined state or crude, or processed, or re-refined, and the like, is that the molecules never wear out—all that happens is that additives in the oil wear out or deplete and need replacing, unless the feed stock is destroyed by means of burning, or molecular breakdown, or by some other method or process necessitated by the feed stock. This is especially true of lubricant oil, and refined oil used in the embodiment of this EFSMP are such as types of product known as, and derivative of, and or any combination of: waste oil/sludge oil; black liquor; mixed waste streams; Orimulsion™ (or other bitumen-based fuel); waste oil; residue oil; black oil; spent oil; heavy crude; extra heavy crude oil (with Nickel and Vanadium); vacuum residue from solvent (VR); bottom of the barrel processing; residual desulfurization (DS); heavy oil kerosene coal; all types of coal, including, but not limited to types ranging from lignite-b to sub-bituminous-A; synthetic crude oil; Coal, Sand Oil, Shale, Bitumen; Lignite; bituminous Coal; Sub-bituminous Coal; Anthracite; Char; Petroleum Coke; Coal Coke; Natural Gas; LPG; Liquid Petroleum Gas; Propane; Methane; and Atmospheric Residue.

The invention disclosed in the present application also contemplates and comprises—in whole, in part, or in any combination, matrix, hybrid, parallel, and permeation thereof—a series of acquisitions and mergers to establish a network of collection and or distribution sites for sourcing, as well as retail outlets. For example, Lukoil has acquired Getty Oil and, as such, has an approximate footprint for the retail sale of gasoline at nearly 5000 locations, or Points of Presence (POP's) in the northeastern USA. We would propose in this embodiment to purchase a company similar to the used tire, and waste tire, network that Liberty Lakin has, if not Liberty Lakin itself, thus establishing an immediate POP of approximately 14,000 locations, either to increase current POP's or to establish such a network. Whereas the Garbage/Waste industry was previously a group of Mom & Pop operations, it was H. Wayne Huizenga, through Waste Management, Block Blockbuster Video, and AutoNation, that set up collection and processing. It is proposed, in the present invention, a similar means of collection, consolidation, and distribution of their respective industries; and the Liberty Lakin example, providing an immediate 14,000 POP's is an example of an efficient way to establish a foothold into the market for Upstream, Downstream, and collection and distribution of products.

Without limitation in the above examples of feed stock and processes, the invention embodiment also utilizes the same EFSMPs, as well as those mentioned throughout the embodiments of this application. Furthermore, without limitation, this EFSMP can process, any petroleum oil, hydrocarbon, petroleum product, crude oil, including light oil, light sweet crude oil, light crude oil, sintered oil, pyrolysis/pyrolyic (or pyrolytic) oil, coal oil, desulfured crude oil, light sulfur oil, shale oil, heavy oil, sour oil, Orimulsion oil, salt oil, presalt oil, sand oil, coal, fugitive emissions, mixed gasses, and the like, either as a primary feed stock, or as a combination and/or mixture of any of the above types of feed stocks, including such additional examples as North Dezful, Naftshahr, Maleh Kooh (Kerman,) Kashagan, et al., through the Reactor System, in either parallel, combination, singular component, multicomponent, matrix, or other vertically integrated technologies such as, for example, but not limited to: Fluid Catalytic Crackers (FCC), (including FCC Maximum Olefin Mode, LPG, Propolyne (or Propylene), and Butylene, FCC Maximum Gasoline Mode, FCC Maximum Distillate Mode); as well as such feeds as, but not limited to: Vacuum Gas Oil Feed (VGO), VGO, Hydrotreated VGO, and VGO mixed w/VR.

Using such processes, as economically desired, but not limited to, and in any matrix, combination, and hybrid of: Treatment Processes such as for example: Amine, Solvent, Solvent De-waxing, Hydro Desulfurization, Sweetening, Solvent De-Asphalting, Crude Distillation, Naphtha Hydrodesulphurizer (hydrodesulfurizer), Kerosene Merox Unit, Gas Oil Hydrodesulphurizer Excess, Naphtha Stabilizer, Gas Sweetening, Jarn Yaphour Crude Oil Stabilization, Unibon Unit, Condensate Splitters, and 16. Kerosene Sweetening, and Biogasification.

Heavy and Extra Heavy Crude Oils, Coal, Coal streams, Mixed Waste Streams, and the like, can pass through the EFSMP for such treatments as: Hydrogen and Steam to processing, Coking, Delayed Coking, Biological Upgrading, Naphtha Hydrotreater, Isomerization, Kerosene Hydrotreater, Gas Oil Hydrotreater, Heavy Naphtha Catalytic Cracking and Carbon Rejection Technologies (such as: Fluid Coking, Flexi Coking, Visco-Reduction, and Solvent Extraction Unit), Sulfur Recovery, Amine Hydrotreating, and LPG Treating & Recovery (such as: Thermal Cracking, Delayed Coking, and Aqua-Conversion and Metal Recovery).

Where necessary, and/or required, where economics and feasibility permit and are desired, the embodiment of this EFSMP incorporates Hydrogen Addition Technology for Catalytic Reforming Unit for Hydrogen Creation, Production of Syngas where Hydrogen is separated, Oxygenates (Okadura type and Interline), Oxygenate MTBE (Methyl Tertiary Butyl Ether), Oxygenate TAME (Tertiary Amyl Methyl Ether), and the like—regardless of the matrix.

Refinery Configurations of the reactor and the like of this EFSMP also include, either jointly or severally, applications such as: topping refinery, cracking refinery, and coking refinery. Such applications are utilized either in matrix, jointly, individually, severally, or in combination of: deasphalting (SDA Process), slag from degasification, hydroskimming—atmospheric distillation, coal gasification, plasma, gasification, slagging gasification, topping refinery, catalytic cracking, residue fluid catalytic cracking, FCC Feed Nozzles Lance's for air introductions, FCC Feed Nozzles at Supersonic Speeds, Isocracking, coking refinery—entrance point, delayed coking+++ (IGCC Integrated Gasification Combined Cycle), fluid coking, thermal cracking, Flexi-Coking (Carbon Rejection Process developed by Exxon) for gasifying to produce gas, similar to fluid coking for Flexi Gas, Thin/Wiped Film Evaporator, Pipe Furnace Vaporizer, Visco-Reduction, Aqua-Conversion, Solvent Extraction, Advanced Separation Systems for FCC's as Cyclones, LPG Merox Units, Gasoline Desulphurization, Steam Methane Reformer/Reactor Furnace (SMR), Desulphurisation (Desulfurization) Units, Mytol Process, and Oxidation/Internal Breakdown.

### Ecologically- (Eco-) and Environmentally-Friendly Systems, Methods and Processes (EFSMP)

The embodiments of the disclosed EFSMP incorporate several different Hydrogen Addition Technology practices in Cells 4 and 15. Several commercial technologies that compete with Hydrocracking with the bottom of the barrel of heavy and extra heavy crudes, like waste oils, are also included but are not limited to: LC Fining-****, HDH Plus, H Oil (Hydrogen Oil), Can Met, Shell Hy Con Technology, Selex-Asp Process, SDA (Solvent Deasphalting A), Ebullated-Bed related to LC Finning, Lummus (LC Finning), Axens (H-Oil), Steam-Methane Reforming, Water-Gas Shift Conversion, Hydrogen Purification, Hydro Desulfurization, Induced Gas Flotation Unit, (IGFU), Naphtha Hydrotreater Unit, Pyrolysis Unit, Catalytic Pyrolysis Process Unit, Electrical Grid or Wire Mesh Reactor, Pyrolysis, Steam Cracking, Ethane Cracker, Catalytic Distillation, Catalytic Hydrotreating, and Catalytic Hydrodesulfurization as well as a Kerosene Hydrotreater Unit, for Rapid Thermal Processing. The foregoing can be incorporated in this EFSMP either in individual platforms, reactors, parallel reactors, parallel processing, a single matrix or matrices, in combination, separately, and be either presented jointly or severally.

Another application of the Chalcogel filtration system is to integrate a catalyst bed either as a separate layer(s) or as a mixed substrate filled filter with catalyst filled pockets and or pellets to function simultaneously as the processing flows pass through and or a quench and or flow mixing layer. The filter can be recycled into fuel and or cleaned and refilled. Another application is creating a tubular or multitubular for intra-pore diffusion and convection expanding the abilities for catalyst pocket, pellet or catalyst bed heat and mass transfer phenomena to occur. The multilayered Chalcogel system may also add a quench layer for added precision processing control. When utilized in-between individual processing chambers, the catalyst integration can optimize quenching and mixing between filtrated or stand-alone catalyst beds for maximum temperature control, and the option of either elimination or, depending on the application, maintaining separate interchamber temperature variances. The combined Chalcogel filtration and/or mixed filtration-catalyst bed can be applied to any or all processing chambers within the Distillation reactor or the pretreatment system.

One of the invention embodiments incorporates Visbreaking, and as such a Vacuum-Flasher is and can be included in the matrix of technologies of this EFSMP, as well as Distillate Hydroforming, and where such additional practices, either in conjunction with, as part of the matrix of vertically integrated technologies, either jointly or severally, in combination, but not necessarily in its own reactor, hybrid, or in parallel, combination, or individually, and collectively, but without limitation are Residue Upgrading Technologies including: De-asphalting, Microwave, HSC (High Conversion Soaker Cracking), Merox, Olgone (by ExxonMobil), Gas-Oil Hydrotreater, QSL, Induced Gas Flotation Unit (IGFU), Naphtha Hydrotreater Unit Scrubbers, Flame Stacks with Steam Turbines, Clay and Kinetic Technology International (KTI), Water Capture Units from condensation and conversion, Waste Oil Sewage Sludge, Black Liquor and Orimulsion™.

Disclosed in the present application is an eco-friendly (to encompass both ecologically-friendly and environmentally-friendly) system, method, and process (EFSMP) of an integrated, interconnected, hybrid, connected, parallel, closed loop (Cell 26), emission-free Oil Refinery, also known as a reactor, as previously described in the invention of this application, and as further described throughout this application, in which uses more than typical Crude Petroleum Oil Feedstocks of which the past and present industry is limited to, and which such is not a limitation for the present invention, and can also be used. This EFSMP can be aggregated or a standalone EFSMP, and use any combination of raw feed stock (crude oil variety), as well as advanced ceramics, Tungsten Carbide, soft ferrites, powdered metals, solid oxide fuel cells, steatites, phosphors and more. In addition to the other Systems, Methods, Processes, and Products that are derived, and as part of the EFSMP of the present invention, one of the embodiments is an EFSMP (e.g., Cell 25) that is integrated in different permutations. Other reactors are modified, according to user requirements, to accommodate different feedstocks, effluents, metals, water, liquids, powders, clays, oil, lubricants, acids, gasses, fumes, fugitive gasses, and the like, in different phases, in such a way that the EFSMP is self-sufficient, self-contained, and closed loop, with negative carbon emissions and a zero carbon emissions, and is not limited to upgrades and modifications by someone skilled in the art, in that: sulfuric acid is filtered, sulfuric acid is refined, sulfuric acid is purified, sulfuric acid is created, ancillary product steams are created, mixed fuels are created, and precious metals are extracted (e.g., Cells 23, 25, and 7).

Products from the EFSMP (e.g., Cell 19) are such as, by way of example but not limited to, LPG, Asphalt (Cell 7), Gasoline, Diesel, ATK, Light Naphtha, Naptha, Heavy Naphtha, Kerosene, Gas Oil, Petrochemical Feedstock, Lube Oil, Fuel Oil (Stricht & Cracked), Bitumen, Solvents, Wax, Coke, Asphalt, Gold, Aluminum, Graphite (Cell 24), Advanced Composites, Aluminum Graphite, Li-ion Graphite, Copper (Cell 20), Zinc (Cell 13), Steel (Cell 17), Precious Metals (Cells 23,25), Sulfur (Cell 11), and lead, as well as advanced ceramics, Tungsten Carbide, soft ferrites, powdered metals, solid oxide fuel cells (Cell 9), steatites, phosphors and, as technology further develops, also includes variations of picene, which becomes a superconductor when it is laced with potassium or rubidium and then chilled. Picene is an organic compound found in crude oil; it is made up of 22 carbon atoms and 14 hydrogen atoms. It looks like five benzene rings—common organic molecules—fused together in a staggered line.

Cells 2, 4 and 27, for example, relate to tires and rubber feed stocks with pyrolysis, radiation, microwaves, ultrasound etc.

Cell 2 relates to dry distillation of spent tires, in an example embodiment of the EFSMP schematic of the direct dry distillation of tires by Fujikasui Engineering is known to someone skilled in the art

Goodyear's devulcanization process is another well-known EFSMP that is encompassed as a module within the present system and method.

Hydrogenation of spent tire rubber (e.g., in Cell 4) is a chemical synthesis process of the EFSMP of the present invention, with effluent streams being petroleum based, as is described throughout this application.

Cells 4, 7 and 27 relate to asphalt from tire and rubber with pyrolysis and the like, for example synthetic asphalt recycled tire rubber emulsions and processes for making them, for example in U.S. Pat. No. 7,547,356, and all cross-related prior art and cited references.

Used lubricant oil can also be processed in this EFSMP, by way of example of U.S. Pat. No. 4,073,720, incorporated herein by reference, is a method for reclaiming waste lubricating oils and the referenced invention relates to an improved method for the refining of hydrocarbon oils. More specifically, the invention relates to an improved pretreatment method for the reclaiming of used lubricating oils by the removal of solid and liquid impurities contained in them. Such application is also incorporated in this EFSMP invention.

Other types of feed stocks used, and EFSMPs for processing, and products created, used, either in combination, or individually, by the EFSMP are for example: Used Lubricants, Refuse Oil, Crankcase Oils, Mixed Waste Streams, Two Stroke Engine Oils, Gas Engine Oils, Preservative Cum Running-in Oils, Gear Oils, Automatic Transmission Fluids, Shock Absorber Oils, Calibration Fluids, Automotive Greases, Rail Road Oils, Turbine Oils, Circulating and Hydraulic Oils (R&O type), Circulating and Hydraulic Oils (Anti-wear Type), Spindle Oils, Machinery Oils, Textile Oils (Scourable Type), Morgan Bearing Oils, Compressor Oils, Stationary Diesel Engine Oils, Vacuum Pump Oils, Machine Tool Way Oils, Pneumatic Tool Oils, Steam Cylinder Oils, Sugar Mill Roll Bearing Oils, General Purpose Machine Oils, Flushing Oils, Soluble Cutting Oils, Neat Cutting Oils, Aluminum Rolling Oils, Steel Rolling Oil, Quenching Oils, Heat Transfer Fluids, Rust Preventatives, Rubber Process Oils, Agricultural spray Oils, Industrial Greases, Marine Oils, Transformer Oil, Coal, Carbon Black, Acid Clay, Spent Olgone, Filter Media, Sorbent's, Diatomaceous Earth and or Sand, Hazardous Waste Coal, Refinery Gas, Sand Oil, Pre-salt Oil, Ultra Deep Pre Salt Oil, Synthetic Petroleum Oil, Athabasca Oil Sands, Canadian Oil Sands, Oil Sands, Bitumen, Sulphur Production, Sulfuric Acid Production, and Water Filtration as related to removal of Sulfur, etc. from effluent streams,

Oil Fields (Offshore, Inshore, Near Shore, On Shore, Inland), Pipe Lines (Export Pipelines, Import Pipelines, Feed lines, transport, interior, network), Coal, Coal Slag, Coal Char, Blue Powder, Shale Oil, Tar Sands, Kerogen, Natural Gas LNG, Liquid Petroleum Gas (LPG), Heavy Oil, Heavy Crude oil, Acidic Oil, Acidic Crude Oil, Orinoco Heavy Oil, Fuel Cell, Lithium Battery, Hydrogen, Helium, Steam Hydrogen reclamation, Oxygen, Nitrogen, Energy Independent, Clay Regeneration—U.S. Pat. No. 4,469,805, Ceramics, and Composite Ceram.

In addition to the previous feed stocks, mentioned in this disclosure, the invention detailed in the present application also includes such effluent streams, (Cells 5 and 12) but are not limited to feeds such as are also known as Mixed Waste, whereas such feeds are a direct result of processing oil, coal, in which the technologies utilized produce additional feed stocks, and effluent streams from such industries, but are not limited to those of pyrometallurgy, effluent streams, waste water stream (Cell 14), pyro hydro metal stream, filter cakes (liquid, dust, solid), metal extrapolation, feed streams, mercury extractions, lead extractions, oil extractions, and the like. The EFSMP in the invention embodiment meets, and beats the targeted reduction goals, and best demonstrated available technology that is currently, but not limited to that of the US EPA, the US DOE, and other governmental (US and non US) Mixed Waste Integrated Program, the Mixed Low-Level Waste Program, such as those used with 3M-IBC Membranes, those of the Boliden-Norzinc Process.

Additionally, the invention embodiment of this application also presents an EFSMP (Cell 6) in which gases produced are also known as Fugitive Emissions, and the like, and are further defined as to include, but without limitation, gasses from coal, oil refining, Recycling Air Streams, as well as those that also result from liquid, metal, and gas, SMP technologies, and the like.

In other forms of the embodiments detailed in this EFSMP invention is that in the event that Crude Oil, and the like, become uneconomical, such EFSMP can also be used for commercial and private power generation, by using such sources of feedstock as is internally produced, that would have been sold on the open market. Such feedstock could include, but is not limited to, in any permeation, combination, individual, single, and jointly, or compounded, products as Coal, bituminous Coal (Cell 24), Graphite, Shale, Oil Sands, Hydrogen, Methane, Ethane, Tulane, Gasses, Mixed Gasses, Heat Recapture for turbines, with placements based upon Pinching Analysis, and the like, exothermic reactions generated from Fuel Cells, sulfuric acid reconstitution, and other processes, and the like, well as other products as described and utilized in the present invention.

Other exemplary embodiments and advantages of the present invention may be ascertained by reviewing the present disclosure and the accompanying drawings.

### BRIEF DESCRIPTION OF THE FIGURES

FIGS. 1, 1A and 1B depict a flow diagram of a receiving, storing, dispensing and routing module, in accordance with one embodiment of the present invention;

FIGS. 2A and 2B are flow diagrams of a tire plant, in accordance with one embodiment of the present invention;

FIGS. 3A, 3B, 3C and 3D are diagrams of a nano plant along with equipment within the nano plant, in accordance with one embodiment of the present invention;

FIGS. 4A and 4B are diagrams of a pyrolysis plant along with equipment within the pyrolysis plant, in accordance with one embodiment of the present invention;

FIG. 5 is a flow diagram of a battery plant, in accordance with one embodiment of the present invention;

FIGS. 6A, 6B and 6C are diagrams of a refining system along with equipment within the system, in accordance with one embodiment of the present invention;

FIG. 7 is a flow diagram of an asphalt plant, in accordance with one embodiment of the present invention;

FIGS. 8A and 8B are flow diagrams of a Claus Process, in accordance with embodiments of the present invention;

FIG. 9 is a flow diagram of a power plant, in accordance with one embodiment of the present invention;

FIG. 10 is a flow diagram of a precipitator, in accordance with one embodiment of the present invention;

FIG. 11 is a flow diagram of a sulfuric acid processing method, in accordance with one embodiment of the present invention;

FIG. 12, 12B (Cell 12) is a flow diagram of a lead smelter plant, in accordance with one embodiment of the present invention;

FIG. 13B (Cell 13) is a flow diagram of a battery cell, in accordance with one embodiment of the present invention;

FIGS. 14A, 14B and 14C are diagrams of a waste water treatment plant, in accordance with embodiments of the present invention;

FIG. 14D is a diagram of a Biological/Microbial Fuel Cell, and other alternative technologies; FIG. 14E is an example algae in a nano curtain configuration; FIG. 14F is an illustration of a complete system;

FIG. 15 (Cell 15) is a flow diagram of a hydrogen plant, in accordance with one embodiment of the present invention;

FIG. 16 (Cell 16) is a flow diagram of a water production plant and oxygen plant, in accordance with one embodiment of the present invention;

FIGS. 17, 17A, 17B, 17C and 17D are diagrams of steel and related foundries, in accordance with embodiments of the present invention;

FIG. 18 (Cell 18) is a flow diagram of a lead oxide plant, in accordance with one embodiment of the present invention;

FIGS. 19A, 19B and 19C are flow diagrams of an aluminum smelter, in accordance with embodiments of the present invention;

FIGS. 20A and 20B are flow diagrams of a copper smelter, in accordance with embodiments of the present invention;

FIGS. 21A and 21B are flow diagrams of a sintering plant, in accordance with embodiments of the present invention;

FIG. 22 (Cell 22) is a flow diagram of a secondary sulfuric acid processing plant, in accordance with one embodiment of the present invention;

FIGS. 23 and 23A are flow diagrams of a precious metal recovery process, in accordance with one embodiment of the present invention;

FIG. 24 is a flow diagram of a nano graphite production plant, in accordance with one embodiment of the present invention;

FIGS. 25, 25B and 25C are diagrams of a metal extraction process, in accordance with embodiments of the present invention;

FIG. 26 is a flow diagram of pre-pyrolysis process in accordance with one embodiment of the invention;

FIG. 27 is a flow diagram or matrix map of the system of the present invention.

FIGS. 28 and 28B are flow diagrams of a foreign plant, in accordance with one embodiment of the present invention;

FIG. 29 is a diagram of a Hydroelectric Power Water Reactor.

FIG. 30 is a diagram of a Hydro Super Reactor.

FIG. 31 is a diagram of another embodiment of a Nano Reactor.

FIG. 32 is a diagram of a Water Purification Reactor.

FIG. 33 shows a cross-sectional view of the core reactor.

FIGS. 34a and 34b show another cross-sectional view of the core reactor.

FIG. 35 shows the propulsion view of the core reactor.

FIG. 36 shows another cross-sectional view of the core reactor.

FIG. 37 shows a view of the core reactor being used with another reactor or function.

FIG. 38 shows a schematic of a matrix in which the core reactor can be used.

FIG. 39 shows a schematic of a matrix in which the core reactor can be used in which the core reactor is present and a mining system.

FIG. 40 shows the mining system.

FIGS. 41A and 41B show a flow multilevel diverter.

FIG. 42 shows an embodiment of an apparatus representing a MAGLEV generator.

FIGS. 43-71 are diagrams of various reactors and portions of the Matrix.

FIG. 72 is a cross-section of a Distillation Reactor embodied in the present invention.

FIG. 73 is a cross-section of a Slurry Treatment Processing and Purification Reactor embodied in the present invention.

FIG. 74 is Cell 10, an embodiment of a SGR/SAR Refinery Plant.

FIG. 75 is Cell 11, an embodiment of a SGR/SAR Metals Plant.

FIG. 76 is an embodiment of the Matrix of the present invention.

### DETAILED DESCRIPTION OF THE INVENTION

The present invention is further described in the detailed description which follows, in reference to the noted plurality of drawings by way of non-limiting examples of embodiments of the present invention, in which like reference numerals represent similar parts throughout the several views of the drawings. The particulars shown in this invention are provided by way of example and for purposes of illustrative discussion of the embodiments of the present invention only, and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making it apparent to those skilled in the relevant art how the several forms of the present invention may be embodied and used in practice.

The present invention relates to a novel and complex system of matrix in integrated Cells of a selective integrating of the petrochemical, metals, pharmaceutical, water, energy and power industry's processes and technologies for optimum energy and operational efficiency, new profitable product diversification and compliant cycled closed looped emissions free processing. The novel system comprises the integration of cost effective, renewable hydrocarbon feedstocks such as coal, spent oil, terminated/expired/spent tires and batteries, heavy and/or light varieties of crude oil, spent and secondary metals refining, and internally generated liquid (materials that have exhausted their original purpose), supercritical phase fluids and drying process, solid and gaseous wastes streams. The novel system can be located, desirably, at major consuming market locations being typically interconnected through a direct system of land, sea and air access media both nationally and internationally. Direct transcontinental and/or undersea pipeline access is an added advantage. If so desired, the system is capable of being adapted for operation at remote subterranean, oceanic and terrestrial locations. The invention strategy can utilize domestic and foreign sourcing of feedstock and can provide a broad spectrum of production diversification. As a bonus, present government funding, land provisions, tax and other monetary sources can considerably reduce startup costs, for such operations have been deemed independently or matrix collectively clean energy, renewable energy, green energy, of which all can also be classified and considered as carbon trading credit and carbon transfer worthy.

Cutting edge technology is used in the system and includes, inter alia: a) rapid cycle time, b) no fugitive emissions; c) a closed loop system; d) water manufacture self-sufficiency; e) utilization of novel super reactor technology; f) cross industry technology applications; g) a safer technology. h) negative carbon emission footprint; i) carbon credit exchange and trading; j) a vertically integrated feedstock; k) power self-sufficiency; l) coal material extraction including coal fines, charcoal, coal ash, actinides and coal combustion gases/fumes, and m) reduced, minimum, zero, or negative environmental (Green Hose Gasses, Carbon Emissions, Toxin, etc.) footprint.

The present embodiment encompasses interconnected modules including an initial feedstock module where feedstock from various sources, which will be described below, is received and stored and/or directly routed to modules of the system for processing. The integrated system can be comprised of pretreatment process modules from which an upstream feed can be pre-purified and then sent to a petroleum refining module with poisoning materials (also defined as contaminants, impurities, toxic, volatiles, equipment fouling substances, and the like) separated from the feedstock during pretreatment then being further recycled to provide useful materials such as, for example, separated metals, rare earths, actinides carbon and fullerenes for production of nano materials, sulfur, sulfuric acid, gas, water, steam, heat and carbon dioxide for energy production. As a consequence of the present system, method and apparatus, by-products from the petroleum refining process which were previously discarded now can be recycled as a renewable source of energy (water, waste oil and rubber/coal derived pyrolyic (or pyrolytic) oil, carbon gases and process gases) or recyclable resources such as metals and precious metals, oxides, minerals and others to the various modules of the present integrated matrix to provide useful end products.

The present invention also allows for the production of refined petroleum at a cost considerably below that of even the best current state-of-the-art presently used in petroleum refineries. The system and method can minimize capital outlay in either retrofit or new build expenditures and can meet the new eminent emissions standards, optimize production output with new ultra-speed cycle times, speeds and outputs, with reduced costs, and effectively vertically integrate feedstocks, expand on and or add profitable new product lines as well as significantly reduce existing technology upgrading and retrofit expenditures, operating costs, maintenance and repair downtime and process cycle time.

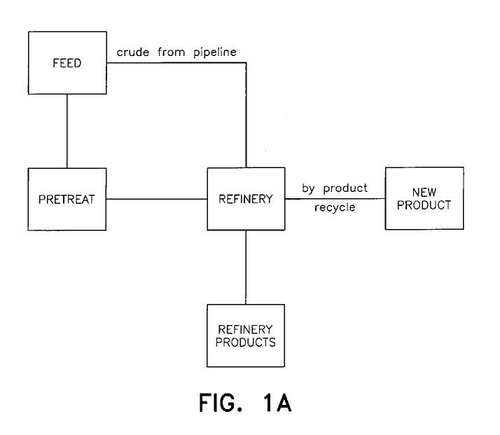

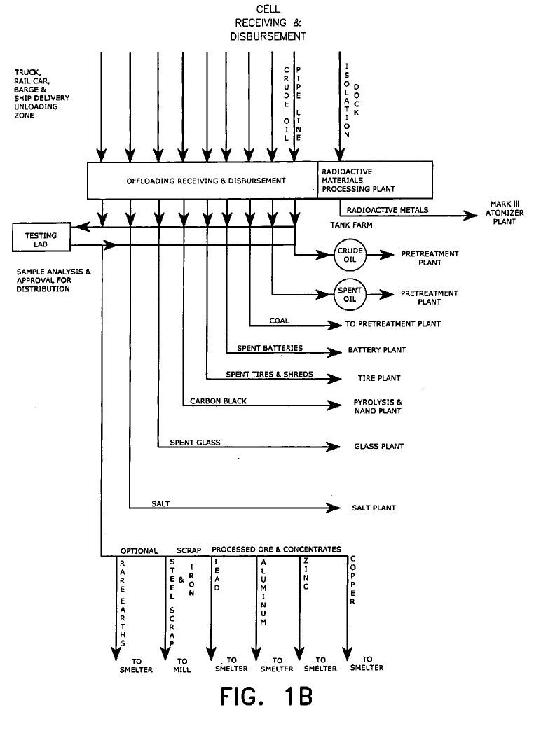

The general concept of the present inventive system, method and apparatus is shown in block diagram form in FIGS. 1A and 1B. A feed module is the module in which feed is received, stored and introduced into the present processing modules and the refinery module. The feed can include: a) oil pipeline feed; b) Crude Oil; c) Peat in various forms, d) Shale Oil; e) Oil Sands; f) Tar Sands, g) waste industrial and utility company transformer oil; h) bitumen; i) waste (spent) automotive oil; j) terminated spent tires; k) spent batteries in various forms and construction; l) coal, coal fines, graphite; and m) carbon black. Spent oil is processed to remove impurities including inter alia minerals, chemical additives, solvents, metals, carbon, grit, chlorine, sulfur, volatile organics, moisture, acids, ash, catalysts, oxidants, PCBs, actinides, unspent fuel and other like contaminants. The pretreated material is sent to the refinery to be reprocessed in the refinery to petroleum, and to other modules such as, for example advanced Nano, to provide composites, carbon fiber or ceramic materials, and other modules to provide fuels, lubricants or electrical and thermal energy products. By-products from the refining process can be recycled through the modules, individually, collectively, in tandem, hybrid, and or part, depending upon user requirements, to provide further products. Products from the present matrix system and process include, inter alia, a) motor oil; b) gasoline; c) diesel and JP-4; d) JP fuels, e) kerosene; f) greases and lubricants; g) LPG, propane, hydrogen, naphtha, nitrogen; h) butane; i) feedstock; j) metals including precious metals; k) metal oxides; l) sulfuric acid and sulfur; m) waxes; n) ceramics; o) activated carbon; fluff (from tires and used as component for growing nano tubes); p) carbon black; q) asphalt; r) ammonia; s) methane; t) water; u) electric power; v) carbon credits; w) nano tubes; x) advanced ceramics and; y) advanced nano composites; z) catalysts, additives, solvents, chemicals for recycle ab) actinides, ac) metals, ad) minerals, ae) chemicals and chemical compounds, af) rare earths; and ag) water.

The integrated modules of the present system, method and apparatus perform processing, separation and recovery, reforming, recycling and manufacturing as well as producing products, energy and feedstocks. The resulting benefits of the present process, apparatus and system include, for example, production of electrical energy, thermal energy, Nano tubes, sulfur extraction, nitrogen extraction, oxygen extraction, and extraction and collection of valuable minerals, pyrometalurgical and hydrometallurgical products, and sulfuric acid as well as water. Each of the numerous modules which can be included in the present invention matrix, system and process will first be described individually and they will be further described as the integrated matrix modules.

The integrated system of the present invention can be comprised of various modules including the following: receiving, storage and routing (tank farm); tire plant; pre-pyrolysis, purification, reduction, mix and treatment; pyrolysis; battery plant; sulfuric acid plant; Nano plant, atomization, oil metal extraction; refining; asphalt plant; steel foundry; lead oxide; lead smelter; aluminum smelter; precious metals smelter and catalyst recovery (Platinum, Gold, Silver and others); zinc smelter; copper smelter; sintering; waste water treatment; water production plant; sour water stripper; rare earth, actinide, rare earths, and mineral extraction and recovery, power generation; gas plants including hydrogen plant; oxygen plant; and nitrogen plant. Methane can also be produced from coal liquefaction and gasification but there is no need for a separate module for methane production as it is converted to syngas in the system.

The present invention gathers, integrates, recycles, renews, consumes and manufactures a diverse range of profitable fuels, including for example, lube oils, electric energy, natural gas, hydrogen, metals and precious metals, actinides, oxides, zinc, asphalt, waxes, sulfur, ammonia, sulfuric acid and steam generation. In addition, technologies integrated into the invention include fuel cells, pyrolysis, distillation, refining, precipitation, thermal reaction and conversion. External recyclables including, for example, waste oil, used tire generated black oil, spent batteries fuel cells with and without their components, metal slag, processed and spent materials (things like red much from aluminum productions, radioactive copper/gold/precious metals, etc.), external renewable lube oils including, for example, industrial, automotive, military, commercial oils; filter cakes, water, as well as crude oils (light, heavy and shale oil) are received and stored in the receiving and storage are of Cell for routing to processing Cells of the present invention. Internal refinery spent feed-stocks, waste emissions and residues (slag, oxides, sulfuric acid, syngas, methane, condensate, waste, and sour and wastewater) are renewed for internal use and as new profitable products.

Should lithium battery, fuel cell, or a combination of the technology replace lead acid batteries in the automotive industry, this present invention provides for a rapid recycling process change-over with little or no further investment.

The present invention comprises an integrated system encompassing processing steps, manufacturing steps, separation and recovery steps and procedures as well as the manufacturing and production of products. The present integrated system further encompasses one or more of: a) the receiving and routing of input materials into the process, system apparatus, without limitation (as this embodiment also process rare earths, actinides, manufacture filter cakes and process them) such as in cells 1, 14 and 28; b) Cells 2 and 4 are a tire plant modules for the processing of tires; c) Cell provides for the pyrolysis of materials of the present system and apparatus; d) Cells 5 and 12 are battery plants for the processing of, e.g. lead batteries or lithium batteries; e) Cells 10 and 11 provide for sulfuric acid processing and manufacturing; f) Cell 25 is an oil metal extraction module; g) Cell is an asphalt plant; h) Cell 17 is a steel foundry; i) Cells 12 and 18 provide for lead oxide production; j) Cells 12, 13, 18, 19 and 20 are Cells for one or more of lead, aluminum, zinc, or copper smelting; k) Cells 23 and 25 provide for precious metal recovery; l) Cell 14 provides for waste water treatment (what about product streams, filter cakes, electricity production, etc.) m) Cell 16 provides for water production; n) Cells 9 and 14 provide for sour water stripping; o) Cell 9 provides for power generation (fuel production, gasses production, fullerene production, heating sulfuric acid production, ultra-pure sulfuric acid production, concentrated sulfuric acid production, metal recovery through the fuel cell membranes, etc.); p) Cells 15, 3a, 3b and 24 are one or more of a hydrogen plant, a nano plant, or a nano processing module; and q) Cell 1 is a tank farm for storage of materials which are routed to the processing Cells of the present invention, and include, but are not limited to, such materials as petrochemical fluids, spent automotive and lubricants, coal, crude oil, acids, water, rare earths, and iron, in their different forms. It should be understood that the present invention does not require the use of all Cells or modules but rather the Cells used can be chosen for the processes and products which are desired. The Cell architecture can be chosen and arranged by the artisan skilled in this art area.

Cells 1 and 5 provide inbound feedstock to the present integrated system including, inter alia and without limitation, waste oil, crude oil, lead acid and/or lithium batteries, rare earths, actinides, water, and iron, and ores, in their different forms. Cell 2 provides spent tires, and coal is provided to the matrix from Cell 5. Materials which may be produced from the batteries include, for example, but are not limited to, lead, acid, polypropylene, rubber, ionized laden membranic material, filter cakes, and lithium. Materials which may be produced from the tires include, for example, rubber, (processed in Cell 17), polyester, and rayon.

Moreover, the embodiments in this invention teach and incorporate directly, and by reference, but is not limited to either, ways to further advance, oil refining, as well as a “Renewable Clean Energy” technology capable of attaining and sustaining imported oil independence at below market pricing while generating significant profit opportunities through the licensing control and or direct use of such technology, and resulting in a negative Carbon Emission Footprint. Further, factories and other consumers of fuel, and incorporate the systems and technologies taught in this invention, to more efficiently utilize energy, and become more compliant with Carbon Emission Reduction standards, polices, and the like.

As conventionally accessible supplies of light sweet crude have become more scarce, and more difficult to extract, the Petroleum Industry has evolved to use a series of alternative access methods such as deep-well drilling, oil sand and shale oil extraction, and the processing of non-conventional extra heavy and sour oils.

There are other factors compounding the energy problems: the global recession; permanently changed consumer patterns, travel choices, values; a trend toward downsizing and sustainability; and the need to develop alternatives to oil by continuing to maintain the economic viability of those alternative technologies. Additionally, water shortages, water rationing, and water rights, are already emerging as a global crisis, with most of the usable water now either brackish or saline, leaving energy providers, industry, agriculture, and human consumption requirements all competing for the dwindling supply. Impending food shortages have been reliably predicted from all corners of the globe and the economic universe. Consequently, ethanol and bio-fuels are being reevaluated because of significant water consumption required in growing the crops, and then the hydrocarbons necessary to process them into fuels, further complicated due to the diversion of crops from food creating a corresponding reduction of food resources and supplies, as well as a human toll: increased starvation.

In addition, system is an Eco Friendly System Method and Process (EFSMP and used interchangeably with the invention embodiments) and works within, but is not limited to, the North American Industry Classification System (NAICS). The NAICS classifies the Petroleum and Coal Products industry (per NAICS 324 and 325) as including petroleum refineries that produces fuels and petrochemicals and manufacture lubricants, waxes, asphalt, and other petroleum, shale, bitumen, oil sands, tar sands, extra heavy oil, oil, shale oil, crude oil, petroleum, and coal products. Moreover, according to NAICS 324110, petroleum refineries are defined as establishments primarily engaged in refining crude petroleum into refined petroleum. Further, the present embodiment refers to both liquid energy and coal resources, since they represent the basic petroleum and energy building blocks the embodiment works with. In describing and understanding this invention, it is important to go beyond conventional oil and include non-conventional liquids such as condensates, natural gas liquids, tar sands, bitumen, extra heavy oil, oil shales, gas-to-liquids, fossil fuels, also known as petroleum, coal, petrochemical, petrocarbon, carbon, hydrocarbon, coal residue, Natural Gas, Petroleum Gas, Bitumen, Shale, Shale Oil, Oil Sands, Peat and the like.

The EFSMP disclosed in the embodiments, includes more than permutations of variable Reactor sizes of lengths and widths, and traditional sources of used lubricant, as will be further described in this invention. Examples of feed stocks can also include Crude Oil and other forms of streams of non-processed, processed, lubricants and Crude Oil, gasses, diesel, and gasoline, from sources that may be nondescript.

Additionally, different industries use different terms. Terms may be industry specific, but are yet terms that represent an equivalent product in other industries. There are times when such terms are referred to generically, yet are inclusive, and representative of technologies, terms, systems, methods, products, procedures, and the like, in other industries. These terms are integrated into the embodiments of the present invention. Examples of which are terms, for example, like ash. Ash is used in Mineralogy and Ore Mining. Char is an equivalent of Ash, and is used in Coal Processing. Slag is usually a term used in processes of the manufacture of metals from ore, as in Iron Ore, produces a slag. In the case of Coal gasification, the Ash is also referred to Slag. Sintering is generally referred to as the separation of metals and other particulates, based upon temperature, within the coal industry. However, it can also refer to an application of particulates to substrates, and whereas by further example a Sinter mix, is a mixture of fines of iron ore, limestone, coke, dolomite and flue dust of the present invention relates to a matrix of vertically integrated technologies, from a multiple discipline of industries. Technologies are also interchangeable, and have different names and provide similar or the same Systems, Methods, and Processes (SMP). In addition, in one industry the SMP may be referred to as a Blast Furnace, yet in another it is a variation of an Autoclave. Sintering is also a SMP that in one industry, oil for example, yet is used in coal processing as a term for liquefaction (whether direct or indirect). Reverberatory Furnaces, Kilns and Fluidized Bed Reactors, distillation columns, though are different equipment names, for technologies that are used in completely different industry, but can be interchanged, in either industry as they perform the same function, yet use different names.

Other embodiments of the Reactors, as generally referred to in this EFSMP, include, but are not limited to Autoclave's, Carbon Fiber Systems, and other types of furnaces, and the like. Some systems that could be implemented are defined by function and name at Harper International's website (www.harperintl.com).

Additionally, the Reactors, as well as the EFSMP, can be vertical, horizontal, or diagonal, and in any permutation, combination, hybrid, parallel, and the like, in position.

Other definitions useful in understanding this invention include the following list below.

Plants in matrix—hydrogen, oxygen, sulfuric, sour gas, electric, power, water, water filtration, asphalt, carbon black.

Sulfuric acid—sour gas, sulfuric acid, acid vapor, caustic vapor: fuel and gases being produced, include syngas, gasoline, jp4, jpx, diesel, kerosene, heavy fuel oil, fuel oil, residuum, naphtha, light oil, methane, mazut, methane, syngas, sour gas, oxygen, ammonia, helium, argon, propane, Liquid Petroleum Gas (lpg), Liquid Natural Gas (lng), catalane, liquid oxygen, liquid nitrogen and butane.

Types of oil—petroleum, petrochemicals, crude oil, petrocarbon material, bitumen, peat, tar sands, oil sands, and spent oils of the same nature.

Coal to liquid—coal liquefaction and gasification/gasification (aka CTL), Coal to gas

Coal—coal fines, mined coal, coal dust, low rank coal, coking coal, steam coal, hard coal, metallurgical coal, coal powder, thermal coal, pulverized coal, Peat, micronized coal, anthronite, organic rock, Bituminous coal, Brown Coal, Subbituminous coal, lignite, coal gas (methane), coal from surface mining, coal from underground mining—including but not limited to, coal from the North America, Eurasia, Russia, China, Antarctica, India, Indonesia, Poland, Kazakhstan, Oceania, Australia, New Zealand, Germany, Africa, Ukraine, Europe, Middle East, Asia Pacific, South America, Central America, from the Moon that orbits the Earth, and from Mar.

Metals—being extracted rare earths, precious metals, transition metals, transition elements, light rare metals, actinides, refractory rare metals, dispersed rare metals, rare earth metals, iron, mercury, lead, platinum, chalcogenides, transport metals, ferrous metals and nonferrous metals, radioactive metals, magnetic metals, electromagnetic metals, thorium, uranium, noble metals, compound metals, metal alloys, alloyed metals, copper, aluminum, metal oxides, metals of the periodic table.

Metal Forms—vaporized metals, atomized metals, fissionable metals, powder metals, liquefied metals, solid metals, plasma metals and gasified metals.

Nano—nanotubes, nanotechnology, single walled nanotubes, multi walled nanotubes, double walled nanotubes, nanocomposites, nano particulates, nano particles, metal chalcogenide nanoparticles, metal chalcogenide nanostructures, nanoparticles shaped like rods, barbells tetrapods and spheres, and Mesoporous functional architecture.

Chalcogel—Chalcogel, Aerogel, x-Aerogel, colloids, solgel, sol gel, metal chalcogenides, metal semiconductors, quantum dots, nano particles from semiconductors, supercritical drying form, supercritical drying and substrates, silica Aerogel, metal oxide Aerogel, metal ions and chalcogenide, chalcogenide, metal chalcogenides nanoparticles, inverse micelle formation chalcogenide gel, inverse micelle formation chalcogenide gel by arrested precipitation, metal chalcogenide gels from Hunt Process CO2 drying, chalcogenide Aerogels, metal chalcogenide Aerogels, Porous Metal Chalcogenide Aerogel, metal chalcogenide nanostructures, phosphide metal chalcogenides, organic aerogel, carbon Aerogel, mesoporous metal chalcogenide, stable mesoporous metal chalcogenide by cross-linking of nanoparticles to for a gel-body, Mesoporous functional architecture, SEAgels.

Colloid—in the process of supercritical drying precipitation is also a particle that can move toward the oppositely charged electrode, whereas such migration is also known as electrophoresis.

Abalation is also defined, without limitation, as Microwave, Infrared, Ultrasound, and Radio Frequency heating technologies. Furthermore, and in addition to, but without limitation Cavitation is also a technology used in heating. When the technologies, etc., and the like are used in conjunction, with or without, in tandem, parallel, on stand alone with metamaterial technologies, i.e., the electromagnetic metamaterials are artificially structured materials that are designed to interact with and control electromagnetic waves, where chemical synthesis is no longer a limitation, electromagnetic materials with changed geometries known as metamaterials provides for increased use of radiation frequencies and energy, in so much, as defined by way of example, and without limitation, electromagnetic waves may be any type of wave in the electromagnetic spectrum that can be used to manipulate temperatures, where the temperatures are multiplied using terahertz spectra, in so much that the energy, radiation, etc., multiplies that of: a) rare earth magnetic fields; b) intensifying sonics and ultrasonics; c) cavitation heat; d) ultrasound heat; e) and any of the energies, and the like as described in the present invention, where used for processing and refining, without limitation.

In addition, ablation, just as radiofrequency (RF) ablation, can be used to treat pathological conditions in situ. For example, ablation can be used to treat a tumor by heating the tumor tissue (e.g., causing cells in the tumor tissue to die). In some instances, tumor ablation can be achieved by inserting an RF electrode having tines at one end into the area of a tumor, deploying the tines, and activating the RF electrode so that RF energy flows through the tines and heats the tumor tissue, so to can any effluent, liquid, plasma and the like, without limitation, be heated in a like manner.

It is a further desire of the present invention to function, but without limitation, with such technologies as can also be employed in Reactors of Variable lengths and widths, and capable of temperatures to exceed 3500 degrees Celsius; Excellent air flow uniformity, Easy internal access to facilitate maintenance; Coal, Electric or gas fired, Optimal temperature uniformity, Operator isolation from effluent; Highest Energy Efficiency, Fastest line speeds; Thermal Recovery Systems, Surface Treatment Systems, Multiple Sizing Agents, Multiple Electrolyte Solutions; Clean and Hygienic; Non-Contact Drying, Flexible System Designs; Unique Gases (e.g.: Argon, Nitrogen); Large capacities (multiple muffle systems); Atmosphere Control, Reduced energy costs; Excellent temperature uniformity, with features, not limited to, but can include Multiple temperature control zones; Proven alternating cross flow design, Adjustable louvers and diffuser plates for precise temperature adjustment; Rigid roll stands; Integrated brush roll assemblies; Excellent float end seals for positive sealing; minimized infiltration of ambient atmosphere and improved temperature uniformity; Aluminized steel construction; Plug fans to facilitate maintenance, Carburization resistant muffle; Low profile muffle for gas flow control; Process gas distribution and sampling system, Proven purge chamber gas curtain technology; and the like. Such embodiments are encompassed in the modules of Cells 12, 17, 18 and 23. Additionally, the EFSMP utilizes, as necessary, multiple temperature and atmosphere control zones, in and throughout the EFSMP systems, but without limitation, in which those zones can be contained independently, automated, robotically connected, robotically filled and drained, and the like, enabling specific temperature vs. atmosphere requirements. Multiple temperature control zones as well as control of temperature above and below the load provide optimal temperature uniformity. Modular construction facilitates modification of the Reactor tunnel to accommodate adjustments in process or production rate. As well as functions of delicate pressure control within the Reactor, the invention provides control of the atmosphere flow path in the Reactor facilitating evacuation of volatiles and optimizing atmosphere uniformity. Reactor gas curtain technologies provide zone-to-zone atmosphere definition under specific conditions. Reactor stripping chamber design provides optimal isolation of internal tunnel Reactor chamber environment from ambient as well as efficient purging of ambient atmosphere entrained within the load entering the Reactor without the use of mechanical doors and seals. The EFSMP of the embodiments (such as in Cells 6, 15, 16, and 14) also include such technologies, reactors, permutations, combinations, hybrids, sections, parallel units, for, but not limited to, rotary reactor sealing systems, providing optimal rotary tube furnace atmosphere integrity with minimal gas consumption. Natural Gas Refinement and Liquid Petroleum Gas Refinement, and the like, to convert this into a useable product requires the initial separation of the mixture into gaseous and liquid components, such as Carbon, Sulfur, Oxygen, Hydrogen, Water, Carbon Dioxide, Nitrogen, Methane, Ethane, Propane, Butane, Pentane, Hexane, triethylene glycol, Potassium, Hydrocarbons, and the like, and then the purifying and separation of the gaseous component. Such examples are presently being produced, but not limited to, those of and by Royal Dutch Shell in Qatar, dubbed Pearl, as well as by Shell Todd Oil Services (STOS) in Australia, and are incorporated herein by reference.

Moreover, anywhere in the present embodiment where CO₂ is vented off, it is reused, regenerated, recycled, captured, and the like, in that it can also be processed into Advanced Carbon Fiber material, gasses, Carbon Credits, Carbon Dioxide Gasses, in any form whatsoever, for sale into the market, or in-house use (either on an inter-campus location basis, or an intra-campus location basis).

Additionally, the present embodiment includes such technologies as those used by Sasol Ltd., a partly state-owned company, built several coal-to-liquids (CTL) plants, including the ones at Secunda, and became the world's leading purveyor of coal-to-liquids technology. However, as those facilities are limited in scope, to solely the processing of coal, the present embodiment does not include such a limitation.

Further, the embodiment, such as in Cells 6 and 26, includes technologies that are structurally different from a typical refinery in that the Cells are self-contained, enclosed, self-sufficient, and emission free (beating global emissions standards), and are not limited to structures and applications that cover, include, and contain: modular components; aggregate and non-aggregate; swappable configurations; distillation; hydrogenation; isomerization; reactor and reactor chambers; bleed streams; coal conversion technologies; Syn-Gas Production (from Oil, Coal, Tires, Rubber), coal gasification, methane reforming and the like; fugitive emissions; reforming (e.g. steam reforming); CO2 Reforming, Partial Oxidation Reforming, and the like; natural gas co-conversion; and Coal and Methane Co-Conversion.

The present embodiment, e.g. Cell 5, utilizes a series of piping architectures, heaters, scrubber, turbines, furnaces, and coolers. Modifications and upgrades, anticipated as the state of the art advances, are also incorporated in the present invention. Including, but not limited to, the eventual enclosure of the EFSMP into a single Reactor, or Parallel Reactors, as the economy of the EFSMP and the scale of such requirements are desired. Moreover, the Management of the EFSMP is done either on-site, at-location, or remotely, as needed or required by the operator. Communication between such operations is typical of a refinery, but does not have the total capacity of all of the EFSMP embodiments outlined in the present invention. Additionally, the EFSMP Reactor System of the present embodiment is similar to, but not limited to, in scope, breadth, or any other capacity, those of Harper International. However, the inventive EFSMP detailed does not have some of the limitations of the Harper International systems, and as a function of technologies that comprise the EFSMP Reactors of the present invention, does include, and are inclusive of the Super Reactor, contained either as an individual unit, parallel series, hybrid, combination, enclosed, or openly visible, and the like, as in the case of a typical oil refinery, and the like. Further, the present embodiment includes a stand-alone EFSMP and combinations of the above, in any permutation desired, without limitation and in any hybrid capacity thereof.

Additionally, examples of the types of feed stock (also defined as any petroleum based oil, also known as a hydrocarbon oil and/or a petrochemical oil), in any form has a characteristic that is common, such that the molecular structure is stable, and that either in the refined state or crude, or processed, or re-refined, and the like, is that the molecules never wear out—all that happens is that additives in the oil wear out or deplete and need replacing, unless the feed stock is destroyed by means of burning, or molecular breakdown. This is especially true of lubricant oil and refined oil. Feed stock are such as types of product known as, and derivative of, and or any combination of: waste oil/sludge oil; black liquor; mixed waste streams; Orimulsion; waste oil; residue oil; black oil; spent oil; heavy crude; extra heavy crude oil (with Nickel and Vanadium); vacuum residue from solvent (VR); bottom of the barrel processing; residual desulfurization (DS).

Furthermore, the present embodiment can utilize heavy oil kerosene coal; all types of coal, including, but not limited to types ranging from lignite-b to sub-bituminous-A; synthetic crude oil; Coal, Sand Oil, Shale, Bitumen; Lignite; bituminous Coal; Sub-bituminous Coal; Anthracite; Char; Petroleum Coke; Coal Coke; Natural Gas; LPG; Liquid Petroleum Gas; Propane; Methane; and Atmospheric Residue.

The present invention is further described in the detailed description which follows, with reference to the drawings by way of non-limiting examples of embodiments of the present invention, in which like reference numerals represent similar parts throughout the several views of the drawings. The particulars shown herein are provided by way of example and for purposes of illustrative discussion of the embodiments of the present invention only, and are presented to provide what is believed to be the most useful and readily understood description of the principles and conceptual aspects of the present invention. In this regard, no attempt is made to show structural details of the present invention in more detail than is necessary for the fundamental understanding of the present invention, the description taken with the drawings making it apparent to those skilled in the relevant art how the several forms of the present invention may be embodied and used in practice.

### The Complex System of Integrated Cells

The Complex System of Integrated Cells (also interchangeably referred to as the present embodiment and/or EFSMP throughout) of the present embodiment is an emissions free power generation and fuel refining system able to turn carbon based feed stocks into renewable energy on a massive profitable, consistent scale at well below current market prices and industry processing costs.

Some of the mass produced products from the embodiment include, for example, manufactured water; refined carbon fuels and lube oils; filtered fuel grade actinide for secondary power creation and a full range of metals, Nano based advanced composites, carbon fiber and ceramics.

Additionally, the present invention's ability to self-supply carbon feed stocks in a massive scale allows for a business model that can profitably establish and operate a national network of strategically located self-sufficient production facilities from major markets.

Such a model allows for significant social and political support and benefits including: national energy independence, renewed or accelerated economic growth, new and secondary job creation, new tax streams all with an abundance of renewable, stably priced, low cost energy, fuels and lube oils.

The present embodiment includes a novel reactor and filtration system having the ability to completely de-poison and purify feedstocks at critical upstream pre-refining and pre-power processing points. This system allows for low cost precision extraction, capture, containment and recycling of individual metals, minerals, gases and solid wastes that poison processing feeds and pollute the environment.

The system also includes new processing reactors with a common thread of few moving parts, very rapid cycle times, construction with advanced materials for ultimate thermal efficiency and viable new product creation. The design standardization and consolidation of refining and materials processes delivers significant reductions in new build or retrofit capitalization, speed to market, operating costs, and repair and maintenance downtime.

The technologies of the present embodiment are clean energy designated, carbon emissions free enabling the clean burning of coal and other hydrocarbon materials products, and is be utilized for carbon trading.

In addition, the present embodiment can be comprised of any desired number of the individual production Cells illustrated in the present invention. Moreover, the individual production Cells are interlinked by shared feedstocks, waste streams and purification systems that capture, purify and recycle all gas, solid and liquid wastes and materials generated. The interlinking allows for the creation of a wide array of new profitable products able to propel profits without damage to the economy, environment or consumers.

### Further Details on Matrix

The Matrix—The Matrix system of interconnected processing plants can be reduced in size with the replacement of the present invention reactors and processing systems. The present invention value is further realized when also considering the benefits of: a standardized equipment design, rapid reactor build and site installation, quick ship interchangeable parts inventory availability, scale of economy savings, advanced construction materials allow for advanced processing abilities, consolidated reactor functions, next generation advanced technology, faster cycle times, increased production volumes, Precision processing & recycle systems, low cost of operation, little maintenance or repair downtime, manufacture scale of economy derived from standardization, closed looped system void of fugitive or smokestack emissions, reduced, or zero to negative emission environmental impacts, self-generated water, steam, sulfuric acid, gas, carbon and pyrolyic oil feedstocks, zero to negative greenhouse gasses footprint, zero to negative carbon footprint, Distillation Reactor—The distillation reactor combines the crude oil, pyrolyic and the waste oil separation processes into a single atmospheric and vacuum distillation reactor system. The distillation reactor also pre-treats, desalts, de-poisons, deasphalts and wipe film/short path evaporates waste oil contaminants through high velocity heated cyclonic vortex centrifugation.

The distillation invention allows for Matrix elimination and or consolidation of: preflashing, desalting, dryers, wiped film and/or short path evaporation reactors, deasphalting, sludge flocculation, waste oil processing reactors such as the dehydrator, diesel stripper, condensers, flash drums, surge vessels and heaters, base oil fractionation equipment, Residuum is forwarded to the Pre-Pyrolysis/Pre-Power Slurring reactor to be used as a boiler, reactor fuel source.

Hydro Reactor—The hydro Reactor system consolidates the Matrix regenerative: hydrotreaters, hydro-finishers, Olgone filtration, •fractionator towers, thermal hydrocrackers, and Visbreakers.

The Hydro Reactor invention can be constructed as a single reactor unit for smaller volume and batch processing (as pictured in the drawing) or as a standalone hydrotreater and a separate hydrocracker reactor for continuous volume processing.

The invention reactor optimizes feedstock concentrations, thermal efficiency and cycle speed well beyond current technologies. The consolidation significantly reduces the length of the piping network and subsequent loss of thermal energy.

Side Stream Reactor—The advanced Side Stream Reactor serves as an upgrade retrofit or replacement for existing systems. Designed as a final filtration safeguard it ensures that distillation processed streams have been purified of poisoning metals such as Vanadium, nickel, sulfur, mercury, iron, cooper, zinc & lead, and the like.

The reactor also provides the final treatment of hydrogen over a cobalt-nickel catalyst for color and odor adjustment at a temperature range, without limitation, of 315 degrees to 345 degrees Celsius.

The Chalcogel filtration system ensures that all remaining metals are isolated, captured and contained for periodic harvesting and recycle, as per user-defined parameters.

Pre-Pyrolysis/Pre-Power Slurry Reactor—The slurry reactor pre-mixes, purifies and pre-heats a proportioned continuous mix of ground coal, petroleum coke, hydroxides, residuum and waste oil. The slurry is pressurized in a hydrogen and propane gas atmosphere with ultrasound assist to form a hybrid clean burning fuel for the Matrix's boilers, carbon fuel cell, gasifiers and reactors.

The Chalcogel filtration allows for precision capture and extraction of metals, effluents, gasses, liquids, and the like, without limitation, for recycle and to de-poison the feedstock for a clean thermal conversion into heat and syngas. Crystalline minerals are also captured and removed for recycle to minimize pyrolyic coke build up in the reactor.

The slurry reactor system allows for Matrix optimization through: better utilization of residuum as a fuel rather than an asphalt mix, no deasphalting process is necessary, high thermal heat value without greenhouse gas emissions, full capture and recycle of trace metals, and upstream refinery de-poisoning for cost effective downstream processing.

The Flash Pyrolysis Reactor features both an advanced gasification system and a pyrolyic thermal reactor with a proprietary round or oval thermal flame liquefaction chamber and high vacuum microsecond extraction flush, however as the state of the art advances, such speeds can be reduced to milliseconds and fractions thereof.

The gasification processing technology allows for the consolidation, upgrading or replacement of all gasifiers within the Matrix due to its continuous high velocity flow rate and processing efficiency. Some gasifiers that the invention technology supersedes or can be modified and integrated with in the Matrix include, and without limitation: •standard Matrix gasifier systems and technologies, •Fischer-Tropsch process integration, •UHDE, •LURGI, •Mitsubishi Gas Chemical, •Haldor Topsoe, •Methanol Casale, •Shell, •Texaco •Chevron, •Sasol, •Exxon Mobil, •Methane, syngas processing & production plants, •Refinery gas plant processing, •Petroleum coke/coal processing, •Power plant gas turbine fuels, •Steam production & steam methane reformers, •heavy residue oil to produce hydrogen for the hydrocracker The Pyrolysis Reactor technology allows for the flexibility of wet, entrained or dry feeds in various configurations, heat sources, heat ranges and types of pressure or vacuum atmospheres. Premeasured catalysts with timed combustion fuses allow for total saturation from a central chamber star burst synchronized with the fuel injection.

The invention Pyrolysis Reactor replaces traditional Matrix counterparts produced by, and without limitation, either individually, in tandem, parallel, combination, and the like: •Metso rotary kilns, •Texaco liquefaction system, •Solvent extraction, •Low temperature distillation, •Stand alone ultrasonic devulcanization, •Stand-alone microwave processing, •Stand alone supercritical water, Atomizer Reactor—This reactor is included in the present invention, Hydrogen Plasma Arc Fuel Cell System—This reactor is included in the present invention, Microbial Fuel Cell—This reactor is included in the present invention, Gatling Gun “style” Nano Reactor—The Gatling Gun Nano Reactor is an advanced system for the industrialized scale production of uniform Nano, nano tubes, nano particles, nanowires, nano wire blocks, nanowires tiles, nanoprocessors, nanonets, photosystems using optical nanomaterials nano whiskers, nanotube solar concentrators, nano ribbons, nano circuits, and Nano composite materials, with different coordination numbers, and the like, without limitation, including: •Single wall Nano tubes (SWNT), •Multiple wall Nano tubes (MWNT), •Nano water, •Nano fullerenes, •Nano strings, threads, yarns, •Nano Buckyballs, •Nano powders, coatings, glue, crystals, •microstructural inhomogeneities, •Metamaterials, •chalcogenide glass, nano cones, •Advanced Nano composites, •Ceramics, •Carbon & carbon fiber, •Graphite & graphene, •Glass, •Powdered metals, •Foam metals, •Rare earths, •Chalcogels & foam solutions, •Soluble chalcogenide clusters, and •Plastics.

Featuring a 10,000 rpm electric pulse plasma arc Gatling gun firing head which can reach temperatures of 20,000 K, but not limited to such, the invention Nano Reactor is able to replace or inculcate current Nano processing Matrix technologies including: •Laser ablation, •Plasma rotating electrode, •Laser assisted CVD process (chemical vapor deposition), •Continuous wave laser-powder method, •Ultra-fast pulsed laser ablation apparatus, •Magnetic field synthesis, •Liquid nitrogen arc discharge, •Thermal CVD, •Plasma CVD, •Vapor phase growth, •Alcohol chemical vapor deposition, •CO flow tube reactor, and •CO Mo catalytic reactor.

Growing chamber systems are integral in Nano, Nano composites, Chalcogel, Aerogels, Silica aerogels, Carbon aerogels, Alumina aerogels, nanogels, xerogel, hydrogel, bidirectional hydrogel, Sol-gel, self-assembled monolayers on mesoporous supports, supercritically dried hydrogel formed Aerogels, SEAgel, Chalcogenido, Colloid and Xerogel (collectively known as and defined throughout as Chalcogels, whereas without limitation, such terms can be interchanged—and which all such material can also be bidirectional) processing as each chamber allows for individual but consecutive processes to be completed in a precision environment. Chamber diameters, lengths, shapes will determine processing times, flow rates, atmospheres including zero gravity, temperatures in conjunction with such technologies as infrared, microwave, ultrasound, radio wave, sonic cavitation, steam forming, electromagnetic, laser, plasma arc, induction coil, autoclave, convection, colloidal, supercritical drying, Chemical Solution Deposition, chemical vaporization deposition, cryogenics, spin-polarization and the like.

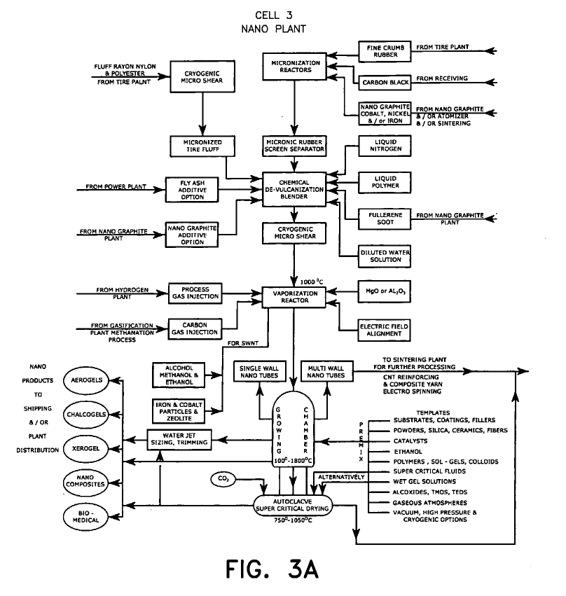

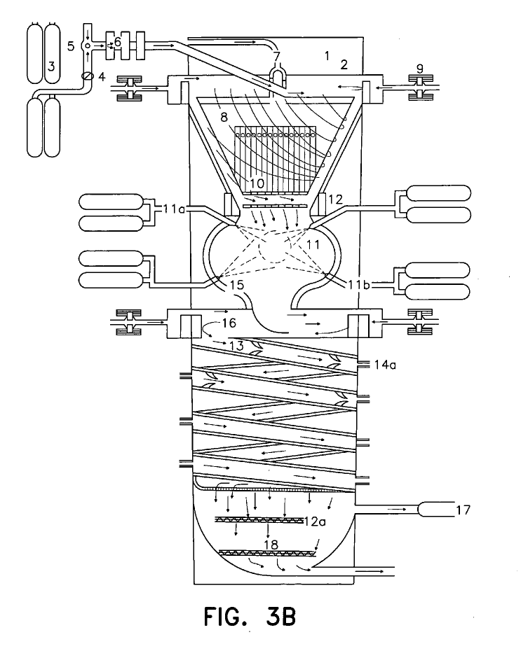

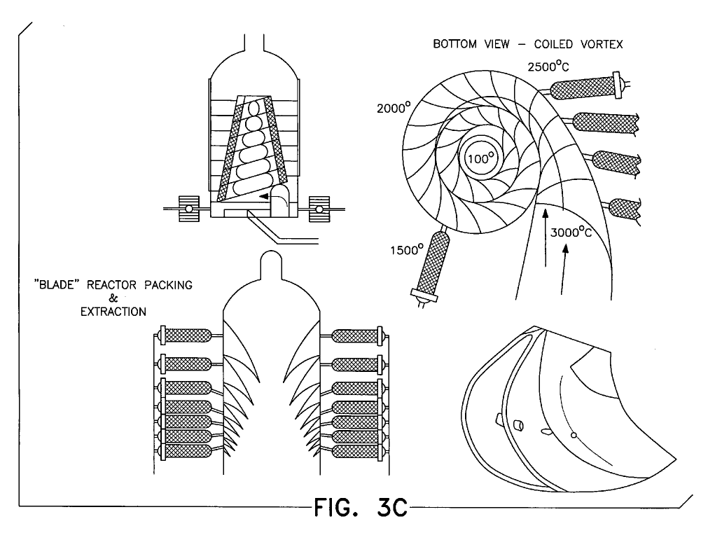

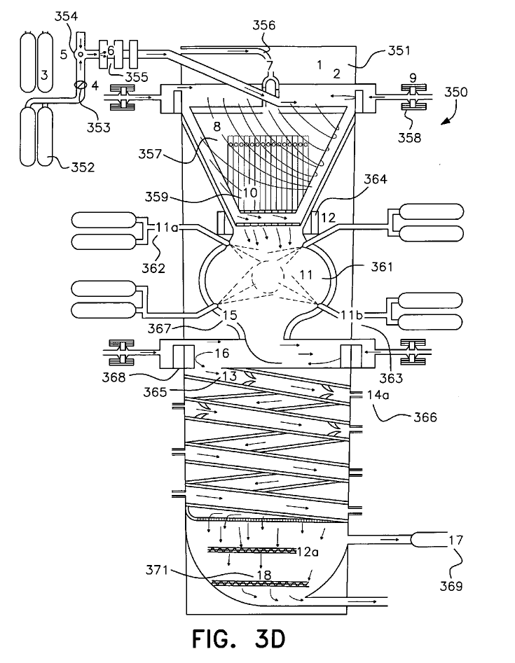

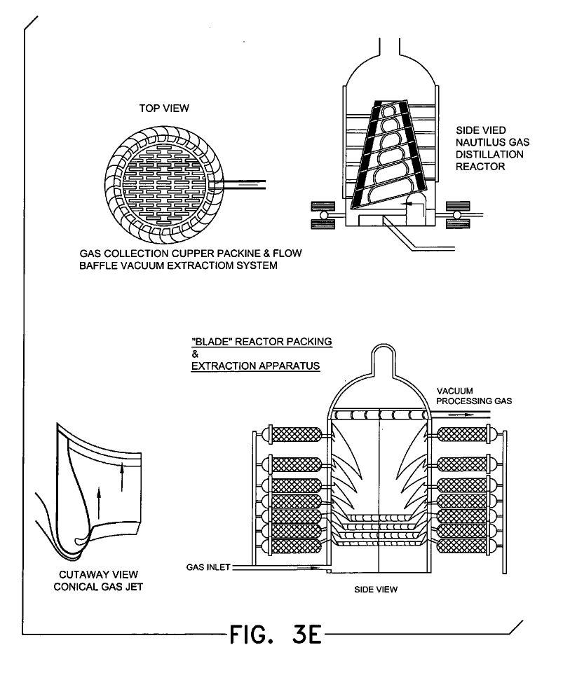

The growing chambers can be fitted with injection ports for catalysts, solutions, coatings, plating, substrates, alloying, curing, tempering, colloidal saturation, gaseous atmospheres, pressures and vacuums. Growing chambers can be configured as descending, ascending or straight planed spirals, coils, elevators, cork/Archimedes screws or Nautilus shell (an example is depicted in FIG. 3C) high velocity vortex shapes. The reactor and or growing chambers can be constructed of advanced materials resistant to deterioration, cracking, erosion, corrosion, scaling and breakage from acids, chemicals, electrolysis and brittling from high temperatures.

Retractable Laser Nano Reactor—This reactor is included in the present invention. Chalcogel Filtration System—This reactor is included in the present invention. Hydroelectric Power System—This reactor is included in the present invention.

Waste Water Reactor—The waste water reactor system allows for all Matrix waste water streams to be purified internally without need for local sewer utility services.

Water Production Reactor—The water production reactor replaces the Matrix hookup to local water utility supplies easing demands on local residential and agricultural usage. In the advent of a local emergency or water shortage such as desert climates the Matrix would now be able to provide fresh water to area residents.

Nautilus Growing Chamber and Reactor Packing System—The reactor packing system invention has been designed as an advanced technology replacement, upgrade or retrofit for existing vapor/liquid separation processing reactors such as but not limited to: •Distillation reactors, towers, columns, •Fractionator reactors, towers, columns, •Coking, •Gas quench towers, •Vacuum towers, •Coker scrubbers, •Coker or Visbreaker fractionators, wash sections, Deodorizers, •FCC fractionators, and •Spray towers.

Traditional reactor packing systems use gravity systems with a slow condensation and down-comer drip network of stainless steel fabricated trays, sieves, weirs, bubble-caps, demisters and condensers and include: •Structured grid packing systems, •ceramic Raschig rings, •stainless steel pall rings, •ceramic saddles, •woven wire, •knitted wire, •expanded metal packing, •column internal liquid/vapor separating systems, •sieve tray, •bubble-cap tray, •fixed valve tray, •cartridge trays, •float valve trays, •configured trays, •Montz trays, •SEMV™ trays, •liquid distributors, collectors, limiters and feed devices

The Nautilus reactor packing system provides an accelerated separation processing cycle of gases and or super critical solutions and liquids. This invention optionally may include a network of high velocity dual flow capable air curtains to create capture zones or chambers, baffle plates, Nautilus shaped vapor collector ears, ultrasonic cavitation flash zones, chambers and packing materials. As an example, but without limitation, of an another proposed embodiment of the invention's packing system, is one that such packing be comprised of advanced materials that contain Chalcogel, in which the packing also performs separation and filtration.

The invention packing system has been utilized in the following invention reactors: the Distillation, the Atomizer, the Waste Water, the Hydro Reactor and the Flash Pyrolysis Reactors.

Growing Chambers: The Nautilus system can be divided into a network of interconnected growing/processing chambers that allow for a continuous flow yet allow independent/specialized treatments or functions to be performed within each chamber.

The growing chamber system is an integral technology utilized in the invention Nano Gatling Gun Reactor and is applicable for use with a multitude of advanced composite applications including the integrating of; Nano, supercritical production of Chalcogels, advanced plastics, ceramics, carbon and carbon fibers, graphite, powdered metals, rare earths and foam metals to name a few.

The chambers are constructed in various diameters, lengths, shapes and configurations such as vertical, horizontal, tilt, spiral or coiled walled tubes. Within the chambers various independent processing technologies can be utilized such as thermal microwave, infrared, flash flame, cavitation, steam, cryogenic, ultrasonic or the like. Direct or indirect contact with the processing materials is possible through lined chambers that allow for roasting, sintering, magnetification or calcination.

Chambers can include access doors which allow for pre-fabricated substrates to be inserted for coating, plating, supercritical drying, curing, layering, treating, and catalyst or solution injection or for substrate timely removal from further processing steps.

The Nautilus growing chamber has been designed and utilized in conjunction with a cyclonic high velocity processing system for the Nano Gatling Gun and the Hydro Reactors.

Vaporized Metals Extraction—Chalcogel or other vacuum filters can be mounted to exterior reactor walls with internal reactor filtration extraction ports. The extraction ports are located at various ascending temperature levels within the reactor so it allows for precision extraction of vaporized metals at their precise boiling points within a high velocity atmosphere controlled environment.

The process is aided by angle mounting Nautilus shaped vapor collector blades just above each exit port to boost extraction efficiency. High velocity air foil curtains, ultrasound, microwave, infrared and baffle plates assist in controlling processing vapor flows within the reactor.

The blades can be of various lengths and mounting angles on the reactor walls to allow vortex flows to slow just enough for metals and other steam poisoning contaminants to be extracted. Blades can be constructed of stainless steel, advanced composites, carbon fibers, graphite composites and other materials tailored to processing environments, feeds, temperatures and atmospheres.

### Cell 1: Receiving Storing, Dispensing and Routing Module

Now turning to FIG. 1A, Cell 1 is the receiving and distribution plant which serves as an inbound feedstock quality control, sorting and disbursement hub to the entire system. Inbound feedstocks include coal, crude oil, spent whole or pre-shredded tires, carbon black, spent batteries, spent oil and ancillary operational supplies.

Inbound feedstocks arrive via crude oil pipeline, tanker truck, rail tanker car, ocean oil tanker or container ship for onsite offloading such as for example via Cell 28, or directly into Cell 1. Crude and waste oil are piped into separate storage tanks within the tank farm to await refinery distribution. Whole and shredded tires are forwarded to the tire plant where they are dump feed into the hammer mill hoppers for initial shredding and further reduction.

Cell 1 can include a receiving, storing, dispensing and routing module 100. The receiving, storing, dispensing and routing module 100 is configured to receive coal and external recyclables (spent oil, used oil, spent oil filters, used expired tires and spent batteries, pre-generated pyrolyic black oil, external renewable waste lube oils (industrial, automotive, military, commercial), and crude oils (light, heavy, tar sands and shale oil). Further, shredded tires and rubber materials can be received in this module. The present invention also includes the processing of alkaline, fuel cells, nickel hydride and lithium batteries in addition to lead storage batteries.

The receiving and routing process can include a number of storage tanks, tank farms 101, bins, silos and bunkers, and the like to hold the feedstocks from which the feedstocks can be routed from storage to various modules of the present matrix module system for pretreatment de-poisoning, purification or processing.

The present invention further includes the processing of alkaline, nickel hydride, fuel Cell and lithium batteries in addition to lead storage batteries and, hence, the receiving and routing module 100 can receive inbound feedstock such as, for example, lead acid, alkaline, nickel hydride, fuel Cells and/or lithium batteries, spent tires, carbon black, crumb rubber and coal.

Materials which can be produced from the batteries can include, for example, lead, acid, sulfur, polypropylene, rubber, nickel, lithium and others while spent oil, fuel Cells and tires can be pretreated to provide useful products as well as materials to be sent to the refinery (Cell 6) to be processed along with crude oil to provide petroleum refinery end-products at reduced cost.

The domestic and foreign sources of feed-stock material for this EFSMP include used oil, lubricants, electrical transformer oils, hydraulic fluids, batteries, tires and such—which could be sourced from industrial sources such as military vessels, cargo ships, marine vessels, recreational vessels and vehicles, merchant vessels, cruise ships, airlines, airports, trains, fleet operations for commercial, utility companies, industrial and non-commercial vehicles, the government (local, state, national, and federal), etc. Additional collection of bulk material could also be from local and chain retailers, e.g., Pep Boys, Jiffy Lube, Luke Oil Service Stations, Goodyear, Sears, Costco, Harley Davidson, military motor pools/naval shipyards, etc., with such collection of materials being legislated, contracted, franchised, outsourced, or owned by the refinery operation or related company/entity.

The waste materials which are received and collected in this module 100 are subsequently pretreated and broken down into useful components which can be recycled via different, and separate, technologies and methods—and these methods can be centrally located for inclusion into a new ecologically and environmentally responsible Super Refinery accessing raw feedstocks directly from the market and returning the recycled, reconstituted products directly back into the consuming market as a renewable energy cycled system. Foreign sourced feedstocks serve as backup resources and are designed to annually add to the amount of local energy resources in such volume as to stay in synch with market growth demands as a closed looped recycling system of clean energy.

Batteries, which are picked up in an exchange program that State, Local, and Federal laws require, are generally cannibalized by the larger battery companies, such as, for example, Johnson Controls. When the spent batteries are not exchanged, there is a fee that is collected. However, this does not account for the large problem of illegal dumping of batteries (within the United States, and outside of the United States—ex: Latin America, Europe, Asia, etc.). Additionally, a problem associated with batteries is what to do with the spent electrolyte acid and lead. There are healthy secondary and tertiary markets for different varieties and grades of lead and acid. These problems are addressed and solved by the matrix system of the present invention.

This embodiment also includes a Cell 1B; this cell includes a pre-atomization method and system. Specifically, materials, from a generator, internal, external, or in situ, without limitation defined as also known as, and defined in the present invention as any person or business entity who acquires materials through personal use or in the ordinary course of business, wherein without limitation such materials are also defined as post consumer materials, pre consumer materials, and the like. Such materials are normally source-separated, at geographical locations, but not limited to such, in which such materials no longer have value for which they were originally intended (as is also the case with used oil, tires and other hydrocarbon/petrochemical feedstocks), but can have potential reuse value as a raw material in new product applications, and can also be known as a commodity, and without limitation be defined as any material, regardless of form, as rubber,

steel, metal, aluminum, auto parts, glass, liquid, solid, plasma, gas, spent fuel, spent carbon, earth, silicates, building debris, rubber, plastic, organic, inorganic, manmade, and natural material, and the like in which such materials can be used for Resource Recovery, as defined in the present invention as a term used to describe the extraction of usable materials or energy from discarded products, are received in Cell 1, from a Hauler, defined without limitation as any person, persons, firms, company, enterprise, corporations or governmental agencies responsible (under oral or written contract or otherwise), or independent of, but for commercial or charitable gain and favor, for the collection of any material, or scrap, within a geographic boundary of the contract community(ies), and the transportation of such materials to sorting stations, recycling centers or end markets into Cell 1.

Whereas, and without limitation, such geographic locations, albeit mobile, terrestrial, oceanic, and the like can either be singularly a multi-use aggregate center or monofill center, or any combination thereof, where a monofill is generally described and defined as a single use landfill or landfill cell used for homogeneous material storage whether permanent or temporary.

In addition, such material can be received for handling and processing by and for such methods, without limitation, as Conversion, Transformation, Reuse, and or Recycling, either in a single process or in combination, or in multiple processes and/or combinations.

Moreover, such apparatus as a Hammermill, crackermill, micromill, shredder, shear shredder, granulator, and the like are used, in tandem, singularly, in tandem, parallel, in combination, but are not limited to such devices to be used as such, and can any configuration or individual apparatuses as the user so requires, and whereas, without limitation such preferred embodiment is a Hammermill, and all apparatuses are defined heretofore as a such, in which such equipment is used for shredding, impacting, and/or pulverizing material into fine particles raw materials, post-consumer materials, and the like, for various applications including preconditioning for refining applications, pre-atomization, and the like, in which the materials are hammered by a series of steel hammers. In this embodiment, the pulverized material exits through a screen plate with apertures to reduce the materials to a specific particle size, as desired by the user, though without limitation such material may be irregularly or regularly shaped.

Further, in this embodiment, after the material is processed through the Hammermill, the material is moved, conveyed, pulled, fed, pushed, and the like through a screen, sieve, or mesh, and the like, without limitation whereas the screen is defined as a large sieve of suitably mounted wire cloth, grate bars or perforated sheet used to separate materials by size. The segment or sections of screen may, and without limitation, be in combination, or sequence with other screens with finer mesh, or holes, and whereas the finer the screen, the more openings it will have per linear inch (e.g. 30 mesh means there are 30 holes or openings per linear inch). The greater number of openings, the smaller the material must be to pass through the screen. Such is also defined as Gradation, without limitation, and can be expressed in terms of total percent of material passing or retained. The percent passing indicates the total percent of material that will pass each given sieve size. The total percent retained is the opposite of percent passing or the total percent passing each given sieve.

Where necessary, based upon user demand, handling of the material may also be augmented, either singularly, in tandem, or in combination with such devices as a Trommel, whereas the Trommel, without limitation, is defined as a revolving cylindrical screen used for separating mixtures or materials into their constituents according to size and density (also referred to as a trommel screen).

Such screens can be magnetized, whereas magnetism is defined in the present invention as paramagnetism, ferromagnetism, anti-ferromagnetism, diamagnetism, magnetism, and the like, and in any combination thereof, so that material can be separated and sent to a trap for handling in an atomizer. In the event that the material does not need to be crushed, and whereas such material is in an effluent state, like lubricants, petroleum, sewage, and the like, the previous steps may be skipped, and the material can go directly into a cyclonic, and or venturi apparatuses for separation, powderization, and pre-atomization.

Smaller particles, materials, and the like, that have not been separated, can further be processed in cyclonic, and or venturi type apparatuses, in a closed loop system, where water, moisture, and liquid contaminants is sent for waste water treatment, and the remaining material is handled as described in, and included in their entirety by reference herein, U.S. Pat. No. 6,971,594, Apparatus and Method for Circular Vortex Air Flow Material Grinding; U.S. Pat. No. 7,736,409, Cyclone Processing System with Vortex Initiator; and U.S. Pat. No. 7,441,716, Aluminum Recovering Dry System and Process without limitation, and is further described as a dry processing system for processing materials containing products and producing reusable particles of ferrous and non-ferrous material, comprising: a magnetic separator arrangement for separating the powdered, pulverized, dust-like material that coming from the pre-crushing unit/s into ferrous and non-ferrous material; whereas there is a vertical (without limitation to, but is user defined) granulator unit having a lower inlet for receiving the material from a feeder unit, an upper outlet, and a granulation chamber between the inlet and the outlet; a means for producing a controlled upward airflow in the granulation chamber drawing those of the particles exceeding a predetermined granulation degree out through the outlet of the vertical granulator unit; a sifter unit for classifying the particles coming from the vertical granulator unit as a function of their sizes; and a separator arrangement for separating the particles classified by the sifter as a function of their weight, magnetic property or magnetic manipulation, the separator arrangement having a first outlet arrangement for releasing the spheroidal particles of material and a second outlet arrangement for releasing residues formed by the other particles, the spheroidal particles of material forming reusable particles of material.

Furthermore, the system wherein the pervious material was crushed by the pre-crusher, the hammer mill unit and the like have sizes in a range of about 1.25 cm. times 1.25 cm. and a thickness of less than about 0.3 mm, and whereas the crushed material has sizes in a range of about 0.63 cm.times.0.63 cm to 1.25 cm.times.1.25 cm, and the particles produced by the granulator, and the like, have sizes in a range of about 0.1 mm to 2.5 mm. Additionally, magnets are utilized, like rare earth magnets, but are not limited to such, wherein the magnetic separator arrangement comprises a conveyor extending between the pre-crusher unit and the crusher unit, and a magnet unit extending over the conveyor for extracting materials that are being transported by the conveyor, and where the magnetic separator arrangement comprises a container extending under the conveyor and the magnet unit for collecting the material.

Furthermore, the cyclonic system has the means for producing a controlled upward airflow in the granulation chamber that comprises a cyclonic arrangement coupled between the outlet of the vertical granulator unit and the sifter unit for transportation of the particles, material, and like. The configuration of steps, is not limited to a specific sequence, and can comprise a cyclone coupled between a vertical granulator unit and the sifter unit, screen unit, sieve unit, and the like, and whereas the cyclone section has an inlet for receiving the particles and material drawn from the vertical granulator unit, and a lower outlet for delivering the particles to the sifter unit.

The cyclonic system and configuration can also, at the user defined specifications include a dust filtering, a magnetic dust filtering, and sieve type, or any combination thereof, in tandem, parallel, or in array and the like, in an arrangement for collecting and separating dust particles among the particles transported from the vertical granulator unit, and releasing filtered air, and then having at least one pneumatic conveyor means coupled between the crusher unit and the feeder unit for transportation of the material, where such pneumatic conveyor means comprises a cyclonic arrangement coupled between the crusher unit and the feeder unit, so that the cyclonic arrangement comprises a dust filtering arrangement, and the like, for collecting and separating dust particles among the materials being transported from the crusher unit, and releasing filtered air.

The mill, as described earlier, also, and without limitation has a conveyor for transporting the material to the lower inlet of the vertical granulator unit; and a transfer bin having an upper inlet for receiving the material from the crusher unit, a lower outlet for delivering the material onto the conveyor, and an adjustable gating member for controlling a thickness of the material fed to the vertical granulator by the conveyor. Additionally the granulator unit has a rotor and a stator about which the rotor turns, a space between the rotor and the stator defining the granulation chamber, the stator having a cylindrical stationary crenelated surface facing the rotor, the rotor having a cylindrical rotating surface facing the stator provided with laterally shifted rows of circumferentially distributed cutting blades extending above one another, whereas the cutting blades of the rows form slanted blade arrangements projecting from the rotating surface with respect to a vertical direction of the vertical granulator unit, of which is without limitation. In another configuration of the blade arrangement, such can also be slanted at an angle of about 15 degree with respect to the vertical direction of the vertical granulator unit, regardless of the amount of blades, and whereas the blades of a number of the rows extend at a closer distance from the crenelated surface than the cutting blades of other ones of the rows.

The blades of the apparatuses or cyclonic apparatus can consist of rows with cutting blades extending at a closer distance from the stationary surface comprise uppermost ones of the rows, where, without limitation, the distance of the cutting blades from the crenelated surface varies in a range of about 0.15 cm to 0.8 cm. Furthermore, and without limitation, the cutting blades have cutting edges extending substantially in a vertical direction of the vertical granulator unit.

Where necessary, based upon user configuration, the screening section of the sieve, screen, and the like has a vibrating sifting stage per classified range of the particles, and an outlet arrangement for separately delivering each classified range of the particles, where such sifting mechanisms can be either magnetized or not, depending upon the predetermined optimum function of such equipment, and whereas the sifter unit comprises an outlet for delivering powders and material resulting from sifting.

Additionally, the present embodiment may contain, without limitation a separator arrangement which comprises a separator unit per range of particles classified by the sifter, each separator unit having a tilt table and first and second outlets extending on opposite sides of the tilt table, the first and second outlet arrangements of the separator arrangement being respectively formed of the first and second outlets of each separator unit, and whereas there is a cyclonic separating and dust filtering arrangement coupled to the separator arrangement, for collecting and separating airborne particles and dust particles among the particles processed by the separator arrangement, and releasing filtered air.

In the embodiment in the present invention, the definition of Magnet, Magnetic Separation, Magnetic processing, and the like also include in its/their entirety by reference herein, U.S. Pat. No. 3,951,784, and U.S. Pat. No. 10,821,392 utilizing ultrasonic and magnetic separation, the embodiment in the present invention, comprises, without limitation a method for producing ferrotungsten-containing articles, in so much as the method involves providing ferrotungsten-containing powder comprising magnetic and non-magnetic particles; and exposing the ferrotungsten-containing powder to a magnetic source to separate the ferrotungsten-containing powder into at least a magnetic fraction and a non-magnetic fraction; and producing an article from at least a portion of the non-magnetic fraction. Furthermore, the material produced includes removing at least a portion of particles having a size smaller than a selected particle threshold, so that the material has been manipulated to principles similar to, but not limited to, powder metallurgy. The material is then sent for further screening and separation, of which are then sent to atomization for further manipulation.

Some example materials that Cell 1B can recycle are: motor vehicles, buildings, airplanes, construction debris, radioactive material, municipal sewage streams, organics, fertilizers, earth, rare earth remediation from auto parts, precious metals, etc.

In addition, the hydrocarbons and the like without limitation that are processed become carbon black material and sent to the appropriate cell for processing (related to the pre-pyrolysis for pyrolyic oil or to the shipping cell for established markets.

### An Additional Embodiment for Cell 1B—Pre-Atomization

Materials, from a Generator, internal, external, or in situ, without limitation defined as also known as, and defined in the present invention as any person or business entity who acquires materials through personal use or in the ordinary course of business, where without limitation such materials are also defined as post consumer materials, pre consumer materials, and the like.

Such materials are normally source-separated, at geographical locations, but not limited to such, in which such materials no longer have value for which they were originally intended, but can have potential reuse value as a raw material in new product applications, and can also be known as a commodity, and without limitation be defined as any material, regardless of form, as rubber, steel, metal, aluminum, auto parts, glass, liquid, solid, plasma, gas, spent fuel, spent carbon, earth, silicates, building debris, rubber, plastic, organic, inorganic, manmade, and natural material, and the like in which such materials can be used for Resource Recovery, as defined in the present invention as a term used to describe the extraction of usable materials or energy from discarded products, are received in Cell 1, from a Hauler, defined without limitation as any person, persons, firms, company, enterprise, corporations or governmental agencies responsible (under oral or written contract or otherwise), or independent of, but for commercial or charitable gain and favor, for the collection of any material, or scrap, within a geographic boundary of the contract community(ies), and the transportation of such materials to sorting stations, recycling centers or end markets into Cell 1.

Whereas, and without limitation, such geographic locations, albeit mobile, terrestrial, oceanic, and the like can either be singularly a multi-use aggregate center or monofill center, or any combination thereof, where a monofill is generally described and defined as a single use landfill or landfill cell used for homogeneous material storage.

Where such material is received for handling and processing by and for such methods, without limitation, as Conversion, Transformation, Reuse, and or Recycling, can be in either in a single process or in combination.

Where such apparatuses as a Hammermill, crackermill, micromill, shredder, shear shredder, granulator, and the like are used, in tandem, singularly, in tandem, parallel, in combination, but are not limited to such devices to be used as such, and can any configuration or individual apparatuses as the user so requires, and whereas, without limitation such preferred embodiment is a Hammermill, and all apparatuses are defined heretofore as a such, in which such equipment is used for shredding, impacting, and/or pulverizing material into fine particles raw materials, post-consumer materials, and the like, for various applications including preconditioning for refining applications, pre-atomization, and the like, in which the materials are hammered by a series of steel hammers. The pulverized material exits through a screen plate with apertures to reduce the materials to a specific particle size, as desired by the user, though without limitation such material may be irregularly or regularly shaped. After the material is processed through the Hammermill, the material is moved, conveyed, pulled, fed, pushed, and the like through a screen, sieve, or mesh, and the like, without limitation whereas the screen is defined as a large sieve of suitably mounted wire cloth, grate bars or perforated sheet used to separate materials by size. The segment or sections of screen may, and without limitation, be in combination, or sequence with other screens with finer mesh, or holes, and whereas the finer the screen, the more openings it will have per linear inch, i.e., 30 mesh means there are 30 holes or openings per linear inch. The greater number of openings, the smaller the material must be to pass through the screen. Such is also defined as Gradation, without limitation, and can be expressed in terms of total percent of material passing or retained. The percent passing indicates the total percent of material that will pass each given sieve size. The total percent retained is the opposite of percent passing or the total percent passing each given sieve.

Where necessary, based upon user demand, handling of the material may also be augmented, either singularly, in tandem, or in combination with such devices as a Trommel, whereas the Trommel, without limitation is defined as a revolving cylindrical screen used for separating mixtures or materials into their constituents according to size and density (also referred to as a trommel screen).

Such screens can be magnetized, whereas magnetism is defined in the present invention as paramagnetism, ferromagnetism, anti-ferromagnetism, diamagnetism, magnetism, and the like, and in any combination thereof, so that material can be separated and sent to a trap for handling in an atomizer. In the event that the material does not need to be crushed, and whereas such material is in an effluent state, like lubricants, petroleum, sewage, and the like, the previous steps may be skipped, and the material can go directly into a cyclonic, and or venturi apparatuses for separation, powderization, and pre-atomization.

Smaller particles, materials, and the like, that have not been separated, can further be process in cyclonic, and or venturi type apparatuses, in a closed loop system, where water, moisture, and liquid contaminants is sent for waste water treatment, and the remaining material is handled as described in, and included in their entirety by reference in the present invention as Windhexe—U.S. Pat. No. 6,971,594 Apparatus and method for circular vortex air flow material grinding, U.S. Pat. No. 7,736,409 Cyclone processing system with vortex initiator, and U.S. Pat. No. 7,441,716 Aluminum recovering dry system and process without limitation, and is further described as a dry processing system for processing materials containing products and producing reusable particles of ferrous and non-ferrous material, comprising: a magnetic separator arrangement for separating the powdered, pulverized, dust-like material that coming from the pre-crushing unit/s into ferrous and non-ferrous material; whereas there is a vertical (without limitation to, but is user defined) granulator unit having a lower inlet for receiving the material from a feeder unit, an upper outlet, and a granulation chamber between the inlet and the outlet; a means for producing a controlled upward airflow in the granulation chamber drawing those of the particles exceeding a predetermined granulation degree out through the outlet of the vertical granulator unit; a sifter unit for classifying the particles coming from the vertical granulator unit as a function of their sizes; and a separator arrangement for separating the particles classified by the sifter as a function of their weight, magnetic property or magnetic manipulation, the separator arrangement having a first outlet arrangement for releasing the spheroidal particles of material and a second outlet arrangement for releasing residues formed by the other particles, the spheroidal particles of material forming reusable particles of material.

Furthermore the system where the pervious material was crushed by the pre-crusher, the hammer mill unit and the like have sizes in a range of about 1.25 cm.times.1.25 cm and a thickness of less than about 0.3 mm, and whereas the crushed material has sizes in a range of about 0.63 cm.times.0.63 cm to 1.25 cm.times.1.25 cm, and the particles produced by the granulator, and the like, have sizes in a range of about 0.1 mm to 2.5 mm. Additionally, magnets are utilized, like rare earth magnets, but are not limited to such, where the magnetic separator arrangement comprises a conveyor extending between the pre-crusher unit and the crusher unit, and a magnet unit extending over the conveyor for extracting materials that are being transported by the conveyor, and where the magnetic separator arrangement comprises a container extending under the conveyor and the magnet unit for collecting the material.

Furthermore, the cyclonic system has the means for producing a controlled upward airflow in the granulation chamber that comprises a cyclonic arrangement coupled between the outlet of the vertical granulator unit and the sifter unit for transportation of the particles, material, and like. The configuration of steps, is not limited to a specific sequence, and can comprise a cyclone coupled between a vertical granulator unit and the sifter unit, screen unit, sieve unit, and the like, and whereas the cyclone section has an inlet for receiving the particles and material drawn from the vertical granulator unit, and a lower outlet for delivering the particles to the sifter unit.

The cyclonic system and configuration can also, at the user defined specifications include a dust filtering, a magnetic dust filtering, and sieve type, or any combination thereof, in tandem, parallel, or in array and the like, in an arrangement for collecting and separating dust particles among the particles transported from the vertical granulator unit, and releasing filtered air, and then having at least one pneumatic conveyor means coupled between the crusher unit and the feeder unit for transportation of the material, where such pneumatic conveyor means comprises a cyclonic arrangement coupled between the crusher unit and the feeder unit, so that the cyclonic arrangement comprises a dust filtering arrangement, and the like, for collecting and separating dust particles among the materials being transported from the crusher unit, and releasing filtered air.

The mill, as described earlier, also, and without limitation has a conveyor for transporting the material to the lower inlet of the vertical granulator unit; and a transfer bin having an upper inlet for receiving the material from the crusher unit, a lower outlet for delivering the material onto the conveyor, and an adjustable gating member for controlling a thickness of the material fed to the vertical granulator by the conveyor. Additionally the granulator unit has a rotor and a stator about which the rotor turns, a space between the rotor and the stator defining the granulation chamber, the stator having a cylindrical stationary crenelated surface facing the rotor, the rotor having a cylindrical rotating surface facing the stator provided with laterally shifted rows of circumferentially distributed cutting blades extending above one another, whereas the cutting blades of the rows form slanted blade arrangements projecting from the rotating surface with respect to a vertical direction of the vertical granulator unit, of which is without limitation. In another configuration of the blade arrangement, such can also be slanted at an angle of about 15 degrees with respect to the vertical direction of the vertical granulator unit, regardless of the amount of blades, and whereas the blades of a number of the rows extend at a closer distance from the crenelated surface than the cutting blades of other ones of the rows.

The blades of the apparatuses or cyclonic apparatus can consist of rows with cutting blades extending at a closer distance from the stationary surface comprise uppermost ones of the rows, where, without limitation, the distance of the cutting blades from the crenelated surface varies in a range of about 0.15 cm to 0.8 cm. Furthermore, and without limitation, the cutting blades have cutting edges extending substantially in a vertical direction of the vertical granulator unit.

Where necessary, based upon user configuration, the screening section of the sieve, screen, and the like has a vibrating sifting stage per classified range of the particles, and an outlet arrangement for separately delivering each classified range of the particles, where such sifting mechanisms can be either magnetized or not, depending upon the predetermined optimum function of such equipment, and whereas the sifter unit comprises an outlet for delivering powders and material resulting from sifting.

Additionally, the may contain, without limitation a separator arrangement which comprises a separator unit per range of particles classified by the sifter, each separator unit having a tilt table and first and second outlets extending on opposite sides of the tilt table, the first and second outlet arrangements of the separator arrangement being respectively formed of the first and second outlets of each separator unit, and whereas there is a cyclonic separating and dust filtering arrangement coupled to the separator arrangement, for collecting and separating airborne particles and dust particles among the particles processed by the separator arrangement, and releasing filtered air.

In the embodiment in the present invention, we propose that the definition of Magnet, Magnetic Separation, Magnetic processing, and the like also include in its/their entirety by reference in the present invention, U.S. Pat. No. 3,951,784, and U.S. patent Ser. No. 10/821,392 utilizing ultrasonic and magnetic separation, where the embodiment in the present invention, comprises, without limitation a method for producing ferrotungsten-containing articles, in so much as the method involves providing ferrotungsten-containing powder comprising magnetic and non-magnetic particles; and exposing the ferrotungsten-containing powder to a magnetic source to separate the ferrotungsten-containing powder into at least a magnetic fraction and a non-magnetic fraction; and producing an article from at least a portion of the non-magnetic fraction. Furthermore, the material produced includes removing at least a portion of particles having a size smaller than a selected particle threshold, so that the material has been manipulated to principles similar to, but not limited to, powder metallurgy.

The material is then sent for further screening and separation, of which are then sent to atomization for further manipulation.

### Cell 2: Tire Plants

The tire plant module of the present Super Reactor pre-processing system encompasses processes for cleaning the used tires (for example by water wash or ultrasonic cleaning), reduction of the used tires by, for example heavy shredder, ball or jet milling or chemical reduction, separation of various components of the reduced used tires by, for example, an electromagnetic steel separator and wire screener for the rubber reduction and providing for processing uniformity of the cleaned and reduced materials.

Today, there are hundreds of millions of tires that litter the globe, with several sources claiming that there are approximately between 270 Million—290 Million of waste tires that are disposed of every year, in the United States alone. Most are left as landfill, while some are broken down, shredded, and used for creating oils, gases, carbon black, mulch, and additives for numerous, products such as asphalt, acoustical products, rail ties and buffers, barriers, flooring, airfield runways, carpet padding, packaging, insulation and numerous others.

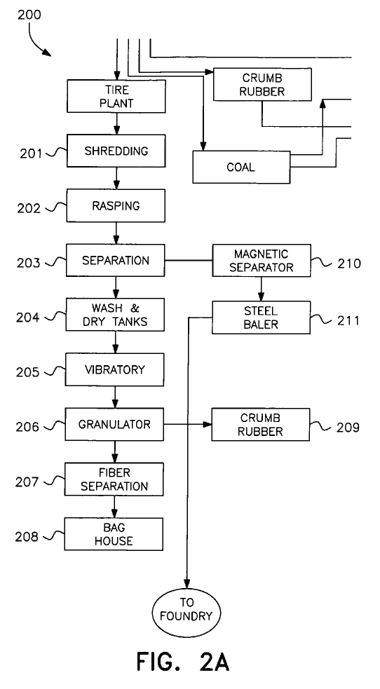

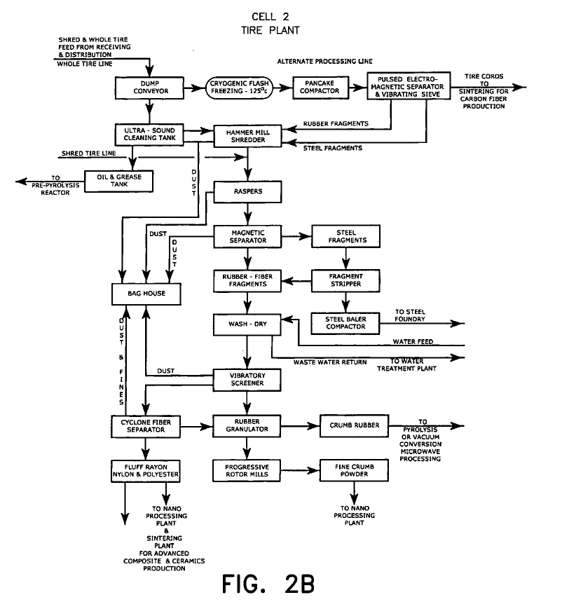

Now turning to FIG. 2A, Cell 2 comprises a tire plant 200 which generally processes tires by shredding, rasping, granulation, and separation to form small particle-sized (micronized) rubber material for further pre-processing as well as the collection of other by-products including, for example, steel and shredded cord fluff. The tire plant module can also include a shredding element 201 which can be a mechanical, chemical and/or cryogenic shredding process element and can comprise, for example, a hammer mill initial shredding reduction process. This Cell also comprises a secondary rasping process 202, a separation process 203, wash and dry tanks 204, a vibratory process 205, a granulator 206 such as a final ball mill or jet mill Micronizing process, a fiber cord separation process, a steel belt and bead fragment separation process, 207 and a contained vacuum exhaust capture and extraction system linked to a receiving bag house with Chalcogel X-Aerogel filtration and or electrostatic precipitator assist to capture and recycle fugitive acid vapors, dust and dirt particles 208 for the initial pre-processing of the waste tires and battery cases. The separation process 203 can include, for example, a magnetic separator 210 configured to separate steel belt fragments from the rasped tire. The separated steel from the wasted tires can be supplied through a steel baler 211 to a steel foundry to produce useful steel products. Through these processes, the tire plant can produce crumb rubber 209 which can be supplied to a pre-pyrolysis reduction, mix, purification, de-poisoning and treatment plant 400 then piped to the pyrolysis plant for further processing into pyrolyic oil, carbon black or syngas for energy production. The pyrolysis plant unit can be a standard pyrolysis unit, a solvent and catalytic extraction process utilizing propane, butane, hexane, heptanes and others or can comprise a novel pyrolysis super reactor process which will be described below.

The shredded, and or micronized tires and battery cases and crumb rubber materials can be loaded into a storage hopper (not shown in FIG. 2A). The hopper then automatically fills the conveyor system, upon which each hopper then feeds the materials into bins for measured front-end or top loading into a horizontal, vertical, fixed or rotating atmospheric pressurized (can be autoclave steam pressurized for polarity) pre-treatment reactor which in a continuous operation further adds pulverized coal, surfactants and a liquid residuum blanket to create a final heavy non-explosive slurry mix. The pre-treatment reactor dries, vaporizes, deasphalts the residuum blanket and selectively de-poisons in exterior electromagnetically charged Chalcogel-X-aerogel filters operated in a vacuum flow-through, closed looped extraction system that directly draws the reactor vapors into the filters where each contaminant is individually separated, captured and contained for periodic filter replacement and recycle of (organics, trace metals, sulfur, oxygen, nitrogen, mutagenic substances, recoverable carbon soot forming pyrite, silicon, actinide fly ash minerals). The reactor mixes the slurry utilizing; an atmosphere of hydrogen or propane, steam or other individual or mixed gas, hydrocolloidal electrostatic interaction when steam or a colloid mill has been utilized, ultra-sonification separation and devulcanization assist, and electromagnetic vacuum extraction portals leading into individual Chalcogel X-Aerogel filters attached to the outer reactor walls. The depoisoned mix is thoroughly saturated by a central reactor Archimedes' screw and ultrasonic/sonication waves (and/or microwave, convection or other) emulating from the inner reactor walls. As the mix reaches the far end of the horizontal reactor it is vacuum pump forwarded into the pyrolysis reactor/s for flash pyrolysis. As discussed above, the crumb rubber is preferably processed in the tire plant 200. However, in accordance with another embodiment of the present invention, other methods can be employed, including those that do not require the step of shredding the tires, but can accommodate the whole tires and or plastic/rubber battery cases, fuel Cells and hydride battery cases comprised of metal, Nano, composites, fiberglass, ceramics and other like materials.

Spent tires (whole or broken, and/or used tires, factory terminated due to production line rejection, recalls or warranty returns and/or discarded tires, and/or expired tires are all defined in the present invention as spent tires) can be cryogenically, mechanically or chemically broken down, or dry-distillated in the tire plant 200. For example, direct dry distillation of tires by Fujikasui Engineering can be utilized in this tire plant 200. Also, the spent tire can be devulcanized in the tire plant 200. For example, Goodyear's devulcanization process can be utilized for the devulcanization of the spent tires.

Fluff, from tire cord separation, reduction and extraction, for example, can be a source of material that can be added to the nano tube production, depending upon user requirements, and system demands.

The metal tire belt and bead fragments separated from the tires and trace metals recovered from the slurry mix and or atomization can be sold on the open market in various forms including ferrous metal ingots, metal oxides, powders or granules and precious metals. The processed tire cord fibers (rayon, nylon, polyester “fluff”) such as those typically found in the tires can be usually sold to the textile industry at established exchanges for such commodities. Such fibers can also be used on-site in an EFSMP module that creates carbon fiber, ceramic and Nano composites and support reinforcement in ceramic bearings.

In the shredding process 201, the tires can be electrically charged with ions that simultaneously pre-clean the tires for processing where the rotors are constantly cleaned with a process and system of blowers, air jets, and the like, in any number of unspecific combinations.

The tire plant 200 can produce specialized feeds that can be used in processes for easy decomposition for recycling into tires, similar to that of Nynas, and incorporated in the present invention by reference (http://www.nynas.com/tyreoils/), as well as films and oils, and feeds used for purposes of self-decomposition such as biodegradation of film (e.g.; polypropylene and polyethylene) used in agricultural fields, mesh/netting, and other plastics, or for tires and other petrochemical feeds that are used for recycling. Additionally, the material can also be broken down via light and photonic and photolytic (light) exposure levels. Materials which can be produced from the tires include, for example, rubber, nylon, polyester, rayon and other chord fibers materials, and or their respective materials as also known collectively as “tire fluff.”

In another embodiment of the present invention, the tire plant 200 can include an apparatus for curing tires or similar vulcanized products, and their related slurry to be used in, or as feed stock, in a press or autoclave equipped with separable molds with inserted bladders, tubes, bags, or bladderless center mechanisms (this also inclusive of separate chambers in the pre-processing autoclave that has material moving from chamber to chamber, either in vacuum, by gravity, pressure or mechanical means). During the principal shaping and vulcanizing period, the bladder is first filled with steam, hydrogen, water, ammonia, synthetic ammonia, aqueous ammonia, anhydrous ammonia, and any other gas, to conform the bladder to its contents that begin the cure. The steam is then vacuum-flushed and replaced with water, or any other fluid, to continue pressure molding and curing of the contents. In the next phase of the curing cycle, inert gas at a high pressure can be introduced to force the water from the bladder, without vaporization or significant loss of heat, back to storage facilities for subsequent reuse. In the final phase of the shaping and curing cycle, the inert gas is evacuated from the bladder, and collected for reuse, by means of a vacuum tank or vacuum pump, if no cooling of the product is desired, or by the introduction of high pressure cold water for the final cooling and shaping period of the cycle, whereupon the water can be flushed and extracted from the bladder and the contents can be removed from the mold. By employing this process and the associated apparatus and system, the water is not mixed, with resultant loss of temperature, thereby yielding substantial energy savings without omitting or foreshortening the cold water cooling and shaping step necessary to insure tire quality and prevent deformation.

As another embodiment of the present invention, FIG. 2B shows a second tire plant 250. The second tire plant 250 can incorporate all of the processes and devices utilized in the first tire plant 200. As such, the same reference numerals and labels can be used in FIGS. 2A and 2B.

As shown in FIG. 2B, the second tire plant 250 can include a tire shredder 251 corresponding to the shredding process 201, a rasper 252 corresponding to the rasping process 202, a vibratory screener 254 corresponding to the vibratory process 205, and a cyclone fiber separator 256 corresponding to the fiber separation process 207.

In addition, the second tire plant 250 can include rubber-fiber fragments 253, progressive rotor mills 255, processed fluff rayon nylon and polyester 257, steel fragments 258, a fragment stripper 259 and fine crumb powder 260.

Compared to the first tire plant 200, the second tire plant 250 can have a different arrangement of the processes and devises. For example, the bag house 208 can be located such a way that it is connected to the rasper 252, the magnetic separator 210, the vibratory screener 254, and the cyclone fiber separator 256 such that dust and fines can be collected in the bag house 208 from such devices. Also, the cyclone fiber separator 256 is arranged between the vibratory screener 254 and the rubber granulator 206 such that it separates the rubber and the fluff rayon nylon and polyester 257 to be fed to the Nano plant 300 for further processing.

In the first tire plant 200 as shown in FIG. 2A, the separation process 203, the magnetic separator 210 and the steel baler 211 can be related to a separation process. In the second tire plant 250 as shown in FIG. 2B, the separation process is illustrated in detail such that the second tire plant 250 can include the magnetic separator 210, the rubber-fiber fragments 253, the steel fragments 258, the fragment stripper 259, and the steel baler compactor 211. As such, the rasped tire can be separated into the steel fragments 258 and the rubber-fiber fragments 253 being washed in the wash-dry tanks 204. The steel fragments 258 can be further separated into steel and rubber-fiber fragments 253 by the fragment stripper 259 and the separated steel will be fed to the steel foundry through the steel baler compactor 211.

Just as the first tire plant 200, the second tire plant can produce the crumb rubber 209 which can be used in a pyrolysis or vacuum conversion microwave processing. Additionally, the second tire plant 250 includes the progressive rotor mills configured to grind the rubber into micro-sized particles such that the second tire plant 250 can produce the fine crumb powder 260, which can be further supplied to the nano plant 300 to produce nano particles, advanced carbon fibers or ceramic composites and further processing into carbon black, pyrolyic oil, syngas, and or activated charcoal, activated and reactivated carbon, fillers and numerous others.

### Cell 3: Nano Plant

The present invention includes a Nano Plant 300 as shown in FIG. 3A. The nano plant 300 can be independent from the present matrix and system. However, in a preferred embodiment of the present invention, the nano plant 300 can be incorporated in the present matrix and system, being connected to, dependent from, and in conjunction with other processes and subsystems of the EFSMP.

FIG. 3B illustrates a flow chart for the Nano Plant 300 and a method for making nano products. In general, the nano plant module of the present matrix system and process uses materials from other Cells of the present matrix and system and transforms such materials via various elements of the nano plant to generate nano or Nano composite products.

As shown in FIG. 3B, the fluff rayon, nylon and polyester from the tire plant can be supplied to a cryogenic micro shear 301 where these materials are frozen to be broken down into micronized particles. The micronized particles such as micronized tire fluff 302 can be delivered to a chemical de-vulcanization blender or to a polymer blender for nano and/or nano composite reinforcement and/or cross layering with or without electromagnetic field alignment 303. Additionally, the fly ash additive 304 and either a graphite and/or nano-graphite additive can be optionally supplied to the chemical de-vulcanization blender 303.

In the Nano Plant, one single nano reactor having several chambers such as micronization chambers 305 and a vaporization chamber 306 can be utilized. Materials such as fine crumb rubber 307, carbon black 308, nano-graphite, cobalt, nickel, iron, metals, clays, tire fluff as described above, any materials extracted and/or produced on site, at each campus/facility, other materials that may be desired by the user, ceramics, 309 and the like can be supplied to the micronization chambers 305 to be micronized. The micronized materials can be supplied to a micronic rubber screen separator 310 where these materials can be screened to separate bigger particles before supplied to the chemical de-vulcanization blender 303. The bigger particles can be sent back to the micronization chambers 305 to be further chopped to micronized particles.

Additives which can be generated at other portions of the present system or matrix or from an external source such as liquid nitrogen, liquid polymer 311, fullerene soot 312, and diluted water solution 313 can be supplied to the chemical de-vulcanization blender 303 where all the materials can be de-vulcanized and mixed together.

The blended materials will be supplied to another cryogenic micro shear 314 where they are frozen to be chopped to micro particles. The chopped micro particles will be supplied to the vaporization chamber 306. A process gas 314 can be injected to the vaporization chamber 306 to create nano-water, and the like from the combining of various gasses The concept here is to be able to create nano fluids, and other compounds for pharmaceutical use, human consumption, medicines, chemicals, etc. using the nano process to create the advanced molecular structures, in nano form, to accomplish user defined requirements. Also, carbon gas 315 can be injected to the vaporization chamber 306 to make multi walled nano tubes (MWNT) 319. Alcohol, such as, for example, methanol or ethanol, iron 316, cobalt and zeolite particles 317 can be added to the vaporization chamber 306 to produce single-walled nano tubes (SWNT) 318.

Magnesium Oxide (MgO) or Aluminum Oxide (Al2O3) 320 can be added to the vaporization chamber 306 as a strengthening agent. Electric field alignment 321 can be applied to the vaporization chamber 306 to create a magnetic field to lead the nano particles in one direction. The multi walled nano tubes 319 can be supplied for another processing.

The temperature range of the nano reactor required to make various nano products varies according to the physical properties of the materials used to form the nano products and determination of optimum temperatures for any specific material or materials can be readily determined by artisan familiar with this art area. It is noted that various atmospheres and feed injections may be used in conjunction with the temperature range.

For example, a range of ambient temperature to about 600 degrees Celsius is the most common temperature reaction range utilized in the nano reactor. However, the particular temperatures used can be calculated by the skilled artisan depending upon the utility. Liquid polymers 311 can be thermal-settled at 250 degrees Celsius and solidify. The solidified polymers can be cross-linked at 400 degrees Celsius under isostatic pressure, which can be sent to pyrolysis for 1,000 degrees Celsius ceramic conversion. A silicon based product can be manufactured at 600 degrees Celsius to be allowed for its softening. A mid-range temperature from 800 degrees Celsius to 1,500 degrees Celsius can be utilized for pyrolysis. A high temperature range between 1,700 degrees Celsius and 2,100 degrees Celsius can be utilized for sintering and conventional and advanced Nano/non-oxide ceramic powder processing. Carbon manufacture can require an ultra-high temperature range up to degrees Celsius. In another embodiment of the present invention, the temperature range of the nano reactor can require 10,000 degrees Celsius to utilize this heat for the Metals breakdown and atomization such as for actinides, Molybdenum, and Carbon.

FIG. 3C shows a first nano reactor 330 utilized in the Nano Plant 300. The first nano reactor 330 can include an extending-retractable laser apparatus 331 connected to a spindle 332, a rotating electrode 333 connected to the spindle 332, a laser lens 334 in a cone shape, a plurality of adjustable nozzle 335, a cathode target 336, induction coils or infrared 337, a furnace zone 338, and a vacuum nano collector having a CO re-circulating pump and trap 339 and a water jacket 340.

The laser apparatus 331 can be a laser gun attachable to the spindle 333, the laser gun being extended from or retracted to the spindle 333. As an example, the laser gun can be a free electron laser which is able to generate ultra fast pulse[s]. The laser gun can also be other forms of optic cables, gem stones, semi-precious gem stones, synthetic gem stones, lenses, or optic transmission forms, and the like, as the state of the art advances. The ultra fast pulses generated from the free electron laser can be ˜400 fs (femtosecond) for example. As another example, the laser gun can be a continuous wave CO2 laser in an argon or nitrogen stream.

The rotating electrode 333 is connected to the spindle 332 such that it can rotate at 5,000 rpm for example. The rotating electrode 333 can be used as an anode (+) and a tip 341 of the rotating electrode faces the cathode (−) target 336. The tip 341 of the anode can be disposed at the tip of the cone of the laser lens 334. The rotating electrode 333 can be configured to penetrate the laser lens 334 and to rotate clockwise, while the laser lens 334 rotates counterclockwise to create turbulence and pressure compressing on a continual base at the tip of the laser lens 334 optimizing production output feed stock. Also, the vortex at the tip 341 of the anode can be adjustable by controlling the rotating speed of the rotating electrode 333 and the laser lens 334.

The plurality of adjustable nozzles 335 can be configured to inject gas or air in a high pressure into a chamber 342 located below the laser lens 334 through an inlet 343. In particular, these nozzles 335 can inject micron-size particle catalyst powders such as alcohol, iron, methanol, cobalt, ethanol, zeolite and the like into the chamber 342. Also, these nozzles 335 can inject gas such as ammonia, and hydrogen, and oxygen, for the production of nanowater, and/or nanotube water, into the chamber 342 for example.

The induction coils or infrared 337 can be configured to cool gradually the heated particles and located in contact with the furnace zone enclosing the chamber 342. For example, the temperature of the furnace zone can be 1150 degrees Celsius and the wall of the furnace zone can be made of Quartz tube and other thermal resistant materials.

The vacuum nano collector can include the CO re-circulating pump and trap 339, a water jacket 340, and an outlet 344. The vacuum nano collector can have two options, an upstream option and a downstream option. The downstream option means that the catalyst powders can be injected through the inlet 343 and the nano tubes can be collected in the outlet 344 of the vacuum nano collector. The upstream option means that the catalyst powders can be injected through the outlet 344 of the vacuum nano collector and the nano tubes can be collected in the inlet 343. The CO re-circulating pump and trap 339 can re-circulate plume and collect the nano tubes such that it is possible to generate no emission.

In case SWNTs (and MWNTs where and when required to produced) are produced by the first nano reactor 330, the size of the SWNTs ranges from 1-2 nm, for example the Ni/Co catalyst with a pulsed laser at 1470 degrees Celsius (however, this is not a limiting temperature, because temperature ranges can be different/adjusted/changed, depending on the type of nanomaterials is needed—ex: nanocomposites, etc.) can form SWNTs with a diameter of 1.3-1.4 nm. In case of a continuous laser at 1200 degrees Celsius (growing chamber temperature—this is a rapid cooling temperature, down to ambient if required) and Ni/Y catalyst, SWNTs with an average diameter of 1.4 nm can be formed with 20-30% yield.

FIG. 3D shows a second nano super reactor 350, which can be utilized in the Nano Plant 300. The second nano super reactor 350 can be positioned for top down, horizontal or bottom-up processing. The second nano super reactor 350 can include a vacuum or atmospheric pressure chamber 351 and non-condensable plasma gas feeds 352. The non-condensable plasma gas feeds 352 can feed process gases such as nitrogen, hydrogen, ammonia, and oxygen, and carbon containing gases such as argon, helium, propane, acetylene, ethylene, ethanol, and syngas individually and or as a mix.

The second nano super reactor 350 can include a computer controlled regulator 353 configured to control an amount of plasma feed streams. The plasma feed streams flow to a collision chamber 353, which causes a standard ionization reaction that prevents foam buildup as a result of the reaction, which is a common problem associated with reactors. The intention is to use it as an alternative option when applied to a vortex amplification chamber to glean its ionizing radiation nucleation effect in the growing chamber as a nano clustering assist, structuring synthesis, nano material modification, absorption spectrum increase of NaNO3 nano crystals, metallic ion nucleation to form nano clusters by irradiation assisted nucleation, neutron, gamma-ray radiation nano shield, and sterilization attribute to nano particles and polymer matrix. The sterilization can be adopted for military, aerospace, pharmaceutical, and medical uses.

The second nano super reactor 350 can include a heat amplifier 355, where the plasma gases can be pre-heated. The heat amplifier 355 is configured to heat the plasma gases by jet impingement heat transfer. The second nano reactor 350 can include central combustion head equalizer plasma jets 356 configured to balance vortex gas streams by accessing a central combustion head zone, to cool anode and cathode, and to provide the central combustion zone counter recoil force.

The second nano super reactor 350 can include intensifier or similar high intensity pumps 358 which function as high velocity vortex amplifiers within the vortex chambers. The intensifier pumps can generate synchronized counterclockwise or clockwise vortex flows and or cross stream flows (reverse “tornado” vortex) 357 (or multidirectional simultaneous flows).

The second nano reactor 350 can include a single, multiple or clustered plasma arc firing head operating as an electronic Gatling gun 359 having a head configured to fire plasma pulses. The Gatling gun (type equipment system) 359 can be a 10,000 rpm computer controlled rotational electric arc firing system, and can include 2 to 32 large diameter anode clusters with matched adjustable cathodes. The Gatling gun 359 can increase a temperature of a primary combustion zone up to 20,000 K. The head of the Gatling gun can be alternatively replaced with a laser or laser assisted chemical vapor deposition or other combustion head. The second nano reactor 350 can be utilized as an immersed process, e.g., immersion in liquid nitrogen, with combustion head modification similar to the hydroelectric head which also uses a Gatling gun rapid fire, alternating plasma combustion system. It is noted that one of ordinary skill in the art, as the state of the art advances further, can improve the Gatling gun 359 to use it for other gasses to be submerged in, and compounds or elements of the periodic chart that have been atomized and under pressure are gaseous, like Carbon (carbon dioxide, carbon monoxide, carbon, xenon, and the like).

The second nano super reactor 350 can include an open flame pyrolyic (or pyrolytic) processing chamber 361, in which the temperature range can be between 100 and 4000 degrees Celsius. The open flame pyrolytic processing chamber 361 can be provided with high pressure powder feed injectors, pulses or continuous flames 362. The high pressure powder feed injectors 362 can be nozzles configured for pyrolytic atomization, and can be disposed at a bottom, top or mixed position of the open flame pyrolyic processing chamber 361. The high pressure powder feed injectors 362 can spray powder, liquid or gas feedstock, from other Cells of the present system or process or from an external source, including polymers, catalysts, fullerenes, chemical dopants, carbon black, potassium permanganate, fillers, colloidal solutions, emulsions, particles, peptization, Chalcogel, Aerogel, X-Aerogel, solgel SEAgel, agate, gar, or colloidal formed substrates consisting of transition metals, iron, carbon fibers, pyrolyic carbon cobalt, zeolite, aluminum, advanced ceramics, clays, silica 1200-1500 degrees Celsius, graphene nano particles produced at 1100 degrees Celsius from silicon carbide, etc. The high pressure powder feed injectors 362 are also configured to spray powdered coal for heat or flame intensification, fullerenes for pyrolyic re-crystallization, steam, air, oxygen, and flame synthesis of SWNTs.

Further, the open flame pyrolyic processing chamber 361 can have a round, teardrop or square dimension and can be provided with a high pressure pyrolytic chamber plasma or fuel injector (and the like) 363 configured for atomization, which can be disposed at a bottom, top, side or multiple or mixed position of the open flame pyrolyic processing chamber 361. The second nano reactor 350 can include combustion zone electromagnetic fields 364 configured for polymerized metal magnetization for nano cross layered composites, plasma anisotropic magnetization, colloidal electrophoresis, nano tube synthesis and interface, and spin-polarization (and the like).

The second nano super reactor 350 can further include nano tube growing chambers 365 where SWNT and MWNT can be generated. The nano tube growing chambers 365 can be coiled chambers, spiral chambers, quartz tube chambers, or straight tube chambers. The nano growing chambers 365 can be provided with Nautilus shaped partial flow barriers to create individual sub-growing chambers within the growing chamber system which may individually include an Archimedes type screw cure apparatus or other mechanical apparatus which assist in controlled growing time cycle(s), injection ports 366, which are configured to inject materials including Aerogel, sol-gel, Chalcogel, X-Aerogel, SEAgel colloids and desired substrates and growing, forming and curing solutions. Additionally, the nano tube growing chamber 365 can include electromagnetic fields for layering and cross layering, controlled forming manipulation and quenching capabilities that speed processing cycle time, maintain exact curing time limits and or further allow for precision control of the forming process.

The open flame, or flash flame continuous feed pyrolytic processing chamber 361 can be surrounded by a heated and/or cryogenic reactor wall system 367, which is configured to precisely control the temperature of the chamber 361. The heated or cryogenic reactor wall system 367 can be vortex, pyrolytic and growing chamber walls using infrared, heated oil or steam jacket, microwave, cryogenic means, ultrasound, microsound, sound waves, ultrasonic, convection, ablation, induction coil, electron beam, etc., and is configured to control the temperature from ambient to 3500 degrees Celsius or above.

The second nano reactor can further include the secondary vortex accelerator or decelerator chamber 368 configured to control vortex force prior to the nano growing chambers 365, gas exit with Chalcogel recycle filtration 369, and nano collection, self-assembly and extraction chamber 371.

The method for making the nano products can include steps of providing a mixture having metal salts and a passivating solvent, and heating the mixture to a temperature above the melting point of the metal salts to form metal nano particles. The metal nano particles of a controlled size distribution can be dispersed in the passivating solvent along with the powdered oxide. The mixture of metal nano particles and powdered oxide can be then extracted from the passivating solvent and annealed under an inert atmosphere. Nano tubes can be grown by exposing the nano particles to a flow of a carbon precursor gas at a temperature in the vicinity of 680 to 900 degrees Celsius. Control over the size of the carbon nano tubes can be achieved in part by controlling the size of the metal nano particles in the growth catalyst.

The nano plant 300 can include a process for the spheroidization, densification and purification of powders through the combined action of plasma processing, and ultra-sound treatment of the plasma-processed powder. The ultra-sound treatment allows for the separation of the nano sized condensed powder, referred to as “soot,” from the plasma melted and partially vaporized powder. The process can also be used for the synthesis of nano powders through the partial vaporization of the feed material, followed by the rapid condensation of the formed vapor cloud giving rise to the formation of a fine aerosol of nano powder. In the latter case, the ultrasound treatment or high flux electron beam step serves in this case for the separation of the formed nano powder form the partially vaporized feed material. More specifically, the process for the purification of a material can include providing powder particles of the material including impurities; plasma heating and melting of the powder particles of the material and release of the impurities in vapor phase through a plasma stream, yielding molten particle droplets of the material mixed in the plasma stream and vaporized impurities; cooling of the molten particle droplets of the material mixed in the plasma stream with the vaporized impurities, yielding a mixture of purified powder particles of the material and soot; exposing the mixture of purified powder particles of the material and soot material to ultrasound vibrations in a sonification medium, yielding separated purified powder particles of the material and soot in the sonification medium; and recovering the purified powder particles of the material from the sonification medium and the soot. The plasma heating and melting of the powder particles of the material through a plasma stream can be achieved by injecting the powder particles in an inductively coupled radio frequency plasma stream using a carrier gas as disclosed, for example, in U.S. Pat. No. 7,572,315. As noted above, this patent and all citations and references made in this document are all expressly incorporated herein in their entirety by reference thereto.

The nano plant 300 can utilize Inductively Coupled Plasma (ICP), which is one of the most promising approaches in the production of a wide range of nano powders with tailored properties, either at laboratory, commercial, or industrial scales. At a sufficient high energy, solids can be melted to liquids and vaporized to form gases, which are ionized to generate plasma. Plasmas are partially ionized gases containing ions, electrons, atoms and molecules, all in local electrical neutrality. ICP can be generated through the electromagnetic coupling of the input electrical energy into the discharge medium. More specifically, radio frequency (RF) AC currents in a coil generate an oscillating magnetic field that couples to the partially ionized gas flowing through the coil (the discharge cavity), generating thereby a stable discharge. The coils can be comprised of Rare Earth Materials, to increase functionality. Under typical low power conditions (torch power <100 kW; oscillator frequency of ˜3 MHz), the discharge is found to present a diameter of ˜20-30 mm, while for high power industrial installation (torch power >100 kW; oscillator frequency of 200-400 kHz), the discharge volume can reach 50-100 mm in diameter by 200-600 mm long.

The ICP technology has unique features summarized as follow: no electrodes (consumable); high purity environment (absence of electrode erosion); axial injection of feedstock in the highest temperature zone of the plasma; rather long residence time within the hot gas stream (up to ˜500 ms, depending on the reactor design, in comparison to typically <1 ms in DC plasma unit); large-volume plasma; discharge in various types of atmospheres, namely inert, reducing, corrosive or oxidizing; rather high throughput. One of the main advantages of the ICP technology is the processing flexibility regarding the chemistry of the plasma gas. Indeed, the absence of electrodes can allow plasma generation not only under inert or reducing environments, but also under oxidizing atmosphere. Depending on the nature of the gas mixture injected in the discharge cavity and, more importantly, on the ionization potential of these gases, various torch performances can be obtained. The gas selection is thus found to depend essentially on chemical reactions to be promoted or avoided in the reactor.

The present invention also provides a method for producing single-wall carbon nano tubes. The method can include the steps of providing a plasma torch having a plasma tube with a plasma-discharging end; feeding an inert gas through the plasma tube to form a primary plasma; contacting a carbon-containing substance and a metal catalyst with the primary plasma at the plasma-discharging end of the plasma tube, to form a secondary plasma containing atoms or molecules of carbon and atoms of metal catalyst; and condensing the atoms or molecules of carbon and the atoms of metal catalyst to form single-wall carbon nano tubes as disclosed, for example, in U.S. Pat. No. 7,591,989.

In another embodiment of the present invention, a method for producing nanometer-sized particles such as nano-phased or nano-structured metals, semiconductors, compounds, and ceramics which are used in a wide range of industrial sectors, such as biomedical, micro-electronic, pharmaceutical, military, aerospace, energy conversion and secure, leak proof storage or transport of such materials as hydrogen and acids, radioactive materials and advanced strength for structural reinforcement. Conventional techniques for producing nanometer-sized particles share the severe drawback of extremely low production rates. These low production rates, resulting in high product costs, have severely hampered the widespread acceptance of nano-phased materials. There is a clear need for a method of preparing nanometer-sized powder materials at much higher production rates, volume, speeds and lower costs. The method can include twin-wire arc vapor deposition (AVD) processes which are capable of mass-producing a wide range of nano-scaled particles including metals, metal compounds, semiconductors, oxides, non-oxide ceramics, and composites. For example, an ADV process disclosed by NANOTEK Instruments, Inc., of Dayton, Ohio, in www.nanotekinstruments.com can be utilized, which is incorporated by reference. AVD processes also allow for concurrent surface treatment or individual particle encapsulation of nano materials during their formation procedures. The method is capable of synthesizing a nano-structured material, which can be a nano powder, nano-porous coating, or solid film of nanometer thickness or nano-scaled phases. The method can include steps of operating a twin-wire arc nozzle (comprising two wires and a working gas being controllably fed into a reaction chamber) to form an arc between two converging leading tips of the two wires to heat and melt (preferably vaporize) the starting material at the leading tips for providing a stream of liquid droplets (preferably vapor species); optionally operating a second high energy source for producing a vaporizing zone adjacent to the arc where the unvaporized droplets are vaporized to form vapor species; cooling the vapor species for forming the nano-structured material. The second high energy source can be a laser beam, electron beam, ion beam, flame, or arc plasma. The method may further include an additional step of introducing a stream of reactive gas into the reaction chamber to impinge upon and exothermically react with the vapor species to produce the nano-scaled clusters.

Advantages of the AVD method can be summarized as follows. A wide variety of nano-structured metals, alloys, metal compounds, semiconductors, and ceramic materials (including simple oxides and mixed oxides) can be readily produced using the present method. Any metal element can be vaporized to react with hydrogen, oxygen, carbon, nitrogen, chlorine, fluorine, boron, and sulfur to form, respectively, metal hydrides, oxides, carbides, nitrides, chlorides, fluorides, borides, and sulfides. Further, the wire material can contain an alloy of two or more elements to form uniformly mixed compound or ceramic powder particles (e.g., composites or complex mixed oxides). Also, the method allows a spontaneous reaction to proceed between a metallic element and a reactive gas such as oxygen. The reaction heat released is spontaneously used to maintain the reacting medium at a sufficiently high temperature so that the reaction can be self-sustaining until completion for the purpose of producing a compound or ceramic material. The method permits an uninterrupted feed of wires or rods, which can be of great or continuous length. This feature makes the process fast and continuous and now enables the mass production of nano-structured materials cost-effectively, for industrialized scale production. The method is simple and easy to operate. It does not require the utilization of heavy and expensive equipment. The overall product costs are very low. This method enables simultaneous nano particle formation and surface coating (or encapsulation) of individual particles for improved compatibility with an intended matrix material or improved dispersibility in an intended liquid medium.

In another embodiment of the present invention, single walled nano-tubes, double walled nano-tubes, multi-walled nano-tubes, tubular and non-tubular nano particles, nano graphite plates, and nano-graphite plate composites, and the like, by means and technologies not limited, but in combination with, in parallel, integrated matrix, stand-alone, and the like, incorporate such technologies as Fullerene Process, Laser Desorption Ionization Mass Spectroscopy of Fullerenes, HiPco Process, and the like.

Other uses of nano-technology can be incorporated in the embodiment of this EFSMP in that such technology can be used to determine the type of feed stock, effluent, material, and the like, as well as the desired product (liquids, solids, gasses, fugitive gasses, precious metals, oils, acids, plasmas, and the like) that is required to be made, and such nano-technology can send the information across a communication network and send and receive instructions for programming and processing accordingly, so as to maximize the results and efficiency, and purity, of product, and the means in which the is handled. In the event self-repair of the piping architecture is required, or additional reinforcement and the like is required by the user to maintain predetermined structural integrity, such nanotechnology can detect where the materials are needed, remove and combine such from any portion of the effluent, and via artificial intelligence, computer programming, flash programming, computer program interfacing, either independently or with instruction, can immediately effect repair, maintenance, and cleaning, so as to reduce downtime for maintenance, repair, cleaning, inspection, and the like. The material manipulation, configuration, and the like can either be preprogrammed into the nano-technology or communicated to such via the communication network, of which the network can or cannot be relying upon an active user interface, but a set of protocols and standards, and such relaying of information, and the like, may be communicated in any numerous forms of media, as is related and taught in the U.S. Pat. No. 6,016,307 and the like.

The nano plant 300 can utilize Carbon as a product for the creating of nano tubes. The nano reactor 330 creating the nano tubes also utilizes metals, and fibers, from the processing and extraction methods, to provide different properties of the nano tubes, as well as for use in or with advanced ceramics, and advanced carbon and carbon fiber related products (and may be used to produce nanomaterials for other industries as well).

In another embodiment of the present invention, the nano plant 300 can produce Advanced Composite Materials, Advanced Ceramics, advanced Carbons, powdered metals and Advanced Metals (e.g. Aluminum), which can be used for the production of Nanotechnology as well.

In another embodiment of the present invention, the present EFSMP is configured to utilize Nano tubes, nano technology composites, and other medium, and the like for water and gas filtration, by way of upgrading, refurbishing, recycled, regenerated, filtered, changing properties, and the like, of the medium in any permutation of the reactor, in such that sorbents are able to be created and reused in house, without the need to seek external sources of filtration media and/or materials and substrates for processes taking place.

Additionally, in an embodiment of the present invention, the nano plant 300 can generate Carbon fiber which is mainly made from a polymer called polyacrylonitrile (PAN) by drawing/spinning a filament, passing through a specific oxidation heat treating, carbonizing heat treating and surface treatment process, with the spinning techniques

In another embodiment of the present invention, the nano plant 300 can have sections that can be used for non-ferrous hydrometallurgy, as well as Nano grain Ceramic Powders, Polymer Fuel Cell Reclamation, and Clay from Clay Acid renewal.

In another embodiment of the present invention, autoclaves can also be integrated in combination with or independently attached, in such fashion in that they are used in the Acid Matte Leach Process and the Nickel Laterite Acid Leach Process, because they allow high temperatures and pressures to be used.

The nano plant of the present invention can be utilized as previously described or can be employed as a standalone unit to produce nano products. An advantage of integrating the nano plant with the present matrix system and process is that if it is desirable to include byproducts of various Cells of the present matrix and system can be recycled to the nano plant to provide useful nano products and at the same time prevent the unacceptable release of noxious materials into the environment.

### Cell 4: Pyrolysis Plant

The pre-pyrolysis reactor encompassed as part of this invention comprises a continuous system and method in which a slurry (fuel applies to the same system utilized in the power generation plant) composition including crushed coal, micronized tires (coal to tire/battery mix weight ratio 1:1), micronized battery cases, 1:2) carbon black optionally 1:3) under atmospheric pressure in a hydrogen, propane or mix environment 1:4) and a residuum blanket oil for prevention of spontaneous combustion and for deasphalting and further pyrolysis processing into oil and/or syngas. The syngas is then sent to the syngas line, for use as internal fuel source, and/or processing into a finished fuel gas. The pre-treated slurry is passed through several reactor heat Cells as it passes from the feed entry port with a temperature of 100-270 degrees Celsius for moisture extraction and then to a vaporizing temperature of 270 to 350 degrees Celsius. Heat is provided by infrared, microwave or convection means. The slurry/vapors are filtered by vacuum extraction and capture of carbon soot and ash forming compounds such as quartz, mullite, pyrite, carbonate, phosphates, actinides, sulfur, moisture and metals in a Chalcogel, X-Aerogel filtration system. The slurry and vapors are continuously mixed and pushed toward the reactor exit port by an Archimedes screw running lengthwise through the center of the reactor with the assist of ultrasonic cavitation aiding desulfurization at 20,000 cps. Coal fines can be utilized in the pyrolysis process with this pre-treatment system.

The purified slurry vapors are then vacuum pump extracted and forwarded into the pyrolysis chamber.

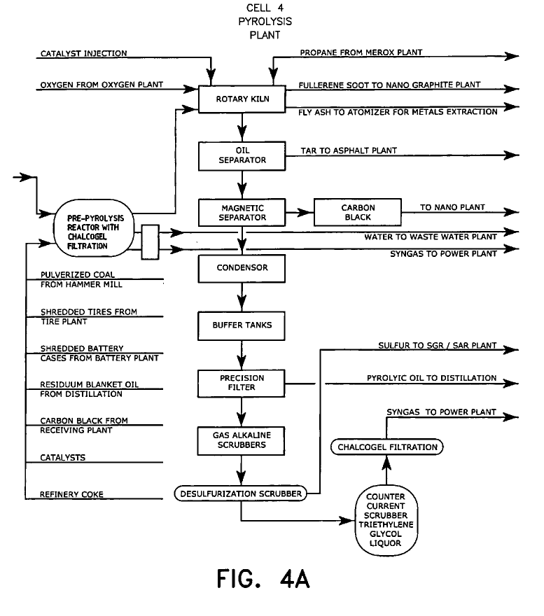

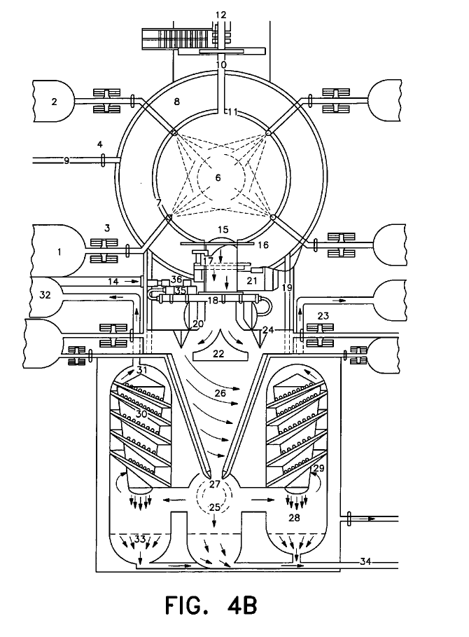

The pyrolysis plant or process 400 is shown in FIG. 4. The novel and improved pyrolysis plant or process of the present invention provides numerous advantages over known pyrolysis plants. The pyrolysis plant 400 can include a kiln 401, an oil separator 402, a magnetic separator 403, a condenser 404, buffer tanks 405, a precision filter 406, gas alkaline scrubbers 407, a desulphurization scrubber 408, etc.

The rotary or fixed kiln 401 can be replaced with a thermal reactor. For example, a super reactor described below in the section of “Super Reactor for Distillation/Desalting/Refining System” can be utilized in this pyrolysis process. As the temperature rises inside the reactor, the material begins to fractionate separating into basic components or feedstocks to further process and or produce the final products in other Cells within the present matrix system or directly process such as, for example, steel wire, carbon black, activated charcoal, activated carbon, 409, bulk oil, fuel, diesel, natural gasses, propane, jet fuel, kerosene, motor gasoline, asphalt, wax, Naphtha, lube oils, petroleum jelly, cracking stock, grease, light gasses, heavy gasses, liquefied solids, gaseous solids, char, and carbon petroleum coke.

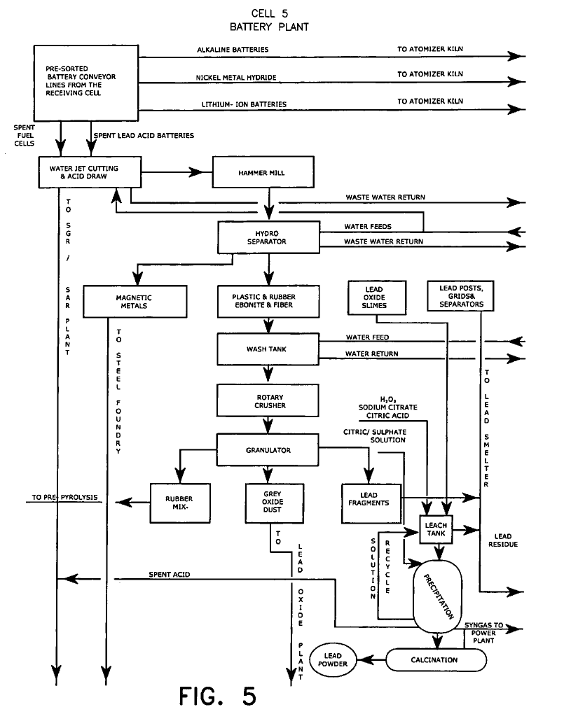

In the pyrolysis plant 400, shredded material such as crumb rubbers can be fed into the reactor, or kiln, by an Archimedes screw, or a similar method, from other plants or processes in the EFSMP. For example, as shown in FIG. 4, the pyrolysis plant 400 can receive coal supplied through the receiving and routing process 100, crumb rubbers supplied from the tire plant 200 or supplied from the receiving and routing process 100, rubbers and plastics supplied from a battery plant 500 which can be incorporated in the EFSMP as described below in reference to FIG. 5, carbon black 409 separated by the magnetic separator 403, and oxygen produced and supplied from an oxygen plant 1600 which can be incorporated in the EFSMP as described below in reference to FIG. 16.

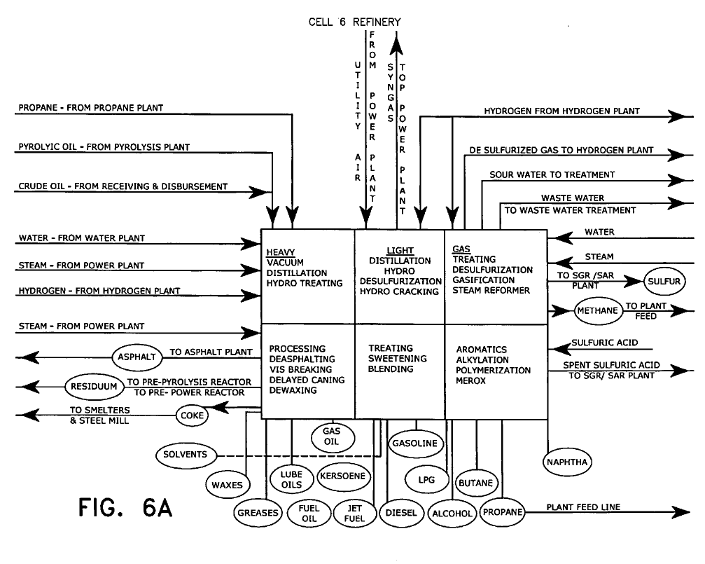

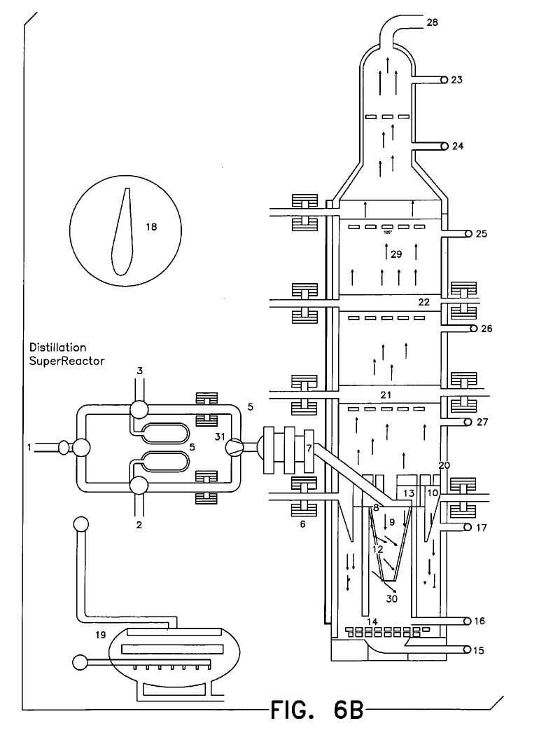

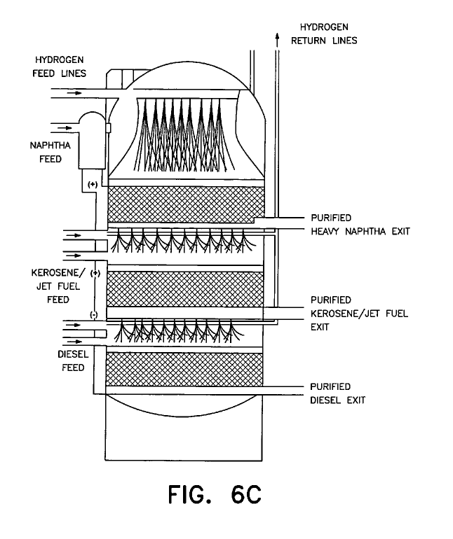

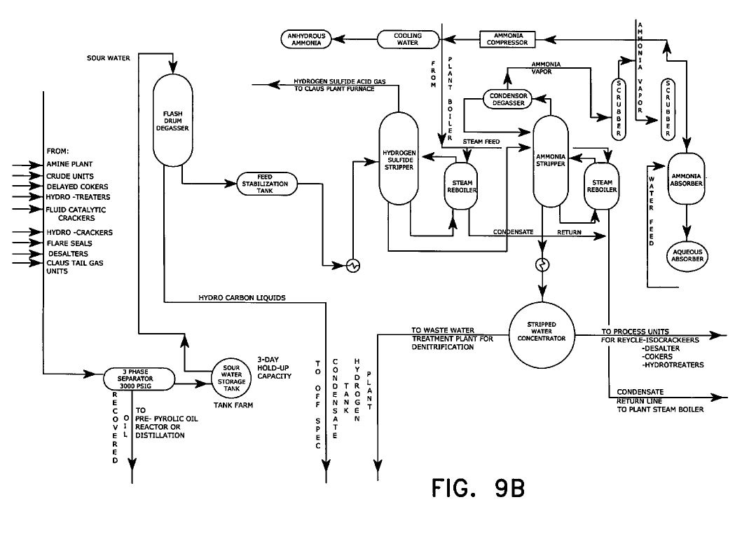

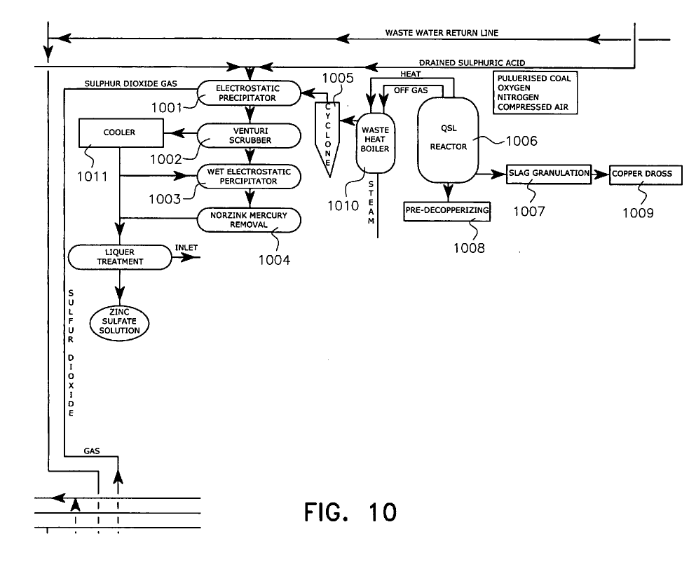

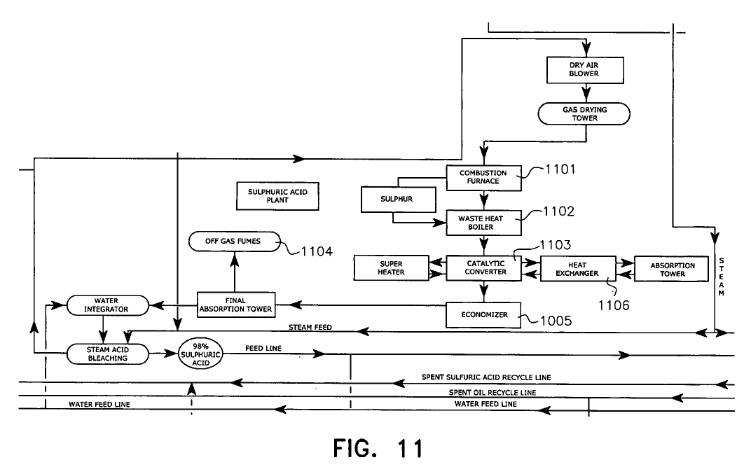

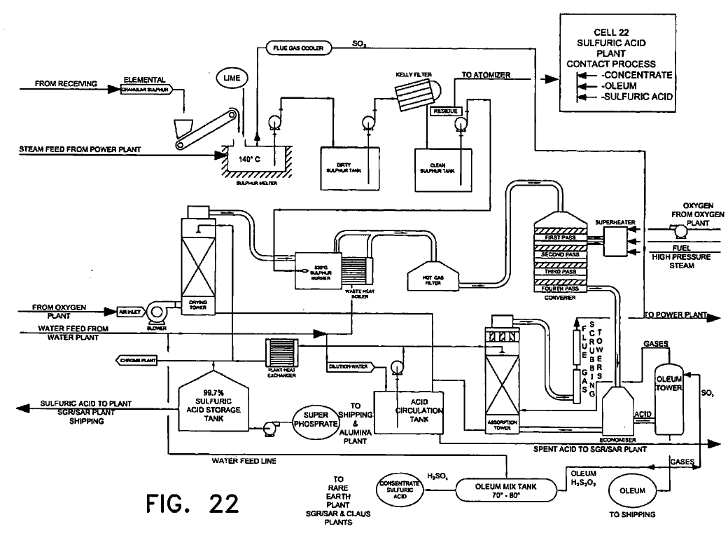

The carbon black 409 produced in the pyrolysis plant 400 (Cell 4) can be fed to the nano plant 300 to produce carbon nano tubes, and other nanomaterials and nanocomposites. The oil separator 402 can separate oil and tar. The precision filter 406 can separate black oil and gas alkaline. The separated black oil can be fed to a refining system 600 which can be incorporated in the EFSMP as described below in reference to FIG. 6A where the black oil can be further refined. The desulphurization scrubber 408 can separate sulfur, which can be fed to an acid plant 2200, which can be incorporated in the EFSMP as described below in reference to FIG. 22 and triethylene glycol liquor fed to a counter current scrubber 410. Synthesis gas can be generated through the counter current scrubber 410 of the triethylene glycol liquor. Then, the synthesis gas can be also fed to a steam turbine 902 of a Power Generation Plant 900, which can be incorporated in the EFSMP as described below in reference to FIG. 9. In the counter current scrubber 410, liquid flows from the top of the scrubber through the packing material. The liquid will be pumped and re-cycled into the scrubber. The contaminated waste gas stream flows in the opposite direction to the liquid, hence the name counter current.

In the pyrolysis plant 400, the reactor or kiln 401 can be a sealed in an oxygen deficient environment, where there are zero emissions and 100% of everything fed into the EFSMP. This pyrolysis process can be a type of Carbon Thermal Depolymerization, and the like, and can fractionalize in a method similar to distilling, and separating the different components. In addition to the above fractionalization, gasses can be fed, back into a furnace/boiler for powering the systems and processes, and thus maintaining an emission free environment.

This pyrolysis process and system 400 can use chemicals to achieve aerobic processes from gasses remaining in the reactor. This pyrolysis process and system 400 can vary in time depending upon carbon-based petrochemical material to obtain desired level of breakdown. Also, the pyrolysis system and process 400 can vary to minimize any emissions that might be created in subsequent processes.

Furthermore, the slurry and sludge that is created can produce gases that can be cooled from elevated reactor temperatures into pressurized gases, to be contained, stored, and shipped. Where carbon black 409, if required, for further breakdown, the pyrolysis plant 400 can be a looped system to continuously process the material until the desired components are achieved.

The pyrolysis plant 400 can incorporate several different Hydrogen Addition Technology practices, however several commercial technologies that compete with Hydrocracking with bottom of the barrel of heavy and extra heavy crudes, like waste oils can be also included in the present invention and include: LC Fining; HDH Plus; H Oil (Hydrogen Oil); Can Met; Shell Hy Con Technology; Selex-Asp Process; SDA (Solvent Deasphalting); Ebullated-Bed—related to LC Finning; and Lummus (LC-Finning).

### Flash Pyrolysis Reactor

The Pyrolysis Plant 400 can include a flash pyrolysis reactor 450 as shown in FIG. 4B. The flash pyrolysis reactor 450 is not limited to be used in the Pyrolysis Plant 400, but can be used in the Nano Plant 300, Water Production Plant 1600, Oil-Metal Extraction Plant 2500, and in other modules, processes, or sections of the EFSMP Matrix of the present invention.

As shown in FIG. 4B, the flash pyrolysis reactor 450 can include gas feed storage tanks 451, preferably two gas feed storage tanks on the right and left sides of the flash pyrolysis reactor 450. The gas feed storage tanks 451 can store individual or mixed gas to feed it to a pyrolysis chamber 456 or to a thermal quench or transition chamber 477. The gas stored in the gas feed storage tanks 451 can be hydrogen, methane, nitrogen, argon, oxygen, propane, helium, syngas, LPG, natural gas, acetylene, naphtha, etc. The hydrogen can be added to the pyrolysis chamber 456 for additional benefits such as reducing atmosphere, hydrotreating, hydro-fining, and a hydro-desulfurization assist. Also, the propane can be added as a deasphalting assist.

The flash pyrolysis reactor 450 can further include a hydrocarbon fuel storage tank 452, preferably two hydrocarbon fuel storage tanks, as is illustrated for descriptive purposes only, within this application, but not intended to be a limitation or a set-in-stone configuration, on the upper right and left side of the pyrolysis chamber 456.

Further, the flash pyrolysis reactor 450 can include intensifier pumps 453a configured to exert 40,000 PSI (the range can be from minimal PSI to a maximum of 60,000 PSI) per stream and located between the pyrolysis chamber 456 and each of the hydrocarbon fuel storage tanks 452 and the gas feed storage tanks 451. These intensifier pumps 453a can be used to speed up the pyrolysis process such that the process can proceed more quickly than with any other pumps. Additionally, the intensifier pumps 453a can be replaced with impinging jets to create high temperature in the pyrolysis chamber 456.

Further, the flash pyrolysis reactor 450 can include regulators 454 configured to control the flow of the gas streams supplied to the pyrolysis chamber 456 and actuated by a computer network for synchronized processing.

Moreover, the flash pyrolysis reactor 450 can include any number of (but for purposes of illustration in this embodiment four are shown) ultra-high pressure swirl injector nozzles 455 injecting the gas supplied from the hydrocarbon fuel storage tanks 452 and gas feed storage tanks 451 into the pyrolysis chamber 456. As such, each of the hydrocarbon fuel storage tanks 452 and gas feed storage tanks 451 is connected to each of the nozzles 455 located on the inside wall of the pyrolysis chamber 456, and each of the intensifier pumps 453a is located between each of the storage tanks 451, 452 and each of the nozzles 455.

Further, the flash pyrolysis reactor 450 can include the pyrolysis chamber 456 which can be a fixed-bed flash atomizing or vaporizing pyrolyic chamber. The conditions of the pyrolysis chamber 456 can be achieved by methods or processes such as jet flame spray pyrolysis (FSP), jet flame assisted spray pyrolysis (FASP), vapor-fed aerosol flame synthesis (VAFS), dry flame spray synthesis, wet steam autoclave pyrolysis, ablative environment or non-ablative environment options, atmospheric pressurized or vacuum environment (35-200 bar), dry processed feed stream for flame spray pyrolysis, pre-coated chamber walls to repel carbon/soot buildup, ultrasonic option for high shear, high saturation agitation, etc.

The FSP is a narrow jet flame produced from the nebulized spray of a combustible liquid. The FSP has been used for synthesis of a broad spectrum of inorganic nano particles from titania to yttrium aluminum garnet for solid state lasers and even catalysts such as Al2O3 supported Pt. In the FSP, micron-scale droplets evaporate, followed by combustion, particle formation and growth and eventual aggregation. Compared to vapor-fed flames, liquid fed spray flames have much higher gas velocities and somewhat higher maximum temperatures.

In VAFS, a metal precursor can be supplied in the form of vapor like SiCl4 and TiCl4 to make most of today's ceramic commodities. In FASP, a precursor can be supplied in the state of low combustion enthalpy solution (<50% of total combustion energy) usually in aqueous solvent, and because of this, its combustion needs to be assisted by an external hydrogen or hydrocarbon flame. In FSP, the precursor can be also in liquid form, but with significantly higher combustion enthalpy (>50% of total energy of combustion), usually in an organic solvent. FSP can have self-sustaining flame, usage of liquid feeds and less volatile precursors, proven scalability, high temperature flames and large temperature gradients. A key feature in the use of FSP as a convenient tool in synthesizing these nano materials is the ability to upscale its production, while closely preserving its tailored properties. As such, the pyrolysis chamber 456 can be provided with injectors (not shown in FIG. 4B) configured to spray the precursors in the form of liquid, aqueous solvent, or vapor to create the flame in the pyrolysis chamber 456.

The pyrolysis chamber 456 can be surrounded by chamber heat elements 457 configured to generate heat in a range of 700-900 degrees Celsius for gasification, and a range of 400-500 degrees Celsius for oil production. In a preferred embodiment, the temperature of the pyrolysis chamber 456 can be 450 degrees Celsius for oil production. The heat elements 457 can be indirect heat options such as infrared, microwave, convection, and coiled induction, or direct heat options such as direct flame, plasma arc, high temperature steam, etc.

Further, the flash pyrolysis reactor 450 can include an atomizing/vaporizing chamber 458 surrounding the chamber heat elements 457. The atomizing/vaporizing chamber 458 can include steam, hot oil, hot sand, etc. Also, the atomizing/vaporizing chamber 458 can include Aerogel or an X-Aerogel composite for insulation, optimum reactor heat and/or cooling retention, and X-Aerogel vibration dampening effect. Furthermore, ultrasonication can be utilized in the atomizing/vaporizing chamber 458 or in the pyrolysis chamber 456 to improve the mixing and chemical reactions. Ultrasonication generates alternating low-pressure and high-pressure waves in liquids, leading to the formation and violent collapse of small vacuum bubbles. This phenomenon is termed cavitation and causes high speed impinging liquid jets and strong hydrodynamic shear-forces. These effects can be used for the deagglomeration and milling of micrometer and nanometer-size materials as well as for the disintegration of Cells or the mixing of reactants. Cavitation may also cause, and serve, without limitation, to increase heat in effluent streams, as described in the waste water treatment Cell 14, and for generating heat in Rankine Cycle systems, and/or gas for turbine energy production, all of which are further disclosed, within the embodiment of this application. Furthermore, chemical reactions benefit from the free radicals created by the cavitation as well as from the energy input and the material transfer through boundary layers. As such, in the atomizing/vaporizing chamber 458 or in the pyrolysis chamber 456, ultrasonication can be utilized as catalyst reactivity stimulant to increase mass transfer, and to prevent reactor wall carbonization, where cavitation energy can be released for the liquid to vapor transition.

Further, the flash pyrolysis reactor 450 can include a steam feed line 459 for external steam reformer and plant distribution.

Moreover, the flash pyrolysis reactor 450 can include a catalyst injection chute 460 configured to inject catalyst into the pyrolysis chamber 456 and connected to the pyrolysis chamber 456. The catalyst injection chute 460 can include a vacuum seal flap 461 at the end facing the pyrolysis chamber 456. The catalyst injection chute 460 can be further provided with an air injector system 462 configured to load and compress catalyst breech and located outside of the atomizing/vaporizing chamber 458.

The air injector system 462 can include a plurality of fixed metal canister launch casings with spherical catalyst charges and be loaded with injector clip. Particularly, the air injector system 462 is configured to synchronize high velocity air injections with 5 second intervals, for example. Also, the air injector system 462 can include charge projectiles 463 having spherical shaped catalysts packed in the charge projectiles 463. As thermal technologies continue to advance with pinpoint accuracy, for example, but not limited to the combined use of computer imaging, infrared, sonogram, sintering, and other technologies, “charge projectiles” may be unnecessary. For example, sending a directed blast/s, from a source or several sources, may be sent to the internal center of the reactor chamber, and accomplish the same results. However, in lieu of that, today, the charge projectiles 463 can be provided with a 360 degree flare starburst for center reaction chamber directed, custom packed in a thinly layered round paper, cellulose or similar material shell allowing for instant shell combustion after rapid deployment, with a center packed gas filled balloon to create the catalyst saturating starburst, 1-5 second catalyst lifecycle/residence time, thorough and complete chamber reach/saturation, round pyrolyic chamber matches round catalyst starburst, etc.

Further, the charge projectiles 463 can be provided with aerosol spray injections aimed at the center pyrolysis chamber 456 for high pressure injection, timed catalyst reaction and fully expended catalyst each cycle. The catalyst used in the charge projectiles 463 can be magnesium hydroxide, potassium hydroxide (“caustic pot ash”), sodium hydroxide (“caustic soda”), calcium hydroxide (“slacked lime”), aluminum hydroxide, lithium hydroxide, ammonia hydroxide, hydrazine, etc., all of which can be used independently or in combination thereof. Also, transition or noble metals used in the charge projectiles 463 can be cobalt, molybdenum, iron, and ruthenium, potassium which can adversely affect cobalt if used in combination thereof, copper, titania dioxide for sulfur removal, acetates, acetylacetonates, and the like. Optionally, the flash pyrolysis reactor 450 can utilize a combustion chemical vaporization deposition process.

Further, the flash pyrolysis reactor 450 can include an ionized water inlet 464 configured to prevents mineral build up on the reactor internals. Also, the ionized water inlet 464 allows for multiple uses of ionized water in aqueous solutions such as Chalcogel, Aerogel, sol gel, colloid, X-Aerogel or a combination in the final substrate and/or composite materials used for the production of, and use in fuel cells.

Further, the flash pyrolysis reactor 450 can include a vacuum flush release ball 465 configured to release vacuum of the pyrolysis chamber 456 and located in the lower portion of the pyrolysis chamber 456. The vacuum flush release ball 465 can be provided with a seal 466.

Further, the flash pyrolysis reactor 450 can include an actuator arm 467 configured to break vacuum, and can be pneumatically actuated. Further, the actuator arm 467 can be configured to evacuate the vacuum of the pyrolysis chamber 456 in one second, and is connected to a vacuum generator 486. Additionally, the flash pyrolysis reactor 450 can include a vacuum bellows actuator 468 connected to a vacuum discharge pump 485.

In addition, the flash pyrolysis reactor 450 can include water/steam transfer pipes 469 connecting the atomizing/vaporizing chamber 458 and a fixed Archimedes screw gasifier and oil condenser 480.

Furthermore, the flash pyrolysis reactor 450 can include a centrifugal high vacuum filter ring 470 configured for filtering fugitive contaminants and for capturing and recycling individually the contaminants. The filter ring 470 can be a matrix filtration made out of Chalcogel, X-Aerogel, Aerogel, colloid, sol gel, or a combination thereof such that it can selectively filter metals, sulfur, nitrogen, calcium, sodium, oxygen, pyrites, etc. based on the particle sizes of the materials sought to be separated from the stream passing through the filter ring 470. Additionally, the filtering ring 470 can include filter supports/substrates made in conjunction with the supercritical evaporation of Chalcogel, X-Aerogel, Aerogel, Colloid, solgel filter pore formation process by adding ceramic, nano, metals or carbon fiber individually or in combination, with an electro-magnetic screen configured to aid metal extraction and to extract contaminants. Further, the filter ring 470 is configured to extract stored contaminants by reversing the current and polarity for filter cleaning or simply by periodic replacement of the filter ring.

Moreover, the flash pyrolysis reactor 450 can include an electric motor 471 which is a digital motor without magnets or brushes.

Additionally, the flash pyrolysis reactor 450 can include a splitter 472 configured to split the vacuum stream before it is fed to a vortex cone chamber 476, one or more, but illustrated, without limitation is six intensifier pumps 453b, whereas it may also be preferable, based upon design or user configuration to have four intensifier pumps 453b, increasing pressure of the gas streams fed to the vortex cone chamber 476, and vortex finder guide posts 474 configured to guide the gas stream into the vortex cone chamber 476. The vortex cone chamber 476 can be heated up to 600 degrees Celsius, preferably maintaining the temperature at 425 degrees Celsius, and is configured to vaporize any remaining fugitive particles and illuminate remaining trace contaminants.

Moreover, the flash pyrolysis reactor 450 can include the thermal quench or transition chamber 477, where the quench temperature drops from 400 to 250 degrees Celsius in a high pressure. The thermal quench or transition chamber 477 can be provided with gas feed lines 487 connected to the gas feed storage tanks 451 so that the gas is supplied to the chamber 477, and can be provided with intensifier pumps 453c. Further, each of the gas feed lines 487 has a spray nozzle 488 configured for swirled gas injection to the thermal quench or transition chamber 477.

Further, the flash pyrolysis reactor 450 can include a gasifier/condenser chamber 475 located in a space adjacent to and below the thermal quench or transition chamber 477. The gasifier/condenser chamber 475 functions as a center receiver and distributor chamber. In a preferred embodiment of the present invention, one or more, but without limitation for illustration purposes in the drawings show two to four gasifier/condenser chambers 475 which can be provided with the flash pyrolysis reactor 450.

Additionally, the flash pyrolysis reactor 450 can be cylindrical being vertical, horizontal or tilt situated and constructed with a preferred round, teardrop, oval combustion chamber but a square or horizontal configuration will work and can include cooling chambers 479 having condensation chambers 478 in a space adjacent to and below the cooling chambers 479. For example, two to four cooling chambers can be included in the flash pyrolysis reactor 450. In the cooling chambers 479, gas is processed, oil condensation occurs and the condensed oil can be collected in the bottom tank. The condensed oil can be collected through oil extraction lines 484. The cooling chambers 479 can include a fixed Archimedes screw gasifier and oil condenser 480. For illustrative purposes, and without limitation, the Flash Pyrolysis reactor 450 has two fixed Archimedes screw gasifier and oil condensers 480 as shown in FIG. 4B. The fixed Archimedes screw gasifier and oil condenser 480 has inwardly angled blades which butt a hollow center cone, and is configured to direct oil condensation into the hollow center cone and to direct the upstream gas flow for graduated cooling. The angled blades can be arranged in a spiral shape as shown in FIG. 4B, and can be hollow such that water can be filled in the hollow blades which can be part of the circulating water jacket and allow for additional cooling surfaces. The hollow center cone has a downstream taper so that it can guide gas upstream to the top chamber gas exit, perforated drain holes can direct condensed oil to the hollow center cone, and the hollow center cone guides down comers into bottom oil collection zones/pools 483. For example, there are three oil collection pools 483 in the flash pyrolysis reactor 450 in FIG. 4B. The fixed Archimedes screw gasifier and oil condenser 480 has a gas exit 481 where the temperature of the gas can be 100 to 105 degrees Celsius.

Further, as explained above, the Flash Pyrolysis reactor 450 can include a capability of raw gas filtration 482 using Chalcogel, Xerogel, Aerogel, Sol gel, colloid, and or a mix within a high impact substrate of advanced material, metal, and or ceramic matrix and/or other composite materials, in unison with or independently of an electrostatic strippers or scrubbers, etc.

### Cell 5: Battery Plant

Now turning to FIG. 5, this embodiment of the present invention includes a battery plant 500. Used, spent, factory warranty, reject and recalled batteries after being inspected and sorted by battery category at the receiving and routing dock then are pallet forwarded to the Battery Plant for final recycle processing. The battery plant 500 recycling process begins with receiving dock bulk dump loading the batteries by chemistry type into its respective sealed, vapor extracted conveyor system. The continuous conveyor system includes a high pressure wash or alternatively ultrasonic cleaning Cell followed by multiple sensor automated water jet battery case cutters and subsequent draining in an explosion proof work Cell equipped with a high velocity air filtration system to contain fugitive corrosive, toxic vapor emissions. Each battery conveyor line accommodates the type of electro-chemical fluid and gas makeup of that specific battery type, such as and including: a) the wet cell, absorbed glass mat and gel Cell battery electrolyte recycling station that drain connects directly to the sulfuric acid plant; b) an independent spent lithium-ion, lithium-sulfur and other lithium related battery work station maintained at cold room temperature as lithium is explosive at room temperatures. The lithium batteries are cryogenically pre-processing frozen at −198 degrees Celsius thus rendering them relatively inert. The drain system connects to the lithium battery electrolytic reprocessing section located within the sulfuric acid plant for reprocessing; c) nickel hydride batteries are sent to the atomization reactor for thermal processing and metals recovery as detailed in the atomization section or alternatively processed using traditional technologies; d) An independent large work station is required to accommodate the larger dimensions of fuel cells, but includes a standard drain line for spent fuel Cell liquid drainage and recycling plant connect. All spent fuel Cells which contain hydrogen or other gases, an/or metals, organics, composites, are vacuum extracted from the work station and directly sent into a customized Chalcogel, Xerogel filtration system that separates each contaminating material, capturing and storing each material in like layer to allow for precision recycle harvesting; e) Dry Cell batteries will be sent in bulk directly to the atomizer plant for thermal recycling and halogen, dioxin and furan forming prevention, syngas reduction conversion, filtration and or destruction by temperatures well above 1200 degrees Celsius. After robotically water jet cutting with subsequent draining the battery cases continue uninterrupted along in the sealed conveyor belt to the heavy hammer mill for rapid bulk loading and mass high impact breakage. Batteries can optionally cryogenically frozen for hammer mill impact breakage, crushed, thermally liquefied, or chemically pre-treated so as to be uniformly fragmented, and ready for further secondary reduction or micronization, Lithium batteries must be cryogenically frozen prior to processing so they are in an inert state. The fragments are then conveyor dropped into a comprehensive separator system to sort the mix of PVC, fiberglass, Nano, carbon, ceramic, graphite and other similar internal battery construction materials from the lead, lead paste, plastics and rubber and electromagnetic sorting of the metal and non-magnetic aluminum case fragments from the spent fuel cells. The magnetically separated metal casing fragments will be sent to the tire plant for baling along with the fragmented tire steel belts. The separator system is equipped with a closed looped dust and vapor extraction and filtration system being Chalcogel, X-Aerogel or traditional bag house, electrostatic precipitator 502. The plastic fragments can next be forwarded to the Pre-Pyrolysis Reactor to be mixed with the tire, coal and residuum oil mix or in the Matrix be sent next to 503, a secondary wash tank 504, a rotary crusher 505, and a granulator or micronizing jet mill, ball mill, rod mill or similar technology. 506.

Lithium batteries may contain lithium monoaluminate and or pentalithium aluminate and others which will be reconstituted by metallothermic high temperature processing, the aluminothermic reduction method and or aluminate synthesis for reprocessing into purified aluminothermic lithium. The rubber and polypropylene from the battery plant 500 can be fed to the pre-pyrolysis plant 400 as discussed above. The lead fragments and paste can be further fed to a paste desulfurizer 508 to produce lead ingots, H2O, lead carbonate, and sodium sulfate crystal. The lead can be further smelted by being fed into a Reverberatory, short or long fixed or tilting rotary kilns, top-blown rotary furnace, electric furnace, traditional blast furnace or YMG submerged needle type of Blast Furnace 1202 of a Lead Smelter Plant 1200. The smelted lead will then be sent to the alloying kettle for subsequent ingot casting, stacking and palletizing. The lead carbonate can be further fed to an Isamelt type of Smelter 1203 of the Lead Smelter Plant. Slag, matte, Speiss, dross, Dore and bullion are sent to the atomizer for metals recovery 1200. The paste desulfurizer can receive steam from the steam feed line to produce such materials.

The battery plant 500 can include a lead posts, paste, plates and separators 507 configured to separate paste from ebonite, fiberglass, Nano and polypropylene. The ebonite and polypropylene can be fed to the pyrolysis plant 400. The fiberglass and Nano can be sent to the Atomizer Reactor for further processing.

As for lead acid batteries, the smelting of lead involves several elements that are required to reduce the various forms of lead (mainly lead oxide and lead sulfates) into metallic lead. Mostly this can include: a) a source of carbon, usually in the form of metallurgical, petroleum coke, charcoal; b) energy, mostly available from natural gas, oil or electricity; c) neutralizing agents used to capture sulfur such as caustic, soda ash, or lime; and d) fluxing agents also used to capture sulfur and improve lead recovery. Many of the materials needed for smelting lead are formed in the present matrix system and method. Such materials can be routed to the lead smelter or can be readily routed from the point of production of the material to Cells of the present matrix system and method where these materials are further fabricated or can be used as sources for changing other materials into useful products.

Frequently lead acid batteries can include various forms of iron and slag enhancing materials. These materials can be isolated in the present matrix system and utilized to form other products or can be useful in their own right. While collecting sources of Recyclables that are highly toxic, as well as those that are non-hazardous and environmentally preferable (EPA executive order 9.6.2 #13101) can be collected from the various Cells of the present matrix system and process. Toxic materials can be further processed to for non-toxic materials or can be collected in a safe manner. Many locations also have an abundance of waste lubricants (Brake Fluid, Transmission Fluid, Hydraulic Fluids, etc.,) and automobile batteries (also known as Lead Acid Batteries, and Lead Batteries)—with which will eventually be included Alkaline, Lithium, Lithium Ion, Cadmium or Lithium Nickel Batteries, Nickel Metal Hydride, Fuel Cells. These materials can be processed in the various Cells of the present matrix system and process to generate useful products. Lithium batteries will be processed using the electrolytic production method to reconstitute (LiCl) and or optionally adding (KCl) and other compositions in the reprocessing system or alternatively sent to the atomizer for metals recovery.

However, it is contemplated that the battery plant 500 is not limited to the process of design in extractive crystallization of lithium, lithium hydroxide, and the like.

The battery plant 500 can include a typical process of the break-down of lead acid batteries that follows the OSHA standards (as set forth in detail, in their entirety, at the OSHA website,) and is common practice in the industry. It is the standard adopted by the United States Department of Labor Occupational Safety and Health Administration (OSHA) for public safety.

Also, a slag refining can be used to modify slag formed in the Cells of the present matrix system and process to form in-house refinery products such as the lead materials found in lead/acid batteries and their recycling. Furthermore, such practices, those used for, and in, but not limited to, and used either individually, or in combination, as part of the matrix of technologies described in the present invention as those such those found in a electrolytic lead refinery, electro ceramics, Isamelting, slag fumers, slag fuming, as well as incorporating ultraviolet radiation, ultraviolet light, crucible furnace processing, ore roasting processes, drossing, CDF drossing, flash smelting, Smelting Matte, Barton pot process, and Ball Mills, where Ball Mill—important for producing lead oxides, and the like.

### Cell 6: Refining System

Now turning to FIG. 6A, this embodiment of the present invention includes a refining system 600. The refining system 600 can be a closed loop emissions free refining system, and can include a distillation/desalting super reactor 650 (as shown in FIG. 6B) to consolidate refining processes and production time. However, the systems can be terrestrial, oceanic, subterranean, sub polar, aquatic, insular, continental bases. The present matrix system and process is specifically designed to incorporate recycling, renewable regeneration, refining and to encompass a manufacturing matrix of technologies can be utilized in the refining system to provide a overall matrix which provides for enhanced petroleum refining at a reduced cost and which recycles products produced in the Cells including the refinery Cell 600 to provide a matrix system and process with low or negative carbon footprint and which provide useful products from previously simply discarded by-products of the refinery.

For purposes of this description, when the term “Oil” is used, it can be defined as Petroleum, Fossil Fuel, Petrochemical, hydrocarbon, petrocarbon, Mineral Oil, Black Oil, Refuse Oil, Pyrolytic Oil, Mazut, Transformer Oil, Gas, vapor, Carbon-based Lubricants, heavy oil, shale oil, tar sand oil, residuum, bitumen, spent oil, re-refined oil, refined oil, motor oil, engine oil, crude oil, virgin crude oil, light and heavy crude oil, processed oil, re-processed oil, regenerated oil, synthetic oil, hydrolytic oil, combusted oil, non-motor oil, regenerative oil, Nano oil, and Waste Oil (derived from crude and waste oil receipt facilities like ships, tankers, inland barges, rail, pipelines, ballast water, and the like.) Refineries also can be designed as oil refineries and gas refineries, natural gas refineries, in addition to LPG, Dehydration Refining, Diesel Stripping, Lube Oil Distillation and Condensation, and the like.

The refining system 600 can include petroleum and gas refining processes. For example, the processes commonly used and accepted in the Petroleum Refining Industry to refine crude oil are systems generally listed as follows: Electrostatic Desalting, Atmospheric Distillation, Vacuum Distillation, Aromatics Extraction, Solvent Dewaxing, Visbreaking, Delayed Coking, Fluid Catalytic Cracking, Two-Stage Hydrocracking, Platforming Process, Distillate Hydrodesulphurization, C4 Isomerization, etc.

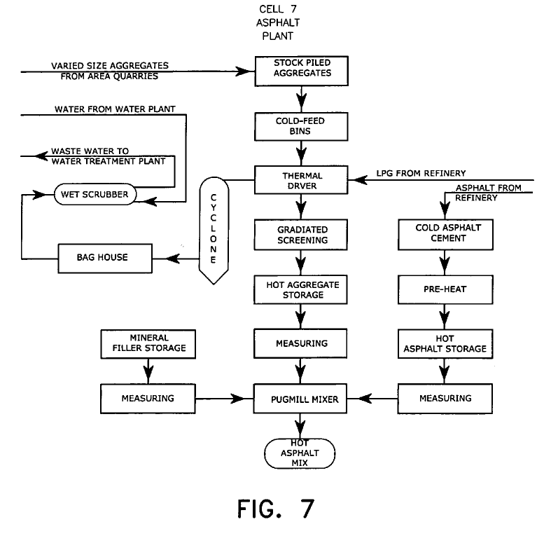

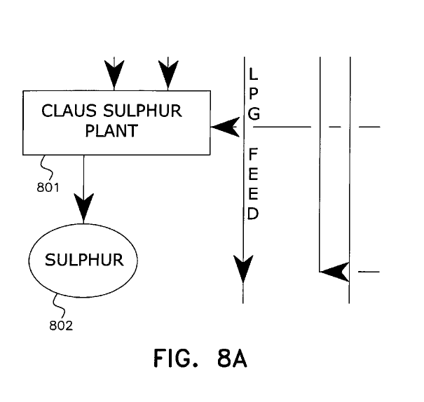

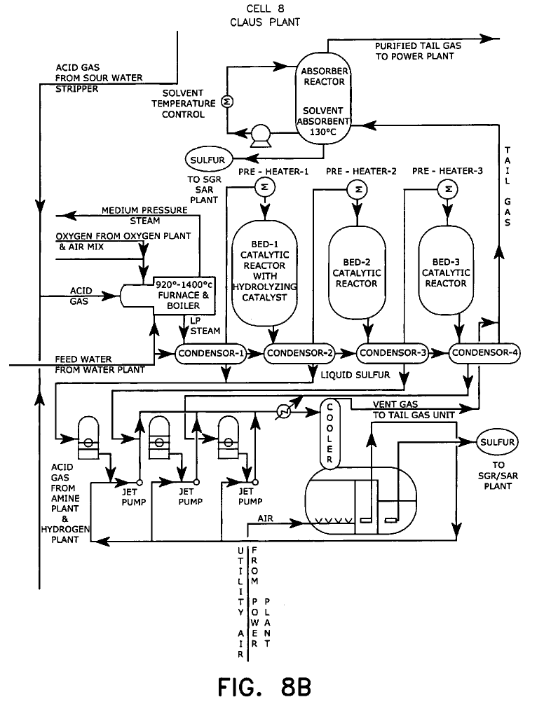

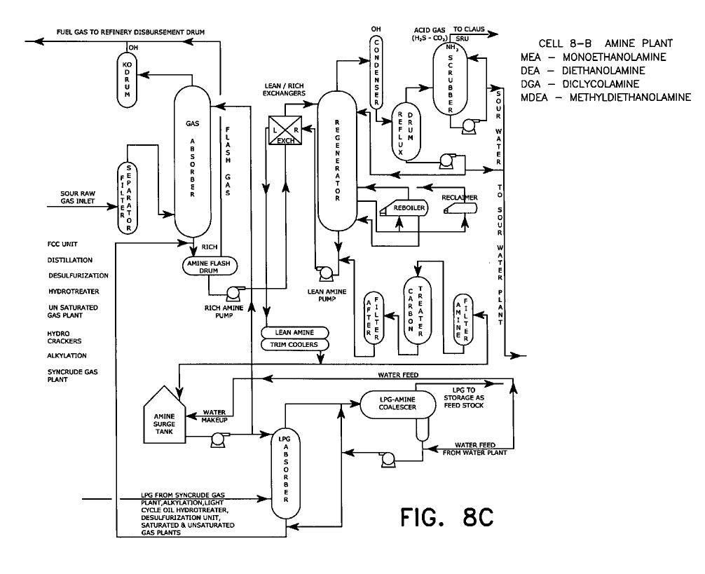

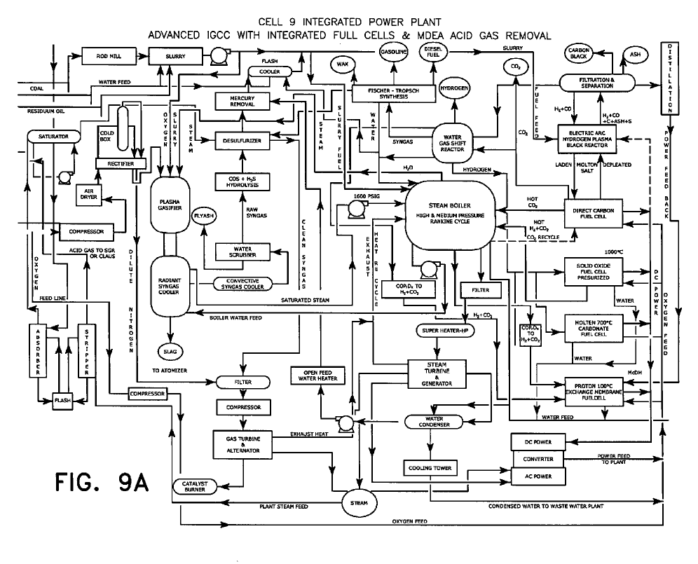

In a preferred embodiment of the present invention, the refining system 600 can include a desalting, deasphalting process 601, an atmospheric distillation process 602, a deep cut vacuum distillation process 603, a lube oil hydrotreating process 604, a residual oil hydro desulphurization process 605, a deasphalting process 606, a visbreaking process 607, a delayed coking process 608, a vacuum flasher 609, a flexi coker 610, a lube oil processing 611, an asphalt blowing process 612, a hydrocracking process 613, a hydrocarbon storage and blending 614, a gas oil hydrodesulfur 615, a moving bed catalytic cracker 616, a fluid catalytic cracker 617, a kerosene hydrodesulphurization process 618, a chemical sweetening process 619, a Merox Minalk process 620, an acid gas removal process 621, a gas processing 622, a naphtha hydro-desulphurization process 623, a catalytic reforming process 624, an isomerization process 625, Merox WS treaters 626, an aromatics complex 628, an alkylation process 629, a polymerization process 630, an amine treating process 631, and a Merox process (conventional) 632. The refining system 600 can further include an asphalt plant as described below with reference to FIG. 7 and a Claus Sulfur Plant 800 as described below with reference to FIG. 8.

The desalting process 601 in the refining system before the atmospheric distillation process 602 removes salts in crude oil such as Calcium, Sodium and Magnesium Chlorides to prevent problems which could arise in the refining process. For example, the high temperatures that occur downstream in the process could cause water hydrolysis, which allows the formation of hydrochloric acid. In the desalting process 601, a conventional desalter or the distillation/desalting super reactor 650 described in the present invention can be used.

The atmospheric distillation process 602 can include an atmospheric distillation unit that is able to distill crude oil into fractions. In the atmospheric distillation process 602, which is known as continuation distillation, a mixture can be continuously (without interruption) fed into the process and separated fractions can be removed continuously as output streams. In this process 602, a liquid feed mixture can be separated or partially separated into components or fractions by selective boiling (or evaporation) and condensation. This atmospheric distillation process 602 can produce at least two output fractions. These fractions include at least one volatile distillate fraction, which has boiled and been separately captured as a vapor condensed to a liquid, and practically always a bottoms (or residuum) fraction, which is the least volatile residue that has not been separately captured as a condensed vapor.

Following the atmospheric distillation process 602, the topped crude oil can be fed to the deep cut vacuum distillation process 603 where the pressure above the liquid mixture to be distilled is reduced to less than its vapor pressure (usually less than atmospheric pressure) causing evaporation of the most volatile liquid(s) (those with the lowest boiling points). The vacuum distillation process 603 can be conducted with or without heating the solution.

### Distillation/Desalting Super Reactor

The desalting process 602 and distillation process 603 can include the distillation/desalting super reactor 650 as shown in FIG. 6B.

In fractional distillation, petroleum is heated then piped into a distillation column or fractionation tower. Inside the tower or column are perforated trays, which catch liquid petroleum products at various levels vaporizing, condensing and draining the condensed droplets for recycle and extracting the separated vapor components off to storage or further processing. The benefits to distilling in the towers include increased efficiency, less labor, and simpler facility construction. Distilling crude oil is most efficient and least expensive when done in two steps: first, fractioning at atmospheric pressure, then feeding the residuum from the first column into a vacuum tower and distilling again. The following description is a significant advancement of these general principles.

As shown in FIG. 6B, the “main chamber” 664 of the reactor is made of a combination of materials, one set of materials forming the inner lining of the chamber 669 and one set of materials forming the outer lining 671 of the chamber. In a preferred embodiment, stainless steel is used, although ceramics, advanced materials and other non-corrosive materials or a combination thereof that can withstand the desalting process can also be used. Such corrosive-resistant materials must be used at least in the parts of the chamber that are in contact with the corrosive agents.

In a preferred embodiment, corrosion-resistant steel (CRES) is used to form the entire lining of the chamber. Stainless steel is used where both the properties of steel and resistance to corrosion and electrolysis are required. Carbon steel rusts when exposed to air and moisture. This iron oxide film (the rust) is active and accelerates corrosion by forming more iron oxide. Stainless steels contain sufficient chromium to form a passive film of chromium oxide, which prevents further surface corrosion and blocks corrosion from spreading into the metal's internal structure. Thus, corrosion caused by the desalting process, impact erosion, and exposure to acids is limited in the present invention. Reactor superstructure includes an advanced Aerogel, Xerogel thermal insulation liner to effectively retain the processing heat from escaping or causing the stainless steel shell to become thermally brittle over time. The ultrasonic or vibrasonic self-cleaning trays, and/or trays can additionally be coated with graphite applied to an advanced ceramic, carbon fiber, powdered metal composite or advanced Nano tube substrate or a combination of.

To the left side of the super reactor drawing, a feedstock section exists 652, with two separate streams and three separate inputs. Feedstocks include, but are not limited to pyrolyic oil that is derived from liquefied coal and tires and produced in other Cells of the present matrix and process, crude oil and waste oil. In addition to the oil feedstock inputs to this system, there are two rectangular tanks 653 illustrated, which appear as chambers located within the larger feedstock input streams, which encapsulate them. These tanks are upright chambers that house the following: a) emulsifiers; and b) hydroxide (OH) in another chamber, although these chambers are not specifically limited to storing any one particular substance. The emulsifiers and hydroxide may always be included as part of the effluent, although crude oil, waste oil and pyrolyic oil can be included in all combinations of varying ratios in the input stream. The emulsifiers will surround the oil and form a protective layer so that the oil molecules cannot “clump” together. This action may help keep the dispersed phase in small droplets and preserves the emulsion. The use of the appropriate emulsifiers and hydroxide composition will prevent foaming of the mixture, which is a known problem in the petroleum refining industry.

In order to take the salt out, fresh water is added to the crude oil to essentially wash the salt out. Chemicals to assist in breaking the emulsion may be added. The salt dissolves in the fresh water, and then the salty water drops to the bottom of the tank where it can be removed. This is carried out at about 200-300 degrees Fahrenheit. About 3-10% volume of water is added.

A standard desalter 654 can be used in connection with the input streams and the main chamber of the super reactor. The desalter 654 is shown below the feedstock section in FIG. 6B. In a preferred embodiment the desalter has a process unit, such as those typically used in an oil refinery that removes salts from the crude oil. The salts can be dissolved in the water in the crude oil, not in the crude oil itself. The products of the desalter can be recycled to other Cells of the present matrix and system for processing to provide useful products which can be isolated or used other portions of the present matrix and system.

The production of Asphalt is part of the present invention as a marketable bi-product of the refining process. Asphalt is a viscous adhesive that, along with aggregate, forms HMA pavement surfaces. Crude oil is heated in a large furnace to about 340 degrees Celsius it becomes partially vaporized. It can then be fed into a distillation tower where the lighter components vaporize and are drawn off for further processing. The residue from this process (the asphalt) is usually fed into a vacuum distillation unit where heavier gas oils are drawn off. Asphalt cement grade is controlled by the amount of heavy gas oil remaining Other techniques can then extract additional oils from the asphalt. Depending upon the exact process and the crude oil source, different asphalt cements of different properties can be produced. Additional desirable properties can be obtained by blending crude oils before distillation or asphalt cements after distillation.

Raw crude oil produced by oil wells drilled into underground petroleum oil reservoirs is accompanied by brine (e.g., water containing inorganic chloride salts and Naturally Occurring Radioactive Materials (NORM)). The amount of chloride salts in the brine may be as high as 20% by weight. Some of that brine is emulsified with the crude oil. The salts present in raw crude oil may be in the form of crystals dispersed in the oil and some of the salts are dissolved in the brine in their ionized form. In general, the oilfield processing facilities strive to remove enough water, sediment and salts so that the transported crude oil contains less than 10 to 20 pounds of salts per 1000 barrels (PTB) of clean, water-free crude oil. The desalting process is integral in a preferred embodiment of the present invention.

The first oil feedstock enters through one channel and a first feedstock stream is mixed with emulsifiers and a second channel is mixed with hydroxide simultaneously. These separate channels run parallel to one another. The parallel streams then pass through an intensifier pump 657a which exerts 40,000 PSI (the range can be from minimal PSI to a maximum of 60,000 PSI) per stream such that they are propelled at this critical pressure, as is well known to persons having ordinary skill in the art in the field of micro-fluidics. After passing through the intensifier pumps 657a, the parallel streams, one containing oil and hydroxide, and the other containing oil and emulsifiers, intersect at a collision chamber 658. The collision chamber 658 causes a standard ionization reaction that prevents foam buildup, a common problem associated with reactors, as a result of the reaction.

The collision chamber 658 acts as a super-saturation and vaporizing device, which helps to ensure that the flow streams are steady when they reach the heat amplification device 659.

From the collision chamber 658, the effluent moves to the heat amplifier 659. In the heat amplifier, similar to that disclosed in U.S. Pat. No. 4,106,554 to Arcella the effluent is heated and catalyzed prior to entering the main chamber. The heated effluent bypasses the walls of the super reactor “main chamber” 664 and enters the venturi cyclonic, cavitation type system 660. In addition, the following is incorporated by reference: United States Patent Application Serial Number 20090031524 to Courtney; Benjamin; and Dyson, for Multistage Cyclonic Separating Apparatus. It should be noted that the left wall of the main chamber 664 has a hollow tube-like structure running vertically along the outer wall of the main frame, which serves as an access point 661 for personnel to be able to work with the reactor all along the side of the reactor. Such access point 661 can be placed anywhere along the main chamber 664 or on any of the outer walls 671 of the reactor.

When the effluent stream enters the venturi system, shown in FIG. 6B as a diagonal tube 662 aimed at an approximately 45 degrees angle in the downward direction towards the main cyclone, the effluent is released towards the top of the main cyclonic separator 660. The heated vortex cone surface may be constructed with a rough surface to more effectively capture, cycle and purify than an agitated thin-film, wiped film or short path evaporator. The venturi effect described in the present invention is the speedup of air through a constriction due to the pressure rise on the upwind side of the constriction and the pressure drop on the downwind side as the air diverges to leave the constriction. The effluent begins being separated by weight upon entry into the vortex, which sends lighter molecular weight oils upward and heavier oils downward.

It is important to note that there can be, for example, four intensifier pumps 657b surrounding the main chamber 664 of the super reactor at the point where the effluent enters the main cyclonic separator 660. These four intensifier pumps 657b are used to speed up the process of refining such that the process can proceed more quickly than with any other pump. The standard reactor will have one or two intensifier pumps, rather than the four included in the present invention, which is another critical distinction between this super reactor and previous technologies. Above 900 degrees Fahrenheit, cracking occurs. Cracking is when high temperatures cause the large hydrocarbon molecules to crack into smaller ones which is undesirable as it is uncontrolled unless it happens in a catalytic cracking process. The heaviest cut points in a distilling column occur at about 750 degrees Fahrenheit. The present invention keeps the temperatures significantly below that where molecular cracking will occur. The initial temperature of the vortex is 420 degrees Celsius. This temperature of 420 degrees Celsius can be any temperature, but 420 degrees Celsius optimal because it is above the melting point for the following metals: zinc (419.5 degrees Celsius), tin (232 degrees Celsius), selenium (217 degrees Celsius), cadmium (321 degrees Celsius), bismuth (271.4 degrees Celsius), etc. There are two secondary cyclones positioned on each side of the main cyclone having an internal temperature of 320 degrees Celsius.

A typical venturi system separates air particles based upon the weight of the respective particles operating in a manner physically similar to that of a centrifuge, the present invention separates molecules based on molecular weight, using hydrogen to aid in the atomization of lighter molecular weight components and propane to aid in the atomization of higher molecular weight components. The main cyclonic separating unit is arranged in a parallel alignment with a pair of secondary cyclones, although tertiary and quaternary cyclones also can be used, which increase separating efficiency. As the separator gradually separates the metals and other contaminants from the effluent stream the separator will send the effluent in the direction of venturi outlets to further process and decontaminate the effluent. This is done at varying temperatures that act to gradually distill and remove contaminants at different gradated temperate and separation zones.

Additionally, propane is pumped into the lower chambers while hydrogen is pumped into the upper chambers. Propane is an appropriate gas atomizer for higher molecular weight gases, while hydrogen is an appropriate atomizer for lower molecular weight gases.

The effluent that moves upstream is treated in each zone as it passes from one zone to the next with the help of intensifier pumps retrofitted with velocity multipliers, which serve as a curtain technology to maintain different environments in different zones. These air curtains 670 preserve the needed temperature zones for processing of the effluent at each temperature gradation. For example, one standard air curtain technology was described that has been used in gas desulfurization (FGD) reactors in “Effect of Near-Wall Air Curtain on the Wall Deposition of Droplets in a Semidry Flue Gas Desulfurization Reactor” by Jie Zhang, Changfu You, Changhe Chen, Haiying Qi, and Xuchang Xu, University of Tsingua, Beijing, China, 2007. Various near-wall air velocities, near-wall air flow inlet heights, and spray characteristics were analyzed numerically to investigate their effect on the gas liquid flow and droplet deposition characteristics. The analytical results show that the near-wall air curtain effectively reduces the wall deposition of droplets in the semidry FGD reactor.

The method of fuel extraction described in the present invention can be a standard atomization fuel extraction method as is known in the art. However, other methods of atomization can be used as well, including but not limited to atomization reactor, described in the present invention. The metals can be magnetized by electrolysis, for example. Thus, when the metals reach the extraction ports 665, they will be vacuum drawn out of the main chamber. The metals will also be drawn out naturally at their respective vaporization points in the zone which contains their appropriate heat of vaporization.

The cyclone can also be known as a vortex. By contrast, fluids that initially have vorticity, such as water in a rotating bowl, form vortices with vorticity, exhibited by the much less pronounced low pressure region at the center of this flow. Also in fluid dynamics, the movement of a fluid can be vortical if the fluid moves around in a circle, or in a helix, or if it tends to spin around some axis.

In addition, the block-shaped panels 667 that are only shown above the three cyclonic separators serve as a filtration system during the initial separation process. Further the arrows indicate the existence of extraction ports 665 for gases and allow for the removal of heavy and trace metals. Extraction can also take place through venturi outlets.

The baffles 668, shown as rectangular plates and or nautilus shaped baffle ears in figure lying just below the intensifier pumps 657c accomplish both slowing the updraft vapors and preventing condensation, droplet formation, etc., which helps to prevent clogging as is common with present technology. The baffles can be comprised of different shapes, or be structures such as turbines, and be of such composite material, nanomaterials, chalcogels, and the like, without limitation, etc., in which heat, water, electric, etc., can be captured and utilized, or of such configuration as to produce heat, not just within this embodiment, but in situ of the EFSMP.

Generally, baffles 668 deal with the concern of support and fluid direction in heat exchangers. Further, the baffles 668 provide a source of heat that acts as a last source of heat to prevent condensation buildup. The baffles 668 can include, but are not limited to housing infrared, micro, and sonic waves. Also, the baffles can contain fixed or revolving turbines, so as to reduce the flow velocity, and or at the same time, the turbines can generate electricity.

One of the problems with prior reactors is the long cycle time required for droplets to form from condensation and travel back downstream causing contamination and corrosion of the component parts. Such a mechanism results in build-up in the reactor that can be problematic to the functioning of the reactor as it can cause clogging and inefficient processing. The present invention solves this problem by providing a flash of infrared, micro, sonic, etc., which prevents condensation and eliminates backflow of contaminants in the form of water droplets, for example, back toward the venturi cyclonic separator.

In an embodiment of the present invention, the refining system 600 can include the hydro desulphurization process 605, where sulfur can be removed from natural gas and from refined petroleum products such as gasoline or petrol, jet fuel, kerosene, diesel fuel, petroleum oils, and fuel oils by a catalytic chemical process. The purpose of removing the sulfur is to reduce the sulfur dioxide (SO2) emissions that result from using those fuels in automotive vehicles, aircraft, railroad locomotives, ships, gas or oil burning power plants, residential and industrial furnaces, and other forms of fuel combustion. Another important reason for removing sulfur from the naphtha streams within a petroleum refinery is that sulfur, even in extremely low concentrations, poisons the noble metal catalysts (platinum and rhenium) in the catalytic reforming units that are subsequently used to upgrade the octane rating of the naphtha streams. The hydro desulphurization process 605 can include facilities for the capture and removal of the resulting hydrogen sulfide (H2S) gas. The hydrogen sulfide gas can subsequently be converted into byproduct elemental sulfur and or hydrogen, or sulfuric acid. Similarly, the refining system 600 can include the gas oil hydro desulphurization process 615, the kerosene hydro desulphurization process 618, and the naphtha hydro desulphurization process 623.

In an embodiment of the present invention, the refining system 600 can include the deasphalting process 606, where asphalt is separated from crude oil or bitumen. The deasphalting process 606 can include a de-asphalter unit which is preferably placed after the vacuum distillation process 603. The de-asphalt unit can be a solvent de-asphalter unit, which can separate the asphalt from the feedstock because light hydrocarbons will dissolve aliphatic compounds but not asphaltenes.

In an embodiment of the present invention, the refining system 600 can include the visbreaking process 607 where the quantity of residual oil produced in the distillation of crude oil can be reduced and the yield of more valuable middle distillates (heating oil and diesel) by the refinery can be increased. In this process 607, large hydrocarbon molecules in the oil can be thermally cracked by heating in a furnace to reduce viscosity and to produce small quantities of light hydrocarbons (LPG and gasoline).

The refining system 600 can further include the delayed coking process 608, where a residual oil feed can be heated to its thermal cracking temperature (also known as supercritical temperature) in a furnace with multiple parallel passes. This coking process 608 cracks the heavy, long chain hydrocarbon molecules of the residual oil into coker gas oil and petroleum coke.

The refining system 600 can further include a cracking process, especially, the hydrocracking process 613. In the refining system 600, cracking is the process whereby complex organic molecules such as kerogens or heavy hydrocarbons are broken down into simpler molecules such as light hydrocarbons, by the breaking of carbon-carbon bonds in the precursors. The rate of cracking and the end products are strongly dependent on the temperature and presence of catalysts.

The hydrocracking process 613 can be a catalytic cracking process assisted by the presence of an elevated partial pressure of hydrogen gas. In the catalytic cracking process, similar to the hydrotreater, the function of hydrogen is the purification of the hydrocarbon stream from sulfur and nitrogen hetero-atoms.

The products of the hydrocracking process 613 can be saturated hydrocarbons, depending on the reaction conditions (temperature, pressure, catalyst activity). These products range from ethane, LPG to heavier hydrocarbons comprising mostly of isoparaffins. The hydrocracking process 613 can be facilitated by a bifunctional catalyst that is capable of rearranging and breaking hydrocarbon chains as well as adding hydrogen to aromatics and olefins to produce naphthenes and alkanes.

Major products from the hydrocracking process 613 can be jet fuel and diesel, while high octane rating gasoline fractions and LPG are also produced. All these products have a very low content of sulfur and other contaminants. Also, the hydrocracking process 613 can be Fluid Catalytic Cracking that is more efficient to produce high octane rating gasoline.

The present refining system 600 can also include a process for the hydrocracking of a hydrocarbonaceous oil to lower boiling hydrocarbon products in the presence of a catalyst prepared in situ from metals added to the oil as thermally decomposable metal compounds. Hydrorefining processes utilizing dispersed catalysts in admixture with hydrocarbonaceous oil are well known. The term “hydrorefining” is intended in the present invention to designate a catalytic treatment, in the presence of hydrogen, of a hydrocarbonaceous oil to upgrade the oil by eliminating or reducing the concentration of contaminants in the oil such as sulfur compounds, nitrogenous compounds, metal contaminants and/or to convert at least a portion of the heavy constituents of the oil such as pentane-insoluble asphaltenes or coke precursors to lower boiling hydrocarbon products, and to reduce the Conradson carbon residue of the oil.

As an example, the hydrocracking process 613 can be a process for cracking a hydrocarbon oil charge stock having a Conradson carbon content of less than about 5 weight percent. This process can include: a) adding to the charge stock a thermally decomposable metal compound in an amount ranging from about 25 to about 950 wppm, calculated as the elemental metal based on the charge stock, the metal being selected from the group consisting of Groups IVB, VB, VIB, VIIB and VIII of the Periodic Table of Elements and mixtures thereof; b) heating the thermally decomposable metal compound within the charge stock in the presence of a gas selected from the group consisting of a hydrogen-containing gas, a hydrogen sulfide-containing gas and a gas comprising hydrogen and hydrogen sulfide to produce a solid, non-colloidal catalyst within the charge stock, the solid catalyst comprising from about 25 to about 950 wppm of the metal, calculated as the elemental metal, based on the charge stock; Celsius) reacting the charge stock containing the catalyst with hydrogen under hydrocracking conditions; and d) recovering a hydrocracked hydrocarbon oil.

The hydrocracking process 613 can be generally applicable to hydrocarbonaceous oils boiling, at atmospheric pressure, in the range of about 430 degrees Fahrenheit to 1100 degrees Fahrenheit, preferably in the range of about 500 degrees Fahrenheit to about 1050 degrees Fahrenheit, more preferably in the range of about 650 degrees Fahrenheit to 1050 degrees Fahrenheit. These hydrocarbon oils can be derived from any source such as petroleum, oil shale, tar sands, coal liquids, carbon black, rubber, polypropylene and peat. By way of example, suitable hydrocarbon oil feeds for the process 613 can include virgin gas oil, vacuum gas oil, coker gas oil, visbreaker gas oil, petroleum distillates, Mazut, hydrocarbon oils derived from coal liquefaction processes, etc., and mixtures thereof. More preferably, the hydrocarbon oil is substantially asphaltene-free oil. By “substantially asphaltene-free” is intended in the present invention that the oil comprises less than about 1.0 weight percent asphaltenes.

In an embodiment of the present invention, the refining system 600 can include the chemical sweetening process 619. The chemical sweetening process 619 can be a copper sweetening process that is a petroleum refining process using a slurry of clay and cupric chloride to oxidize mercaptans. The resulting disulfides can be less odorous and usually very viscous, and can be removed from the lower-boiling fractions and left in the heavy fuel oil fraction.

The refining system 600 can include the acid gas removal process 621, also known as an amine gas treating process. The acid removal process 621 can include a group of processes that use aqueous solutions of various alkanolamines (commonly referred to simply as amines) to remove hydrogen sulfide (H2S) and carbon dioxide (CO2) from gases.

The refining system 600 can include the catalytic reforming process 624, where petroleum refinery naphtha's, typically having low octane ratings, can be converted into high-octane liquid products called reformates which are components of high-octane gasoline. The catalytic reforming process 624 can re-arrange or re-structure the hydrocarbon molecules in the naphtha feedstocks as well as breaking some of the molecules into smaller molecules. The overall effect is that the product reformate contains hydrocarbons with more complex molecular shapes having higher octane values than the hydrocarbons in the naphtha feedstock. By the catalytic reforming process 624, hydrogen atoms can be separated from the hydrocarbon molecules and very significant amounts of byproduct hydrogen gas for use in a number of the other processes involved in a modern petroleum refinery can be produced.

The refining system 600 can also include the isomerization process 625, where one molecule is transformed into another molecule which has exactly the same atoms, but the atoms are rearranged (isomerized) e.g. A-B-C→B-A-C. In some molecules and under some conditions, isomerization can occur spontaneously. Many isomers are equal or roughly equal in bond energy, and so exist in roughly equal amounts, provided that they can interconvert relatively freely, that is the energy barrier between the two isomers is not too high.

The isomerization process 625 can be a process to isomerize hydrocarbon feed streams including contacting a hydrocarbon feed stream with a steamed catalyst such as a zeolite, and or a multidimensional medium pore zeolite, or a multidimensional zeolite, a one-dimensional medium pore zeolite (“zeolite”), and the like, under hydroisomerization conditions. The hydroisomerization conditions can include temperatures above ambient room temperatures and increased pressures above common barometric pressures. The steamed catalyst can be steamed under conditions such that the alpha value of the steamed catalyst does not exceed the alpha value of an unsteamed catalyst including the same one-dimensional zeolite, and where zeolites can include at least one binder or matrix material selected from clays, silica, and alumina and the like. The zeolites can be, for example, ZSM-22, ZSM-23, ZSM-35, ZSM-57, ZSM-48, ferrierite, a Group VIII metal, a Group VIII noble metal.

Additionally, the steamed catalyst can be molecular sieves. The molecular sieves suitable for use in the isomerization process 625 can be selected from acidic metallosilicates, such as silicoaluminophosphates (SAPOs), and one-dimensional 10-ring zeolites, e.g. medium pore zeolites having one-dimensional channels comprising 10-member rings. The SAPOs can include SAPO-11, SAPO-34, and SAPO-41. It is preferred that the catalysts used in the present invention contain at least one Group VIII metal, preferably a Group VIII noble metal, and most preferably Pt, as discussed above. The catalyst may be steamed prior to or subsequent to adding the at least one Group VIII metal. It is preferred, however, that the catalyst be steamed subsequent to the incorporation of the at least one Group VIII metal.

The zeolite can be combined with a suitable binder or matrix material. Such materials include active and inactive materials such as clays, silica, and/or metal oxides such as alumina. Naturally occurring clays that can be composited include clays from the montmorillonite and kaolin families including the subbentonites, and the kaolins commonly known as Dixie, McNamee, Ga., and Florida clays. Others in which the main mineral constituent is halloysite, kaolinite, dickite, nacrite, or anauxite may also be used. The clays can be used in the raw state as originally mixed or subjected to calcination, acid treatment, or chemical modification prior to being combined with the zeolite.

Additionally, the zeolite can also include a porous matrix or binder material such as silica-alumina, silica-magnesia, silica-zirconia, silica-thoria, silica-beryllia, or silica-titania. The zeolite can also include a ternary composition such as silica-alumina-thoria, silica-alumina-zirconia, silica-alumina-magnesia, and silica-magnesia-zirconia. It is preferred that the porous matrix or binder material includes silica, alumina, or a kaolin clay. It is more preferred that the binder material includes alumina.

The refining system 600 can include the Merox WS Treaters 626. Merox is an acronym for mercaptan oxidation. In the Merox WS Treaters 626, a proprietary catalytic chemical process can be used to remove mercaptans from LPG, propane, butanes, light naphthas, kerosene and jet fuel by converting them to liquid hydrocarbon disulfides. The Merox WS Treaters 626 can include a process requiring an alkaline environment which, in some of the process versions, is provided by an aqueous solution of sodium hydroxide (NaOH), a strong base, commonly referred to as caustic. The alkalinity can also be provided by ammonia, (a weak base). The catalyst used in the Merox WS Treaters 626 can be a water-soluble liquid. The catalyst can also be impregnated onto charcoal granules.

The refining system 600 can also include an alkylation process 629. Alkylation is the transfer of an alkyl group from one molecule to another. In oil refining contexts, alkylation refers to a particular alkylation of isobutane with olefins. In the alkylation process 629, isobutane can be alkylated with low-molecular-weight alkenes (primarily a mixture of propylene and butylene) in the presence of a strong acid catalyst, either sulfuric acid or hydrofluoric acid. The catalyst protonates the alkenes (propylene, butylene) to produce reactive carbocations, which alkylate isobutane. In the alkylation process 629, the reaction can be carried out at mild temperatures (0 and 30 degrees Celsius) in a two-phase reaction. It is important to keep a high ratio of isobutane to alkene at the point of reaction to prevent side reactions which produces a lower octane product, so the plants have a high recycle of isobutane back to feed. The phases separate spontaneously, so the acid phase can be vigorously mixed with the hydrocarbon phase to create sufficient contact surface. The alkylation process 629 can transform low molecular-weight alkenes and iso-paraffin molecules into larger iso-paraffins with a high octane number.

The refining system 600 can include the polymerization process 630. In the polymerization process 630, monomer molecules can react with each other in a chemical reaction to form three-dimensional networks or polymer chains.

The refining system 600 can be self-contained and can include Topping Refinery, Cracking Refinery, and Coking Refinery and can also include Slag from Degasification, and Hydroskimming. A hydroskimming refinery is defined as a refinery equipped with atmospheric distillation, naphtha reforming and necessary treating processes. The hydroskimming refinery is therefore more complex than a topping refinery (which just separates the crude into its constituent petroleum products by distillation, known as atmospheric distillation, and produces naphtha but no gasoline) and it produces gasoline. However, a hydroskimming refinery can produce a surplus of fuel with a relatively unattractive price and demand.

In an embodiment of the present invention, gasses produced are known as Fugitive Emissions, and the like, and are further defined as to include, but without limitation, gasses from coal, oil refining, Recycling Air Streams, as well as those that also result from liquid, metal, acid, and gas, SMP technologies, and the like.

In the refining system 600, the series of processes and methods can change the state of crude oil and the like into other forms of product with different viscosities, matter/mass, gasses, and substances.

Whereas conventional refining systems use exothermal methods routinely, the refining system 600, in accordance with another embodiment of the present invention, can interchange thermal energy produced from, or used in, cracking and/or fracturing, requiring energy to raise temperatures above ambient (surrounding stasis temperatures) room temperature and infrared (I/R) practices can be easily utilized. Additionally, nuclear, atomic, chemical, electrical, cavitation, sonic, ablation, thermal, Drop-Tube, Pressurized Radiant Coal, Flow Reactor, and/or a heated mix of compounds (liquids, metals, solids, gasses, fluids, plasmas, and the like) can be utilized. The I/R can be used either as a standalone, or in a combination application, and the like, as and for gas catalytic infrared ovens, dryers, and furnaces, infrared heating and thermal processing, roasting, and convection oven-type performance.

Furthermore, I/R in addition to processing and refining can be used to detect or direct electron, neutron, proton, characteristics of feeds/products entering into the EFSMP. The EFSMP can separate different liquids, metals, solids, gasses, and plasmas into various distillation tanks, much like typical reactors in a refinery (ex: atmospheric distillation 602, vacuum distillation 603, and the like) into different tracks for collection, sale, use, recycling, further processing, internal use, or holding and storage. I/R can be also used as refractory lenses for the ability to detect leaks via infrared.

The refining system 600 can utilize chemogenesis analysis—where the chemogenesis analysis identifies five distinct types of electron accountancy and five associated reaction chemistries, such as the following examples: Lewis acid/base; Redox; Radical; Diradical; and Photochemistry. Analysis of atom-to-atom mapping can be understood in terms of unit and compound mechanism steps including Complexation, Fragmentation, Substitution, Insertion, Pericyclic processes, Metathesis, Addition, Elimination, Rearrangement, and Multistep name reaction. The five reaction chemistries can be arranged against the atom-to-atom mappings to give a matrix of mechanism types.

Some refinery complexities, in addition to Fisher-Tropsch Processes, involve reactor systems which normally consist of two or three reactors in series. This is a drawback of the current state of the art. In an embodiment of the present invention, the refining system 600 does not have the same drawback, either in the necessity of having more than two reactors in the entire facility, or in having just one. The refining system 600 can be rendered as single pass-through or multiple matrices of technologies as pass-through EFSMPs, any of which can be vertically integrated depending upon the configuration of the location as well as desired costs and economics. The distillation/desalting super reactor 650 can be used for upgrading base feed stocks, or for breaking down enriched or encumbered feed stocks. Types of feed stocks, that the refining system 600 can process, can be crude oil, used lubricant oil, shale, shale oil, coal, thermonuclear treated and extracted petroleum products, bitumen, black oil, dark oil, waste lubricants, oil filters, used oil filters, spent oil, tar sands, oil spills like the Exxon Valdez, or the Orinoco Belt in Venezuela, or that at the Trans Ocean facility/Mocondo oil spill in the Gulf of Mexico, and the like, as well as the oil from BP's management of the Oil Spill in not using absorbent materials to collect the oil.

The purpose of refining, extracting, and processing, is to convert natural raw materials such as crude oil and natural gas into useful, saleable products. Crude oil, vapors, gas, and natural gas are naturally occurring hydrocarbons, found in many areas of the world in varying quantities and compositions. In the refining system 600, they can be transformed into different products, such as: fuels and lubricants for cars, trucks, trains, airplanes, spacecraft, ships and other forms of transport; combustion fuels for the generation of heat and power for utilities, military, industrial and consumers; raw materials for the petrochemical, power, water, metals, pharmaceutical, and chemical industries, synthetic crude oil; and specialty products such as lubricating oils, paraffins/waxes and bitumen, and other various materials in which its decay is desirable.

The refining system 600, in addition to petroleum, either crude or refined, can be directed to a metal recovery of the metals contained in any of the oils, catalysts, or with which are used to derive the substances from ores used in oil refining, so as to create additional profit streams, where an economy exists for doing such, and in which includes, but is not limited to, nor to the exclusion of, basic ferric sulfates and/or jarosites are controlled by a number of mechanisms, including control of the oxidation reaction conditions, and the like.

While there are a few well-known, large companies that do oil re-refining, such as Evergreen, Interline Resource Corp., Breslube, Consolidated Recycling, Mohawk, DeMenno/Kerdoon/Enforoput, Mid-America Distillations, and Safety-Kleen, these oils are re-packaged and sold back into the stream of commerce, once again, primarily as lubricants. Methods currently used by these companies do not produce the full range of fossil fuel products, nor the other myriad of products described in the embodiment of this invention, found at a traditional petrochemical refinery that uses crude oil as refinery feed stock (and that uses the numerous methods of souring, de-souring, sweetening, atmospheric distillation, cracking, hydrocracking, coking, slow coking, hydrogen blending, hydrocracking, etc.) simply because this is not called for in their business model. Re-refiners are typically small business ventures as they have not figured out how to obtain high volume, steady supplies of waste feedstocks so large refiners have not taken it seriously to date as a viable business opportunity. The invention has volume sourced (local major market and foreign imported) and thus enabled a combined tire, battery case, coal and waste oil mix in a collective and continuous mass volume to accommodate a pyrolyic oil ratio of 80-90% to crude oil as 10-20% refining mix supplying ten or more 500,000 plus barrel per day refineries, within the continental United States alone. Other regions, and geographies, based upon growing economies, such as China, Russia, Eurasia, India, the Middle East, Brazil, and the like, as well as those of Europe and Asia can also easily accommodate similar amounts of facilities and refineries, with even greater capacity.

In accordance with an embodiment of the present invention, the refining system 600 does not have such volume restrictions, and as a refinery, processor, and re-refinery, nor does the EPA or foreign regulatory agencies impose limitations upon mixing feedstocks described above and contained within the present invention.

In addition to crude oil, petroleum products, petroleum effluents, hydrocarbon, synthetic oil, black oil, and other feed stocks outlined in an embodiment in the present invention, the invention also relates to lubricating oils suitable for use in alpha-olefin compressors. The base fluid is mineral or synthetic oil or a mixture thereof. Synthetic oils are made from other chemicals rather than by a conventional crude oil refining process. Suitable synthetic oils include poly(alpha-olefins), polybutenes, and products of the Fischer-Tropsch process. Mineral oil is a distillate of petroleum. It can be paraffinic, naphthenic, or mixed base oil. Blends of oils of various viscosities and compositions may also be used instead of one single type of oil. “Mineral oil” can include “white oil,” also sometimes can be referred to as “white mineral oil.” White mineral oil is prepared from a distillate of petroleum crude oil. Preparation of white mineral oil generally includes one or more upgrading steps for purifying the oil. Common upgrading steps can include hydrotreating, hydrogenation, filtering, solvent refining, and dewaxing.

The refining system 600 can also include a cooling system module. The cooling system module can be enmeshed throughout the facility to lower processing temperatures of material and equipment. Also, the refining system 600 can include such modules where necessary due to the EFSMPs and the continuous endothermic reactions that take place, and where exothermic reactions are not recaptured back into energy.

In addition to being a closed loop system, negative carbon emission footprint, with zero emissions, the refining system 600 can be classified as a “green refinery”, a “clean energy class”, and “renewable energy class” EFSMP, in that it will use the latest clean process technologies, producing ultra-low Sulfur fuels, gasoline's, etc., where precuts can be sent out by truck, rail, pipeline, and tanker where available. Cleaner energy technology, fuel Cells using sulfuric acid, and an Integrated Gasification Combined Cycle (IGCC) using petroleum coke, are each identified “Green Energy” systems that the EFSMP of the present invention will use.

There are also technologies that are similar to a torpedo that blows out the chimney/line from pressure, but whereas the EFSMP has no vents, stacks, chimneys and the like, and this technology could be used in such EFSMP facilities and campuses. In one embodiment of the present invention, the present EFSMP can be a closed looped system where such type of internal projectile could be used to clean out the internal clogging or debris that can accumulate. A similar form of technology can be a commonly used systems for cleaning air vents in Air Conditioned Systems (also closed loop), that could be a spinning bow-tie type, or brush, of EFSMP.

In accordance with an embodiment of the present invention, advanced communication systems and software can also be used for such a matrix of communication. Imperative in implementing and coordinating the interdependent technologies in the present invention is a communications system that can track—in real time—and notify refinery operators (or management) of system status, contemporaneously. The same technology can be used as a basis for security, and for monitoring external conditions, including, but not limited to, weather, intruder/trespasser detection and deterrence, terrorist threats, site security breaches, counter measures; monitoring and testing of systems, system loads, stress limits, integrity and redundant apparatuses, feed streams, quality control, product quality control, etc., to on site, and off site testing laboratories, as well as establishing redundant communication between any EFSMP its equipment, apparatuses, as well as establishing redundant communication between any EFSMP, the refinery EFSMP management, and outside bodies (police, fire, ambulance, hospitals, FEMA, government or industry-standard monitoring, off-site management, environmental management, utility management, service, safety, management, and security, performance monitoring and quality control, commodities/economics management, off site security, etc.) The integrated communications system within the refining system 600 also include video, radio, satellite, microwave, wireless, wire line, voice, data, machine to machine communications, machine to operator, and other systems (not limited merely to communications) such as internal power.

The present refining system 600 upgrades, and refines crude oil, extra heavy crude oil, and the feed stocks outlined in the present invention, into synthetic crude oil, none the least of which would be a monolithic hydrotreating technology for middle distillates, as an alternative to hydrotreating and EFSMPS of Hydrotreating. The refining system 600 can also be referred to as a heavy crude upgrader (aka Wild Catter HCU) in that the refining system 600 easily uses heavy crude, peat, crude oil that is infused with bitumen-based oil, such as Orimulsion, and the like, and shale oil as well as tar sands. Also, the refining system 600 can use a combination of streams, steam, and other catalysts that are mixed and then refined into a light crude. At this point, the process will provide a secondary system that separates heavy crude from the light crude into a permutation that is economically suitable for additional processing and refinement.

The present refining system can include autoclaves as part of the overall system, either as a stand alone unit, or in any hybrid or combination thereof, and the like. Such autoclave technologies are not limited to Microwave Autoclaving, Steam Reactors, Mixed Steam with I/R, Autoclaving with Super Heated Steam, composite autoclaves, Hydro Autoclaving, Radiant Tube heating, glass-laminating autoclaves, concrete autoclaves and or radiation, atomics, ultrasound, sound waves, light, slurry, sludge, ethenates, hydrogenates, other forms of heat, gases, solids, fluids, plasmas, and the like.

### Chalcogel Filtration Capabilities

In an aspect of the present invention, one or more modules of the present EFSMP including the refining system 600, but not limited to, can include Chalcogel, X-Aerogel, colloid, Solgel, SEAgel, Agar, or Aerogel custom formed filtration capabilities collectively, mixed or individually in the present invention referred to as “Chalcogel”, or “Aerogel”, but without limitation, and whereas Foam Metals can be a substrate for the production of Chalcogels, Aerogels, etc., or vice versa, all from a negative gravity environment (either in space or in a “drop zone” which typically lasts about 5 seconds, in which a hole is dug, and an elevator dropped and a zero gravity zone is created, where the free fall creates the negative gravity). The Chalcogel filtration system allows for a total upstream feed stock depoisoning and stream purification with the extracted impurities cost effectively separated, contained, extracted and recycled into vital renewable feed stocks, catalysts, products and energy fuels.

Aerogel, as defined in the present invention collectively, and is also further referred to in different embodiments, in the following descriptions, is a manufactured material with the lowest bulk density of any known porous solid. It is produced by extracting the liquid component of a gel through supercritical drying and by replacing the liquid components of the gel with a gas. This allows the liquid to be slowly drawn off without causing the solid matrix in the gel to collapse from capillary action, as would happen with conventional evaporation. It consists of lightweight silica solids derived from a gel in which the liquid component has been replaced with gas. The silica solids, which are poor conductors, consist of very small, three-dimensional, intertwined clusters that comprise only 3% of the volume. Conduction through the solid is therefore very low. The remaining 97% of the volume is composed of air in extremely small nano pores. The air has little room to move, inhibiting both convection and gas-phase conduction. These characteristics make Aerogel the world's lowest density solid and most effective thermal insulator. It is nicknamed Frozen Smoke, Solid Smoke, Solid Air or Blue Smoke due to its translucent nature and the way light scatters in the material; however, it feels like expanded polystyrene (Styrofoam) to the touch. For example, an X-Aerogel is a conformal polymer cross-linking nanostructure that is 300 times stronger than the native silica Aerogel, allowing for a wider range of technology opportunities. Potential X-Aerogel applications can include extreme insulation capabilities, sound and vibration dampening materials, fuel Cell membranes, ballistic impact-resistant liner materials, absorbents, filters and catalyst supports, as well as platforms for chemical, electronic and optical devices.

A Chalcogel or properly metal chalcogenide Aerogel is an Aerogel made from chalcogens (the column of elements on the periodic table beginning with oxygen) such as sulfur and selenium, with cadmium, tellurium, platinum, and other elements. Metals less expensive than platinum, can also be used in its creation as catalysts or substrates to withstand impact, crushing under compression, or extreme temperature ranges. Various substrate materials can also be added such as Nano, ceramics, advanced composites, advanced carbon fibers, advanced and traditional metals and numerous other materials.

Chalcogels preferentially absorb heavy metals, showing promise in absorbing pollutants mercury, lead, actinides and cadmium from water, liquids or gases. In addition, Chalcogels can be twice as effective at desulfurization as any current methods. Chalcogels have many applications. For example, when water contaminated with the heavy metal mercury (which can cause nerve and brain damage in fetuses and children) was run through a sulfur-germanium Chalcogel, the amount of mercury dropped from 645 parts-per-million to just 0.04 ppm. The metal-bearing water passes through the torturous, porous network of the Chalcogel and sooner or later, these heavy elements will encounter sulfur. The key is the surface area of the Chalcogel, an extremely low-density solid made up primarily of air. A cubic centimeter of this stuff could have 1,500 square meters—almost a football field—inside of it. That expanded surface is a widely spaced version of the amorphous structure that forms the initial gel. In an embodiment of the present invention, Aerogel and Chalcogels can be used for, but are not limited to, templates, membrane substrate for fuel cells, gas filtration, emission filtrations, etc., structured packings within the atmospheric distillation process 602 and the vacuum distillation process 603 of the refinery system 600 of the present invention either as constructed materials or as coatings like Teflon applied to standard packings or applied to preformed micro porous filtering substrates. The term “structured packing” refers to a range of specially designed materials for use in absorption and distillation columns and chemical reactors. Structured packings typically consist of thin corrugated metal plates or gauzes arranged in a way that they force fluids to take complicated paths through the column, thereby creating a large surface area for contact between different phases. Additionally, Chalcogel can be used for the very packings themselves, floor planning, and maintenance of packings with its ongoing relationship with Sulfur, and Sulfuric Acid in the refining system 600.

Also, a Chalcogel filtration system can be used between connectors and connecting pipes going from the atmospheric distillation process 602 to the vacuum distillation process 603 including for inter and intra connectivity filtration and thermodynamics.

In an embodiment of the present invention, the refining system 600 can include, but not limited to, a Chalcogel made out of cobalt-molybdenum-sulfur to remove mercury from polluted water and to separate hydrogen from other gases and, can be used as a catalyst to pull sulfur, and other matter, out of and/or deasphalting crude oil. The Chalcogel can be freeze-dried, producing a sponge-like material with a very high surface area. Hydrodesulfurization is a widely used catalytic chemical process that removes sulfur from natural gas and refined petroleum products, such as gasoline and diesel and jet fuels. The Chalcogel catalysts can be twice as active as a conventional catalyst used in hydrodesulphurization.

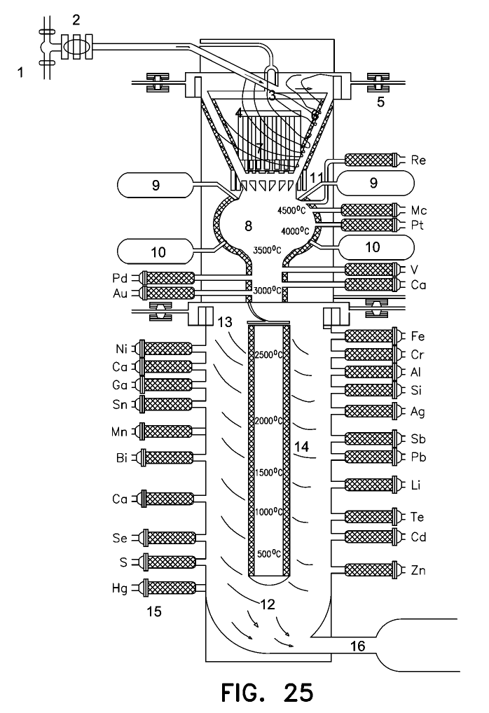

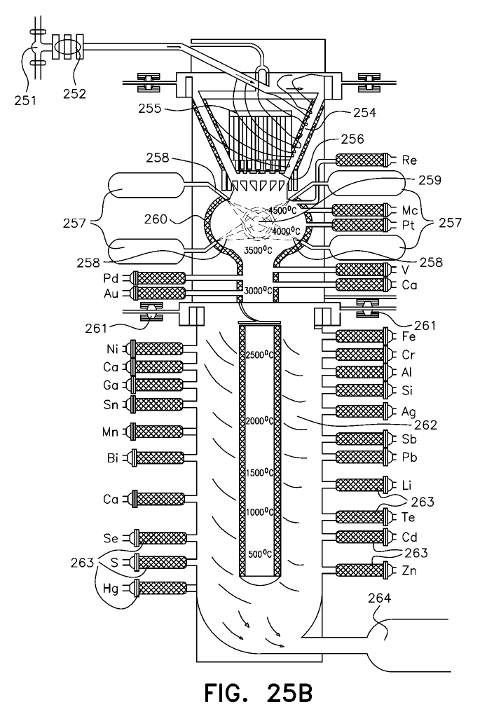

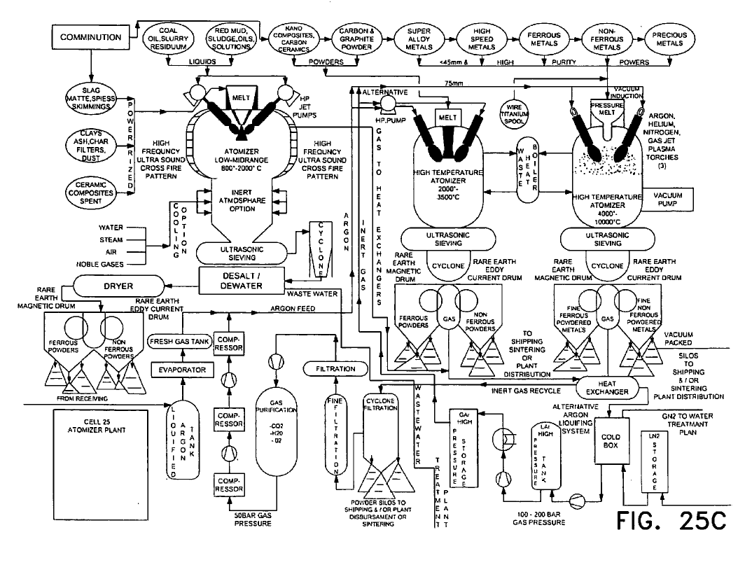

In an embodiment of the present invention, Chalcogel filtration chambers (Chalcogel filters) can be also incorporated in the Atomizer Reactor as shown in FIG. 25B and Power and Water Plant Super Reactor as shown in FIG. 25C.

While a conventional reactor does a thorough job in removing both poisoning and stream contaminants, the Atomizer Reactor depicted in FIG. 25B of the present invention can include a new final treatment by means of the Chalcogel filtration chambers, substrates, pores, structures, etc. which ensures their near total, if not total, removal. By doing so, the new Atomizer Reactor having the filtration chambers can allow for a superior next generation refining technology with a significant operating profit margin.

Following the distillation process, traditional refineries utilize a side-stream fractionator as a secondary purifier for the light and heavy fuels, in turn the fractionating is followed by further purification using Hydrotreating, Hydrodesulphurization, Amine treating, Phenol extraction, and Hydrodenitrification processes.

In the present invention, however, these processes can be combined into the Atomizer Reactor with independent multiple feed streams. The Atomizer Reactor can be immediately positioned next to the Distillation Reactor 650 and can segregate feed streams of light naphtha, kerosene, jet fuel, diesel, light vacuum gas oil, heavy gas oil, residuum, etc.

The Atomizer Reactor can include plural layers of Chalcogel filtration chambers (Chalcogel filters). Each filter can include micro pores having a uniform diameter that specifically matches a target contaminant and allows for total micelles absorption. The micro pores are tailored to match each specific extracted metal's diameter. The layers can be disposed in the Atomizer Reactor in such a way that the largest pore filter can be on the top and subsequent layers are followed in a descending pore diameter order. Each filter can be separated with a sieved metal plate to allow for easy filter extraction and replacement. Each layer of the Chalcogel filters can be specially treated with solvents, or solvent embedded to a porous skeletal support, to expedite a filtration process by one of a gas injection, liquid spray mist, and pre-coated substrate. The support can be alloyed with transition or noble metals selected for polarizing capability used to selectively separate contaminants from oil molecules and draw them into the micelles for capture and containment. Powdered metal catalysts can also be spray applied and electro-statically fixed to the support substrate.

The Chalcogel filter can eventually be replaced and allow for the solvent or atomization extraction and harvesting of the metals (precious and ferrous), sulfur, rare earths, actinides, nitrogen, oxygen, and additives. All volatile organics can be destroyed in the distillation and atomization processes. The Chalcogel filters can also be used to filter contaminants such as oxygen compounds, sulfur, sulfuric acid, nitrogen compounds, Halogen, metals, aromatics, alcohol and ether based fuel/oil additives, chlorine, chloride, automotive fuels, benzene, toluene, hexane, mercaptans, etc.

Chalcogel filter manufacture can be focused on proven substrate materials which include Nano grown composites as shown in FIG. 25B of the Atomizer Reactor, advanced ceramics, carbon composites, Matrix media (alumina, silica, activated clays, activated charcoal and carbon, Zeolites, Laterite, etc.), stabilizing powdered, crystallized alloys or surfactants (Mo/Ni, Mo/S, Co/Ni, Pd/Se, etc.).

The Chalcogel system can also be used as a filtration filler injected into existing reactor packing systems allowing for immediate use, but will make the spent filter compound separation and harvesting process more complicated.

A strong super-structured material can be used, which allows for a high shear velocity, and high temperature utilization, use of metal alloys in a formamide super critical gel drying process. The metal alloys allow for effective use of electric current in the Chalcogel process, where the oil molecule polarity reacts with the metal alloys and contaminants are released and electrically attracted into the micelles in a captured holding state.

Additionally, the Gatling gun 355 (jet impingement apparatus) of the Nano Atomizer Reactor allows for mass production of tailored Chalcogel filters within the Nano growing chamber and in standalone or separate processes. The Chalcogel filter can be water jet trimmed to a desired chamber diameter and filter depth. Metals can be extracted using the Atomized Reactor to gasify and extract the metals by atomic weight through the Chalcogel filters. Traditional solvent or chemical extraction can be utilized for sulfur and other compounds, and the Chalcogel filters can be reused. Spent Chalcogel filters can be reversed flushed to clean, micronized in a ball or jet mill and atomized along with other waste streams such as slag, filter cakes and the like.

The Chalcogel filters can be utilized in the Power and Water Plant Super Reactor as shown in FIG. 25C to purify refinery waste streams including coal, water, syngas, spent and impure sulfuric acid, and sour water and to allow for the harvesting of metals and viable compounds. An important Chalcogel filtration feature of the invention is in its ability to separate, capture, extract and harvest actinides from coal being processed in the Pre-power Reactor and Pre-Pyrolysis Reactor in such quantities as to provide significant supplies to power facilities as premium fuels at a below market price. The Chalcogel filter can be used additionally or in lieu of a separate filter reactor by situating it in a transition area of the Atomized Reactor between the atmospheric and vacuum chambers.

The Chalcogel filters can also be used in the Pyrolysis process 400 to capture and harvest fullerenes vital for Nano production, to purify refinery gas streams and to allow for an efficient use of coal in power generation while maintaining a closed looped, and air emissions-free operation.

Chalcogels and Aerogels can be used for solar cells. The optical absorbance of these Chalcogels and Aerogels can correspond nicely to the solar spectrum, so these could be promising platforms for photovoltaic solar Cells and photocatalysts. In other words, such Chalcogels can provide the basis for more efficient and faster conversion of incoming light into electricity or to break down water into hydrogen.

The refining system 600 can include an intermetallic filter. The Chalcogel filters used in the Atomizer Reactor and Power and Water Plant Super Reactor (depicted in FIG. 25C) can be replaced with the intermetallic filter.

The intermetallic filter can be made out of a mixture of, for example, two metals. The mixture of two metals can be heated to nearly 1,000 degrees Fahrenheit and sprayed through a nozzle. Emerging as a fine crystalline powder, this intermetallic substance can be bonded to an inert substrate, such as carbon fiber. The coated substrate can be then packed into a hollow glass cylinder, creating a large interior surface. The greater is the surface, the higher is the efficiency of the filter. Crystals occur in an infinite variety of shapes. The shapes of crystals can be controlled by using certain chemicals. To remove sulfur, the intermetallic powder can be treated to produce a crystalline structure containing small pits that match the size and shape of sulfur molecules. By altering the crystalline structure, variants of the intermetallic filter can also be used to treat sewage and purify wastewater. Other embodiments of this invention relate to, for example, the removal and remediation of nuclear material, such as Actinide removal from coal by intermetallic filtration.

The intermetallic filter for removing sulfur can work best when the crude is mixed in an emulsion of water. In nature, petroleum is often found in that very sort of emulsion; and sometimes drillers create such emulsions by pumping water or steam into petroleum deposits to force out the crude.

Because of the polarity of oil molecules in a water emulsion, the petroleum's sulfur molecules tend to hide within clusters of hydrocarbon molecules called micelles. When sodium and calcium surfactants are added, the emulsion changes polarity and the sulfur molecules move to the surface of the micelles, where they are exposed to the intermetallic filter.

The intermetallic filter can not only remove the sulfur but also absorb the surfactants. By fine-tuning several parameters, such impurities as oxygen compounds, nitrogen compounds and organometallic compounds can also be extracted from crude.

In its natural, unprocessed state, crude oil is a mixture of hydrocarbon compounds, and the mixture is found in thousands of variations. After the crude's volatile compounds have been taken off, three main parts remain. The thickest, heaviest and most viscous compounds are classified as asphaltene. Next are the resins. Last are the lighter compounds, known as gas oils. In addition to removing impurities, the intermetallic filter can refine crude oil. When crude oil passes through it, some of the asphaltene can be cracked and upgraded into resin. The intermetallic filter can reduce the asphaltene content by about 20%. By changing the electrical current, the intermetallic filter also can do the reverse and turn some of the resin into asphaltene. This intermetallic filter can process oil without high temperatures and pressures such that the refining process is inexpensive and far more environmentally friendly.

The intermetallic filter can be a stable compound of materials such as tin and antimony and can have an integral porous structure or can be in the form of particles. It can remove trace metal ions such as Ca and Na ions. The intermetallic filter comprises particles that have an average diameter in the range of 1×10-6 m to 1×10-4 m. This is a particularly effective way of providing the filter. Small particles have a high surface area per unit volume and thus there is very effective attraction of the trace metals. The particles can be contained in a fluidized bed or in a column, or indeed can be added to fuel and later removed. The particles can be bonded by sintering to form a porous filter structure.

The filter comprises a porous structure. This is a convenient and effective implementation, for example, for use in a refining process. Preferably, the filter has porosity in the range of 30% to 50%, and preferably has permeability of 1×10-13 m2 to 400×10-13 m2. The filter can have pores with sizes in the range of 2 μm to 300 μm.

The refining system 600 can include nano-sponges comprising particles made of glass or natural diatomaceous earth to remove to remove arsenic from drinking water and to reduce the amount of mercury in crude oil. The particles are 5 millionths to 50 millionths of a meter wide and filled with holes a thousand times smaller. The surfaces of these particles can bear a variety of flavors or coatings that soak up specific toxic metals for instance; sulfurous organic coatings attract mercury, while coppery organic coatings bind to arsenic and radioactive metals known as actinides. The particles' spongy nature gives them an incredible 6,400 square feet to nearly 11,000 square feet of surface area per gram of material with which to draw in toxins.

The refining system 600 can include a Side Stream Finishing Reactor 680 as shown in FIG. 6C. The Side Stream Finishing Reactor 680 has been created as a superior filtering technology for retrofit of an existing reactor or as a reactor upgrade replacement. Following the atmospheric distillation process 602 or the vacuum distillation process 603, the Side Stream Reactor 680 can be utilized as a secondary guard filter ensuring fuel purity and preventing downstream poisoning. FIG. 6C shows a secondary side stream fuel purification following the atmospheric or vacuum distillation processes 602, 603.

The Side Stream Finishing Reactor 680 can include three separate processing chambers, such as a Naphtha processing chamber 690, a Kerosene/Jet Fuel processing chamber 691, and a Diesel Fuel processing chamber 692. Each of the three separate processing chambers can include a hydrogen feed line 681 and a hydrogen return line 682. Through the hydrogen feed line 681, hydrogen is supplied to each chamber of the three separate processing chambers. Such hydrogen can be supplied from the Power/Energy reactor 900 (shown in FIG. 9) lines as well as from the Hydrogen Plant within the Matrix.

The naphtha processing chamber 690 can be provided with a naphtha feed line 683 configured to feed naphtha to the chamber 690 where naphtha and hydrogen are mixed, creating a mixing zone, and an exit port 684 for purified heavy naphtha. Likewise, the Kerosene/Jet Fuel processing chamber 691 and the Diesel Fuel processing chamber 692 can be provided with a kerosene/jet fuel feed line 685 and a diesel feed line 687, respectively. Also, the Kerosene/Jet Fuel processing chamber 691 and the Diesel Fuel processing chamber 692 can be provided with exit ports 686 and 689 for purified kerosene/jet fuel and purified diesel, respectively.

Each of the Naphtha processing chamber 690, Kerosene/Jet Fuel processing chamber 691, and Diesel Fuel processing chamber 692 can include multi layered Chalcogel or X-Aerogel filters 693 configured for 100% contaminant removal. The Side Stream Finishing Reactor 680 can include electrical grids 694 configured to distribute electricity to each of the Naphtha processing chamber 690, Kerosene/Jet Fuel processing chamber 691, and Diesel Fuel processing chamber 692. In particular, the electrical grids 694 can be configured to sandwich the multi layered Chalcogel or X-Aerogel filters 693, allowing electrical current to maintain polarization. Additionally, the electrical grids 694 can be used to crack asphaltene into an upgraded resin or vise-versa in the Distillation Reactor 650.

The multi layered Chalcogel or X-Aerogel filters 693 can be replaceable and be constructed with high impact support composites to prolong the filters' life cycle. Each filter can be displaced such that it is sandwiched between the electrostatic grids 694 to aid in the extraction process of purified naphtha, kerosene, jet fuel, and diesel. It is also possible to magnetize the Chalcogel/X-Aerogel supports by the addition of metal within the polymer/substrate forming mixture.

Contaminants captured and contained in the Chalcogel filters 693 can be flushed from the filters by reversing the polarity current allowing for harvesting of the recyclable metals. Alternatively, the Chalcogel filters 693 can be sent to the Atomizer Reactor shown in FIG. 25B for the metal harvesting and Chalcogel filter destruction. The contaminants such as nitrogen, oxygen, vanadium, trace metals, fuel and oil additives, spent catalysts, halogen, phosphates, chemicals and sulfur can be captured in the Chalcogel/X-Aerogel filters 693.

The multi layered Chalcogel or X-Aerogel filters 693 can be used for or in replacement of bag-houses, electrostatic precipitators, filtration and processing of various gas streams, filtration and processing of electrolyte and sulfuric acid, soot filtration and fullerene processing, deasphalting, refinery guard bed reactors, reformers, fractionator, stripping columns, fuel sweetening/Merox process, isomerization, benzene filtration/hydrogenation in a fixed-bed reactor, Alkylation-Naphthene dehydrogenation in a catalytic reformer to form aromatic hydrocarbons, and catalyst extraction columns.

The filtration system created by Chalcogel, Aerogel, X-Aerogel, Sol-gel (aka solgel, Solgel, and interchanged throughout this application) and or Colloid support integration mixtures can be endless and creates an unparalleled new utility for cost savings to a refinery from a 100% filtration capability both up and downstream.

Via the numerous possible combinations of modules, it is also possible to remove the different additives blended into lubricant oil prior to sale and use. Since the EFSMP, does not need these additives, they can be separated, distilled, etc. and bifurcated into separate containers for sale into the market place. Additionally, as the state of the art of the technology continues to develop, it is a preferred embodiment of this invention (EFSMP) that the same additives can be used, on site, for incorporation as additives, blends, catalysts, and the like, into different fuels (as octanes, etc.), or for sale as cleaned Catalysts, and/or their respective additives, for the Refining Industry.

The present EFSMP can be constantly upgraded to be current with all economics, types of feed stock (e.g.: heavy or light oil, natural gas, gasoil, atmospheric residue, vacuum residue, shale oils, tar sands liquid and coal tar, refinery sludges, oil sands, bitumen, synthetic crude oil, and other heavy residues. etc.) and regulations (International, Federal, State, and Municipal). As with any multifaceted facility, and in specifics a refinery using a series of the EFSMPs, whether integrated modularly or on a modular by modular basis, the entire EFSMP requires and integrated refinery management system as well, for management such as Environmental management activities, utility management and overall refinery management (noise, odor, safety, maintenance).

### Cell 7: Asphalt Plant

In another embodiment of the present invention, the EFSMP can include an asphalt plant 700 as shown in FIG. 7. The asphalt plant can include an aggregate cold feed bin 701, a drying and heating process 702, a primary screening process 703, a secondary screening process 704, a pugmill mixer 705, mineral filler, hot binder, and a dust collector 706.

Asphalt is a sticky, black and highly viscous liquid or semi-solid that is present in most crude petroleum and in some natural deposits sometimes termed asphaltum. It is a carefully refined residue from the distillation process of the selected oils described above regarding the refining system 600.

In the distillation processes of the refining system 600, raw asphalt can be produced. The raw asphalt can be supplied to the pugmill mixer 705 of the asphalt plant from the hydrocarbon storage and blending 614 of the refining system 600 to produce the hot asphalt mix. Also, used asphalt concrete can be fed through the aggregate cold feed bin 701 into the asphalt plant 700. The used asphalt concrete can be dried and heated in the drying and heating process 702. The dried and heated used asphalt then can be fed to the pugmill mixer 705 through the primary screening process 703 and secondary screening process 704 to produce the hot asphalt mix.

### Cell 8: Sulfur Module

FIG. 8A shows the Claus Sulfur module used if so desired in the present matrix system and process. The Claus process is a known process used in prior art refinery operations and this process occurs in the “Claus Sulfur Plant” which is one way that the gas de-sulfurizing process can occur. The Claus Sulfur Plant module of the present matrix system and module serves to recover sulfur 802 from hydrogen sulfide. Sulfur in the crude oil feedstock is converted to predominately hydrogen sulfide (also called acid gas) during the cracking and hydrotreating processes at an oil refinery. The acid gas is removed from the cracking and hydrotreating process exhaust and is then sent to a sulfur recovery plant located within the present matrix system and process. The sulfur in the present matrix system and process arises from other sources than in the prior art and is one of the modules to which materials from other modules are recycled to produce useful products and energy. An example of such recycling in the present matrix system and matrix and process is the recycling of sulfur from lead storage battery breakdown.

Acid gas is combusted with air to form sulfur dioxide, which in turn is reacted with the hydrogen sulfide in the acid gas stream. The Claus process 8A recovers sulfur from the gaseous hydrogen sulfide found in raw natural gas and from the by-product gases containing hydrogen sulfide derived from refining crude oil and other industrial processes.

In another example within this embodiment of sulfur extraction, the sulfur separated from Cell 9, can be added to the sulfur dioxide, creating an exothermic reaction for heat capture, use, and electrical turbine generators, and the resulting sulfuric acid can be sent to the Solid Oxide Fuel Cells (aka SOFC) for processing back into the matrix.

The Claus Sulfur Plant module of the present matrix and system enables recovered sulfur to be used within the refinery to produce sulfuric acid. Oil refineries use sulfuric acid in isomerization and alkylation processes to increase the value of their petroleum products. If not, the sulfur can be sold for use in producing sulfuric acid offsite or for use in other processes requiring elemental sulfur. The sulfur removal process is usually the most cost-effective method of reducing refinery sulfur compound air emissions.

Moreover, FIG. 8B illustrates another embodiment of Cell 8.

### Cell 9: Power Plant

FIG. 9 shows Cell 9 which comprises a matrix of symbiotic technologies that fit together in a close-looped system that utilizes water, coal, sulfuric acid, and hydrocarbons in combination with mechanisms to accomplish desulfurization, the harnessing of heat from exothermic reactions, power generation, and the reuse of effluents, including but not limited to coal and waste feed oil.

Further, FIG. 9 shows an embodiment which is an energy efficient, closed loop, emission free, waste free, and toxic free system which enables an energy efficient closed loop emission free and toxic free refinery matrix system and process. It is a chart showing one embodiment of a matrix of technologies that are put together in a novel way. The present embodiment uses the best available techniques, (on a case by case basis) processes, methods, equipment, technology, which can be constantly upgraded and updated so that the present EFSMP can be current with all economics, types of feed stock (e.g., heavy or light oil, Peat, natural gas, synthetic gas/syngas, gasoil, atmospheric residue, vacuum residue, shale oils, tar sands liquid and coal tar, refinery sludges, oil sands, bitumen, synthetic crude oil, and other heavy residues. etc.,) and regulations (International, Federal, State, and Municipal). As with any multifaceted facility, and in specifics a refinery using a series of EFSMPs that are described, disclosed and claimed in this application, whether integrated modularly or on a modular by modular basis, the entire EFSMP requires an integrated refinery management system as well, for management such as Environmental management activities, utility management and overall refinery management (noise, odor, safety, maintenance.)

FIG. 9 of the present invention incorporates reactors and processes, in which Sulfuric Acid, recovered from the operation and also encompasses acid recovered from the battery plant, as well as sour water. Also, see the preceding section, as well of the present matrix system and process, is filtered, passed through a membrane of solid oxide fuel Cells 901, broken down into Sulfur Oxide, Sulfur Trioxide, and the like (e.g., SOx). The effluent is then passed into a system where municipal water, filtered water, or on-site created water, is added, thus creating steam and heat in an exothermic reaction. The heat created is captured as energy by placing heat turbine generators strategically throughout the facility through a Pinching Analysis study, and the like, and also incorporating steam turbines 902 and the like. The effluent is then reconstituted into sulfuric acid, which can be used to run fuel cells. Also, as stated before, that since Oil refineries use sulfuric acid in isomerization and alkylation processes to increase the value of their petroleum products, the present embodiment includes return lines going back into Cell 6 of the Flow Chart Matrix so that the Sulfuric Acid can be reused. This feature is part of the closed loop of this embodiment, and self sufficiency of present invention.

Overall, the present EFSMP will take the existing sulfuric acid (lead acid) from batteries (e.g. Cell 5 which relates to the Battery Plant) and pass it through an EFSMP to refine it, recycle it, recover it, or redistill it, as necessary. In the EFSMP, there could be a means for refining and cleaning the sulfuric acid (in the present invention sulfuric acid is defined by the inventors as sour water, sulfur trioxide, sulfur dioxide, sulfuric acid, and the like) using technologies also found in fuel-Cell technology, where the sulfuric acid is broken down, for refining, cooled off where and if necessary through a series of heat exchangers, cooling towers, cooling EFSMPs, and the like—either in a single pass or multiple passes, and as the H2SO4 passes through the membrane of the fuel cell, Hydrogen (H2) is stripped off, and oxygen (O2) is stripped off, creating energy for the fuel Cell and the adjacent refinery. What remains is pure sulfuric trioxide (SO3). As soon as the SO3 is isolated it can be reconstituted back into H2SO4 simply by adding water (H2O) where the mixture generates substantial exothermic (heat producing) energy that can be collected to further produce electricity for the refinery (by use of a steam turbine). When additional hydrogen which is not produced from the facility's energy plant utilizing fuel Cell technologies is needed, the hydrogen can be collected.

On the left side of FIG. 9, a waste oil feed is shown entering the Electric Arc Hydrogen Plasma Black Reactor 909. The Electric Arc Hydrogen Plasma Black Reactor 909 extracts compounds and elements that can be sent through a filtration system 910, such as the distillation reactor (shown in FIG. 6B) described above with regard to Cell 6. By-products, including ash, sulfur, and carbon black can be pulled out. Due to the efficiency of Aerogel, Chalcogel, x-Aerogel, Colloids and the like, placement of this material to immediately and continuously process H2SO4.

Coal is shown as another feed stream at the top left portion of FIG. 9, which enters a coal feed pulverizer 911 and coal pelletizer 912 for pre-processing of the coal containing feedstock prior to entering the rotary tilt reforming reactor 913. Such rotary tilt reforming reactor 913, described in the present invention, can remove slag 904 and ash 903 from the coal. A Pre-Pyrolysis Reactor can be used to process ash, fines, soot, pieces, etc., are prior to Pyrolysis and ash 903 from the coal. The ash 903 can then be used in the heat recovery steam generator 914, rather than being discarded as it is with traditionally known technologies. It is the Pre-Pyrolysis systems/reactor that also (with atomized particulate) is able to further remove other compounds, rare earths, soot, metals, lead, mercury, actinides, etc. from the ash. Also, as Methane is a byproduct of Coal sintering, and pyrolysis, the methane can be converted to Syngas. Syngas, from the Methane, as derived from the coal, is then processed/converted into gasoline. Gasoline, being a saleable end product of the present invention and matrix. This methane is process and application derivative also known as coal gasification, aka coal to liquid, aka coal to fuel (all known by the acronym of CTL. These CTL are known to someone of ordinary skill in the art, at the Sasol CTL plant in S. Africa, and elsewhere. However, CTL is not often practiced outside of S. Africa due to the escape of Carbon emissions and Green House Gasses (GHG), which the present EFSMP captures, sequesters, and turns back into material for r Nanotubes (see the nano plant), and other products. Materials to support, as well as describe the Sasol systems, are found in the any general “reference library.” All of this, again, makes our EFSMP closed loop.

Additional inputs to the heat recovery steam generator 914 can be sulfur oxide and water. The ash 903 and the sulfur oxide enter the heat recovery steam generator 914 for further processing in the steam turbine 902. The steam turbine 902 is one mechanism, described in the present invention, which can also be used for power generation, including alternating 915 and direct 916 current electricity generation, as is shown in the bottom right portion of FIG. 9. The mechanism by which the turbine can be used to produce electricity and purify water is described below and is shown in FIG. 25C.

FIG. 25C is an embodiment of the Power Production and Water Plant Super Reactor as one system. Alternatively, the Power Production Reactor and Water Plant Super Reactor can operate as standalone technology operating independently.

In a preferred embodiment, the Power Production and Water Plant Super Reactor is a submerged bottom-up stream reactor system. The system is submerged, inter alia, so that the streams are less dense and thus the flows within the reactor can rise more rapidly and increase pressure more efficiently, which is advantageous in a power generating turbine apparatus, such as the one described in the present invention.

The steam generator 914 is fed with an input stream of water as described in FIG. 25C. Some of the water feed is used for the steam generator and further power generation, described above and additional steam is sent to the sour water stripping tower 917 so that the sulfur can be stripped. A sour water stripper 918 is also used for this water feed to make sure that sulfur is removed efficiently. This mechanism is shown in the lower middle portion of Cell 9.

Also, after passing through the rotary tilt reactor slag 904 soot, and ash 903 are removed from the coal, the effluent moves to an electrostatic precipitator 919, which is used to efficiently filter the stream from impurities prior to entering the venture scrubber 920, where the atomization process will begin as molecules and elements will be separated based upon their molecular weights. It should be noted that a sorbent injector 922 is used to feed the electrostatic precipitator 919 to begin this filtration process. A sorbent injector 922 is the most efficient way to control the emissions of mercury, volatiles, actinides, metals, gasses, and contaminants, into the atmosphere and the environment. As such, a control mechanism such as this is of vital important to the ability to filter mercury through the system described above.

Once the atomization process or reactor separates the molecules based upon their molecular weights, the effluent feeds the pulse jet bag house 921 in the final step of the filtration process. Then mercury, gold, rare earths, pollutants, toxins, precious metals, actinides, and the like (for example) extraction process is effectuated. The extracted materials, included mercury, can be stored in the storage tank 922 shown in FIG. 9. Any number of storage tanks, although FIG. 9 shows only one tank. This process is described in detail below, as it is shown in FIG. 10 and is incorporated in the present invention by reference.

A water gas shift reactor 923 is used to create carbon dioxide and hydrogen. The water-gas shift reaction is an important industrial reaction. It is often used in conjunction with steam reforming of methane or other hydrocarbons, which is important for the production of high purity hydrogen for use in ammonia synthesis. The carbon dioxide and hydrogen can then be separated within the gas separator 924 prior to entering the gas turbine 905, where steam, for example, can be used to create additional power. Any and all excess hydrogen can be fed into the hydrogen plant for distribution to needed processes and reactor treatment or, for example, the Water/Power reactor for use to create Water. This is another example of “closed loop” of the present Matrix Invention. As for Methane, as per the previous description and use of methane, as derived from Coal, please refer to a feed line that can connect the methane from the CTL process to manufacture, syngas, and gasoline. The constant closed-loop mechanism to generate additional power from steam, for example, will ensure self-sufficiency, which is inherently tied to cost effectiveness and efficiency.

The direct carbon fuel Cell 925 will feed into a steam boiler rankine cycle 926. A rankine cycle, generally, is a model of a steam operated heat engine most commonly found in power generation plants and is a component of the present invention. Common heat sources for power plants using the rankine cycle 926 are the combustion of coal, natural gas and oil, which this plant includes, but is not limited to.

Additionally, but not limited to placements of technologies utilizing, but not limited to, Pinching Analysis, and the like, this EFSMP utilizes technologies and apparatuses, and reactors, in parallel, combination, hybrid, or separately, and the like, whereas heat used from power to dehydrate water biologics can be employed, and organics, for example, in the water processing plant—a series of equipment, and autoclaves can be used, or a reactor/s, to heat up flows, and direct heat where needed; thus reducing piping costs, and exposure of pipes to corrosions, whether internal or environmental, prevents precipitation from rotting out pipes, as well as reducing capital costs using Syngas to create power. Syngas, as above, can optionally be fed into the Syngas lines, from the CTL system to also create gasoline, as per user defined parameters and configuration of the matrix.

The process data can be represented as a set of energy flows, or streams, as a function of heat load (kW) against temperature (degrees Celsius). These data can be combined for all the streams in the plant to give composite curves, one for all hot streams (releasing heat) and one for all cold streams (requiring heat). The point of closest approach between the hot and cold composite curves is the pinch temperature (pinch point or just pinch), and is where design is most constrained. Hence, by finding this point and starting design there, the energy targets can be achieved using heat exchangers to recover heat between hot and cold streams. In practice, during the pinch analysis, often cross-pinch exchanges of heat are found between a stream with its temperature above the pinch and one below the pinch. Removal of those exchanges by alternative matching makes the process reach its energy target.

In addition to being a Renewable Energy, Clean Energy, and a closed loop system, with zero emissions, the invention embodiments could also be classified as a “green refinery” EFSMP, in that it will use the latest clean process technologies, producing ultra-low Sulfur fuels, gasolines, etc., where precuts can be sent out by truck, rail, pipeline, and tanker where available. Cleaner energy technology, fuel Cells using sulfuric acid, and an Integrated Gasification Combined Cycle (IGCC) using petroleum coke, are each identified “Green Energy” systems that the EFSMP will use.

As part of the fuel Cell technology component of the energy plant configuration, and the needs of a standalone EFSMP, as well as those of an integrated EFSMP with byproducts, Applicants disclose that in addition to using fuel that is generated by the EFSMP to power generators, as well as public utility electricity consumption, the EFSMP Texaco Gasification Power Systems (TGPS) can be used, heat integration, air separation units that power steam-driven compressors and turbines, and the like, either in a hybrid EFSMP format or stand-alone, depending upon economic needs (cost, sales, and by-products,) redundancy, capacity, and the like. Heat recovery steam generators, as part of the energy plant EFSMP, may also be utilized throughout the embodiments, and without limitation to any byproducts that may be generated, produced, or sold, in any form or capacity. This embodiment may also utilize Cogen generators, similar to the Jun. 22, 2007-exempted ones mentioned in the California Energy Commission brief, in which in addition to the generator, a series of cooling towers may be used in new hydrogen production.

In addition to fuel Cell technology, and the like, sulfuric acid can be regenerated by EFSMPs like that of a regeneration furnace or refractory, where the material is atomized and then used in supplemental acid production. Exothermic reactions generate heat that is recaptured in turbines to be used for energy reclamation, either in upstream or downstream processes.

Water can be added, or removed, as is necessary to provide the optimum economy for acid reclamation, regeneration, and energy creation.

As economic profitability of the EFSMP in this embodiment is an obvious requirement, by integrating multiple EFSMPs, and seeing to it that they are all interconnected, by numerous EFSMP systems presents a synergy that is exclusive to this embodiment. By having integration for all EFSMP units, heat integration for efficient use of low level heat, common sulfur removal and acid gas removal EFSMPs, also will reduce and minimize required compressions costs for Hydrogen.

The EFSMP can also be used to capture exothermic energy in the form of turbines, nanotube water filtration and hydrogen extraction/separation, and the like from such process as hydrogen from catalytic reforming units, and methanation. Where cooling is necessary for plant equipment or feed stocks, combinations of EFSMPs can perform such cooling (without limitation imposed by cooling towers, etc.,) or use steam reforming methods (also used for Hydrogen gas generation.) Steam/methane reforming technologies, supplemented by induced, substantial upward and downward variations in ambient temperatures can help maximize production of Hydrogen gas. In addition the preceding language, other forms of Hydrogen production are included in the embodiments in the present application, to be engineered in accordance with the specifications required for any given site. Examples exist industrially (though in this embodiment, EFSMPs are not limited to any combination, either singularly or in entirety,) e.g., the co-project Air Products and Technip designed, as used by Marathon Petroleum Oil of a) feed gas hydrodesulfurization; b) steam-methane reforming; c) water-gas shift conversion; and, d) hydrogen purification. Nitrogen can be process-removed from an array of EFSMPs. The Nitrogen can then be marketed for use in fertilizers, and other common uses.

Fuel Cell technology (as described above) reduces the need for refrigerators to cool down the H2SO4 slipstream before it is recycled, as the process is endothermic. Where there is an exothermic reaction (Heat) being radiated during the distilling, recycling, refining, and reconstituting of sulfuric acid, (from adding H2O to the residual sulfur trioxide produced by the fuel Cell system,) steam turbines will easily produce additional electricity.

While there are still needs for cooling systems throughout the EFSMP as determined by the different configurations, there will also be a probable need for additional energy to power such systems. The EFSMP hybrid/combination operations allow for an in-series application, as well as a stand-alone. Other than exothermic-heat harnessing turbines, sources of generation for the power systems (energy) are refinery fuels—those generated from the different methods (as by-products,) and via those specialized uses and purposes for any individual EFSMP location Additional methods of power generation, could be permutations of gas and steam cogeneration, integrated gasification combined cycles, etc. Additionally the Shell Gasification Process is the basis for an IGCC, which produces hydrogen in addition to power. A gas turbine combined cycle is the most efficient way to produce power from the syngas. The refinery steam network can be used for supplying steam to the existing steam turbines. As solar power, and wind energy (renewable energy) technology develops, such methods and EFSMPs can also be incorporated where and when necessary. Energy, electricity, and power can be obtained from Nuclear, Intra-Plant, Secondary, Tertiary, and other public and private source including, but not limited to companies like Duke Power and Energy, Florida Power and Light, where such energy can be purchased directly from the public utility, or brokered, traded, bought, and sold on the open market. Either a network grid, or wireless method of transmission can be utilized—whether terrestrial or super-atmospheric in nature.

Oxygen and Hydrogen are by-products of fuel Cell technology methods in practice, and are part of the power plant EFSMP configuration. These gases, including syngas, can be cooled, compressed, and tanked for either open market resale, or reuse at the refinery.

The electrical requirements and usage of the embodiment in the present invention has the capacity, potential, ability, and the like, to be self-sustaining, and a closed looped and self-contained. The electrical power needs of the EFSMP in the present invention can be independent or in combination of non-internally generated power, and can be further understood and integrated by someone skilled in the art, to produce a hybrid or combination, or stand alone, or solely foreign (non intra-generated power) electricity.

### Cell 10: Electrostatic Precipitator

FIG. 10 shows Cell 10 which comprises an electrostatic precipitator (ESP) 1001, or electrostatic air cleaner that collects particles from air and from a flowing gas (such as air) using the force of an induced electrostatic charge. In this particular embodiment, the flowing gas is sulphur dioxide (SO2), which is shown as a feed stream entering the ESP 1001.

Electrostatic precipitators 1001, such as the one shown in FIG. 10 are highly efficient filtration devices that minimally impede the flow of gases (such as sulphur dioxide gas) through the device, and can remove fine particulate matter such as dust and smoke from the air stream. The ESP 1001 applies energy only to the particulate matter, making it very efficient with respect to its consumption of energy (in the form of electricity).

Although FIG. 10 shows the gas stream being sulphur dioxide, other gases can be used, such as sulphur dioxide, Propane, Nitrogen, Hydrogen, Argon, and the like. For example, sulfur trioxide can be used to lower the resistivity of the particles in order to improve the collection efficiency of the ESP.

Once the ESP 1001 collects and removes the particles from the sulphur dioxide or other gas, the particles are fed to the Venturi Scrubber 1002, which is shown directly below the ESP in FIG. 10. The venturi scrubber 1002 (also known as an ejector) controls the pollution from the ESP. It is conventionally installed on the exhaust flue gas stacks of large furnaces, but can be used on any number of other air exhaust systems. The venturi scrubber 1002 is attached to a cooler 1011, which is more commonly known as an evaporative cooler or quencher section. The cooler 1011 helps to accommodate the highest of temperatures within the system in a safe and efficient manner, as it is described in U.S. Pat. No. 4,981,500 for “Venturi type cooler for flue gas desulphurization device” to Krause and Schulz, which is incorporated herein by reference in its entirety.

The ejector venturi is unique among available scrubbing systems since it can move the process gas (e.g., the sulphur dioxide) without requiring the assistance a blower or a fan. The liquid spray coming from the nozzle creates a partial vacuum in the side duct of the scrubber. This partial vacuum can be used to move the process gas (e.g., sulphur dioxide) through the venturi as well as through the facility's process system.

The energy for the formation of scrubbing droplets comes from the injected liquid. The high pressure sprays passing through the venturi form numerous fine liquid droplets that provide turbulent mixing between the gas and liquid phases. Very high liquid-injection rates are used to provide the gas-moving capability and higher collection efficiencies. As with other types of venturi systems, the entrained liquid must be separated from the gas stream. One device to separate the liquid from the gas stream is an entrainment separator, which is a device that is commonly used to remove remaining small droplets.

From the venturi scrubber, the stream enters the wet electrostatic precipitator (WESP) section 1003. A wet electrostatic precipitator (WESP) operates with saturated air streams (e.g., streams of air having 100% relative humidity). One type of WESP 1003 uses a vertical cylindrical tube with centrally-located wire electrode (gas flowing upward) with water sprays to clean the collected particulate from the collection surface (plates, tubes). The collected water and particulate forms a wet film slurry that eliminates the resistivity issues associated with dry ESP's. Another type of WESP 1003 (used for coke-oven gas detarring) uses a falling oil film to remove collected material.

After leaving the WESP, the stream goes to the Boliden Norzink (Norzink) Mercury removal section 1004.

Norzink Mercury removal is a process developed for removing mercury from roasters. It consists of spraying wash solution into a scrubber tower where the gases are cleaned in a counter current flow. Part of the wash solution from the bottom of the tower goes back into circulation and part of it goes into a sludge separator. The solution from the separator is returned to the scrubbing liquid circuit or is diverted from the process, while part of the sludge containing mercury chloride is transferred to an oxidation plant, where mercury is oxidized, which is returned to the system. The rest of sludge containing mercury chloride is removed and sequestered from the system as a raw material for mercury production.

The stream enters the ESP originally from the right side of FIG. 10 through a Cyclone Separator 1005. Cyclonic separation is a method of removing particulates from air, gas or water, without the use of filters. It does so through vortex separation, which is similar to a centrifuge, which uses gravitational forces to separate the particulates.

Specifically, the cyclone creates a high speed rotating air flow within a cylindrical or conical container 1005. Air flows in a spiral pattern, beginning at the top (wide end) of the cyclone and ending at the bottom (narrow) end before exiting the cyclone in a straight stream through the center of the cyclone and out the top. Larger (denser) particles in the rotating stream have too much inertia to follow the tight curve of the stream and strike the outside wall, falling then to the bottom of the cyclone where they can be removed. In a conical system, as the rotating flow moves towards the narrow end of the cyclone the rotational radius of the stream is reduced, separating smaller and smaller particles.

An alternative cyclone design uses a secondary air flow within the cyclone to keep the collected particles from striking the walls to protect them from abrasion. The primary air containing the particulate enters from the bottom of the cyclone and is forced into spiral rotation by a stationary spinner. The secondary air flow enters from the top of the cyclone and moves downward toward the bottom, intercepting the particulate from the primary air. The secondary air flow also allows the collector to be mounted horizontally because it pushes the particulate toward the collection area.

Large scale cyclones are used in sawmills to remove sawdust from extracted air. Cyclones are also used in oil refineries to separate oils and gases, and in the cement industry as components of kiln preheaters. Smaller cyclones are used to separate airborne particles for analysis.

Analogous devices for separating particles or solids from liquids are called hydrocyclones or hydroclones. These may be used to separate solid waste from water in wastewater and sewage treatment. Any of these types of cyclones may be used in the present invention.

The QSL Reactor 1006 feeds into a slag granulation system 1007 and a pre-decopperizing 1008 system. Slag is a partially vitreous by-product of smelting ore to separate the metal fraction from the worthless fraction. It can be considered to be a mixture of metal oxides; however, slag can contain metal sulfides (see also matte) and metal atoms in the elemental form. While slag is generally used as a waste removal mechanism in metal smelting, they can also serve other purposes, such as assisting in smelt temperature control and minimizing re-oxidation of the final liquid metal product before casting.

From the QSL Reactor 1006, the heat and off gas enter a Waste Heat Boiler 1010, which recovers heat and increases fuel and energy efficiency.

Ground granulated slag 1007 can be used in concrete in combination with Portland cement as part of a “blended cement.” Ground granulated slag 1007 reacts with water to produce cementitious properties. Concrete containing ground granulated slag develops strength over a longer period, leading to reduced permeability and better durability. Since the unit volume of Portland cement is reduced, this concrete is less vulnerable to alkali-silica and sulfate attack.

When iron ore is heated in a blast furnace, the impurities or ‘slag’, which include large quantities of calcium and silica, become molten and are separated from the raw iron.

As the slag is channeled out of the furnace, thousands of gallons of water are poured over it. This rapid cooling, often from a temperature of around 2,600 degrees Celsius, is the start of the granulating process. This process causes several chemical reactions to take place within the material, and gives the slag its cementitious properties.

The water carries the slag in its slurry format to a large agitation tank, from where it is pumped along a piping system into a number of gravel based filter beds. The filter beds then retain the slag granules, while the water filters away and is returned to the system.

When the filtering process is complete, the remaining slag granules, which now give the appearance of coarse beach sand, can be scooped out of the filter bed and transferred to the grinding facility where they are ground into particles that are finer than Portland cement.

This previously unwanted recycled product is used in the manufacture of high performance concretes, especially those used in the construction of bridges and coastal features, where its low permeability and greater resistance to chlorides and sulfates can help to reduce corrosive action and deterioration of the structure.

Copper dross 1009 is an end product of slag granulation 1007. Dross is a mass of solid impurities floating on a molten metal. It appears usually on the melting of low-melting-point metals or alloys such as tin, lead, zinc or aluminum, or by oxidation of the metal(s). It can easily be skimmed off the surface before pouring the metal into a mold or casting flask.

With tin and lead, the dross can also be removed by adding sodium hydroxide pellets, which dissolve the oxides and form a slag.

Dross, as a solid, is distinguished from slag, which is a liquid. Dross product is not entirely waste material; aluminum dross, for example, can be recycled and is used in secondary steelmaking for slag deoxidation.

In the electronic wave soldering process, dross can account for over 50% of the metal required. With the advent of lead-free solders, the cost of replacing metal lost to dross has become unacceptably high. Dross also reduces the expected quality of the solder joint as measured in defects per million opportunities (DPMO).

### Cell 11: Sulfuric Acid Processing

Cell 11 is the sulfuric acid processing and manufacturing module. Lead batteries can be separated and treated by a specialized recycler. Nickel cadmium, nickel metal hydride and lithium ion batteries can be treated by a separate process. Silver oxide button Cells can also be taken for special treatment.

Lead acid (typically H2SO4: Sulfuric Acid) can be re-refined, and then sold off as glass cleaner or multi-surface cleaner, (in varying diluted strengths,) if not used for other commercial purposes. Additionally, there are numerous forms of Sulfur extraction, also known in the present invention as desulfurization, and not limited to just that of Sulfur, but can also include Hydrogen extraction, from the EFSMP, in as much as metal-oxide sorbent/s, zeolite/s, silica/s, and the like, at different pressures, and various temperatures, are used on Oil Coke, Coal, gases, and the like.

Turning to FIG. 11, a combustion furnace 1101 and waste heat boiler 1102, as shown as two of the mechanisms by which temperature and pressure can be varied. In a preferred embodiment, a combustion furnace 1101 can treat sulfur from the combustion furnace before sending it to a waste heat boiler 1102 and catalytic converter 1103.

Use of the combustion furnace 1101; waste heat boiler 1102; and catalytic converter 1103 work to greatly reduce the toxicity of emissions of the sulfuric acid, as well as the other fumes that are given off.

After passing through the catalytic converter 1103, the effluent enters the economizer 1105 increases the efficiency of the energy consumption mechanism of the entire processing and manufacturing module. The economizer 1105 works as a standard heat recovery system, which can prevent flooding of the waste heat boiler 1102 with liquid water that is too cold to be boiled given the flow rates and design of the waste heat boiler 1102. However, the design of this particular waste heat boiler 1102 is not limited.

Steel components are also recycled for production, whereas the electrolyte and sulfuric acid is treated in such a manner that it chemically reduces to anhydrous sodium sulfate: it is then supplied for use in the production of detergents, papers, glass, and for anodizing processes.

In another example of this embodiment, but not limited to, is that the Zinc is processed to create Sulfur and Sulfuric Acid, which is sent to the Sulfuric Acid Plant and the Thermal Atomization Reactor of such.

Such slag refining is used for the in-house refinery products such as the lead materials found in lead/acid batteries and their recycling, zinc and zinc ores used in-house to make sulfuric acid, and for lithium and any/all other materials as found in the lithium batteries.

The present EFSMP will take the existing sulfuric acid (lead acid) from batteries and pass it through an EFSMP to refine it, recycle it, recover it, or redistill it as necessary. In the EFSMP, there could be a means of refining and cleaning the H2SO4 using technologies also found in fuel-Cell technology, where the sulfuric acid is broken down.

For example, in a Zinc Sulfate solution, from Zinc, the solution must be very pure for electrowinnowing to be at all efficient. Impurities can change the decomposition voltage to where the electrolysis Cell produces mostly Hydrogen instead of Zinc metal, as described as Zinc Smelting according Wikipedia.

In as much as Hydrogen is a necessary product for Sulfuric Acid, the embodiment in the present invention of the EFSMP may not necessarily need a specific Hydrogen Plant, but can include one if necessary, or the technology either as a standalone or in combination of the Zinc Smelting that takes place in the Sintering Plant/Reactor or Heat Exchanger 1106, to produce any required Hydrogen (H) for either internal use, or for tanking and resale to consumer markets. Internal use can also be intra-corporate/intra-refinery as well as inter-corporate and inter-refinery operations.

This embodiment includes any excess SO3, S, SO2, and the like, regardless of form, that is generated/produced from such SMP as Sintering and Fuel Cell technologies, that is not used in-house, can be sold to the market, through companies such as DuPont, any of their competitors, or any supply houses that serve the petrochemical industry or other industrial and manufacturing needs.

In the event that additional H2SO4 is needed, Zinc is brought onto the campus, also known as a refinery, and through common off the shelf technology (COTS), H2SO4 is made and the process of plant use, refining, reclamation, and energy generation and production processes are repeated. In addition to the process of creating H2SO4, the EFSMP also can be used to remove toxic metals from the feed.

### Cell 12: Lead Smelter Plant

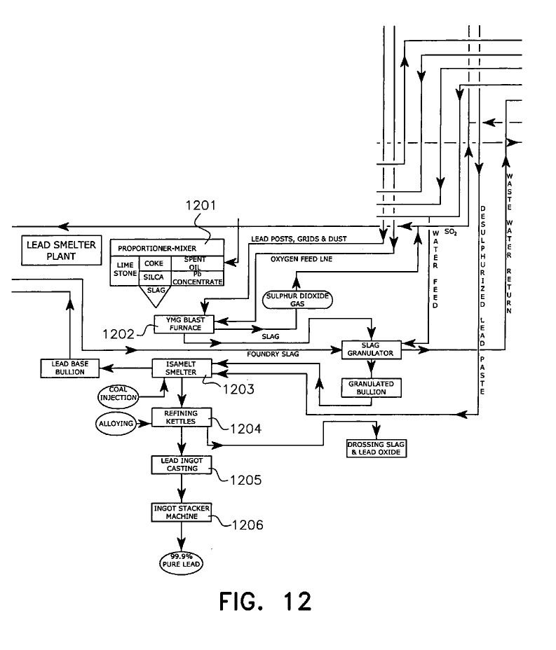

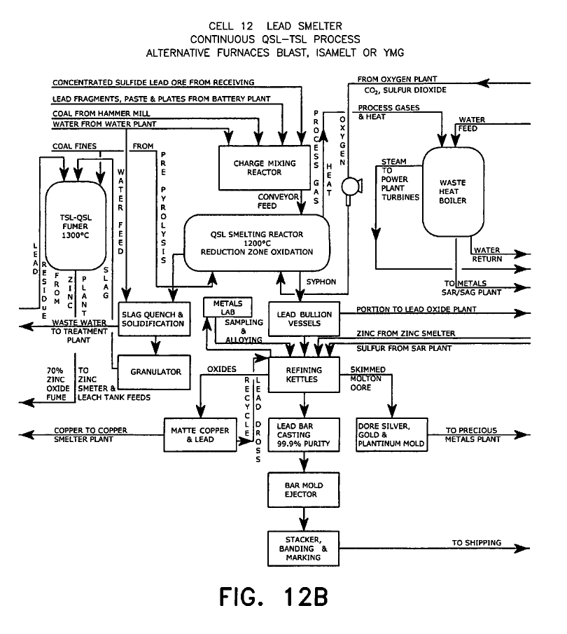

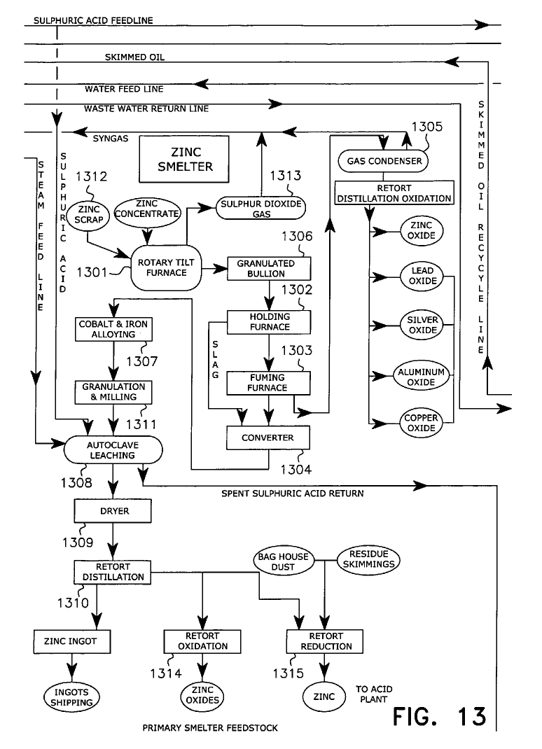

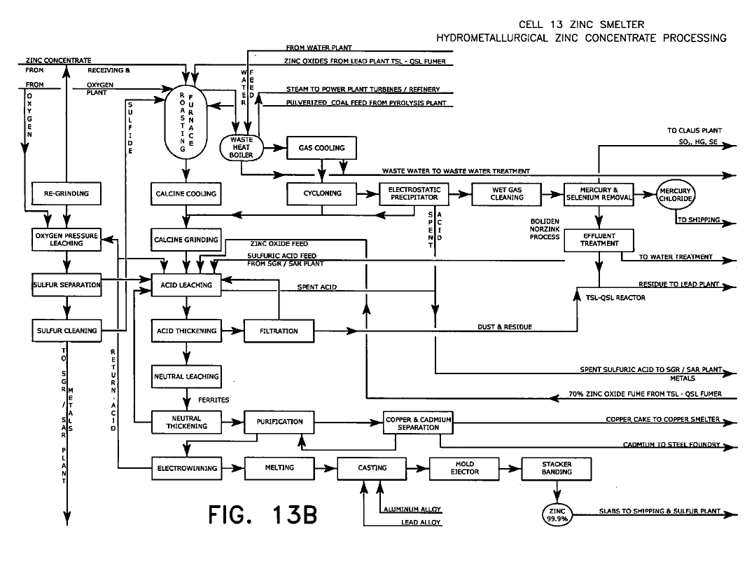

FIG. 12 depicts Cell 12, a steel foundry and lead oxide production in which steel and lead from other Cells of the present matrix system and process can be converted into useful end products.

The YMG Blast Furnace 1202 has the advantage that, generally, at least 40% of the lead in feed will go directly into the smelting furnace, which, in this case, is the Isamelt smelter 1203. This type of smelter is smaller and can be readily enclosed to eliminate emissions.

From the smelter 1203, the products will then feed into refining kettles 1204, which will melt all of the non-ferrous metals for use in the lead ingot casting 1205 section. The lead ingot casting 1205 will produce the appropriately casted alloys before entering the ingot stacking machine 1206, shown at the bottom of the present figure. A final byproduct of the lead ingot casting system is 99.9% pure lead product.

It is a further desire of the present invention to function, but without limitation, with such technologies as can also be employed in Reactors of Variable lengths and widths, and capable of temperatures to 10,000 degrees Celsius, Excellent air flow uniformity, Easy internal access to facilitate maintenance, Coal, Electric or gas fired, Optimal temperature uniformity, Operator isolation from effluent, Highest Energy Efficiency, Fastest line speeds, Thermal Recovery Systems, Surface Treatment Systems, Multiple Sizing Agents, Multiple Electrolyte Solutions, Clean and Hygienic, Non Contact Drying, Flexible System Designs, Unique Gases (e.g.: Argon, Nitrogen), Large capacities (multiple muffle systems), Atmosphere Control, Reduced energy costs, Excellent temperature uniformity, with features, not limited to, but can include Multiple temperature control zones, Proven alternating cross flow design, Adjustable louvers and diffuser plates for precise temperature adjustment, Rigid roll stands, Integrated brush roll assemblies, Excellent float end seals for positive sealing, minimized infiltration of ambient atmosphere and improved temperature uniformity, Aluminized steel construction, Plug fans to facilitate maintenance, Carburization resistant muffle, Low profile muffle for gas flow control, Process gas distribution and sampling system, Proven purge chamber gas curtain technology, and the like.

In addition to the previous feed stocks, mentioned in the present invention, the invention detailed also includes such effluent streams, but are not limited to feeds such as are also known as Mixed Waste, shown in the figure within the proportioner-mixer 1201, whereas such feeds are a direct result of processing oil, coal, in which the technologies utilized produce additional feed stocks, and effluent streams from such industries, but are not limited to those of pyrometallurgy, effluent streams, waste water stream, pyro hydro metal stream, filter cakes (liquid, dust, solid), metal extrapolation, feed streams, mercury extractions, lead extractions, oil extractions, and the like. The invention embodiment in the present invention meets, and beats the targeted reduction goals, and best demonstrated available technology that is currently available, but not limited to that of the

United States EPA, the United States DOE, and other governmental (United States and non United States) Mixed Waste Integrated Program, the Mixed Low-Level Waste Program, such as those used with 3M-IBC Membranes, those of the Boliden-Norzinc Process.

The invention uses a SMP of collection of waste products, for recycling, re-use, and as a source of feed stock, similar to the curb side, and commercial waste collection services provided by Waste Management, and the United States Military, of products such as used lubricants, lead acid batteries, used tires, and the like.

Steel components are also recycled for production, whereas the electrolyte and sulfuric acid is treated in such a manner that it chemically reduces to anhydrous sodium sulfate: it is then supplied for use in the production of detergents, papers, glass, and for anodizing processes. The lead paste and oxides are de-sulfured with soda ash (recycled from the steel industry,) filtered, and reclaimed as metallic lead (through furnace refraction) for reuse in new batteries. Then polypropylene, ABS, and other plastics are cleaned, isolated, and sorted for reuse in production. Afterwards, grid separators, fiber edonites, and miscellaneous materials are cleaned and combined as reverberatory fuel filler.

Precious metals such as germanium, rhenium, palladium, platinum, gold, silver, and aluminum, as well other elements categorized in this embodiment, can be extracted from a refractory ore, and petroleum with a stream using a conventional leaching step or a Super Reactor in which atomization is incorporated with thermal properties. The refractory ore, ores, metals, fluids, plasmas, feed stocks, and the like are also pretreated, when desired, by fine grinding and an initial leaching step, but is not limited to the restriction of such steps as to viability. Oxygen, also defined as gas, air, enhanced air, enhanced gasses, and the like, and is either individually or combined in any form, or in any pressure, or not under any pressure, is added to the initial leaching step and the conditions are carefully controlled to only partially oxidize the ground ore. Any step of the EFSMP can be carried out at any temperature or atmospheric pressures without limitation or restriction. The pre-treated ore is then leached to recover the precious metal.

As part of the baseline feed stock introductory process (at a point where it will be possible to control the nature of the feed stock—taken from any of the above materials) used in the EFSMP, a desalting entry point is likely, as well as a hydrotreating point in which hydroconversion EFSMPs occur and/or where necessary, but not exclusively, and in any combination thereof, also include Hydrotreaters, of which, in principle, at least three reactions are taking place, but not all three at the same time, or in unison/tandem, or in hybrid form, at that site: hydro-demetallisation, hydrotreating/hydrogenation and hydrocracking. Removal of the metals from the residue feed predominantly occurs in the first reactor(s) and uses a low activity Co/Mo catalyst. Hydrotreating, hydrogenation and hydrocracking occur in the following reactor(s) where the quality is mainly improved by increasing the hydrogen-to-carbon ratio.

Furthermore, such practices those used for, and in, but not limited to, and used either individually, or in combination, as part of the matrix of technologies described in the present invention as those such those found in a electrolytic lead refinery, electro ceramics, Isamelting, slag fumers, Induction Plasma Arc's, Induction Coupled Plasma Arc's, Radio Frequency Plasma Arc's, Thermite Plasma Arc's, slag fuming, as well as incorporating Ultra-Violet (UV) radiation, UV light, crucible furnace processing, ore roasting processes, drossing, CDF drossing, flash smelting, Smelting Matte, bartonpot process, and Ball Mills, where Ball Mill—important for producing lead oxides, and the like. In a preferred embodiment, a YMG blast furnace 1202 can be used, as well as an Isamelt smelter 1203. Typically, metal from the smelting furnace (e.g., the Isamelt smelter) 1203 is melted in an indirect-fired kettle or pot and the trace elements are combined to produce the desired alloy. The use of refining kettles 1204 can help to prevent employees may be exposed to lead fume and particulate during the refining process.

After moving through the blast furnace 1202 and the Isamelt smelter 1203, refining kettles 1204 can also be used to control emissions.

While Britannia uses liquid oxygen, the embodiments of the present invention also use other forms of oxygen, other gases, liquids, plasmas, and the like, either individually, or in hybrid, and or combination.

The metals from the tires can be sold on the open market as pig iron. Customers could also include the same clientele as the consumers of the lead production that will come from the recycling and removal, and smelting of the lead batteries. Fibers (rayon, nylon) such as those typically found in the tires are usually sold to the textile industry at established exchanges for such commodities. Metals and fibers can both be used in situ as described in the present invention. Such fibers can also be used on-site in an EFSMP module that creates composites and ceramic bearings. The Fibers are also known as “fluff”, and can be used in Ceramic, advanced Ceramics, nanoceramics, advanced nanoceramics etc., as well as Nanomaterials, Nanocomposites, Nanotechnology and Nanotubes, and the like.

The present vertically integrated ESFMP invention matrix discloses a metallurgy module that is a part of the EFSMP in which Lead, Zinc, Gold, Aluminum, Silver, Steel, Iron, Nickel, Zinc, Copper, and other metals are reclaimed and removed from oils, batteries, acids, feeds, flare stacks, exhaust piping, pressure relief systems (EFSMP), bunkers, distillation towers, and other EFSMPs similar to that of Gemini Technologies, as well as those found in lead acid recovery facilities, Gold Refiners, and other precious metals and non-precious metals operations. Such metals are all sold on the open market when collected, as well as toxic metals, if not being used in situ, are being disposed of as required by local, state, federal, and international standards and law. The embodiment of the EFSMP in the present invention also comprises a means of manufacturing of amorphous metal alloys, also called metal glasses, silicon carbide fiber, Carbon Foaming Ceramics, and means for Microwave Assist Technology.

### Cell 13: Battery Cell

FIG. 13 depicts zinc-chloride, zinc-air, alkaline and lithium button Cells and other button Cell batteries are recycled by Oxyreducer process, and the like, which involves treating them at very high temperature in a rotating hearth furnace (e.g., rotary tilt furnace) 1301 or reactor.

Scrap zinc 1312 and other zinc concentrates can be fed into the rotary tilt furnace 1301 as shown in FIG. 13. One yield from the rotary tilt furnace 1301 will be a sulfur dioxide emission 1313, which can be condensed by a gas condenser 1305 so that none of the harmful SO2 emissions are released into the environment. This will protect the environment and those working in proximity to the harmful gas. Another product escaping the rotary tilt furnace 1301 will be granulated bullion 1306, which will enter a holder furnace 1302 before being filtered by a series of filtration devices, including but not limited to, the fuming furnace 1303; and converter 1304. Fuming Furnaces are designed to filter zinc and lead from nonferrous metallurgy slags, such as copper slag, zinc and lead slag, tin slag, etc.

Upon leaving the converter 1304, the effluent enters a granulation and milling section 1311 and a cobalt and iron alloying section 1307. From the granulation and milling section, the cobalt-iron alloy enters the autoclave leaching section 1308, which is similar in process to that of U.S. Pat. No. 4,304,644 to Victorovich, Nissen and Subramanian, titled “Autoclave oxidation leaching of sulfide materials containing copper, nickel and/or cobalt” is incorporated herein by reference in its entirety. From the leaching section, the stream enters the dryer 1309 prior to undergoing retort distillation 1310, which is a commonly known distillation technique in the industry, where a more narrowed portion above the stream will serve as a condenser for the condensation after the dryer 1309 section. At this point, the oxidation of zinc naturally occurs through retort oxidation 1314, and retort reduction 1315 reactions can occur. It should be noted that after the autoclave leaching section 1308, spent sulfuric acid will enter a feed line for another process.

The present invention, in addition to petroleum, either crude or refined, is directed to a metal recovery EFSMP of the metals contained in the oils, or with which are used to derive the substances from ores used in oil refining, so as to create additional profit streams, where an economy exists for doing such, and in which includes, but is not limited to, nor to the exclusion of, basic ferric sulphates and/or jarosites are controlled by a number of mechanisms, including control of the oxidation reaction conditions, and the like, in the first autoclave reactor compartment, hot curing of the autoclave discharge slurry, and/or contacting of the autoclave feed slurry with the hot cured discharge liquid.

The embodiments in the present invention, the EFSMP, also utilize reactors, including fuming furnaces 1303, such as Slag Fumers, for zinc recovery, and in some instances, microwave heating, fiber optics, Laser Tunnel Ionization, and other methods for directing heat for SMP's can be utilized. Furthermore, the autoclave reactors (including CSTRs), tubular reactors, and combinations thereof are suitable.

A method for obtaining, metal, semi-precious metals, precious metals, palladium, platinum, gold, silver, lead, zinc, nickel, copper, and the like, in different forms of purity is provided in this EFSMP is not limited to, but as an example of which oxygen, or enriched air, or air, or any other gas, is blown onto a melt, in a melting furnace (or reactor as defined herein) lined with refractory material, having a waste heat boiler set onto it, in order to oxidize contaminants, or change its form for collection, is contained in the melt and thereby remove them from the melt, and where a splash protection device through which fluid flows is provided above the ore melt, or metal melt, or (metal being defined as any element found in the Periodic Table, such as iron, carbon, rhenium, germanium, palladium, gold, silver, copper, aluminum, platinum, zinc, lead, and the like) on the inside wall of the melting furnace, which prevents copper, and the like, that splashes out of the melt (comprising any of the metals listed in the embodiment in the present invention, either individually or in combination, regardless of the level of purity or impurity) from penetrating into the waste heat boiler. Boiling water, plasma, or any other fluid, or gas, is used for cooling the splash protection device, protection device.

The blister copper, zinc, lead, gold, silver, and/or the like is transferred from the converting furnace 1304, preferably through a CBT, or Rotary Tilt Furnace 1301 to a holding furnace 1302. The primary purpose of this furnace is to provide scheduling flexibility to the overall smelting process, e.g. to provide a location for the accumulation of molten blister if the anode furnaces cannot accept it for any reason directly from the converter. However in certain embodiments of this invention, the holding furnace 1302 can be adapted to not only hold the molten blister, but also to further process it prior to its introduction into an anode furnace.

In a preferred embodiment of this invention, two rotating anode furnaces are located proximate to the converting or holding furnace 1302, as the case may be, and are sized to accommodate the output from the converting and/or holding furnace 1302. These furnaces, also known as thermal conversion super reactors, atomization reactors, and also known in the present invention, and throughout, as super reactors, hearths, furnaces, kiln's, autoclaves, and the like, are typically of conventional design and operation, and are used in tandem with one another such that while one is in operation, or as is the case may be in this example, is fire-refining the blister to anode copper, zinc, lead, gold, silver, and/or the like, the other is filling—if tandem/parallel/combination reactors are indeed needed. The output from the anode furnaces is transferred to an anode casting device (of any conventional design) on which the anodes are formed and subsequently removed to electrolytic refining.

Methods for EFSMP Thermal Conversion Atomization Reactor of processing precious metals, for example but are not limited to such metals as aluminum, copper, zinc, lead, palladium, platinum, gold, silver, aluminum, include, High Flux Heaters, sintering, and/or the like powder comprise technologies such as, but are not limited to, atomization, electrowinning (see U.S. Pat. No. 6,558,527, and incorporated herein by reference), Isothermal Melting Processes (ITM), decoating metals using indirect-fired controlled atmosphere (IDEX) kilns, and the like, as well as, either in tandem, hybrid, parallel, or stand alone, in such that providing powder and heating the powder in a nitrogen, or other gas, atmosphere containing a partial pressure of water vapor.

Likewise other methods of Hydrogen recovery that are claimed for incorporation would be updated forms of steam reforming, oxidation, pressure swing absorption, membrane recovery, cryogenics, and catalytic hydrotreating, and hydrogen recovery processes. As with this embodiment, production of hydrogen is included in the present invention, where the SMP is accomplished by Sintering Zinc, in such a manner that additional Hydrogen is created a as a desired excess byproduct in the creation of Sulfuric Acid, in the sintering of the Zinc Ore for such desired purposes.

For example, in a Zinc Sulfate solution, from Zinc, the solution must be very pure for electrowinnowing to be at all efficient. Impurities can change the decomposition voltage to where the electrolysis Cell produces mostly Hydrogen instead of Zinc metal, as described as Zinc Smelting according Wikipedia.

In as much as Hydrogen is a necessary product for Sulfuric Acid, the embodiment in the present invention of the EFSMP may not necessarily need a specific Hydrogen Plant, but can include one if necessary, or the technology either as a standalone or in combination of the Zinc Smelting that takes place in the Sintering Plant/Reactor, to produce any required Hydrogen (H) for either internal use, or for tanking and resale to consumer markets. Internal use can also be intra-corporate/intra-refinery as well as inter-corporate and inter-refinery operations.

EFSMP, Blast Furnace and those using Paddle Mixer—the present invention can use the spent oil, from the mixer, for a feed stock, where the effluent from this mixes with Coke, and the like, limestone, slag, and then liquid oxygen gets mixed in for super heating then onto the Isamelt for processing. The slag and dross go into sintering, then into matte, then back into sintering, and the matte is ladled for further processing, as well as other uses to be, and that have been, described in the present invention the EFSMP.

The present vertically integrated ESFMP invention matrix discloses a metallurgy module that is a part of the EFSMP in which Lead, Zinc, Gold, Aluminum, Silver, Steel, Iron, Nickel, Zinc, Copper, and other metals are reclaimed and removed from oils, batteries, acids, feeds, flare stacks, exhaust piping, pressure relief systems (EFSMP), bunkers, distillation towers, and other EFSMPs similar to that of Gemini Technologies, as well as those found in lead acid.

### Cell 14: Waste Water Treatment Plant

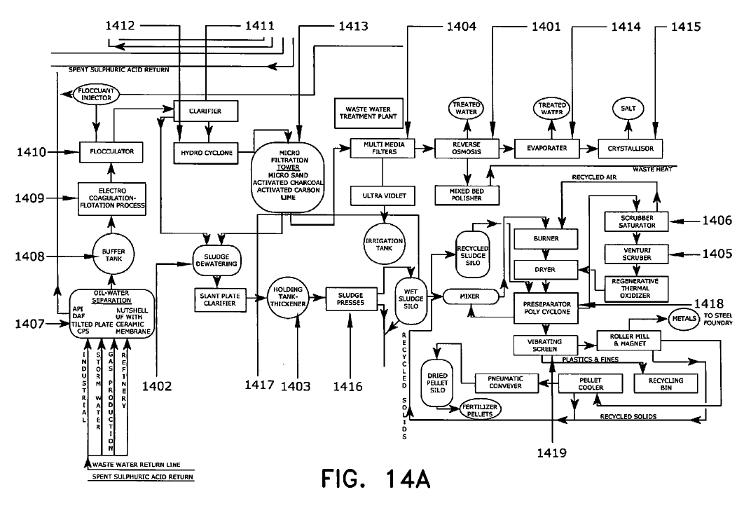

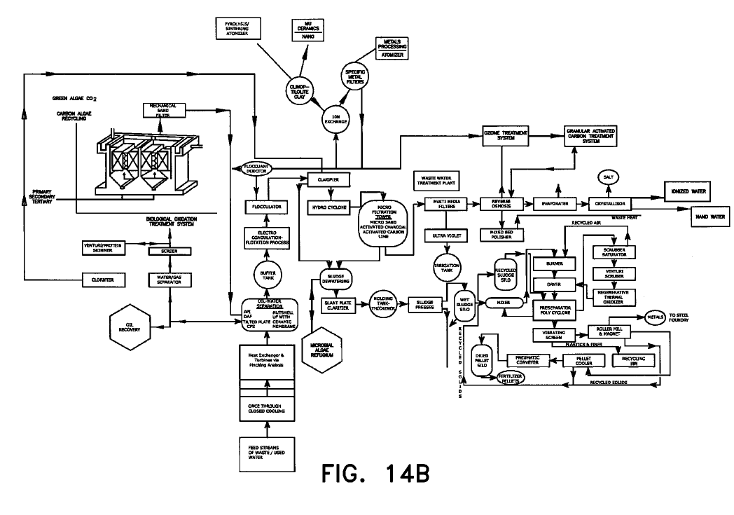

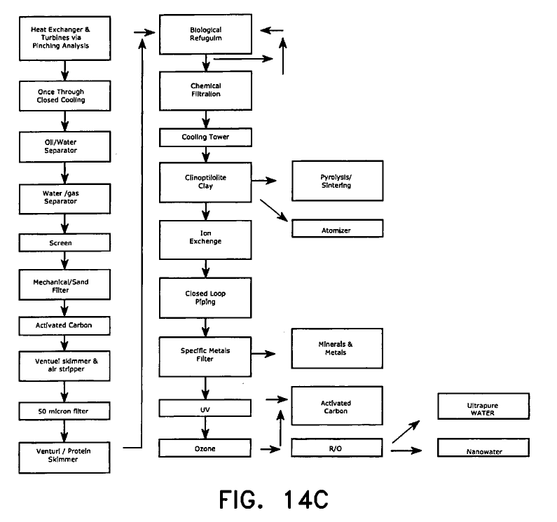

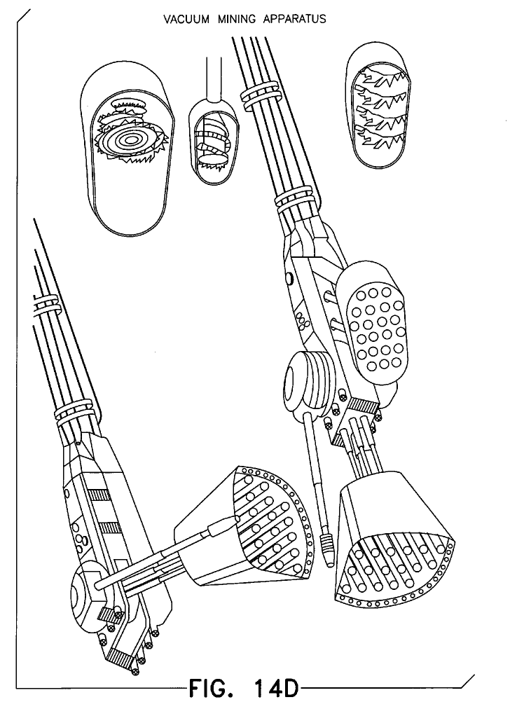

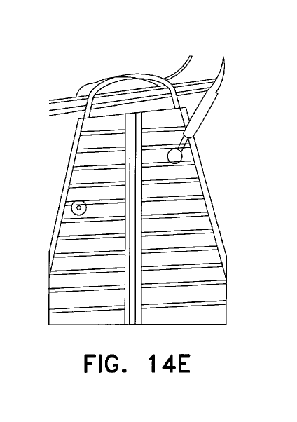

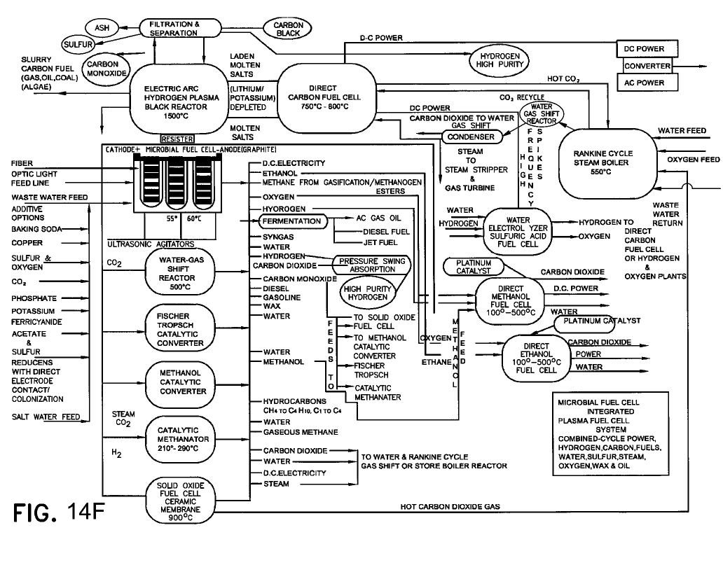

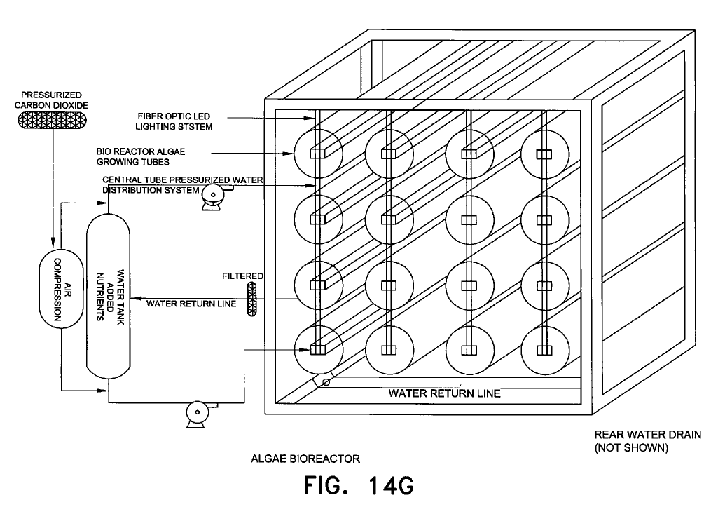

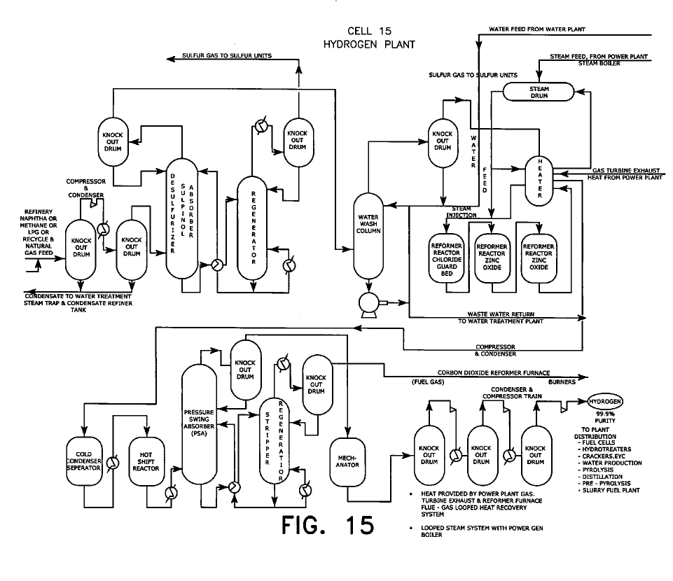

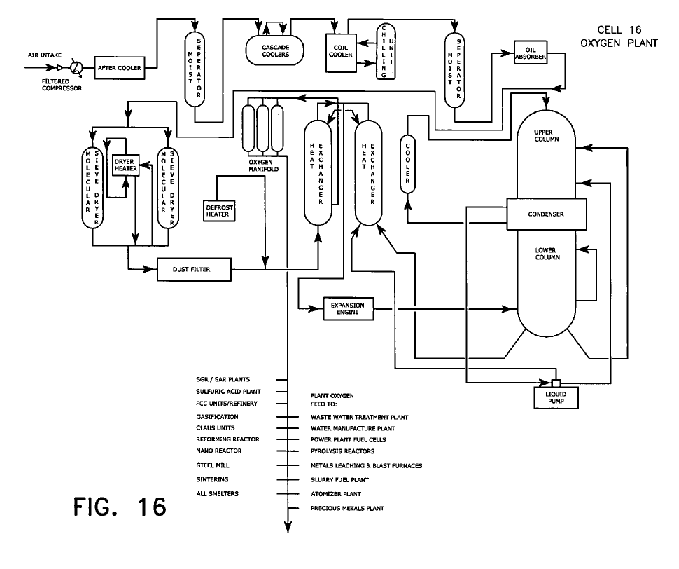

FIG. 14 shows one embodiment of the present invention. An oil-water separator 1407 is shown entering a buffer tank 1408. Separation of oil, water and gas is an important process stage in oil and gas production. Such mixed fluids with different densities are often separated using a gravity separator. An unwanted emulsion will develop in the layer between oil and water and should not be a part of the oil output flow from the separator. The level and thickness of the emulsion layer together with oil and water content is therefore one of the important properties when controlling the oil output flow rate. The water output flow can be used to adjust the position of the interface/emulsion layer which should be below the oil output. Most of the level estimators are based on radioactive level measurements where the radiation is influenced by the density of the liquids. One of the reasons a buffer tank 1408 is used is to ensure that impurities are removed after the separation process.

After the buffer tank 1408, the effluent is proceeds through the electrocoagulation floatation (ECF) 1409 process, which further separates the water content rather than destroying wastewater residuals. Once additional residuals are separated by the ECF process, the residuals are aggregated chemically in a flocculation unit 1410. This helps to remove sediment from the flow. Next, a clarifier 1411 is employed, such as those used by Met-Chem, Inc. This also separates the residuals of the prior to their entering the hydrocyclone 1412.

The hydrocyclone classifies, separates and/or sorts particles based on the ratio of their centripetal force to fluid resistance. This ratio is high for dense (where separation by density is required) and coarse (where separation by size is required) particles, and low for light and fine particles. Hydrocyclones 1412 also find application in the separation of liquids of different densities. In a preferred embodiment, this hydrocyclone can separate liquids based upon densities, as well as the ratio of their centripetal force to fluid resistance.

Once the particles are separated based upon density, for example, they move to the micro filtration tower/micro sand activated charcoal/activated carbon lime filtration system 1413. The micro-filtration tower 1413 will remove even the smallest of contaminants from the flow stream.

The cyclonic separation can be that which is described in FIG. 25B with regard to the atomization reactor. Additionally, the filtration described in the present invention can be that which is described with regard to chalcogel technology with regard to FIG. 25C.

Finally, the next series of filters add to the filtration process, including multi-media filters 1401, followed by reverse osmosis 1401 filtration. Evaporator 1414 components and crystallizer 1415 components can be used in a preferred embodiment. Cell 14 further depicts water filtration as related to removal of Sulfur, etc. from effluent streams whereas such feeds are a direct result of processing oil, coal, in which the technologies utilized produce additional feed stocks, and effluent streams from such industries, but are not limited to those of pyrometallurgy, effluent streams, waste water stream, pyro hydro metal stream, filter cakes (liquid, dust, solid), metal extrapolation, feed streams, mercury extractions, lead extractions, oil extractions, and the like. The EFSMP in the invention embodiments meets, and beats the targeted reduction goals, and best demonstrated available technology that is currently, but not limited to that of the United States EPA, the United States DOE, and other governmental (United States and non United States) Mixed Waste Integrated Program, the Mixed Low-Level Waste Program, such as those used with 3M-IBC Membranes, those of the Boliden-Norzinc Process.

Ash, Water, Sour Water, Oil Sludge, Filter Cake, Molten Stream, Slurry, or any effluent stream and feedstock, is produced by ejected molten, refined lubricants, oils, and the like metal through a small orifice. Furnaces like Caldo, Aldo, Arc, Ausmelt, Sirosmelt, and the like, but not limited to, are permutations of the EFSMP, and the Reactor, and Reactors described in the present invention, can all achieve ranges of 10,000 degrees Celsius. The EFSMP is and can be, but is not limited to, Batch and or Continuous Processing, and the like, whereas the stream can be centrifuged with a Centrifugal Gravity Concentrator, Tall Column Flotation, Automated Mechanical Flotation, High Gradient Magnetic Separation, (such magnets and magnetic material may include magnets that are known as super strong magnets, which could be comprised of rare earths, or combinations of other materials produced in-house or in situ, etc.) and the like, either in combination, tandem, parallel, compartmentalized, jointly connected, vertically integrated, or as part of an overall matrix of technologies, and the like, that are incorporated in the present invention as part of a Reactor, is broken up or disintegrated by jets of inert gas, air, or water, and the like into small drops. The EFSMP technology utilizes a technique, but not limited to, the rapid solidification of the powder from the melt. Gasses are used, and an example of which, but not as a limitation of, are that of air nitrogen, hydrogen, and argon. This EFSMP makes possible the production on a semi-continuous basis (that is, in multi-ton lots) of fine powders from molten metals and alloys from the feedstocks and typical waste products associated with metallurgy and the like.

The metal nitrate solution is prepared by having its metal components in a preselected ratio so that when the water of solution is removed and the resulting nitrates are decomposed to form oxides, a desired stoichiometry of the metal components is maintained. It is considered essential in order to maintain adequate decomposition and proper subsequent stoichiometry that only nitrate solutions be used.

The waste tanks are designed, and or configured so that the waste oil is fed and/or emptied from a primary tank (a tank can be defined as a structure to hold waste oil, waste lubricants, acids, water, liquid, gel, and the like—and can be single unit, or a series of units interconnected, or separately as is desired) into a secondary tank that could act, but is not exclusive of functioning as such, a sediment tank or holding tank thickener 1403. Such systems and the software to operate them are included in this embodiment. From the holding tank thickener 1413, the flow stream moves through the sludge press 1416 and the wet sludge silo 1417.

The invention embodiments incorporate Super Reactors and processes in which Sulfuric Acid is filtered, with multimedia filters 1404, for example, passed through a membrane of solid oxide fuel cells, broken down into Sulfur Oxide, Sulfur Trioxide, and the like, creating energy for local consumption, and then the effluent is then passed into a system where municipal water, filtered water, or on-site created water, is added, thus creating steam and heat, whereas the exothermic reaction is harnessed, as per Pinching Analysis, by steam turbines and the like, the effluent is then reconstituted into Sulfuric Acid, and electricity is created. Any steam from the exothermic reaction is then passed through scrubbers, such as a venturi scrubber 1405 and a scrubber saturator apparatus 1406, and then the water is extracted and human toxins are removed. From the scrubber saturator 1406 and venture scrubber 1405 recycled air passes to a burner and dryer for further thermal separation before entering the pre-separation polycyclone 1418 which separates the particles by density, similar to that of the zone mechanisms of the distillation super reactor, described in the present invention. For example, the polycyclone 1418 will use heat, pressure and concentration gradients to separate that which enters. The vibrating screen 1419 is used in coal dressing, metallurgy, mine, power station, water conservancy project, building industry, light industry and chemical industry etc. They are efficient screening machines for the classification and separating materials of bulk, such as coal, minerals, coke, etc.

In another phase of the curing cycle, inert gas at a high pressure is introduced to force the water from the bladder, without vaporization or significant loss of heat, back to storage facilities for subsequent reuse. In the final phase of the shaping and curing cycle, the inert gas is evacuated from the bladder, and collected for reuse, by means of a vacuum tank or vacuum pump, if no cooling of the product is desired, or by the introduction of high pressure cold water for the final cooling and shaping period of the cycle, whereupon the water is flushed and extracted from the bladder and the contents are removed from the mold. By employing this process and the associated apparatus and system, the water is not mixed, with resultant loss of temperature, thereby yielding substantial energy savings without omitting or foreshortening the cold water cooling and shaping step necessary to insure tire quality and prevent deformation.

Forms of reverse osmosis, as shown in the figure 1401, for feed lines, placed in different locations may be utilized as well, as a means of water filtration. Additionally, the EFSMP, through production, refinement, processing, molecular changing, atomization, and creation of feed streams, feed stocks, waste streams, gasses, fugitive gasses, liquids, effluents, sorbents, metals, powdered metals, atomized metals, and the like, with the inclusion of same, but not limited in any combination such products, at varying temperatures that are in the reactors, and exposed to such either in combination, parallel, hybrid, tandem, or stand alone, as is the desired methodology by the user, of such items as Carbon Black, Carbon, Advanced Ceramics, Ceramics, Clay, Advance Carbon, and Nanotubes, nanotechnology composites, and other medium, substrates, and the like, the current embodiment is able to utilize such products for water filtration, by way of upgrading, refurbishing, recycled, regenerated, filtered, changing properties, and the like, of the medium in any permeation of the reactor, in such that sorbents are able to be created and reused in house, without the need to seek external sources of filtration media for processes taking place, and required by the EFSMP.

Additionally, the embodiments of the present invention utilizes technologies that facilitate ultrapure water, as may be needed for the super critical boilers, and the reactors used in the power production and to produce materials from other Cells or used within the EFSMP herein, and where water of great purity is needed to clean semiconductor wafers, and the like, and where water used for external sale as a product, similar to that of quality used in chemicals, and drugs, pharmaceuticals, cosmetics, circuitry, or electronics, and the like, whereas such chemicals, pharmaceuticals, cosmetics, and drugs injected into, or used on, the human body must also be ultrapure, the EFSMP filtrations system in the present invention can purify liquid and water streams to meet user demands. Additionally, as there is a large and growing market for equipment and materials needed to meet the purity requirements, the EFSMP in the present invention is situated to capture market requirements for production of such high quality water, in such that systems, components, piping, filters, degasifiers, and chemicals are used to facilitate the necessary standards. As such, the EFSMP utilizes reactors, thermal conversion units, plants, and other such technologies in such combination as, but is not limited to those of Reverse osmosis systems, Ion exchange systems, Instruments and controls, Degasification, Filtration, Pumps and valves, Storage and piping, Disinfection, Construction, Heaters, Distillation, Steam and Hot Water, Sludge treatment, such as sludge dewatering 1402, and the like.

Another embodiment of Cell 14 is shown in FIG. 14B. Next to the Refinery (cell 6), and also at least as important as the Power Cell 9, is water (cell 14 and the Invention Hydro/Water/Power reactor). One factor is the enormous strain that exists today on existing fresh water resources. Recycled water from the EFSMP is a drought-proof, dependable, internally controlled additional source of water supply and hence one of the most effective solutions to help solve water scarcity. Thus, the escalating water shortages and rising water costs, coupled with tighter regulations on consumption, and use, of fresh water and discharge of waste water, have significantly boosted the adoption of water recycling by industry, but also, as in the present invention, in almost every facet of the matrix, water is used. For example, and without limitation, see Table 1.

TABLE 1
WASTE WATER MATRIX CELL & CONTAMINANTS

| 1 | | Desalter | see Table 2 below |
|---|---|---|---|
| 2 | | tire plant | wash/dry tanks, rubber dust, metal, tire fiber, grime, oil and grease |
| 3 | | nano plant | water jacket |
| 4 | | Pyrolysis | pre-pyrolysis coals, tire, battery, blanket oil, carbon black, catalysts |
| 5 | | Battery wash tank, sulfuric acid, sour water, hydro-separator | |
| | i. | grey oxide, plastic, rubber, ebonite and fiber | |
| 6 | | Refinery | see Table 2 below |
| 7 | | Asphalt | wet scrubber, coke, asphalt, aggregates |

| | |
|---|---|
| 8 | Amine/Claus sulfur, sour water, ammonia |

| | | |
|---|---|---|
| b. | Tail Gas | petroleum gases |
| c. | Degassing | |

| 9 | | Power steam, water from fuel cell RO, fuel cell tank houses, coal compounds, coal slurry | |
|---|---|---|---|
| | ii. | peat, waste water from cooling towers, boilers, hydrolysis | |
| | iii. | sulfur, sour water, ammonia, volatiles from water gas shift reactor | |
| | iv. | condensed water | |
| 10 | | SAR/GAR | ammonia, coke, sulfur |
| 11 | | Integrated | copper, steel, lead, zinc, aluminum, precious metals |

| | | |
|---|---|---|
| b. | SAR/GAR | sulfur, pickling acids |
| c. | H2SO4 | |

| 12 | | Lead | lead, sulfur, carbon, zinc, |
|---|---|---|---|
| | v. | silver, gold, platinum, copper | |
| 13 | | Zinc | zinc, sulfur, copper, cadmium, calcine, aluminum, lead |

| | vi. | coal, limestone, silica, silver | |
|---|---|---|---|
| 14 | | Waste Water | |
| 15 | | Hydrogen | sulfur, methane, LPG, Nat Gas |

| | vii. | zinc, chlorine | |
|---|---|---|---|
| 16 | | Oxygen | condensation, cooling |
| 17 | | steel mill | pickling, sulfur, iron, ammonia, coke, residuum oil, coal |

| | |
|---|---|
| b. | steel foundry lime, carbon, ammonia, metallurgical coke, Nitrogen |

| | viii. | sodium, chromium, molybdenum, manganese, nickel | |
|---|---|---|---|
| 18 | | Lead Oxide | lead, litharge |
| 19 | | Alumina | aluminum, sand, iron, titanium, caustic soda (Red Mud) |

| | ix. | copper, zinc, silicon | |
|---|---|---|---|
| | x. | magnesium, iron, lithium, nitrogen, sulfur, chlorine | |
| 20 | | Copper copper, lead, gold, silver, carbon | |
| 21 | | Sintering | carbon, clay, Red Mud, silica |
| 22 | | Sulfuric Acid | zinc, sulfur, copper, lead |
| 23 | | Precious Metals | gold, silver, platinum, cadmium |

| | | |
|---|---|---|
| 24 | | Nano Graphite chalcogels/Aerogels, composite materials |
| | xi. | sulfur, graphite, xylene, carbon, fullerene |
| 25 | | Atomizer |
| 26 | | Fuel/Pre-Pyrolysis |

| | |
|---|---|
| b. | Pre-Power |
| c. | In addition to the overall drawing, for Cell 14A, this embodiment includes a |
| | sequence of steps to be followed, however, as user requirements change, as well as the state of |
| | the art advances, so can the configuration & STEPS change of this embodiment of Cell 14. |

Raw Water, as an alternate back up, but is not a limitation to the EFSMP, as onsite water production volumes exceeds known restricted limitations of existing technologies, enters the system from the local municipality, ports, subterranean wells, surface streams, rivers, lakes, open/closed looped piping from reactors, geysers, ponds, rain water, rail car, freighter, and any source of water, either manmade, natural, or un-natural (like nanowater/nanotechnology water) and the like. Additional water can be received from the proposed EFSMP as waste streams for processing to extract materials, or from/as a co-op with local municipalities, farms, industry, etc., or as from water derived and used on/at Cell 28.

This embodiment of this cell also processes contaminated material streams from Coal wash water, piped in reactor water, and without limitation merges the two waste water streams into one concentrated filtration system to extract the materials. Inflow and outflow for perfect cycle and use is proposed. Another bonus of this cell's function, within the matrix is presented within this EFSMP in that the embodiment recycles and reharvests, and optimizes the harvesting of materials, and prevents any pollution—both below United States EPA guidelines well in observance of Sharia Law requirements.

All Water, Nano Water, Sour Water, Water streams, and the like, regardless of the origination, is treated as if it were simple Waste Water, but through the EFSMP's proposed Waste Water Treatment, in the following steps, but not limited to the written description, as there may be tandem, looped back, multiple, and different permutations of the proposed, and preferred steps for processing, in addition to the materials identified (but not limited to) in Tables 1 and 2:

Waste Water Treatment, in the following steps, but not limited to the written description, as there may be tandem, looped back, multiple, and different permutations of the proposed, and preferred steps for processing, in addition to the materials identified (but not limited to) in Tables 1 and 2:

a. Waste Water Treatment
b. oil and grease removal system
c. activated sludge systems
d. sequential batch reactors
e. anaerobic processes
f. high rate solids contact clarifiers
g. trickling filters
h. bacterial cultures
i. sludge dewatering
j. water recycle
k. pressure filters
l. continuous sand filters
m. photochemical oxidation
n. reverse osmosis
o. disinfection
p. demineralisers
q. ultrafiltration
r. coagulation and flocculation
s. chemical dosing systems
t. clarification
u. clariflocculators
v. Inclined Plate Clarifiers
w. high rate Solids Contact clarifiers
x. ultra high rate clarifiers
y. Precipitators
z. Filtration
aa. pressure and gravity filters
bb. multi grade filters
cc. single and dual media filters
dd. activated carbon filters
ee. continuous sand filters
ff. monovavle/monoscour filters
gg. ultra filtration systems
hh. treatment
ii. softeners
jj. dealkalisers
kk. demineralisers
ll. electrode ionization
mm. reverse osmosis
nn. ultra filtration
oo. micron filters
pp. monitoring instruments
qq. ozonators
rr. chlorinators
ss. post treatment
tt. chemical dosing systems
uu. deaerators
vv. condensate polishing
ww. sidestream filters
xx. cooling water chemicals

Sludge dewatering, and processing of the sludges into filter cakes, whereas the sludges from the steel filters are sent to the steel and metal foundry for processing. In addition, Gold and Silver, and other precious metals, are sent to the Precious Metals foundry for processing. Diamond Dust (sourced from the coal/energy—Cell 9)) is sequestered, and sent to established markets (Sulfur, Lead, and so on and so forth, etc.).

Specifically, all of the waste water streams, albeit water or Nano water, entering into this cell, and all initial flows will first start out passing through screens, as shown FIG. 14A.

All of the above terms, types and compounds are in the present invention defined as water, potable, non-potable, etc., regardless of the interchangeability or use of specific words throughout this document, as it describes the EFSMP.

Computer monitor and control system for data logging and remote service and troubleshooting are constantly deployed and integrated throughout this cell of the EFSMP, and also serve as described below.

### Screens

After the process of Oil/Water separation takes place, and the Oil is sent to the Oil Recovery Tank for processing back into pre-pyrolysis, and then the Water is passed through a Screen mesh to remove metals, which are later sent back to the atomizer for processing back into the appropriate sections of the matrix metallurgical processes, as described above.

The Screens have properties of specific mesh size, to capture specific contaminants, diamond dust, metals, volatiles, and equipment fouling materials and the like based upon their pore size, as well as being powered with electrolytic properties, magnets, magnetic material, and electrodes in such that the electrolyzed solution of Raw Water, and Nano Water, and the like, that is passing through the filter can interact with the Hydrogen (H) atoms and Hydroxide Ions, or other preferred materials or gasses, and the like, in which the Ions of the metals and volatiles are deflected by a magnetic field and shown to obey the left hand motor rule (see The Royal Society of Chemistry—Classic Chemistry Demonstrations #43—Movement of Ions during Electrolysis: Someone of ordinary skill in the art can implement such methods for filtration), also known as Electrowinning/Electrowinners with different plates attract different trace metals, rare earths, precious metals, actinides, and volatiles, and the process of separating the Hydroxide Ions from the nano water, separate steams of Hydrogen and Oxygen are sent off to electrostatic precipitation then to atomizer, and the filter cakes created from the full mesh screens are sent off (charcoal and sand are also sent to the atomizer), with Hydrogen and Oxygen sent off to their respective plants within the EFSMP.

Moreover, the Primary Mesh filters larger Metals such as Copper, Lead, Iron, Aluminum, molybdenum, cadmium, nickel, silver, cobalt, and zinc. In addition, the gold and platinum group metals that are associated with sulfuric base metal ores are also filtered in this initial Mesh. These metals are sent off to electrostatic precipitation then to atomizer for processing.

Secondary and tertiary meshes filter out, and separate metals such as Vandium, Precious metals, noble metals, and other Trace Metals. These metals are sent off to electrostatic precipitation then to atomizer for processing.

Not shown, yet included, but without limitation, is the implementation of existing technology for Fuel Cells for water filtration. These fuel cells can be specialized for specific purposes, and kept in Tank Houses, like Metal Removal Fuel cells, and the like, in which the fuel cells are typically located in a Tank House, and are identical, when needed, for processing materials from water that are also found at the Ball Mill from within the metallurgy sections of the Matrix invention, either in a single location, or in multiple locations throughout this section of the Matrix (Waste Water Treatment). The membranes are clearly able to process waste water, and as such, the electricity from the energy production can be sent back into the system for refining, in as much that these fuel cells multitask, that removes contaminants, and filter water produce electricity, from the Hydroxide effluent. Membranes are also removed and processed, as needed, for material removal, and cannibalization, and the metals, once removed, via processes similar to that described below, but not limited to current available state of the art, but also to methods and processes by someone or ordinary skill in the art, are sent to the rotary tilt reactor for processing into such products as Carbon Black, or the user may direct such material to pre-pyrolyic cells for further breakdown, and use of the material. A byproduct from fuel cells could also be water, Hydrogen, and Oxygen, but are not limitations to the effectiveness or capacity of the function of any particular type of fuel cell. There will be a greater description of this from the Tank House located after the section of Ionization, and before/as part of Reverse Osmosis (R/O). As ligands, discussed below, ionization, fuel cell technology, zeolites and reverse osmosis are similarly related, it is proposed that someone of ordinary skill in the art can work with hybrid fuel cells, which serve multi-function purposes, of which will be described below.

Water flows are then processed in/through the Venturi Pumps and Protein skimmers, where Carbon Materials are further collected to be sent back to the refinery for processing. Cavitation separation effects associated with Venturi/Cyclonic activity, and those skilled in the art, are familiar and able to implement this technology.

Computer monitoring and control systems for data logging and remote service and troubleshooting are proposed in this invention, and are also described in further detail below.

### Water Gas/Oil Separator

In no specific order, and without limitation, gas is separated from the water waste streams. Water has come into contact with Hydrocarbons; principally ethane, propane, butane, and pentanes at Cells 6 and 9. In addition, raw natural gas contains water vapor, hydrogen sulfide (H2S), carbon dioxide, helium, nitrogen, and other compounds.

Gasses separated from the waste water stream produce what is known as ‘pipeline quality’ dry natural gas. Not shown, but included in this embodiment, is piping that sends these gasses back into the system for use as power, or to be sold into existing markets.

While the ethane, propane, butane, and pentanes must be removed from natural gas, this does not mean that they are all ‘waste products’.

In fact, associated hydrocarbons, known as ‘natural gas liquids’ (NGLs) can be very valuable by-products of natural gas processing. NGLs include ethane, propane, butane, iso-butane, and natural gasoline. These NGLs are sold separately and have a variety of different uses; including enhancing oil recovery in oil wells, providing raw materials for oil refineries or petrochemical plants, and as sources of energy.

Heaters and scrubbers, based upon user requirements, are installed, and are used to make sure that pre-cooling does not lower temperatures to unsatisfactory levels, as prior to having materials removed at the Refugium, as described below, exothermic heat, captured from the EFSMP, at temperatures of 3000 degrees Celsius, are used to generate air heat flow, and steam flows, where turbines are also incorporated for electric energy productions, where Pinching Analysis may be used to determine locations of all these streams are returned for utilization back into the appropriate, and needed locations of the present invention, prior to cooling.

The scrubbers serve primarily to remove sand and other large-particle impurities. The heaters ensure that the temperature of the gas does not drop too low. With natural gas that contains even low quantities of water, natural gas hydrates have a tendency to form when temperatures drop. These hydrates are solid or semi-solid compounds, resembling ice like crystals.

The Oil, previously extracted from the water, is sent to a closed tank, where the force of gravity serves to separate the heavier liquids and the lighter gases, like natural gas. Natural gas is then used onsite for additional power, or converted into materials and products that the user requires, such as fuel, ammonia, ethane, methane, syngas, and gasoline. In this embodiment, the remaining oil is sent back to Cell 6 for refining.

The remaining water and gas then travels through a high pressure liquid ‘knockout’, which serves to remove any liquids into a low-temperature separator. The gas then flows into this low-temperature separator through a choke mechanism, which expands the gas as it enters the separator. This rapid expansion of the gas allows for the lowering of the temperature in the separator. After liquid removal, the dry gas then travels back through the heat exchanger and is warmed. Furthermore, to separate water from gasses, absorption and adsorption methods are utilized. Absorption occurs when the water vapor is taken out by a dehydrating agent. Adsorption occurs when the water vapor is condensed and collected on the surface water vapor is condensed and collected on the surface. Glycol Dehydration and flash tank separator-condensers are also utilized so that in addition to absorbing water from the wet gas stream, the glycol solution is further separated to remove methane and other compounds found in the wet gas. Methane is sent back into the Matrix facility piping system, and used according to system requirements of placed back into existing markets.

Remaining Organic Compounds and sludges are sent to the Venturi/Cyclonic Pumps and vented into the (protein) skimmer to be pressed into filter cakes, and processed into pellets, as needed, in which the equipment is automated, in such that the presses are filled, conveyored and injected, from the mold ejection, via robotics, as is the case throughout the entire embodiments of the EFSMP, including Cell 28. The filter cakes are then later used, either with the production of Carbon Black or other processing. The making of these cakes, from the sludges and organic compounds is very similar to the description of processing of the metals within the matrix, except what we're defining, and using our own lexicography, such as “Continuous-Filter-Cake-Making”.

Material for filter cakes comes from sections, but not limited to, and throughout this cell's: irrigation tanks, sludge tanks, buffer tanks, Refugium tanks, gas purification filters, wet sludge tanks, multimedia filters, clarifier tanks, desiccant material, sludge presses and the like.

As an alternative to glycol dehydration, Solid-desiccant dehydration can be utilized, either in tandem, parallel, or inline, or separate as the primary form of dehydrating natural gas using adsorption, and usually consists of two or more adsorption towers, which are filled with a solid desiccant. Typical desiccants include activated alumina (which can be produced onsite from the alumina production) material. Wet gasses are passed through these towers, from top to bottom. As the wet gas passes around the particles of desiccant material, water is retained on the surface of these desiccant particles. Passing through the entire desiccant bed, almost all of the water is absorbed onto the desiccant material, leaving the dry gas to exit the bottom of the tower.

To ‘regenerate’ the alumina desiccant, the material is sent back to the alumina plant for processing at high-temperature. Passing the alumina back into the system for processing and regeneration vaporizes the water, and the hydrogen and oxygen, or water as the case may be, is sent back into the system for further Waste Water Treatment.

As mentioned in the preceding paragraphs, Natural Gas is extracted from the petroleum that has been separated during the Oil/Water separation process. Since Natural Gas Liquids (NGLs) have a higher value as separate products, it is thus economical to remove them from the gas stream, should the user decide that the monetization of these materials is suitable. The removal of natural gas liquids usually takes place in a relatively centralized processing plant, and uses techniques similar to those used to dehydrate natural gas. Someone of ordinary skill the art is able to incorporate common-off-the-shelf-equipment as is readily available in today's market. Natural gas almost always contains contaminates or other unacceptable components, including heavy hydrocarbons, mercaptans, mercury, and the acid gases H2S and CO2. The present inventions are able to produce a significant amount of natural gas in so much that the current embodiment can process NGL and feed it into pipelines that are dedicated for such purposes. To this effect, that a Natural Gas Plant be needed, or desired within the Matrix, to process the material, after Oil/Water separation, there are two basic steps to the treatment of natural gas liquids in the natural gas stream. First, the liquids must be extracted from the natural gas. Second, these natural gas liquids must be separated themselves, down to their base components.

However, the present invention does indeed separate and process each facet of these materials, as described in the present invention, and is commonly known (and without limitation) to someone of ordinary skill in the art.

Amine solutions are used to remove the hydrogen sulfide. This process is known simply as the ‘amine process’, or alternatively as the Girdler process, and is used in a large percentage of United States gas sweetening operations. The sour gas is run through a tower, which contains the amine solution. This solution has an affinity for sulfur, and absorbs it much like glycol absorbing water. There are two principle amine solutions used, monoethanolamine (MEA) and diethanolamine (DEA). Either of these compounds, in liquid form, will absorb sulfur compounds from natural gas as it passes through. The effluent gas is virtually free of sulfur compounds, and thus loses its sour gas status. Like the process for NGL extraction and glycol dehydration, the amine solution used can be regenerated (that is, the absorbed sulfur is removed), allowing it to be reused to treat more sour gas.

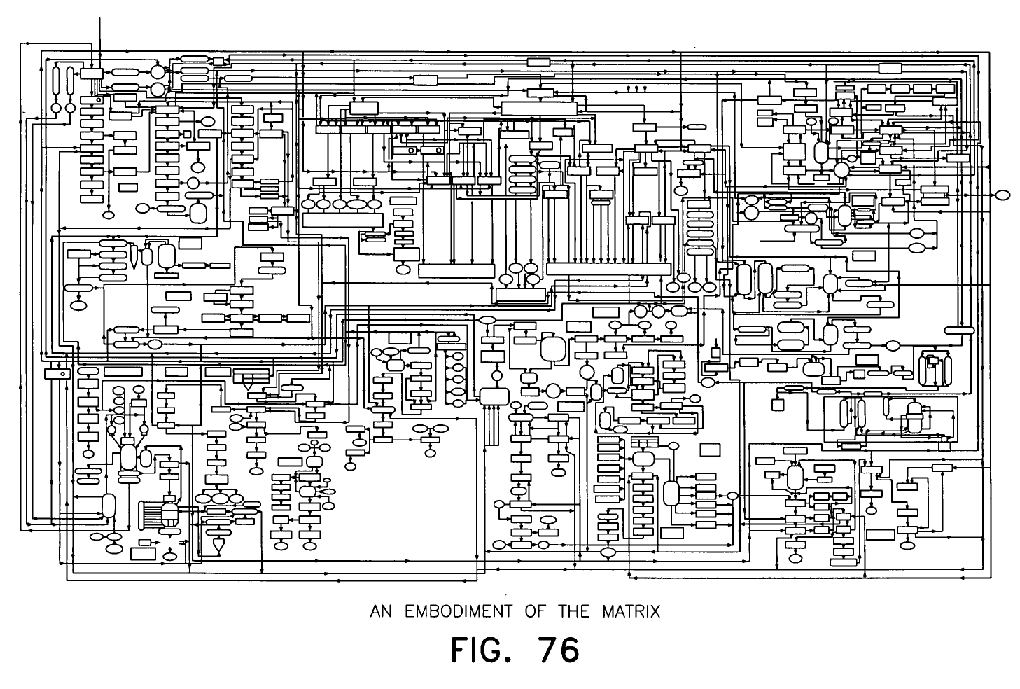

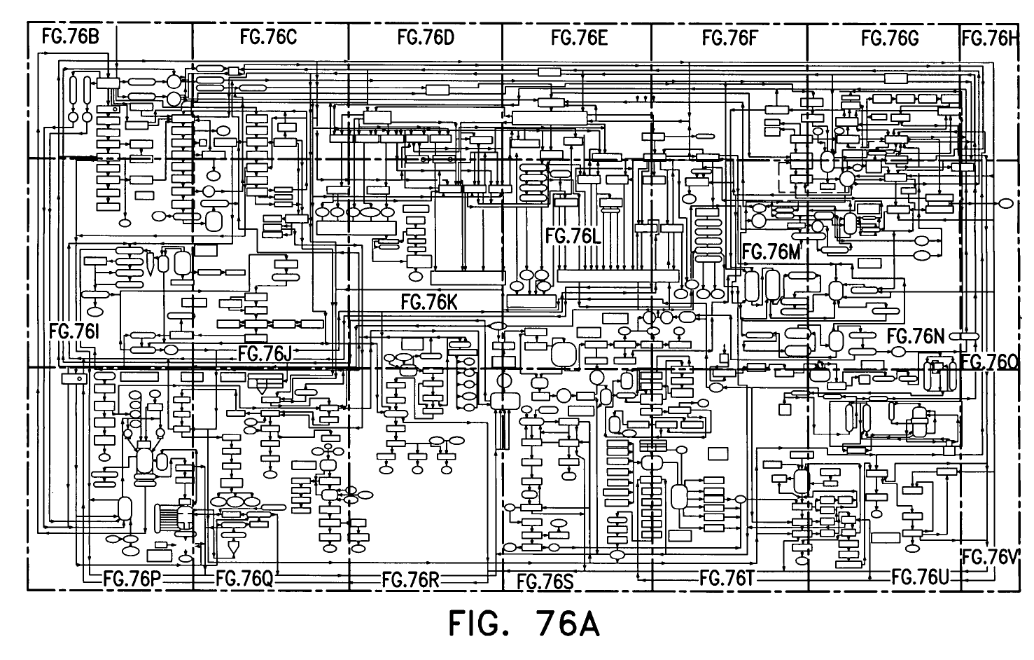

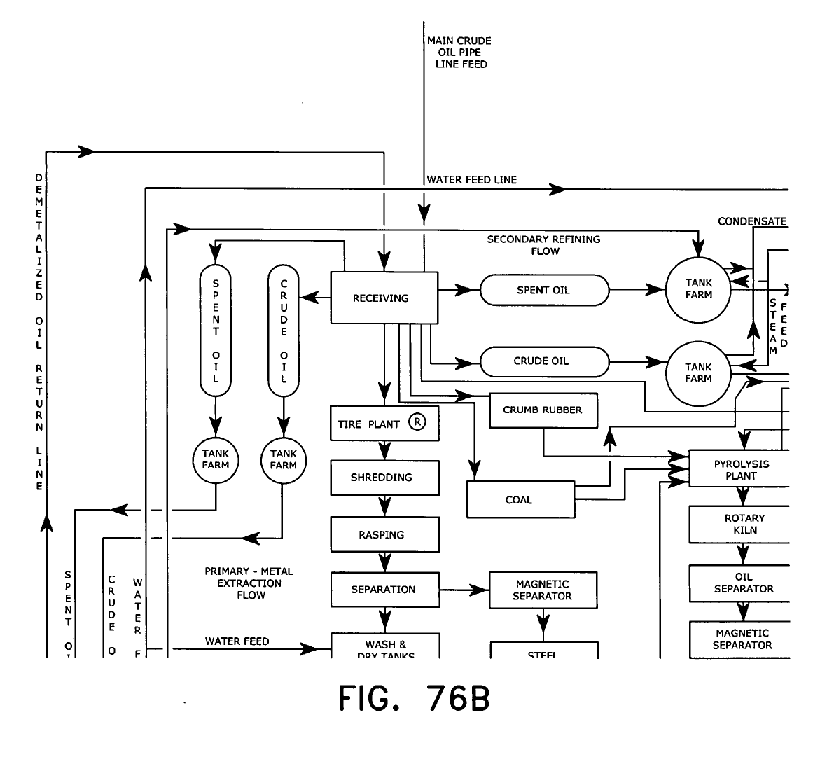

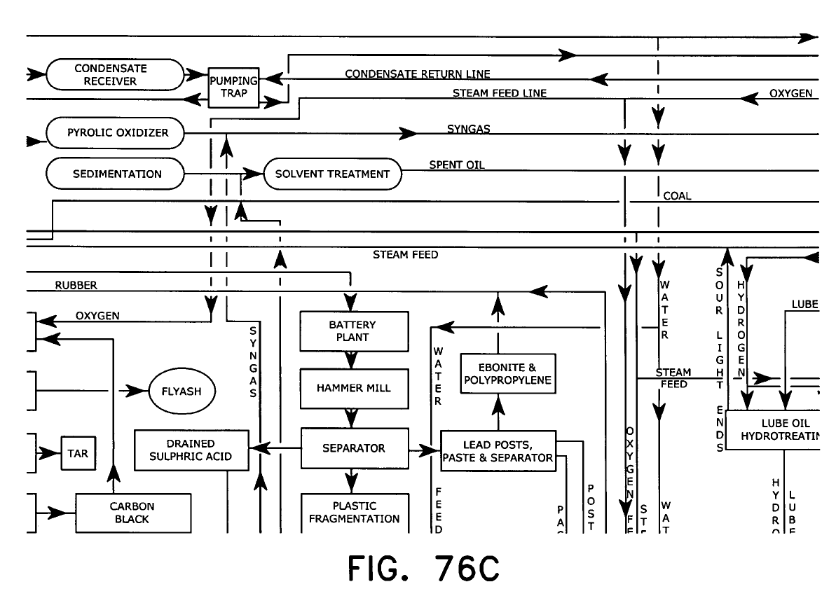

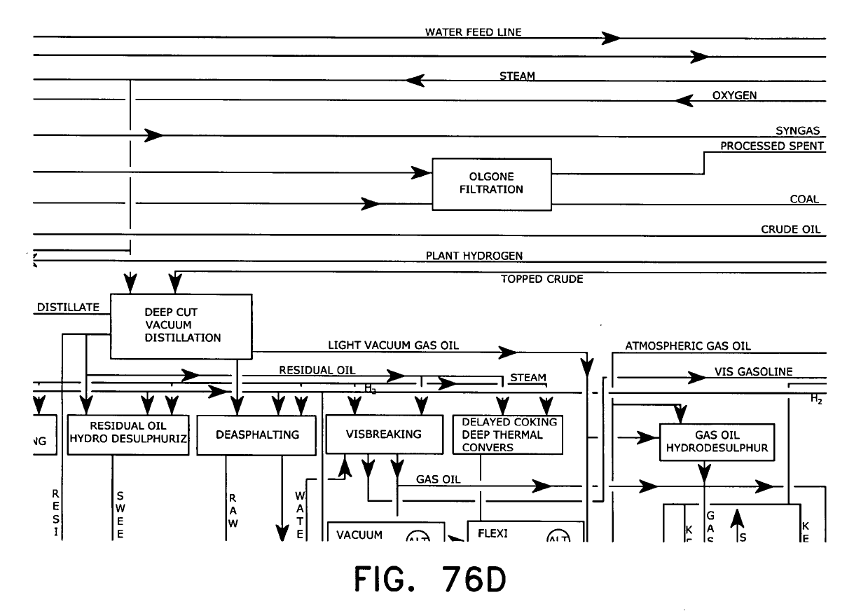

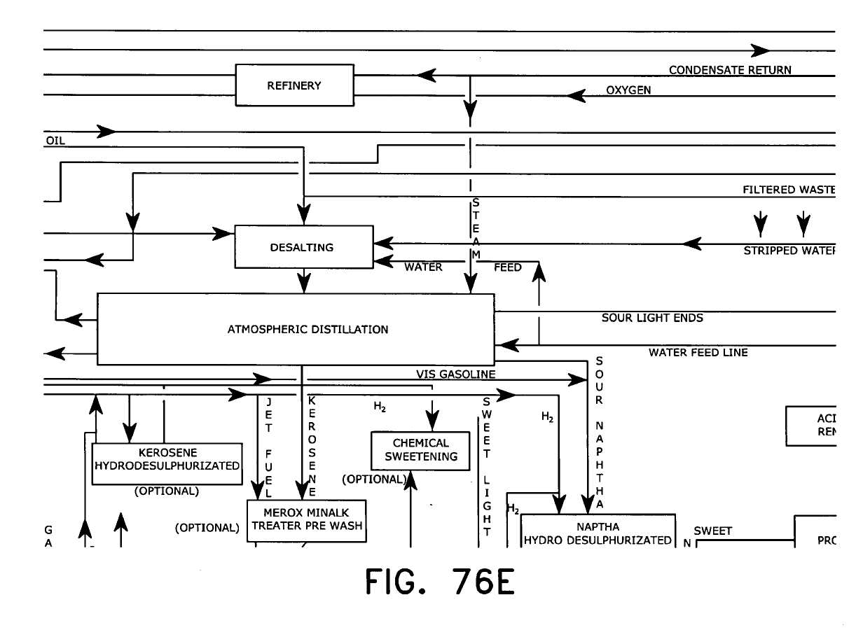

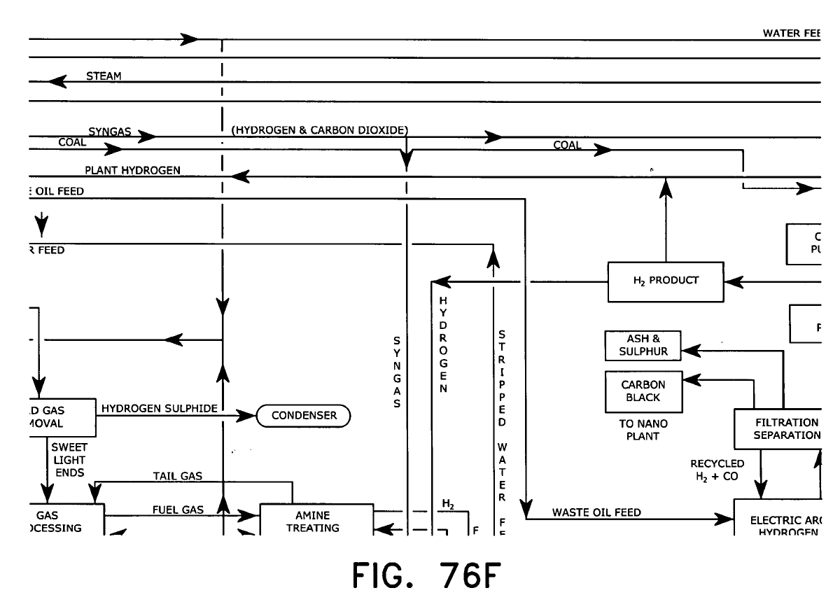

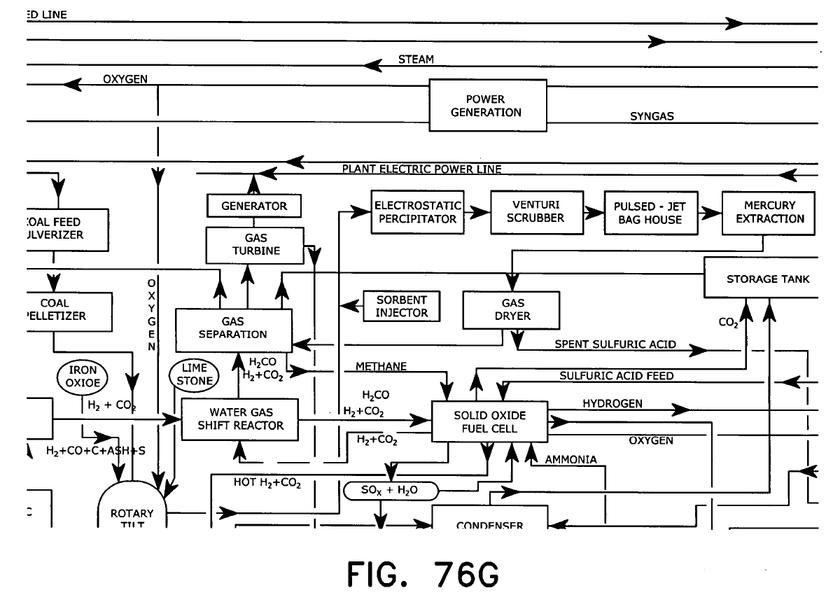

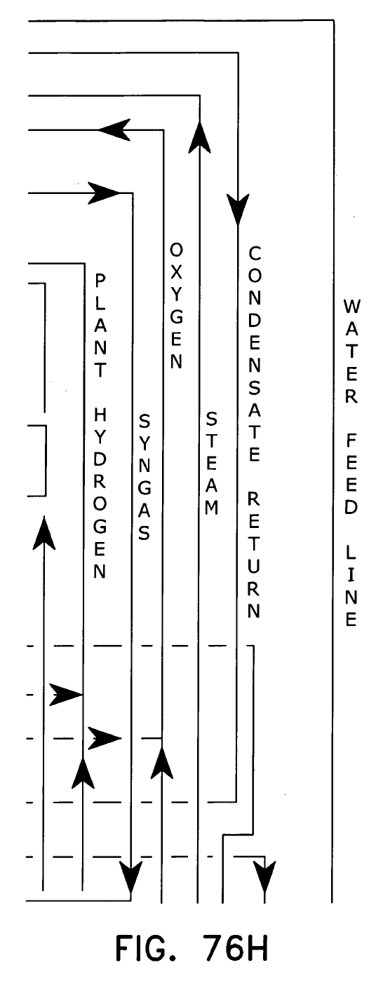

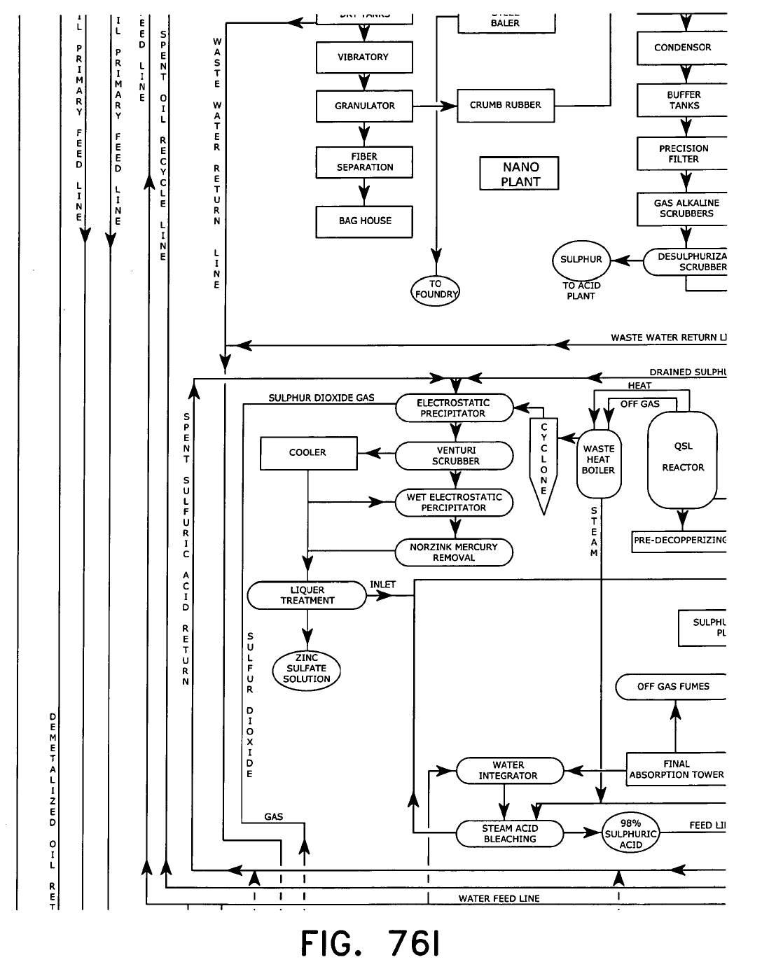

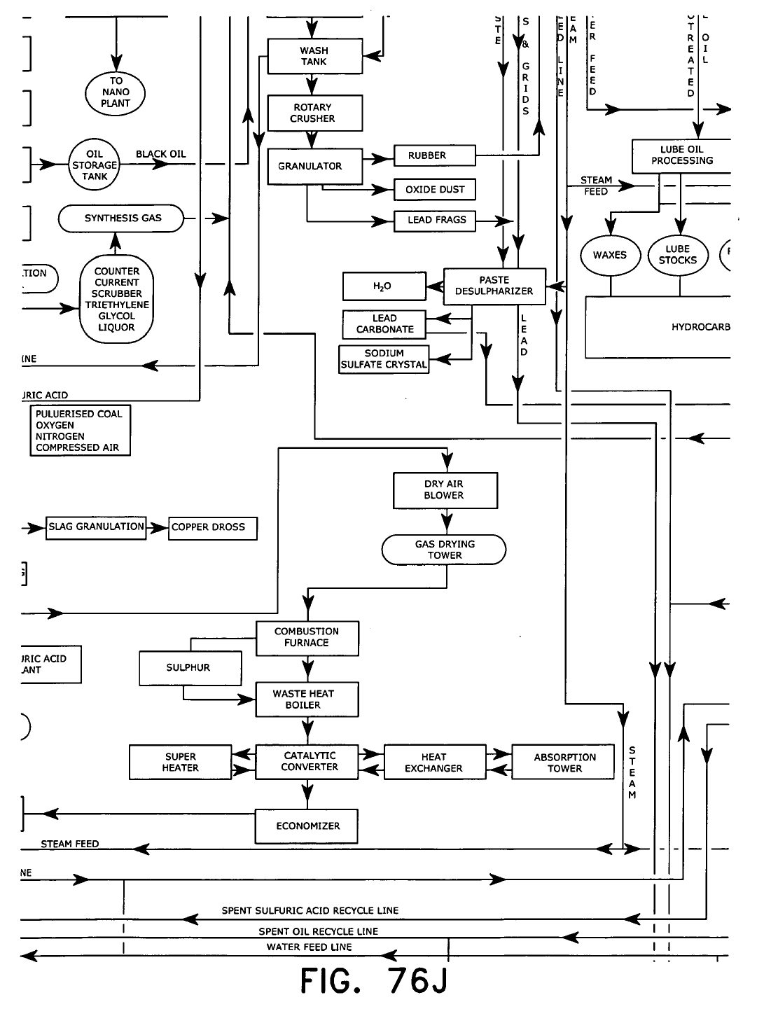

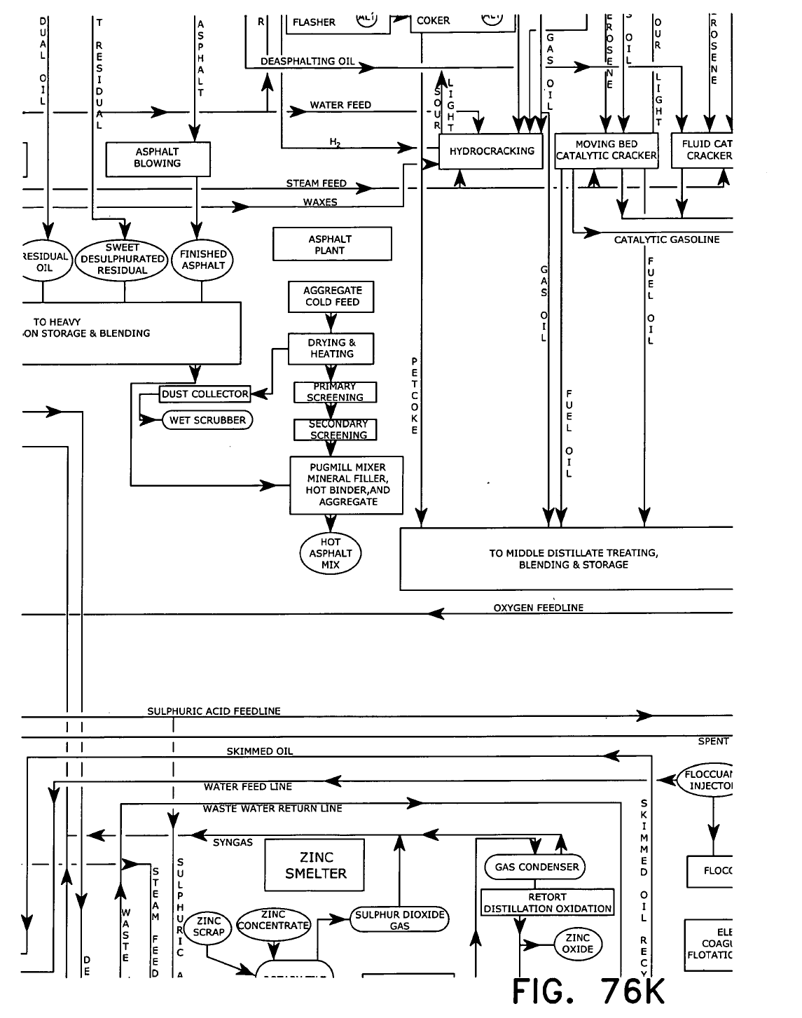

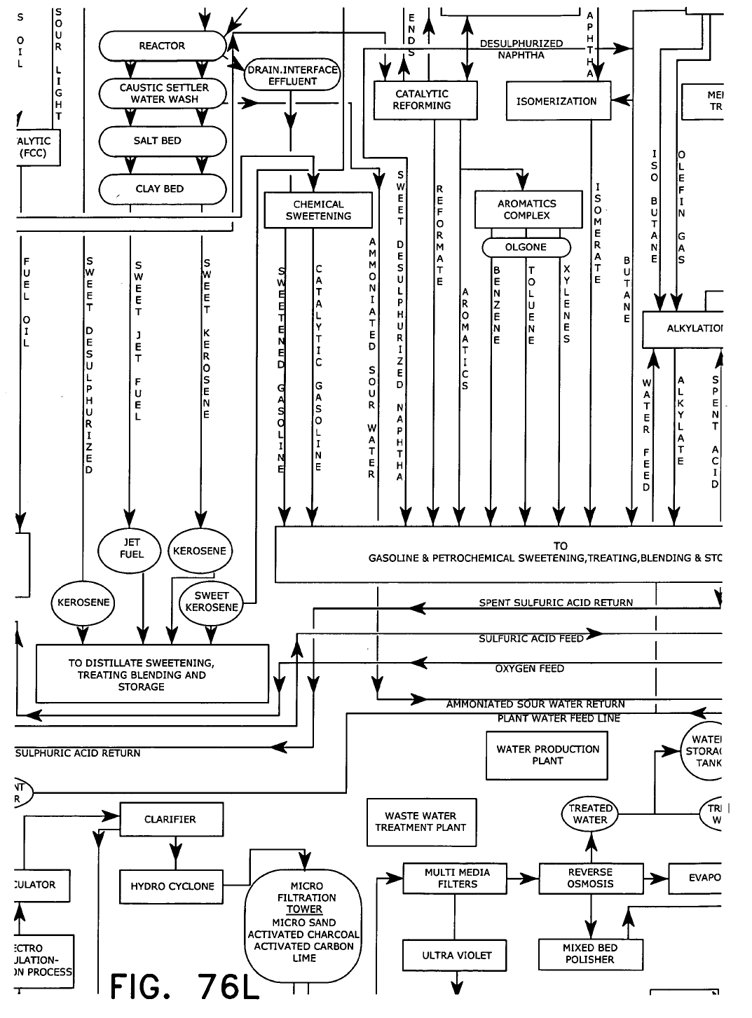

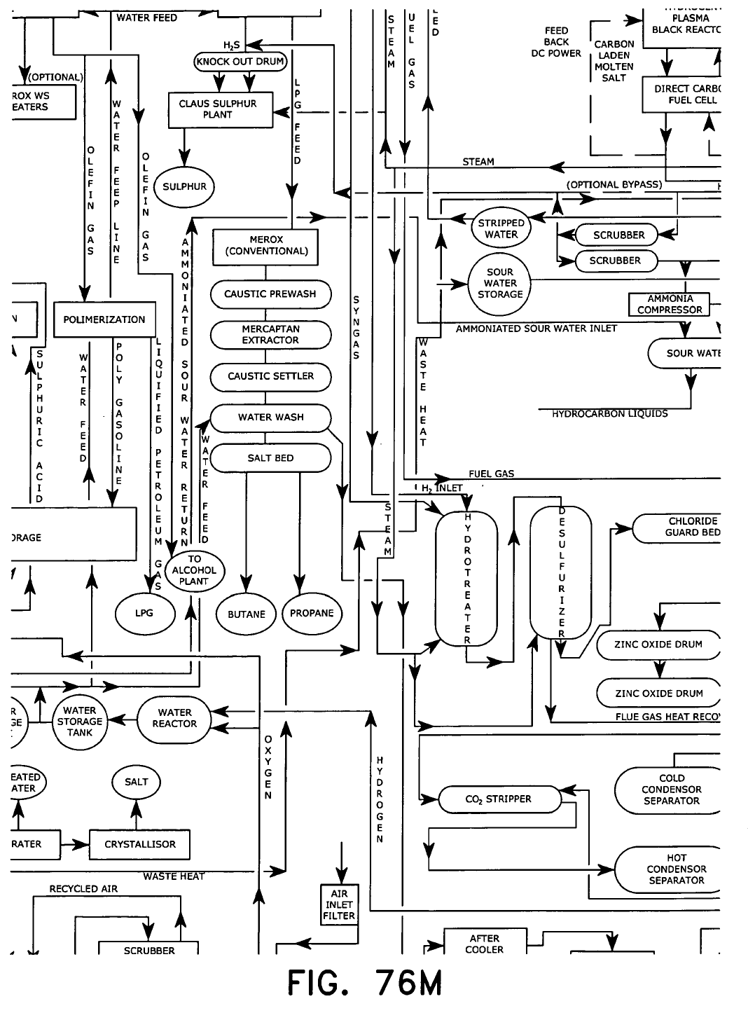

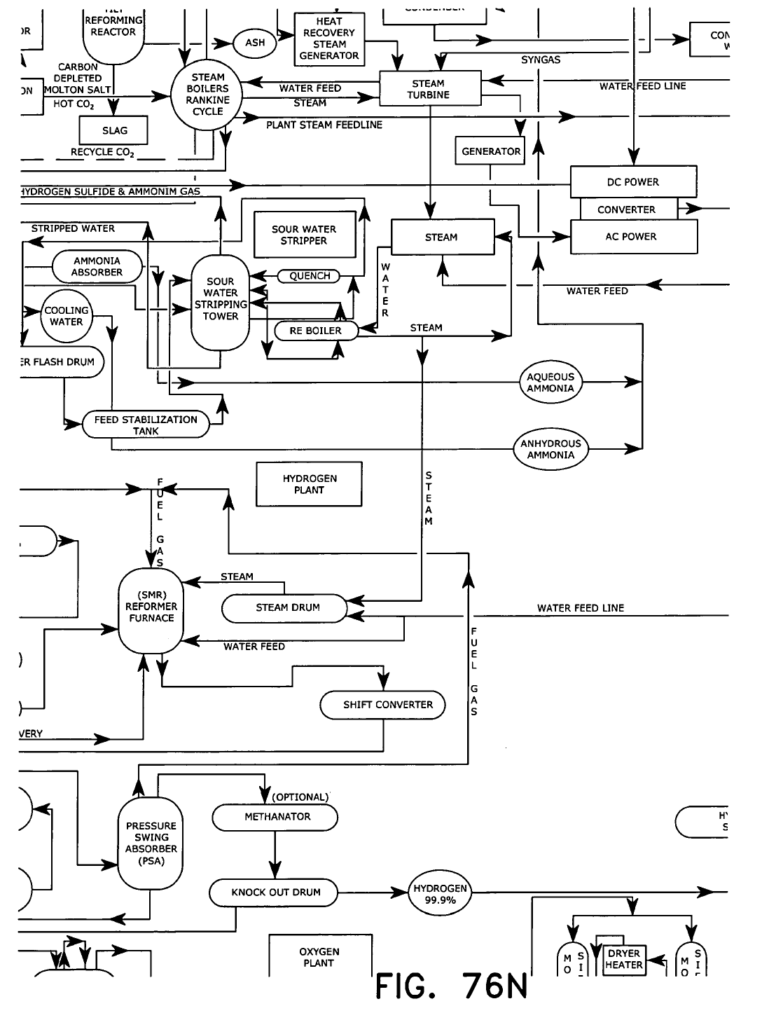

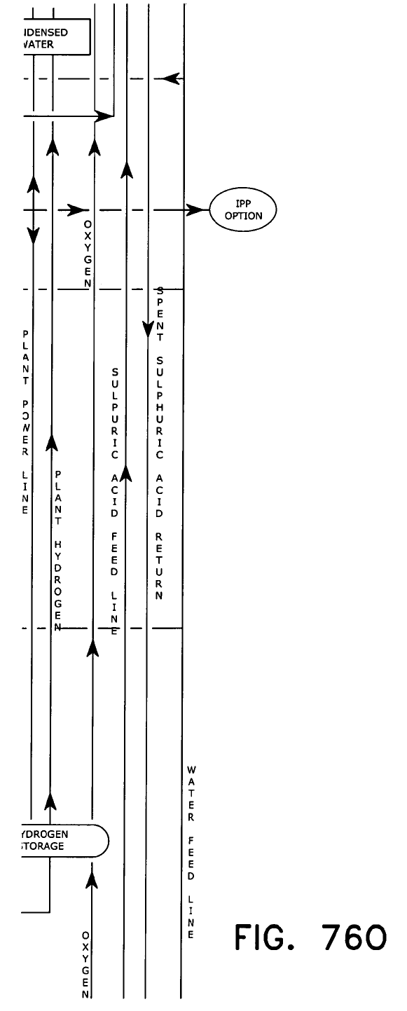

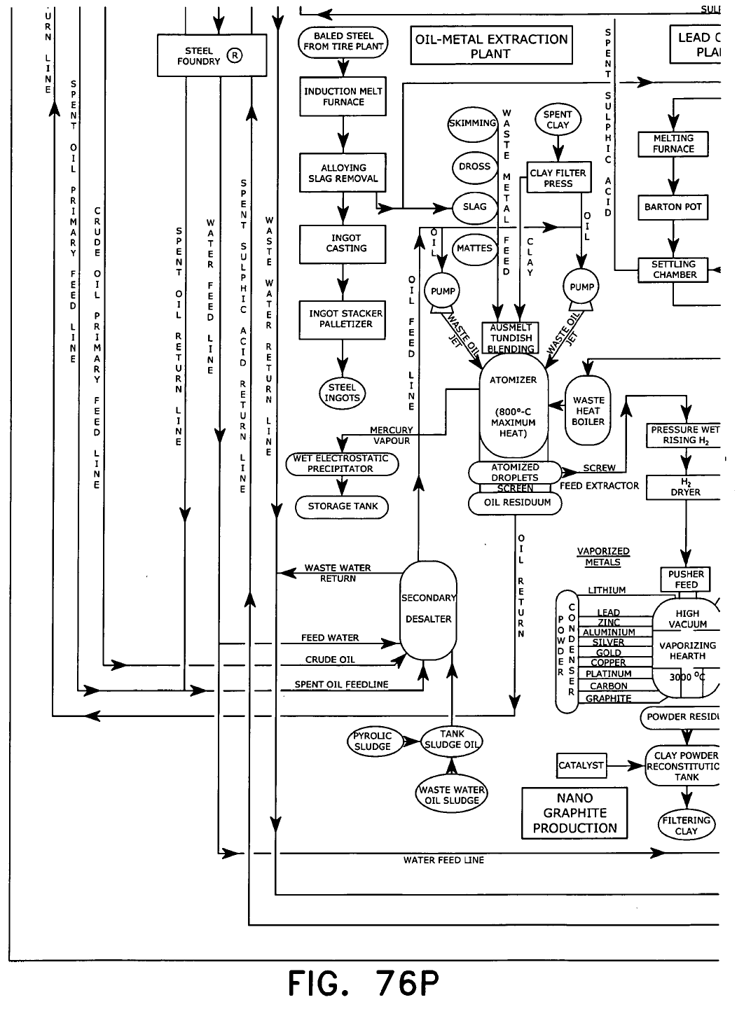

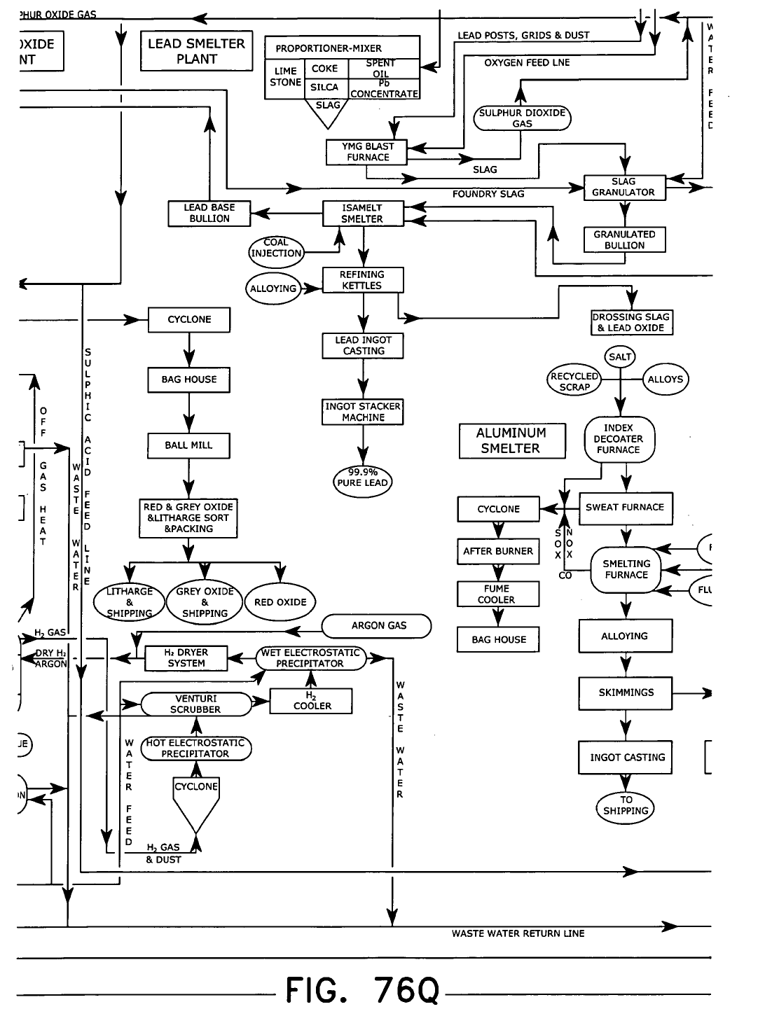

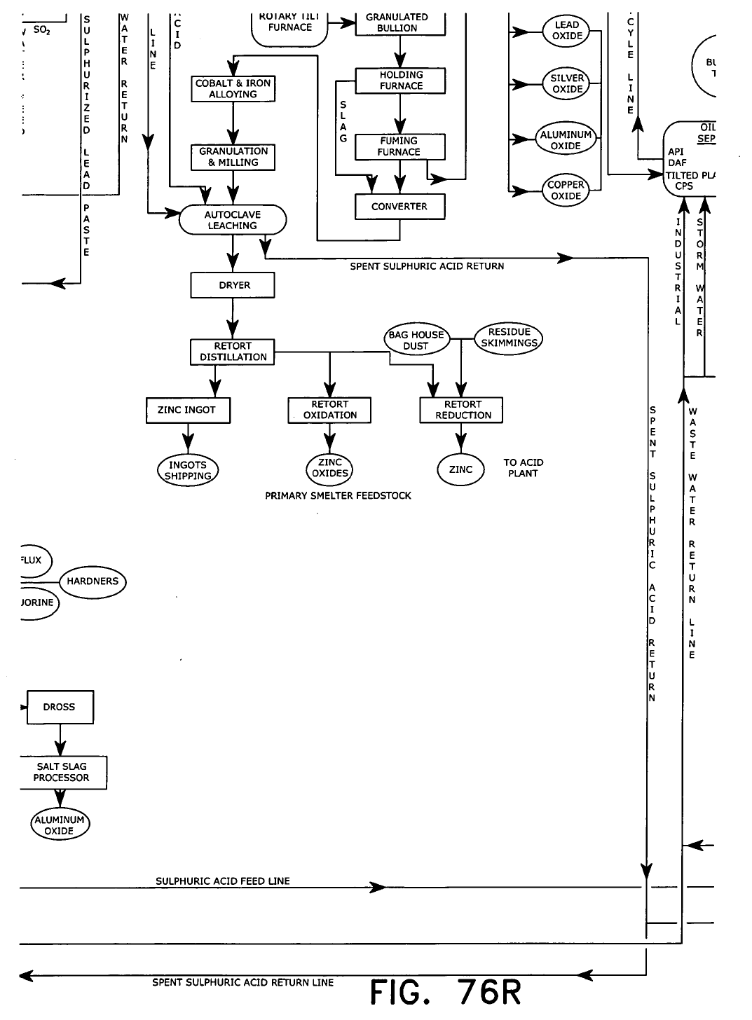

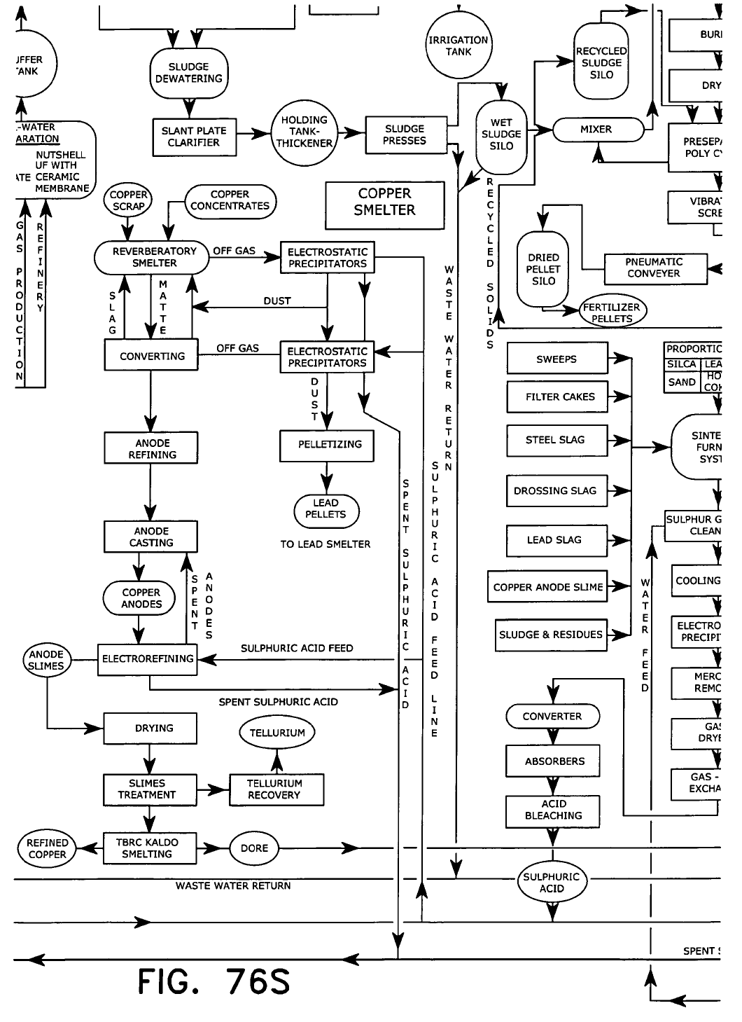

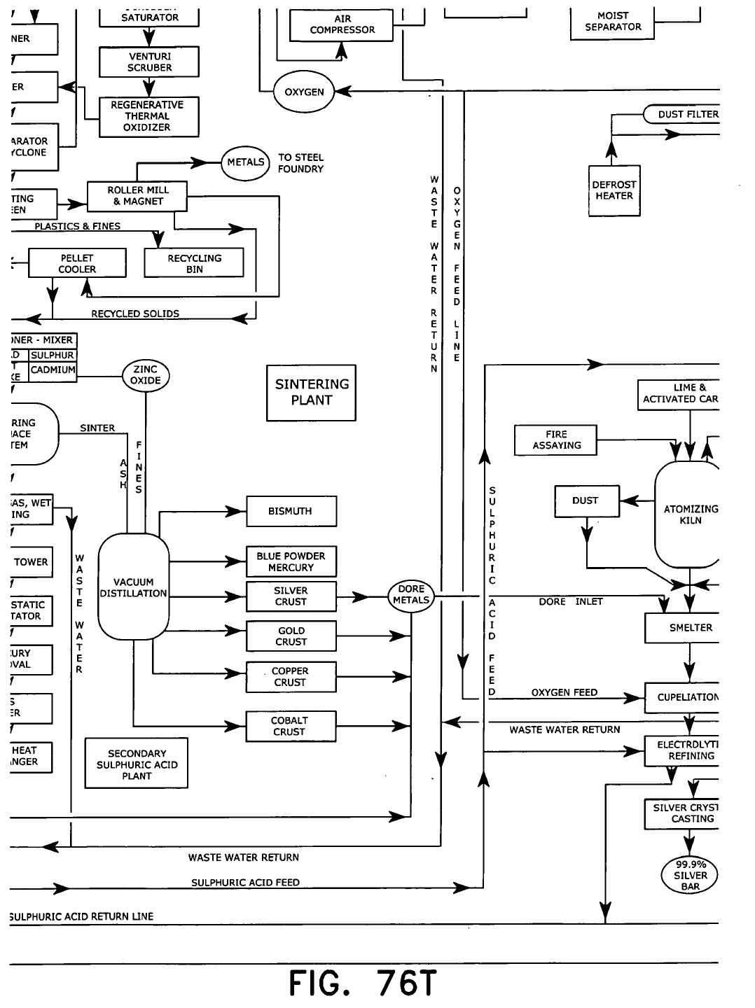

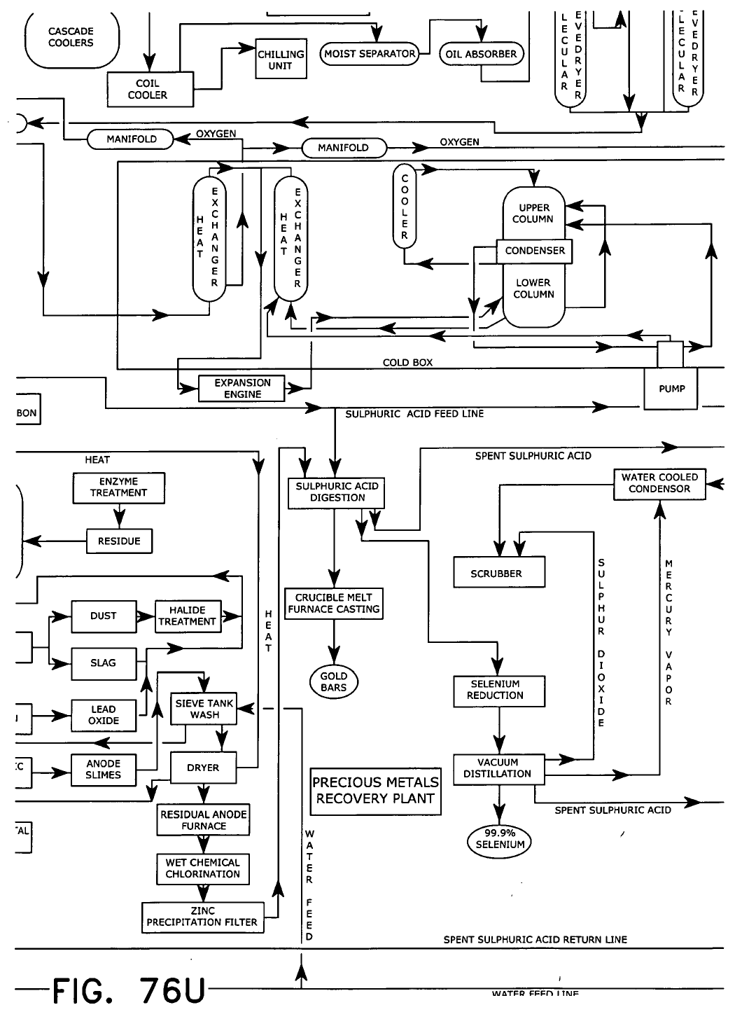

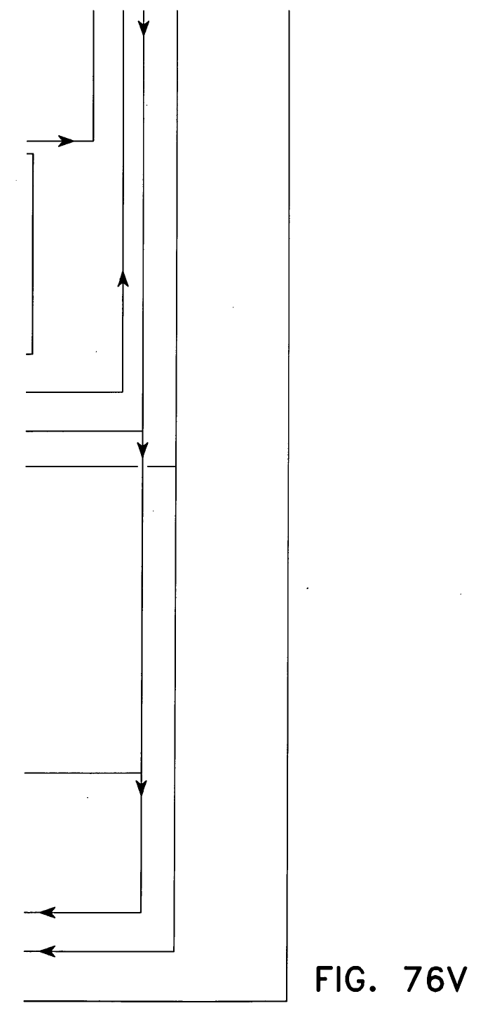

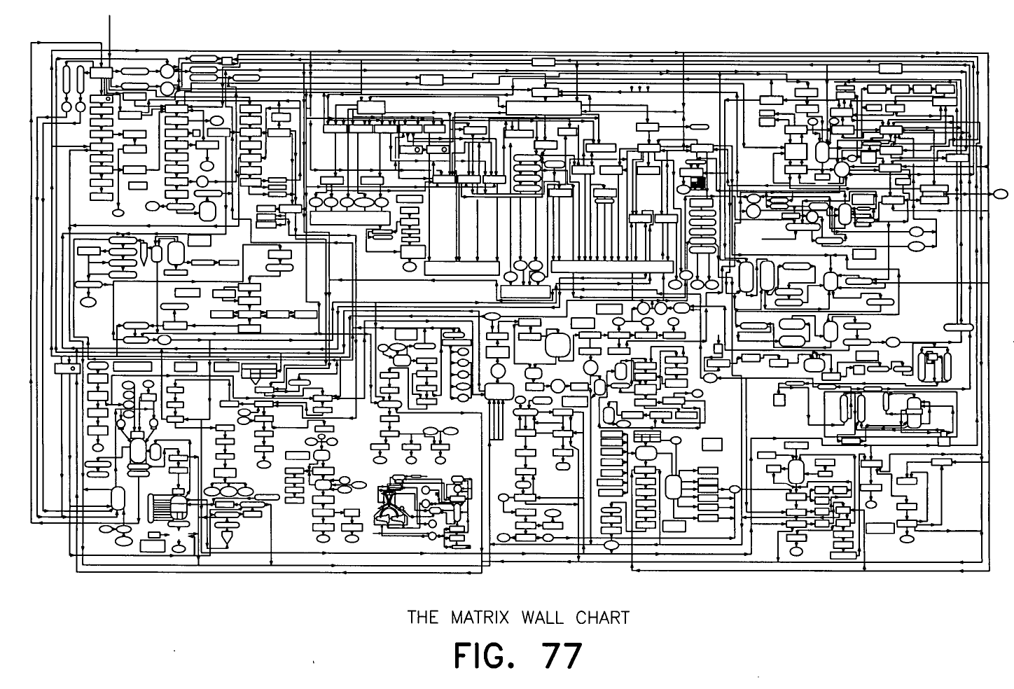

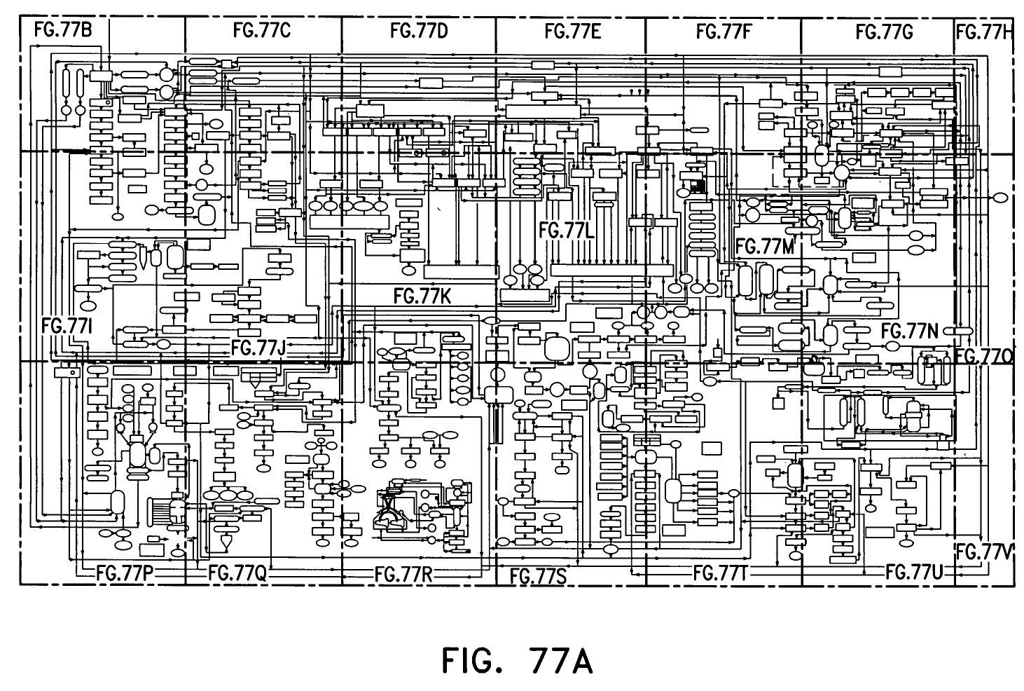

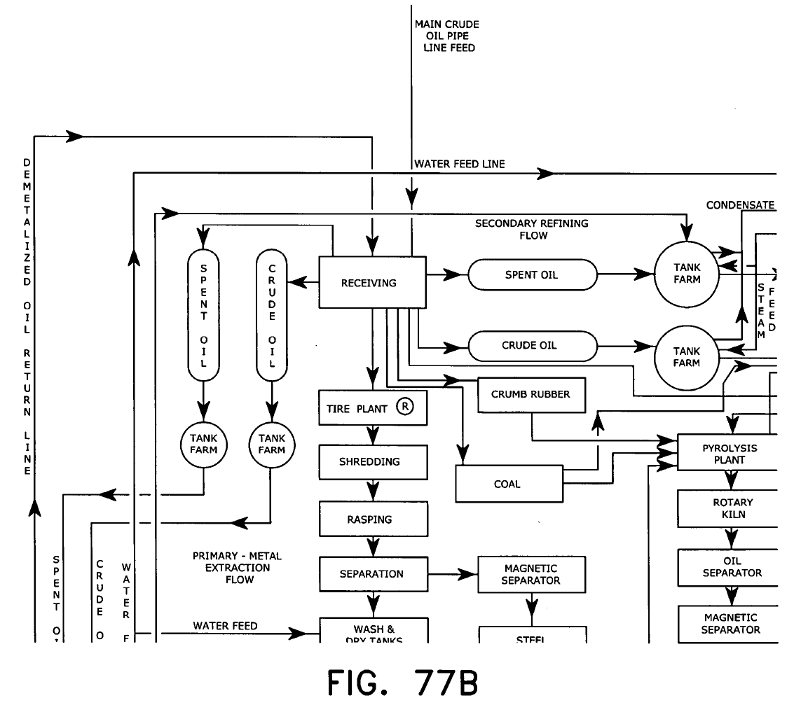

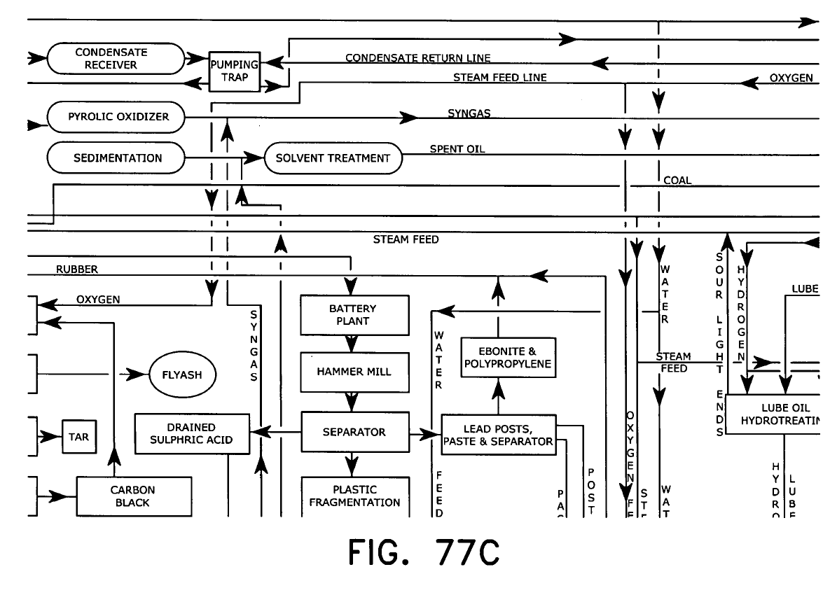

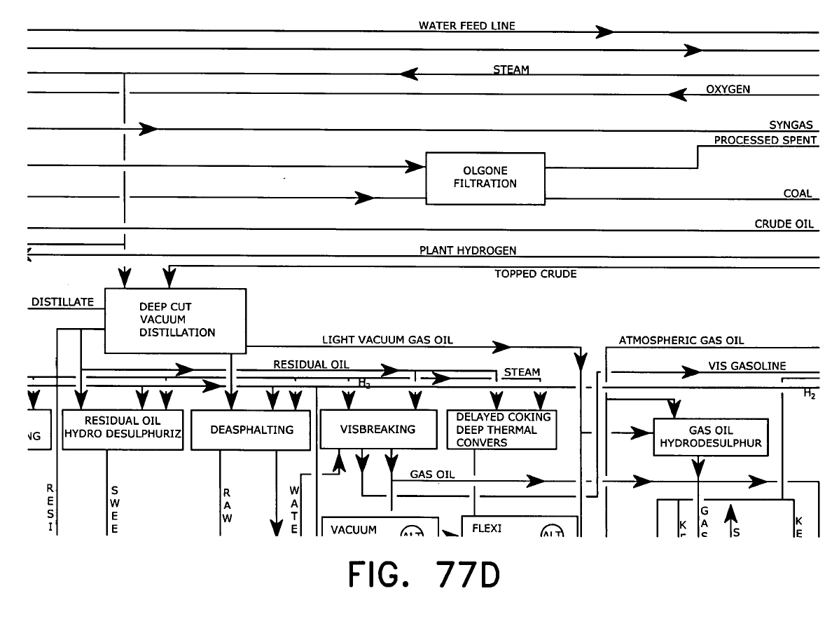

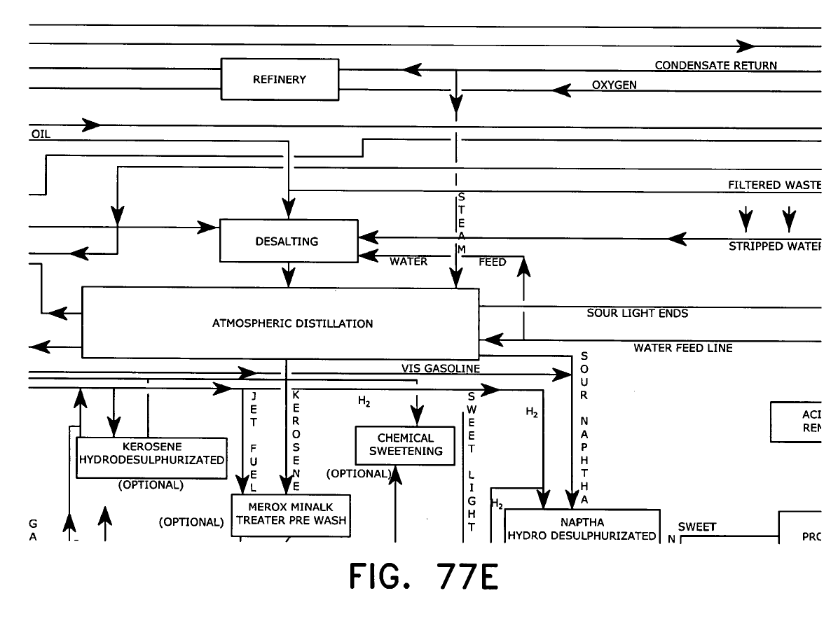

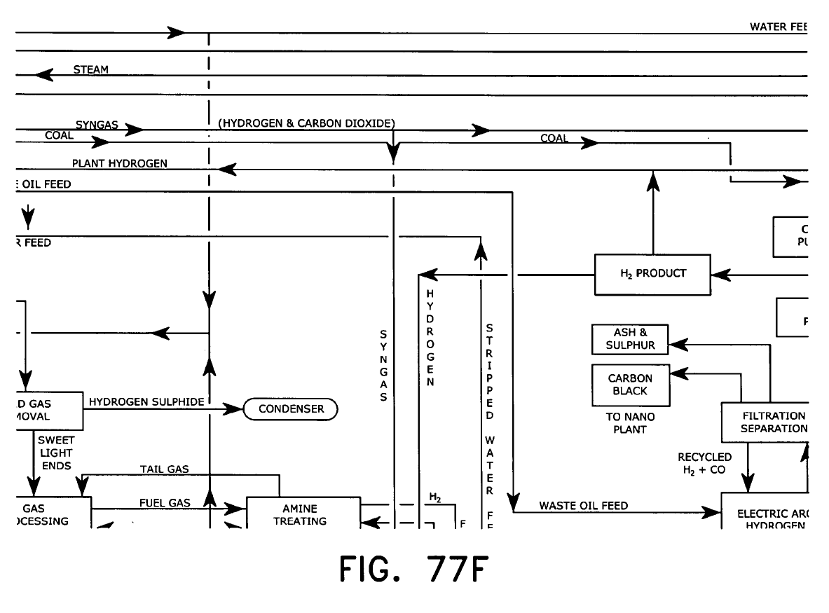

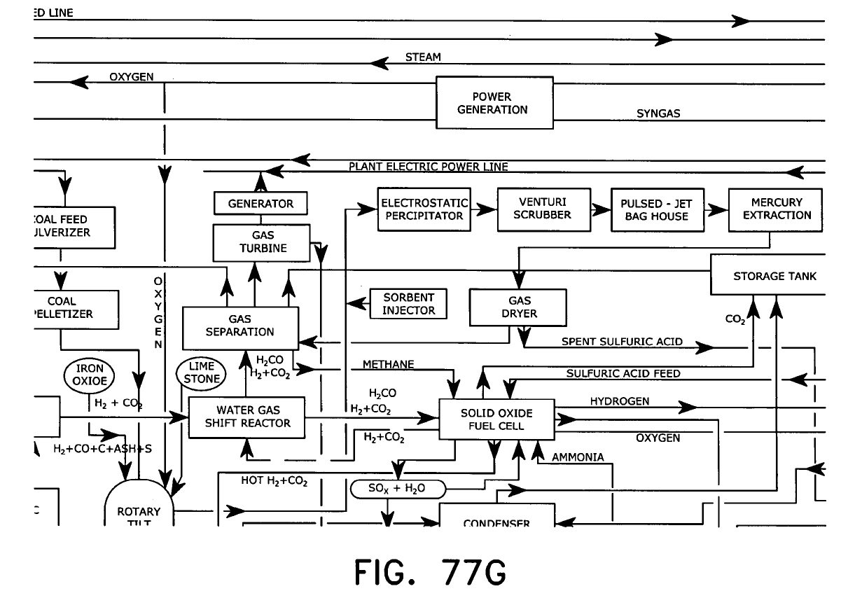

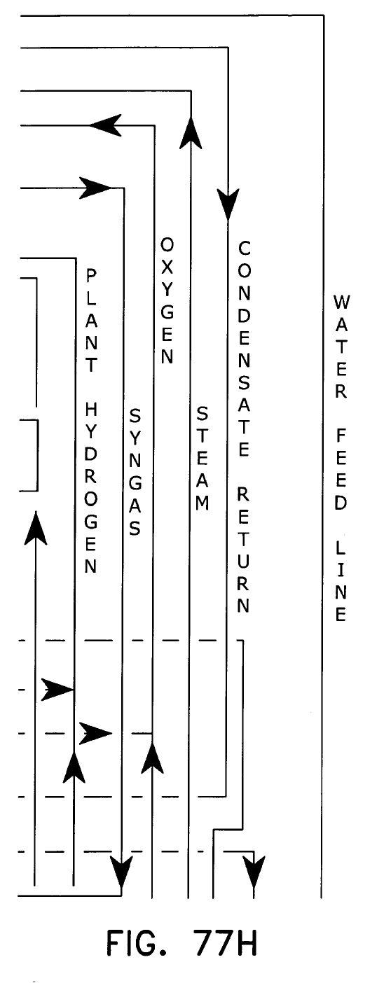

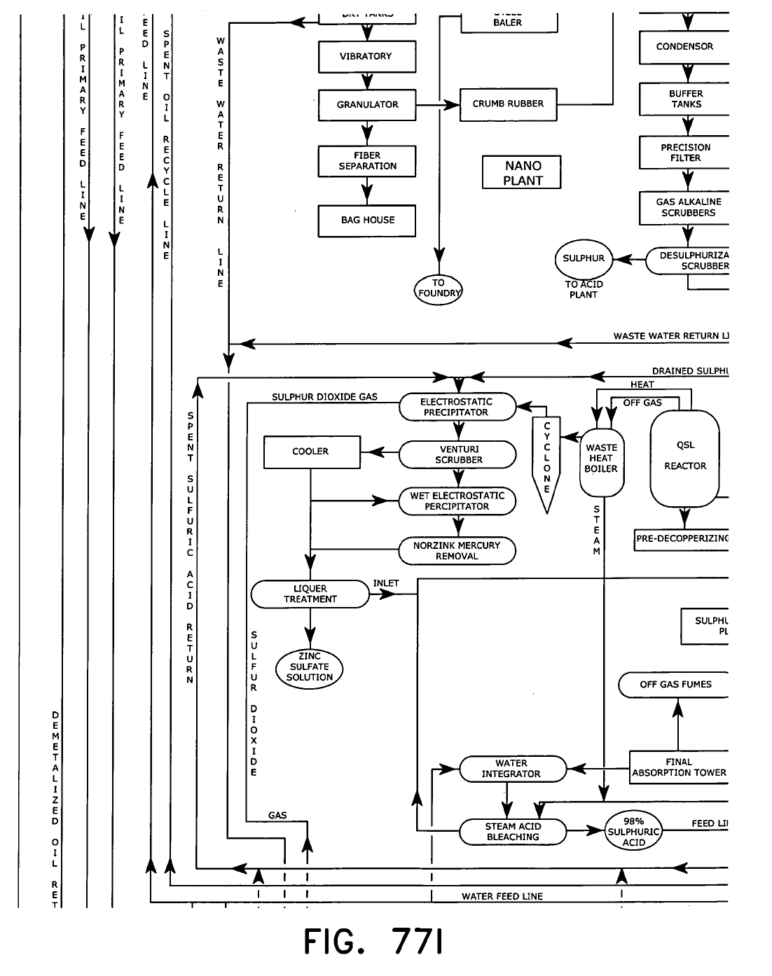

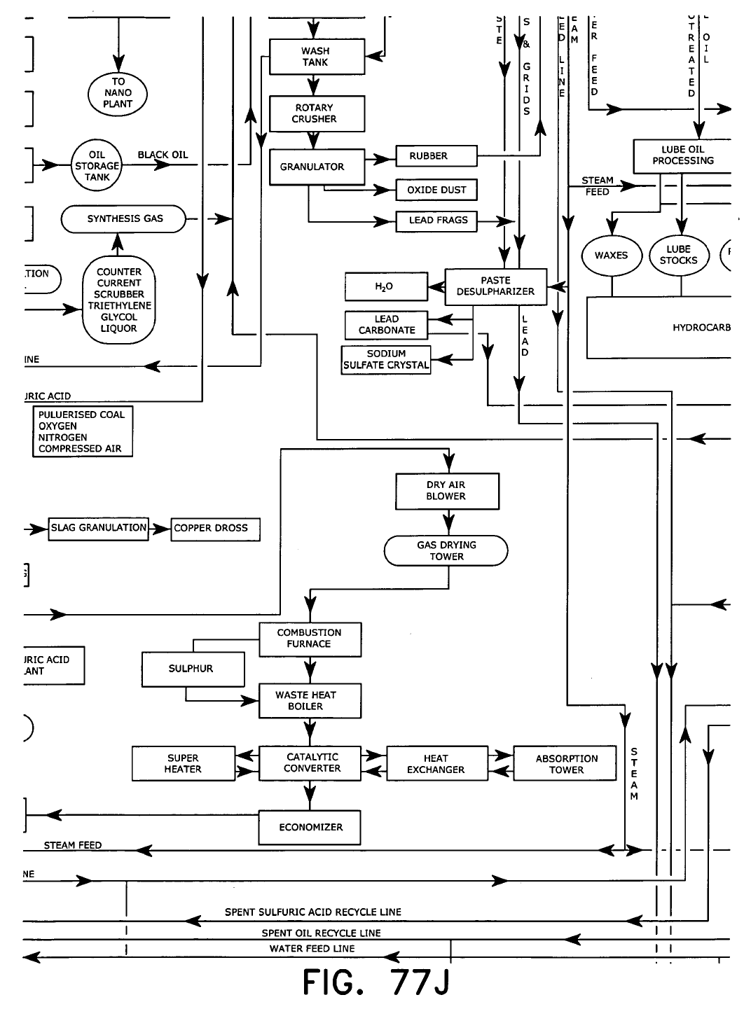

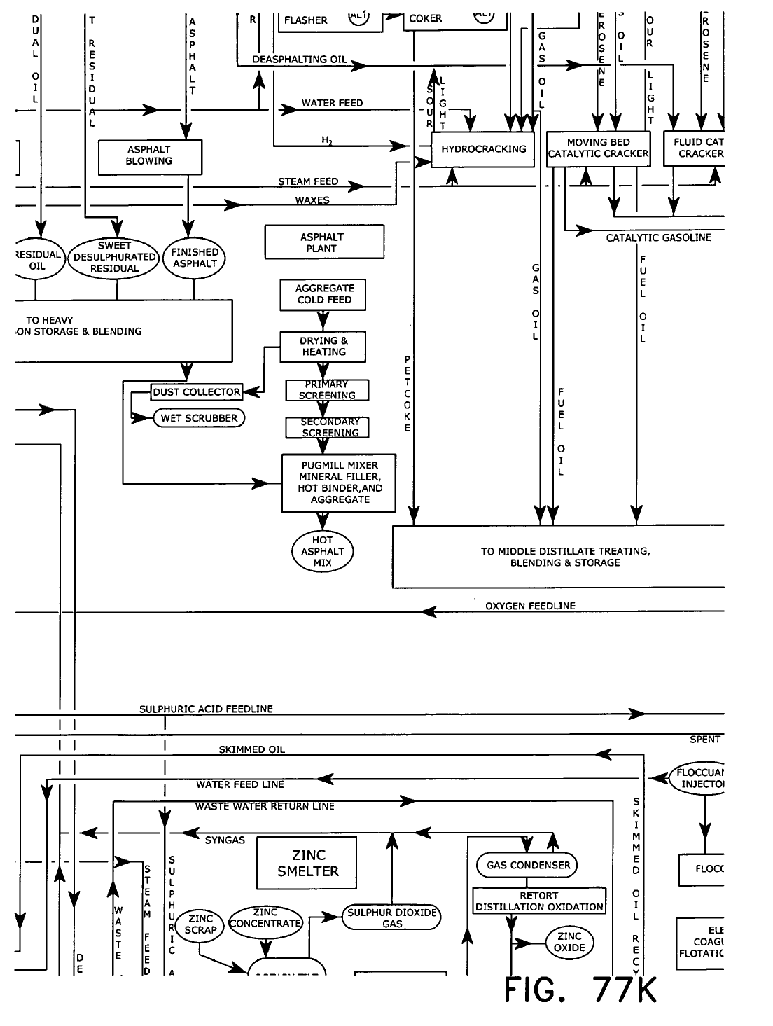

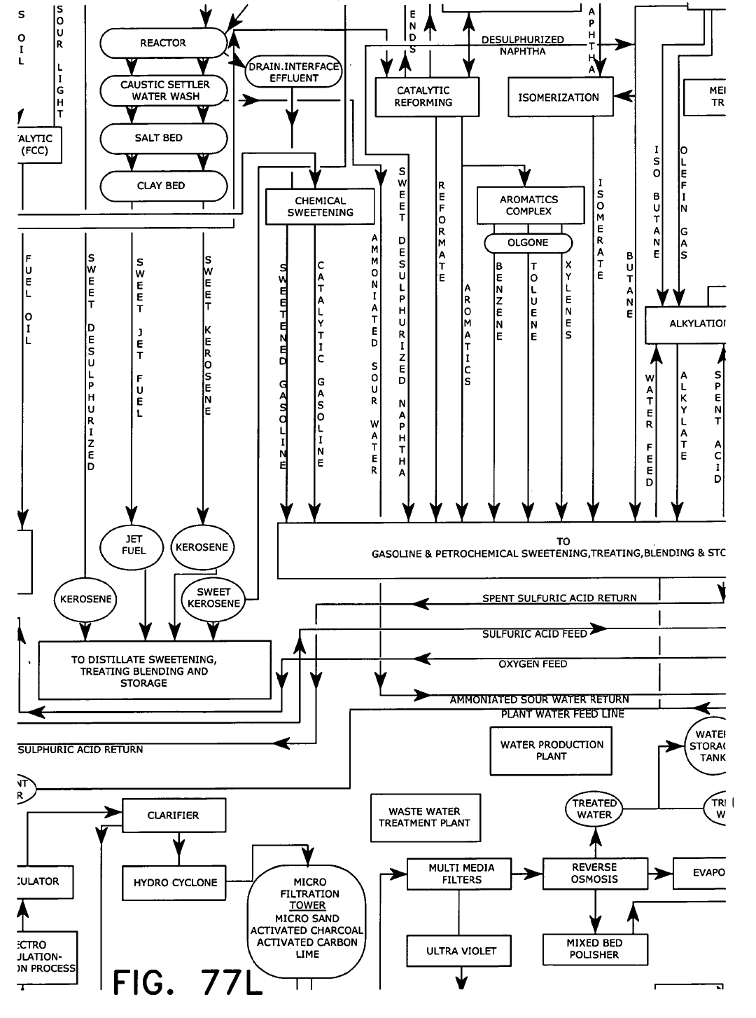

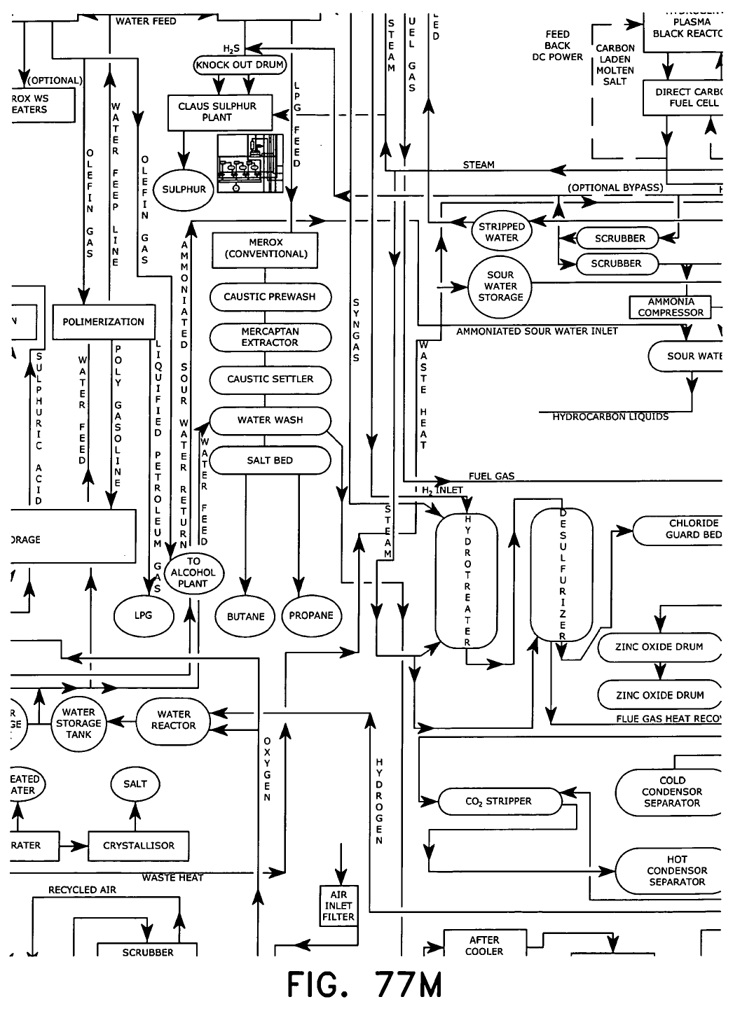

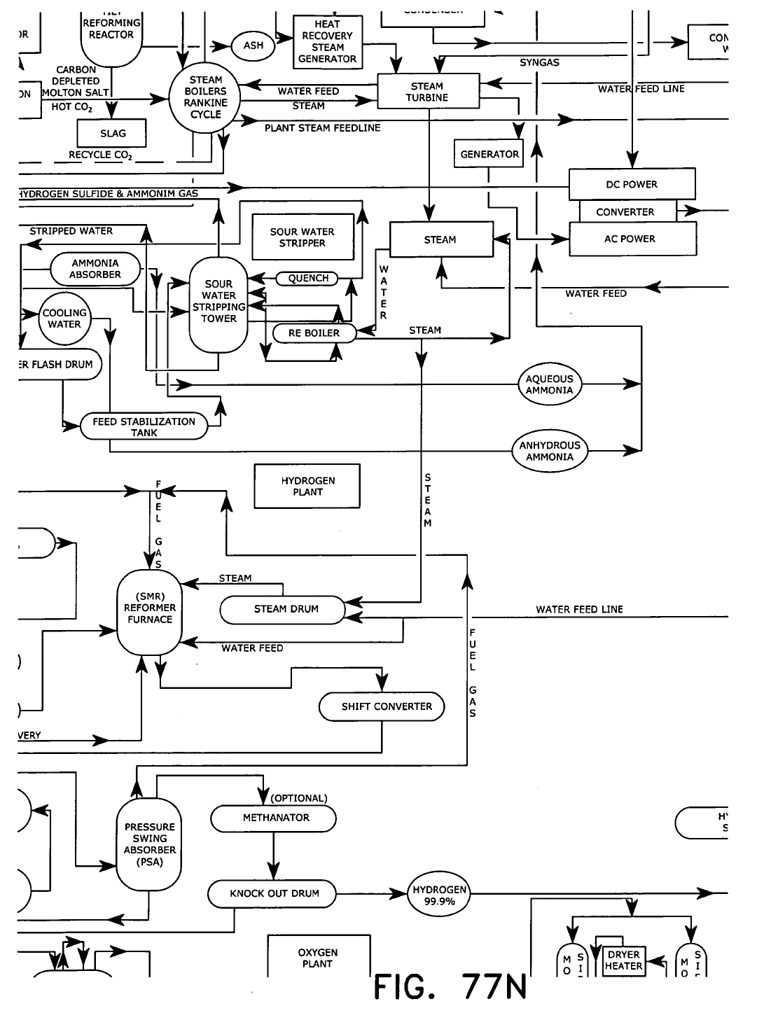

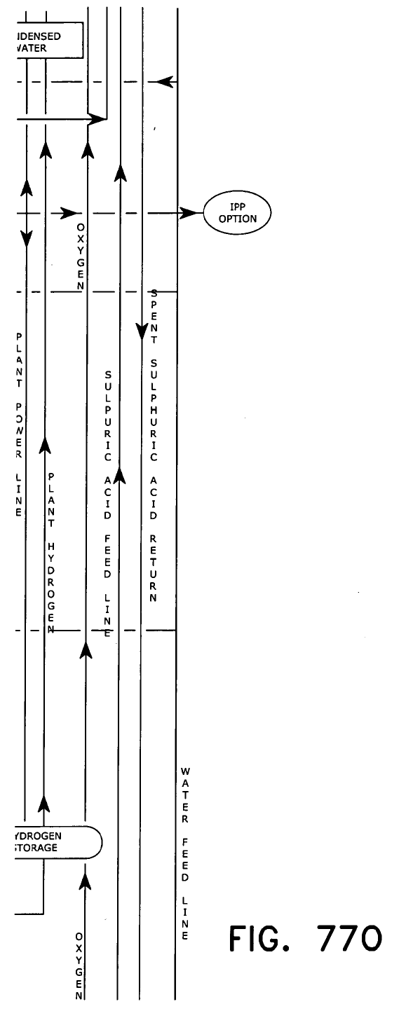

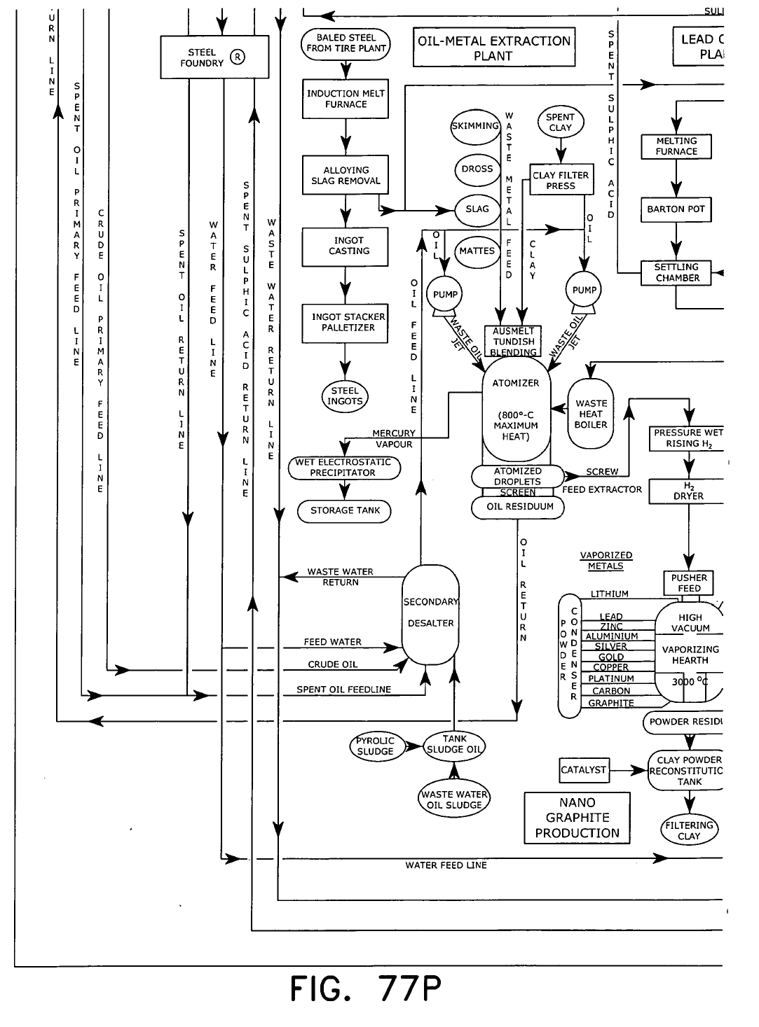

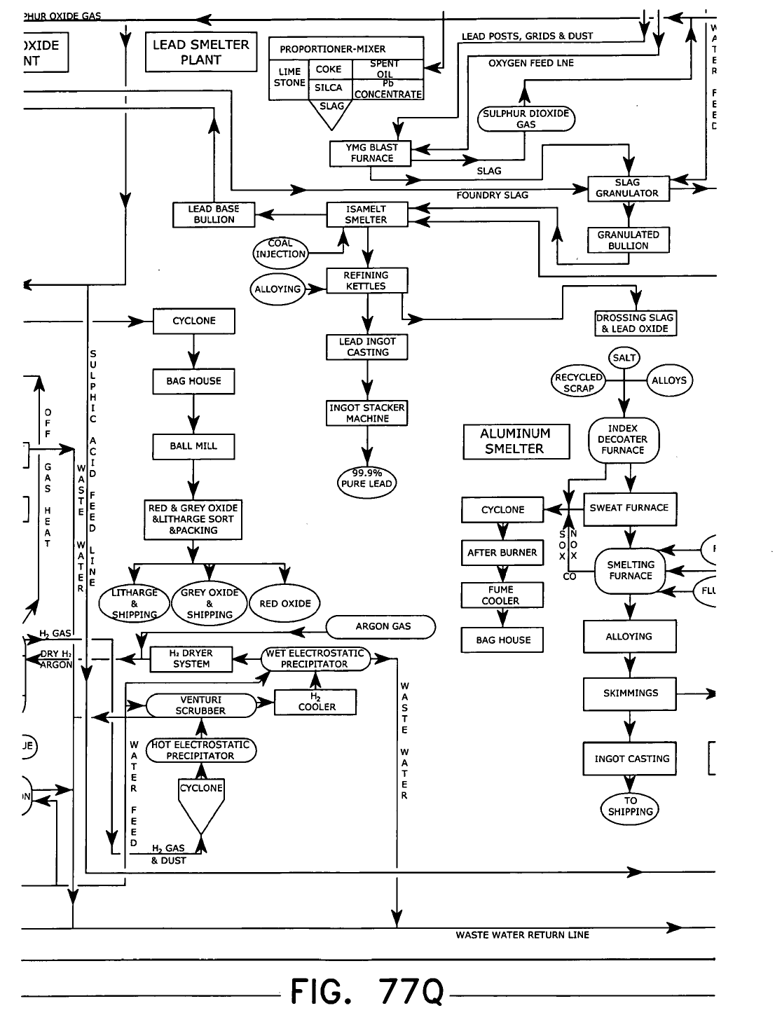

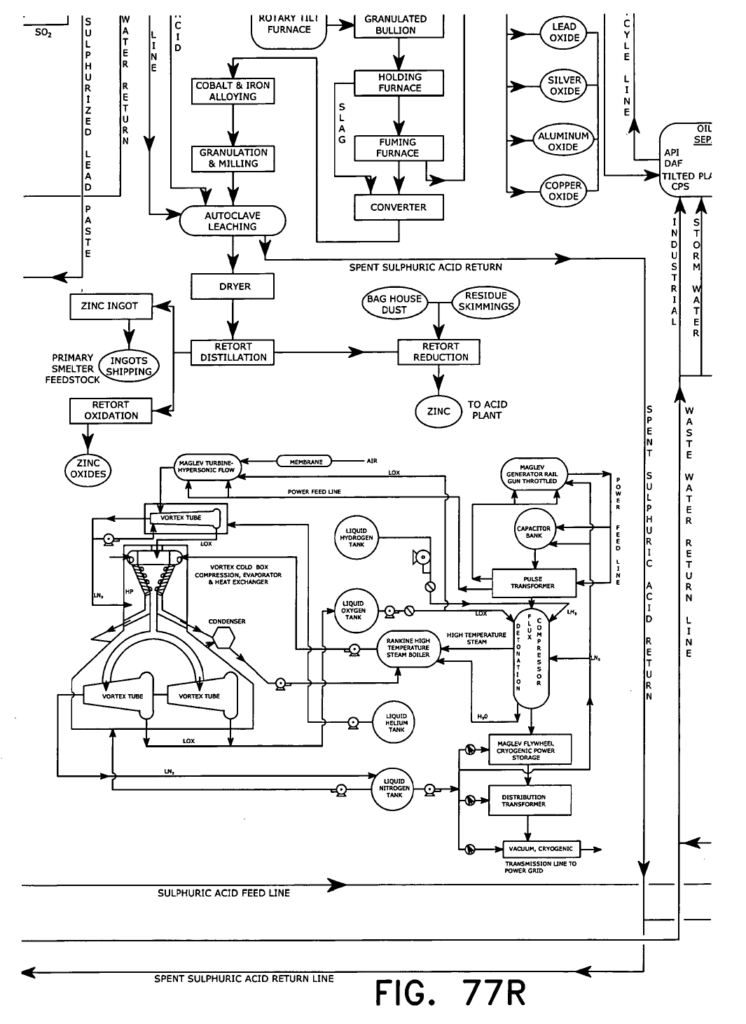

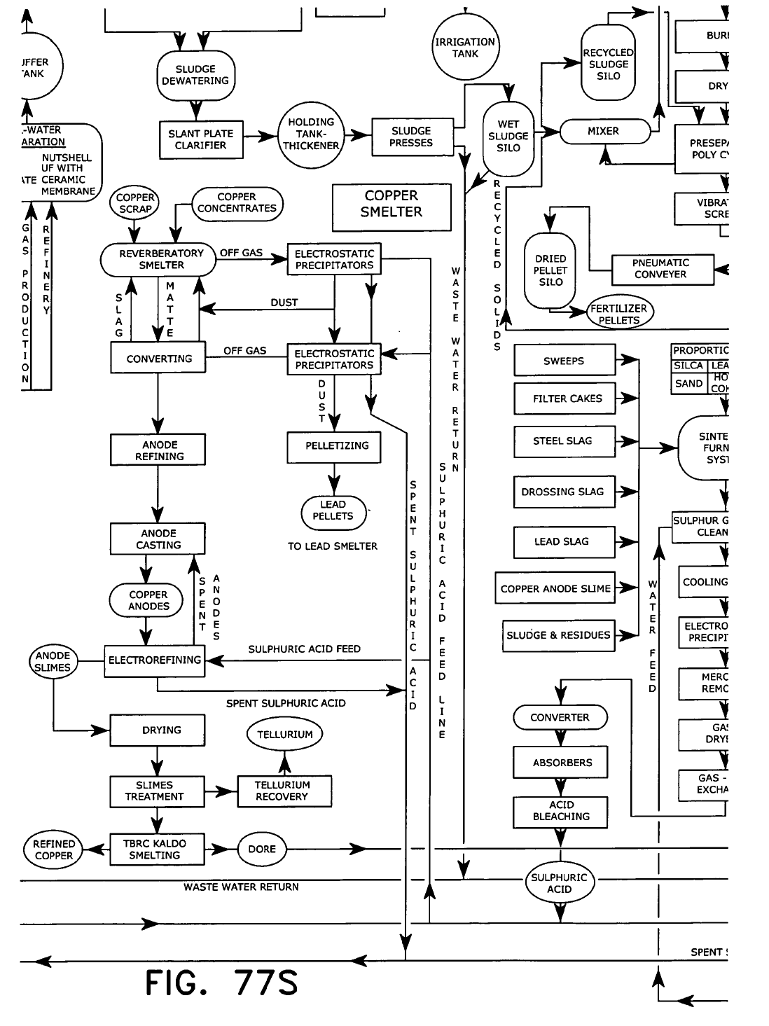

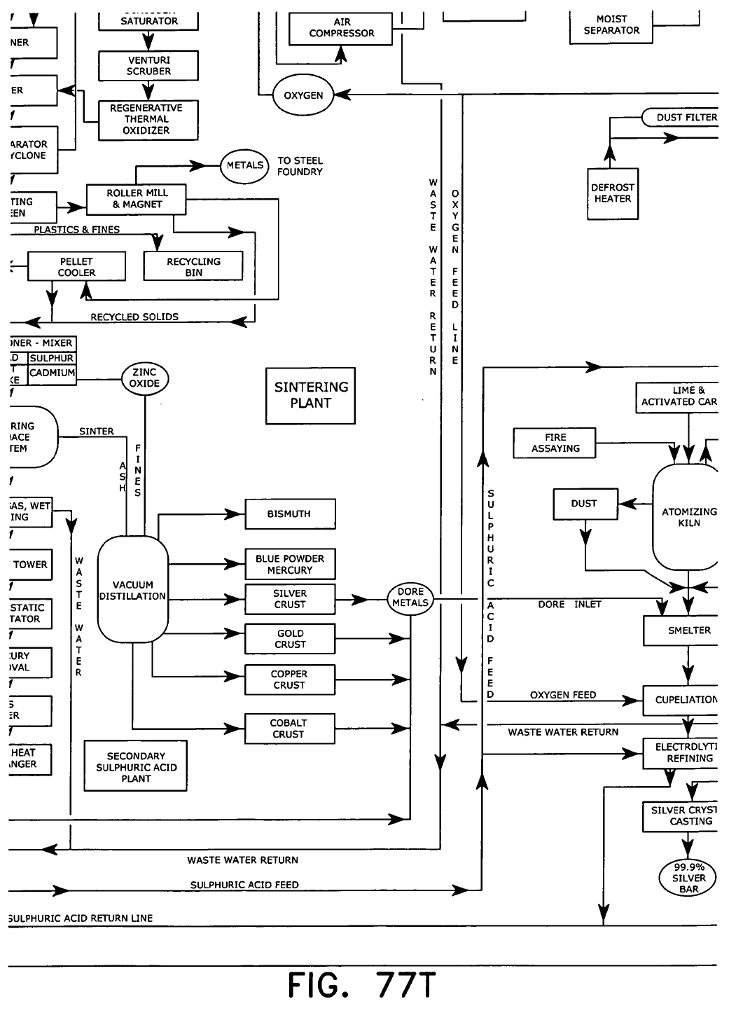

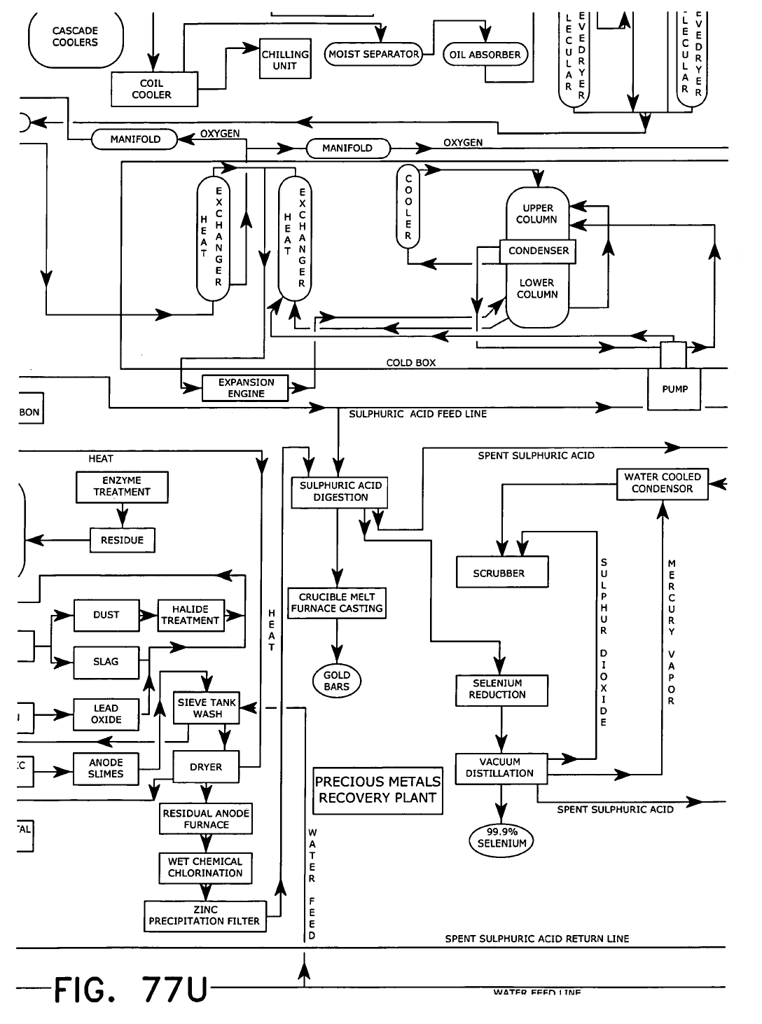

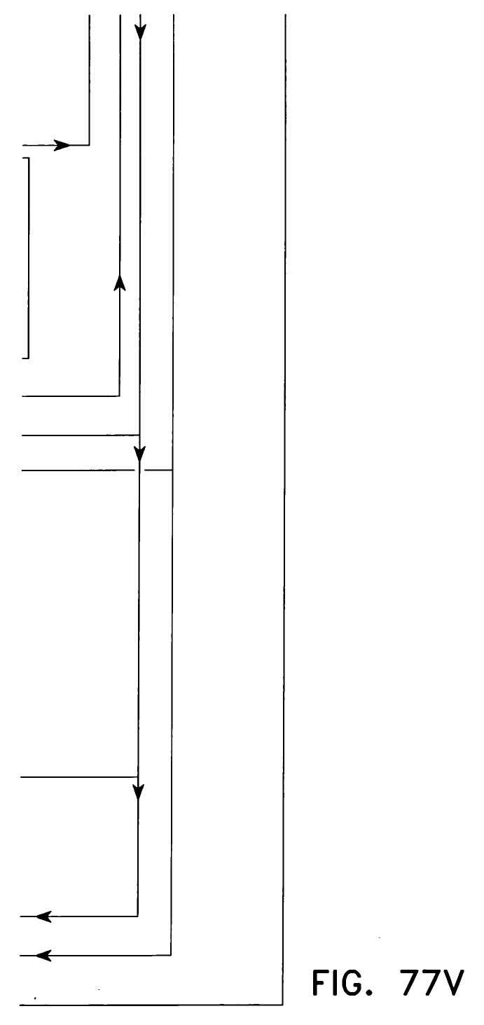

Although most sour gas sweetening involves the amine absorption process, it is also possible to use solid desiccants like iron sponges to remove the sulfide and carbon dioxide. As there is a significant amount of iron passing through the EFSMP it is the preferred embodiment, but without limitation, to use iron sponges. The iron sponges are then sent to the metallurgy plant for processing and the sulfur is sent to the SAR/GAR plant (FIGS. 75 and 76, Cells 10 and 11). However, if needed, the remaining material sulfur gasses are then sent to the Claus Sulfur plant, within the Matrix since the Claus process is able to recover a large percentage of the sulfur that has been removed from the natural gas stream. The remaining sulfur is processed at the SAR/SGR plants within the Matrix. The SAR/SGR plants relate to sulfuric acid and sulfur gas regeneration processing and metals processing. The SAR/SGR plants are novel systems and methods for refining sulfur gas and regenerating sulfuric acid with double absorption capability and a novel systems and methods for the production and regeneration of sulfuric acid for use in a variety of commercial areas through the use of various metal feeds.

Computer monitoring and control systems for data logging and remote service and troubleshooting, as described below.

### Granular Activated Carbon and Carbon Black

One of the most commonly-used adsorbent is activated carbon—a substance which is quite similar to common charcoal. Activated carbon, however, is treated by heat and oxidation so that it becomes extremely porous and able to readily adsorb, or capture, the impurities found in water, including, but not limited to bromine gas, as described below in Ozone O3.

Activated carbon also attracts not only known contaminants, but also naturally dissolved organic matter (much of which is harmless). Therefore, monitoring is needed to ensure that carbon doses are high enough to absorb all contaminants.

There are two different forms of activated carbon in common use, granular activated carbon (GAC) and powdered activated carbon (PAC). Physically, the two differ as their names suggest—by particle size and diameter.

Powdered activated carbon is an inexpensive treatment option (capital cost) that can typically be added to an existing treatment system's infrastructure. This flexibility makes PAC an attractive option for short-term treatment responses to poor water conditions. It is particularly useful to treat taste and color deficiencies.

PAC works quickly and efficiently but it is limited to lower removals than GAC and becomes expensive if it must be used on a continuous basis. When the process is complete the powdered carbon must be removed, usually by filtration.

Overall, activated carbon is better than ion exchange for removing organic substances.

### Granular Activated Carbon

The general principles of adsorption systems are covered in the section on powdered activated carbon (PAC).

Granular activated carbon (GAC) consists of particles about a millimeter in size—ten to 100 times the size of the powdered form. It is typically arranged in a bed or column through which source water is slowly passed or percolated. Sometimes several adsorption columns are linked together in a single system.

Like powdered activated carbon, granular activated carbon also attracts not only known contaminants, but also mostly harmless, naturally dissolved organic matter. Therefore, careful monitoring is needed to ensure that enough carbon remains active to absorb all contaminants. Particulates may also clog systems and compromise their effectiveness. GAC systems have a higher capital cost but are capable of accomplishing higher levels of removal, and their operating costs (mostly the cost of replacing spent GAC) are lower if removal is required on a continuous basis.

Throughout this embodiment, Carbon, Carbon Black, GAC, PAC, charcoal, and the like terms are interchangeable, without limitation, and defined in the present invention as Carbon.

These systems may also serve as biological water filters without compromising effectiveness if beneficial microbes are allowed to grow within the system.

Physical reactivation of carbon: The precursor is developed into activated carbons using gases. This is generally done by using one or a combination of the following processes: a) Carbonization—Material with carbon content is paralyzed at temperatures in the range 600-900 degrees Celsius, in absence of oxygen (usually in inert atmosphere with gases like argon or nitrogen); and b) Activation/Oxidation: Raw material or carbonized material is exposed to oxidizing atmospheres (carbon monoxide, oxygen, or steam) at temperatures above 250 degrees Celsius usually in the temperature range of 600-1200 degrees Celsius.

Computer monitoring and control system for data logging and remote service and troubleshooting, while this process is being done in cell 9.

### Gas Purification

Filters with activated carbon are usually used in compressed air and gas purification to remove oil vapors, odors, and other hydrocarbons from the air. The most common designs use a one stage or a two stage filtration principle in which activated carbon is embedded inside the filter media. Activated charcoal is also used in spacesuit Primary Life Support Systems. Activated charcoal filters are used to retain radioactive gases from a nuclear boiling water reactor turbine condenser. The air vacuumed from the condenser contains traces of radioactive gases. The large charcoal beds adsorb these gases and retain them while they rapidly decay to non-radioactive solid species. The solids are trapped in the charcoal particles, while the filtered air passes through.

A computerized monitor and control system for data logging and remote service and troubleshooting is known.

### Regeneration

The regeneration of activated carbons involves restoring the adsorptive capacity of saturated activated carbon by desorbing adsorbed contaminants on the activated carbon surface.

Thermal regeneration at the EFSMP—one of the most common regeneration techniques employed in industrial processes is thermal regeneration. The thermal regeneration process generally follows three steps: a) Absorbent drying at approximately 105 degrees Celsius; b) High temperature desorption and decomposition (500-900 degrees Celsius) under an inert atmosphere; and c) Residual organic gasification by an oxidizing gas (steam or carbon dioxide) at elevated temperatures (800 degrees Celsius).

The heat treatment stage utilizes the exothermic nature of adsorption and results in desorption, partial cracking and polymerization of the adsorbed organics. The final step aims to remove charred organic residue formed in the porous structure in the previous stage and re-expose the porous carbon structure regenerating its original surface characteristics. After treatment the adsorption column can be reused. Per absorption-thermal regeneration cycle between 5-15 wt % of the carbon bed is burnt off resulting in a loss of adsorptive capacity.

A computerized monitoring and control system for data logging and remote service and troubleshooting is also used.

### Other Regeneration Techniques

Current alternative regeneration methods are: a) Chemical and solvent regeneration; b) Microbial regeneration; c) Electrochemical regeneration; d) Ultrasonic regeneration; and e) Wet air oxidation.

The electrochemical regeneration of activated carbon based adsorbents involves the removal of molecules adsorbed onto the surface of the adsorbent with the use of an electric current in an electrochemical cell restoring the carbon's adsorptive capacity. Electrochemical regeneration represents an alternative to thermal regeneration commonly used in waste water treatment applications. Common absorbents include powdered activated carbon (PAC), granular activated carbon (GAC) and activated carbon fiber.

There are several mechanisms by which passing a current through the electrochemical cell can encourage pollutant desorption. Ions generated at the electrodes can change local pH conditions in the divided cell which affect the adsorption equilibrium and have been shown to promote desorption of organic pollutants such as phenols from the carbon surface. Other mechanisms include reactions between the ions generated and the absorbed pollutants resulting in the formation of a species with a lower adsorptive affinity for activated carbon that subsequently desorbs, or the oxidative destruction of the organics on the carbon surface. It is agreed that the main mechanisms are based on desorption induced regeneration as electrochemical effects are confined to the surface of the porous carbons so cannot be responsible for bulk regeneration. The performance of different regeneration methods can be directly compared using the regeneration efficiency.

### Cathodic Regeneration

The cathode is the reducing electrode and generates OH (ions which increases local pH conditions). An increase in pH can have the effect of promoting the desorption of pollutants into solution where they can migrate to the anode and undergo oxidation hence destruction. Cathodic regeneration has shown regeneration efficiencies for adsorbed organic pollutants, such as phenols, of the order of 85% based on regeneration times of four hours with applied currents between 10-100 mA.

### Anodic Regeneration

The anode is the oxidizing electrode and as a result has a lower localized pH during electrolysis which also promotes desorption of some organic pollutants. Regeneration efficiencies of activated carbon in the anodic compartment are lower than that achievable in the cathodic compartment by between 5-20 percent for the same regeneration times and currents, however there is no residual organic due to the strong oxidizing nature of the anode.

### Repeated Adsorption-Regeneration

For the bulk of carbonaceous adsorbents regeneration efficiency decreases over subsequent cycles as a result of pore blockages and damage to adsorption sites by the applied current. Decreases in regeneration efficiency are typically a further 2% per cycle. As such, this embodiment provides that the EFSMP material is larger regenerable, and recyclable, through absorptive capacity by means of either sending the material back to the tilt furnace reactor for regeneration or by including such systems as electrochemical regeneration, in part, tandem, dual, parallel, and looped back means.

### Commercial Electrochemical Regeneration Systems

Further, the EFSMP utilizes a carbon adsorbent called Nyex in a continuous adsorption-regeneration system that uses electrochemical regeneration to adsorb and destroy organic pollutants. Someone of ordinary skill in the art has the ability to integrate such primary, secondary, or tertiary systems, methods, and procedures, of apparatus into the configuration of the proposed EFSMP.

Carbon Black—Carbon Black also includes Nano Carbon Black, graphite, nanographite and flexible graphites.

As Carbon Black is used for Water Filtration. One example of how to achieve this is described in U.S. Pat. No. 6,426,007; removal of soluble metals in waste water from aqueous cleaning and etching processes provides a method for treating waste water containing organic bases such as tetramethyl ammonium hydroxide and dissolved metals such as Mo, W, Cu and Ni and U.S. Pat. No. 3,803,807—a carbon black process employing a compartmentalized housing, the lower portion of the bag being positioned in a lower compartment and the upper portion of the bag being positioned in the upper compartment. On carbon black removal from the bag, the black is removed first from the walls of the upper portion of the bag and thereafter from the walls of the lower portion of the bag.

Carbon black is the general term used to describe a powdery commercial form of carbon. Carbon black is a lot like graphite—carbon forms the largest number of compounds, next only to hydrogen. It ranks seventeenth in the order of abundance in the earth's crust. Carbon occurs in the free native state as well as in the combined state. Carbon and its compounds are widely distributed in nature.

In its elemental form, carbon occurs in nature as diamond and graphite. Coal, charcoal and coke are impure forms of carbon. The latter two are obtained by heating wood and coal, and sometimes coconut, in the absence of air, respectively. In the combined state, carbon is present as carbonate in many minerals, such as hydrocarbons in natural gas, petroleum etc. In air, carbon dioxide is present in small quantities, (0.03%). Moreover, carbon black is a material produced by the incomplete combustion of heavy petroleum products such as FCC tar, coal tar, ethylene cracking tar, and a small amount from vegetable oil. Carbon black is a form of amorphous carbon that has a high surface-area-to-volume ratio, although its surface-area-to-volume ratio is low compared to that of activated carbon. It is dissimilar to soot in its much higher surface-area-to-volume ratio and significantly less (negligible and non-bioavailable) PAH (polycyclic aromatic hydrocarbon) content. Carbon Black is also a byproduct of the EFSMP's petroleum processing, and is also remnants of coal processing, that is achieved in cells 6 and 9, respectively. Because of the abundance of this material, at every EFSMP location, in addition to activated carbon, and the like, and in combination, tandem, synch, and the like, etc., with same, Carbon Black is also used for water filtration.

Surface chemistry of all carbon blacks has chemisorbed oxygen complexes (i.e., carboxylic, quinonic, lactonic, phenolic groups and others) on their surfaces to varying degrees depending on the conditions of manufacture. These surface oxygen groups are collectively referred to as volatile content. It is also known to be a non-conductive material due to its volatile content. As carbon black is produced on site, the embodiment in the present invention proposes, and provides for customization of same, based upon user requirements, especially where the user requires specific amounts of chemically-bonded oxygen (from onsite product streams of oxygen) on the surface area of the black, so that there is an increase in its ability to have enhanced performance characteristics.

Carbon black is also produced, at the EFSMP, where, from material streams, such as natural gas, the natural gas is burnt in a limited supply of air, and the resulting soot is deposited on the underside of a revolving disc. The carbon black and is then scraped off and filled in bags. It differs from lamp black in being not so greasy.

In the production of Gas carbon and petroleum coke, water from cell 9, has come into contact with Carbon scraped from the walls of the retort used for the destructive distillation of coal, and the material (sans water) is called gas carbon. During refining of crude petroleum, petroleum coke is deposited on the walls of the distillation tower.

Both, gas carbon and petroleum coke are used for making electrodes in dry cells and are good conductors of electricity. Some petroleum coke is converted into Carbon Black, and such material is used in Cell 14 for water treatment.

Fullerenes, Diamonds, Graphites, that are processed, from coal, in cell 9 or are part of the material not cannibalized in Cell 9's side stream materials, if not previously extracted in their gaseous form, if possible, after coming into contact with the water streams, water jackets, water, and the like, defined as water, are sent to the Waste Water Treatment facility for removal. A breakdown of these materials is described below.

### Fullerenes

Fullerenes are recently discovered (1985) allotropes of carbon. They have been found to exist in the interstellar dust as well as in geological formations on earth. They are large cage like spherical molecules with formulae C32, C50, C60, C70, C76, C84 etc. The most commonly known fullerene is C60 which is named as ‘buckminster fullerene’ after the designer of the geodesic dome, American architect Buckminster.

### Structure of C—60 Molecule

C60 molecule has marvelously symmetrical structure. It is a fused-ring of aromatic system containing 20 hexagons and 12 pentagons of sp2 hybridized C atoms. The structure bends around and closes to form a soccer ball shaped molecule. C60 is therefore also called buckyball. The diameter of ball cage is about 70 pm. It is about 6-10 times as large as an H atom. The ball cages are highly stable and do not break up till 1375 K. It is a highly symmetrical structure in which all the carbon atoms occupy identical position.

### Diamond

Diamonds are chiefly found in the Union of South Africa, the Belgian Congo, Brazil, British Guiana, India etc. Further, diamonds occur in the form of transparent octahedral crystals usually having curved surfaces and do not shine much in their natural form. To give them their usual brilliant shine they are cut at a proper angle so as to give rise to large total internal reflections.

Moissan (1893) prepared the first artificial diamond by heating pure sugar charcoal and iron in a graphite crucible to a temperature of about 3000° C. in an electric arc furnace.

### Graphite

Graphite is found widely distributed in nature, viz., in Siberia, Sri Lanka, United States, Canada, etc. Moreover, large quantities of graphite are also manufactured from coke or anthracite in electric furnaces.

Diamonds and graphite are two crystalline allotropes of carbon. Diamond and graphite both are covalent crystals. But, they differ considerably in their properties.

Comparison of the properties of diamond and graphite—these differences in the properties of diamond and graphite are due to the differences in their structures.

### Biological—Algal, Plant, Bacterial, Biomat Slime and Microbial Refugiums

The present invention proposes utilizing a Refugium for biological filtration of water streams through the EFSMP. The EFSMP Refugium, in combination, tandem, or strategically placed throughout the overall Matrix, and without limitation, includes a single holding tank where water flows through the system, and biological filtration takes place. Such filtration can be anaerobic, aerobic, a combination of the same, whereas such live filtration is being performed by algal, plant, (rotifiers, clams, bi-valves, shrimp, fish(s), mollusks, snails, crustaceans, limpits, barnacles, exoskeltal organisms, and interskelatal organisms) bacterial, slime, and microbial processes, and without limitation thereto. Further, the living filtration can be in combination, or in tandem, and either in conjunction with, tandem, or combination. The wastewater holding tanks, having an interior adapted to hold wastewater, saltwater, ocean water, pond water, and water (as previously defined in the present invention) and if/as the user desires, a generator positioned to provide ozone, oxygen, UV (as described below) or any combination of these within, next to, adjacent, in-line before or after water passes through the tank, as well as being a part of the interior of the holding tank. In one embodiment, the holding tank comprises a gray-water tank, a black-water tank, a non-potable water tank, a potable water tank, wet sludge silo, wet sludge tanks, and the system further comprises a non-potable water tank having an interior. In this embodiment, the system further includes a second generator positioned to provide ozone, oxygen, or a combination of the two to the interior of the non-potable water tank and a conduit coupling the gray-water tank to the non-potable water tank. The system can further include a black-water tank having an interior, a third generator positioned to provide ozone, oxygen, or a combination of the two to the interior of the black-water tank, and a conduit coupling the black-water tank to the non-potable water tank. The system can also include a potable water tank, a point of water usage coupled to the potable water tank, and a fourth generator positioned to provide ozone, oxygen, or a combination of the two to the potable water tank. Tanks and their terms used for Refugium, of the present invention include, without limitation, are defined as, and are included, but are not limited to Biological Fuel Cells, irrigation tanks, sludge tanks, buffer tanks, grey-water tanks, black-water tanks, sludge silo's, wet sludge tanks, multimedia filters, clarifier tanks, and holding tank as shown in the flow chart placement of this embodiment, and the like.

As organic life is used as a portion of the proposed embodiment of this EFSMP's water purification system, it is also envisioned that such apparatus creates an integrated, small-scale marine or fresh water ecosystem that is particularly useful in filtering water to levels typically found at a home, school, office, or laboratory aquariums. In operation, and as a proposed, but without limitation, example of water flow, the water from the tank is routed to an algal turf scrubber screen or equivalent algal-growing surface placed in a movable, tray-shaped receptacle. An algal turf, comprising preferably a dense colony of microalgae, resides on the screen or other substrate. As the receptacle fills with water, the center of gravity of the receptacle moves across the axis of the pivots upon which the receptacle is mounted. At this time, the substantially filled receptacle rotates on its pivots and the desired surge effect across the scrubber by the exiting water is achieved. The surge, light energy provided by lights above the receptacle, and algal photosynthesis promote metabolic cellular-ambient water exchange to remove carbon dioxide, dissolved nutrients and organic compounds, and other pollutants. Oxygen is also released into the water. The substantially emptied receptacle returns to its horizontal position and the purified and oxygenated water is then returned to the tank. A linear or rotary vibrating motor may also periodically cause water to surge across the screen. In addition, other appropriate components of the ecosystems may be included, such as tide creators, high intensity, broad spectrum artificial lights over the tank, salinity controllers, pH controllers, sediment removers, temperature controllers, automatic feeders, timers, and the like.

All fluids exiting this section are sent through a UV Sterilization (electromagnetic radiation such as ultraviolet light) so as to prevent living organics, or viruses, fungi, slime, mold, bacteria, microbes, etc., from passing through, and fouling the following systems and remaining water purification apparatus, or into water which could be used for consumption. Ultraviolet disinfection utilizes Ultraviolet light and is also very effective at inactivating cysts, as long as the water has a low level of color so the UV can pass through without being absorbed. The main disadvantage to the use of UV radiation is that, like ozone (see below section) treatment, it leaves no residual disinfectant in the water. Because neither ozone nor UV radiation leaves a residual disinfectant in the water, it is sometimes necessary to add a residual disinfectant after they are used. This is often done through the addition of chloramines, discussed above as a primary disinfectant. When used in this manner, chloramines provide an effective residual disinfectant with very few of the negative aspects of chlorination. However, this is not a limitation if the user chooses other existing technologies, that are commonly available to someone of ordinary skill in the art, or if a user decides on producing ultrapure water. If required, by the user, or municipality, or other vendor, that the ultrapure water be treated with additional chemicals, dissenfectants, nutrients, materials, products, metals, etc., in such a manner, then same can be done as the water exits the EFSMP. Other methods of electrical impulses or radiation, EMF, or post treatment consists of stabilizing the water and preparing it for distribution. Desalination processes are very effective barriers to pathogenic organisms; and hybrid fuel cells, which can also serve as desalinators, or other ionic filtration fuel cells can be utilized in the present invention, without limitation, so that disinfection procedures and apparatus are used to ensure a “safe” water supply. Disinfection, when required by the user, (sometimes called germicidal or bactericidal) is employed to sterilize any bacteria, protozoa and viruses that have bypassed the desalination and other osmotic separation processes into the product water. Disinfection in any of the following user required forms, without limitation, may be by means of such methods either in tandem, in-line, in combination, stand alone, multichambered, and the like, such as ultraviolet radiation, using UV lamps directly on the product, or ozone, or by chlorination or chloramination (chlorine and ammonia). In many countries, either chlorination or chloramination is used to provide a “residual” disinfection agent in the water supply system to protect against infection of the water supply by contamination entering the system, and the like can be utilized, and any and all such steps are defined as UV Sterilization, as they all accomplish similar results.

Before the water exits the refugia, it is processed so as to remove organics, and dead biological, by means of, but without limitation to, either in stand alone, or any combination, of a Venturi Pump with Protein Skimmer, Activated Carbon, Sand Filtration, Clay, and the like.

Following this step, a Metal Recover Ion Exchange (MRIX) system to remove target metals from the waste water. Instead of the MRIX system, a microfiltration unit or a clarifier with very good final filtration could be used. After the MRIX the water can be filtered further, as user defined requirements are built, looped back into the system for further processing, is carbon treated to remove any residual oxidizers or organics, and moved towards the next phase of filtration.

Materials from within the muds, protein skimmer collectors, skimmer collectors, etc., and other media, used in the Refugium/refugia can be sent to the sludge press, for manufacture into filter cakes, and sent back within the EFSMP, for use as fuel, after material separation. Please see the previous description of automatic Filter-Cake making Filter Cake making, as described in the embodiment in the present invention, is also employed or used, as user requirements, in Cell 28.

The second MRIX system, if so desired by the user, is a complete front end reverse osmosis system with reverse osmosis feed water storage and pH adjust and full city type water pretreatment. The MRIX effluent water is injected into the reverse osmosis feed tank where pH is adjusted. This water can be diverted to drain by the PLC during regenerations when the TDS is very high.

The percentage recycled depends on how much of the reverse osmosis systems output is sent to rinses and returned to the MRIX system. If the EFSMP's water bypasses the MRIX, the percent of recycled water will be low. If all goes to the MRIX, the ratio can be 80-90 percent for removal of volatiles, and organics. Further removal of the remaining materials takes place in the following steps and sections.

### Clinoptilolite Clay

The two main physical properties of Clinoptilolite make it both an effective sorbent and ion exchanger for many organic and inorganic substances. The following cations can be effectively removed by Clinoptilolite from water:

### K+; Cs+; NH4+, Na+; Cd+; Pb; Zn; Ba; Sr Cu; Ca; Hg+; Mg; Fe, Co+

and others. It can be seen from the above list that natural zeolite may be used for ammonia (NH4+) and heavy metals removal from water tanks and water streams.

Apart from ammonia control, Clinoptilolite is known to adsorb other toxic gases, including Hydrogen Sulfide (H2S) and Methane and even increase the dissolved oxygen (DO) content of the water.

Another important benefit of Clinoptilolite that it produces an evident bacterio-static effect restricting the growth of harmful bacteria and blue-green weeds in other applications, and will do the same within the EFSMP. This property is most effective when granular Clinoptilolite is used to cover the tank and refugia bottom during preparation. This is especially important in view of the recent moves by the EU and other governments.

Powder Clinoptilolite also has a certain flocculating affect, speeding up sedimentation of suspended solids, which can also be sent to sludges for dewatering and turned into filter cakes, thus reducing turbidity of the water. Absorbing and neutralizing products of organic decomposition at the tank bottom Clinoptilolite also creates favorable conditions for a stable PH level of the water, reducing the reliance on special PH adjustment compounds such as dolomite lime or others. It is also important to note that natural Clinoptilolite contains practically untraceable amounts of toxic elements (Pb-0.001-0.002%; As-0.001-0.003%) and is therefore is nearly safe for humans, but such material will eventually be removed from the flow, sent back to its relevant cell for processing, and thus assuring lead free water, with completely recycled metals, being placed back into existing markets for monetization.

All in all, the above-mentioned characteristics and benefits of Clinoptilolite make it a very useful natural and environment-friendly water quality control agent for aquaculture, refugiums, and the like, especially in view of today's growing tendency to restrict the use of chemicals and other potentially hazardous man-made substances.

Clinoptilolite zeolite clay is a new method to reduce N volatilization. Zeolite clay is a naturally occurring hydrated aluminosilicate mined from volcanic ash deposits associated with alkaline lakes. As the alumina plant, produces significant amount of ash, it is proposed in the embodiment that someone of ordinary skill in the art, can manipulate such ash to provide such quantity and quality of synthetic clay for intra-plant filtration media, similar to that of quality of the clay in naturally occurring environments, with the clay having a high cation exchange capability and permeability rate which may make it effective in adsorbing ammonia, and barium.

Efficient anion adsorbents can be prepared by appropriate modification of clinoptilolite tuff. Simultaneously, such anion adsorbents may also adsorb certain nonpolar organic compounds. The availability of zeolite tuffs, their low cost and simple preparation make this material suitable for the production of large quantities of adsorbents for a wide range of applications in packed-bed water treatment processes and as permeable barriers.

Numerous applications of natural zeolites arise from their properties of molecular sieves and cation exchanges. The EFSMP includes anion adsorption, whereas natural zeolites do not show any affinity for anions without previous modification.

Another more common way of natural zeolite modification, proposed in the present invention the overall EFSMP's alumina plant, and utilized within this Cell, is the transformation into the H+ form. Treatments modify the acidity and chemical composition of zeolite as well as its texture and structure, of which someone or ordinary skill in the art, like Tsitsishvili, 1988, is able to do.

The zeolite modification being used in Cell 14, and created on-site, is formation of strong acid sites on the zeolite surface which increase the amine adsorption in processes of preparing organozeolites. The strong organo-zeolite complex obtained by amine adsorption on Hq zeolite has a high adsorption of anions from aqueous solutions.

Anion adsorption ability may be divided in two groups, but without limitation: .strong anion adsorbents based on the Hq-forms of the oleylamine derivatives (OHZ-1, OHZ-2r2 and OHZ-3., and b. weak anion adsorbents based on the Ca- and Na-forms of the oleylamine derivatives OZ, NaZ and OMCZ).

As there are more than 40 natural zeolite species, linoptilolite, [(Na,K)6_{—}2xCax] (Al6Si3oO72)′24H20, and clinoptilolite seems to be the most abundant zeolite in soils and sediments, and could be used for purposes with the EFSMP. The EFSMP are able to utilize them all, as well as the synthetic formulae created in house, for Water Filtration. Clinoptilolitein natural environments have several cations on the exchange sites, however, the dominant cations are Na+, K+, and Ca 2+. Clinoptilolite exhibits cation selectivity; e.g., Ca 2+ is easily replaced by Na*.

A more advanced application of granular Clinoptilolite for closed type tanks is to continuously pump the water of the tank through a Clinoptilolite filter, thus trapping not only ammonia, but other pollutants including suspended solids. After the Clinoptilolite is saturated, it can be further used as an effective slow-release fertilizer for fruits and vegetables (applicable only in fresh water farming) the marketplace has seen a rise in specialty products, such as Clinoptilolite Zeolite, which offers many benefits including: a) improving the cation exchange capacity of sand soil profiles; b) Attracts and retains nutrients for use by turf grasses; c) Holds and slowly releases water and nutrients as the turf demands; d) Improving the value gained from fertilizers applied and saves money on fertilizer; e) Improving water retention; f) Does not break down in the soil providing permanent benefit; g) Reduces nutrient loss through leaching; and h) Promotes responsible management practices by reducing the levels of pollution leaching into surrounding areas as a result of fertilization.

When used accurately, Clinoptilolite Zeolite can produce impressive results, including rapid germination timelines and growth rates, healthier and more stable turf, while at the same time reducing the requirements of expensive fertilizer and water applications. Ensuring that the key ingredients are available at the root of the problem, guarantees that the turf is looking and performing at its best everyday of the year.

Furthermore, it is disclosed that the aforementioned zeolites and clinoptilolite's, and clays, are able to be processed in the following Ion Exchange segment of the embodiment for waste water treatment, and or sent back to the pre-pyrolysis and pyrolyic cells for further processing, or where and if required by the user, an EFSMP, similar to that in U.S. Pat. No. 7,695,703, describing a zeolite material is steam-treated at a temperature and duration sufficient to partially de-aluminize the zeolite to approximately a steady state, but not sufficient to fully collapse its chemical structure. Iron, from the overall described EFSMP is added to the zeolite material. The zeolite material is calcined at a temperature, humidity, and duration sufficient to stabilize the zeolite material. However the preceding application has limitations as it requires broad temperatures 500-1100 degrees Celsius, up to several hours to process, whereas the present EFSMP utilizes electronic deionization methods for the automatic cleaning and processing of the zeolites, as described herein through methods similar to that of U.S. Pat. No. 7,828,883, in which a Carbon ion pump for removal of carbon dioxide from combustion gas and other gas mixtures is disclosed.

### Ion Exchange

Removal of ions and other dissolved substances via Ultrafiltration membranes use polymer membranes with chemically formed microscopic pores that can be used to filter out dissolved substances avoiding the use of coagulants. The type of membrane media determines how much pressure is needed to drive the water through and what sizes of micro-organisms, volatiles, chemicals, metals, equipment fouling materials, and the like can be filtered out.

In coordination chemistry, and part of the membranes used in this EFSMP for Reverse Osmosis and Fuel Cells, but without limitation, to create hybrid fuel cells that generate electricity, ligands are included as an ion or molecule (see also: functional group) that binds to a central metal atom to form a coordination complex. The bonding between metal and ligand involves, without limitation, formal donation of one or more of the ligand's electron pairs. The nature of metal-ligand bonding can range from covalent to ionic. Furthermore, the metal-ligand bond order can range from one to three. Ligands are viewed as Lewis bases, although rare cases are known involving Lewis acidic “ligands.”

Metal and metalloids are bound to ligands in virtually all circumstances, although gaseous “naked” metal ions can be generated in high vacuum. Ligands in a complex dictate the reactivity of the central atom, including ligand substitution rates, the reactivity of the ligands themselves, and redox. Ligand selection is a critical consideration in many practical areas, including bioinorganic and medicinal chemistry, homogeneous catalysis, and environmental chemistry.

Ligands are classified in many ways: their charge, size (bulk), the identity of the coordinating atom(s), and the number of electrons donated to the metal (denticity or hapticity). The size of a ligand is indicated by its cone angle.

In general, ligands are viewed as donating electrons and electrostatic molecules to the central atom. Bonding is often described using the formalisms of molecular orbital theory. In general, electron pairs occupy the HOMO (Highest Occupied Molecular Orbital) of the ligands.

Ligands and metal ions can be ordered in many ways; one ranking system focuses on ligand ‘hardness’ (see also hard/soft acid/base theory). Metal ions preferentially bind certain ligands. In general, ‘hard’ metal ions prefer weak field ligands, whereas ‘soft’ metal ions prefer strong field ligands. According to the molecular orbital theory, the HOMO of the ligand should have an energy that overlaps with the LUMO (Lowest Unoccupied Molecular Orbital) of the metal preferential. Metal ions bound to strong-field ligands follow the Aufbau principle, whereas complexes bound to weak-field ligands follow Hund's rule.

Binding of the metal with the ligands results in a set of molecular orbitals, where the metal can be identified with a new HOMO and LUMO (the orbitals defining the properties and reactivity of the resulting complex) and a certain ordering of the 5 d-orbitals (which may be filled, or partially filled with electrons). In an octahedral environment, the 5 otherwise degenerate d-orbitals split in sets of 2 and 3 orbitals (for a more in depth explanation, see crystal field theory): 3 orbitals of low energy: dxy, dxz and dyz; and 2 of high energy: dz2 and dx2−y2.

The energy difference between these 2 sets of d-orbitals is called the splitting parameter, Δo. The magnitude of Δo is determined by the field-strength of the ligand: strong field ligands, by definition, increase Δo more than weak field ligands. Ligands can now be sorted according to the magnitude of Δo. This ordering of ligands is almost invariable for all metal ions and is called spectrochemical series, and without limitation is incorporated in the present invention, and such laden ligand based membranes are removed, and sent for metallurgical processing, to their respective contained metals, and remaining materials are internally recycled.

For complexes with a tetrahedral surrounding, the d-orbitals again split into two sets, but this time in reverse order: 2 orbitals of low energy: dz2 and dx2−y2; and 3 orbitals of high energy: dxy, dxz and dyz.

The energy difference between these 2 sets of d-orbitals is now called Δt. The magnitude of Δt is smaller than for Δo, because in a tetrahedral complex only 4 ligands influence the d-orbitals, whereas in an octahedral complex the d-orbitals are influenced by 6 ligands. When the coordination number is neither octahedral nor tetrahedral, the splitting becomes correspondingly more complex.

The arrangement of the d-orbitals on the central atom (as determined by the ‘strength’ of the ligand), has a strong effect on virtually all the properties of the resulting complexes. For example, the energy differences in the d-orbitals has a strong effect in the optical absorption spectra of metal complexes. It turns out that valence electrons occupying orbitals with significant 3d-orbital character absorb in the 400-800 nm region of the spectrum (UV-visible range). The absorption of light (what is perceived as the color) by these electrons (that is, excitation of electrons from one orbital to another orbital under influence of light) can be correlated to the ground state of the metal complex, which reflects the bonding properties of the ligands. The relative change in (relative) energy of the d-orbitals as a function of the field-strength of the ligands is described in Tanabe-Sugano diagrams.

In cases where the ligand has low energy LUMO, such orbitals also participate in the bonding. The metal-ligand bond can be further stabilized by a formal donation of electron density back to the ligand in a process known as back-bonding. In this case, a filled, central-atom-based orbital donates density into the LUMO of the (coordinated) ligand. Carbon monoxide is the preeminent example a ligand that engages metals via back-donation. Complementarily, ligands with low-energy filled orbitals of pi-symmetry can serve as pi-donor.

Alpha-olefins, especially those containing 6 to 20 carbon atoms, are important items of commerce. Carbon is removed from this cell, and other cells of the EFSMP matrix, and is reused, or placed into existing markets, for monetization or credit, as they user may desire. The Alpha-olefin carbons are used as intermediates in the manufacture of detergents, as monomers (especially in linear low-density polyethylene), and as intermediates for many other types of products. Especially desired, and a product of this cell is the sending of the material for process of making a range of linear .alpha.-olefins such as 1-butene and 1-hexene.

Most commercially produced .alpha.-olefins are made by the oligomerization of ethylene, catalyzed by various types of compounds, see for instance B. Elvers, et al., Ed. Ullmann's Encyclopedia of Industrial Chemistry, Vol. A13, VCH Verlagsgesellschaft mbH, Weinheim, 1989, p. 243-247 and 275-276, and B. Cornils, et al., Ed., Applied Homogeneous Catalysis with Organometallic Compounds, A Comprehensive Handbook, Vol. 1, VCH Verlagsgesellschaft mbH, Weinheim, 1996, p. 245-258. The major types of commercially used catalysts are alkylaluminum compounds, certain nickel-phosphine complexes, and a titanium halide with a Lewis acid such as A1C1.sub.3. In all of these processes, significant amounts of branched internal olefins and diolefins are produced.

Invention catalyst systems, suitable for solution or slurry-phase oligomerization reactions to produce .alpha.-olefins, comprise a Group-8, -9, or -10 transition metal component (catalyst precursor) and an activator.

The ionic filtration systems of this EFSMP utilize, without limitation, an olefin polymerization or oligomerization catalyst system comprising the reaction product of: a) an activator selected from the group consisting of alumoxane, aluminum alkyl, alkyl aluminum halide, alkylaluminum alkoxide, boron compounds, hexafluoro phosphorus compounds, hexafluoro antimony compounds, and hexafluoro arsenic compounds; and b) a catalyst precursors having: Ni, Fe, Co, Pd, or Pt, N is are independently selected from the groups consisting of methyl, ethyl, propyl, butyl, pentyl, hexyl, heptyl, octyl, nonyl, decyl, undecyl dodecyl, cyclobutyl, cyclohexyl, phenyl, benzyl, phenethyl, tolyl, cyclopentyl, cycloheptyl, cyclooctyl, cyclononyl, cyclodecyl, and cyclododecyl; as well as being independently selected from the group consisting of methyl, ethyl, propyl, butyl, pentyl, hexyl, heptyl, octyl, nonyl, decyl, undecyl dodecyl, cyclobutyl, cyclohexyl, phenyl, benzyl, phenethyl, tolyl, cyclopentyl, cycloheptyl, cyclooctyl, cyclononyl, cyclodecyl, cyclododecyl and substituents, and may independently be joined to form a saturated or unsaturated cyclic structure; such as butenyl or has one of the following some hydrocarbyl radicals; or where the structure is also a non-hydrocarbon atom functional group; and a Group-14 element; and where materials may further have been selected from group consisting of chloride, bromide, iodide, methyl, ethyl, propyl, butyl, pentyl, hexyl, heptyl, octyl, nonyl, decyl, undecyl, dodecyl, methoxide, ethoxide, dimethylamide, diethylethoxide, and phenoxide, and the olefin polymerization or oligomerization catalyst system exhibits an activity that exceeds 8000 moles of ethylene per mole of M per hour.

Ion exchange systems use ion exchange resin- or zeolite-packed columns to replace unwanted ions. The most common case is water softening consisting of removal of Ca2+ and Mg2+ ions replacing them with benign (soap friendly) Na+ or K+ ions. Ion exchange resins are also used to remove toxic ions such as nitrate, nitrite, lead, mercury, arsenic and many others.

The Hybrid Fuel cells of this EFSMP, and of which are used without limitation employ Electrodeionization: This is where Water is passed between a positive electrode and a negative electrode. Ion exchange membranes allow only positive ions to migrate from the treated water toward the negative electrode and only negative ions toward the positive electrode. High purity deionized water is produced with a little worse degree of purification in comparison with ion exchange treatment. Complete removal of ions from water is regarded as electrodialysis. The water is often pre-treated with a reverse osmosis unit to remove non-ionic organic contaminants.

The ESFMP includes a method (similar to the one described in U.S. Pat. No. 7,862,700—incorporated herein by reference, along with all of its prior art and their related references) of treating water comprising: providing water to be treated into a storage vessel; passing a first water stream from the storage vessel through a depleting compartment of an electrodeionization device; applying an electric current through the electrodeionization device to produce a second water stream from the depleting compartment having a Langelier Saturation Index (LSI) of less than about 0; passing the second water stream through a cathode compartment of the electrodeionization device to produce a treated water stream; and introducing at least a portion of the treated water stream into the storage vessel. This method can be either in part, integrated into, separate, in tandem, or in conjunction with a hybrid fuel cell, as previously described.

Furthermore, electrically charged atoms or molecules are heretofore known as ions. The ion exchange treatment process uses special resins to remove charged, inorganic contaminants like arsenic, chromium, nitrate, calcium, radium, uranium, and excess fluoride from water.

The EFSMP also includes by reference, in its entirety United States Patent Publication, 20090236235 for a method of treating water comprising: introducing water into an electrochemical device to produce treated water and a concentrate stream from a concentrating compartment thereof; recirculating at least a portion of the concentrate stream in the concentrating compartment; and discharging a predetermined portion of the concentrate stream according to a predetermined discharge schedule.

When source water is passed through a series of resin beads, it exchanges its charged contaminants for the harmless charged ions stored on the resin surface. Ion exchange resins then store the attracted contaminants. Because of this accumulation process, resins must be periodically cleaned with a solution that recharges their supply of harmless, interchangeable ions.

The surface can be a flat permeable membrane, spherical membrane, spherical material of buckyball characteristics, powder resins, and the like.

U.S. Pat. No. 7,820,024 introduces electrical separation systems that allow recovery of species from feed streams, typically aqueous solutions. The disclosed techniques can also provide electrical separation systems having reduced tendency to form scale especially when water is being purified to reduce the concentration of hardness-causing species.

In addition, U.S. Pat. No. 5,457,266, incorporated herein in its entirety by reference, is a process for treating actinide type wastes, and the like. The invention relates to a process for treating waste which occurs in the form of contaminated, powdery ion exchange resin.

Such processes are used for reducing the volume of the quantity of waste. European Patent Number 0 126 060 B1, incorporated herein in its entirety by reference, discloses processes used for that purpose in which a mixture of ion exchange resins is heated in the presence of water and a substance giving an alkaline reaction, until the onset of decomposition of the anion exchange resins and the release of amines. In that case, temperatures of up to 280 degrees Celsius are required.

Ion exchange resins in that case retain a significant part of their water absorption capability in spite of the not inconsiderable expenditure of energy for the heating. With regard to swelling processes associated with the water absorption, the proportion of ion exchange resins incorporated in a matrix, for example of cement or bitumen, must not exceed 10% of the mass of the waste product. That has the consequence of providing only an unsatisfactory reduction in the volume of the quantity of waste.

Derwent Abstract AN 86-158976 of Published Japanese Application 61 091 600, incorporated herein in its entirety by reference, also already discloses a process for treating actinide type materials and wastes, and the like, in the form of contaminated, powdery ion exchange resin, according to which the resin is dewatered, then mixed with a calcium compound and finally dried. When the resins are dewatered, they are sent to the Automated Filter Cake system for further processing and sent to its respective processing counterpart for removal and extraction of materials to be utilized as material for sale into existing markets.

It is accordingly an object of the invention described in this embodiment to provide a process for treating actinide type waste and materials (here forth known as, and defined as actinide material, actinide waste, actinide species, and the like), which overcomes the disadvantages of the known methods of this general type and which treats ion exchange resins to be disposed of and put into final storage as waste, in such a way that their possible proportion of the weight and volume of a waste product is distinctly above 10%, with the aim of the treatment being to reduce water absorption and swelling capacities of the ion exchange resins.

With the foregoing and other objects in view there is provided, in accordance with the invention, a process for treating actinide proposed waste in the form of contaminated, powdery ion exchange resin, which comprises mechanically dewatering the ion exchange resin; mixing the dewatered ion exchange resin with a calcium compound to form a mixture; drying the mixture at temperatures of up to 120° Celsius and preferably around 50 to 60° Celsius, and at a pressure of from 120 to 200 hPa, until a residual moisture content of less than 10% of the mass of the mixture is reached; and subsequently thermally treating the dry mixture at a pressure below atmospheric pressure by heating up to a temperature of from at least 120° Celsius to at most, 190° Celsius.

In accordance with another mode of the proposed invention of this EFSMP, there is provided a process in which after it has cooled, the thermally treated mixture is introduced into a matrix, preferably being formed of cement or bitumen, with the mass of the mixture amounting to up to 50% of the mass of the matrix.

In accordance with a further mode of the invention, there is provided a process in which calcium hydroxide is used as the calcium compound and its amount accounts for 50% to 150% of the take-up capacity of the ion exchange resins.

In accordance with an added mode of the invention, there is provided a process in which drawn-off vapors are passed on after their condensation, to a waste water treatment, in the same way as water occurring during the dewatering.

In accordance with a concomitant mode of the invention, there is provided a process in which at least the mixing, drying and thermal treatment of the ion exchange resin and the calcium compound take place in a mixing device which remains in operation at least until completion of the thermal treatment.

The process according to the invention is very advantageous, since it effects an irreversible elimination of the water absorption capability of the ion exchange resins in a surprising way, so that swelling of the ion exchange resins during or after their introduction into a matrix is prevented with certainty.

The behavior of the ion exchange resins subjected to the process according to the invention is surprising in as much as the calcium compound loads only the cations and in fact reduces only their water absorption and swelling behavior.

The simultaneous reduction in the water absorption and swelling behavior of the part of the ionic exchange resins representing anions makes it possible to harmlessly introduce at least twice as many resins into a matrix as would be possible without the treatment according to the invention.

As a result, the overall quantity of waste suitable for final storage from the ion exchange resins is noticeably reduced.

Although this section of the embodiment is described in the present invention as embodied in a process for treating radioactive waste, NORMs and waste water treatment, it is nevertheless not intended to be limited to the details given, since various modifications may be made without departing from the spirit of the embodiments and within the scope and range of equivalents of the claims.

The method of operation of the embodiment in the present invention, however, together with additional objects and advantages thereof will be best understood from the following description of specific embodiments.

Referring now to the EFSMP is the process according to the description is explained in more detail below without reference to an illustrative embodiment.

Depleted radioactively charged ion exchange resin is ground into a dusty powder and introduced, preferably as a suspension, into a drying apparatus, for example a cone drier. This suspension is initially mechanically dewatered in the cone drier. A calcium compound, for example calcium hydroxide in aqueous solution, is admixed with the dewatered, but still moist powder of ion exchange resin in a mixer. However, this may not be required, and is done without limitation, and the resin may then be sent to a filter press. However, in the event that calcium is admixed, then the amount of admixed calcium compounds in this case is sufficient to account for 50 to 150% of the take-up capacity of the ion exchange resin.

After thorough mixing of the ion exchange resin with the calcium hydroxide, the mixture thus formed is heated while the mixer continues to run. In this case, water present in the mixture is evaporated at a temperature of about 50 to 60° Celsius and at a pressure of 120 hPa to 200 hPa, until the residual moisture in the mixture is less than 10% of the mixture.

Then, with the mixer still continuing to run, the temperature is increased to over 120 degrees Celsius, and preferably to 150 to 160° Celsius, but at most, to 190° Celsius, for the thermal treatment of the mixture. In this case, at least the cations of the ion exchange resin which have previously not been loaded enter into irreversible bonds with calcium hydroxide and lose their capacity for absorbing water.

The vapors produced during the drying and during thermal treatment are drawn off to obtain the subatmospheric pressure, are condensed and are passed on to a waste water treatment device, in the same way as the water occurring in the dewatering of the ion exchange resins.

Due to the heat treatment together with the preceding loading of the cation resins, the corresponding active groups are transformed in their water absorption capacity and swelling behavior to such an extent that virtually only the normal swelling behavior of plastic remains. As tests have shown, the water absorption capability and swelling capacity of the anion resin is also unexpectedly reduced at the same time by the thermal treatment.

However, the crucial step for the further reduction in swelling behavior and water absorption capacity is the virtually complete loading of the cation resins by the subsequent heat treatment. One heat treatment alone does not lead to the desired result with the cation resins in the temperature range.

By virtue of the absent water absorption capability and swelling capacity of the ion exchange resins following treatment, in comparison with untreated ion exchange resins, at least twice the amount can be incorporated in a matrix, with the mass of the treated mixture of the ion exchange resin and the calcium compound amounting to up to 50% of the mass of the matrix. Cement and bitumen are suitable in particular as the matrix. Since the ion exchange resin together with this matrix is suitable for final storage, use of the process according to the invention has the effect of reducing the quantity of the waste substance to be put into final storage to at least half. This is an advantage which is not to be underestimated for a managed and safeguarded final storage of radioactively contaminated ion exchange resins.

In order to leave the effectiveness of the process unimpaired, it is expedient to permit the mixer or a mixing device to operate continuously without interruption during the mixing, drying and thermal treatment. This ensures that the mixture of the ion exchange resin and calcium compound achieves the same state of treatment in each case in all of the stages of the process in all of its regions.

The process according to the proposed embodiment can be applied just as much to ion exchange resins as to toxic chemicals, provided that in each case they are in the form of mixtures of independently active mixture components including cations and anions.

Ion exchange resin comes in two forms: cation resins, which exchange cations like calcium, magnesium, and radium, and anion resins, used to remove anions like nitrate, arsenate, arsenite, or chromate. Both are usually regenerated with a salt solution (sodium chloride). In the case of cation resins, the sodium ion displaces the cation from the exchange site; and in the case of anion resins, the chloride ion displaces the anion from the exchange site. As a rule cation resins are more resistant to fouling than are anion resins. Resins can be designed to show a preference for specific ions, so that the process can be easily adapted to a wide range of different contaminants.

This treatment process works best with particle-free water, because particulates can accumulate on the resin and limit its effectiveness.

Ion exchange is a common water treatment system that can be scaled to fit any size treatment facility, and is part of this segment of this cell. It may also be adapted to treat water at the point-of-use and point-of-entry levels.

### Activated Alumina

Activated alumina treatment is used to attract and remove contaminants, like arsenic and fluoride, which have negatively charged ions.

Activated alumina (a form of aluminum oxide) is typically housed in canisters through which source water is passed for treatment. A series of such canisters can be linked together to match the water volume requirements of any particular system.

As alumina absorbs contaminants, it loses its capacity to treat water. Therefore, treated water quality must be carefully monitored to ensure that cartridges are replaced before they lose their treatment effectiveness. Also the capacity of the alumina is strongly influenced by the pH of the water. Lower pH is better. Many systems use acid pretreatment to address this need.

Source water quality is an important consideration for activated alumina systems. The treatment agent will attract not just contaminants, but many other negatively charged ions found in source water. This can limit the alumina's ability to attract and remove the targeted contaminants.

Activated alumina technology can be expensive, and many of its costs are associated with disposal of the contaminated water that is created when alumina is purged of contaminants and “reset” for future use. Large-scale activated alumina systems also require a high level of operational and maintenance expertise, and consequently are relatively rare.

Small-scale systems are more common and can be tailored to accommodate any specific water volume requirements.

Ion exchange is a reversible chemical reaction in which an ion (an atom or molecule that has lost or gained an electron and thus acquired an electrical charge) from solution is exchanged for a similarly charged ion attached to an immobile solid particle. These solid ion exchange particles are either naturally occurring inorganic zeolites or synthetically produced organic resins. The synthetic organic resins are the predominant type used today because their characteristics can be tailored to specific applications.

### Ion Exchange System

An ion exchange system consists of a tank containing small beads of synthetic resin. The beads are treated to selectively adsorb either cations (positive) or anions (negative) and exchange certain ions based on their relative activity compared to the resin. This process of ion exchange will continue until all available exchange sites are filled, at which point the resin is exhausted and must be regenerated by suitable chemicals.

Ion exchange systems, without limitation, can be used in several ways. One method is Water Softening, whereas the ion exchange water softener is one of the most common tools of water treatment. Its function is to remove scale-forming calcium and magnesium ions from hard water. In many cases soluble iron (ferrous) can also be removed with softeners. A standard water softener has four major components: a resin tank, resin, a brine tank and a valve or controller.

The softener resin tank contains the treated ion exchange resin—small beads of polystyrene. The resin beads initially adsorb sodium ions during regeneration. The resin has a greater affinity for multi-valent ions such as calcium and magnesium than it does for sodium. Thus, when the hard water containing the Calcium and Magnesium Ions is passed through the resin bed, the calcium and magnesium ions adhere to the resin, releasing the sodium ions until equilibrium is reached. The water softener has exchanged its sodium ions for the calcium and magnesium ions in the water.

Regeneration is achieved by passing a NaCl solution through the resin, exchanging the hardness ions for sodium ions. The resin's affinity for the hardness ions is overcome by using a highly concentrated solution of brine. The regeneration process can be repeated indefinitely without damaging the resin.

Water softening is a simple, well-documented ion exchange process. It solves a very common form of water contamination: hardness. Regeneration with sodium chloride is simple, inexpensive and can be automatic, with no strong chemicals required. In the case of the presently proposed EFSMP, ultrapure water is desired, but not limited as to the only type of water processed back into the system, and is thus not a limitation of the proposed embodiment.

The disadvantages of water softening become apparent when high-quality water is required. Softening merely exchanges the hardness ions in the water supply for normally less-troublesome sodium ions. Since the treated water contains sodium instead of calcium or magnesium, it is still unsuitable for many uses.

### Demineralization/Deionization

Deionization refers to a specialized form of Ion Exchange where Hydrogen (H+) and Hydroxide (OH−) is used to replace the positive and negative Ions. See Deionization below.

Ion exchange deionizers (DI) use synthetic resins similar to those used in water softeners. Typically used on water that has already been pre-filtered, DI uses a two-stage process to remove virtually all ionic material remaining in water. Two types of synthetic resins are used, one to remove positively charged ions (cations) and another to remove negatively charged ions (anions).

Cation deionization (DI) resins exchange hydrogen (H+) ions with cations, such as calcium, magnesium and sodium. Anion deionization resins exchange hydroxide (OH−) ions for anions such as chloride, sulfate and bicarbonate. The displaced H+ and OH− combine to form H2O.

Resins have limited capacities and must be regenerated upon exhaustion. This occurs when equilibrium between the adsorbed ions is reached. Cation resins are regenerated by treatment with acid, which replenishes the sites with H+ ions. Anion resins are regenerated with a strong base which replenishes (OH−) ions. Regeneration can take place off-site with regenerated “exchange tank” deionizers brought in by a service company, or regeneration can be accomplished on-site by installing regenerable deionizers and regeneration equipment and chemicals.

### Two-Bed and Mixed-Bed Deionizers

The two basic configurations of deionizers are two-bed and mixed-bed. Two-Bed deionizers have separate tanks of cation and anion resins. In Mixed-Bed deionizers, the anion and cation resins are blended into a single tank or vessel. Generally, mixed-bed systems will produce higher quality water with a lower total capacity than two-bed systems.

Deionization can produce extremely high-quality water in terms of dissolved ions or minerals, up to the maximum resistance of 18.3 megohms/cm. However, they do not generally remove organics and can become a breeding ground for bacteria, actually diminishing water quality where organic and microbial contamination are critical.

Failure to regenerate the resin at the proper time may result in harmful salts remaining in the water or even worse, being increased in concentration. Partially exhausted resin beds can increase levels of some dangerous contaminants due to the resin's selectivity for specific ions, and may add particulates and resin fines to the deionized water.

An organic ion exchange resin is composed of high-molecular-weight polyelectrolytes that can exchange their mobile ions for ions of similar charge from the surrounding medium. Each resin has a distinct number of mobile ion sites that set the maximum quantity of exchanges per unit of resin.

An ion-exchange resin or ion-exchange polymer is an insoluble matrix (or support structure) normally in the form of small (1-2 mm diameter) beads, usually white or yellowish, fabricated from an organic polymer substrate. The material has highly developed structure of pores on the surface of which are sites with easily trapped and released ions. The trapping of ions takes place only with simultaneous releasing of other ions; thus the process is called ion-exchange. There are multiple different types of ion-exchange resin which are fabricated to selectively prefer one or several different types of ions.

Incorporated by reference herein are the following references: IUPAC “strongly discourages” the use of the term ‘ion-exchange resin’ to refer to an ion-exchange polymer, but it remains very common: International Union of Pure and Applied Chemistry (2004), “Definitions of Terms Relating to Reactions of; and Polymers and to Functional Polymeric Materials (IUPAC Recommendations 2003)”, Pure Appl. Chem. 76 (4): 889-906, doi:10.1351/pac200476040889, http://media.iupac.org/publications/pac/2004/pdf/7604x0889.pdf.

Besides being made as bead-shaped materials, ion exchange resins, are produced as membranes. The membranes are made of highly cross-linked ion exchange resins that allow passage of ions, but not of water, are used for electrodialysis. Membranes and substrates or chalcogel, nanomaterials, lignides, ion exchange resins, etc., are proposed in the present invention.

There are four main types differing in their functional groups: a) strongly acidic (typically, sulfonic acid groups, e.g. sodium polystyrene sulfonate or polyAMPS); b) strongly basic, (quaternary amino groups, for example, trimethylammonium groups, e.g. polyAPTAC); c) weakly acidic (mostly, carboxylic acid groups); and d) weakly basic (primary, secondary, and/or ternary amino groups, e.g. polyethylene amine).

There are also specialized types such as chelating resins (iminodiacetic acid, thiourea, and many others).

### Water Purification

In this embodiment, ion-exchange resins, as described previously, and throughout this application, without limitation, are used to remove poisonous (e.g., copper) and heavy metal (e.g., lead or cadmium) ions from solution, replacing them with more innocuous ions, such as sodium and potassium.

Few ion-exchange resins remove chlorine or organic contaminants from water—this is usually done by using an activated charcoal filter mixed in with the resin. There are some ion-exchange resins that do remove organic ions, such as MIEX (magnetic ion-exchange) resins. Domestic water purification resin is not usually recharged—the resin is discarded when it can no longer be used.

### Production of High Purity Water

Water of highest purity is required for electronics, scientific experiments, production of superconductors, and nuclear industry, metallurgy, petroleum refining, and throughout this EFSMP, without limitation, among others. Such water is produced using ion-exchange processes or combinations of membrane and ion-exchange methods described in the present invention. Cations are replaced with hydrogen ions using cation-exchange resins; anions are replaced with hydroxyls using anion-exchange resins. The hydrogen ions and hydroxyls recombine producing water molecules. Thus, no ions remain in the produced water. The purification process is usually performed in several steps with “mixed bed ion-exchange columns” at the end of the technological chain.

### Ion-Exchange in Metal Separation

Ion-exchange processes are used to separate and purify metals, including separating uranium from plutonium and other actinides. In addition, there are two series of rare earth metals, the lanthanides and the actinides. Members of each family have very similar chemical and physical properties. However, ion-exchange is the only practical way to separate them in large quantities. This type of separation was developed in the 1940's by Frank Spedding.

A very important case is the PUREX process (plutonium-uranium extraction process someone of ordinary skill in the art is familiar with the PUREX system) which is used to separate the plutonium and the uranium from the spent fuel products (e.g., from a nuclear reactor and NORMs, etc.), and to be able to dispose of the waste products. Then, the plutonium and uranium are available for making nuclear-energy materials, such as new reactor fuel and nuclear weapons.

The ion-exchange process is also used to separate other sets of very similar chemical elements, such as zirconium and hathium, which incidentally is also very important for the nuclear industry. Zirconium is practically transparent to free neutrons, used in building reactors, but hafnium is a very strong absorber of neutrons, used in reactor control rods.

Ionic Resins for the Ultrapure Water Created Onsite, is Used for, Catalysis

In chemistry ion-exchange resins are known to catalyze organic reactions.

### Juice Purification

Ion-exchange resins are used in the manufacture of fruit juices such as orange juice where they are used to remove bitter tasting components and so improve the flavor. This allows poorer tasting fruit sources to be used for juice production.

### Sugar Manufacturing

Ion-exchange resins are used in the manufacturing of sugar from various sources. They are used to help convert one type of sugar into another type of sugar, and to decolorize and purify sugar syrups.

### Pharmaceuticals

Ion-exchange resins are used in the manufacturing of pharmaceuticals, not only for catalyzing certain reactions but also for isolating and purifying pharmaceutical active ingredients. Three ion-exchange resins, sodium polystyrene sulfonate, colestipol, and cholestyramine, are used as active ingredients. Sodium polystyrene sulfonate is a strongly acidic ion exchange resin and is used to treat hyperkalemia. Colestipol is a weakly basic ion-exchange resin and is used to treat hypercholesterolemia. Cholestyramine is a strongly basic ion-exchange resin and is also used to treat hypercholesterolemia.

### Colestipol and Cholestyramine are Known as Bile Acid Sequestrants

Ion-exchange resins are also used as excipients in pharmaceutical formulations such as tablets, capsules, and suspensions. In these uses the ion-exchange resin can have several different functions, including taste-masking, extended release, tablet disintegration, and improving the chemical stability of the active ingredients.

Ion exchange reactions are stoichiometric and reversible, and in that way they are similar to other solution phase reactions.

For example: NiSO₄+Ca(OH)₂═Ni(OH)₂+CaSO₄.

In this reaction, the nickel ions of the nickel sulfate (NiSO₄) are exchanged for the calcium ions of the calcium hydroxide Ca(OH)₂ molecule. Similarly, a resin with hydrogen ions available for exchange will exchange those ions for nickel ions from solution. The reaction can be written as follows: 2(R—SO₃H)+NiSO₄=(R—SO₃)2Ni+H₂SO₄ (2).

R indicates the organic portion of the resin and SO3 is the immobile portion of the ion active group. Two resin sites are needed for nickel ions with a plus 2 valence (Ni+2). Trivalent ferric ions would require three resin sites.

As shown, the ion exchange reaction is reversible. The degree the reaction proceeds to the right will depend on the resins preference or selectivity, for nickel ions compared with its preference for hydrogen ions. The selectivity of a resin for a given ion is measured by the selectivity coefficient K which in its simplest form for the reaction R−A++B+=R−−B++A+(3) is expressed as: K=(concentration of B+ in resin/concentration of A+ in resin)×(concentration of A+ in solution/concentration of B+ in solution).

### Heavy-Metal-Selective Chelating Resins

Chelating resins behave similarly to weak acid cation resins but exhibit a high degree of electivity for heavy metal cations. Chelating resins are analogous to chelating compounds found in metal finishing wastewater; that is, they tend to form stable complexes with the heavy metals. In fact the functional group used in these resins is an EDTAa compound. The resin structure in the sodium form is expressed as R-EDTA-Na.

The high degree of selectivity for heavy metals permits separation of these ionic compounds from solutions containing high background levels of calcium, magnesium, and sodium ions. A chelating resin exhibits greater selectivity for heavy metals in its sodium form than in its hydrogen form. Regeneration properties are similar to those of a weak acid resin; the chelating resin can be converted to the hydrogen form with slightly greater than stoichiometric doses of acid because of the fortunate tendency of the heavy metal complex to become less stable under low pH conditions. Potential applications of the chelating resin include polishing to lower the heavy metal concentration in the effluent from a hydroxide treatment process or directly removing toxic heavy metal cations from wastewaters containing a high concentration of nontoxic, multivalent cations.

Ion exchange processing can be accomplished by either a batch method or a column method, or any combination thereof, without limitation. In the first, or one, method, the resin and solution are mixed in a batch tank, the exchange is allowed to come to equilibrium, then the resin is separated from solution. The degree to which the exchange takes place is limited by the preference the resin exhibits for the ion in solution. Consequently, the use of the resins exchange capacity will be limited unless the selectivity for the ion in solution is far greater than for the exchangeable ion attached to the resin. Because batch regeneration of the resin is chemically inefficient, batch processing by ion exchange has limited potential for application.

Passing a solution through a column containing a bed of exchange resin is analogous to treating the solution in an infinite series of batch tanks Consider a series of tanks each containing 1 equivalent (eq) of resin in the X ion form. A volume of solution containing 1 eq of Y ions is charged into the first tank. Assuming the resin to have an equal preference for ions X and Y when equilibrium is reached the solution phase will contain 0.5 eq of X and Y. Similarly, the resin phase will contain 0.5 eq of X and Y. This separation is the equivalent of that achieved in a batch process.

### Ion Exchange Process Equipment and Operation

Most industrial applications of ion exchange use fixed-bed column systems, and is the basic component of which is the resin column. In this embodiment, the column design includes: Contain and support the ion exchange resin; Uniformly distribute the service and regeneration flow through the resin bed; Provide space to fluidize the resin during backwash; Include the piping, valves, and instruments needed to regulate flow of feed, regenerant and backwash solutions.

Regeneration Procedure—after the feed solution is processed to the extent that the resin becomes exhausted and cannot accomplish any further ion exchange, the resin must be regenerated. In normal column operation, for a cation system being converted first to the hydrogen then to the sodium form, regeneration employs the following basic steps: the column is backwashed to remove suspended solids collected by the bed during the service cycle and to eliminate channels that may have formed during this cycle; then the back-wash flow fluidizes the bed. releases trapped particles and reorients the resin particles according to size.

### Batch Tanks

Concentration Profile in a Series of ion Exchange Batch Tanks—during backwash the larger, denser panicles will accumulate at the base and the particle size will decrease moving up the column. This distribution yields a good hydraulic flow pattern and resistance to fouling by suspended solids.

The regeneration also includes: the resin bed is brought in contact with the regenerant solution. In the case of the cation resin acid elutes the collected ions, and converts the bed to the hydrogen form. A slow water rinse then removes any residual acid.

Moreover, the regeneration includes: the bed is brought in contact with a sodium hydroxide solution to convert the resin to the sodium form. Again, a slow water rinse is used to remove residual caustic. The slow rinse pushes the last of the regenerant through the column. Further, the resin bed is subjected to a fast rinse that removes the last traces of the regenerant solution and ensures good flow characteristics.

### Cocurrent and Countercurrent Regeneration

Columns are designed to use either cocurrent or countercurrent regeneration. In cocurrent units, both feed and regenerant solutions make contact with the resin in a down flow mode. These units are the less expensive of the two in terms of initial equipment cost. On the other hand, cocurrent flow uses regenerant chemicals less efficiently than countercurrent flow: it has higher leakage concentrations (the concentration of the feed solution ion being removed in the column effluent), and cannot achieve as high a product concentration in the regenerant.

Furthermore, methods, systems, and devices for electrically purifying liquids containing species such as minerals, salts, ions, organics, and the like are described in the present invention. One aspect of the invention provides methods of regenerating media within an electrical purification device, for example, exposing the media to one or more eluting solutions, and/or selectively desorbing ions, organics, and/or other species from the media by exposing the media to certain eluting conditions. In yet another aspect, methods of selectively removing one or more ions, organics, and/or other species from a liquid to be purified are provided, e.g., by selective removal of one or more ions, or organics, and the like from solution that can easily precipitate, and/or cause scaling or fouling to occur. In still another aspect, the invention provides a method of treating a solution containing ions, organics, and/or other species using an electrical purification apparatus in a continuous or semi-continuous fashion, while also performing regeneration of media contained within the apparatus. While U.S. Pat. No. 7,658,828 (included in its entirety by reference herein) does disclose certain methods, it is limiting, and such limitations are not contemplated in the present invention.

Additionally, the embodiment includes Continuous Electrodeionization (CEDI) is a chemical-free process that uses ion exchange resins and electricity to produce ultra-pure deionized water. CEDI utilizes no chemical regenerants and creates no hazardous wastes. The ion exchange resins are used primarily as a bridge to allow electric current to pass through the electrodeionization cell—this allows the modules to operate without any brine injection or concentrate recycle. Also, the ion exchange resins are used to “polish” the purified water stream by removing minute quantities of silica, carbon dioxide and other contaminants. Additionally, the resins are continually regenerated by the dissociated hydrogen and hydroxyl ions that have been created by the electric current.

### Reverse Osmosis aka R/O

Reverse osmosis (RO) is a filtration method that removes many types of large molecules and ions from solutions by applying pressure to the solution when it is on one side of a selective membrane. The result is that the solute is retained on the pressurized side of the membrane and the pure solvent is allowed to pass to the other side. To be “selective,” this membrane should not allow large molecules or ions through the pores (holes), but should allow smaller components of the solution (such as the solvent) to pass freely.

In this embodiment, where Reverse Osmosis (RO) and Fuel Cells (FC) are mentioned, the invention also relates to thermal processes such as multi-stage flash (MSF). Also, as previously stated, Reverse Osmosis, Ionic manipulation systems, and Fuel Cells, along with their specialized membrane properties, can also be categorized as Hybrid Fuel Cells, as they, without implied limitation, perform the same tasks, yet also create electricity, which is sent back into the EFSMP for use. MSF works with the integration of exhaust gases from the EFSMP, also known, in part as a hybrid power plant (fuel cell/turbine system) which contains and produces a considerable amount of thermal energy, which may be utilized for RO and FC units. This exhaust heat can be suitably used for preheating the feed in the processes such as reverse osmosis which not only increases the potable water production, but also decreases the relative energy consumption by approximately 8% when there is an increase of just an 8° Celsius rise in temperature. Additionally, an attractive hybrid system application which combines power generation at 70%+ system efficiency with efficient waste heat utilization is thermal processing. System efficiencies can be raised appreciably when a high-temperature fuel cell co-generates DC power in-situ with waste heat suitable for MSF. Such a hybrid system could show a 5.6% increase in global efficiency. Such combined hybrid systems have overall system efficiencies (second-law base) exceeding those of either fuel-cell power plants or traditional RO plants.

Furthermore, the Fuel Cell membrane electrode assemblies of the fuel cells are recycled to recover the precious metals from their assemblies. The assemblies are cryogenically embrittled and pulverized to form a powder. The pulverized assemblies are then mixed with a surfactant to form a paste which is contacted with an sulfuric acid solution, common to the EFSMP, or some other acid if the user desires, to leach precious metals from the pulverized membranes.

Pretreatment configurations may be necessary, without limitation, prior to effluent, water, and steams of material, depending upon placement, temperature, scaling materials, and that like, so that water flow will easily work on the front of an reverse osmosis water system, should only a RO be required, and without limitation, to the placement of any FC Tank House. Part of the selection is based on the capabilities and experience of the maintenance staff. The better preventative maintenance, the easier it will be to maintain any chemical addition system. Chemical addition will require metering systems, and without limitation, require more daily maintenance and calibration to insure consistent operation. Fixed bed systems such as softeners and carbon beds require little daily maintenance.

Water must have a very low silt (solids) content to keep the membranes from plugging up. This can be accomplished by removing (as described above, and within the proposed drawing of Cell 14) the solids or keeping them in suspension while passing through the system. Chemicals can be added to the incoming water to keep the solids in suspension or efficient filtration can be used. In this embodiment, all solids are removed before the RO/FC system, which results in the lowest rate of membrane plugging.

As the water passes through the reverse osmosis system, the ionic content of the reject stream increases as water permeates the membranes. This increase in TDS can result in calcium and magnesium (the hardness ions) precipitating out in the system and plugging the membranes.

Industrial reverse osmosis, FC's, Ionic Exchanges, all known in this section and defined as RO, and the like, can use spiral wound membranes mounted in high pressure containers. The membrane stack can be two, very long semi permeable membranes with a spacer mesh between them that is sealed along the sides. This is then wound up in a spiral tube with another spacer to separate the outside of the stack. The spiral winding provides a very high surface area for transfer. Between each membrane layer is a mesh separator that allows the permeate (pure) water to flow. Water is force in one end of the spiral cylinder and out the out other end. Backpressure forces the water through the membrane where it is collected in the space between the membranes. Permeate then flows around the spiral where it is collected in the center of the tube.

In the normal osmosis process the solvent naturally moves from an area of low solute concentration, through a membrane, to an area of high solute concentration. The movement of a pure solvent to equalize solute concentrations on each side of a membrane generates a pressure and this is the “osmotic pressure.” Applying an external pressure to reverse the natural flow of pure solvent, thus, is reverse osmosis. The process is similar to membrane filtration. However, there are key differences between reverse osmosis and filtration. The predominant removal mechanism in membrane filtration is straining, or size exclusion, so the process can theoretically achieve perfect exclusion of particles regardless of operational parameters such as influent pressure and concentration. Reverse osmosis, however, involves a diffusive mechanism so that separation efficiency is dependent on solute concentration, pressure, and water flux rate.

Membrane pore sizes can vary from 0.1 nanometres (3.9×10-9 in) to 5,000 nanometres (0.00020 in) depending on filter type. “Particle filtration” removes particles of 1 micrometre (3.9×10-5 in) or larger. Microfiltration removes particles of 50 nm or larger. “Ultrafiltration” removes particles of roughly 3 nm or larger. “Nanofiltration” removes particles of 1 nm or larger. Reverse osmosis is in the final category of membrane filtration, “hyperfiltration”, and removes particles larger than 0.1 nm.

In the United States military, Reverse Osmosis Water Purification Units are used on the battlefield and in training Capacities range from 1,500 to 150,000 imperial gallons (6,800 to 680,000 l) per day, depending on the need; both are able to purify salt water and water contaminated with chemical, biological, radiological and nuclear agents from the water.

### Water and Wastewater Purification

In industry, reverse osmosis removes minerals from boiler water at power plants. The water is boiled and condensed repeatedly. It must be as pure as possible so that it does not leave deposits on the machinery or cause corrosion. The deposits inside or outside the boiler tubes may result in under-performance of the boiler, bringing down its efficiency and resulting in poor steam production, hence poor power production at turbine.

It is also used to clean effluent and brackish groundwater. The effluent in larger volumes (more than 500 cubic meters per day) should be treated in an effluent treatment plant first, and then the clear effluent is subjected to reverse osmosis system. Treatment cost is reduced significantly and membrane life of the RO system is increased. The process of reverse osmosis can be used for the production of deionized water.

In 2002, Singapore announced that a process named NEWater would be a significant part of its future water plans. It involves using reverse osmosis to treat domestic wastewater before discharging the NEWater back into the reservoirs.

### Hydrogen Production

For small scale production of hydrogen, reverse osmosis is sometimes used to prevent formation of minerals on the surface of electrodes.

### Reef Aquariums and Both Aquaculture and Mariculture

Many in the reef aquarium and fish farm aquaculture and mariculture industries use reverse osmosis systems for their artificial mixture of seawater. Ordinary tap water can often contain excessive chlorine, chloramines, copper, nitrogen, phosphates, silicates, or many other chemicals detrimental to the sensitive organisms in a reef environment. Contaminants such as nitrogen compounds and phosphates can lead to excessive, and unwanted, algae growth. An effective combination of both reverse osmosis and deionization (RO/DI) is the most popular among reef aquarium keepers, and is preferred above other water purification processes due to the low cost of ownership and minimal operating costs. Where chlorine and chloramines are found in the water, carbon filtration is needed before the membrane, as the common residential membrane used by reef keepers does not cope with these compounds. Larger reef systems are in place at National Aquariums (Baltimore Aquarium, San Diego Aquarium, etc.), and the embodiment of this EFSMP incorporates the same technology by reference in the present invention, without limitation.

The typical single-pass SWRO system consists of the following components: a) Intake; b) Pretreatment; c) High pressure pump; d) Membrane assembly; e) Remineralisation and pH adjustment; f) Disinfection; g) Alarm/control panel; and h) Pretreatment.

Pretreatment is important when working with RO and nanofiltration (NF) membranes due to the nature of their spiral wound design. The material is engineered in such a fashion as to allow only one-way flow through the system. As such, the spiral wound design does not allow for backpulsing with water or air agitation to scour its surface and remove solids. Since accumulated material cannot be removed from the membrane surface systems, they are highly susceptible to fouling (loss of production capacity). Therefore, pretreatment is a necessity for any RO or NF system. Pretreatment in SWRO systems has four major components: screen of solids; cartridge filtration; dosing and prefiltration.

Screening of solids—solids within the water must be removed and the water treated to prevent fouling of the membranes by fine particle or biological growth, and reduce the risk of damage to high-pressure pump components.

Cartridge filtration—generally, string-wound polypropylene filters are used to remove particles between 1-5 micrometres.

Dosing—oxidizing biocides, such as chlorine, are added to kill bacteria, followed by bisulfite dosing to deactivate the chlorine, which can destroy a thin-film composite membrane. There are also biofouling inhibitors, which do not kill bacteria, but simply prevent them from growing slime on the membrane surface and plant walls.

Prefiltration pH adjustment—if the pH, hardness and the alkalinity in the feedwater result in a scaling tendency when they are concentrated in the reject stream, acid is dosed to maintain carbonates in their soluble carbonic acid form.

CO3−2+H30+=HCO3−+H2O

HCO3−+H30+=H2CO3+H2O

Moreover, carbonic acid cannot combine with calcium to form calcium carbonate scale. Calcium carbonate scaling tendency is estimated using the Langelier saturation index. Adding too much sulfuric acid to control carbonate scales may result in calcium sulfate, barium sulfate or strontium sulfate scale formation on the RO membrane.

Prefiltration antiscalants—scale inhibitors (also known as antiscalants) prevent formation of all scales compared to acid, which can only prevent formation of calcium carbonate and calcium phosphate scales. In addition to inhibiting carbonate and phosphate scales, antiscalants inhibit sulfate and fluoride scales, disperse colloids and metal oxides, and specialty products can be to inhibit silica formation.

Post treatment as discussed earlier is an important function of water leaving these apperati, and consists of stabilizing the water and preparing it for distribution. Desalination processes are very effective barriers to pathogenic organisms; however, disinfection is used to ensure a “safe” water supply. Disinfection (sometimes called germicidal or bactericidal) is employed to sterilize any bacteria, protozoa and viruses that have bypassed the desalination process into the product water. Disinfection may be by means of ultraviolet radiation, using UV lamps directly on the product, or by chlorination or chloramination (chlorine and ammonia), or by Ozonation, and in any combination thereof, depending upon user requirements. Ozone will be described in a following section. In many countries, either chlorination or chloramination is used to provide a “residual” disinfection agent in the water supply system to protect against infection of the water supply by contamination entering the system. As described earlier, and in further detail, below, is computer monitoring and control system for data logging and remote service and troubleshooting.

### Fuel Cell

Fuels cells, mentioned earlier, and their hybrid forms are disclosed and incorporated in the present invention, without limitation, and are widely used devices designed to generate electric power. In a fuel cell an electrochemical reaction involving a substrate occurs in the presence of a catalyst. In a conventional fuel cell the catalyst is an inorganic catalyst. In other permutations of FC's, and in conjunction with the Refugium, the EFSMP of the present invention proposes also using a specialized fuel cell type, that is, a biological fuel cell is utilized, and the catalyst is a biological catalyst such as an enzyme or, in the case of a microbial fuel cell (MFC), a bacterium or microbe. The substrate, sometimes referred to as the fuel of the fuel cell, is a substance that is consumed in the electrochemical reaction. Conventional fuel cell substrates typically include hydrogen gas and hydrocarbons such as methane. In a biological or microbiological fuel cell the substrate typically includes complex organic compounds such as volatile fatty acids, starches and sugars that are digested by the enzymes or bacteria of the cell. Substrate is loaded into a chamber in which the anode is situated (the “anode chamber”) and reacts in an electrochemical reaction catalysed by the catalyst to produce electrons and positively charged ions. In order for an electrical circuit to be completed, electrical charge must be transferred between the electrochemical reaction site and the electrodes. The electrons produced in an electrochemical reaction in a fuel cell flow from the anode through an external circuit (load) to the cathode. The positive ions (cations) travel through the electrolyte to the cathode. At the cathode electrons are combined with cations in a further electrochemical reaction. In some instances an ion-exchange membrane is present that separates the fluid-containing chamber of a fuel cell into an anode chamber and a separate cathode chamber. The positive charge is transferred from cations in the anode chamber across the ion-exchange membrane to form cations in the cathode chamber.

In a standard MFC, substrate is consumed by the bacteria in generating their life energy through an electron transport chain of reactions which can be subverted to partake in the electrochemical reaction. Bacteria in an anode chamber catalyze the oxidation of a substrate during bacterial cell respiration. The electrons produced from that bacterial cell respiration are released to the anode, either directly or via a mediator. Positively charged ions such as protons are also released into a fluid electrolyte present in the anode chamber.

The use of mediators, which are also known as “shuttling compounds”, to transfer charge from bacteria to the anode in an MFC has previously been described. For example, Ieropoulos et al., in “Energy accumulation and improved performance in microbial fuel cells”, Journal of Power Sources, 2005, 145, 253-256 describe the use of sulphide/sulphate ions as a redox mediator in MFCs.

The term “fuel cell” used in the present invention also encompasses, without limitation, conventional systems that are used to generate electricity and other systems in which substrate is consumed in an electrochemical process involving an electrical circuit. Thus, the term “fuel cell” may also include waste and effluent treatment systems and the like in which the primary purpose is to consume waste matter rather than to generate electricity. In some embodiments of the invention electric energy may be supplied to the system in order to drive the electrochemical processes involved in consuming substrate.

Recovery of platinum from used fuel cells represents a large value that would otherwise go to waste. Efficient methods of recycling reduce the cost of employing fuel cells allowing for more widespread use. Such recover is done, as described below, and previously, as with the precious metals that are embedded in the membranes, as they are removed from water steams.

Fuel cells convert a fuel and an oxidizing agent into electricity, heat, and water, and gasses. Fuel cells are composed of a polymer electrolyte membrane sandwiched between an anode and a cathode, and the polymer electrolyte membrane also serves to keep the fuel and oxidizing agent locally separated. The polymer electrolyte membrane is selectively permeable and non-conductive, for example, the polymer electrolyte membrane is permeable only to hydrogen ions in a hydrogen/oxygen fuel cell. The reactions at the cathode and anode may be summarized as follows:

H₂→2H++2e−(Anode)→½O₂+2e−→H₂O(Cathode) (1).

The polymer electrolyte membrane, anode, and cathode are further sandwiched between two gas diffusion layers forming five layers in total, referred to as a membrane electrode assembly. The gas diffusion layers are formed from porous, fibrous carbon fibers allowing for gaseous reactants and products to diffuse toward or away from the anode and cathode. The anode and cathode are formed from platinum-containing electrode catalyst layers that are deposited on the surface of either the gas diffusion layers or the polymer electrolyte membrane. Electrode catalyst layers deposited on the gas diffusion layer are known as gas diffusion electrodes, and those having the electrode catalyst layers deposited on the polymer electrolyte membrane are known as catalyst coated membranes. The terms gas diffusion electrode assembly and catalyst coated membrane assembly, respectively, refer to membrane electrode assemblies having the respective type of electrode catalyst layers.

The electrode catalyst layers typically contain precious metals as active catalytic components in addition to other components including conductive supporting material. For example, 0.5-4 mg/cm2 of platinum can be applied to the electrodes in the form of an ink or using complex chemical procedures. Platinum is a significant cost in the fabrication of a fuel cell.

The bulk of the membrane electrode assembly is carbon-based; therefore, a standard method to recycle precious metals, including platinum, involves a combustion step to remove carbon material. However, membrane electrode assemblies have high fluorine content due to polytetrafluoroethylene (PTFE) impregnated on the carbon fibers and from common polymer electrolyte membrane materials, such as Nafion® (DuPont Co., Wilmington, Del.), which results in a large, undesirable discharge of HF upon combustion. Removal of HF gas involves scrubbing and dedicated equipment that can withstand the corrosive nature of HF gas. Isolating the combustion from existing infrastructure is recommended to localize maintenance needs caused by the effects of HF gas.

The subject EFSMP provides for a method to recover precious metals from the different fuel cells used during water filtration—of which, without limitation can also be used throughout the matrix in every Tank House, or with any free standing Fuel Cell. Specifically, precious metals can be recovered from both catalyst coated membrane assemblies and gas diffusion electrode assemblies without any need to determine the type of membrane electrode assemblies present or without sorting of the assemblies before recovery.

One aspect of the EFSMP relates to methods for recovering precious metal from fuel cells by super-cooling membrane electrode assemblies to embrittle the membrane electrode assemblies and pulverizing the embrittled membrane electrode assemblies. Precious metal is then removed from the pulverized membrane electrode assemblies by contacting an acid solution containing an acid and an oxidizing agent to form an extract. Precious metal can be recovered from the extract using known electroplating and/or chemical reduction techniques.

Another aspect of the EFSMP relates to methods for recycling precious metals from fuel cells where the methods are environmentally friendly and do not produce HF gas. Consequently, the cost of fabricating fuel cells can be reduced by providing efficient methods to recycle precious metals from fuel cells that have reached the end of their useful lives.

Yet another aspect of the EFSMP relates to assaying the entire precious metal value of a lot of catalyst coated membrane assemblies and/or gas diffusion electrode assemblies. The precious metal value of a residue of the pulverized electrode membrane assembly can be assayed after being leached at least one time to assist in calculating mass balance.

The subject EFSMP provides a system and consolidated process to recover and/or recycle one or more precious metals from both catalyst coated membrane assemblies and gas diffusion electrode assemblies without any need to determine the type of membrane electrode assemblies present at any stage of the process. The process also allows for the opportunity to recover polymer from the polymer electrolyte membrane and/or ruthenium from the electrode catalyst layers as a downstream operation. While a functional membrane electrode assembly typically contains a number of layers including a polymer electrolyte membrane layer, two gas diffusion layers, and two electrode catalyst layers, the term membrane electrode assembly used in the present invention refers to a polymer electrolyte membrane with at least one electrode catalyst layer adhered and/or contacted to either side of a polymer electrolyte membrane. Membrane electrode assembly can alternatively refer to a polymer electrolyte membrane layer with at least one gas diffusion layer and one electrode catalyst layer. The terms catalyst coated membrane assembly and gas diffusion electrode assembly refer to membrane electrode assemblies having catalyst coated membrane electrode catalyst layers and gas diffusion electrode catalyst layers, respectively.

One available alternative to combustion recycling is delaminating of the electrode catalyst layers followed by filtration, described in U.S. patent application Ser. No. 11/110,406 filed Apr. 20, 2005 which is incorporated herein by reference. The carbon fiber gas diffusion layers are removed via manual or solvent delaminating in order access the electrode catalyst layers containing the precious metals. However, over the life of a fuel-cell, a portion of the precious metals migrates from the electrode catalyst layers into the polymer electrolyte membrane layers and/or adheres to the gas diffusion layer. Migration of the precious metals results in the formation of nanocrystallites (less than about 200 nm) in the membrane.

The nanocrystallites containing precious metals are unrecoverable since they are lost in solvent delamination as they are finer than the filter openings. Removal of the gas diffusion layer results in immediate loss of a portion of the precious metals originally present in the fuel Cell that is otherwise available for recycling. When catalyst coated membrane assemblies are solvent delaminated, the gas diffusion layers are removed, the electrode catalyst layers mobilize into the solvent, and the polymer electrolyte membranes emulsify.

Precious metals are then recoverable by filtration acts since the precious metals in the mobilized electrode catalyst layer are not dissolved in the solvent, being present in fine and coarse particles. However, solvent delaminating is not as effective with gas diffusion electrode assemblies since the laminated gas diffusion electrode assemblies only partially separate. The polymer electrolyte membrane remains intact and the electrode catalyst layers stay firmly attached to the gas diffusion layers. Therefore, precious metals from gas diffusion electrode assemblies are not recoverable via delaminating and filtration.

Another alternative to combustion recycling is heat-assisted acid leaching from membrane electrode assemblies, which is performed by immersing intact membrane electrode assemblies in hot aqua regia and heating. However, the yield of precious metal recovery is not reproducible due to the resultant inconsistent penetration of the leaching acid into the electrode catalyst layers of the intact membrane electrode assemblies. Higher consistency may be obtained by delaminating the gas diffusion layers; however, as discussed above, solvent delaminating the gas diffusion layers from gas diffusion electrode assemblies is ineffective. In addition, manual delamination is labor intensive and costly; therefore, manual delamination is not preferred.

The process disclosed in the present invention bypasses the need to delaminate membrane electrode assemblies by pulverizing the membrane electrode assemblies into a homogenous powder prior to acid leaching. Grinding into a powder allows for acid to reach the precious metal contained in the electrode catalyst layers regardless of whether catalyst coated membrane assemblies or gas diffusion electrode assemblies are being recycled. Both types of membrane electrode assemblies (catalyst coated membrane assemblies or gas diffusion electrode assemblies) can be processed together or separately. The process provides for precious metal recovery while allowing an opportunity for recovery of: a) polymer from the polymer electrolyte membranes; and b) ruthenium from the electrode catalyst layers during downstream operations.

Normally, a fibrous and polymeric material does not mill well. However, both the carbon fibers of the gas diffusion layers and polymer electrolyte membrane materials can be dismembered and significantly reduced in size using an impact mill after the membrane electrode assemblies are suitably cooled to a cryo-temperature sufficient to embrittle the membrane electrode assemblies. Carbon fibers (spaghetti-like material) of an intact gas diffusion layer from a catalyst coated membrane assembly are depicted in a 500× magnification electron micrograph. In addition to the carbon fibers, micro-PTFE is impregnated on the carbon fibers and is observed as lighter colored clumps adhering to the carbon fibers.

A further advantage of the methods disclosed in the present invention is the ability to assay the entire precious metal value of a lot of used catalyst coated membrane assemblies and/or used gas diffusion electrode assemblies without extracting precious metals from the entire lot. Since the pulverization of the intact membrane electrode assemblies results in a homogeneous powder, precious metals can be extracted from a small portion of the entire lot and measured through standard analytical techniques. The precious metal value of the entire homogenized lot can be calculated using routine mathematics once the precious metal value of a portion of the homogenized lot is known. Further, the ability to assay a portion of the homogenized lot or mixture also assists in mass balance calculations in determining the yield of precious metal recovered.

The pulverization can be performed in a batch-wise fashion. The pre-cooled membrane electrode assemblies are pulverized, for example, in an impact mill. The membrane electrode assemblies can optionally be re-cooled and the pulverization is repeated as many times as are necessary to achieve sufficient homogeneity. Suitable impact mills include, for example in small scale operations, the SPEX® 6850 (SPEX CertiPrep, Metuchen, N.J.) and the like.

In an alternative embodiment, the pulverization can be accomplished by continually grinding while maintaining a cryo-temperature. In one embodiment, this is performed by placing membrane electrode assemblies in a feeder with the capability to maintain a cryo-temperature by continually cooling the membrane electrode assemblies, such as contacting with a cryo-liquid such as liquid nitrogen. Suitable feeders include Cryo-Grind™ feeders (Air Products, Allentown, Pa.) and cryogenic feeders supplied by Pulva Corporation (Saxonburg, Pa.). The cooled and embrittled membrane electrode assemblies then exit the cryogenic feeder directly into a high-capacity impact mill capable of forming a homogenized powder in one pass through the mill. Suitable impact mills include the Mikro Bantam™ mill (Hosokawa Micron Crop., Osaka, Japan) and the like. In another embodiment, membrane electrode assemblies are pre-cooled to embrittlement and placed directly into a high-capacity impact mill.

A cryo-temperature is a temperature sufficient to embrittle membrane electrode assemblies. In one embodiment, a cryo-temperature is a temperature of about −75 degrees Celsius or less. In another embodiment, a cryo-temperature is a temperature of about −125 degrees Celsius or less. In yet another embodiment, a cryo-temperature is a temperature of about −196 degrees Celsius or less. Cooling may be affected by contact with cryogenic cooling systems and may involve the use of cryo-materials including liquid nitrogen, dry ice, and the like.

In one embodiment, the density of pulverized membrane electrode assemblies is from about 25 to about 2500 kg m-3. In another embodiment, the density of pulverized membrane electrode assemblies is from about 50 to about 1500 kg m-3. In yet embodiment, the density of pulverized membrane electrode assemblies is from about 100 to about 1000 kg m-3.

The pulverized membrane electrode assemblies are crushed to a sufficiently small size to facilitate subsequent extraction. In one embodiment, the pulverized membrane electrode assemblies have at least about 90% by weight of the particles with an average particle size of about 250 microns or less. In another embodiment, the pulverized membrane electrode assemblies have at least about 90% by weight of the particles with an average particle size of about 100 microns or less. In another embodiment, the pulverized membrane electrode assemblies have at least about 90% by weight of the particles with an average particle size of about 50 microns or less.

Leaching can be repeated to obtain an additional yield of precious metals. The residue remaining after completion can be contacted with any of a second acid solution, a third acid solution, and so forth (further acid solutions) as desired to obtain further extracts, which can be treated in the same manner as the first extract. Any acid solutions used to repeat leaching also contain a mineral acid and an oxidizing agent. In one embodiment, the first acid solution and any further acid solutions have the same composition. In another embodiment, the first acid solution and any further acid solutions have different compositions.

The first extract and any further extracts contain valuable materials worthy of recovery. One or more of the first and any further extracts may contain one or more of chloroplatinic acid, chloroplatinic salts, platinum, platinum salts, ruthenium, ruthenium salts, and the like. Further, valuable materials, such as ruthenium and polymer material from the polymer electrolyte membrane remain in the residue after leaching. These materials can be recovered in downstream processes.

The leaching of the pulverized membrane electrode assemblies can be assisted by optional heating. In one embodiment, leaching is performed at a temperature from about 15 to about 210 degrees Celsius. In other embodiment, leaching is performed at a temperature from about 25 to about 110 degrees Celsius. In yet another embodiment, leaching is performed at a temperature from about 50 to about 100 degrees Celsius. In one embodiment, one or more of the leaching activities is performed in a sealed PTFE container from about 50 to about 210 degrees Celsius. The heating for leaching may be provided by conductive means, convective means, in situ plant heat, or a microwave field.

General examples of surfactants and/or dispersants include one or more of a nonionic surfactant, cationic surfactant, anionic surfactant, and amphoteric surfactant. Specific examples of surfactants include alkali metal salt of polymeric carboxylic acid surfactants and phosphate ester surfactants. These surfactants are known in the art, and many of these surfactants are described in McCutcheon's “Volume I: Emulsifiers and Detergents” and “Volume II: Functional Materials”, 2001, North American Edition, published by McCutcheon's Division, The Manufacturing Confectioner Publishing Co., Glen Rock, N.J., which describe a number of surface-active agents and is hereby incorporated by reference for the disclosure in this regard. In one embodiment, the surfactants are one or more of Tamol® 731A, a diisobutylene/maleic acid anhydride co-polymer (Rohm and Haas, Philadelphia, Pa.), and Strodex® PK90, a phosphoric acid ester (Dexter Chemical, L.L.C, Bronx, N.Y.).

### Ozone

In some municipalities, and regions the government and or local authorities may require that Ozone disinfection O3 is utilized for all water being introduced back into the local municipal water facilities. O3 is an unstable molecule which readily gives up one atom of oxygen providing a powerful oxidizing agent which is toxic to most waterborne organisms. It is a very strong, broad spectrum disinfectant that is widely used in Europe. It is an effective method to inactivate harmful protozoa that form cysts. It also works well against almost all other pathogens. Ozone is made by passing oxygen through ultraviolet light or a “cold” electrical discharge. To use ozone as a disinfectant, it must be created on-site and added to the water by bubble contact. Some of the advantages of ozone include the production of fewer dangerous by-products (in comparison to chlorination) and the lack of taste and odor produced by ozonisation. Although fewer by-products are formed by ozonation, it has been discovered that the use of ozone produces a small amount of the suspected carcinogen bromate, although little bromine should be present in treated water. Another of the main disadvantages of ozone is that it leaves no disinfectant residual in the water. Ozone has been used in drinking water plants since 1906 where the first industrial ozonation plant was built in Nice, France. The United States Food and Drug Administration has accepted ozone as being safe; and it is applied as an anti-microbiological agent for the treatment, storage, and processing of foods.

The formation of oxygen into ozone occurs with the use of energy. This process is carried out by an electric discharge field as in the CD-type ozone generators (corona discharge simulation of the lightning), or by ultraviolet radiation as in UV-type ozone generators (simulation of the ultraviolet rays from the sun). In addition to these commercial methods, ozone may also be made through electrolytic and chemical reactions. In general, an ozonation system includes passing dry, clean air through a high voltage electric discharge, i.e., corona discharge, which creates and ozone concentration of approximately 1% or 10,000 mg/L. In treating small quantities of waste, the UV ozonators are the most common, while large-scale systems use either corona discharge or other bulk ozone-producing methods.

The raw water is then passed through a Venturi throat which creates a vacuum and pulls the ozone gas into the water or the air is then bubbled up through the water being treated. Since the ozone will react with metals to create insoluble metal oxides, post filtration may be required, depending upon placement of the ozone system, if so required or desired.

Furthermore, ozone may be used for a method for separating contaminants from a contaminated material that includes the steps of supplying the contaminated material to a processing chamber, moving the contaminated material through the processing chamber, heating the contaminated material by externally heating the processing chamber so as to volatilize the contaminants in the contaminated material, removing vapor resulting from the heating, the vapor comprises the volatilized contaminants, collecting, condensing, and recovering the volatilized contaminants, and contacting the volatilized contaminants with an effective amount of ozone.

In yet another aspect, this embodiment relates to a system for separating contaminants from a material that includes a processing chamber, a heat source connected to the processing chamber adapted to vaporize hydrocarbons and other contaminants disposed on the material, a condenser operatively connected to an outlet of the process chamber and adapted to condense the vaporized hydrocarbons and other contaminants, and an ozone source operatively connected to the condenser.

Reverse osmosis will remove 93-96% of the bromide from water. Since bromine is a disinfectant, it along with the disinfection by-products can also be removed with activated carbon, ultrafiltration, or electro dialysis.

The EFSMP for waste water, creates Ultrapure Ionized water, and can be used for such designer waters can be tailored for beverages (Coca Cola/Pepsi Cola), or the water can be tailored for agricultural irrigation (ConAgra/ADM/Potash). The minerals that are sucked out of the waste water can be resold for designer water, as in water alloys, or for local usage and consumption.

According to local law within the matrix jurisdiction—water is treated prior to being introduced into municipalities, like within the United States, where, for example fluoride, and chlorines are required.

Products removed, recycled, and introduced for monetization, in situ use, exported, sold, include but are not limited to the following: 1. Activated carbon; 2. Activated carbon fiber; 3. Alpha-olefins carbons; 4. Alumina; 5. Aluminum; 6. Ammonia; 7. Antimony; 8. Arsenic; 9. Barium; 10. Benzene; 11. Butane; 12. Cadmium; 13. Carbon; 14. Carbon black; 15. carbon dioxide gas; 16. carbon monoxide gas; 17. chromium; 18. clinoptilolite zeolite clay fertilizer; 19. Cobalt; 20. Copper; 21. cyanide; 22. diamond dust; 23. diamonds; 24. electricity; 25. ethane; 26. filter cakes; 27. fullerenes; 28. gas purification filter cakes; 29. gold; 30. granular active carbon; 31. graphite; 32. H₂S gas; 33. helium; 34. hydrogen; 35. ionized; 36. iron; 37. lead; 38. magnesium; 39. manganese; 40. mercury; 41. metals; 42. methane; 43. molybdenum; 44. nano water; 45. natural gas; 46. natural gas liquids; 47. nickel; 48. nitrogen; 49. NORM-Naturally Occurring Radioactive Material; 50. oil/petroleum; 51. oxygen; 52. Pentane; 53. Petroleum hydrocarbons; 53a. Mercaptans; 54. Pipeline quality dry natural gas; 55. Platinum; 56. Powdered activated carbon; 57. propane; 58. ruthenium; 59. selenium; 60. silver; 61. sulfur; 62. tetra methyl ammonium hydroxide; 63. thallium; 64. thorium; 65. tin; 66. ultrapure water; 67. uranium; 68. vanadium; 69. tungsten; 70. waste heat recovery and utility air and steam production boiler—as a pre-chiller product streams to aid in cooling to avoid the lack of capture and use of heat in recovery. The amount of steam and heat recovery is spread around the rest of the matrix, saving power, and generating electricity with turbines. 71. Water to order; and 72. zinc.

### Monitor and Control Processes

The EFSMP incorporates numerous systems, as per user defined parameters, that use real-time data acquisition and trending to allow you to see what is happening within the EFSMP, as it happens. Any process can be automated and monitored by these systems.

It is further proposed, that such system could be programmed to: monitor high and low levels in the day tanks, fill them when a certain level is reached; calculate and store the volume used; monitor the level in the main feed tank, an alarm rings when a certain level is reached to notify purchasing (or send an e-mail), and Plot the usage of chemicals vs. time, process, or any other parameter.

One example is for hexavalent chrome treatment, if and when needed, whereas a system is used for automated batch treatment of chrome waste from a deionization system. In addition, the system includes the following: the system has 3 tanks, waste acid, waste base, and batch; the batch tank is recirculated if there is waste to treat; the chrome/base waste is added to a certain level (ultrasonic level); acid from the batch acid tank is added to reduce the pH to 2.5. If the acid tank is empty, a metering pump is activated; and once the pH is correct, the ORP is adjusted with a reducing agent. ORP is monitored.

The system also includes: waiting for one half hour for the chrome to be reduced; raising the pH to 8 with a metering pump; and the waste is transferred to a cone tank for flocculation.

Moreover, the system, either automatically, or with user assistance can: turn pumps, valve, switches on and off, measure and log pH, conductivity, viscosity, pressure, temperature, flow rate and volume, parts, weight, color, etc.; alarm and notify by phone, e-mail, buzzer, etc.; and log any data and create real-time trending charts.

Further, the displays are color coded and indicate real-time conditions. An individual object can have many different colors coded to indicate various states. Tank levels can change color to indicate low, high, and operating conditions.

The real advantages of a SCADA system is that you have a real-time control of inventories and can program a system to “see ahead”, to notify you that the tank will be empty in “76 hrs”. It also will take most operator errors (or neglect) out of the process. The system doesn't tire, take breaks, or go on vacation. A user can monitor the system over a network, from a remote site over the Internet or through a dial-up line. The system can also decide who to notify and if the situation is not corrected, be programmed to alert personnel at higher levels of responsibility.

Additionally, the system has multiple levels of security available so that screens can be locked, hidden or display only depending on the security level. Higher levels of authorization can change set points and timing.

Updating software is a dial-up operation and is easily done without a site visit. Once a system is running, program changes are easily made at little cost. We can remotely monitor a system to debug or update software in real time. The system stays running while the rest of the current embodiment works.

Lastly, and not shown in drawing, where necessary, and without limitation, Humidification Cells, as described and incorporated herein by its entirety by reference to United States Patent Publication Number 20100323251, are utilized throughout the matrix.

Moreover, Table 2 below illustrates some contaminants that Cell 14 filters.

TABLE 2

| | Materials used to remove |
|---|---|
| Contaminants | containments |
| Refinery | |
| Sour Water | |
| Sulfur | |
| Mercury | silica |
| Lead | silica |
| Cadmium | silica |
| Zinc | silica polystyrene + liquid |
| Iron | |
| Nickel | |
| Copper | polystyrene + liquid |
| Manganese | polystyrene + liquid |
| Magnesium | polystyrene + liquid |
| Aluminum | polystyrene + liquid |
| Silver | |
| Gold | |
| NORM | |
| Uranium | |
| Thorium | |
| Ammonia | |
| petroleum hydrocarbons | |
| ethyl benzene | |
| Benzene | |
| Phenol | |
| Benzene | |
| Toluene | |
| Xylene | |
| Metals | |
| Lead | wire mesh |
| Silver | wire mesh |
| Copper | wire mesh |
| Mercury | wire mesh |
| Nickel | wire mesh |
| Chromium | wire mesh |
| Zinc | wire mesh |
| Cadmium | wire mesh |
| Tin | wire mesh |
| Iron | wire mesh |
| Arsenic | wire mesh |
| Gold | wire mesh |
| Platinum | wire mesh |
| Cyanide | wire mesh |
| Cobolt | wire mesh |
| Aluminum | wire mesh |
| Spent Battery | |
| Lead | silica |
| Cadmium | silica |
| Zinc | silica |
| Coal | |
| Sulfur | |
| Methane | |
| Nitrogen | |
| Benzene | |
| Carbon | |
| Arsenic | |
| Cadmium | |
| Cobolt | |
| Chromium | |
| Copper | |
| Mercury | |
| Manganese | |
| Nickel | |
| Lead | |
| Antimony | |
| Tin | |
| Thallium | |
| Vanadium | |
| Selenium | |
| Zinc | |
| NORM | |
| Uranium | |
| Thorium | |

Further, Table 3 below illustrates the various egress and ingress paths of the matrix.

TABLE 3

| Cell | | Egress | Ingress |
|---|---|---|---|
| 1 | Desalter | see table 2 | |
| 2 | tire plant | wash/dry talk, rubber dust, metal, tire | ultrapure water. |
| | | fiber, grime, oil and grease | |
| 3 | nano plant | water jacket | Diluted water solution, water jacket |
| 4 | Pyrolysis | pre-pyrolysis coals, tire, battery, | |
| | | blanket oil, carbon black, catalysts | |
| 5 | Battery | wash tank, sulfuric acid, sour water, | steam, water jet |
| | | hydro-separator | |
| | | grey oxide, plastic, rubber, | |
| | | ebonite and fiber | |
| 6 | Refinery | see sheet 1 | steam, water |
| 7 | Asphalt | wet scrubber, coke, asphalt, | water for wet scrubber |
| | | aggregates | |
| 8 | Amine/Claus | sulfur, sour water, ammonia | water, steam, furnace boiler |
| | Tail Gas | petroleum gasses | |
| | Degassing | | |
| 9 | Power | steam, water from fuel cell R/O, coal | ultrapure water, water, saturated |
| | | compounds, coal slurry | steam |
| | | peat, waste water from cooling | |
| | | towers, boilers, hydrolysis | |
| | | sulfur, sour water, ammonia, volatiles | |
| | | from water gas shift reactor | |
| | | condensed water | |
| 10 | SAR/GAR | ammonia, coke, | |
| | | sulfur | |
| 11 | Integrated | cooper, steel, lead, zinc, aluminum, | |
| | SAR/GAR | precious metals | |
| | H2SO4 | sulfur, pickling acids | |
| 12 | Lead | lead, sulfur, carbon, | water |
| | | zinc, | |
| | | silver, gold, platinum, | |
| | | copper | |
| 13 | Zinc | zinc, sulfur, copper, cadmium, | water |
| | | calcine, aluminum, lead | |
| | | coal, limestone, silica, | |
| | | silver | |
| 14 | Waste Water | | Water and Ultra Pure Water |
| | | | NOTE: future to include Nano-Water |
| 15 | Hydrogen | sulfur, methane, LPG, | ultrapure water |
| | | Nat Gas | |
| | | zinc, | |
| | | chlorine | |
| 16 | Oxygen | condensation, | is the Condenser the need for water |
| | | cooling | in this cell/plant? |
| 17 | steel mill | pickling, sulfur, iron, ammonia, | ultrapure water |
| | | coke, residuum oil, coal | |
| | | lime, carbon, ammonia, | |
| | steel foundry | metallurgical coke, Nitrogen | |
| | | sodium, chromium, molybdenum, | |
| | | manganese, nickel | |
| 18 | Lead Oxide | lead, | water |
| | | litharge | |
| 19 | Alumina | aluminum, sand, iron, titanium, | ultrapure water, steam |
| | | caustic soda (Red Mud) | |
| | | copper, zinc, silicon | |
| | | magnesium, iron, lithium, nitrogen, | |
| | | sulfur, chlorine | |
| 20 | Copper | copper, lead, gold, | |
| | | silver, carbon | |
| 21 | Sintering | carbon, clay, Red Mud, | |
| | | silica | |
| 22 | Sulfuric Acid | zinc, sulfur, copper, | |
| | | lead | |
| 23 | Precious | gold, silver, platinum, | |
| | Metals | cadmium | |
| 24 | Nano | chalcogels/aerogels, | ultrapure water |
| | Graphite | composite materials | |
| | | sulfur, graphite, xylene, | |
| | | carbon, fullerene | |
| 25 | Atomizer | | |
| 26 | Fuel/Pre- | | |
| | Pyrolysis | | |
| | Pre-Power | | |

In addition, FIG. 14C illustrates an example flow of Cell 14 to produce filtered water from the Matrix (EFSMP).

Moreover, another embodiment of Cell 14 is now described. In the cell for Waste Water Treatment (Cell 14), an optional additional piece of equipment can be added to screen size and typical rare earth magnets are utilized, either in tandem, parallel, interlaced, combination, individually, and the like, without limitation is can be included such apperati, depending upon user configuration, either in tandem, alternatively, in conjunction with, singularly, parallel, hybrid, and the like an “impact grinder” or “centrifugal grinder” whereby a very rapidly spinning wheel accelerates the material down its spokes and flings it against an impact block. Any silicate (aka silicate, carbon, petrocarbon, hydrocarbon, graphite, diamond, rare earths, actinides, minerals, manmade material, synthetic material, fiber, fluff, dust, non-metallic material, alloyed materials, sulphides, oxides, ferrous material, non-ferrous material, carbonates, and the like, but without limitation) impurities still attached to the free metal are shattered off. It is also feasible to have drum speeds sufficient to flatten the metal granules (aka powder, material, grain, contaminants, volatiles, organics, inorganics, rare earths, actinides, and the like) by impact, but is not a limitation to someone of ordinary skill in the art. A centrifugal grinder may be used, when required, and if necessary, after mechanical grinding and sieving, and before further magnetic separation takes place. In fact, most of the shattered silicate will be small particles which could be sieved out either within the screen as described in figures of Cell 14, or as placed within other locations of the matrix EFSMP, without limitation, and either in tandem, parallel, hybrid, combination, singularly, and the like, where such placement is not limited to a specific location within the overall EFSMP of the Matrix or any particular cell of the Matrix, or Invention Reactor, or individual capacity and the like.

Magnetic beneficiation can be used not only for separating pure nickel-iron, ferrous, metal granules, metal, metallic material, non ferrous material and the like, but also for minerals, rare earths, actinides, noble metals, and the like, or other materials which have weak magnetic properties, that have not previously been separated and sequestered for reprocessing within any of the matrix cells of the EFSMP. This section of the EFSMP, without limitation, and which can be used in combination, tandem, parallel, hybrid, and the like, with other individual cells of the Matrix System, or individually here, included such materials that are minerals that are attracted, repulsed, and unaffected by magnetic fields, based on their “permeability” to magnetic fields. This is often illustrated by showing a picture of magnetic field lines and grains which attract lines by bending them into the grain (concentrating), grains which repel the lines, and grains which aren't affected. The degrees of magnetic permeability differ from mineral to mineral. Particles which concentrate the lines of force and become polarized and consequently attracted are called “paramagnetic”. Those which disperse the lines are called “diamagnetic”.

Based on magnetic behavior, paramagnetic materials are sub-classified as ferro-magnetic and feebly magnetic, and the like, and are included in the present invention by definition.

In addition, magnetic separators, as are used in the present invention, but without limitation, and are known to someone of ordinary skill in the art, are classified as using different magnetic behavior's on materials, and can be drums, pulley's, disc's, ring's and belt separators, and may or may not, have screens of such configuration as described in the present invention, without limitation, based upon user defined needs and user requirements. They are all based on the same principle, and all use a provision for feed to run into and through the magnetic field and various means for discharging separately the magnetic and nonmagnetic portions or materials.

The EFSMP and screens in the Cell 14, and other cells, in combination, parallel, hybrid and combination, and likewise as is included in the Matrix, use a form of magnetic handling which separate the mineral grains by a process called “electrostatic beneficiation”, also known as “magnetic beneficiation”, which means charging them with static electricity and separating them by passing them through an electric field, whereas a electrostatic beneficiator (in tandem, parallel, combination, hybrid, individually, or separately) works because different minerals have different electrostatic affinities—will absorb different amounts of charge depending upon their composition, and hence are deflected different amounts by an electric field. After grains are sieved by size, they are placed through a beneficiator. After a few passes through beneficiators, materials have been separated from different minerals (there's no change in physical or chemical identity; there's only separation of minerals and material).

Beneficiators typically use free-fall of grains through electric fields, however this is not a limitation and someone of ordinary skill in the art can use different permutations of feed stream movement. For example, some beneficiators slide, without limitation, the grains down a ramp, and some put them across a rotating drum with a certain electrostatic charge so that grains of a certain affinity will stick to the drum and others will fall to the ground due to gravity or the centrifugal force. Other variations can also be where such magnetic separators are classified as drum, pulley, disc, ring and belt separators (in tandem, parallel, combination, and the like). They are all based on the same principle, and all use a provision for feed to run into and through the magnetic field and various means for discharging separately the magnetic and nonmagnetic portions. Thus, beneficiation separates minerals and materials according to their electrostatic affinity, as well as their different densities (with gravity or the centrifugal force).

The beneficiator charges the material, grains, powders, etc, without limitation, by any of the following methods (either in tandem, parallel, combination, individually, etc.): charging the screen that sieves them, or charging another surface which they slide over, or a diffuse electron beam as they fall. The charging method can depend upon which minerals are to be separated, since different minerals have different responses to different methods (and indeed to different temperatures, too).

The resultant material is collected in different bins whereby the enriched portion of the desired mineral is called the “concentrate” and the rest of the output is called the “gangue” or “tailings”. For purposes of definition, and without limitation, these are also synonyms for material in different form as is handled throughout the EFSMP.

Further configurations of someone of ordinary skill in the art with electrostatic beneficiators (also known as magnetic beneficiators) could have multiple bins, as the mineral stream will split up into multiple streams depending upon the degree of attraction or repulsion of each mineral.

In order to accommodate, facilitate, and the like, beneficiation, without limitation, an autoclave type environment can be utilized so as to provide a vacuum type of environment, and or one in which there is no air turbulence, because air does not tolerate electric fields as well as vacuum, and in fact electric fields can be ten times stronger in vacuum. The process of foam steel production is facilitated in a vacuum free, and gravity free environment, and such technology is incorporated in the present invention, so if user configuration is desired, different strengths of gravity can be accomplished by someone of ordinary skill in the art, similar to that of one sixth lunar gravity which dramatically slows the fall of the material through the electric field, thereby greatly enhancing the separation. However this is not a limitation. In addition, when beneficiate minerals in orbit (e.g., asteroidal minerals, space materials such as the material processed on the International Space Station, Apollo Missions, Space Shuttle Labs, where experiments with simulated lunar soil have produced excellent results using beneficiators in a regular air environment; moreover, while many mines on Earth are able separate the valuable mineral ilmenite, and the like, a similar process can be used on the Moon where that type of material is in abundance; indeed, some engineering companies focus on ilmenite in their first lunar mission scenarios), the centrifuges could create artificial gravity of any sensitivity, which would be superior when applications of this technology is required to facilitate maximum user-defined separation of materials.

When there are silicates, diamonds, carbons, graphite, and the like, which have been previously defined in the present invention, that have been separated, and without limitation, the material, is heated to 1500 degrees Celsius, and dropped in liquid oxygen. Within the EFSMP of the embodiments in the present invention, the Plasma Black Hydrogen Reactor, and the Tilt Furnace Reactor each attain temperatures for conversion, and are suitable for use, without limitation. The diamond becomes carbon dioxide gas, syngas and an altered diamond product, and can be used, without limitation to produce products in the nano reactor called diamond nano—a very hard subject/product, or manufactured and incorporated into the EFSMP in situ as materials or structures for the production of Aerogels and Chalcogels, and the like, since a diamond nano for substrate for chalcogel is one that would be extremely difficult to wear out, crumble—or the silicate materials are sent to pyrolysis to harvest the diamond dust, and mixed separately so that it doesn't mix with the char in the pyrolic chamber. The gas exits the pyrolic chamber, leaving the char and diamond, diamond dust, and the like. After the gas exits the chamber, the EFSMP robotically pulls out the trays and filters that have the diamonds and filter the char from the diamonds. Micro-filtration systems are also used for this char/diamond separation, and flush of effluent or water is used within the filter system chamber so that the ashes would flow and the diamonds sink, and do so by sending them into a water bath and then pull the diamonds out from the bottom. Char goes onto further processing to remove thorium and NORM, and the actinides (see http://www.pbs.org/wgbh/nova/transcripts/2703diamond.html).

Furthermore, metal-producing minerals are not the only targets of beneficiation as described in the EFSMP. Quick production of some kinds of simple glass products are also included in the present invention.

For the Solar Power Satellite (SPS), the General Dynamics report states: “The presence of large quantities of fine glass particles in lunar regolith is particularly relevant to the recommended use of foamed glass as primary structure for the SPS solar array and antennas. Foamed glass is commercially manufactured from fine particles of ground glass by the addition of small quantities of foaming agents and the application of heat. Thus, beneficiation of lunar regolith to recover the large amounts of fine glass particles may permit the direct production of all of the foamed glass needed for the SPS with few or no intermediate steps required to prepare the glass for foaming.”

While the EFSMP utilizes beneficiation on Earth, locating the beneficiator on a lunar mine (or non terrestrial location) could significantly reduce hauling of ore and hence the cost of bigger haulers and more energy, but would require that the beneficiator be mobile. Some designs in the literature, of those of ordinary skill in the art, have a mobile beneficiator as part of the mobile excavation equipment whereby the waste is left behind in the same spot it was dug up, as landfill. However the use of beneficiation in material separation to be processed within the EFSMP, or where such material is placed into existing markets, does not have the limitation of waste, and therefore is not a limitation of the embodiments in the present invention.

Other variations of magnetic material separation, of this EFSMP, without limitation are, and are fully incorporated herein by reference: United States Patent Publication Number 20110003392, System and Method for Magnetically Concentrating and Detecting Biomarkers, shows a System and method for capturing, concentrating, and detecting a diagnostic target in a liquid, comprising applying a magnetic field to a mixture comprising a co-aggregate in the liquid to provide a collected co-aggregate in the liquid, wherein the co-aggregate comprises a magnetic particle having a stimuli-responsive polymer attached thereto and a non-magnetic particle having a stimuli-responsive polymer and a diagnostic target attached thereto.

In addition, United States Patent Publication Number 20100294706, Magnetic Filter and Magnetic Filtering Assembly, has a limitation in that it specializes in only ferrous material attraction, however that based upon other properties of magnetism, and defined in the present invention, such attraction can be, without limitation, for nonferrous materials, counter, but similar to that describe as a reusable magnetic device for the extraction of ferrous particles from a body of fluid, where the device comprises a plurality of magnets and soft ferrous metal spacers arranged in an alternating sequence to form a stack, adjacent magnets being arranged with like poles facing, a non-magnetic and non-ferrous end piece terminally disposed at a first end of the stack, and a nonmagnetic housing that contains the magnets, the spacers and the end piece. The magnetic device can be installed in a vessel to provide a fluid filtering assembly.

As previously described above, and without limitation is equipment is an “impact grinder” or “centrifugal grinder” whereby a very rapidly spinning wheel accelerates the material down its spokes and flings it against an impact block. Any silicate impurities still attached to the free metal are shattered off. Moreover, it is feasible to have drum speeds sufficient to flatten the metal granules by impact. A centrifugal grinder may be used after mechanical grinding and sieving, and before further magnetic separation. In fact, most of the shattered silicate will be small particles which could be sieved out.

Further, magnetic beneficiation can also be used for separating alloys like pure nickel-iron metal granules, powders, and the like, as well as for minerals which have weak magnetic properties, without limitation. Based upon the density of material, and their absorption of electrostatic and magnetism, minerals as well as metals can be attracted, repulsed, and unaffected by magnetic fields, based on their “permeability” to magnetic fields. This is often illustrated by those of ordinary skill in the art, by showing pictures of magnetic field lines and grains which attract lines by bending them into the grain (concentrating), grains which repel the lines, and grains which aren't affected. The degrees of magnetic permeability differ from mineral to mineral. Particles which concentrate the lines of force and become polarized and consequently attracted are called “paramagnetic”. Those which disperse the lines are called “diamagnetic”. Utilizing Rare Earth Magnets, is proposed in the EFSMP to further facilitate separation, based upon user defined configuration and requirements.

Additionally, based on magnetic behavior, paramagnetic materials are sub-classified as ferro-magnetic and feebly magnetic. By further reference, and included in the present invention, in their entirety, without limitation, are illustrated additional forms of magnetic separation of liquids, effluents, and material.

Furthermore, U.S. Pat. No. 7,100,495, incorporated by reference herein, discloses a method and apparatus of treating wine to improve the wine's taste. This is accomplished by treating the wine with a magnetic field formed by one or more magnets, preferably at least two magnets. These magnets are positioned with one magnet at the base of a container that is holding the wine and another magnet at the top of the container.

Moreover, U.S. Pat. No. 7,107,894, incorporated by reference herein, a device to magnetically treat beverages by fastening to a beverage container. The device is preferably a magnetic fastener constructed and arranged to be attached to the neck of a wine bottle. The magnetic fastener comprises two semi-cylindrical halves, a spring mechanism connecting the semi-cylindrical halves and a plurality of magnets. Each semi-cylindrical half may preferably have a fastening end and a grasping end, where each fastening end may contain three columns of magnets which may preferably be substantially evenly spaced in the fastening end of the semi-cylindrical half. The magnets may preferably be aligned so that the polarity runs through the device, and where the north pole is located at one end and south pole is located at the other end.

In addition, U.S. Pat. No. 6,959,640, incorporated by reference herein, discloses a device for magnetically treating materials includes a base, and at least one magnet carried by the base to generate a magnetic field within the material. In some embodiments, the material may be within a container, and the magnetic field may be generated within the container to magnetically treat the material. The material may be a beverage and the magnetic treatment may enhance the flavor of the beverage, or may be an emollient and the magnetic treatment may change a characteristic of the emollient. The device may include a base, a plurality of tubular members extending upwardly from the base and arranged in spaced-apart relation to receive the material, and at least one magnet within each of the tubular members to generate a magnetic field within the material.

Further, U.S. Pat. No. 6,287,614, incorporated by reference herein, discloses a method and apparatus for improving the organoleptic properties of various alcoholic beverages by reducing the sensory perception of acids and tannins in wine, brandies, sherries, cognacs, spirits, beer, tea, coffee and fruit juice, including but not limited to any alcoholic beverages that have been aged in wood barrels or had the addition of wood or wood chips added to improve or enhance the flavor. The product to be treated can be either placed upon, inside or channeled through a magnetic field produced by permanent magnets, strong enough to achieve the desired results. The minimum gauss strength of the magnets should be strong enough to achieve the results depending upon whether the liquid to be treated is stationary, contained in a bottle, barrel or tank, or is moving through a pipe line during the manufacturing process.

Additionally, U.S. Pat. No. 6,974,543, incorporated by reference herein, discloses a magnetic-energy-releasing molecular rearranging structure includes an amount of magnetic powder, which is molded into a magnetic member in the form of a ball, a mass, or a flat piece, and having magnetic-energy-releasing molecules, so that the member has magnetic lines that together with earth poles produce a radiated magnetic field. Superficial molecules of a solid body and a liquid, or air molecules in a limited space may be magnetized and rearranged using the magnetic-energy-releasing member, and molecules of a substance that is to be magnetized may be magnetized and rearranged through magnetic energy transmission from the magnetized molecules of the solid body, the liquid, or the air in the limited space to the substance.

Moreover, U.S. Pat. No. 6,755,968, incorporated by reference herein, discloses a liquid magnetic processing unit that can activate a liquid flowing in a thick pipe and can perform water treatment. The liquid magnetic processing unit is mounted around the pipe in which the liquid flows and activates the liquid by magnetic force. The unit has one or more water treatment sections each having a band to be placed around the pipe and magnet housings which have the band inserted through them and that house a plurality of permanent magnets. The one or more water processing sections are covered with a case of a non-magnetic material.

Furthermore, U.S. Pat. No. 6,706,179, incorporated by reference herein, discloses a water magnetizer including a permeance member and a cooking recipient. The permeance member consists of two parallel disks spaced apart each other by a plurality of partitions located along the periphery of the disks, such that there is clearance between the two parallel disks. The permeance member is placed into the cooking recipient that is charged with water. Then, the cooling recipient is placed onto an electromagnetic heater. When the electromagnetic heater powers on, inner coils of the electromagnetic heater regularly vibrate at high frequency to change the direction of electric current and then induce a swirled magnetic field in the clearance. The water would be boiled by a lot of heat generated from electron movement in the induced magnetic field.

In addition, U.S. Pat. No. 6,440,302, incorporated by reference herein, discloses a portable water purifier of a type having a pitcher with a lower terminal wall and being divided vertically by a lateral partition into an upper compartment for holding raw water and a lower compartment for holding purified water, and a filter depending from the lateral partition into the lower compartment for purifying the raw water into the purified water. The improvement includes a base having a weight and replaceably supporting the pitcher thereon and acting as a coaster therefore, and a permanent magnet having a weight and encased throughout the base for delivering a concentrated and polarized magnetic charge through the lower terminal wall of the pitcher and into the purified water so as to polarize the purified water until its molecules are gradually rearranged from a normal agglomerated state into a more linear, organized, and substantially more permeable state that increases a body's ability to absorb and assimilate the purified water.

Moreover, U.S. Pat. No. 6,390,319, incorporated by reference herein, discloses a beverage container volume is exposed to magnetic fields associated with a permanent magnet. A beverage container volume is exposed to a permanent magnet incorporated into a beverage container cap, bottom, collar, holder or over layer.

Additionally, U.S. Pat. No. 6,299,768, incorporated by reference herein, discloses a magnetic treatment apparatus for magnetically activating water. The apparatus includes an upstream connector, a housing, a downstream connector and a magnetic unit. The magnetic unit is accommodated within a magnetic treatment passage formed in the housing. The upstream connector and the downstream connector are provided with a water inlet passage and a water outlet passage, respectively. Both of the water passages are in communication with the magnetic treatment passage of the housing. The magnetic unit includes a plurality of magnet holding pipes extending along the magnetic treatment passage. Each of the magnet holding pipes hermetically contains a plurality of disk-shaped permanent magnets, so that water to be treated will not come into contact with the permanent magnets.

Further, U.S. Pat. No. 5,932,096, incorporated by reference herein, discloses apparatus for removing magnetic material from a flowing fluid such as water by magnetic separation has a single set of electromagnets which are used with a plurality of magnetic filters for continuous magnetic separation operation alternately without obstructing the flow of the fluid being processed. A high-gradient magnetic filter arrangement which passes through a magnetic field generated by the magnets is made up of at least two magnetic filters separated by a watertight partition. When the fluid being processed is flowing through one of the magnetic filters, the other filter is removed from the flow of the fluid into a magnetic filter housing which is separated from the fluid flow through the magnetic filter by means of partitions. Backwashing of this other magnetic filter is carried out while purification of the fluid being processed by the former magnetic filter continues uninterrupted. Dummy magnetic filters are provided at the outer ends of the magnetic filter arrangement so that whichever of the magnetic filters is removed from the flow of the fluid being processed, the filter matrices do not leave the magnetic field formed by the plurality of magnets, and consequently the magnetic filters can be moved in and out of the magnetic field with a minimal driving force.

In addition, U.S. Pat. No. 5,891,332, incorporated by reference herein, discloses a method for purifying raw water taken from a raw water reservoir. The method includes the steps of subjecting the raw water to magnetic treatment, causing the magnetically treated water to flow through a filter medium in a first direction for purification of the treated water, and discharging the purified water into the raw water reservoir. The method further includes the steps of causing the magnetically treated water to pass through the filter medium in a second direction opposite to the first direction, and discharging the oppositely passing water into the raw water reservoir. The apparatus for realizing the above method includes a water intake assembly, a filter assembly and a water discharge assembly. A magnetic treatment device is mounted on the water intake assembly for subjecting the raw water to magnetic treatment. A switching device is operated to cause the magnetically treated water to flow through the filter assembly selectively in the first and second directions.

Furthermore, U.S. Pat. No. 5,813,557, incorporated by reference herein, discloses a magnetized fluid vessel which includes a fluid container or conduit. First and second magnets are situated on opposite sides of the vessel wall and are encircled by a metallic band or collar. The vessel may have an open mouth defined by a rim. In one embodiment, magnets are suspended by hangers form a rim of a cup. The cup and magnets are received in an exterior container with a removable lid. Other embodiments include oxygen tanks, oxygen tubes and containers for intravenous liquids.

Additionally, U.S. Pat. No. 5,804,068, incorporated by reference herein, discloses a fluid treatment device having fluid containment housing with a first containment region and a second containment region. The first and second containment regions are connected in fluid flow communication with one another by a generally narrow, elongate transfer channel that permits fluid to flow there through from one containment region to another while the fluid defines a natural vortex. Moreover, a generally powerful, polarized magnet is disposed about the transfer channel in order to deliver a concentrated, polarized magnetic charge into the transfer channel, thereby acting on the fluid flowing in the natural vortex through the transfer channel and polarizing it until the fluid molecules thereof are gradually rearranged from a normal agglomerated state into a more linear, organized and substantially more permeable state that will increase a body's ability to absorb and assimilate the fluid and obtain benefits there from.

Further, U.S. Pat. No. 5,628,900, incorporated by reference herein, discloses a water purifier includes a filter having a cylindrical housing formed with a water inlet at one end and a water outlet at the other end and contains in the housing a ceramic layer consisting of granular ceramic heaped up in a layer, a magnetite layer consisting of broken pieces of magnetite heaped up in a layer and provided at least above or below the ceramic layer, and annular magnets provided above and below the ceramic layer in such a manner that these annular magnets coincide with each other in the sense of magnetic lines of force and that the direction of the magnetic lines of force is parallel to the direction of flow of water. Water molecules are activated while passing through the magnetic field produced by the annular magnets and the magnetite layers which are magnetized by the annular magnets.

U.S. Pat. No. 5,542,562, incorporated by reference herein, discloses a magnetized fluid vessel. The vessel includes a fluid container or conduit. First and second magnets are situated on opposite sides of the vessel wall and are encircled by a metallic band or collar. The vessel may have an open mouth defined by a rim. In one embodiment, magnets are suspended by hangers form a rim of a cup. The cup and magnets are received in an exterior container with a removable lid. Other embodiments include oxygen tanks, oxygen tubes and containers for intravenous liquids.

Further, U.S. Pat. No. 5,522,992, incorporated by reference herein, discloses a device for the treatment of selected solutions where the device is a sealed container including a chemical mixture, at least one of the ingredients being magnetite.

Moreover, U.S. Pat. No. 5,094,742, incorporated by reference herein, discloses a magnetic water conditioning shower arm disposed in a water circuit supplying a shower head terminating the water circuit, the device comprises magnetic elements disposed within a tubular pipe-like element for treatment of water flowing there through by magnetic lines of force. The shower arm is preferably disposed immediately before the shower head in the water circuit and can thus be easily retrofitted into existing shower apparatus as well as installed as part of an original shower apparatus. The shower arm is particularly useful for the treatment of water containing scale minerals which deposit on surfaces of a shower head and which often render such heads prematurely useless. Magnetic treatment of water containing scale minerals according to the invention and prior to contact of untreated water with a shower head inhibits scale formation caused by precipitation of calcium salts, magnesium salts and other mineral compounds, thereby extending the useful life of a shower head to that life normally expected.

In addition, U.S. Pat. No. 4,946,590, incorporated by reference herein, discloses a clamp-on magnetic water treatment device for minimizing hard precipitate scale and lime deposit in a fluid supply, especially a domestic water system, has a magnet array having two sections which clamp together over a non-ferromagnetic section of conduit in the water system. The array of magnets defines at least two pairs of magnetic poles of opposite polarity across the flow path for the water, whereby a magnetic field is produced defining flux lines directly perpendicular to the flow path, and the magnets in the array attract one another across the flow path. The magnets in the array also define magnetic poles of opposite polarity proceeding downstream along the flow path. However, the individual magnets in the array are all arranged such that their poles are directed toward and away from the conduit, and not longitudinally along the flow path. In this manner, the maximum field strength is obtained in a clamp-on device. An outer enclosure of ferromagnetic material confines lines of flux to high permeability materials, maximizing flux density at the area of the fluid flowing in the conduit.

Furthermore, U.S. Pat. No. 4,299,700, incorporated by reference herein, discloses a device for the magnetic treatment of water and other liquids, having a pair of concentric tubular casings which are spaced from each other so as to form an annular treatment chamber. The inner casing contains an elongated magnet having two or more longitudinally spaced poles, and the intermediate casing is made of a magnetic material which serves to concentrate the magnetic lines of force within the annular chamber. The inner casing is supported within the intermediate casing by means of elastic, non-magnetic sleeves which are positioned over opposite ends of the inner casing and compressed between it and the inner surface of the intermediate casing so that the treatment chamber is rendered fluid-tight. Pair of apertures are provided in the opposite ends of the inner casing to permit fluid to flow into and through the annular chamber. In order to prevent the magnet from shifting axially relative to the inner casing and to prevent the inner casing from shifting axially relative to the sleeves, the apertures are deformed inwardly and outwardly so as to form locking ears between the apertures and the magnet and sleeves, respectively. The ends of the inner casing are flared outwardly so as to prevent the sleeves from sliding off the inner casing and to impart additional compression to the sleeves.

Additionally, U.S. Design Pat. No. D511,198, incorporated by reference herein, discloses an ornamental design for a magnetic treatment device for fluids.

Further, U.S. Design Pat. No. D500,118, incorporated by reference herein, discloses an ornamental design for a magnetic treatment device for fluids.

Moreover, United States Patent Publication Number 20070017924, incorporated by reference herein, discloses a thermally insulated beverage bottle holder that includes a sleeve constructed of flexible thermally insulating material having the general shape of a beverage bottle, the sleeve having a generally bottom cylindrical portion defining a first opening at the bottom first end thereof and an upper tapered portion that converges in size to define a second opening at the top second end thereof, whereby a beverage bottle can be inserted through the bottom first end of the sleeve with the top of the bottle exposed at the tapered top second end for access by a user to the contents of the beverage bottle. A securement member has one end thereof attached to or integral with one side of the sleeve and is removably attachable at the second end thereof to an opposite side of the sleeve and spans the bottom first opening of the sleeve in securing a beverage bottle within the sleeve. One or more magnets are incorporated into the structure of the securement member or sleeve to provide for removable attachment of the bottle holder to a metal surface.

Furthermore, United States Patent Publication Number 20060201956, incorporated by reference herein, discloses a magnetized insulator for beverage container. An insulator for holding a beverage container against a surface is a shell having an elastomeric wall. The top portion of the insulator includes an opening leading to an interior portion of the insulator. The insulator wall includes at least one magnetic strip. A beverage container is held within the interior of the insulator. The insulator and retained beverage container may then be attached to any metallic surface. The insulator may include retaining straps to more securely hold the beverage container within the interior of the insulator.

Additionally, United States Patent Publication Number 20060124526, incorporated by reference herein, discloses an apparatus for treating a liquid includes a container containing a liquid and a magnetic treatment device therefore. The magnetic treatment device may include an elastic band removably fastened around the container and urged there against by elastic deformation of the elastic band, the elastic band being deformable to accommodate containers having different sizes. The magnetic treatment device may also include at least one permanent magnet carried by the elastic band for magnetically treating the liquid in the container. Alternately, the magnetic treatment device may include a band with a joint or a drawstring removably fastened around the container.

Moreover, United States Patent Publication Number 20060102544, incorporated by reference herein, discloses a fluid magnetization device includes a first box and a second box, a pair of permanent magnets and a washer. The second box and the washer are sized to be inserted into the first box, and the permanent magnets are sized to be inserted into the second box and the washer, respectively. The first box and the second box engage with a pipeline. The magnetic field caused by the two permanent magnets magnetizes the fluid flowing the pipeline.

Additionally, United States Patent Publication Number 20030226447, incorporated by reference herein, discloses a beverage flavor enhancing device for use with a beverage container includes a base and a plurality of tubular members extending upwardly from the base and arranged in spaced-apart relation to receive the beverage container there between when the beverage container is positioned on the base. At least one permanent magnet is carried by each of the tubular members to generate a magnetic field within the beverage container to thereby enhance the beverage flavor.

Furthermore, sections of the EFSMP of the embodiment in the present invention can be lined or configured with neoprene, nano neoprene, chalcogel, chalcogel neoprene, nano chacolgel neoprene materials, neoprene materials, etc. in the present invention defined as neoprene. Neoprene sheet is a black colored rubber which is used where moderate oil, petroleum, ozone and weathering-resistance is needed. It is very popular due to the broad range of applications in which it may be used. Neoprene compound may be a blend of SBR (Styrene Butadiene Rubber), CR (Neoprene) and BR (Nitrile rubbers), etc. Neoprene provides excellent resistance to hydrogen gas, natural gas, Salt/Sea Water, Butanol (primary), Acetic Acids (up to 20%), ammonium Salts, Mineral Oils, silicone Oils and Greases, and many more. Neoprene is generally flexible, and may have a medium durometer (55-65), and in sheet form offers moderate pliability and elasticity.

A neodymium magnet or NIB magnet (also, but less specifically, called a rare-earth magnet, and the like, without limitation, of which the entire group is included in the present invention by reference) is a powerful magnet made of a combination of neodymium, iron, and boron—Nd2Fe14B. Neodymium magnets are very strong in comparison to their mass, but are also mechanically fragile and the most powerful grades lose their magnetism at temperatures above 80 degrees Celsius (176 degrees Fahrenheit). High-temperature grades will operate at up to 200 and even 230.degrees Celsius but their strength is only marginally greater than that of samarium-cobalt. Neodymium magnets should always be handled carefully. Some that are slightly larger than the size of a penny are powerful enough to lift over 10 kilograms. Strong magnetic fields can disrupt the operation of some internal medical devices such as pacemakers. While most solid state electronic devices are not affected by magnetic fields, some medical devices are not manufactured to mitigate the effects of strong magnetic fields. Neodymium magnets are commercially available in various forms, such as in disc or cylindrical form, from various suppliers.

Sections of the embodiment in the present invention also includes a water purification system using magnetism and far infrared technology, comprising, without limitation: a tube; means for providing far infrared wavelength energy; means for providing a magnetic field; and means for securing both the means for providing far infrared wavelength energy and the means for providing a magnetic field to the tube, including means for providing a magnetic field and the means for providing far infrared wavelength energy are secured to the tube such that water flowing through the tube is subjected to a magnetic field and to far infrared wavelength energy. Also, and without limitation, the outer sleeve can have a first end and a second end, and the tube is positioned within the outer sleeve and the means for providing far infrared wavelength energy, and other forms of energy as previously described herein (see definition for Radio Frequency, Microwave, Sonic, Ultrasonic, and the like), and the means for providing a magnetic field are secured between outer surface of the tube and inner surface of the outer sleeve. Also, in any configuration as desired by the end user, this section of the embodiment can have a first end cap having a cylindrical side and a top with an aperture; a second end cap having a cylindrical side and a top with an aperture; and the cylindrical side of the first end cap mates with the first end of the outer sleeve to form a watertight seal and the aperture in the first end cap mates with the tube to form a watertight seal; and the cylindrical side of the second end cap mates with the second end of the outer sleeve to form a watertight seal and the aperture in the second end cap mates with the tube to form a watertight seal; and means for providing far infrared wavelength energy and means for providing a magnetic field are contained within a cavity defined by an outer surface of the tube, inner surface of outer sleeve, first end cap and second end cap.

Moreover, the EFSMP can have a means for securing both the means for providing far infrared wavelength energy and the means for providing a magnetic field to the tube is epoxy, and whereas it can have the ability to producing far infrared wavelength energy is far infrared ceramic powder, or other silicate form, and whereas, without limitation the tube is constructed of an acrylic material capable of penetration by far infrared wavelength energy. However, to prevent limitation as to the design and configuration of the magnets, whether in tandem, parallel, inline, and the like, the EFSMP has a means for providing a magnetic field is a plurality of magnets. Furthermore, such magnets, whether individually or in any plurality of configuration, but without limitation can provide magnetic fields within coils of electrical wire, and such magnets are not limited to that of rare earth magnets and the like.

The EFSMP of the Waste Water Treatment in which any section of the figures in Cell 14, without limitation, and regardless of any plurality, duality, or configuration, operates in conjunction with a second device from the group consisting of a protein skimmer, a foam fractionator, a canister filter, an ultraviolet light sterilizer, an ozonation medium unit, a live sand system, a trickle system, a sump pump, a refugium, a calcium reactor and/or an aquarium tank, in any sequence, if so desired.

The EFSMP in which a water purification system using magnetism and far infrared technology, comprising: a plurality of tubes; a first disc and a second disc; means for providing magnetic fields; and means for providing far infrared wavelength energy; wherein the plurality of tubes are substantially equal in length and each of the tubes has a first end and a second end; wherein each of the first disc and the second disc has a plurality of cavities equal in number to the plurality of tubes; wherein the first end of each of the plurality of tubes mates with a corresponding cavity in the first disc to form a water tight seal; wherein the second end of each of the plurality of tubes mates with a corresponding cavity in the second disc to form a watertight seal; and wherein the means for providing magnetic fields and the means for providing far infrared wavelength energy are contained inside each of the plurality tubes such that water in contact with the outer surface of each of the plurality of tubes is subjected to a magnetic field and to far infrared wavelength energy.

In addition, this alternate embodiment of Cell 14 is a part of the Refugium and is also known a “Biological Fuel Cell”.

In the refugium, the algae's (also defined herein as flora and fauna, and without limitation to that of algae, macro-algae, micro-algae, fungi, slimes, microbes, bacteria, rotifers, crustaceans, copapods, bivalves, mollusks, nematodes, fishes, aquatic organisms, etc., biofuel genomic products, genetically modified strains of an electricigenic microbes selected from groups consisting of Desulfuromonas acetoxidans, Geobacter metallireducens, Geobacter sulfurreducens, or Rhodoferax ferrireducens, Citrobacter freundi, Pseudomonas putida, Alcaligenes paradoxus, Xanthomonasmaltophilia, Flavobacter indologenes and the like) none the least of which could be packed with blue-green algae spread onto vertical screens. The algae use the CO₂ and water from the plant to grow new algae, giving off oxygen and water vapor in the process. The organisms also absorb components of acid, such as nitrogen oxide and sulfur oxide, of which the algae's that are populated within the refugium can be used in conjunction with natural, or artificial light, in a photosynthetic environment which grows algae, passing carbon dioxide in the waste water stream over large membranes, placed vertically (and without limitation) to save space. The carbon dioxide produced by the algae is harvested by dissolving into the surrounding water. The algae can be harvested and made into biodiesel fuel and feed for animals, or harvested by other microbes, and algae's within the refugium/refugia as a means to absorb algae that is harvested and used for either fuels or materials for other materials.

Oil eating microbes, without limitation, such as Alcanivorax borkumensis are used herein, and are hydrocarbon eating bacteria, which have typically been used in bioremediation in 5° C. or warmer conditions. So as to not have limitations of temperatures, in this embodiment, Oleispira Antarctica, which can thrive at below 5° Celsius may also be used, in which these bacteria consume alkane compounds, molecules of carbon and hydrogen that provide the bacteria with energy and a source of carbon. They use the oxygen in seawater and their own specialized enzymes to break down the oil and process the alkanes, in the process emitting carbon dioxide. This still leaves a lot of the oil but, importantly, it is broken down and emulsified by the natural surfactants (glucose lipids) that the bacteria generate which, in turn, allows more rapid degradation. The emulsified oil may then be attacked by other bacteria whose favorite items on the menu are different from those of Alcanivorax. Further, someone skilled in the art in biogenetics and or microbiology, are able to, without limitation, manipulate, genetically create, and/or alter the DNA of this, and or any, bacteria, cell, organic, animal, algae, microbe, algaes, fungi, bacteria, rotifers, worms, flora, fauna vertebrates, invertebrates, mollusks, gastropods, cephalopods, arthropods, heterotrophs, any of their related phylogeny, phylogenetic tree, autapamorphic relatives, etc., and the like, without limitation, to further enhance organics, organic life, etc., as described and defined herein, and throughout this embodiment, of their respective capabilities (either native or non-native—e.g., inherent or non-inherent, but genetically adapted for the function) for purposes so desired and outlined in the embodiments throughout the present application, and whose nomenclature can be interchanged and generically used as such, without limitation or restriction, as being any of the descriptive verbiage as listed in this application.

The EFSMP processes hydrocarbons, and other material, whereas such materials come into contact with water, and such water is then sent to Cell 14, also known as Waste Water Treatment. Some of the hydrocarbon material is Crude Oil, Refined Oil, and secondary materials from petroleum and other products without limitation. In so much as crude oil is a soup of different hydrocarbons and other chemicals as well as the other materials of the EFSMP that are being handled are also of different properties. As such, the refugium is meant to utilize different microbes, without limitation, all of which prefer different components of the crude oil and other materials, to perform different cellular tasks. Alcanivorax, for example, uses n-alkanes (or saturated hydrocarbons) primarily as a food source. Other microbes can use the hydrocarbons as the finial electron acceptor in cellular respiration. These microbes primarily use the aromatics and cyclical hydrocarbons in the crude oil. There are many species of oil degrading microbes which all use different parts of the crude oil so, in the end, the majority of the crude can be degraded naturally in the environment. After the oil is gone, the bacterial bloom will die, with the environment not being able to support the inflated biomass of the bacteria. However, as is illustrated FIG. 14B, UV Light and UV Radiation is used to kill any and all bacterium, microbes, flora, fauna, and the like, whether natural or genetically manipulated, so as to prevent living organisms from leaving the facility and entering into the environment, in order to prevent any harm to human, and non human life, and where bacteria such as these hydrocarbon digesting bacteria could be manipulated to only uptake the spilt oil and not digest it, then if these bacteria were separated from their surroundings then this oil could be extracted, possibly for future use, and hence to prevent discarding of this material. Typically, and without limitation these bacteria, used in the refugium, without limitation, thrive on any oil, naturally “spilt” or otherwise sent through and into the waste water treatment section, or as a stand alone of cell 14. Furthermore, in different sections, plates, components, and the like of this section of the EFSMP, and Biological Power Cell, there can also contain, without limitation, other bacteria to ingest organic waste and process it into useable hydrocarbons plus a variety of other chemicals (see http://newscenter.lbl.gov/news-releases/2010/01/27/microbes-produce-biofuels/ and http://blogs.discovermagazine.com/80beats/2010/01/28/engineered-e-coli-bacteria-produces-road-ready-diesel/).

The refugium contains such principals that are also known, but without limitation to that of alga culture (farming algae) for biofuels, bio-ethanol, biogasoline, biodiesel, bio-butanol and they all consume CO2 during their growth, and CO2 is later released in energy production. Spirulina Algae, and the like, for example, but without limitation are commonly used in the Salton Sea for Nitrogen and Carbon capture, can be included and utilized in the refugium.

Furthermore, the embodiment herein can utilize a photo bioreactor that uses photosynthesis to grow algae just like a plant would take carbon dioxide up and, through the energy of the sun, convert that into oxygen. The carbon dioxide passes over the membrane substrate/strata, which are like a fabric found in a shirt. It is a woven material, and as the carbon dioxide pass by them, that carbon dioxide dissolves into the water. That carbon dioxide is broken down by the algae. Nitrogen and clean oxygen are released back into the EFSMP to be utilized therein, or placed into existing markets.

Membranes, and substrates, and/or strata, etc. all defined herein are interchangeable, without limitations, whereas the membranes can be placed within the refugium, so as to facilitate/accommodate an substrate environment for which different algae, microbes, bacterium, flora, fauna, exist, and filter the water, and in which, without limitation, any flu gases that would run through the EFSMP the algae that would be growing on the suspended vertical (or other planeular directional) surfaces can be harvested and made into biodiesel fuel and or feed for animals.

As there are different temperatures of waste water flows that are enter the Waste Water Treatment piping, architecture, and apperati, carbon dioxide emissions from fossil fuel exhaust with the help of heat-loving algae and hybrid solar lighting, can also have additional elimination of CO₂ from coal-burning as described in Cell 9, and can use, without limitation a natural process of photosynthesis. This works, without limitation by using blue-green algae spread onto vertical screens. The algae use the CO₂ and water from the power plant to grow new algae, giving off oxygen and water vapor in the process. The organisms also absorb components of acid streams, acid rain, and the like, without limitation, in so much as nitrogen oxide and sulfur oxide.

The refugium media for algae, and the like, without limitation, can utilize any configuration of placed screens of woven fiber, strata, substrate, etc., with algae, being vertically, horizontally, diagonally, and the like. Further, such screens can be stationary or rotating. Since some algae, and utilized herein, but without limitation, need sunlight to thrive, hybrid solar lights that collect sunlight with curved mirrors and then channel it through the reactor via optical fibers can be used, as well as any bioluminessence generated from the ligands, or other algaes, flora or fauna and fiberoptically transferred to the refugia organics, etc. Those of ordinary skill in the art, could also use different phosphoric material and synthetic light to facilitate the same effect and need, based upon user configuration and demand.

In addition to utilizing genetically modified algae, bacteria, flora, fauna, (is defined herein, and throughout the embodiment to include, but is not limited to any aquatic organism, which can include, but not limited to, fishes, eels, bacteria, microbes, slimes, algae, etc.) and the like, a proposed alternative, without limitations is a species of algae found that naturally thrives in the hot springs of Yellowstone National Park, and does equally well in the exhaust of a power plant as well as the proposed EFSMP. These algae can also be genetically manipulated to accommodate the needs of the EFSMP and the refugium, and the Biological Fuel Cell. Furthermore, bacterium such as Shewanella oneidensis are known to be manipulated for the digestion of ferrous materials. Someone of ordinary skill in the art can work with these bacterium and other algae's, microbes, fungi, rotifers, flora, and fauna in order to manipulate the nucleic acids, and other genetic material of such organisms, so that they can be introduced and used in the waste water refugia and treatment to remove all types of metals, as well as minerals, silicates, ferrous and non ferrous metals and materials for further harvesting and reclamation.

A limitation of bioreactors, which is not applicable in the present invention application, remains a challenge of how to dispose of the large quantities of algae produced by the bioreactor; one option is to collect it and use it as a biologically derived fuel (biofuels), and is included herein. Additionally, remaining material can be sent to the Furnace Reactor in Cell 9, by way of filter cakes, pressed material, etc. and the like, without limitation, for further fuel usage and material reclamation within the EFSMP of the embodiment herein. Since algae are relatively simple organisms that capture light energy through photosynthesis, or can be any variety of non light species, where all of these organisms convert inorganic, and or, organic, without limitation, substances into organic matter and vice versa.

They are usually found in damp places or bodies of water. They vary from single-celled forms to complex forms made of many cells, such as giant kelps, which can grow as much as 65 meters in length. It is estimated that algae produce between 73 to 87% of the net global production of oxygen.

In this embodiment of the EFSMP, the biological fuel cell is a system for aquaculturing aquatic life forms, biological organisms, and the like, comprising, and without limitation, but subject to user requirements and specifications: a reservoir holding water; a tray substrate media membrance etc., and the like without limitation, holding the aquatic life forms submerged in the water, wherein the tray is rotatable within and with respect to the reservoir; and a means for rotating the tray in the reservoir. Where, there is direct water flow across the aquatic life forms on the tray while the tray is either a solid plate, perforated, vented, and the like (also known as a membrane or other woven material) rotates—however, the tray, can be fixed and stationary, where the tray can be removed for harvesting of life forms, biologics, microbes, fungi, rotifers, and the like, with collected minerals, gasses, solvents, metals, non-metals, materials and the like, being extracted in the appropriate sections of the Matrix EFSMP or individual cells, as so desired for end product manipulation and positioning into either established markets or used in situ. Also, where water flows and membrane, membrane trays, and the like are considered, the EFSMP can direct water flow across the aquatic life forms on the tray, wherein the second means to direct water flow generates a flow of water different than that produced by the first means to direct water flow, and whereas there is a plurality of buoyant floats for positioning under aquatic life forms on the tray. Furthermore, the tray can have an aerator positioned under it as being operable to produce a flow of air through the tray when the tray is submerged under water, of which the air flow can also affect, and or manipulate the flow of water, if such manipulation is deemed necessary according to optimal parameters.

Since this embodiment of the Waste Water Treatment System, Cell 14 contains flora and fauna, such EFSMP section, without limitation, can contain a greenhouse containing any reservoir or capture device, and where as any of the trays, and the like, can be robotically, and or automatically positioned, or removed, and that while in line, there is a means to regulate the depth of the tray under water when the tray is submerged in water. If so desired, and without limitation, depths can be monitored, and configured, and set, and measured, and the like by such means, and without limitation, as a float coupled to the tray by a connector.

Further, as water flows throughout the refugium, and crosses membranes and the like, fixed or rotating trays can be automatically changed for flow manipulation by a means to direct water flow directed to impinge a flow of water upon the tray or within the system so that that user configuration that has determined the best and optimal configuration for the biological organisms can be positively, or negatively affected, with regard to growth and the like, and wherein aquatic life forms positioned on the tray experience water flow in at least two different directions relative to the aquatic life forms during one rotation of the tray when the tray is submerged under water.

The EFSMP of Cell 14, and the Waste Water Treatment that, without limitation, wherein the tank has a reservoir outlet in the reservoir; a refugium outlet in the refugium; a spray bar in the refugium directed away from the refugium outlet; a water pump operably coupled between the reservoir outlet and the spray bar; and a nozzle operably coupled to the refugium outlet, wherein the nozzle generates a flow of water across the aquatic life forms on the tray while the tray rotates, and where such embodiment, without limitation can further comprise: a first means to direct water flow across the top of the rotating tray in a first direction; and a second means to direct water flow across the top of the rotating tray substantially in the first direction; wherein aquatic life (flora, fauna, etc.) forms positioned on the tray experience water flow from the first and second means in different directions relative to the aquatic life forms during rotation of the tray in the reservoir. The refugium, and biological fuel cell comprises, without limitation, a method for aquatic aquaculture comprising the acts of: providing a habitat containing water adapted for aquaculture of aquatic life forms; providing a tray upon which the aquatic life forms are located; substantially continuously revolving the tray in the habitat; generating a first flow of water in the habitat that causes variable water flow conditions in the habitat so that the organic, biologic, and/or aquatic life etc., on the tray experience water flow in at least two different directions relative to the aquatic life forms during one rotation of the tray.

Because, in addition to, but without limitation, some biologics, regardless of being aerobic or anaerobic, may not require much more than a flow of water with nutrients, also known as material, the EFSMP can generate a second flow of water in the habitat that further varies the variable water flows conditions in the habitat. Such flows can be different permutations of further comprising the acts of: impinging the first flow of water against the tray to revolve the tray in the habitat.

As water flows, defined as material flows, acid flows, sour water flows, metal flows, and the like, all vary, in substance and flow direction, there may be a requirement to use specific strains of organic life, and such, in that the organisms can tolerate different volatiles, salinity, acids, materials, temperatures, and the like, so that they are not negatively affected, nor inhibited from performing their desired function of material removal and usage from within streams of water and other effluents and gasses, that are passing through the refugium, biological fuel cell, bioreactor, and the like.

If the algae's, bacterium, fungi, and the like, after absorbing material can be harvested, the biologics can be pressed into filter cakes, like algae that absorb nitrogen, and can be used as fertilizer, or those that absorb carbon (hydrocarbons and the like) and can be sent to the atomizer for carbon removal, or to the pyrolysis reactor for gas generation, or the power plant for use in the furnace for heat generation and carbon reclamation as the EFSMP is designed for. or as Shewanella which generate a small amount of electricity as they eat waste, giving them potential as biofuel cells.

Materials from within the Matrix EFSMP and which can be handled, without limitation can also be known as micro-nutrients, where the micro-nutrients which methane bacteria require in trace quantities include: iron, manganese, copper, nickel, zinc and cobalt.

Although the materials of the waste water streams may contain toxic metals which are needed in any quantity at all, can include cadmium, chromium, mercury or lead, the biological, and bacterium can be genetically altered, and in some cases are inheritantly native to having protections for survival that tend to be protected from excessive concentrations of these metal salts by the action of sulphate-reducing bacteria which tend to precipitate “surplus” metal ions as their insoluble sulphide salts. Additionally, toxic metals, etc., harmful to organics (mankind, animal life, etc.) can be collected by the organics specifically engineered to capture them, and the like, pressed into filter cakes, and sent offsite for legal waste collection at approved cites for handling the materials, metals, salts, etc.

If required, sewage sludge and animal slurries can be added to the waste water, and effluent material streams to provide a useful source of all the “major and micro” nutrients required by the anaerobic digestion bacteria.

Within this embodiment of Cell 14, and the membrane plates of the refugium, methane bacteria can be seeded therein that will grow at all pH values between 6.0 and 8.5 with an optimum slightly above pH 7.0. A minimum alkalinity of about 500 mg/l is required to neutralize the acidity of the dissolved carbon dioxide gas and to form a buffer of the within the optimum pH range.

Higher alkalinities are sometimes helpful, especially during start-up, to neutralize the initial acidity of a larger than normal level of volatile fatty acids, until the contents of the reactor “age”.

A major source of alkalinity is ammoniacal nitrogen which is released by cell lysis (the breakdown of cell proteins) in the MSW. The concentrations of ammoniacal nitrogen are high and often in the 1000-4000 mg/l NH4N range. The release results in pH values in the range 7.5-8.5, which is naturally suitable for the fermentation process.

### Salts and Salinity

Calcium and magnesium salts are also present in the MSW but inhibition unlikely as their maximum concentrations are limited by their solubility, and in anaerobic digesters, they tend to precipitate before they reach inhibiting concentrations.

Reaction rates are generally limited by the slow growth of the methanogens—those “methane bacteria” that convert acetic acid to carbon dioxide and methane.

Both mesophilic and thermophilic strains of methane bacteria can be used in anaerobic digestion processes.

Mesophilic methane bacteria grow best at 35-40° Celsius Thermophilic methane bacteria grow best at 55-60° Celsius.

For simplicity of operation and to avoid the need to heat the reactor, waste water streams, and the like, most anaerobic digestion plants are operated at mesophilic temperatures that at temperatures between 3 and 35° Celsius and require 15 to 20 days of mean retention time in the digestion reactor to produce a reasonably high methane gas yield and a high quality digestate product.

The thermophilic reaction rate can be more than double the mesophilic rate, in theory, so it may be chosen to reduce vessel size.

Traditional anaerobic digestion for treatment has most often used the mesophilic range. However, there has been a trend for the high solids contents available to use the more rapid fermentation at thermophilic temperatures of 55 to 60° Celsius.

The temperature attained during thermophillic provides a much better sterilization of weed seeds and possibly also of “pathogens”.

The EFSMP of the Biological Fuel Cell contained herein is able to, and without limitation, extract energy in the form of electricity, which can be harvested from marine sediments, and or non-marine sediments, and other effluent sediments within the EFSMP, by placing a graphite electrode (the anode) in the anoxic zone and connecting it to a graphite cathode in the overlying aerobic water. With a specific enrichment of genetically altered microorganisms of the family Geobacteraceae, and other organisms, as listed herein, on energy-harvesting anodes, and it is shown that these microorganisms can conserve energy to support their grown by oxidizing organic compounds with an electrode serving as the sole electron acceptor.

Members of the genus Geobacter are the dominant metal-reducing microorganisms in a variety of anaerobic subsurface environments and have been shown to be involved in the bioremediation of both organic and metal contaminants.

The refugium, and waste water system, as defined herein, are different than that of typical biological fuel cells, microbial fuel cells, bioreactors, and the like, and without limitation thereof, is that the systems referenced in the attachment are “closed loop” systems. That is, they are systems that have been, and are use in laboratory environments only, and do not focus on an active “open system” live flows of effluent, water, materials, etc. and the like. This embodiment of the ESFMP includes using open systems, in such that there is constantly new sources of water, including regenerated water, continued waste water for treatment and purification, etc., and effluent that are being introduced for treatment, from such things as rain water, sour water, rain jacket water, sulfuric acid water from batteries, as well as from the production of water in the Hydro Electric Reactor; in which water is used to facilitate the refining and treatment of material in the EFSMP. As such, new water is always being introduced to the EFSMP.

Furthermore the EFSMP treats heavy metals via thermophilic anaerobic digestion, in which the methane bacteria are considered a very sensitive group in anaerobic digestion, and as such, and without limitation probes in substrate mud and sediments remove electricity are used. Such probes can be metals, composites, alloys, and the like.

Additional phylum Proteo bacteria, and without limitation are a type of bacteria that can also be used in the bacterial community of the bioreactor, followed by Firmicutes, Actinobacteria, and Flavobacteriaceae. However, the occurrence and predominance of specific bacterial species varied with the concentrations of NH₃ introduced into the bioreactor may be more beneficial, depending upon user requirements. The complexity of the bacterial species generally decreased with increasing inlet NH₃ concentration. Based on the characteristics of the identified species, there is a potential for nitrification, denitrification, nitrate reduction, nitrite reduction, and ammonia assimilation to occur simultaneously in the bioreactor. The strains identified in this EFSMP can be used independently, in combination, in tandem, parallel, and the like, for the purification of waste gases containing high concentrations of NH₃.

The refugium of this cell can also aid, or be the sole treatment of a way to dilute gaseous hydrocarbon waste streams which remains a current need for many industries, particularly as increasingly stringent environmental regulations and oversight force emission reduction. Biofiltration systems hold promise for providing low-cost alternatives to more traditional, energy-intensive treatment methods such as incineration and adsorption. The EFSMP matrix within Cell 14, and the refugium, and biological fuel call, or bioreactor, and the like, but without limitation, can exploit a microbial consortium to treat a mixture of 0.5% n-pentane and 0.5% isobutane in air. Since hydrocarbon gases are sparingly soluble in water, good mixing and high surface area between the gas and liquid phases are essential for biodegradation to be effective. The EFSMP utilizes such degradation methods, by someone of ordinary skill in the art, of n-pentane and isobutane as sole carbon and energy sources. The maximum degradation rate in this gas-recycle system was 2 g of volatile organic compounds (VOC)/(m3·h), but as the art continues to advance, so does the efficiency of such technology. As surface area, similar to the membrand plates, and found on the membrane plates are necessary for the biologics to grow, also included are such methods of introducing flow streams, by means of a trickle-bed bioreactor to provide a higher surface areas (using a structured packing) with increased rates. Degradation rates consistently are approximately 50 g of VOC/(m3·h) via single pass in this gas-continuous columnar system. Control of biomass levels can be implemented by limiting the level of available nitrogen in the recirculating aqueous media, enabling long-term stability of reactor performance.

The EFSMP utilizes, but without limitation, natural extensions of engineering principles and reactor designs as applied to bio treatment of gaseous hydrocarbons include areas of higher concern as well, such as bioconversion of fossil fuels or syngas and bioremediation of aromatics and chlorinated hydrocarbons. As an alternative to traditional treatment methods such as incineration and adsorption, bioreactors properly designed to remove sparingly soluble gaseous substrates from effluent air streams hold promise for providing low-cost treatment methods. Furthermore, a process of moving contaminated gas through a biologically-active matrix or bed where microorganisms convert the contaminants to carbon dioxide, water, biomass, and inorganic salts, is included herein. Many compounds can be treated by bio filtration, e.g., hydrogen sulfide, odors, acetylene, ethylene, aliphatics, toluene, ammonia, aldehydes, ethanol, ketones, esters, styrene, etc. The EFSMP's trickle-bed bioreactors, plates, membranes, and the like can also be used for conversion of gas components to fuels such as hydrogen and methane from other gaseous components, whereas such methods are known to those of ordinary skill in the art, and are included herein by reference, for removing undesirable gaseous compounds from air dates back to 1923, when removal of hydrogen sulfide from German waste treatment plants was discussed (Bach, 1923). The first large-scale application of bio filters in the United States was in California during the 1950's (Pomeroy, 1963), and around the same time frame (1959), a soil bed biofilter was installed in Germany (Hartmann, 1976); both of these systems were applied for odor control. Soil beds have been used for odor control from rendering plants (Prokop and Bohn, 1985) and for removal of alkanes from aerosol-can filling operations (Kampbell et al., 1987).

A thorough review article was published by Leson and Winer for soil and compost biofilters (Leson and Winer, 1991) and is included herein by reference, which contains typical operating conditions, power consumption rates, and economic considerations. The internal structure for these filters varies but mainly contains soil and/or organic compost material from wood refuse. Flow rates can be as high as 75,000 m3/h for a large filter (2100 m3) with an empty bed superficial velocity of 1.8 m/min (Leson and Winer, 1991). Several other large-scale operations (5000-150,000 m3/h) have also been listed, and it has been estimated that approximately 50-500 biofilters are in use in the United States and Europe, respectively (Kirchner and Wagner, 1994; Leson and Winer, 1991; Naylor and Kuter, 1994). Biofiltration methods have offered a more cost-effective solution for removing contaminants but have not yet received widespread acceptance. The EFSMP utilizes, without limitation, two common designs: gas recycle (bubble) trickle-bed bioreactors. The first of these typically employs a column filled with an aqueous medium containing nutrients capable of supporting microbial growth. Gas containing contaminants to be removed is bubbled through the column and exits at the top. As bubbles move upward through the column, contaminants transfer into the aqueous phase and are subsequently converted into carbon dioxide, water, and biomass. Such columns may contain packing material to increase gas dispersion. The packing may also serve as a support for biofilm growth.

The trickle-bed biofilter represents the latest development in biological air pollution control and differs from the traditional biofilter in that it always has a continuous flow of liquid over the packed-bed material. Another difference is that the packing/substrate material is usually man-made in the form of dumped or structured packings commonly used in gas-liquid columnar contactors. Depending upon the packing type, microorganisms may attach to the packing and create a fixed biofilm which provides more biomass in the system and increases rates (Togna and Singh, 1994). Among trickle-bed designs there are many variations primarily related to the chosen packing material.

Both full-scale applications and research have shown that a variety of airborne contaminants can be degraded in different types of biofilters. The key to high removal rates and small filter size lies in the design of the biofilter. A well-designed biofilter operates close to mass-transfer limited conditions (from gas to liquid), meaning a large active biomass must be available to carry out rapid degradation (Andrews and Noah, 1995). The most effective strategy for maintaining a high biomass in the system is to use a trickle-bed filter with a type of packing which supports biomass attachment. In doing so, however, overgrowth may cause fouling and increased pressure drops, resulting in extended shut-down periods. This was noted by Sorial et al. (Sorial et al., 1994), who were forced to design a high-flow flushing system for periodic (twice a week) removal of biomass. Other biofilters, such as compost filters, use the packing to provide nutrients for biomass growth. These biofilters can foul due to growth or lose activity when nutrients are eventually depleted. Other characteristics a packing material should possess include channel-free flow, high surface area, resistance to microbial degradation, and cleaning/replacement ease.

In so much as the EFSMP utilizes different permutations of technologies in the refugium, all are referred to, and defined as, without limitation as a biological fuel cell—whereas such configuration can contain an anode and cathode to remove electricity from mud. To increase and amplify the amperage from the initial electrical voltage, it is proposed to do so with a rare earth materials incorporated into the cathode and anode in a hallow tube, or directly in the solution, if it is not necessary to sequester or to protect organisms from getting shocked, then the amperage will be increased from within the solution. A rare earth magnet between the cathode and anode will magnify the amperage.

The Biological Fuel Cell Tank, can also be run in parallel, tandem, and in combination (as can all other types of fuel cells in the EFSMP, with other types of fuel cells . . . and is not limited to being connected to that of a Carbon fuel cell, in which the fuel cell plant produces carbon black. Someone of ordinary skill in the art can interconnect, and utilize the new biological and microbial plates, substrates, strata, etc., and the like, in the carbon fuel cell where the organisms eat the carbon black, and then by adapting the technologies, limitless amounts of electricity is produced.

In the embodiment of the biological fuel cell, and the electric arc hydrogen plasma black reactor, in which, without limitation, are connected in situ to a carbon fuel cell, and then there is an exchange between the molten salts of the two where it is a dual reactor and pumps out DC current for electricity production.

In addition, the following United States Patent Publications and Patents are related to these embodiments and also incorporated by reference: 20020025469 Biological Fuel Cell and Methods; 20020172992 Method For The Determination Of Glycated Hemoglobin; 20030138674 Electrochemical Methods For Generation Of A Biological Proton Motive Force and Pyridine Nucleotide Cofactor Regeneration; 20030152823 Biological Fuel Cell and Methods; 20030196946 Water Treatment System Using Magnetism and Far Infrared Technology; 20040048111 Biocatalytic Direct Alcohol Fuel Cell; 20040048112 Arrangement and Method For Generating Electric Power, and Power Source; 20040241528 Implantable, Miniaturized Microbial Fuel Cell; 20040241771 Electrode Compositions and Configurations For Electrochemical Bioreactor Systems; 20050074663 Fuel Cell Electrode; 20050106425 Membrane Free Fuel Cell; 20050123823 Enzyme-Based Photo electrochemical Cell For Electric Current Generation; 20050176131 Structured Material For The Production Of Hydrogen; 20050208343 Membrane less and Mediator less Microbial Fuel Cell; 20050255345 Biofuel Cell; 20050288717 Micro Integrated Cardiac Pacemaker and Distributed Cardiac Pacing System; 20060011491 Bio-Electrochemically Assisted Microbial Reactor That Generates Hydrogen Gas and Methods Of Generating Hydrogen Gas; 20060063043 Electrochemical Methods For Generation Of A Biological Proton Motive Force and Pyridine Nucleotide Cofactor Regeneration; 20060096894 Vacumag Magnetic Separator and Process; 20060118485 Method Of and Apparatus For Converting Biological Materials Into Energy Resources; 20060147763 Upflow Microbial Fuel Cell (Umfc); 20060159981 Biological Fuel Cell and Methods; 20060205029 Device For The Determination Of Glycated Hemoglobin; 20070012620 Method and Apparatus For Recovering Energy From Turbulence Created Within An Aerobic Biological Reactor; 20070042480 Process For Producing Hydrogen; 20070048577 Scalable Microbial Fuel Cell With Fluidic and Stacking Capabilities; 20070059565 Microbial Fuel Cell With Flexible Substrate and Micro-Pillar Structure; 20070063924 Fuel Cell Powered Wireless Network Display Systems; 20070134520 Method and Apparatus Of Generating Electric Power; 20070248850 Biological Fuel Cell and Methods; 20070259216 Substrate-Enhanced Microbial Fuel Cells; 20070259217 Materials and Configurations For Scalable Microbial Fuel Cells; 20070298472 Electrode Compositions and Configurations For Electrochemical Bioreactor Systems; 20080044721 Miniature Biological Fuel Cell That Is Operational Under Physiological Conditions, and Associated Devices and Methods; 20080050637 Micro fabricated Fuel Cell; 20080118782 Miniature Biological Fuel Cell That Is Operational Under Physiological Conditions, and Associated Devices and Methods; 20080123814 Systems, Methods and Apparatus For A Mobile Imaging System Equipped With Fuel Cells; 20080124585 Compositions and Methods For Bioelectricity Production; 20080187975 Process For Rapid Anaerobic Digestion Of Biomass Using Microbes and The Production Of Biofuels Therefrom; 20080213631 Hybrid Power Strip; 20080213632 Light-Powered Microbial Fuel Cells; 20080220292 Microbial Fuel Cells For Oxidation Of Electron Donors; 20080261083 Enhanced Electrical Contact To Microbes In Microbial Fuel Cells; 20080261085 Biological Battery Or Fuel Cell Utilizing Mitochondria; 20080277273 Electrohydrogenic Reactor For Hydrogen Gas Production; 20080286624 Microbial Fuel Cells; 20080292912 Electrodes and Methods For Microbial Fuel Cells; 20080319287 Implantable Power Sources and Sensors; 20080319502 Cardiac Pacing System and Distributed Cardiac Pacing System; 20090017336 Power Generation Device Utilizing Living Plant Nutrients; 20090017512 Apparatus and Methods For The Production Of Ethanol, Hydrogen and Electricity; 20090029198 Influential Fuel Cell Systems Including Effective Cathodes and Use With Remediation Efforts; 20090029198 Influential Fuel Cell Systems Including Effective Cathodes and Use With Remediation Efforts; 20090061267 Power Device and Oxygen Generator; 20090082653 Access Disconnect Detection Using Glucose; 20090087690 Microbial Fuel Cell With Anion Exchange Membrane and Solid Oxide Catalyst; 20090105627 Access Disconnect Detection Using Glucose; 20090137016 Process For Rapid Anaerobic Digestion Of Biomass Using Microbes and The Production Of Biofuels Therefrom; 20090159010 System and Method For Aquaculture Of Marine Life Forms; 20090159455 Bio-Electrochemically Assisted Microbial Reactor That Generates Hydrogen Gas and Methods Of Generating Hydrogen Gas; 20090169924 Biological Fuel Cells With Nano porous Membranes; 20090176300 Method Of and Apparatus For Converting Biological Materials Into Energy Resources; 20090211667 Surface Treatment Method Of Titanium Material For Electrodes; 20090253190 Enhanced Metabolite Generation; 20090297890 Anode For Bioelectric Power Generation and Power Generation Method and Apparatus Utilizing Same; 20090297908 Fuel Cell With Porous Frit Based Composite Proton Exchange Membrane; 20090297913 Nanostructure-Enhanced Stereo-Electrodes For Fuel Cells and Biosensors; 20090305084 Microbial Fuel Cell and Method Of Use; 20090305085 Microbial Fuel Cell and Method Of Use; 20090317882 Electromethanogenic Reactor and Processes For Methane Production; 20090324996 Microbial Fuel Cell and Method; 20090324998 Scalable Microbial Fuel Cell and Method Of Manufacture; 20100003543 Microbial Fuel Cell Stack; 20100013647 Hybrid Power System; 20100040908 Microbial Fuel Cells; 20100059436 Systems and Methods For Microbial Reductive Dechlorination Of Environmental Contaminants; 20100081014 Microbial Fuel Cell Power Systems; 20100092804 Microbial Fuel Cell With Improved Anode; 20100108588 Method Of and Apparatus For Converting Biological Materials Into Energy Resources; 20100112380 Electricity Generation In Single-Chamber Granular Activated Carbon Microbial Fuel Cells Treating Wastewater; 20100119879 Methods and Apparatus For Stimulating and Managing Power From Microbial Fuel Cells; 20100119920 Cathodes For Microbial Electrolysis Cells and Microbial Fuel Cells; 20100124554 Redox-Active Compounds and Related Compounds, Compositions, Methods and Systems; 20100140943 Device For Storage Of Intraluminally Generated Power; 20100140956 Method For Generation Of Power From Intraluminal Pressure Changes; 20100151279 Electrodes and Methods For Microbial Fuel Cells; 20100151356 Fuel Cell and Method For Generating Electric Power; 20100176005 High-Throughput Biological Screening Assay Using Voltage Gradients; 20100176035 Vacumag Magnetic Separator and Process; 20100178530 Microbial Fuel Cell; 20100190039 Device and Method For Converting Light Energy Into Electrical Energy; 20100196742 Electricity Generation Using Phototrophic Microbial Fuel Cells; 20100200495 Microbial Fuel Cell Treatment Of Fuel Process Wastewater; 20100203359 Microbial Fuel Cell Treatment Of Ethanol Fermentation Process Water; 20100203361 Biological Fuel Cell; 20100221830 Device and Method for Ambient Storage of Fresh/Frozen Tissue Sections Via Desiccation; 20100224246 Method and Apparatus For Generating Electrical Power Using Sunlight and Microorganisms; 20100227203 Device Comprising A New Cathode and Method For Generating Electrical Energy With Use Thereof; 20100239920 Multi-Electrode Microbial Fuel Cells and Fuel Cell Systems and Bioreactors With Dynamically Configurable Fluidics; 20100252443 Bioelectrochemical Treatment Of Gaseous Byproducts; 20100266906 Biofuel Battery and Process Of Preparing The Same; 20100270158 Desalination Devices and Methods; 20100279178 Microbial Fuel Cell; 20100297477 Microbial Fuel Cell Cathode Assembly; 20100203361 Biological Fuel Cell; 20100221830 Device and Method for Ambient Storage of Fresh/Frozen Tissue Sections Via Desiccation; 20100224246 Method and Apparatus For Generating Electrical Power Using Sunlight and Microorganisms; 20100227203 Device Comprising A New Cathode and Method For Generating Electrical Energy With Use Thereof; 20100239920 Multi-Electrode Microbial Fuel Cells and Fuel Cell Systems and Bioreactors With Dynamically Configurable Fluidics; 20100252443 Bioelectrochemical Treatment Of Gaseous Byproducts; 20100266906 Biofuel Battery and Process Of Preparing The Same; 20100270158 Desalination Devices and Methods; 20100279178 Microbial Fuel Cell; 20100297477 Microbial Fuel Cell Cathode Assembly; 20100297737 Microbial Fuel Cell; 20100304189 Geobacteraceae Strains and Methods; 20100304226Microbial Fuel Cell; 20100310945 Biological Fuel Cell; 20100330434 Microbial Fuel Cell and Method; 20110020671 Internal-Resistance Measuring Device For Response-Delay Type Fuel Cell; 20110033757 Floating-Type Microbial Fuel Cell; U.S. Pat. No. 3,941,685 Process For Electrostatic Separation Of Pyrite From Crude Coal; U.S. Pat. No. 6,323,451 Particle Separation System Using Parallel Multistage Electrostatic Separators; U.S. Pat. No. 6,927,354 Tribocharging and Electrostatic Separation Of Mixed Electrically Insulating Particles; U.S. Pat. No. 7,163,758 Integrated Plasma Fuel Cell Process; and U.S. Pat. No. 7,681,736 Vacumag Magnetic Separator and Process.

In addition the following references are also incorporated herein by reference: http://www.ncbi.nlm.nih.gov/pmc/articles/PMC150094/pdf/1568.pdf; and http://www.ncbi.nlm.nih.gov/pmc/articles/PMC150094.

Moreover, since the Refugium can grow biologics, and some of those biologics can be bifurcated to separate plates/membranes/substrates/strata, etc., without limitation, and the membranes also serve as anode and/or cathode plates, and the biologics generate electricity in an anaerobic environment, and the environment contains materials such as toxins, volatiles, radioactive material, rare earths, metals, minerals, and the like, the plates, having a porous or non porous configuration, which can be positionally manipulated, and where such pores are also grooves/vents/slats and can open or close based upon user defined perameters—where perameters can be for increasing impingement, flow streams, etc., and where the flow manipulation can aid in absorption of materials in the waste material stream, and where such can also be done to maximize or minimize population viability, or mortality, and can be further utilized to turn hydro/electrical generating turbines, and where such biologics can also be harvested for biofuels, fertilizers, etc, and where the biologics can remove CO2 and other materials from the Carbon fuel Cell and the aperati listed in the U.S. Pat. No. 7,163,758, and where H and O are split off in the fuel Cell and then sent to the Invention Hydro Power Reactor, for water production, and carbon is consumed by biologics, and where the embodiment of the EFSMP processes silicates at 1,500 degrees Celsius and syngas is processed, and a continuous and endless loop of perpetual energy creation and material filtration takes place.

The system configuration is applicable in Cell 9, Cell 14, as well as other Matrix cells that have materials that can be filtered and broken down, and processed in Fuel cells for energy creation.

Now turning to FIG. 14D, a Biological/Microbial Fuel Cell, and other alternative technologies diagram is shown.

In addition, another embodiment of the Waste Water Treatment, Cell 14, will now be described. This embodiment is unaccompanied by drawings, but is not limited by not having such. In this embodiment, the Waste Water Treatment includes: Liquid waste streams are initially reduced and separated by Jet mill processing, Filtration, High velocity colloidal impact and/or Cyclonic jet stream high velocity impact.

Moreover, a particle sizing screen system captures recyclable materials and permanent high power rare earth drum magnets are also included (in tandem, parallel, interlacing, combination or individually). The system also includes magnetic drum and scraper with collection chambers for ferrous metals.

Further, this embodiment includes eddy current drum with scraper and collection chamber for non-ferrous metals, and dry streams are reduced by “impact grinder” or “centrifugal grinder”.

Additionally, the system includes a high velocity processing wheel and material reduction by centrifugal impact.

Furthermore, the system includes magnetic field reduction assist.

Moreover, the materials to be captured and processed include: silicates; carbon, petrocarbon, hydrocarbon, graphite, diamond, rare earths, actinides, minerals, manmade material, synthetic material, fiber, fluff, dust, non-metallic material, alloyed materials, sulphides, oxides, ferrous material & non-ferrous material, and carbonates.

Further, fines and ultra-fines are centrifugally removed by variable or pulsating drum speeds and/or Ultrasound assist.

The system also includes upstream electromagnetic field particle polarization and mid and downstream electric fields, to assist in the separation of contaminants and to desalt filter cakes.

The system also includes final sieving captures any fugitive particles for recycle. Moreover, the waste water reactors are free fall/gravity induced, in a vacuum environment or in a controlled atmosphere.

This embodiment also includes variable pressure ranges and variable thermal transforming media and technology, including: thermal evaporative; steam; gas; chemical; biological; microbiological; microwave; infrared; laser; plasma; convection; cavitation; induction; radiation; solar; ultrasound, sonar, radio wave, oscillation, ultrasonic, ablation; thermal, high pressure shock waves; flame ionization; electrolytic and electro ionization.

### Microbial Fuel Cell

Another embodiment includes a microbial Fuel Cell (see www.microbialfuelcell.org/Publications/WUR/Strik_PAMFC).

This embodiment includes large rectangular double lined tanks, row stacked, micro algae options; mesophilic and thermophilic strains; Chlorella vulgaris (a microalgae); Ulva lactuca (a macroalgae); aqueous 7-9 pH nutrient rich water electrolyte; sterile, anaerobic salts buffer plus 5 mM acetate; round plastic tube reactor packing vertically inserted; graphite cathode and anode (G. sulfurreducens directly connected to the anode); top spray bar computer controlled nutrient. carbon dioxide mix; fiber optic light cables into each plastic tube to convey sunlight; 55 to 60 degree Celsius solution for rapid algae growth; Carbon dioxide bottom tank feed system derived from solid oxide fuel cell.

This embodiment also includes by-products of carbon dioxide, methane, oxygen, water, hydrogen and is synchronized with and integrated into the Electric Arc Hydrogen Plasma Black Reactor and Direct Carbon Fuel Cell system.

Further, Algae provides: fuel for the electric arc hydrogen plasma black reactor; Methane from fermentation for combustion to produce electricity; and oxygen and hydrogen for water production, fuel production (Fischer Tropsch).

In addition, this embodiment can also be used in Cells 1, 9, 14, 22, and 28 without limitation.

### Alternate Biological Fuel Cell

Moreover, when the term Biological Fuel Cell is used, Biological also includes the terms, in addition to that which was provided in Cell 14's explanation of life within a refugium, such things as living, microbe, microbial, bacterial, algae, genetically mutated, genetically altered, genetically engineered, organisms, and the like, without limitation, and where biologics can survive in temperatures of 121 degrees Celsius, and where materials passing through the fuel cell can be at 121 degrees Celsius.

The Biological Fuel Cell membranes can be of such porous configuration as to be: curtains in shape; curtains can be lowered and or raised via crane; or bidirectional hydrogels.

Fuel Cell is also know as, and without limitation, a Flex Fuel type of system, due to the numerous permutations and varieties of fuels used, etc., and since it makes ethanol in carbon plasma arc hydrogen reactor with system integration, such fuel can be used in a separate form of a fuel cell which embodies the same or similar technologies that are presented herein, without limitation.

This embodiment also includes: Cellulose; Nanowater and cellulose; and Wet gels. In addition, this embodiment includes Aerogel (as defined herein).

Moreover, this embodiment includes an aqueous solution that is able to be supercritically dried, which is the basis for porosity in the super structure of the membrane. Catalysts and other material can be added to the aqueous solution (ex: Hydrochloric Acid). Acid Catalysts can be any protic (sic) acid. These basic acid catalysts usually use ammonia, or ammonia buffered with ammonium fluoride, so that more shrinkage can occur, as in microstructural affects, for small pores. Someone of ordinary skill in the art, and without limitation can also advance the state of the art.

The first step of this embodiment is making a wet gel, like the aqueous solution, and the next step is the supercritical drying. In the next step, it is populating the surface membranes and pores with the microbes for growth. Sintering the membranes is another alternative, and can be used in tandem, sequence, and the like, but by not doing so is not a limitation.

This embodiment also includes microbes and algae that are grown in the gel.

Further, porous substrates can be made of Aerogel, silica Aerogel (which is also a silica nanofoam, which is also porous), Chalcogel, x-Aerogel, carbon Aerogel (which includes nanocarbon), alumina Aerogels (aluminum based Aerogels like NASA uses), and SEAgel (similar to Aerogel but made of gar), Aerogel Glass, which is a silica glass Aerogel is also an alternative.

This embodiment also includes Sol Gel and the like are exponentially more surface area, so instead of 1 kilo/1.5 kW, the difference in volume of materials from a typical membrane of a fuel cell, or that of Rankine Cycle Systems (wherever Aerogel, Solgel and the like are used) produces gigawatts, as a pencil eraser (1 cubic cm) size of Solgel, as described earlier with the embodiment of this EFSMP, has the surface area, without limitation, of at last 1 football field, and more, depending upon the material spread.

This embodiment also includes Nano water+chalcogel+hydrocarbon (aka fiber optic) membranes allow for 4 dimensional exposure of organic life to light.

Furthermore, with so many pores, when the effluent passing through the pores are ultrasonically agitated, or microwaved, etc., and the like, or some other form of agitation, undergoes cavitation, and the aqueous heat is generated, and the heat is transferred out and directly into the steam turbines, Megawatts, and Gigawatts of Electricity can be generated. Using vortex technology draws the heat into the turbines.

When the aqueous solution is created, for nano membrane production for the fuel cell substrates, for the supercritical drying, and everything is poured into a mold, that included the fiber optic material, the mold could be convex, without limitation, and the wires are included for heat transfer, with a 4 dimensional wire harness being created, and the wires are either potentially insulated, and the structure for the membrane of porous material to hold the electricity generating algae's and populations thereof, is dried. In the center of the substrate membrane the chalcogel with the substrates around it, which is then populated with microbes, algae's, fungi, and the like. Wires could be gold, or nanogold, and the like, for optimal transferring of heat and electricity, of which the conductors are non toxic.

In this embodiment, a separate chamber after electric gathering, from the microbes is obtained, where Rankin cycle boiler system/s with cavitation (via microwave, ultrasound, ultrasonic, and the like), with chalcogel interior, and where the fuel cell is separate, or attached, and the like, and then take the water after the refugium is processed in the Rankine cycle boiler, and the steam from with the hydrogen plasma arc, and Aerogel, takes the non meltable super substrates, which could attain temperature of 15000 k to 20000 k. Products are high temp steam to drive turbines, water, hydrogen, ethanol, ethanol fuel cell fuel, see FIG. 14C for more details, but are not limited to only those listed.

Further, if user demands require, flow rates and flow streams, etc. can be adjustabed regulated, etc. and the like, if required, in such that the user desires or needs to make more fuel or oil, it is possible to channel the system egress material flows to make more of one product or the other, or balance out product and materials as user demands have been established, but without limitation. For example, and without limitation, it is possible to create huge amounts of electrical power, steam power, hydro power, pumping out JP4, oil, gasoline, diesel, etc.

In this embodiment, Series 121 Microbial Algae is used. However, the Series 121 Microbial Algae is genetically changed to produce electricity as per the enclosed types of flora, fauna, and the like, as is described and found within the Refugium of Cell 14.

Moreover, embrane materials are packed tightly, the hydrogel can share light, electric, and form ribbon like nanomaterials, like curtains, of fiberoptic cable so that the biologics are fully exposed to light for photosynthesis and thus resulting in production of respiration of material, energy, congruence of life, and toxic free emission biodiversity.

Material harvested from the membranes for use in chemicals, fertilizer, vitamins, biofuels, and material as fuel for energy production within the EFSMP.

This embodiment also includes Nano circuitry and the programming intelligence, etc., and the like, that allows for self repair instruction, without limitation to Cell 14, but throughout the EFSMP where user requirements determine that the functionality and integration of such is beneficial. The nanocircuitry is flexible and contains instructions for self repair. The nanocircuitry contains embedded programming and nano regeneration assures perpetuity.

Disclosed are nontoxic hydrogels wherein a polymer matrix can be modified, without limitation, to contain a bifunctional poly(alkylene glycol) molecule covalently bonded to the polymer matrix, and the like. The hydrogels can be cross-linked using, for example, glutaraldehyde or other materials. The hydrogels may also be crosslinked via an interpenetrating network of a photopolymerizable acrylates. Living cells, algae's, microbes, may also be entrained within the hydrogels. The hydrogels may also be modified to carry light so that such light can be used as a food source from within each algae, microbe, living cell, and the like, having 360 degree photosynthetic exposure.

Membrane composites can contain gold, nanogold, nanomaterials, nanoparticles, nanocomposites, nanowhiskers, and the like, without limitation for spreading, distributing, carrying, reflecting, and transmitting light (and its equivalent, and the like), without limitation, as an alternative, tandem, parallel, combination and the like, for fiber optics—solar lights that collect sunlight with curved mirrors and then channel it through the reactor via optical fibers.

The membrane, substrates, gels, and the like can have the following properties: It should be non-toxic, biocompatible, and permeable to moisture and gases to absorb electrolytes, toxins, and the like, as well to maintain any predefined appropriate humidity, gas, effluent, and oxygen levels. It should be porous to prevent swelling of the membrane structure and accumulation of the biologics and the material. It should be flexible and durable.

Hydrogels are three-dimensional networks capable of absorbing copious amounts of water. Hydrogels have been explored for many uses, including drug delivery devices, wound dressing materials, contact lenses, and cell transplantation matrices. Edible hydrogels, such as gelatin, find extensive use in various food-related applications, such as texture modification, gelling, clarification of beers and wines, and as medicine capsules.

Hydrogels comprise a polymer matrix, nanomaterials, nanotubes, nanotechnology, nanosilicates, nanoglass, nanowater, and the like, without limitation, and can also contain gelatin or a synthetic polymer (preferably a biodegradable polymer, although the polymer may also be non-biodegradable), modified to contain bifunctional poly(alkylene glycols) covalently bonded to the polymer matrix. Heterobifunctional, poly-C.sub.1-C.sub.6-poly(alkylene glycol) molecules, preferably poly(ethylene glycol) molecules (hPEGs), each having an .alpha.-terminus and an .omega.-terminus, are bonded to the polymer backbone via covalent bonds involving either of the .alpha.- or .omega.-termini. One or more biofunctional agents are then bonded to the other of the .alpha.- or .omega.-termini (i.e., the free termini) of the hPEGs, thereby yielding a modified, pharmacologically active, homogenous, and covalently-assembled hydrogel.

The novel hydrogel constructs described herein are not limited to physical blends, which are common in the formulation of current biomedical hydrogels; hence, the chemical and physical properties of the subject hydrogels are homogenous and can be tailored to suit any particular end-point requirement, without limitation. Furthermore, the hydrogel constructs are mechanically stable because the components are covalently bonded. In addition, the hydrophilicity and flexibility of the porous hydrogel accommodate the absorption of microbes/biologics/organics, etc, (as defined herein without limitations) and assist the final removal of the material from the electrolyte of the fuel cell (if necessary or desired). The nature of gelatin and the porosity of the construct further facilitate the exchange of gases, light, and electricity, electrolytes, and other material.

The membranes of Cell 14 of the EFSMP of this embodiment herein, are directed to a hydrogel that comprises a polymer matrix. The preferred polymer matrix contains reactive amino groups. The most preferred polymer matrices are gelatin and collagen, but can be any cellulose, or other compound. The polymer matrix is modified using a bifunctional modifier comprising a poly(alkylene glycol) molecule having a substituted or unsubstituted.alpha.-terminus and a substituted or unsubstituted.alpha.-terminus. At least one of the .alpha.- or .omega.-termini is covalently bonded to the polymer matrix. The other terminus projects into the interior of the hydrogel mass and modifies its physico-chemical properties. By controlling the nature of the .alpha.- and .omega.-termini, the physical and chemical qualities of the resulting hydrogel can be altered.

Further, and without limitation, the polymer matrix of the hydrogel may be cross-linked with a cross-linking reagent such as glutaraldehyde, nanomaterials, silicates, and the like. Cross-linking alters the absorption characteristics and material strength of the resulting gel. Thus, cross-linking may be desirable where increased mechanical strength of the gel is required.

Likewise, all of the hydrogels according to the present embodiment may further comprise a pharmacologically-active agent or a living cell entrained within the hydrogel.

A hydrogel comprising: a first polymer matrix; and a bifunctional modifier comprising a poly(alkylene glycol) molecule, nanomaterials, silicate, and the like, without limitation, having a substituted or unsubstituted .alpha.-terminus and a substituted or unsubstituted .omega.-terminus, and wherein at least one of the .alpha.- or .omega.-termini is covalently bonded to the first polymer matrix; whereas the hydrogel's first polymer matrix can be proteinaceous, and wherein the first polymer matrix contains an amino group and wherein at least one of the .alpha.- or .omega.-termini is covalently bonded to the amino group. Further, the hydrogel of the first polymer matrix is selected, without limitation, from the group consisting of gelatin, calcium alginate, calcium/sodium alginate, collagen, oxidized regenerated cellulose, carboxymethylcellulose, amino-modified cellulose, whey protein, and the like.

Also, the hydrogel's first polymer matrix can be selected from the group consisting of gelatin and collagen; and the polymer matrix is cross-linked with a cross-linking reagent, like that of glutaraldehyde, and the like, without limitation.

Any of the biologics, and the like, and without limitation, such as algae, microbes, fungi, rotifers, and the like can be manipulated to exceed thermal temperatures found in hot springs or chemical thermoclines of the ocean where life does exist, as well as to thrive in different effluents, and materials as is user defined for any specific fuel cell.

Over 300 different known living organisms with more being genetically manipulated and engineered every day, by someone of ordinary skill in the art of biogenetics, can be utilized in the biological fuel cell. Currently, as limitations of membrane porosity, and biologics, electricity in the amount and ration of 1 kilo yields 1.5 mW. However, such is not a limitation of this EFSMP, in such that the Aerogel/Chalcogel Porosity of the bidirectional hydrogel membrane/substrate structures are able to accommodate substantially greater surface area.

Potential Products are: Fertilizer; Electricity; Biofuels; Medicines; Cosmetics, (e.g. collagen, restylane, creams, dermal fillers, skin, body and facial aesthetics, implants, prosthetics, etc.) and Pharmaceuticals.

Renewable Energy is a US Government classification of the materials, and processes of the system of this EFSMP as it relates to a Biological Fuel Cell, and the membranes therein.

Membrane, and Bidirectional Hydrogel materials and composites can also be made up (without limitation) of nanotubes, nanoribbons, nanostructures, nanowires tiles, nanowires, nanonets, and the like can be programmed to self repair, and notify/alert the system of damages, and resources, as well as send reports of shelf life and status.

As described above, the membranes of the Biological Fuel Cell can contain, without limitation nano computer circuits, and the like, in which the complexity of computer circuits that can be assembled from synthesized nanometer-scale components, and wherein the components can yield nanoprocessors and other integrated systems.

Nanowire components now demonstrate the reproducibility needed to build functional electronic circuits, and also do so at a size and material complexity difficult to achieve by traditional top-down approaches.

Moreover, the tiled architecture is fully scalable, allowing the assembly of much larger and ever more functional nanoprocessors.

Furthermore, such membranes, without limitation, in so much as artificial photosystems using optical nanomaterials to harvest solar energy that is converted to electrical power, and then the sunlight into electricity and use an electrolyte—a liquid that conducts electricity—to transport electrons and create the current.

The cells contain light-absorbing dyes called chromophores, chlorophyll-like molecules that degrade due to exposure to sunlight.

The membranes in the Biological Fuel Cell, and other Fuel Cells, as described herein, and without limitation, continuously replaces the photo-damaged dyes with new ones, like self-regeneration is done in plants every hour. In the embodiment herein, the biologics as are connected within the membrane structure are symbiotic in that the DNA recognizes the dye molecules, and then the system spontaneously self-assembles. The functionality can be, without limitation, embedded, produced, manufactured, grown, etc., into extruded nanomaterials, nanotubes, and the like, whereas same can be used for, and in, extruded production of piping, and cylindrical, seemless tubing, wherein same is self repairing and is also able to communicate within the monitoring and communication system of the EFSMP within the present embodiment. The extruded material may also have a lattice type of configuration, and the like, without limitation, so as to further assist in its manufacture and or functionality.

When the chromophores are ready to be replaced, they might be removed by using chemical processes or by adding new DNA strands with different nucleotide sequences, kicking off the damaged dye molecules, wherein such acids, etc., are embedded in the composition of the nanomaterial. New chromophores would then be added.

Two elements are critical for the technology to mimic nature's self-repair mechanism: molecular recognition and thermodynamic metastability, or the ability of the system to continuously be dissolved and reassembled.

Without limitation, instead of using biological chromophores, this embodiment uses synthetic ones made of dyes called porphyrins.

As the system contains nanomaterials, the technology of nano, and without limitation, produces and extracts hydrogen.

Coating a lattice of tiny wires called Nanonets with iron oxide (rust) creates an economical and efficient platform for the process of water splitting

By virtue of the increased surface area and improved conductivity of the nano-scale netting made from titanium disilicide, a readily available semiconductor can be created.

Nanonets are highly conductive and offer significant surface area. They serve dual roles as a structural support and an efficient charge collector, allowing for maximum photon-to-charge conversion, and the use of a catalyst can boost the performance of hematite. As such, there is a potential performance of hematite at its fundamental level, without a catalyst. By using this unique Nanonet structure, there is shed a new light on the fundamental performance capabilities of hematite in water splitting.

Biologics that can be genetically mutated, or configured for user defined purposes can be, without limitation, such as, volcanic algae, as they are extremophiles-hardy microbes that can stand the heat, as such are also defined, and without limitation the nomenclature of extremophiles also includes the biologics that like to live in extreme hot or extreme cold.

A newly discovered microscopic creature from the deep sea can survive in heat of up to 266 degrees Fahrenheit, or 121 degrees centigrade—called Strain 121, a iron-breathing microbe, and is included in the definition, without limitation of the biologics found within the refugium, and the Biologic Fuel Cell, and as such, can contribute, by being genetically engineered, or cross bread with other biologics, to be a method for efficiently producing energy, electricity (DC and AC), and other material.

Further, in this embodiment, the Fuel Cell is connected, without limitation, to a method for efficiently producing energy, electricity (DC and AC), and other material like carbon, carbon monoxide, synthetic carbonaceous liquid and gaseous fuels, water, oxygen, vitamins, fertilizer, heat, steam, methane, syngas, carbon dioxide, ethanol, wax, and hydrogen from fossil or biomass fuels with minimal carbon dioxide emissions. The method includes using a combined cycle, and/or combined feed streams, of different batteries of equipments and apperati, that run un tandem, parallel, combination, synchronous, and the like, without limitation, in such as are also defined as an Electric Arc Hydrogen Plasma Black Reactor wherein hydrogen, carbon monoxide, carbon, ash and sulfur are produced and using a Direct Carbon Fuel Cell wherein a molten salt delivers the carbon produced from the reactor as a feedstock in the fuel cell to produce electricity and hot carbon dioxide gas.

Further, all fuel cells, and the like, described herein can be designed to be fuel-flexible and to operate at high temperatures to maximize efficiencies, without limitation.

And where the production of energy, carbon and hydrogen in a combined cycle (but is not limited to such), the method comprising the steps for (a) using an Electric Arc Hydrogen Plasma Black Reactor wherein hydrogen, carbon monoxide, carbon, ash and sulfur are produced and used and wherein the Reactor consumes a carbonaceous fuel; (b) using a Direct Carbon Fuel Cell wherein a molten salt delivers the carbon produced in step (a) as a feedstock and wherein electricity and hot carbon dioxide gas are produced and used; (c) using a Water Gas Shift Reactor wherein the hydrogen, and carbon monoxide produced in step (a) is used and wherein water and carbon dioxide gases from step (d) are used and wherein hydrogen, carbon monoxide and carbon dioxide are produced and used; (d) using a Solid Oxide Fuel Cell wherein hydrogen and carbon monoxide from step (c) are consumed and wherein electricity is produced and used and wherein carbon dioxide gas and water are produced and used; (e) using a Steam Boiler Rankine Cycle (of temperatures to 15,000° Celsius) wherein the hot carbon dioxide gas produced in the Direct Carbon Fuel Cell of step (b) is used, wherein the water and carbon dioxide gas produced in the Solid Oxide Fuel Cell of step (d) is used and wherein steam is produced and used, (f) wherein a Biological Fuel Cell is used to produce the steam and maintain temperature ranges of 55° Celsius to 121° Celsius, with water and steam, and effluent, and the like exiting at the temperatures, without limitation, (g) a steam turbine is used (able to obtain & use materials and steam having reached or exceeded supercritical temperatures, where 2500° Celsius and 4000 psig are obtained, but without limitation; and where a typical range of gas, water, steam, and the like, are passed through and utilized, where as currently safe material ranges of the composite turbine, are within a range of 27° Kelvin to 50° Kelvin of metal temperatures), either in parallel, tandem, hybrid, singularly, and the like, and without limitation, and (h) wherein the steam & gaseous materials have reached supercritical temperatures that can be generated by cavitation (generating heat up to 30,000° Celsius, at 2000 atmospheres) are used; and wherein such types of turbines, without limitation could be (1) Very High Temperature Turbine, (2) Advanced Gas Cooled Turbine, and (3) Ultra Super Critical Pressure Steam Turbine, and wherein a (i) a Rankine Cycle Steam Boiler (with 550-5000° Celcius temperature ranges) is utilized where the cavitation is used to produce and use steam, and (j) a Biological fuel Cell is used, and (k) other types of fuel cells are used, in tandem, parallel, combination, hybrid, and the like without limitation, and whereas all fuel cells use electrolytes, without limitation, and materials from the EFSMP can also be processed and recycled from the functions herein. Wherein the production of energy, carbon, carbon monoxide and hydrogen from a carbonaceous fuel in a combined cycle, the method comprising (a) a step for using an Electric Arc Hydrogen Plasma Black Reactor wherein hydrogen, carbon monoxide, carbon, ash and sulfur are produced and used; and, (b) a step for using a Direct Carbon Fuel Cell wherein a molten salt delivers the carbon produced in step (a) as a feedstock and wherein electricity and hot carbon dioxide gas are produced and used, and where, without limitation, a Water Gas Shift Reactor is used wherein hydrogen, carbon monoxide and carbon dioxide are produced and used. Furthermore, water is produced and used when using a Solid Oxide Fuel Cell wherein electricity is also produced and used and wherein carbon dioxide gas is also produced and used.

The EFSMP further utilizes Integrated technology wherein a Fischer-Tropsch Catalytic Reactor wherein water and gasoline and diesel fuel are produced and used, as well as such apperati as a Methanol Catalytic Converter wherein water and methanol are produced and used; and a Catalytic Methanator wherein water, gaseous methane and C₁ to C₄ hydrocarbons are produced and used; and a Water Electrolyzer wherein hydrogen and oxygen are produced and used.

Furthermore, this embodiment includes, without limitation that hydrodynamic cavitation technology is incorporated herein, an alternative process that creates small-scale materials with unique morphologies. Additionally, and without limitation cavitation is regulated by porosity of gels, and membranes, and as such, the fineness of bubbles, air, gas, and the like, can be regulated by size/surface are and volume speed, etc.

The EFSMP, without limitation can utilize Cavitation also through pores of membrane to generate additional electricity—Ultrasonic Cavitation in Liquids; and wherein Ultrasonic waves of high intensity ultrasound generate cavitation in liquids. Cavitation causes extreme effects locally, such as liquid jets of up to 1000 km/hr, pressures of up to 2000 atm and temperatures of up to 5000° Kelvin, without limitation.

When sonicating liquids at high intensities, the sound waves that propagate into the liquid media result in alternating high-pressure (compression) and low-pressure (rarefaction) cycles, with rates depending on the frequency. During the low-pressure cycle, high-intensity ultrasonic waves create small vacuum bubbles or voids in the liquid. When the bubbles attain a volume at which they can no longer absorb energy, they collapse violently during a high-pressure cycle. This phenomenon is termed cavitation. During the implosion very high temperatures (approx. 5,000° K) and pressures (approx. 2,000 atm) are reached locally. The implosion of the cavitation bubble also results in liquid jets of up to 280 m/s velocity.

Cavitation—“over-unity” is defined as hydrosonic water pump” which operated over-unity by producing hot water or steam with energy in excess of the electrical energy input to the pump motor. Also a vortex heat generator (VHG) can produce more thermal energy out than it electrical energy input in.

Further, the EFSMP cavitation apperati, can be a liquid or water treatment apparatus comprising one or both of an electrodialysis cell and a cavitation unit. The cavitation unit generates cavitation in the liquid by flow of the liquid into a constriction where cavitation bubbles are formed and then to an outlet where cavitation bubbles implode, and the constriction includes an aperture formed by walls which are long and narrowly spaced in a plane normal to the flow direction. The electrodialysis cell is arranged with an inlet flow path for directing only part of a quantity of water to be treated through the electrodialysis cell, and an outlet flow path for returning a product of the electrodialysis cell to the remainder of the water.

As well as the disadvantages of the use of a static tank, ultrasonic cavitation is less effective than other cavitation production methods, in particular hydrodynamic cavitation. This is because the bubble size and cloud density are not as large in cavitation generated by means of ultrasonic exposure compared to the bubble size and cloud density of hydrodynamic cavitation. Thus, hydrodynamic cavitation possesses a higher effective reaction volume compared to ultrasonic cavitation, and is not a limitation of the embodiment herein.

After Cavitation, the cavitated fluid then goes through a system of thermodynamics, such as that of a Rankine Cycle is a cycle that converts heat into work. The heat is supplied externally to a closed loop, which usually uses water. This cycle generates about 80% of all electric power used throughout the world, including virtually all solar thermal, biomass, coal and nuclear power plants. It is named after William John Macquorn Rankine, a Scottish polymath. The Rankine cycle is the fundamental thermodynamic underpinning of the steam engine.

There are four processes in the Rankine cycle, which without limitation, and are included in the embodiment herein, and can be described as:

Process 1-2: The working fluid is pumped from low to high pressure, as the fluid is a liquid at this stage the pump requires little input energy.

Process 2-3: The high pressure liquid enters a boiler where it is heated at constant pressure by an external heat source to become a dry saturated vapor. The input energy required can be easily calculated using [ ] or h-s chart or enthalpy-entropy chart also known as steam tables.

Process 3-4: The dry saturated vapor expands through a turbine, generating power. This decreases the temperature and pressure of the vapor, and some condensation may occur. The output in this process can be easily calculated using the Enthalpy-entropy chart or the steam tables.

Process 4-1: The wet vapor then enters a condenser where it is condensed at a constant pressure to become a saturated liquid.

In an ideal Rankine cycle the pump and turbine would be, i.e., the pump and turbine would generate no entropy and hence maximize the net work output. Processes 1-2 and 3-4 would be more closely resembling such methods used, and without limitation of that of the Carnot cycle. The Rankine cycle prevents the vapor ending up in the superheat region after the expansion in the turbine.

Rankine Cycle with Reheat

In this variation, two turbines work in series. The first accepts vapor from the boiler at high pressure. After the vapor has passed through the first turbine, it re-enters the boiler and is reheated before passing through a second, lower pressure turbine. Among other advantages, this prevents the vapor from condensing during its expansion which can seriously damage the turbine blades, and improves the efficiency of the cycle, as more of the heat flow into the cycle occurs at higher temperature.

In a Regenerative Rankine cycle, the cycle is so named because after emerging from the condenser (possibly as a subcooled liquid) the working fluid is heated by steam tapped from the hot portion of the cycle. Saturated liquid at the same pressure, but different temperatures is also defined herein, and without limitation called “direct contact heating”. The Regenerative Rankine cycle (with minor variants) is commonly used in real power stations.

Another variation is where ‘bleed steam’ from between turbine stages is sent to feedwater heaters to preheat the water on its way from the condenser to the boiler. These heaters do not mix the input steam and condensate, function as an ordinary tubular heat exchanger, and are named “closed feedwater heaters”.

The regenerative features here effectively raise the nominal cycle heat input temperature, by reducing the addition of heat from the boiler/fuel source at the relatively low feedwater temperatures that would exist without regenerative feedwater heating. This improves the efficiency of the cycle, as more of the heat flow into the cycle occurs at higher temperature.

The organic Rankine cycle (ORC) uses an organic fluid such as n-pentane[1] or toluene[2] in place of water and steam. This allows use of lower-temperature heat sources, such as solar ponds, which typically operate at around 70-90° degrees Celsius. The efficiency of the cycle is much lower as a result of the lower temperature range, but this can be worthwhile because of the lower cost involved in gathering heat at this lower temperature. Alternatively, fluids can be used that have boiling points above water, and this may have thermodynamic benefits. As the Biological Fuel Cell generates and or maintains temperatures of 121 degree Celsius, steam turbines, and other thermodynamic apperati can be incorporated therein for the production of electricity, water, hydrogen, oxygen, gas, steam, and the like, without limitation.

Moreover, the Rankine cycle does not restrict the working fluid in its definition, so the inclusion of an “organic” cycle is simply a marketing concept that should not be regarded as a separate thermodynamic cycle.

Further, the Biological Fuel Cell, with or without Cavitation in Rankine Cycle Reactors and Steam Turbines, etc., in a smaller footprint than Industrial usage, can also be utilized in Commercial, Residential, Transportation (Trains, Planes, Automobiles, Boats, Ships, Trucks, Equipment, and the like), manufacturing, construction, emergency, extra-terrestrial (space station, shuttles, satellites, and the like), subterranean, sub sea (submarines, oil rigs, oil platforms, and the like), for perpetually renewable energy.

Further, FIG. 14E illustrates an example of an algae nano curtain, and functional service, maintenance apperati.

### Cell 15: Hydrogen Plant

FIG. 15 illustrates a hydrogen plant 1500 included in the EFSMP according to one embodiment of the present invention, in which water creation is possible, e.g., hydrogen from a coal production process. The hydrogen plant 1500 of the present invention may employ various technologies including advanced water-gas shift technologies, advanced hydrogen separation, development of polishing filters and advanced CO2 separations.

In one embodiment, the EFSMP may incorporate Hydrogen Addition Technology for Catalytic Reforming Unit for Hydrogen Creation.

In another embodiment of this EFSMP, technologies as are utilized in Coal gasification can be employed, whereas, the gasification offers one of the most versatile and clean ways to convert coal into electricity, hydrogen, and other valuable energy products.

For purposes of illustration, by means of example, and included herein, as part of the embodiment of this application, a hydrotreater 1505, a desulfurizer 1510, a chloride guard bed 1515, a zinc oxide drum 1520, a reformer furnace 1530, a steam drum 1535, a shift converter 1540, a Co2 stripper 1545, a cold condenser separator 1550, a hot condenser separator 1555, a pressure swing absorber 1560, a methanator 1565, and a knock out drum 1570.

In the reformer furnace 1530, coal gasification is performed by first reacting coal with oxygen and steam under high pressures and temperatures to form synthesis gas, also known as syngas, a mixture consisting primarily of carbon monoxide and hydrogen. The synthesis gas is cleaned of impurities and the carbon monoxide in the gas mixture is reacted with steam via the water-gas shift reaction by the shift converter 1540 to produce additional hydrogen and carbon dioxide. Syngas is then reused as a fuel for power generation, having been fed into existing facility lines for the piping of syngas, or the syngas is sent for sequestration and further processing into gasolines, as the continuation of the processing of CTL materials, as stated earlier in this application. Hydrogen is removed by a separation system including the Co2 stripper 1545 and the highly concentrated CO2 stream can subsequently be captured and sequestered. Furthermore, the EFSMP could handle the carbon dioxide produced in the hydrogen production process and bifurcate it for further capture, use, and processing by the Nano Plant or use in other technologies now being developed in DOE's Carbon Sequestration Program and eventually demonstrated in other activities by the Office of Clean Coal.

Additionally, rotary reactor sealing systems can be utilized to provide optimal rotary tube furnace atmosphere integrity with minimal gas consumption. And, when such Methane or other gasses, according to U.S. Pat. No. 7,659,437, which is incorporated herein by reference, generates water in an EFSMP wherein an effluent from the coal comprises methane, hydrogen and other gasses and the like, hydrogen derived and separated from the effluent and the methane and the like further comprises a) separating at least part of the hydrogen from the first effluent or b) reacting at least part of the hydrogen from the first effluent with oxygen-containing specie(s) to produce a second effluent having a reduced hydrogen content compared with the first effluent.

Likewise other methods of Hydrogen recovery that are claimed for incorporation would be updated forms of steam reforming, oxidation, pressure swing absorption, membrane recovery, cryogenics, and catalytic hydrotreating, and hydrogen recovery processes. As with this embodiment, production of hydrogen is included herein, wherein the SMP is accomplished by Sintering Zinc, in such a manner that additional Hydrogen is created a as a desired excess byproduct in the creation of Sulfuric Acid in the sintering of the Zinc Ore for such desired purposes. For example, in a Zinc Sulfate solution, from Zinc, the solution must be very pure for electrowinnowing to be at all efficient. Impurities can change the decomposition voltage to where the electrolysis Cell produces mostly Hydrogen instead of Zinc metal.

Since hydrogen is a main element consumed in refineries, for the refining, processing, and breaking down in subatomic useful components of oils, crude oil, acidic crude oil, black oil, coke, heavy oil and gasses, the fuel Cell energy unit EFSMP is a significant process that performs multiple tasks. Steam/methane reforming technologies, supplemented by induced, substantial upward and downward variations in ambient temperatures can help maximize production of Hydrogen gas.

The embodiment herein includes a reactor, either as a standalone unit, a series of units, or a combination of different reactors, and the reactor includes a hydrogen reactor. The reactors in the embodiment herein are pressure vessels in the form of cylinders (horizontal or vertical) or long horizontal tubes. To ensure complete mixing of feed, materials, and the like, including reagents, the reactors can be agitated. Methods of agitation vary; and include the injection of high-pressure steam, mechanical agitation, or rotation of the whole reactor. When used with corrosive media, part of the reactor, or the entire section of the reactor in as much resemble autoclaves are constructed of special steel alloys, advanced ceramics, nanotubes, titanium, and other high-grade materials. In some instances the interior surfaces are lined with glass, quartz, mineral, chemical, rubber or ceramic material.

When additional hydrogen is needed, that which is not produced from the facility's energy plant utilizing fuel Cell technologies, can be collected, for example, in the following manner. A hydrogen plant of EFSMP according to one example embodiment of the present invention will/can be added, where configurations are such that 99.9 percent hydrogen purity is guaranteed, and at the same time, high pressure steam is also created through the use of such technologies as steam/methane reforming. Hydrogen production EFSMP can consist of numerous processing steps. For example, Hydrogen production processing of the EFSMP of the present invention can include: a) feed gas hydrodesulfurization, which can be performed by the desulfurizer 1510; b) steam-methane reforming, which can be performed by the methanator 1565; c) water-gas shift conversion, which can be performed by the shift converter 1540; and d) Hydrogen purification.

### Cell 16: Water Production Plant and Oxygen Plant

FIG. 16 illustrates an oxygen plant 1600 and a water production plant 1600′ included in the EFSMP according to one embodiment of the present invention. The oxygen plant 1600 and the water production plant 1600′ are used for the creation of Oxygen and water, respectively. In one embodiment, the water production plant 1600′ may include a water reactor 1605. Also, in one embodiment, the oxygen plant 1600 may include an air inlet filter 1610, an air compressor 1620, cascade coolers 1630, coil cooler 1640, a moist separator 1650, an oil absorber 1660, a heat exchanger 1670, a condenser 1680, a dryer section 1685, an expansion engine 1690 and a pump 1695. In one embodiment, the EFSMP may be connected to an Air Pump, typically used in the creation of Oxygen (O2) and is mixed together to create water. The water produced by Cell 16 can be used to refine oil, used for sale as a product or used internally to reduce costs. Where necessary, the embodiment of this EFSMP incorporates Hydrogen Addition Technology for Catalytic Reforming Unit for Hydrogen Creation, Production of Syngas where Hydrogen is separated, Oxygenates (Okadura type and Interline), Oxygenate MTBE (Methyl Tertiary Butyl Ether), Oxygenate TAME (Tertiary Amyl Methyl Ether), and the like—regardless of the matrix.

One form of the embodiment of this embodiment proposed is a reactor, and technologies, and equipment, running in stand alone, serial, parallel, combination, hybrid, and the like, whereas, for example, but without limitation a pump that combines hydrogen and oxygen in exhaust into water. The water is produced by taking the hydrogen, which is already present in fuel and/or oil, and combining it with oxygen. For example, water can be produced by the oxidation process of MyOx technologies, where Chemical-looping combustion (CLC) is practiced and is a combustion technology with inherent separation of the greenhouse gas CO2. The technique involves the use of a metal oxide as an oxygen carrier which transfers oxygen from the combustion air to the fuel. Hence the direct contact between fuel and combustion air is avoided. Subsequently, the products from combustion, e.g. carbon dioxide and water, will be kept separate from the rest of the flue gases, e.g. nitrogen and any remaining oxygen or by using a mixed oxidation generator. This generator may use, for example, salt, water and electricity and the like to make the water drinkable.

Also, for example, in order to produce water, the exhaust gas is to be cooled below its dew point by using the cascade coolers 1630, thus initiating condensation. The quantity of water collected is a function of the volume of air treated and the difference between the concentration of water in the exhaust gas and in the cooled saturated exhaust exiting the system. The heat exchanger 1670 is designed based on the calculations and preliminary measurements of temperature and flow of the exhaust gas.

In order to combine hydrogen and oxygen feeds from plant systems to produce water, in one embodiment, the dryer section 1685 can be utilized using the heat from the ESFMP, e.g., a reactor, tilt reactor, autoclave, blast furnace, and the like. Alternatively, other technique, for example, permeation, a distillery or the like can be utilized.

For example, the EFSMP according to the present invention may receive an existing sulfuric acid (or lead acid) from batteries and pass the sulfuric through the EFSMP to refine, recycle, recover, or redistill the sulfuric as necessary. In the EFSMP, H2SO4 can be refined and cleaned by using technologies also found in fuel-Cell technology, where the sulfuric acid is broken down, for refining, cooled off where and if necessary through a series of heat exchangers, cooling towers, cooling EFSMPs, and the like—either in a single pass or multiple passes, and as the H2SO4 passes through the membrane of the fuel cell, Hydrogen (H2) is stripped off, and oxygen (O2) is stripped off, creating energy for the fuel Cell and the adjacent refinery. What remains is pure sulfuric trioxide (SO3). As soon as the SO3 is isolated it can be reconstituted back into H2SO4 simply by adding water (H2O,) where the mixture generates substantial exothermic (heat producing) energy that can be collected to further produce electricity for the refinery (by use of a steam turbine.

### Cell 17: Steel Foundry

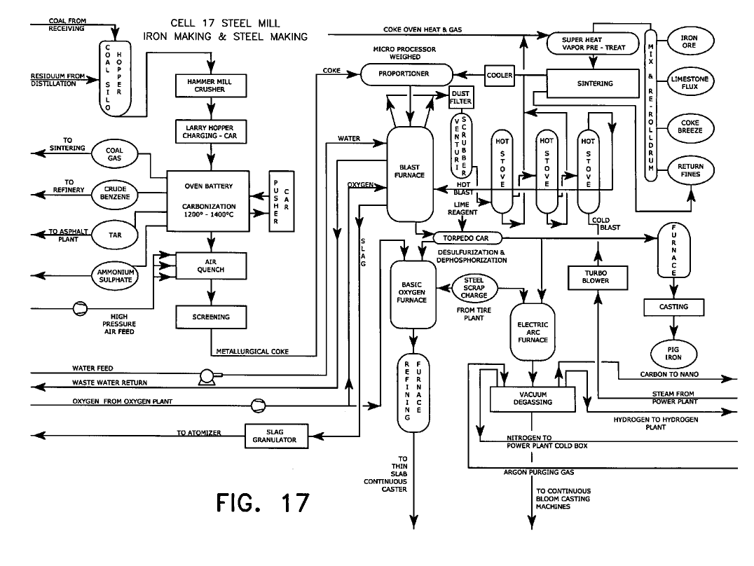

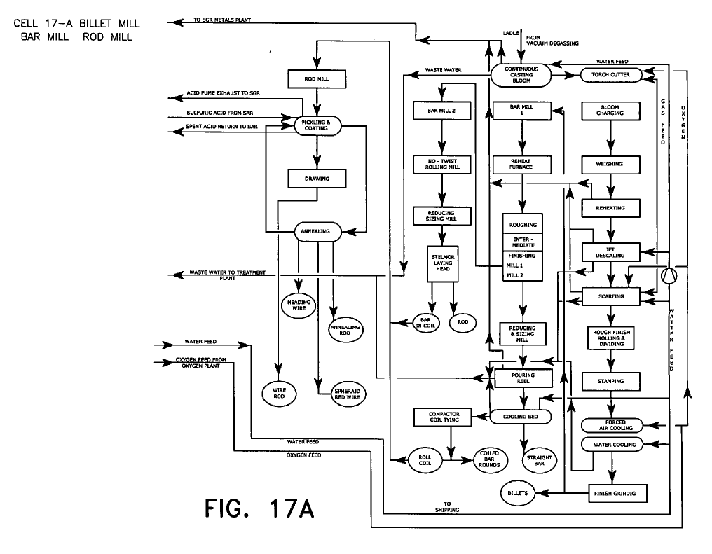

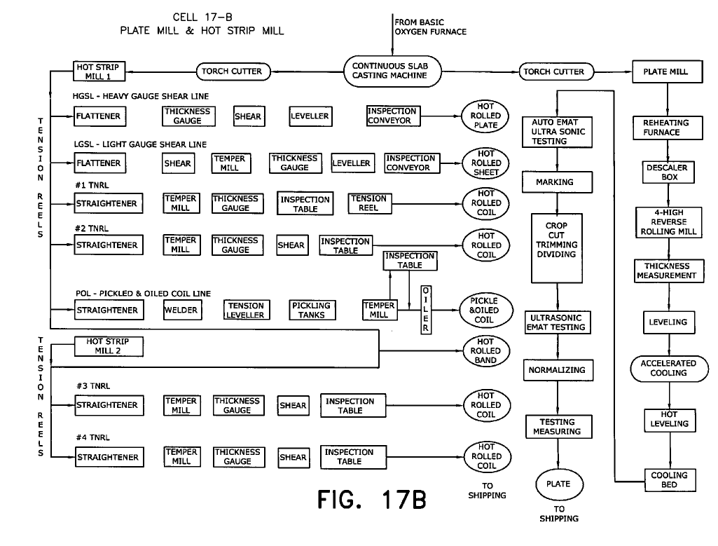

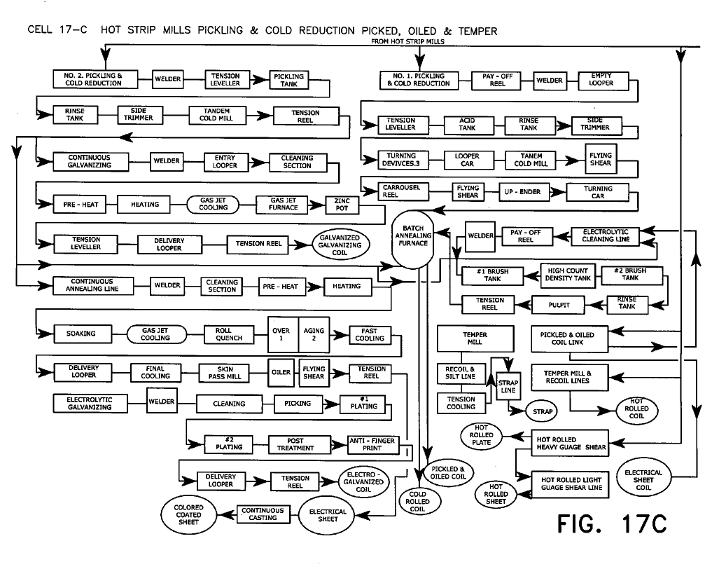

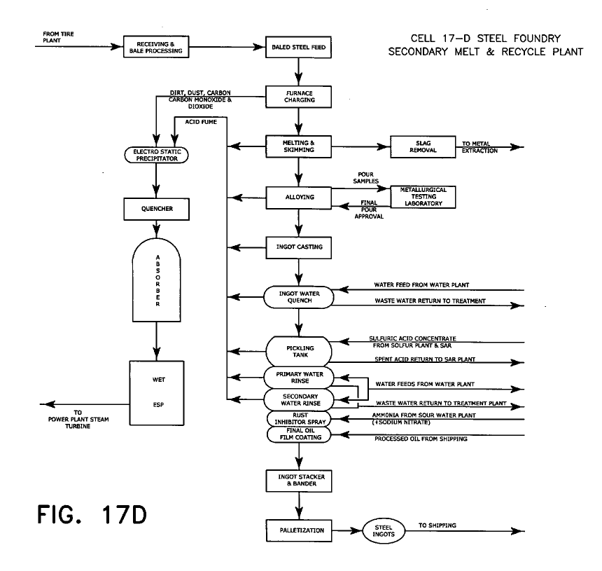

FIG. 17 illustrates a steel foundry 1700 according to one embodiment of the present invention, which is provided to recycle steel components in a mixed waste in various types. The steel foundry 1700 may include an induction melt furnace 1730, an alloying slag removal step 1750, an ingot casting step 1770 and an ingot stacker pelletizer 1790. When steel is separated from used tires and supplied to the induction melt furnace 1730, slag become molten and channeled out of the induction melt furnace 1730 step 1750. The resulting steel is then cast ingot form for reuse step 1770.

A reactor of variable lengths and widths is provided, which is capable of temperatures up to 3500 degrees Celsius, Excellent air flow uniformity, Easy internal access to facilitate maintenance, Coal, Electric or gas fired, Optimal temperature uniformity, Operator isolation from effluent, Highest Energy Efficiency, Fastest line speeds, Thermal Recovery Systems, Surface Treatment Systems, Multiple Sizing Agents, Multiple Electrolyte Solutions, Clean and Hygienic, Non Contact Drying, Flexible System Designs, Unique Gases (e.g. Argon, Nitrogen), Large capacities (multiple muffle systems), Atmosphere Control, Reduced energy costs, Excellent temperature uniformity, with features, not limited to, but can include Multiple temperature control zones, Proven alternating cross flow design, Adjustable louvers and diffuser plates for precise temperature adjustment, Rigid roll stands, Integrated brush roll assemblies, Excellent float end seals for positive sealing, minimized infiltration of ambient atmosphere and improved temperature uniformity, Aluminized steel construction, Plug fans to facilitate maintenance, Carburization resistant muffle, Low profile muffle for gas flow control, Process gas distribution and sampling system, Proven purge chamber gas curtain technology, and the like.

The EFSMP utilizes, as necessary, multiple temperature and atmosphere control zones enable specific temperature versus atmosphere requirements. Multiple temperature control zones as well as control of temperature above and below the load provide optimal temperature uniformity. Modular construction facilitates modification of the Reactor tunnel to accommodate adjustments in process or production rate. As well as functions of Delicate pressure control within the Reactor provides control of the atmosphere flow path in the Reactor facilitating evacuation of volatiles and optimizing atmosphere uniformity. Reactor gas curtain technologies provide zone-to-zone atmosphere definition under specific conditions. Reactor stripping chamber design provides optimal isolation of internal tunnel Reactor chamber environment from ambient as well as efficient purging of ambient atmosphere entrained within the load entering the Reactor without the use of mechanical doors and seals.

The metals from the tires can be sold on the open market as pig iron. Customers could also include the same clientele as the consumers of the lead production that will come from the recycling and removal, and smelting of the lead batteries. Fibers (rayon, nylon) such as those typically found in the tires are usually sold to the textile industry at established exchanges for such commodities. Such fibers can also be used on-site in an EFSMP module that creates composites and ceramic bearings.

In addition, FIG. 17A illustrates a Billet Mill, 17B illustrates a Plate Mill, 17C illustrates a Hot Strips Mill and 17D illustrates a Steel Foundry. The Figures includes both the iron and steel making process.

The Steel Mill serves as a major profit center as it is able to far exceed similar or even identical operation's profitability by full Matrix integration of: internally produced/shared feedstocks all at little or no cost; thermal energy shared efficiency without waste or duplication; advanced composite thermal piping systems with Aerogel blanket insulation; waste heat recovery boiler systems; reactor construction with advanced metals, composites and ceramic high temperature materials; fugitive emissions proofed buildings with advanced air filtration and heat recycle systems; major market location with little or no transportation or middleman costs; carbon emissions capture, containment and conversion into energy; product optimization by ability to produce powdered and advanced metals, composites, ceramics and Nano to order; total optimization of waste stream recovery, recycle harvesting of metals and catalysts; and Standardized equipment and production floor plans for significant buying power savings, replacement parts simplicity and rapid build/future retrofit cycles.

Entering feed stocks include: iron ore and/or pellets from the receiving's covered warehouse via conveyor system delivery; coal from the receiving department via coal storage silo via the hammer mill crusher; residuum oil from the distillation reactor is injected to wet the coal into a non-explosive slurry; water plant supplies the blast furnace water jacket, air coolers, an alternative quench to the air system depicted in the coke process, forming quench tanks and rinse systems; oxygen from the oxygen plant for the basic oxygen and blast furnace ore conversion process; utility air from the power plant for high pressure coke air quenching; steam from the power plant to provide the hot stove cold blast; steel bales from the Tire Plant feed the charge for the basic oxygen and electric arc furnaces; and sulfuric acid for the pickling tanks from the sulfuric acid regeneration plants.

Internally generated and consumed feed stocks include: coal gas from the coke ovens, blast furnace, sintering hearth to fuel the sintering pre-heat; alternatively to provide syngas to the power plant; hot stove oven fuel supply; annealing furnaces fuel supply; reheat furnaces; waste heat boilers; Hydrogen from the vacuum degassing process to the hydrogen plant; nitrogen from the vacuum degassing process to the power plant cold box and gas turbine; carbon from the vacuum degassing process to the Nano plant as a feed stock; excess coke is transported to the Refinery coke plant as a feeds stock; tar from the coke oven battery to the asphalt plant as a feed stock; ammonium sulfate to the Sour Water Plant ammonia sulfide stripper for processing; and crude benzene form the coke oven battery to the Refinery Aromatics processing complex.

Exiting waste streams include: waste water to the waste treatment plant from the blast furnace water jacket, hot stoves, water quench and rinse systems, descalers and cooling towers; slag from the blast furnace to the atomizer for metals extraction and recycle; sulfuric acid (and/or hydrochloric acid) from the pickling tanks to the SGR/SAR Metals Plant for recycle; and syngas from flues, furnaces, heaters, ovens, hearths to the power plant for cleaning and power production.

Some products produced from the mills include: cast iron ingots; steel ingots; galvanized coil and sheet; hot roll sheet, coil and plate; cold roll; electrical steel sheet and coil; color coated coil and sheet; heavy and thin gauge plate; rod, rounds, reinforcing bar and coiled rounds; bar, rail, joist, flats, angles, squares and channels; billets and round billet; seamless tube; and wire-rod.

### Cell 18: Lead Oxide Plant

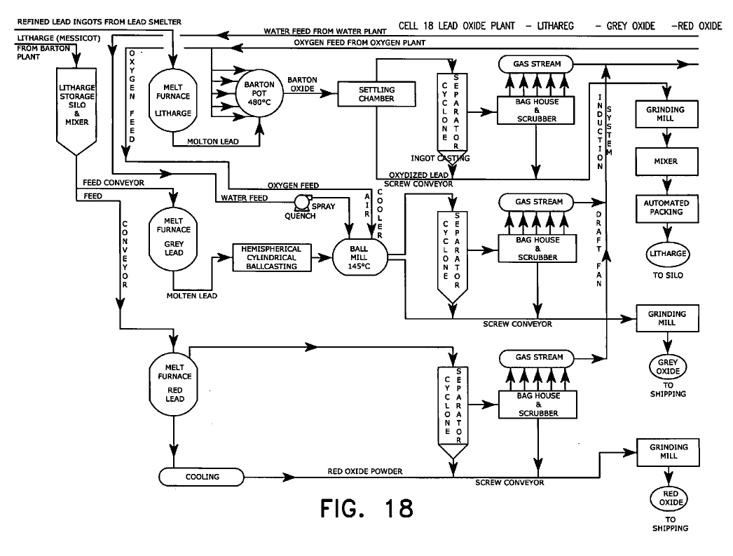

FIG. 18 illustrates a lead oxide plant 1800 according to one embodiment of the present invention. The lead oxide plant 1800 may include a melting furnace 1810, a Barton pot 1820, a settling chamber 1830, a cyclone 1840, a bag house 1850, a ball mill 1860, a red and grey oxide and litherage sort and packing step 1870.

Lead oxide is a general term and can be either lead monoxide or “litharge” (PbO); lead tetroxide or “red lead” (Pb3O4); or black or “gray” oxide which is a mixture of 70 percent lead monoxide and 30 percent metallic lead. In one example embodiment, a Barton pot process is used, which utilizes a cast iron pot with an upper and lower stirrer rotating at different speeds. When molten lead is fed from the melting furnace 1810 into the Barton pot 1820, the molten lead is broken up into droplets by high-speed blades. Heat is supplied initially to develop an operating temperature from 370 to 480 degrees Celsius (698 to 896 degrees Fahrenheit). The exothermic heat from the resulting oxidation of the droplets is usually sufficient to maintain the desired temperature. The oxidized product is swept out of the pot by an air stream. Next, by using the settling chamber 1830 and the cyclone 1840, lead oxides and pigments are collected into the bag house 1850. Low temperature oxidation of lead is accomplished by tumbling slugs of metallic lead in a ball. In addition, mill 1860 is equipped with an air flow.

The EFSMP according to the invention embodiment herein may include, and are not limited to the process Design in Extractive Crystallization of lithium, Lithium Hydroxide, and the like. The smelting of lead involves several elements that are required to reduce the various forms of lead, which is mainly Lead oxide and Lead sulphates, into metallic lead. The elements include the followings: a) a source of carbon, usually in the form of metallurgical, petroleum coke, charcoal; b) energy, mostly available from natural gas, oil or electricity; c) neutralizing agents used to capture sulphur such as caustic, soda ash, or lime; and d) fluxing agents also used to capture sulfur and improve lead recovery.

Frequently, this includes various forms of iron and slag enhancing materials. Additionally, during the lithium battery recycling and processing, which is incorporated in the EFSMP, generally batteries contain toxic heavy metals, such as nickel, cadmium, iron, mercury, and the like. 2nd Mercosur Congress on Chemical Engineering, and the 4th Mercosur Congress on Process Systems Engineering conference, which are well known to those having ordinary skill in the art. However, these technologies are limited in that these technologies are not applied in areas of oil refining, coal processing, nanotechnologies, water production, water resource management, fugitive and volatile gas handling, power generation, metals and metallurgy processing, carbon emissions. Also, these technologies do not address other matrix of technologies outlined herein, in which an overall reactor and other processing as defined in the embodiment herein this EFSMP perform as part of the overall matrix of vertically integrated technologies.

A typical process of the break-down of lead acid batteries, which follows the OSHA standards as set forth in detail, in their entirety may include the following steps: a) refine lead and other metals via thermal metallurgy, and the embodiment herein goes beyond such rudimentary function to utilize infrared (I/R) technology and sintering SMP's to process such materials into a purified state; b) next, cast into ingot form for reuse in batteries and other products; steel components are also recycled for production, whereas the electrolyte and sulfuric acid is treated in such a manner that it chemically reduces to anhydrous sodium sulfate; c) it is then supplied for use in the production of detergents, papers, glass, and for anodizing processes; the lead paste and oxides are de-sulfured with soda ash (recycled from the steel industry,) filtered, and reclaimed as metallic lead (through furnace refraction) for reuse in new batteries; d) then polypropylene, ABS, and other plastics are cleaned, isolated, and sorted for reuse in production; afterwards, grid separators, fiber edonites, and miscellaneous materials are cleaned and combined as reverbatory fuel filler; and e) the remaining slag and industrial detritus are oxidized via high-temperature combustion into low toxicity granules; these are sent to licensed hazardous material disposal fills.

Ingots and the material contained therein may also be derived from other EFSMP modules. Furthermore, subsidiary component materials maybe comprised of pellets, dust, blocks, and/or any other such forms or states as are feasibly and economically marketable (including, but not limited to solid, liquid, gas, and plasma states.) The invention embodiment herein incorporates Super Reactors and processes, similar to that of DuPont in which Sulfuric Acid is filtered, passed through a membrane of solid oxide fuel cells, broken down into Sulfur Oxide, Sulfur Trioxide, and the like, creating energy for local consumption, and then the effluent is then passed into a system where municipal water, filtered water, or on-site created water, is added, thus creating steam and heat, whereas the exothermic reaction is harnessed, as per Pinching Analysis, by steam turbines and the like, the effluent is then reconstituted into Sulfuric Acid, and electricity is created. Any steam from the exothermic reaction is then passed through scrubbers, and then the water is extracted and toxins from sewage streams that run through the waste system toxic to personnel are removed.

Furthermore, metals such as gold, as well other elements categorized in this embodiment, can be extracted from a refractory ore, and petroleum streams using a conventional leaching step or a Super Reactor in which atomization is incorporated with thermal properties. The refractory ore, ores, metals, fluids, plasmas, feed stocks, and the like are also pretreated, when desired, by fine grinding and an initial leaching step, but is not limited to the restriction of such steps as to viability. Oxygen, also defined as gas, air, enhanced air, enhanced gasses, and the like, and is either individually or combined in any form, or in any pressure, or not under any pressure, is added to the initial leaching step and the conditions are carefully controlled to only partially oxidize the ground ore. Any step of the EFSMP can be carried out at any temperature or atmospheric pressures without limitation or restriction. Methods for EFSMP Thermal Conversion Atomization Reactor of processing metals, for example but are not limited to such metals as aluminum, copper, zinc, lead, gold, silver, include, High Flux Heaters, sintering, and/or the like powder comprise technologies such as, but are not limited to, atomization, electrowinning (see U.S. Pat. No. 6,558,527, and incorporated herein by reference), Isothermal Melting Processes (ITM), decoating metals using indirect-fired controlled atmosphere (IDEX) kilns, and the like, as well as, either in tandem, hybrid, parallel, or stand alone, in such that providing powder and heating the powder in a nitrogen, or other gas, atmosphere containing a partial pressure of water vapor. The aluminum, copper, zinc, lead, gold, silver, and/or the like powder is not pressed together by a mechanical force that substantially deforms particles of the powder either prior to or during the step of heating.

As part of the baseline feed stock introductory process (at a point where it will be possible to control the nature of the feed stock—taken from any of the above materials) used in the EFSMP, a desalting entry point is likely, as well as a hydrotreating point in which hydroconversion EFSMPs occur and/or where necessary, but not exclusively, and in any combination thereof, also include Hydrotreaters, of which, in principle, at least three reactions are taking place, but not all three at the same time, or in unison/tandem, or in hybrid form, at that site: hydro-demetallisation, hydrotreating/hydrogenation and hydrocracking Removal of the metals from the residue feed predominantly occurs in the first reactor(s) and uses a low activity Co/Mo catalyst. Hydrotreating, hydrogenation and hydrocracking occur in the following reactor(s) where the quality is mainly improved by increasing the hydrogen-to-carbon ratio.

Furthermore, such practices those used for, and in, but not limited to, and used either individually, or in combination, as part of the matrix of technologies described herein as those such those found in a electrolytic lead refinery, electro ceramics, Isamelting, slag fumers, slag fuming, as well as incorporating UV radiation, UV light, crucible furnace processing, ore roasting processes, drossing, CDF drossing, flash smelting, Smelting Matte, bartonpot process, and Ball Mills, where Ball Mill—important for producing lead oxides, and the like. Furthermore, incorporated hereinto is the reactor and EFSMP, Blast Furnace and those using Paddle Mixer—the present embodiment of this invention can use the spent oil, from the mixer, for a feed stock, wherein the effluent from this mixes with Coke, and the like, limestone, slag, and then liquid oxygen gets mixed in for super heating then onto the Isamelt for processing. The slag and dross go into sintering, then into matte, then back into sintering, and the matte is ladled for further processing, as well as other uses to be, and that have been, described herein the EFSMP.

### Cell 19: Aluminum Smelter

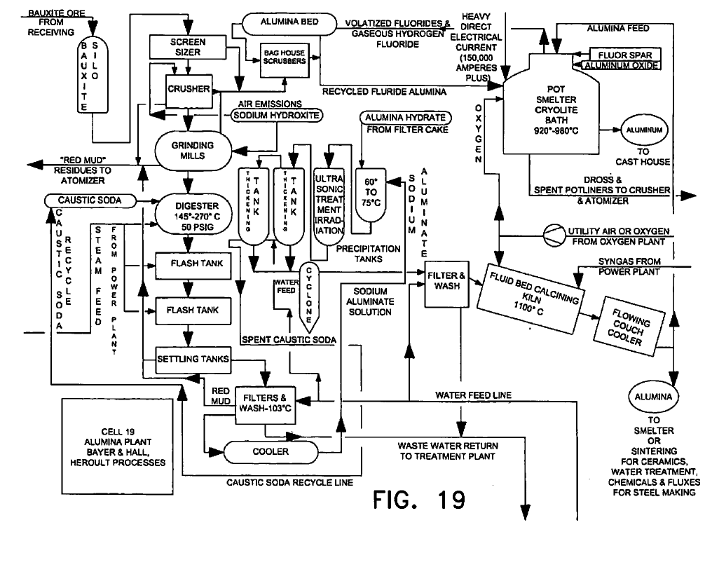

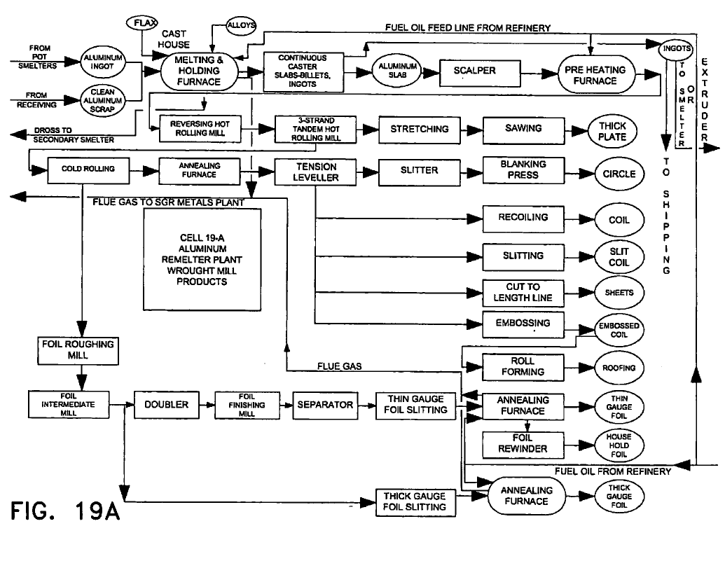

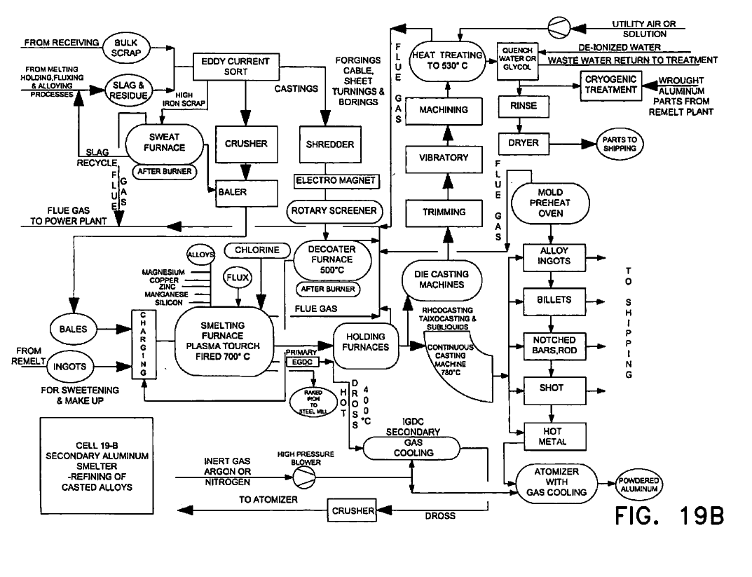

FIG. 19 illustrates an aluminum smelter 1900 included in the EFSMP according to one embodiment of the present invention. The aluminum smelter 1900 may include an IDEX decoater furnace 1905, a sweat furnace 1910, a cyclone 1911, a burner 1913, a fume cooler 1915, a bag house 1917, a smelting furnace 1920, an alloying step 1930, skimmings 1940, dross 1942, a salt slag processor 1944 and an ingot casting step 1950. According to one example embodiment of the present invention, metals are decoated by using the indirect-fired controlled atmosphere (IDEX) decoater furnace 1905. The decoated metals are then processed in the sweat furnace 1910, which is designed for selectively melting and separating aluminum from mixed metal scrap. The molten aluminum is transferred to an alloying furnace to be mixed with desired alloys to obtain specific characteristics (step 1930). Then the alloyed aluminum is cast into ingots for transport to, for example, fabricating shops (step 1950). Meanwhile, in addition to scrap, the dross 1942, which is a by-product of primary aluminum melting, can be used in the aluminum plant. The dross is crushed, screened and melted in a rotary furnace where the molten aluminum is collected in the bottom. The resulting salt slag, which is a waste product, is processed by the salt slag processor 1964.

A method for obtaining, metal, gold, silver, lead, zinc, nickel, copper, in different forms of purity is provided. In a non-limiting example oxygen, or enriched air, or air, or any other gas, is blown onto a melt, in a melting furnace (or reactor as defined herein) lined with refractory material, having a waste heat boiler set onto it, in order to oxidize contaminants, or change its form for collection, is contained in the melt and thereby remove them from the melt, and wherein a splash protection device through which fluid flows is provided above the ore melt, or metal melt, or (metal being defined as any element found in the Periodic Table, such as iron, carbon, gold, silver, copper, platinum, zinc, lead, and the like) on the inside wall of the melting furnace, which prevents copper, and the like, that splashes out of the melt (comprising any of the metals listed in the embodiment herein, either individually or in combination, regardless of the level of purity or impurity) from penetrating into the waste heat boiler. Boiling water, plasma, or any other fluid, or gas, is used for cooling the splash protection device, protection device.

The blister copper, zinc, lead, gold, silver, and/or the like is transferred from the converting furnace, preferably through a CBT, or Rotary Tilt Furnace to a holding furnace. The primary purpose of this furnace is to provide scheduling flexibility to the overall smelting process, e.g. to provide a location for the accumulation of molten blister if the anode furnaces cannot accept it for any reason directly from the converter. However in certain embodiments of this invention, the holding furnace can be adapted to not only hold the molten blister, but also to further process it prior to its introduction into an anode furnace.

In an example embodiment, two rotating anode furnaces are located proximate to the converting or holding furnace and are sized to accommodate the output from the converting and/or holding furnace. These furnaces, also known as thermal conversion super reactors, atomization reactors, and also known herein as super reactors, hearths, furnaces, kiln's, autoclaves, and the like, are typically of conventional design and operation, and are used in tandem with one another such that while one is in operation, or as is the case may be in this example, is fire-refining the blister to anode copper, zinc, lead, gold, silver, and/or the like, the other is filling—if tandem/parallel/combination reactors are indeed needed. The output from the anode furnaces is transferred to an anode casting device (of any conventional design) on which the anodes are formed and subsequently removed to electrolytic refining.

In another embodiment, a single anode furnace, either rotating or nonrotating, is located proximate to the converting or holding furnace, as the case may be, and is sized to accommodate the output from the converting and/or holding furnace. This nonrotating furnace can be of any suitable configuration, and consists of an oxidation zone and a reduction zone. These zones are separated by any conventional means, e.g. a dam or baffle, but are otherwise in fluid communication with one another such that the oxidized blister can move freely and continually from the oxidation zone to the reduction zone.

Methods for EFSMP Thermal Conversion Atomization Reactor of processing metals, for example but are not limited to such metals as aluminum, copper, zinc, lead, gold, silver, include, High Flux Heaters, sintering, and/or the like powder comprise technologies such as, but are not limited to, atomization, electrowinning (see U.S. Pat. No. 6,558,527, and incorporated herein by reference), Isothermal Melting Processes (ITM), decoating metals using indirect-fired controlled atmosphere (IDEX) kilns, and the like, as well as, either in tandem, hybrid, parallel, or stand alone, in such that providing powder and heating the powder in a nitrogen, or other gas, atmosphere containing a partial pressure of water vapor. The aluminum, copper, zinc, lead, gold, silver, and/or the like powder is not pressed together by a mechanical force that substantially deforms particles of the powder either prior to or during the step of heating.

The microstructure of the sintered aluminum, copper, zinc, lead, gold, silver, and/or the like powder contains no compositional concentration gradients indicative of the use of a sintering aid and no evidence of particle deformation having occurred by an application of a mechanical force prior to or during the sintering of the powder. Additionally, in a controlled atmosphere environment, as envisioned, and incorporated herein, such technologies are incorporated for Oxidizing, and Reducing of Solids, Metals, Gasses, Plasmas, Liquids, and the like, and whereas such Purity Control Monitoring and other methods, but not limited to that of, multiple atmospheres (in difference chambers of a Reactor, or in Parallel, Tandem, Hybrid configurations) exist. Such technology can also be used for Corrosive Atmosphere, Fugitive Gas, and Toxic Effluent manipulation.

With regard to waste water treatment, via processes such as desouring, the embodiment herein also includes an EFSMP Thermal Atomization Reactor using dissolved air flotation, venturi, protein skimmers, biological, optical, chemical, physical, mechanical, thermal, and waste recovery. Additionally, such filtration systems, such as Venturi system with a Protein Skimmer attached, in some embodiments, the intake of the Venturi System can be hooked up to utilize more than just air, and utilize gasses, other liquids, solids, metals, plasmas and the like. Metals for example, could be such as those of Aluminum (in various states), and or other chemicals, wherein if the feed is not directly from an aluminum source, the feed line could be come from the aluminum derived from the lubricant feed that enters into the EFSMP.

As part of the baseline feed stock introductory process (at a point where it will be possible to control the nature of the feed stock—taken from any of the above materials) used in the EFSMP, a desalting entry point is likely, as well as a hydrotreating point in which hydroconversion EFSMPs occur and/or where necessary, but not exclusively, and in any combination thereof, also include Hydrotreaters, of which, in principle, at least three reactions are taking place, but not all three at the same time, or in unison/tandem, or in hybrid form, at that site: hydro-demetallisation, hydrotreating/hydrogenation and hydrocracking Removal of the metals from the residue feed predominantly occurs in the first reactor(s) and uses a low activity Co/Mo catalyst. Hydrotreating, hydrogenation and hydrocracking occur in the following reactor(s) where the quality is mainly improved by increasing the hydrogen-to-carbon ratio.

FIG. 19A illustrates another embodiment of the Alumina Plant.

Matrix Importance: The Alumina Plant has been integrated into the Matrix as it is: a) a major raw material for the world's new and existing super powers escalating alumina/aluminum product demands; b) it economically serves as a major Matrix feedstock consumer of internally processed coal pitch, petroleum coke, fuel cell DC electric power and water; and c) it also internally produces alumina to spec for Matrix manufacturing advanced ceramics, carbon fiber and Nano composites.

Its Matrix integration depends on the cost effective advantages of proximity to Bauxite ore mines (Australia, China, Russia, North America, Jamaica, Brazil, Venezuela and Europe) and major consuming markets (China, India, Brazil, the United States and Europe). Permanent primary and secondary job creation is significant especially in the transportation (automotive, aerospace, marine and defense) and consumer markets (see list below). Recycling from the secondary smelting Plant creates a growing, perpetual locally looped cycle by combining new aluminum into locally made products and recycled back into the community. The Matrix's gas purification system allows the alumina processing to be re-established in the United States as it is EPA and OSHA compliant.

Process: Bauxite ore refining is a continuous process using the Bayer Process of milling, digestation, settling, filtration, precipitation, filtration, calcination and final cooling to produce pure alumina. The digester operates at 50 lb. psi and at a temperature range of 145 degrees to 270 degrees Celsius. The calcinator is heated to 1100 degrees Celsius and utilizes a fluid bed calcination system where particles are suspended above a screen by forced air. It takes 4 lbs. of bauxite to make 1 lb. of aluminum and a half pound of carbon for each pound of aluminum.

The alumina is then processed into aluminum using the Hall-Heroult Process using a battery of lines of Pot Smelters with carbon lining, heated cryolyte electrolyte solution and high voltage DC current range between 150,000 to 230,000 amps. The reduction process operates at a temperature between 960 and 970 degrees Celsius.

Not pictured is the spent pot hammer mill and wash tank, coke and pitch silos, the Green Anode shop which produces the carbon Pot replacement liners and the Rodding Shop which manufactures and assembles both the carbon anodes, copper and steel electrical bus-bar system also for the Pot Smelters. High temperature ovens are used to bake the carbon linings to form and for final heat treating.

Feeds to the Green Anode Shop include petroleum coke from the Refinery Delayed Coke Plant, carbon from either, the Pyrolysis Plant, Nano Graphite or Atomizer Plants, copper from the copper smelter.

Feed Steams: Bauxite ore from the Receiving Plant, water from the Water Plant, Oxygen from the Oxygen Plant, DC power (power accounts for ⅓ total cost of smelting aluminum), utility air, steam and syngas all from the Power Plant, carbon from the Atomizer, Nano Graphite Plant or Pyrolysis Plant and recycled copper from the atomizer or direct from the Copper Plant.

Waste Streams Include: sand, iron, titanium, caustic soda (sodium hydroxide), etc., collectively called “Red Mud” which is forwarded to the atomizer for metals and caustic soda recycle, waste water for waste treatment plant recycle, gas emissions are forwarded after passing through the aluminum bed filtration system to the power plant for syngas processing, carbon pot liners are sent to hammer mill then to the Green Anode shop, dross is forwarded from the hammer mill to the atomizer for metals recycle.

Products derived include, but are not limited to, Alumina (alumina oxide) of which about 10% is sold or utilized internally for Matrix advanced ceramics, Nano and advanced carbon composite manufacturing. Alumina is the most comprehensive engineered machining ceramic because of its high temperature capabilities electrical, chemical, and mechanical properties and relative low cost. Outside buyers of alumina use it for the manufacture of water treatment chemicals such as aluminum sulphate, Poly Aluminum Chloride and sodium aluminate. Large tonnages are also used in the manufacture of zeolites, coating titania pigments and as a fire retardants/smoke suppressant. The major uses of specialty aluminum oxides are in refractories, ceramics, polishing and abrasive applications. Minor uses include use in toothpaste formulations, and as a medium for chromatography. Aluminum oxide is also used in preparation of coating suspensions in compact fluorescent lamps. Al2O3 is also used in fluoride water filters. It is one of the few methods available to filter water soluble fluorides out of water. Commercial uses Because of aluminum oxide's position on the Mohs scale of mineral hardness, (9), it is very widely used as an abrasive as a significantly less expensive replacement for industrial diamonds. Many types of sandpaper use aluminum oxide crystals. In addition, its low heat retention and specific heat makes it widely used in almost all grinding operations, particularly cutoff tools. Alumina is also the byproduct of hydrogen generation for the purposes of fuel generation when water is added to pellets comprised of aluminum and gallium. The other byproduct of the reaction is gallium.

The cost effective recycling of aluminum mirrors that of liquefied coal, spent oil, tire and battery conversion to oil—the more brought into a major market from foreign sources and recycle it locally, the greater that market's reserve of raw materials will become and the less dependent on foreign sources that country will be.

FIG. 19B illustrates a Secondary Aluminum Smelter, which processes spent “cast aluminum” also known as dirty scrap derived from a mix of internally produced dross and outside sourced spent aluminum products collected for recycle.

In addition, a method to distinguish the difference between the remelt and the secondary smelting operation is that in Cell 19A, wrought aluminum products are fabricated from first run alumina ingots and “clean” or “new” scrap from OEM by hot working (mainly a rolling or an extrusion process) which is normally followed by cold working and /or finishing operations.

In Cell 19B, aluminum castings are manufactured by the solidification of recycled cast products returned to a molten metal, followed by cast refining, forming and finishing operations. Typical bulk recycled items include aluminum automotive transmission housings, engine blocks, vehicle and aircraft bodies, construction materials, appliances and soda cans amongst many others.

The electrical power originally utilized to produce these spent aluminum products from raw ore is called an “energy bank” in that once the energy has been “invested” in it through the ore smelting process it can be effectively drawn upon again and again through recycling. Aluminum recovery from scrap requires only about five percent of the energy required to originally extract it therefore, secondary aluminum production from recycling scrap has the potential to significantly reduce greenhouse gas emissions.

Aluminum can be recycled over and over again without loss of properties. The high value of aluminum scrap is a key incentive and major economic impetus for recycling.

The following European web site is a good reference: http://eaa.net/upl/4/en/doc/EAA_Environmental_profile_report_May08.pdf.

End products. Aluminum is primarily used to produce pistons, engine and body parts for cars and aircraft, beverage cans, doors, siding and aluminum foil. It may also be used as sheet metal, aluminum plate and foil, rods, bars and wire, aircraft components, windows and door frames. The leading users of aluminum include the container and packaging industry, the transportation industry, the defense industry and the building and construction industry.

In addition, the remelt plant depicted in FIG. 19A focuses on plate, sheet, foil, bars, or rods in addition to ingots all derived from the Alumina Smelter's final pot smelter processing.

The rolling mill equipment allows rod to be drawn into wire which is stranded into cable for electrical transmission lines. Presses extrude the ingots into hundreds of different useful and decorative forms, or fabricating plants may make them into large structural shapes for a multitude of construction products.

This unit process begins with the processing of molten primary aluminum and ends with the output of sheet ingot suitable for rolling, extruding, or shape casting. The various operations carried out with this embodiment include: Pretreatment of hot metal (cleaning and auxiliary heating); Recovery and handling of internal process scrap; Batching, metal treatment, and casting operations; Homogenizing, sawing, and packaging and casting operations; Maintenance and repair of plant and equipment; and Treatment of process air, liquids, and solids.

The secondary smelter depicted in FIG. 19B produces billet and ingots in addition to manufacturing alloys, pastes, powders and or flakes. Both the Matrix and other aluminum die casters, foundries and extruders use the recycled aluminum ingots and billets to form a multitude of various shapes and sizes depending on their end use.

Methods to remove specific impurities such as Mg, Fe, Pb, Li, Si, and Ti to produce high-quality metal from mixed scrap include pre-separation, skimming and separation catalysts. Iron rakings removed from the smelting furnace are forwarded to the steel mill for recycle, is included in the embodiment herein, without limitation.

Depending on the application, metal is then processed through an inline filter to remove any oxides that may have formed. Subsequently, metal is cast into ingots in a variety of methods: open molds (typically for remelt ingots), through direct chill molds for various fabrication shapes, electromagnetic molds for some sheet ingots, and through continuous casters for aluminum coil.

The importance to the Matrix is that the plant provides; a total vertical integration and optimization of feedstocks, a depth and breadth of profitable products to meet escalating market demands, a significant regional source of primary and secondary jobs created, and national independence from foreign imports.

Feedstock coming into Cell 19B includes; alumina from the pot smelter in Cell 19, bulk scrap from the receiving plant, slag from Cell 19 and 19A, aluminum ingots from Cell 19A, utility air from the power plant, deioninzed and treated water from the water treatment plant, inert gas from the power plant and electric power from the power plant.

Exiting waste streams include: waste water from the water quench and rinse tanks, dross to the atomizer for metals extraction and recycle, flue gas from the furnaces, holding ovens, casting machines and powdered aluminum atomizer sent to the power plant for syngas production. The slag contains chlorides, fluxes and magnesium all of which are recycled for use. Products produced include: powdered aluminum for further production with advanced ceramics, Nano composites, graphite and advanced carbon fiber final products, alloyed ingots, billets, notched bar, rod, shot, die cast products and cryogenic treated products for the aerospace, defense, consumer, automotive and pharmaceutical industries.

Competitive advantages include: scale of economy, logistics for rapid cycle time and quick response to regional market needs (made-in-market for market and recycled back into the market), low cost power, feedstocks produced in house, efficient use of resources and energy, reduction of emissions to air and water, reduction of waste and high recycling rates at the end of the product life-cycle.

The addition of a plasma torch to the smelting furnace eliminates the need for salt fluxes, it reduces emissions and allows for maximum aluminum to be recovered with a fast cycle time. The after burners on the sweat furnaces and decoater furnaces greatly reduce air emissions by combusting oil and grease as the furnace or kilns heat source (about a 56% savings) while destroying any volatile organics at the same time. Hot gases are continuously recirculated back into the furnace to optimize thermal efficiencies.

Emissions. The most significant emissions resulting from the aluminum recycling process are emissions released into the air. These include dust and smoke, metal compounds, organic materials, nitrogen oxides, sulfur dioxides and chlorides. State-of-the-art technology is used, within the embodiment of this EFSMP, to extract fumes and other emissions and to reduce fugitive emissions. The limits for dioxin emissions are very strict, in the range of <0.1-1 ng/Nm3.

North American and European refiners and remelters are equipped with state-of-the-art air filter equipment to clean exhaust gases of dust, acidic gases (HCl, HF, SO2), volatile organic carbon, dioxins, and furans. The Transtar Chalcogel filtration system will enable all emissions to be captured, contained, filtered and useful contaminants extracted for recycle.

### Cell 20: Copper Smelter

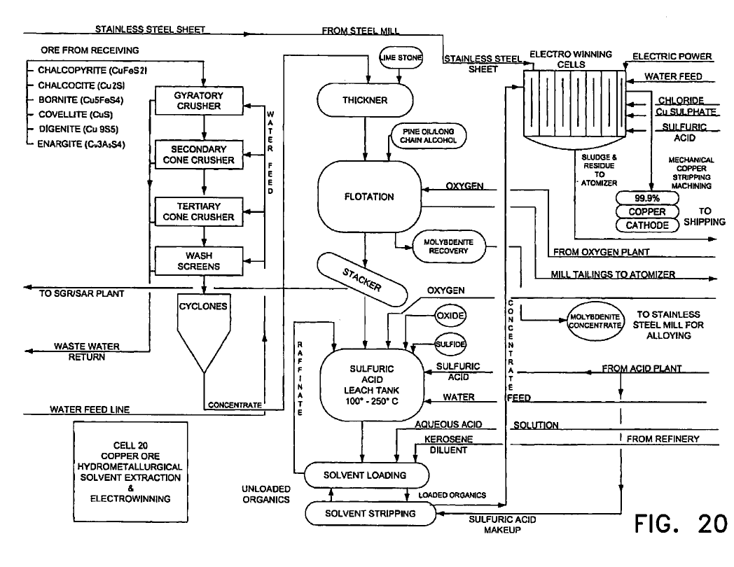

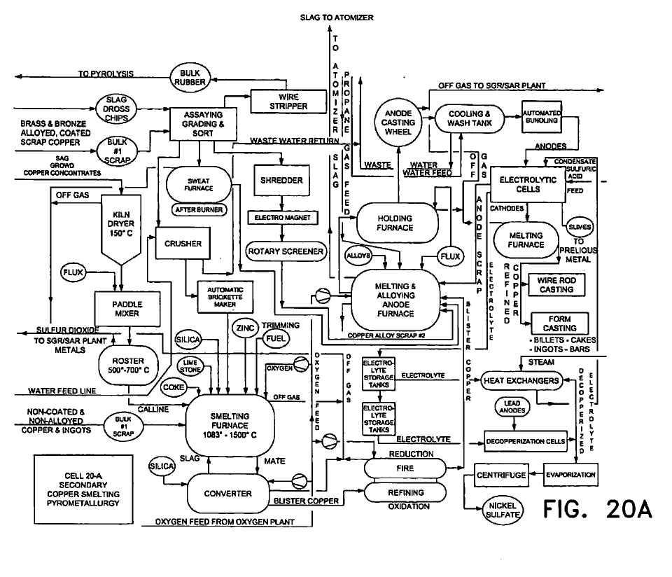

FIG. 20 illustrates a copper smelter 2000 included in the EFSMP according to one embodiment of the present invention. The copper smelter 2000 may include a reverberatory smelter 2010, electrostatic precipitators 2012, a pelletizing step 2016, a converting step 2020, an anode refining step 2025, an anode casting step 2030, an electrorefining 2040, drying 2045, slimes treatment 2050, tellurium recovery 2055 and a TBRC Kaldo smelting 2060.

Copper scrap or copper concentrates are supplied to the reverberatory smelter 2010, where the copper scrap or copper concentrates are partially oxidized and melted, resulting in segregated layers. A matte layer refers to an iron-copper sulfide mixture which sinks to the bottom and wherein a slag, which is remaining impurities, floats on top of the matte. The matte is recovered and moved to the converter, a cylindrical vessel into which the copper is poured (step 2020). The slag is removed and recycled back into the reverberatory smelter 2010. Sulfur dioxide is usually captured through electrostatic precipitation by using the electrostatic precipitators 2012. Once captured, the sulfur dioxide is converted into sulfuric acid and sold or reused in process. Air and natural gas are blown through the copper to remove any remaining sulfur and oxygen. The copper is cast into copper anodes and placed in an electrolytic cell. Once charged, the pure copper collects on the cathode and is removed as 99% pure (step 2025, step 2030). Anode slime, which refers to impurities that sink to the bottom of the electrolytic cell, is dried and transported for slimes treatment (step 2045, 2050). Electrolytic refining procedures also produce some liquid waste. This waste is usually sent to waste water treatment facilities and discharged and/or recycled.

According to one embodiment, provided is a matrix of Metallurgical, Mining, Smelting, and Refining technologies for ores, and ore products, in the form of Super Reactors, and Reactors, as described herein, of which is typically found in significant metal ore refining operations such as Nyrstar and Smelting, such systems, methods, and processes (SMP's) metallurgy and foundry, and blast furnaces, Imperial Sintering Plants, Autoclaves, and the like, in which they all independently process ore and ore bodies, this embodiment proposes the same, in combination, hybrid form, “daisy chained”, connected, and the like, for processing metals and ores, as well as those feeds that are described in the embodiment herein for feed stocks such as petroleum, crude oil, and the like, that employ such SMP's as this embodiment utilizes such as pyrometallurgical processes, hydrometallurgical or electrolytic processes, metal recovery, convection ovens, roasting, individually or in combination with any combination with electrolysis, but not limited to using either method, and either individually or in combination, or as a hybrid of an electrolytic process, also called the Roast-Leach-Electrowin (‘RLE’) process, since it has various advantages over the pyrometallurgical process (overall more energy-efficient, higher recovery rates, easier to automate hence higher productivity, etc.). for such materials used for feed stock, either solid, liquid, gas, gel, or plasma, regardless of their individual component, or combination therein of the Periodic Table of Elements, such as zinc is found within the same ore as lead, copper, silver, and gold, and the like, as well as crude oil, coal, and synthetic oil, also contain lead, and the like, and whereas, the embodiment herein could also be utilizing such efficiencies of an exothermic (and/or endothermic) autoclave leach process, where autoclave as a combination of the EFSMP described herein includes such definitions as sintering furnaces, blast furnaces, smelting furnaces, roasters, Infrared, Ultraviolet, laser, Nuclear, Microwave, and the like, and were as the EFSMP is enhanced by increasing the retention time of the solids fraction in the feed slurry over that of a liquid fraction. This is achieved by flashing the contents of the first oxidative autoclave compartment, also known as part of a reactor chamber, or a distillation tray chamber, to a flash vessel, with the underflow therefore passing to a thickener and the underflow from the thickener being fed to the autoclave feed tank or any tank upstream of the feed tank. Exothermic heat generated in the first compartment and is captured and is collected and directed to turbines, using Pinch Analysis for power generation and electricity. Additionally portions of the overflow are returned to the feed tank and fed to either another reactor chamber, or an autoclave discharge tank or the like.

The embodiment herein employs an Oxidative-type smelting furnace of two basic designs, bath and flash, and either design can be used in the practice of this invention. Both designs are part of the reactor, autoclave, sintering furnace, and the like, hereby referenced as a reactor, or part of a Reactor Chamber, and the like, and are well known in the copper smelting industry. Representative bath smelters include those operated by Noranda Inc. at its Horne, Canada facility; Mitsubishi Materials Corporation at its Naoshima, Japan facility; and Isamelt at its Mt. Isa, Australia facility, as well as various SMP's contained in Nystar's Australia and other global operations. Representative flash smelters include those operated by Outokumpu Oy at its Harjavalta, Finland facility, and Inco Limited at its Sudbury, Canada facility. Because flash smelting furnaces can be operated in a manner more consistent with existing and foreseeable environmental regulations than bath smelting furnaces (they are more readily sealed against fugitive gas and particulate emissions than bath furnaces), flash smelting furnaces are the preferred smelting furnaces for use in this invention, though not necessarily as an individual SMP, but can also be in tandem or as part of a Hybrid Reactor, as described in this embodiment.

The Reactor furnace is operated such that the matte is converted to blister metals, slag, etc., like copper, gold, silver, and the like, using the solid matte oxygen, air, or some variation thereof, in a conversion process taught in U.S. Pat. No. 4,416,690, which is incorporated herein by reference. According to this process, matte, oxygen and flux are fed into the furnace such that the converting reaction is conducted autogenously (although small amounts of various fuels can be burned to provide auxiliary heat to the reaction for purposes of exercising tight furnace control). Molten blister copper accumulates within the furnace, and the slag accumulates on the top of the molten copper.

FIG. 20A depicts a secondary copper smelting cell.

These cells contain an optimum amount of processes and equipment which in actuality could be consolidated. The roaster, for example, is being phased out in many countries and the total amount of furnaces could be reduced.

There have been few innovations in either equipment or in process within this industry for decades making it fertile ground for a new reactor inventions and ancillary improvements such as a launder conveyor system with zero emissions, mechanical wire and cable strippers, etc., instead of burning off the rubber as is the current practice (included in the drawings as it produces volume rubber vital in producing pyrolyic oil for refinery processing), a Chalcogel air emissions filtration system and an Aerogel insulated piping system made of extruded Nano based advanced composites.

A new source of volume recyclable copper and precious metals is coming from spent electronics equipment such as used cell phones, television sets, radios, computer equipment and numerous other devices all with short life spans.

Matrix relationship: Primary mined and secondary recycled copper is an integral component of an economy's infrastructure which is why it ranks third in the world consumption of metals, after iron and aluminum. Each major Matrix market's copper consumption is able to justify a cyclical system of secondary production, consumption and recycle back into that market. Where copper ore mines are within economical distance to a Matrix site primary smelting is a serious consideration. Volume copper derived from internal Matrix waste streams adds to the steady flow of area generated recyclable scrap daily collected and feed into the copper smelters.

A compelling reason for copper's inclusion in the Matrix is its significant creation of secondary jobs and tax revenues by drawing vertically integrated businesses from the electronics, defense, construction, aerospace and automotive industries into the marketplace. Collectively with the Matrix a major market can become an independent self-sustaining economy onto itself.

The economy of scale and other savings from traditional raw material import, transportation and middle man costs combined with air emissions which meet or exceed the environmental regulatory agencies requirements makes it a lucrative business addition to the Matrix.

Products produced include: a) copper cathodes and anodes for plating, b) molybdenite concentrate and molybdenum disulfide, c) nickel sulfate, d) bulk rubber scrap for pyrolyic oil production; e) cast refined copper billet, rod, ingots, bar, wire, strip, pipe, tube, cakes and powder for plating, f) copper powder for advanced ceramics and chemical production of cupric oxide, copper sulfate and others; g) secondary wrought production includes copper, brass and bronze rolling mill manufacture of plate, rolled coil, slit coil, sheet, foils, wrought copper and copper alloys; h) the making of brass and bronze wrought metal alloys by brass mills accounts for the largest share of copper recovery from scrap; i) Notable amounts of other metals derived from copper scrap include tin, antimony, lead, zinc, nickel and aluminum; and j) additionally various precious metals, selenium, tellurium, nickel sulfate, and sulfuric acid are derived as byproducts, and the like, etc., without limitation, and are included herein.

Feed streams include: a) water from the water plant; b) sulfuric acid from the SGR/SAR plant; c) oxygen from the oxygen plant; d) diesel fuel from the refinery; e) electric power from the power plant, f) copper ores and ore concentrates from the receiving plant; g) stainless steel sheet from the steel mill for use in the electrowinning process; and h) bulk scrap including copper, brass and bronze wire, cable, processed electronics, slippings, trimmings, stampings, borings and turnings forwarded from the receiving plant and collected from the Matrix trade area.

New, or mill-return, clean scrap is readily used by the industry in making new semi fabricated products. Low-copper or mixed scrap materials include: scalper and other dusts, grindings, mill scale, drosses, skimmings, ashes, slag and other residues.

Waste streams include: a) waste water from the crushers, wash tanks and electrowinning process is forwarded to the waste water treatment—metals plant, b) heavy process gas streams to the SGR/SAR—metals plant, and the cleaner streams to the power plant for syngas production, c) spent sulfuric acid to the SGR/SAR—metals plant for recycle, d) sludge and residue to the atomizer plant, e) spent stainless steel sheet from the electrowinning process back to the steel mill foundry to be remelted and recast, f) mill tailings to the secondary copper smelter, g) baghouse dusts are recycled for their zinc, copper and tin content, h) process gas streams containing SO2 are processed in the SGR/SAR plant to produce sulfuric acid, liquid sulfur dioxide, or raw sulfur and i) electrolytic slimes are sent to the precious metals plant for recovery and use as catalysts and individually sold on the world market as a regular product line including gold, silver and platinum.

Technology and processes: Copper can be produced pyrometallurgically, hydrometallurgically or in combination. In the most common hydrometallurgical process the ore is leached with ammonia or sulfuric acid to extract the copper. These processes can operate at atmospheric pressure or as pressure leach circuits. Copper is recovered from solution by electrowinning—a process similar to electrolytic refining. The process is most commonly used for leaching low grade deposits in situ or as heaps. The solvent-extraction process is also known as the SX process and electrowinning as the EW process. There is a new hydrometallurgical process called the InTec Copper Process which is described in the attached web site: http://www.intec.com.au/uploaded_files/document_uploads/Green%20Processing%202002.pdf.

Copper smelting is primarily done using flash smelters including such systems as the Mitsubishi continuous smelter and converter, the Noranda, Inco, Contop and Outokumpu flash smelters or processes such as ISA-SMELT, QSL and KIVCET which replaces roasting and smelting. For converting the Pierce-Smith and Hoboken converters are the most common processes. Electric arc furnaces using scrap as feed are also common.

Some good background web sites for further reference include: http://www.scribd.com/doc/30131619/Copper; http://pubs.usgs.gov/circ/circ1196x/pdf/circ1196X.pdf; and http://www.mine-engineer.com/mining/copperm.htm.

### Cell 21: Sintering Plant

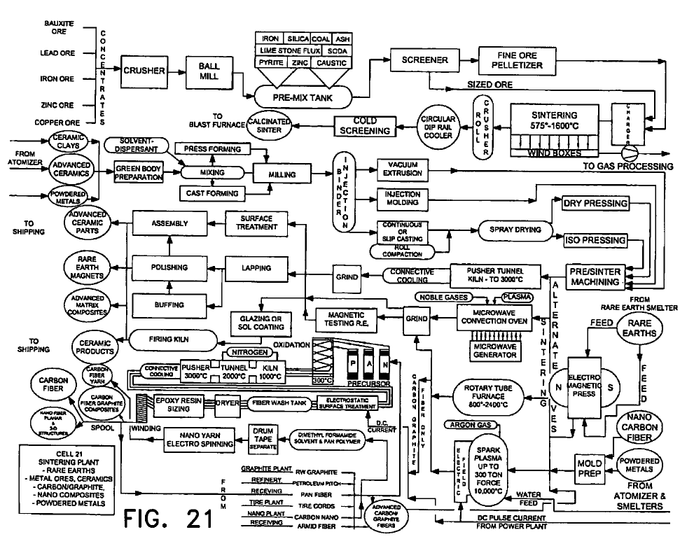

FIG. 21 illustrates a sintering plant 2100 according to the present invention. Sintering is generally referred to as the separation of metals and other particulates, based upon temperature, within the coal industry, however it can also refer to an application of particulates to substrates, and whereas by further example a Sinter mix, is a mixture of fines of iron ore, limestone, coke, dolomite and flue dust. Sintering can take place using part of the ESFMP as a matrix for various technologies, including such types as, Calcination, Oxide Reduction, Carbonization, Solid-solid reaction, Gas-solid reaction, Purification, Malizing radiant tube heating, in any combination, or connected network, such that arc sintering, autoclaves, I/R sintering, laser sintering, optical sintering, solid state sintering, hot pressing sintering, unpressurized sintering, selective laser sintering, a rapid prototyping technology, plasma sintering, spark plasma sintering, frit, yttrium-stabilized zirconia, and high-temperature superconductor sintering, and the like. Additionally, the EFSMP uses principles of atomization of metals, but is not limited to such, in that Powder metallurgy is a technology where metal parts are made by compacting fine metal powders in suitable dies and sintering, that is, heating without melting, and whereas, the invention embodiment herein comprises technologies, but are not limited to that of continuous processing apparatus, section, or reactor, either in parallel, combination, hybrid, stand-alone, and the like for high temperature thermal treatment of granular materials. In one embodiment, the sintering plant 2100 may include a sintering furnace system 2110, a sulphur gas wet cleaning 2120, a cooling tower 2130, an electrostatic precipitator 2140, a mercury removal 2150, a gas dryer 2160, and a gas-heat exchanger 2170 and a vacuum distillation 2180.

The EFSMP contains sintering technologies for the atomization of metals from various feedstreams, feedstocks, materials, effluents, and the like, and in general, provides in one permutation, a spray calcination process for decomposing a metal nitrate solution to form fine grain multicomponent metal oxide powders of selected composition. Such powders, for example, find particular utility in the electronics industry. For example, the spray calcination process may be used for the preparation of superconductor precursor powders. Accordingly, this invention will be described with particular reference to the preparation of such precursor powders.

The metal nitrate solution is sprayed into the calcination zone, wherein the metal nitrate solution is contacted by an externally heated hot gas stream introduced into the calcination zone at a temperature in the range of about 200 to 1100 degrees Celsius, and preferably between 500 and 1000 degrees Celsius, with such temperatures not being a limitation to the embodiment herein, and where the temperature being sufficient to vaporize the nitrate solution and convert the metal nitrates to their corresponding oxides. Preferably the hot gas stream consists of an inert gas enriched with oxygen. This thermal conversion process of substantially simultaneous evaporation and calcination occurs in the spray calcination zone at a residence time of about 0.5 to 15 seconds, preferably between 1 and 10 seconds. Where a compound of a metal component is highly volatile at the elevated temperature present in the calcination zone, a residence time of between 1 and 3 seconds is particularly preferred.

The formed metal oxides are then separated from the gas stream as finely divided intimately mixed metal oxide powders of selected composition having the desired stoichiometry. These intimately mixed metal oxide powders, when prepared in a stoichiometry corresponding to that of superconductor precursor powders, may then readily be processed by further heat treatment involving sintering, pressing, thin-film formation, or the like.

Sintering using Infrared and other vertically integrated technologies, software, robots, computers, and the like (not to the exclusion of any one technology or necessarily being forced to use all or any specific SMP outlined herein, or not outlined herein,) either stand alone or in combination, in the form of the EFSMP reactor using light spectrum analysis or calibration for sorting, classifying feed stock, processed products, work-in-production, and finished products—wherein ultraviolet light spectra can be used. Ultraviolet light and its various spectra, as well as light of other wavelengths can also be used for the EFSMP in other permutations, as can lasers (monochromatic, coherent, amplified light beams.)

Heating for Thermal Processing can be done, in any reactor, furnace, tank, distillation unit, and the like, but not limited to combinations of methods, or individual methods, or orders (steps/sequences of methods) comprising of heaters, radiation, Infra Red (I/R), microwaves, ultrasonic, sonic, subsonic, ultrasound, spectrums of light, sintering, furnace, combustion, fusion, thermal fusion, Nuclear Magnetic Resonance Fourier Transform Infrared (FTIR), flameless combustion, hydraulic fracturing, electrical fracturing, nuclear fracturing, fracturing, and using technologies such as MRI, Sonogram, X-Ray, Nuclear, and Tesla type methods and the like.

All EFSMP's are implemented to obtain different viscosity for further processing, and reduction of the petroleum, petroleum streams, effluent streams, fugitive gasses, gasses, plasmas, feed stocks, atomization streams, and other hydrocarbons.

In this process, other gasses may be separated, isolated, and moved, collected, segregated, and the like for sale, and or internal use, to minimize costs.

It is well known that mercury is a problem toxic that is dangerous to a human body as well as animals. The embodiment herein, through various ESFMP's can separate/parcel, segregate, sequester and bifurcate mercury, and in the ESFMP can create what is known in the mining industry as Blue Powder. This Blue Powder, also described as Ash, Char, and Coke, as a cross-industry term mentioned earlier in the embodiment of this invention, is a powdered form of Mercury that can be used in the building material, construction process, and has other industrial applications, and is not released into the atmosphere through smoke stacks or exhaust.

Additionally, the embodiment herein contains a matrix of Metallurgical, Mining, Smelting, and Refining technologies for ores, and ore products, in the form of Super Reactors, and Reactors, as described herein, of which is typically found in significant metal ore refining operations such as Nyrstar and Smelting, such systems, methods, and processes (SMP's) metallurgy and foundry, and blast furnaces, Imperial Sintering Plants, Autoclaves, and the like, in which they all independently process ore and ore bodies, this embodiment proposes the same, in combination, hybrid form, “daisy chained”, connected, and the like, for processing metals and ores, as well as those feeds that are described in the embodiment herein for feed stocks such as petroleum, crude oil, and the like, that employ such SMP's as this embodiment utilizes such as pyrometallurgical processes, hydrometallurgical or electrolytic processes, metal recovery, convection ovens, roasting, individually or in combination with any combination with electrolysis, but not limited to using either method, and either individually or in combination, or as a hybrid of an electrolytic process, also called the Roast-Leach-Electrowin (‘RLE’) process, since it has various advantages over the pyrometallurgical process (overall more energy-efficient, higher recovery rates, easier to automate hence higher productivity, etc.) for such materials used for feed stock, either solid, liquid, gas, gel, or plasma, regardless of their individual component, or combination therein of the Periodic Table of Elements, such as zinc is found within the same ore as lead, copper, silver, and gold, and the like, as well as crude oil, coal, and synthetic oil, also contain lead, and the like, and whereas, the embodiment herein could also be utilizing such efficiencies of an exothermic (and/or endothermic) autoclave leach process, where autoclave as a combination of the EFSMP described herein includes such definitions as sintering furnaces, blast furnaces, smelting furnaces, roasters, Infrared, Ultraviolet, laser, Nuclear, Microwave, and the like, and were as the EFSMP is enhanced by increasing the retention time of the solids fraction in the feed slurry over that of a liquid fraction, also known as liquid faction, and liquefaction. This is achieved by flashing the contents of the first oxidative autoclave compartment, also known as part of a reactor chamber, or a distillation tray chamber, to a flash vessel, with the underflow therefore passing to a thickener and the underflow from the thickener being fed to the autoclave feed tank or any tank upstream of the feed tank. Exothermic heat generated in the first compartment and is captured and is collected and directed to turbines, using Pinch Analysis techniques for proper placement of appropriate equipment and resources for power generation and electricity. Additionally portions of the overflow are returned to the feed tank and fed to either another reactor chamber, or an autoclave discharge tank or the like.

Lead and other metals are typically refined via thermal metallurgy, and the embodiment herein goes beyond such rudimentary function to utilize infrared (I/R) technology and sintering SMP's to process such materials into a purified state; next, cast into ingot form for reuse in batteries and other products.

The embodiment herein also employs a method, individually or in hybrid, or in any combination thereof, of making nanoparticles, nanotubes, ceramics, and advanced ceramics, included heating a reaction mixture in an autoclave reactor, or reactor chamber, or sintering furnace plant, or sintering furnace chamber (of which the inventors claim that the terms referenced herein are interchanged and used as descriptive definition of the invention described herein), where the reaction mixture includes a titanium, lithium, carbon, carbon soot, carbon gasses, carbon monoxide, carbon dioxide, carbon trioxide, graphite, coal, fullerenes, coal soot, coal ash, tire fiber fluff, fugitive effluents, nitrogen, non-metal, or other metal source, and a polar organic solvent, or other solvent, or solvent combination, as may be economically feasible.

A method for obtaining, metal, gold, silver, lead, zinc, nickel, copper, in different forms of purity is provided in this EFSMP wherein is not limited to, but as an example of which oxygen, or enriched air, or air, or any other gas, is blown onto a melt, in a melting furnace (or reactor as defined herein) lined with refractory material, having a waste heat boiler set onto it, in order to oxidize contaminants, or change its form for collection, is contained in the melt and thereby remove them from the melt, and wherein a splash protection device through which fluid flows is provided above the ore melt, or metal melt, or (metal being defined as any element found in the Periodic Table, such as iron, carbon, gold, silver, copper, platinum, zinc, lead, and the like) on the inside wall of the melting furnace, which prevents copper, and the like, that splashes out of the melt (comprising any of the metals listed in the embodiment herein, either individually or in combination, regardless of the level of purity or impurity) from penetrating into the waste heat boiler. Boiling water, plasma, or any other fluid, or gas, is used for cooling the splash protection device, protection device.

Additionally, the embodiment herein employs an Oxidative-type smelting furnace of two basic designs, bath and flash, and either design can be used in the practice of this invention. Both designs, also included in the EFSMP and are part of the reactor, autoclave, sintering furnace, and the like, hereby referenced as a reactor, or part of a Reactor Chamber, and the like, are well known in the copper smelting industry. Representative bath smelters include those operated by Noranda Inc. at its Horne, Canada facility; Mitsubishi Materials Corporation at its Naoshima, Japan facility; and Isamelt at its Mt. Isa, Australia facility, as well as various SMP's contained in Nystar's Australia and other global operations. Representative flash smelters include those operated by Outokumpu Oy at its Harjavalta, Finland facility, and Inco Limited at its Sudbury, Canada facility. Because flash smelting furnaces can be operated in a manner more consistent with existing and foreseeable environmental regulations than bath smelting furnaces (they are more readily sealed against fugitive gas and particulate emissions than bath furnaces), flash smelting furnaces are the preferred smelting furnaces for use in this invention, though not necessarily as an individual SMP, but can also be in tandem or as part of a Hybrid Reactor, as described in this embodiment.

In a typical and preferred embodiment of this invention, two rotating anode furnaces are located proximate to the converting or holding furnace, as the case may be, and are sized to accommodate the output from the converting and/or holding furnace. These furnaces, also known as thermal conversion super reactors, atomization reactors, and also known herein, and throughout, as super reactors, hearths, furnaces, kiln's, autoclaves, and the like, are typically of conventional design and operation, and are used in tandem with one another such that while one is in operation, or as is the case may be in this example, is fire-refining the blister to anode copper, zinc, lead, gold, silver, and/or the like, the other is filling—if tandem/parallel/combination reactors are indeed needed. The output from the anode furnaces is transferred to an anode casting device (of any conventional design) on which the anodes are formed and subsequently removed to electrolytic refining.

In another embodiment of this invention, a single anode furnace, either rotating or nonrotating, is located proximate to the converting or holding furnace, as the case may be, and is sized to accommodate the output from the converting and/or holding furnace. This nonrotating furnace can be of any suitable configuration, and consists of an oxidation zone and a reduction zone. These zones are separated by any conventional means, e.g. a dam or baffle, but are otherwise in fluid communication with one another such that the oxidized blister can move freely and continually from the oxidation zone to the reduction zone.

Methods for EFSMP Thermal Conversion Atomization Reactor of processing metals, for example but are not limited to such metals as aluminum, copper, zinc, lead, gold, silver, include, High Flux Heaters, sintering, and/or the like powder comprise technologies such as, but are not limited to, atomization, electrowinning (see U.S. Pat. No. 6,558,527, and incorporated herein by reference), Isothermal Melting Processes (ITM), decoating metals using indirect-fired controlled atmosphere (IDEX) kilns, and the like, as well as, either in tandem, hybrid, parallel, or stand alone, in such that providing powder and heating the powder in a nitrogen, or other gas, atmosphere containing a partial pressure of water vapor. The aluminum, copper, zinc, lead, gold, silver, and/or the like powder is not pressed together by a mechanical force that substantially deforms particles of the powder either prior to or during the step of heating. Articles comprising sintered aluminum powder. The microstructure of the sintered aluminum, copper, zinc, lead, gold, silver, and/or the like powder contains no compositional concentration gradients indicative of the use of a sintering aid and no evidence of particle deformation having occurred by an application of a mechanical force prior to or during the sintering of the powder. Additionally, in a controlled atmosphere environment, as envisioned, and incorporated herein, such technologies are incorporated for Oxidizing, and Reducing of Solids, Metals, Gasses, Plasmas, Liquids, and the like, and whereas such Purity Control Monitoring and other methods, but not limited to that of, multiple atmospheres (in difference chambers of a Reactor, or in Parallel, Tandem, Hybrid configurations) exist. Such technology can also be used for Corrosive Atmosphere, Fugitive Gas, and Toxic Effluent manipulation.

As part of the EFSMP, described in the embodiment herein, the ability for the system self repair itself, by communicating in a machine to machine (MTM) manner with reports for such steps done autonomously and with the software that performs a functional Artificial Intelligence to act as a Sintering Repairman, so to say, in that the EFSMP detects issues of service and repair in as much as such detection is done fiber optically, or via some other detection product, method and device, where Carbon particles, such as, carbon fibrils and carbon nanotube molecules, may be assembled by the EFSMP into substantially pure aligned fibers or Composites and the like, as is needed by the structural demands and protocol of such EFSMP at the site of treatment and attention, and the like by dispersing the carbon particles within a curable liquid, aligning the carbon particles by flowing the mixture of curable liquid and carbon particles down a tapering tube, and curing the flowing mixture of curable liquid and carbon particles, creating a molecular fiber, so to say, in the general vicinity of the end of the tapering tube to form a fiber. The curable liquid may be cured using ultraviolet light, infra red, microwave, heat, air, gasses, and the like. The solidified mixture may be further processed by heating the fiber so as to cause the volatile elements of the solidified curable liquid portion to substantially dissipate from the fiber, twisting the fiber to increase its density, heating the fiber to sinter the carbon particles within the fiber, and cladding the fiber. The resulting fiber will serve as a temporary patch, repair, at the least, until such time additional permanent repairs can be performed in the event such immediate repair was and is unsatisfactory for economic viability and safety of the EFSMP.

This embodiment comprises a matrix of vertically integrated thermal conversion and atomization technologies that represent either in stand alone, or in any combination thereof, a system of slag, dross, and the like, refining, as a byproduct from ore and metal/s processing, using sintering technology, in conjunction with a chemical or a catalyst, in relation to the atomic properties of minerals and elements, where such refining, under controls of heating, refining, cooling, pressure, and the like, can change the electron, proton, and neutron properties of material to remove radiation or neutralize elements.

Likewise other methods of Hydrogen recovery that are claimed for incorporation would be updated forms of steam reforming, oxidation, pressure swing absorption, membrane recovery, cryogenics, and catalytic hydrotreating, and hydrogen recovery processes. As with this embodiment, production of hydrogen is included herein, wherein the SMP is accomplished by Sintering Zinc, in such a manner that additional Hydrogen is created a as a desired excess byproduct in the creation of Sulfuric Acid, in the sintering of the Zinc Ore for such desired purposes. For example, in a Zinc Sulfate solution, from Zinc, the solution must be very pure for electrowinnowing to be at all efficient. Impurities can change the decomposition voltage to where the electrolysis Cell produces mostly Hydrogen instead of Zinc metal, as described as Zinc Smelting according Wikipedia. In as much as Hydrogen is a necessary product for Sulfuric Acid, the embodiment herein of the EFSMP may not necessarily need a specific Hydrogen Plant, but can include one if necessary, or the technology either as a standalone or in combination of the Zinc Smelting that takes place in the Sintering Plant/Reactor, to produce any required Hydrogen (H) for either internal use, or for tanking and resale to consumer markets. Internal use can also be intra-corporate/intra-refinery as well as inter-corporate and inter-refinery operations.

This embodiment includes any excess SO3, S, SO2, and the like, regardless of form, that is generated/produced from such SMP as Sintering and Fuel Cell technologies, that is not used in-house, can be sold to the market, through companies such as DuPont, any of their competitors, or any supply houses that serve the petrochemical industry or other industrial and manufacturing needs.

This embodiment of the invention EFSMP as a Sintering Furnace, Sintering Reactor, Sintering Plant, and its uses therein, either singularly, or in any combination thereof, uses both, and either Pyrex Lining, Shielding, Insulation, Piping, and the like and or heat in the form of IR, Radiation, Electricity, Thermonuclear energy, sonic waves, ultraviolet waves, CT Scan imaging waves, magnetic resonance (ex: MRI technology), Tesla technologies, and the like. and where the ESFMP, wherein the upstream contacting zone and/or downstream contacting zone comprises one, or more, and in any combination/s thereof, stacked bed reactors, either vertically or horizontally, and the like, and where the ESFMP, wherein the upstream contacting zone and/or downstream contacting zone comprises one or more ebullating bed reactors, and where the ESFMP, wherein the system further comprises a crude feed conduit coupled to the upstream contacting zone, the crude feed conduit being configured to convey a crude feed to the upstream contacting zone; a total product conduit coupled to the downstream contacting zone, the total product conduit being configured to convey the total product from the downstream contacting zone; and one or more gas conduits, at least one of the gas conduits is coupled to the upstream contacting zone, the gas conduits being configured to convey a hydrogen source and/or a carrier gas into the upstream contacting zone and/or downstream contacting zone, and where the ESFMP, wherein the system further comprises: an upstream separation zone coupled to the upstream contacting zone upstream of the upstream contacting zone, the upstream separation zone being configured to produce the crude feed; and an additional crude feed conduit coupling the upstream separation zone to the upstream contacting zone, the additional crude feed conduit being configured to convey the crude feed from the upstream separation zone to the upstream contacting zone. Through a breakdown stage, like pyrolysis, plasma arcs, electric arc, spark plasma sintering, vacuum sintering, current pulses, electrical resistance heating, inductive heating, gas pressure sintering, microwave and sound wave bombardment, heat, light, laser, radiation, thermonuclear heat, sintering, chemical, anaerobically, aerobically, either individually or jointly, petroleum products, petroleum derived products, petroleum effluents, lead, lead dross, dross, used clay, lithium fluff, lithium, oil sands, e-waste, ore and petroleum oil/s, and tires and rubber can be broken down into components such as gases (light and heavy,) tire wire steel, tire fiber (polyester, nylon, rayon, etc. see chart), carbon black, diesel oil, diesel fuel, fuel oil. Through different methods they can continuously loop back. When and where needed, tires and rubber can be broken down into a slurry that is suitable for adding to the crude oil feed stock, or waste-lubricant oil, or waste lubricants, for processing and refining using methods found in refineries for coking, and producing typical refinery products. Applicants' embodiment herein also includes SMP's for adding effluents, made up of different petroleum and gas products (as described in Texaco patents).

In any refinery there is a series of processes and methods that are used to change the state of crude oil and the like into other forms of product with different viscosities, matter/mass, gasses, and substances.

Additionally, the EFSMP, in this invention embodiment, and its matrix, utilizes vertically integrated technologies in combination, in part, in various permutations, in stand-alone, in order to handle crude oil, refined oil, lubricants, coal, and other materials described herein, to generate internal electricity, power, oil products, metals, compounds, liquids, other solids, plasmas and the like at near-zero emissions, if not completely zero emissions, or negative emissions when beating PetroPolitical targets, as a refinery and a power co-production facility, when economically suitable.

Whereas in the industry systems use exothermal methods routinely, this embodiment proposes an ESFMP that can interchange thermal process produced from, or used in, cracking and/or fracturing, requiring energy to raise temperatures above ambient (surrounding stasis temperatures) room temperature and the like: infrared (I/R) practices are easily utilized.

Applicants represent in this embodiment a matrix of systems, reactors, and processes, that either singly, jointly, or in any combination can accomplish the same result. I/R is one example contained in this invention embodiment, as are nuclear, atomic, chemical, electrical, thermal, Drop-Tube, Pressurized Radiant Coal, Flow Reactor, and/or a heated mix of compounds (liquids, metals, solids, gasses, fluids, plasmas, and the like) are processes that can be utilized also. I/R in this matrix embodiment of vertically integrated technologies can be used either as a stand alone, or in a combination application, and the like, as and for gas catalytic infrared ovens, dryers, and furnaces, infrared heating and thermal processing, roasting, and convection oven-type performance.

Furthermore, using I/R in addition to processing and refining could be used to detect electron, neutron, proton, characteristics of feeds/products entering into the ESFMP. Such SMP's could be used to separate different liquids, metals, solids, gasses, and plasmas into various distillation tanks, much like typical reactors in a refinery (ex: atmospheric distillation, vacuum distillation, and the like) into different tracks for collection, sale, use, recycling, further processing, internal use, or holding and storage.

Furthermore, in order to prevent significant duplication in the matrix, this embodiment represents an improvement over a typical refinery wherein any combination of ESFMP's can be utilized in any configuration as required to attain the greatest economic efficacy.

Robotics, are also used in this embodiment in order to more quickly and precisely work within a sintering furnace—and/or sintering plant—where sintering and the like can take place using part of the ESFMP as a matrix for various technologies, including such types as, Calcination, Oxide Reduction, Carbonization, Solid-solid reaction, Gas-solid reaction, Purification, Malizing radiant tube heating, in any combination, or connected network, such that arc sintering, autoclaves, I/R sintering, laser sintering, optical sintering, solid state sintering, hot pressing sintering, unpressurized sintering, selective laser sintering, a rapid prototyping technology, plasma sintering, spark plasma sintering, frit, yttrium-stabilized zirconia, and high-temperature superconductor sintering, and the like. Additionally, the EFSMP, uses principles of atomization of metals, but is not limited to such, in that Powder metallurgy is a technology where metal parts are made by compacting fine metal powders in suitable dies and sintering, that is, heating without melting, and whereas, the invention embodiment herein comprises technologies, but are not limited to that of continuous processing apparatus, section, or reactor, either in parallel, combination, hybrid, stand-alone, and the like for high temperature thermal treatment of granular materials. The apparatus includes a vertical conveyor means with an internal feed mechanism for transporting granular feedstock upward, an external export means for taking reacted product downward wherein the internal feed heats the granular feedstock by absorbing heat from the product flowing downward through the export means, and a heating means disposed around a top portion of the vertical conveyor means and the external export means. Such EFSMP chambers, units, sections and configurations, employ different atmospheric pressures, and temperatures, and promote, and enable, and conduct, fusing and bonding of individual particles. In conjunction with, but not limited to sintering technology, Atomization process technologies are used, and is the one of the processes for reconstitution of effluents, and metals, and making powder metals. Definition of the atomization, as is included in the preferred embodiment of the matrix of this EFSMP is, but not limited to, is a method where feedstocks are, but not limited to, a liquid, plasma, gas, slag metal, slag, metal slag, mat, carbon black, clay, Olgone, sorbent, petroleum sorbents, petroleum, lubricants, acids, Dore, Heavy Oil, Shale Oil, Acid Clay, Ash, Water, Sour Water, Oil Sludge, Filter Cake, Molten Stream, Slurry, or any effluent stream and feedstock, is produced by ejected molten, refined lubricants, oils, and the like metal through a small orifice. Furnaces like Caldo, Aldo, Ausmelt, Sirosmelt, and the like, but not limited to, are permeations of the EFSMP, and the Reactor, and Reactors described herein, can all achieve ranges of 3500 degrees Celsius. The EFSMP is and can be, but is not limited to, Batch and or Continuous Processing, and the like, whereas the stream can be centrifuged with a Centrifugal Gravity Concentrator, Tall Column Flotation, Automated Mechanical Flotation, High Gradient Magnetic Separation, and the like, either in combination, tandem, parallel, compartmentalized, jointly connected, vertically integrated, or as part of an overall matrix of technologies, and the like, that are incorporated herein as part of a Reactor, is broken up or disintegrated by jets of inert gas, air, or water, and the like into small drops. The EFSMP technology utilizes a technique, but not limited to, the rapid solidification of the powder from the melt. Gasses are used, and an example of which, but not as a limitation of, are that of air nitrogen, hydrogen, and argon. This EFSMP makes possible the production on a semi-continuous basis (that is, in multi-ton lots) of fine powders from molten metals and alloys from the feedstocks and typical waste products associated with metallurgy and oil refining. The invention embodiment of this EFSMP contains sintering technologies for the atomization of metals from various feedstreams, feedstocks, materials, effluents, and the like, and as such, and in general, provides in one permutation, a spray calcination process for decomposing a metal nitrate solution to form fine grain multicomponent metal oxide powders of selected composition. Such powders, for example, find particular utility in the electronics industry. In its more specific aspects, this process is of particular utility for the preparation of superconductor precursor powders.

In its broadest aspects, a metal nitrate solution containing two or more metal components is introduced into a spray (or other form of transfer) calcination zone, and the like, in the form of a finely atomized spray. The metal nitrate solution is prepared by having its metal components in a preselected ratio so that when the water of solution is removed and the resulting nitrates are decomposed to form oxides, a desired stoichiometry of the metal components is maintained. It is considered essential in order to maintain adequate decomposition and proper subsequent stoichiometry that only nitrate solutions be used.

At the same time that the metal nitrate solution is sprayed into the calcination zone, it is contacted by an externally heated hot gas stream introduced into the calcination zone at a temperature in the range of about 200 to 1100 degrees Celsius, and preferably between 500 and 1,000 degrees Celsius; the temperature being sufficient to vaporize the nitrate solution and convert the metal nitrates to their corresponding oxides. Preferably the hot gas stream consists of an inert gas enriched with oxygen. This thermal conversion process of substantially simultaneous evaporation and calcination occurs in the spray calcination zone at a residence time of about 0.5 to 15 seconds, preferably between 1 and 10 seconds, however, as is the case here, and throughout the embodiment herein, the “time” is not a limitation, as the state of the art continues to develop, it is anticipated that reductions of this cost are possible and indeed attainable. Where a compound of a metal component is highly volatile at the elevated temperature present in the calcination zone, a residence time of between 1 and 3 seconds is particularly preferred.

The formed metal oxides are then separated from the gas stream as finely divided intimately mixed metal oxide powders of selected composition having the desired stoichiometry. These intimately mixed metal oxide powders, when prepared in a stoichiometry corresponding to that of superconductor precursor powders, may then readily be processed by further heat treatment involving sintering, pressing, thin-film formation, or the like.

It is an advantageous feature of the EFSMP, that the metal nitrate feed solution may be adjusted in composition either initially or during the process run to yield the desired product stoichiometry. This is particularly useful when dealing with volatile compounds such as nitrates and oxides containing metal components such as thallium. Also, by adding an oxidizing agent such as H2O2, e.g. 3% H2O2, to the feed solution containing metals having multiple valence states, e.g., Cu and Tl, the metal component is converted to its highest valence state such as the conversion of Tl+1 to Tl+3. This further serves to reduce volatility and improve solubility.

Features of the EFSMP relate to the production, but are not limited to, of intimately mixed metal oxide powders of desired stoichiometry, particularly suitable for conversion to superconductors as well as to the preparation of specific types of rods, plates, or other ceramic forms of superconductors. The description of this EFSMP affords flexibility in preparing a wide variety of multicomponent superconductor powders in a desired stoichiometry utilizing two or more metals, provided soluble nitrates of the metal components are available. The number of metal components that may be used is basically limited only by considerations of the mutual solubility of their nitrates. The EFSMP employs a shallow cup, but not limited to, as one example of the technology, and is not a limitation herein, one that is rotating at high speeds.

Once the high speeds are obtained an atomizing fluid such as water, oil or any other hydrocarbon is fed to the cup to form a thin sheet or layer which is distributed on the inner surface of the cup and which is accelerated to speeds essentially the same as that of the spinning cup. Within the cup a stream or spray of molten metal is propelled into this thin sheet of atomizing fluid. The metal interacts with the fluid and is fragmented or broken down into many small droplets which are quenched by the atomizing fluid and solidified into fine powder. These powders can be continuously removed and recovered. Because the atomizer can be spun at higher speeds, it can produce finer powders.

A further preferred invention embodiment is to add a preatomizer between the stream of molten metal and the spinning cup. A mechanical impact preatomizer, for example, has rotating impeller blades which break up the molten stream into a series of droplets that will be directed to the atomizing liquid film on the inner wall of the spinning cup. Other embodiments may include the use of a gas atomizer or a centrifugal atomizer. Gasses, oil, and water is the liquid most widely used, but is not a limitation of the embodiment herein. Atomization can take place using different widely known technologies, in hybrid, tandem, chambered, parallel and forms, and in different Reactors, Chambers, Sections, Permeations, Segments, and the like, with different properties of lining, temperatures, gravity, vacuum, and atmospheres, as well as particle size, density, specific gravity, specific gravity weights, and the like. When atomizing, pyrolysis of the oil may occur leading to carbon pick up, and as such the EFSMP so to control the oxide level, the powder may be decarburized by a wet hydrogen anneal, and the like, followed by dry hydrogen reduction, and the like, to prevent pyrolysis, however, such is not a limitation to the embodiment of this EFSMP.

The EFSMP, by reference of U.S. Pat. No. 3,891,428, and incorporated herein in its entirety, whereas the EFSMP of this embodiment, herein, but is not limited to, treating non-ferrous slag in a furnace, reactor, and the like, by injecting liquid fuel and air into molten slag to heat and reduce the slag. The injection of the liquid fuel and air is obtained by discharging the liquid fuel under pressure through a nozzle to produce an atomized stream of the fuel, introducing the atomized stream of fuel into a stream of air, and carrying the mixed streams into the slag.

Artificial intelligence, computers, networks of computers, and related software, also known as A.I., can be used to determine flows, direction, sourcing, quality control, management, leak detection, repair (automatic, scheduled, emergency, routine,), complete automation, and the like. This use can be made either independently, or in connection with augmentation hardware, such as robotics and the like, to prevent such recent incidents as occurred at a United States based Royal Dutch Shell Oil facility in late 2009.

In another form of the preferred embodiment of this EFSMP is an apparatus, also known as a Reactor, herein also known as an EFSMP, where the EFSMP is used for treatment of a plurality of molecular sieves whereas the EFSMP can also utilize, either in a standalone form, or in hybrid, or in combination, comprises a steam preparation section, a steam reactor section, and a steam collection section. The EFSMP has multiple sections, wherein such sections, either standalone, or in hybrid, or in combination, include generators, and where such generators, and reactors, and where any reactor section includes a plurality of sample holders. Further, any section or reactor of the EFSMP, either overall or individually, as described herein can be connected for preparation to any other section of the EFSMP section or reactor. Furthermore, any section or standalone unit of the EFSMP, either in part and parcel, a single unit, or a combined unit, tandem unit, parallel unit, daisy chained unit, hybrid, or any matrix of technologies integrated thereof, and the like, may also be carried out.

Additionally, and included by reference herein, the EFSMP utilizes such technology and principals as Combinatorial Chemistry, also known as High Throughput Experimentation (HTE) or high-speed experimentation (HSE), and sieves, where as such is an emerging area of technology and science that has applicability in various technology fields, and is included herein in the embodiment of the EFSMP. The aforementioned sciences are also used in the pharmaceutical industry, as well as in the material science and chemical industries and are incorporated herein by reference without limitation. It is widely recognized that the combinatorial synthesis methods can be a useful tool in increasing the rate of experimentation and improving and accelerating the possibility of making discoveries of new products or processes. Such science is incorporated in the A/I (artificial intelligence) described herein.

Potential areas of use, but are not limited to, wherein HTE may be useful relates to the modification and characterization of molecular sieve materials which can serve as catalysts, either individually or in any combination or components that is so desired, such as, but not limited to tungsten, vanadium, molybdenum, rhenium, nickel, cobalt, chromium, manganese, or a noble metal, such as platinum or palladium, where a hydrogenation-dehydrogenation function is desired. Such components can be exchanged into the molecular sieve composition, impregnated therein or physically intimately admixed therewith. In addition, such molecular sieves, both natural and synthetic, and can include zeolites.

Additionally, molecular sieves can be exposed to steam or hydrothermal environment under various circumstances in commercial use. Several existing approaches have been proposed for HTE-type synthesis, screening and characterization of organic compounds and catalysts, such as homogeneous catalysts. For example, U.S. Pat. No. 6,419,881 proposes a method for the combinatorial syntheses, screening and characterization of libraries of supported and unsupported organometallic compounds and catalysts. U.S. Pat. No. 6,759,014 proposes an apparatus and methods for parallel processing of multiple reaction mixtures. United States Patent Application Publication 2003/0100119 proposes combinatorial synthesis and screening of supported organometallic compounds and catalysts. United States Patent Application Publication 2004/0132209 suggests a multi-chamber treatment apparatus and method, particularly for a simultaneous treatment of a plurality of materials, such as catalysts.

This embodiment includes an EFSMP for treatment of a plurality of molecular sieves samples comprising: a) a steam preparation section; b) a steam reactor section, including a plurality of sample holders, the steam reactor section operatively connected to the steam preparation section; and c) a steam collection section operatively connected to the steam reactor section, the steam collection section including a plurality of knock-out vessels, and wherein the EFSMP the steam preparation section includes: a) a steam generator; b) a conduit for delivering steam to a manifold of the steam reactor section; c) a first means to supply an inert gas into the manifold; d) a second means to supply an inert gas into the manifold; e) a means to control the flow of steam into the manifold.; and f) a means to control the flow of the inert gas into the manifold, as well as an EFSMP for the treatment of a plurality of molecular sieves samples, including: a) providing an apparatus comprising: i) a steam preparation section; ii) a steam reactor section, including a plurality of sample holders, the steam reactor section operatively connected to the steam preparation section; and iii) a steam collection section operatively connected to the steam reactor section, the steam collection section including a plurality of knock-out vessels operatively connected with each respective sample holder; b) placing the molecular sieves samples into the sample holders; c) supplying a flow of steam or a mixture of steam and an inert gas into each of the sample holders; d) removing the steam or the mixture of steam and inert gas from each of the sample holders and directing the steam or the mixture of steam and inert gas into the plurality of knock-out vessels; e) condensing at least a portion of the steam into a liquid; and f) maintaining a desired level of the liquid in each knock-out vessel, as well as an EFSMP for adjusting steam flux.

An EFSMP for treatment of a plurality of molecular sieves samples which comprises: a steam preparation section, a steam reactor section and a steam collection section. The steam reactor section includes a plurality of sample holders. The steam reactor section is operatively connected to the steam preparation section. The steam collection section includes a plurality of knock-out vessels, and the steam collection section is operatively connected to the steam reactor section. The knock-out vessels may be operatively connected with each respective sample holder. The term “operatively connected”, used in conjunction with sections, elements or components, means that such sections, elements or components are connected to each other through physical means, such as conduits or, mechanically, or through signal means, such as electrical or electronic connections, which may be wired or wireless.

An EFSMP for the treatment of a plurality of molecular sieve samples that includes, but is not limited to, providing an apparatus comprising: a steam preparation section, a steam reactor section, and a steam collection section.

In yet another aspect, provided is a process for adjusting steam flux (under working pressure) in the EFSMP disclosed herein, wherein the sample holders contain molecular sieve samples. The process comprises introducing an inert gas into the steam reactor section and directing the inert gas to all sample holders containing molecular sieve samples.

Furthermore, sintering using Infrared and other vertically integrated technologies, software, robots, computers, and the like (not to the exclusion of any one technology or necessarily being forced to use all or any specific SMP outlined herein, or not outlined herein,) either stand alone or in combination, in the form of the EFSMP reactor using light spectrum analysis or calibration for sorting, classifying feed stock, processed products, work-in-production, and finished products—wherein ultraviolet light spectra can be used. Ultraviolet light and its various spectra, as well as light of other wavelengths can also be used for the EFSMP in other permutations, as can lasers (monochromatic, coherent, amplified light beams.)

In the petroleum industry, crude oil is the feed stock used in refineries. There are over 230 Billion gallons of crude virgin oil that are processed in the United States each year. These refinery operations may be run by KBR, Foster Wheeler, Bechtel, UOP, Flour Atlantic, Thyssen Rheinstahl Technik, Technip, Du Pont, Honeywell, Schlumberger, Halliburton, and others. However, each process of the refining, with the exception of sulfur extraction, is generally handled/processed as a type of interdependent individual subsidiary company. Du Pont, for example, holds many patents, and operates either in tandem with, for, on behalf of, each refinery in “Sulfur Product and Byproduct handling.” Their website also indicates that they will even provide design, financing, and management for such operations.

The present invention embodiment does not have the prior art limitations, either in the necessity of having more than two reactors in the entire facility, or in having just one. The invention embodiment herein can be rendered as single pass-through or multiple matrices of technologies as pass-through EFSMPs, any of which can be vertically integrated depending upon the configuration of the location as well as desired costs and economics. The EFSMP reactors can be used for upgrading base feed stocks, or for breaking down enriched or encumbered feed stocks. Types of feed stocks, that the invention embodiment herein could use could be crude oil, used lubricant oil, shale, shale oil, coal, thermonuclear treated and extracted petroleum products, bitumen, black oil, dark oil, waste lubricants, oil filters, used oil filters, spent oil filters, Pyrolysis oil, sinter furnace oil, and the like.

The embodiment of the EFSMP herein discloses that such a reactor, or reactors (of which such reactors may not have been from traditional industries, but in a matrix of vertically integrated technologies such as mining, metallurgy, metallurgical operations, chemical processing, energy production, and the like,) may be placed or arranged in different configurations serving different purposes, either in tandem, or via backup, redundancy, stages, efficiency, parallel, hybrid, and the like, etc., where the EFSMP is best specialized for a particular method of operation by the engineer, operator, or owner.

Additionally, metallurgy, metal recovery, metals extraction, and the like, can be accomplished with technologies, but not limited to such, as metal vaporization, metal extraction, metal powders, high rate biotechnology, Metal recovery from liquid streams (process bleed streams, leach water, waste streams), integrated removal of (fugitive) SO2, treatment of acid blow down, as well as patented technologies developed by the Paques company, which has realized some 500 high rate biological treatment plants worldwide. Thirteen industrial plants specially designed for the reduction of sulfur compounds are successfully operated on a continuous basis. The technology is marketed under the THIOPAQ®-trademark, and incorporated herein by reference, and other options. Whereas there is no limitation to the embodiment herein, those technologies, and patents referenced herein are limited in scope and only apply to metals recovery, as well has having other limitations as related to other related technologies and patents in the same field, and not to the overall matrix of technologies which are vertically integrated into the EFSMP, outlined herein.

As part of the invention embodiment of this EFSMP, there is a means for Pyrolysis in which refining can take place in a rapid time frame, one that is less than is typical for a conventional refinery in as much that in combination, or stand alone, or in any sequence or permutation using sintering and infrared, and wherein every process and/or chemically metamorphic function that is used in a typical petrochemical refinery uses heat and variation of temperature. Applicants note that with this invention embodiment there is no limitation on the functional use of temperatures, whether ambient, lowered (cooled,) or elevated (heated). The present invention provides the capability to refine virgin crude and waste oil, ores, slag, chemically altered substances—classified as “pollution,” or not—or any other identifiable substances, as needed (whatever physical state or form such substance might take: gas, solid, liquid, or plasma, including but not limited to atomized mist/s, precipitation, steam/condensate, ammonia, fumes, residues, deposits, oxidation products/ash, dust, powders, crystals, compound matrices including waste or excess, slag, chemicals, colloidal additives, and/or any single element (or compound/mixture of elements) as are currently (or in the future) listed by atomic number in the Periodic Table of Elements, whether naturally occurring or synthetic, without limiting the invention embodiments to crude oil.

The purpose of refining, extracting, and processing, is to convert natural raw materials such as crude oil and natural gas into useful, saleable products. Crude oil, vapors, gas, and natural gas are naturally occurring hydrocarbons, found in many areas of the world in varying quantities and compositions. In refineries, they are transformed into different products, such as: fuels for cars, trucks, airplanes, ships and other forms of transport; combustion fuels for the generation of heat and power for industry and households; fossil fuels, raw materials for the petrochemical and chemical industries, synthetic crude oil; and specialty products such as lubricating oils, paraffins/waxes and bitumen; energy as a by-product in the form of heat (steam) and power (electricity).

In the embodiment of the present EFSMP this embodiment incorporates modules, and present a matrix of different SMP's wherein they also constitute a multi-disciplinary arrangement of vertically integrated technologies from multiple different industries that have not previously been grouped into an oil refinery, and the like. In doing so, this embodiment demonstrates a cost savings that will not only provide a less expensive feed stock for refining, from ancillary, secondary, tertiary, etc., byproducts and the like, but will also produce cleaner fuels, and additional petrochemical products, and other saleable products, some or all of which could be use used internally to further reduce costs, all whilst ameliorating an extremely significant source of environmentally burdensome waste products.

This embodiment also uses a combination of, either independently, in a matrix, or as vertically integrated technologies for the collection of such, a means of collection of material for feed-stock, in raw form, either as ore, rubber, oil, lubricant, batteries, and the like, whereas additionally, with regard to off-site collection, as well as domestic collection, this embodiment proposes a matrix, and vertical integration of technologies such as in-plant pyrolysis for power-generation. The waste tanks are designed and/or configured so that the waste oil is fed and/or emptied from a primary tank (a tank can be defined as a structure to hold waste oil, waste lubricants, acids, water, liquid, gel, and the like—and can be single unit, or a series of units interconnected, or separately as is desired) into a secondary tank that could act, but is not exclusive of functioning as such, a sediment tank. Such systems and the software to operate them are included in this embodiment.

Heating for Thermal Processing can be done, in any reactor, furnace, tank, distillation unit, and the like, but not limited to combinations of methods, or individual methods, or orders (steps/sequences of methods) comprising of heaters, radiation, Infra Red (I/R), microwaves, ultrasonic, sonic, subsonic, ultrasound, spectrums of light, sintering, furnace, combustion, fusion, thermal fusion, Nuclear Magnetic Resonance Fourier Transform Infrared (FTIR), flameless combustion, hydraulic fracturing, electrical fracturing, nuclear fracturing, fracturing, and using technologies such as MRI, Sonogram, X-Ray, Nuclear, and Tesla type methods and the like.

All EFSMP's are implemented to obtain different viscosity for further processing, and reduction of the petroleum, petroleum streams, effluent streams, fugitive gasses, gasses, plasmas, feed stocks, atomization streams, and other hydrocarbons. In this process, other gasses may be separated, isolated, and moved, collected, segregated, and the like for sale, and or internal use, to minimize costs.

Today, there are hundreds of millions of tires that litter the globe, with several sources claiming that there are approximately between 270 million to 290 million of waste tires that are disposed of every year in the United States alone. Most are left as landfill, while some are broken down, shredded, and used for creating oils, gases, carbon black, mulch, and additives for asphalt. Most fuels and gasses are used by Power Utilities, Cement Companies, and Paper Mills. While Tires burn cleaner, and give off a greater BTU than coal, by burning their component contaminants are released into the atmosphere, and pollute the environment—sometimes at dangerously toxic levels and sometimes causing such severe conditions as birth defects, onset of cancers and other illnesses, and premature death.

Where tires are originally collected, the present invention also includes a vertical integration of collecting waste oil for re-refinement. This waste oil matrix, is part of the overall ESFMP of this embodiment, part of which according the United States government, through the Environmental Protection Agency, of which is incorporated herein by reference (www.epa.gov), and the Energy Information Administration (www.eia.doe.gov), as well as the National Petroleum Council (www.npc.org) and the American Petroleum Institute (www.api.org) define this as a source of both renewable energy and alternative energy. Additionally the EPA states that re-refining of lubricant oil is a process that can regenerate used oils into base oils that are of equivalent in quality to fresh, virgin base oils. Of particular note, at the federal level used oils are not classified as hazardous wastes reflecting policy decisions made decades ago. Specifically, on Nov. 19, 1986, EPA issued a decision not to list recycled used oil as a hazardous waste material (51 FR41900). The agency determined that used oil, being recycled, should not be listed as a hazardous waste under Resource Conservation and Recovery Act (RCRA).

The invention embodiment herein uses a SMP of collection of waste products, for recycling, re-use, and as a source of feed stock, similar to the curb side, and commercial waste collection services provided by Waste Management, and the United States Military, of products such as used lubricants, lead acid batteries, used tires, and the like. As for Lead Acid Battery's, The smelting of Lead involves several elements that are required to reduce the various forms of Lead (mainly Lead oxide and Lead sulfates) into metallic lead. This includes: a) a source of carbon, usually in the form of metallurgical, petroleum coke, charcoal; b) energy, mostly available from natural gas, oil or electricity; c) neutralizing agents used to capture sulfur such as caustic, soda ash, or lime; and d) Fluxing agents also used to capture Sulfur and improve Lead recovery.

Frequently this includes various forms of iron and slag enhancing materials. While collecting sources of recyclables that are highly toxic, and those that are non-hazardous and environmentally preferable (EPA executive order 9.6.2 #13101) many locations also have an abundance of waste lubricants (Brake Fluid, Transmission Fluid, Hydraulic Fluids, etc.,) and automobile batteries (also known as Lead Acid Batteries, and Lead Batteries)—with which will eventually be included Lithium, Lithium Ion, Lithium Nickel Batteries, Nickel Metal Hydride, (and the like.) As national and global initiatives to reduce the impact of industrial wastes, and to enhance fossil fuel technology productivity, continue to increase in number and direction, this EFSMP becomes both more profitable and a more desirable environmental citizen.

The EFSMP of the invention embodiment herein, in tandem, stand alone, parallel, combined parallel, hybrid, combination, and the like, include, and are not limited to the process design in extractive crystallization of lithium, lithium hydroxide, and the like. The smelting of lead involves several elements that are required to reduce the various forms of lead (mainly lead oxide and lead sulfates) into metallic Lead. This includes: a) a source of carbon, usually in the form of metallurgical, petroleum coke, charcoal; b) energy, mostly available from natural gas, oil or electricity; c) neutralizing agents used to capture Sulfur such as caustic, soda ash, or lime; and d) fluxing agents also used to capture Sulfur and improve Lead recovery. Frequently this includes various forms of iron and slag enhancing materials.

Additionally, the lithium battery recycling and processing that the EFSMP incorporates deals with the fact that most batteries contain toxic heavy metals, such as nickel, cadmium, iron, mercury, and the like. One skilled in the art, and not limited to having attended such, but is also familiar with the 2nd Mercosur Congress on Chemical Engineering, and the 4th Mercosur Congress on Process Systems Engineering conference, of which the technologies presented there are incorporated herein by reference. However, those technologies are limited in such as they do not do oil refining, coal processing, nanotechnologies, water production, water resource management, fugitive and volatile gas handling, power creation and generation, precious metals and metallurgy processing, carbon emissions, or address the other matrix of technologies outlined herein, in which an overall reactor, and other processing as defined in the embodiment herein this EFSMP perform, as part of the overall matrix of vertically integrated technologies, and which this is just but one part of such matrix. The embodiment herein, also addresses, in parallel, tandem, hybrid, stand alone, but not limited to the following description, but included as part of the integrated matrix a SMP in which is described as being that batteries, when such economics present themselves, are sorted and shredded and lead batteries are separated and treated in a specialized recycler. Nickel cadmium, nickel metal hydride and lithium ion batteries are treated by a separate process. Silver oxide button Cells are also taken for special treatment. The remaining zinc-chloride, zinc-air, alkaline and lithium button Cells and other button Cell batteries are recycled by Oxyreducer process, and the like, which involves treating them at very high temperature in a rotating hearth furnace or reactor. Button Cell batteries containing mercury are recycled using a vacuum-thermal treatment, in which the mercury vaporizes. The mercury condenses and eventually solidifies when temperatures are reduced and can then be re-used. Additionally, the Sulfuric Acid Plant when filtering and processing the fluids from the Spent Sulfuric Acid Lines, and Recycle Lines, are able to produce a level of purity of Sulfuric Acid of 98%. The embodiment herein, proposes different permeations of technologies, those mentioned herein are just an example, but not necessarily the preferred reduction to practice.

In further explanation of different matrix of services that are used in this embodiment, there may be additional sources of feed-stock material for this EFSMP are used oil, lubricants, hydraulic fluids, batteries, and such—which could be sourced from industrial sources such as military vessels, cargo ships, merchant vessels, cruise ships, airlines, airports, trains, fleet operations for commercial and non-commercial vehicles, the government (local, state, national, federal, etc. Additional collection of bulk material could also be from local and chain retailers, e.g., Pep Boys, Jiffy Lube, Luke Oil Service Stations, Goodyear, Sears, Costco, Harley Davidson, etc., with such collection of materials being franchised, outsourced, or owned by the refinery operation, similar to that of the Liberty Lakin description, previously addressed in the embodiment of this invention.

In collecting these waste materials, all of which can be broken down into useful components and can be recycled via different, and separate, technologies and methods—and these methods can be centrally located for inclusion into a new ecologically and environmentally responsible Super Refinery.

Batteries, which are picked up in an exchange program that State, Local, and Federal laws require, are generally cannibalized by the larger battery companies, like Johnson Control. When the spent batteries are not exchanged, there is a fee that is collected. However, this does not account for the large problem of illegal dumping of batteries. Additionally, a problem associated with batteries is what to do with the lead acid. There is a healthy secondary and tertiary market for different varieties and grades of lead acid. The same holds true for the battery casings, and the reduction/breakdown of the plastics into pellets. Almost 100% of battery-case plastics is repurchased and re-used by the battery manufacturers in the production of new battery casings and batteries. However, lead acid (typically H2SO4: Sulfuric Acid) is re-refined, and then sold off as glass cleaner or multi-surface cleaner, (in varying diluted strengths,) if not used for other commercial purposes. Additionally, there are numerous forms of Sulfur extraction, also known herein as desulfurization, and not limited to just that of Sulfur, but can also include Hydrogen extraction, from the EFSMP, in as much as metal-oxide sorbent/s, zeolite/s, silica/s, and the like, at different pressures, and various temperatures, are used on Oil Coke, Coal, gasses, and the like

Lead and other metals are typically refined via thermal metallurgy, and the embodiment herein goes beyond such rudimentary function to utilize infrared (I/R) technology and sintering SMP's to process such materials into a purified state; next, cast into ingot form for reuse in batteries and other products. Steel components are also recycled for production, whereas the electrolyte and sulfuric acid is treated in such a manner that it chemically reduces to anhydrous sodium sulfate: it is then supplied for use in the production of detergents, papers, glass, and for anodizing processes. The lead paste and oxides are de-sulfured with soda ash (recycled from the steel industry,) filtered, and reclaimed as metallic lead (through furnace refraction) for reuse in new batteries. Then polypropylene, ABS, and other plastics are cleaned, isolated, and sorted for reuse in production. Afterwards, grid separators, fiber edonites, and miscellaneous materials are cleaned and combined as reverbatory fuel filler. Finally, the remaining slag and industrial detritus are oxidized via high-temperature combustion into low toxicity granules. These are sent to licensed hazardous material disposal fills. Moreover, ingots and the material contained therein may also be derived from other EFSMP modules. Furthermore, subsidiary component materials maybe comprised of pellets, dust, blocks, and/or any other such forms or states as are feasibly and economically marketable (including, but not limited to solid, liquid, gas, and plasma states.) The invention embodiment herein incorporates Super Reactors and processes, similar to that of DuPont in which Sulfuric Acid is filtered, passed through a membrane of solid oxide fuel cells, broken down into Sulfur Oxide, Sulfur Trioxide, and the like, creating energy for local consumption, and then the effluent is then passed into a system where municipal water, filtered water, or on-site created water, is added, thus creating steam and heat, whereas the exothermic reaction is harnessed, as per Pinching Analysis, by steam turbines and the like, the effluent is then reconstituted into Sulfuric Acid, and electricity is created. Any steam from the exothermic reaction is then passed through scrubbers, and then the water is extracted and human toxins are removed.

The invention embodiment herein comprises a matrix of vertically integrated technologies, and SMP's, that represent either in stand alone, or in any combination thereof, for the removal of mercury, methylmercury, and the like, as well as other highly toxic and hazardous wastes. The embodiment herein, through various ESFMP's can separate/parcel, segregate, bifurcate mercury and in the ESFMP create what is known in the mining industry as Blue Powder. This Blue Powder also described as Ash, Char, and Coke, as mentioned earlier in the embodiment of this invention, is a powdered form of Mercury that can be used in the building material, construction process, and has other industrial applications, and is not released into the atmosphere through smoke stacks or exhaust. Such material is also known as coking, but not necessarily, always associated with the coke of the petroleum industry, or the soft drink market.

Additionally, the embodiment herein contains a matrix of Metallurgical, Mining, Smelting, and Refining technologies for ores, and ore products, in the form of Super Reactors, and Reactors, as described herein, of which is typically found in significant metal ore refining operations such as Nyrstar and Smelting, such systems, methods, and processes (SMP's) metallurgy and foundry, and blast furnaces, Imperial Sintering Plants, Autoclaves, and the like, in which they all independently process ore and ore bodies, this embodiment proposes the same, in combination, hybrid form, “daisy chained”, connected, and the like, for processing metals and ores, as well as those feeds that are described in the embodiment herein for feed stocks such as petroleum, crude oil, and the like, that employ such SMP's as this embodiment utilizes such as pyrometallurgical processes, hydrometallurgical or electrolytic processes, metal recovery, convection ovens, roasting, individually or in combination with any combination with electrolysis, but not limited to using either method, and either individually or in combination, or as a hybrid of an electrolytic process, also called the Roast-Leach-Electrowin (‘RLE’) process, since it has various advantages over the pyrometallurgical process (overall more energy-efficient, higher recovery rates, easier to automate hence higher productivity, etc.). for such materials used for feed stock, either solid, liquid, gas, gel, or plasma, regardless of their individual component, or combination therein of the Periodic Table of Elements, such as zinc is found within the same ore as lead, copper, silver, and gold, and the like, as well as crude oil, coal, and synthetic oil, also contain lead, and the like, and whereas, the embodiment herein could also be utilizing such efficiencies of an exothermic (and/or endothermic) autoclave leach process, where autoclave as a combination of the EFSMP described herein includes such definitions as sintering furnaces, blast furnaces, smelting furnaces, roasters, Infrared, Ultraviolet, laser, Nuclear, Microwave, and the like, and were as the EFSMP is enhanced by increasing the retention time of the solids fraction in the feed slurry over that of a liquid fraction. This is achieved by flashing the contents of the first oxidative autoclave compartment, also known as part of a reactor chamber, or a distillation tray chamber, to a flash vessel, with the underflow therefore passing to a thickener and the underflow from the thickener being fed to the autoclave feed tank or any tank upstream of the feed tank. Exothermic heat generated in the first compartment and is captured and is collected and directed to turbines, using Pinch Analysis for power generation and electricity. Additionally portions of the overflow are returned to the feed tank and fed to either another reactor chamber, or an autoclave discharge tank or the like. In another example of this embodiment, but not limited to, is that the Zinc is processed to create Sulfur and Sulfuric Acid, which is sent to the Sulfuric Acid Plant and the Thermal Atomization Reactor of such.

Additionally, the EFSMP herein utilizes, but is not limited to, the principle of separating pure metal from mixed metallic particles (MMPs) by vacuum metallurgy is that the vapor pressures of various metals, going through, but not limited to, atomization and distillation, at the same temperature are different. As a result, the metal with high vapor pressure and low boiling point can be separated from the mixed metals through distillation or sublimation, and then it can be recycled through condensation, and the like. Additionally bioleaching, as developed by the BacTech Mining Corporation, and tailings reclamation for metals, precious metals, and the like is proposed herein, and is not limited to being an isolated section of the matrix of technologies envisioned and included herein.

The present invention, in addition to petroleum, either crude or refined, is directed to a metal recovery EFSMP of the metals contained in the oils, or with which are used to derive the substances from ores used in oil refining, so as to create additional profit streams, where an economy exists for doing such, and in which includes, but is not limited to, nor to the exclusion of, basic ferric sulfates and/or jarosites are controlled by a number of mechanisms, including control of the oxidation reaction conditions, and the like, in the first autoclave reactor compartment, hot curing of the autoclave discharge slurry, and/or contacting of the autoclave feed slurry with the hot cured discharge liquid.

The embodiment herein, wherein also the EFSMP also utilizes reactors for Slag Fumers for zinc recovery, and in some instances, microwave heating, fiber optics, Laser Tunnel Ionization, and other methods for directing heat for SMP's can be utilized. Furthermore, the autoclave reactors (including CSTRs), tubular reactors, and combinations thereof are suitable.

A single reactor or a combination of reactors is used. The reactor/s can be lined with Teflon, specialized nanotubes, advanced ceramics, and the like, coated with Teflon, nanotubes, advanced ceramics, and the like, have Pyrex glass tubing, and the like, and any means of processing feed as is optimally required to maximize economic efficiency. The reactor design can be any that is suitable for high-pressure ethylene polymerization.

A means to deliver I/R and other spectrum of light, and the like are used, and described herein. In addition, those skilled in the art will recognize many variations that are within the spirit of the invention and scope of the claims.

The embodiment herein also employs a method, individually or in hybrid, or in any combination thereof, of making nanoparticles, nanotubes, ceramics, and advanced ceramics, included heating a reaction mixture in an autoclave reactor, or reactor chamber, or sintering furnace plant, or sintering furnace chamber (of which the inventors claim that the terms referenced herein are interchanged and used as descriptive definition of the invention described herein), where the reaction mixture includes a titanium, lithium, carbon, carbon soot, carbon gasses, carbon monoxide, carbon dioxide, carbon trioxide, graphite, coal, fullerenes, coal soot, coal ash, tire fiber fluff, fugitive effluents, nitrogen, non-metal, or other metal source, and a polar organic solvent, or other solvent, or solvent combination, as may be economically feasible. Furthermore, single walled nano-tubes, double walled nano-tubes, multi-walled nano-tubes, tubular and non-tubular nano's, nano graphite plates, and nano-graphite plate composites, and the like, by means and technologies not limited, but in combination with, in parallel, integrated matrix, stand-alone, and the like, incorporate such technologies as Fullerene Process, Laser Desorption Ionization Mass Spectroscopy of Fullerenes, HiPco Process, and the like.

Other uses of nano-technology is incorporated in the embodiment of this EFSMP in that such technology can be used to determine the type of feed stock, effluent, material, and the like, as well as the desired product (liquids, solids, gasses, fugitive gasses, precious metals, oils, acids, plasmas, and the like) that is required to be made, and such nano-technology can send the information across a communication network and send and receive instructions for programming and processing accordingly, so as to maximize the results and efficiency, and purity, of product, and the means in which the is handled. In the event self repair of the piping architecture is required, or additional reinforcement and the like is required by the user to maintain predetermined structural integrity, such nanotechnology can detect where the materials are needed, remove and combine such from any portion of the effluent, and via artificial intelligence, computer programming, flash programming, computer program interfacing, either independently or with instruction, can immediately effect repair, maintenance, and cleaning, so as to reduce downtime for maintenance, repair, cleaning, inspection, and the like. The material manipulation, configuration, and the like can either be preprogrammed into the nano-technology or communicated to such via the communication network, of which the network may or may not be relying upon an active user interface, but a set of protocols and standards, and such relaying of information, and the like, may be communicated in any numerous forms of media, as is related and taught in U.S. Pat. No. 6,016,307, and the like, and is incorporated herein by reference. Additionally, and without limitation, nanomaterials, nanotubes, etc., can be extruded in forming nanonet, nanolattice, nanofabric, and extruded woven materials for the construction of piping, tubes, reactors, reactor walls, reactor lining, tube lining, pipe lining, etc., where the nano membranes, nanonets, etc., of the embodiments piping architecture, Fuel Cells, etc. as described herein, and without limitation, continuously replaces any damaged nanomaterials with new ones, like self-regeneration is done in plants every hour, as described earlier within the embodiment of the EFSMP herein, and where as just as biologics as are connected within the membrane structure are symbiotic in that the DNA recognizes the dye molecules, and then the system spontaneously self-assembles, so to are compositions and materials within the nanomaterials able to do so. The functionality can be, without limitation, embedded, produced, manufactured, grown, etc., into extruded nanomaterials, nanotubes, and the like, whereas same can be used for, and in, extruded production of piping, and cylindrical, seemless tubing, Reactors, Furnances, Packings, etc., wherein same is self repairing and is also able to communicate within the monitoring and communication system of the EFSMP within the present embodiment. The extruded material may also have a lattice type of configuration, and the like, without limitation, so as to further assist in its manufacture and or functionality which also include embedded circuitry which is programmed to facilitate the purposes.

A method for obtaining, metal, gold, silver, lead, zinc, nickel, copper, in different forms of purity is provided in this EFSMP wherein is not limited to, but as an example of which oxygen, or enriched air, or air, or any other gas, is blown onto a melt, in a melting furnace (or reactor as defined herein) lined with refractory material, having a waste heat boiler set onto it, in order to oxidize contaminants, or change its form for collection, is contained in the melt and thereby remove them from the melt, and wherein a splash protection device through which fluid flows is provided above the ore melt, or metal melt, or (metal being defined as any element found in the Periodic Table, such as iron, carbon, gold, silver, copper, platinum, zinc, lead, and the like) on the inside wall of the melting furnace, which prevents copper, and the like, that splashes out of the melt (comprising any of the metals listed in the embodiment herein, either individually or in combination, regardless of the level of purity or impurity) from penetrating into the waste heat boiler. Boiling water, plasma, or any other fluid, or gas, is used for cooling the splash protection device, protection device.

Furthermore, precious metals such as gold, as well other elements categorized in this embodiment, can be extracted from a refractory ore, and petroleum streams using a conventional leaching step or a Super Reactor in which atomization is incorporated with thermal properties. The refractory ore, ores, metals, fluids, plasmas, feed stocks, and the like are also pretreated, when desired, by fine grinding and an initial leaching step, but is not limited to the restriction of such steps as to viability. Oxygen, also defined as gas, air, enhanced air, enhanced gasses, and the like, and is either individually or combined in any form, or in any pressure, or not under any pressure, is added to the initial leaching step and the conditions are carefully controlled to only partially oxidize the ground ore. Any step of the EFSMP can be carried out at any temperature or atmospheric pressures without limitation or restriction. The pre-treated ore is then leached to recover the precious metal.

Extractions of metals has been previously achieved by smelting, or burning, of sulfide ores or concentrates, and the like, and is a limitation of their individual technologies, all of which are not part of a combined matrix of integrated technologies, as is described in the embodiment of this EFSMP. Concentration of metal sulfides into a smaller mass is often performed prior to smelting or bioleaching, and is again, a limitation, as these are the more expensive parts of an overall operation, and although economically efficient, smelting produces noxious S02 emissions that create acid rain. Bioleaching produces no offensive gases as it is a hydrometallurgical form of treatment. The embodiment herein of this EFSMP utilizes technologies of powder metals, and atomization, and is not limited by the previous descriptions.

Carbon Capture, as per the Kyoto Protocol and United Nations (UN) worldwide agreements, as well as Maximum Achievable Control Technology (MACT), which is defined as the emissions level of the best performing 12 percent of coal plants, and approaches known as the Clear Skies Initiative, as well as what the United States Environmental Protection Agency (EPA) attempted to bring via regulatory amendments., whereas in 2005 EPA issued rules exempting coal plants from MACT requirements and instead setting up a “cap and trade” system, allowing plants with stronger controls to sell pollution credits to plants with weaker controls is included in the embodiment herein. Furthermore, such Carbon Capture Trading Credits, Credits, and collected emissions, and the like are a non-intrinsic, or intrinsic as the case may be, product of this EFSMP Embodiment. The EFSMP of this embodiment described herein has a Negative Carbon Footprint. As such, Carbon Capture can be turned into Carbon Credits for Trading on any of the world wide exchanges, in any form (actual, hypothecated, futures, etc, and the like), and is a source of revenue that can also be used inter, intra, domestic, foreign, national, international, state, and local, for exchange by and between Governmental bodies for credit, money, supplies, and any other form of economic gain. Additionally the EFSMP herein, utilizes such technologies for Carbon sequestration as being to include principals in which CO2 is recovered from combustion exhaust by using amine absorbers and cryogenic coolers. Other methods for Carbon Capture and Storage (CCS) for CO2 (aka Carbon Dioxide) also include those for compression of same, and can and does include methods for physically marketing the same by means of transporting it, injecting it into suitable permanent storage sites, such as deep underground formations, and the like, for trading on exchanges. Such examples, by way of inclusion as referenced herein would be the Cranfield in Southwestern Mississippi. The purpose of which this embodiment of the EFSMP described herein is to also reduce CO2, Greenhouse gasses, greenhouse gas emissions, and the like as is and was typically found in previous oil refineries in their various permeations and embodiments. The EFSMP embodiment herein is further designed to mitigate and minimize the effect of oil refining, regardless of re-refined oil, crude oil, white oil, and other materials as described herein, that would have a negative effect on global climate change, and to meet or exceed global CO2 atmospheric reduction goals.

The EFSMP of the embodiment herein also includes the sale of Carbon Dioxide, and the like. Carbon Credits, carbon, CO2, and the like are also saleable products, which are captured, stored, and used by, and amongst the Petroleum industry. An example of such utilization is found in the Dakota's Gasification Projects that sells its CO2 to the aging oil fields of southeastern Saskatchewan, in the process burying more CO2 in a year than 100,000 cars release in their operational lifetime. CO2, in the embodiment of the EFSMP, instead of being a liability, is actually a saleable byproduct.

Wherein the EFSMP is a matrix of vertically integrated technologies, similar to that of the Dakota Gasification Operation, in that it is connected to, or has its own onsite (inter or intra as is economically desired in the preferred embodiment herein) a pipeline full of carbon dioxide. The CO2 plunges a kilometer and a half below the earth's surface into thick, stubborn oil deposits. Above ground storage is also included in the EFSMP herein, as may be required, or preferred, as economical and determined, and whereas if the CO2 is pumped underground for purposes of replacing or adding to oil reserves, natural gas reserves, and the like, in an Upstream manner, as the Petroleum industry refers to, and of which a Magazine and Website, incorporated herein by reference (www.upstream.com), either land based, terrestrial based, oceanic, aquatic, marsh, celestial, and the like, where the CO2 cuts the oil's viscosity by a factor (for example: four) and eases its flow to the surface. Once in the ground, the carbon dioxide takes the petroleum's (and other oils and gasses) place, becoming trapped beneath an impermeable stack of rock, limestone, sandstone, shale, sand, dirt, mud, marsh, and the like.

Additionally, this EFSMP utilizes technology, in hybrid, combination, parallel, or individually wherein coal and steam reacted together may be at 1,000 degrees Celsius to yield a gaseous mixture of hydrogen, carbon monoxide, and CO2 (plus contaminants such as sulfur, mercury, and xenon gas), however as included herein, and throughout this embodiment, the temperatures are a proposed range and are not a limitation of the functionality or utility of the EFSMP. Pure CO2 and contaminant streams were bled off, and the remaining carbon monoxide and hydrogen—a mixture known as synthesis gas or “syngas”—is fed to a catalyst to form hydrocarbons.

The EFSMP of an embodiment of this invention also utilizes Carbon as a product for the creating of nanotubes. The Super Reactor creating the nanotubes also utilizes metals, and fibers, from the processing and extraction methods previously described herein, to provide different properties of the nanotubes, as well as for advanced ceramics, and advanced carbon ceramics and fluff, from tire vulcanization. For example, is another source of material that can be added to the nanotube production, depending upon user requirements, and system demands. Furthermore, when Carbon exhaust streams are mixed and/or sprayed with liquids, like Seawater, so that cement can be created, as per the methods employed and utilized by Calera, Inc.

The EFSMP employs technologies for Coal Gasification's in which industrial CO2 is pooled underground, or above ground, as may be required by the user, in creating an environmental benefit that could economic value as well as political (domestic and international) value in adaptations in cap-and-trade emissions policy or policies.

In another embodiment of this EFSMP, technologies as are utilized in Coal gasification included herein, whereas, the gasification offers one of the most versatile and clean ways to convert coal into electricity, hydrogen, and other valuable energy products.

Coal gasification electric power plants are now operating commercially in the United States and in other nations, and many experts predict that coal gasification will be at the heart of future generations of clean coal technology plants.

Rather than burning coal directly, gasification (a thermo-chemical process) breaks down coal—or virtually any carbon-based feedstock—into its basic chemical constituents. In a modern gasifier, coal is typically exposed to steam and carefully controlled amounts of air or oxygen under high temperatures and pressures. Under these conditions, molecules in coal break apart, initiating chemical reactions that typically produce a mixture of carbon monoxide, hydrogen and other gaseous compounds.

The environmental benefits of gasification, autoclaving, and the like, as well as other methods as described herein, either in combination or stand alone, and either as a series of parallel reactors or individual reactors, stem from the capability to achieve extremely low SOx, NOx and particulate emissions from burning coal-derived gases. Sulfur in coal, for example, is converted to hydrogen sulfide and can be captured by processes presently used in the chemical industry. In some methods, the sulfur can be extracted in either a liquid or solid form that can be sold commercially. In an Integrated Gasification Combined-Cycle (IGCC) plant, the syngas produced is virtually free of fuel-bound nitrogen. NOx from the gas turbine is limited to thermal NOx. Diluting the syngas allows for NOx emissions as low as 15 parts per million. Selective Catalytic Reduction (SCR) can be used to reach levels comparable to firing with natural gas if required to meet more stringent emission levels. Other advanced emission control processes are being developed that could reduce NOx from hydrogen fired turbines to as low as two parts per million.

Additionally, the EFSMP of the embodiment herein also uses technologies, but is not limited to, and is done in stand alone, combination, hybrid, and parallel, for the liquefaction processes, which are classified as direct conversion to liquids processes and indirect conversion to liquids processes. Direct processes are carbonization and hydrogenation. Pyrolysis and carbonization processes See also: Karrick process.

While there are a number of carbonization processes. The carbonization conversion occurs through, but is not limited to, pyrolysis or destructive distillation, and it produces condensable coal tar, oil and water vapor, non-condensable synthetic gas, and a solid residue-char. The condensed coal tar and oil are then further processed by hydrogenation to remove sulfur and nitrogen species, after which they are processed into fuels.

Efficiency gains are another benefit of coal gasification. In a typical coal combustion-based power plant, heat from burning coal is used to boil water, making steam that drives a steam turbine-generator. In some coal combustion-based power plants, only a third of the energy value of coal is actually converted into electricity.

A coal gasification power plant, however, typically gets dual duty from the gases it produces. First, the coal gases, cleaned of impurities, are fired in a gas turbine—much like natural gas—to generate one source of electricity. The hot exhaust of the gas turbine, and some of the heat generated in the gasification process, is then used to generate steam for use in a steam turbine-generator. This dual source of electric power, called a “combined cycle” is much more efficient in converting coal's energy into usable electricity. The fuel efficiency of a coal gasification power plant in this type of combined cycle can potentially be boosted to fifty percent or more.

Future concepts that incorporate, and is incorporated in the embodiment herein of this EFSMP, are that of a fuel cell, in stand alone, combination, parallel, hybrid, and the like, as well as fuel cell-gas turbine hybrid could achieve efficiencies nearly twice today's typical coal combustion plants, if not better. If any of the remaining heat can be channeled into process steam or heat, perhaps for nearby factories or district heating plants, the overall fuel use efficiency of future gasification plants could reach seventy to eighty percent. Additionally, but without limitation, excess methane, and other gasses, from coal production, gasification, utilization, and the like, that is not run into Fuel Cells, internal power generation, and the like is run/converted into water Fuel Cells are also known as Solid Oxide Fuel Cells, and the like, and can use any feed stream, combination, hybrid, parallel, and the like; of which several types of sources of feed streams are H2SO4, H2CO3 H2O, H2C02, H2SOx, methane, ammonia, hydrogen, and the like.

Higher efficiencies translate into more economical electric power and potential savings for ratepayers. A more efficient plant also uses less fuel to generate power, meaning that less carbon dioxide is produced. In fact, coal gasification power processes under development by the Energy Department could cut the formation of carbon dioxide by forty percent or more, per unit of output, compared to today's conventional coal-burning plant.

The capability to produce electricity, hydrogen, chemicals, or various combinations while eliminating nearly all air pollutants and potentially greenhouse gas emissions makes coal gasification one of the most promising technologies for energy plants of the future.

The embodiment herein, either in tandem, parallel, hybrid, combination, individually, and the like, provides a way for coal particles to be continuously cleaned from reactors by means of sonic wave technologies, which knocks off the carbon soot from charcoal, coal, etc., off the walls of the pyrolysis reactors, and chambers, and other sections of the EFSMP, to then process in sintering for clumping, then into Isa Melting, with flash oxygen injection, creating an instant high temp burn, for further processing into a autoclave for movement into hydrogenation for production of carbon black, back into additional oil extraction—possibly additional hydrogen extraction, and the like.

The EFSMP of this invention embodiment includes pressure-response monitoring techniques, real-time data collection, reporting, monitoring verification, and accounting (MVA) technologies and carbon dioxide capture technologies for Carbon Dioxide Gasses traded on, and collected for, and produced by the EFSMP for sale and or credit on any exchange or for economic gain.

Representative bath smelters include those operated by Noranda Inc. at its Horne, Canada facility; Mitsubishi Materials Corporation at its Naoshima, Japan facility; and Isa melt at its Mt. Isa, Australia facility, as well as various SMP's contained in Nystar's Australia and other global operations. Representative flash smelters include those operated by Outokumpu Oy at its Harjavalta, Finland facility, and Inco Limited at its Sudbury, Canada facility. Because flash smelting furnaces can be operated in a manner more consistent with existing and foreseeable environmental regulations than bath smelting furnaces (they are more readily sealed against fugitive gas and particulate emissions than bath furnaces), flash smelting furnaces are the preferred smelting furnaces for use in this invention, though not necessarily as an individual SMP, but can also be in tandem or as part of a Hybrid Reactor, as described in this embodiment.

In certain embodiments of this invention, the concentrate and other feed components to the flash furnace are reduced to fine particle size by any conventional technique, e.g. ball mill or vertical roller grinding. The furnace is operated in conventional fashion, and the concentrate is transformed into an essentially quiescent pool of molten matte and slag within the confines of the furnace. The matte and slag are allowed to separate within the Reactor, or Reactor Chamber, or Hybrid Reactor Chamber, or Hybrid Reactor (hereby known as a Reactor), (slag floats to the top of the matte because it is less dense than the matte), and the molten matte and slag are removed separately. The slag is removed from the chamber by skimming it from the surface of the matte through one or more appropriately located tap holes or skimbay openings in one or more walls of the Reactor or Reactor's chambers. It is collected in a conventional transport vessel, and then it is removed from the Reactor site for further processing or disposal. The molten matte is drained from the Reactor Chamber through one or more appropriately located tap holes (usually different from those used to remove the slag), in one or more walls of the EFSMP Reactor, and then solidified. A Tap Hole can also be in any distillation compartment of the autoclaving sinter reactor.

Any process and apparatus that will solidify molten matte can be used in the practice of this invention. These processes include, but are not limited to, water and air granulation, casting, and a cooled vibrating plate, and the like.

The EFSMP Reactor also includes a means for molten matte solidification in a SMP known as water granulation. Two types of water granulation techniques are water spray and mechanical dispersion, however the embodiment herein is not limited to the use of either one, nor in using one over the other, and can use them both in tandem. In the water spray technique, molten matte is simply poured through a spray or curtain of which results in a rapid quench of the matte and the granules or particles are cool to the touch within a few tenths of a second of formation, and little, if any, fugitive gases, volatile heavy metals, or particulate matter is created.

Mechanical dispersion also produces granules that are cool to the touch within a few tenths of a second of formation and with little, if any, formation of fugitive gases, heavy metals or particles.

Regardless of the process used to solidify the molten matte, preferably the solidified matte is subjected to a size reduction step before it is fed to another Chamber or Reactor of the EFSMP. The solidified matte can be reduced in size by any conventional technique.

The EFSMP Reactor can also include Converting furnaces, which are basically of two types, flash (also known as suspension) and bath, and the purpose of both furnaces is to oxidize, e.g. convert, the metal sulfides to metal oxides. Representative bath furnaces include those used by Noranda Inc. at its Horne, Canada facility, and Inco Limited at its Sudbury, Canada facility. Representative flash converting furnaces include those used by Outokumpu Oy at its Harjavalta, Finland facility, and the KHD Contop Cyclone furnace used by Asarco at its El Paso, Tex. facility. The EFSMP Reactor flash converting furnace raises the precious metal concentration in the matte to a greater purity percent by weight.

The removal of the blister precious metals, slag, and the like, from the Reactor's flash furnace is preferably accomplished through the use of a continuous blister tapper (CBT) as opposed to one or more tap holes (although these can be used if desired). The design and operation of the CBT can vary to convenience, but preferably it is attached to the furnace in such a manner that the blister is continuously transferred from the furnace to the CBT while the slag is retained in the EFSMP reactor.

In the embodiment of the invention herein, the Thermal Conversion Atomization Reactor and the EFSMP contains a combination of a matrix of technologies that include common off the shelf (COTS) technologies from industries, and different manufacturers that are not related to the oil refining industry, but yet have products that can be vertically integrated to create the invention herein. Such types of other forms of SMP's are those technologies that can perform Thermal Conversion Atomization and Processing are those like that of Convection Oven, Microwave, Sound waves, ultrasound, photo, (laser, light, optical, ultraviolet, gamma radiation, and the such), Magnetic Resonance Imaging Pulses, metamaterials, metamaterial rare earth magnets, cavitation with metamaterials, sonic heating with metamaterial radiation, nuclear imaging, tesla technologies and the like, without limitation.

A method and apparatus for curing tires or similar vulcanized products, and their related slurry to be used in, or as feed stock, in a press or autoclave equipped with separable molds with inserted bladders, tubes, bags, or bladderless center mechanisms. During the principle shaping and vulcanizing period, the bladder is first filled with steam, from hydrogen, water, ammonia, synthetic ammonia; aqueous ammonia, anhydrous ammonia, and any other gas hereinafter known as steam to conform the bladder to its contents begin the cure. The steam is then flushed and replaced with water, or any other fluid, to continue pressure molding and curing of the contents. In the next phase of the curing cycle, inert gas at a high pressure is introduced to force the water from the bladder, without vaporization or significant loss of heat, back to storage facilities for subsequent reuse. In the final phase of the shaping and curing cycle, the inert gas is evacuated from the bladder, and collected for reuse, by means of a vacuum tank or vacuum pump, if no cooling of the product is desired, or by the introduction of high pressure cold water for the final cooling and shaping period of the cycle, whereupon the water is flushed and extracted from the bladder and the contents are removed from the mold. By employing this process and the associated apparatus and system, the water is not mixed, with resultant loss of temperature, thereby yielding substantial energy savings without omitting or foreshortening the cold water cooling and shaping step necessary to insure tire quality and prevent deformation.

The embodiment herein also describes and EFSMP for an electroceramic component, for example a varistor, comprises a laser irradiation of a part of the surface of an electroceramic body before a metallization is applied to the part of the surface.

Methods for EFSMP Thermal Conversion Atomization Reactor of processing precious metals, for example but are not limited to such metals as aluminum, copper, zinc, lead, gold, silver, include, High Flux Heaters, sintering, and/or the like powder comprise technologies such as, but are not limited to, atomization, electrowinning (see U.S. Pat. No. 6,558,527, and incorporated herein by reference), Isothermal Melting Processes (ITM), decoating metals using indirect-fired controlled atmosphere (IDEX) kilns, and the like, as well as, either in tandem, hybrid, parallel, or stand alone, in such that providing powder and heating the powder in a nitrogen, or other gas, atmosphere containing a partial pressure of water vapor. The aluminum, copper, zinc, lead, gold, silver, and/or the like powder is not pressed together by a mechanical force that substantially deforms particles of the powder either prior to or during the step of heating. Articles comprising sintered aluminum powder. The microstructure of the sintered aluminum, copper, zinc, lead, gold, silver, and/or the like powder contains no compositional concentration gradients indicative of the use of a sintering aid and no evidence of particle deformation having occurred by an application of a mechanical force prior to or during the sintering of the powder. Additionally, in a controlled atmosphere environment, as envisioned, and incorporated herein, such technologies are incorporated for Oxidizing, and Reducing of Solids, Metals, Gasses, Plasmas, Liquids, and the like, and whereas such Purity Control Monitoring and other methods, but not limited to that of, multiple atmospheres (in difference chambers of a Reactor, or in Parallel, Tandem, Hybrid configurations) exist. Such technology can also be used for Corrosive Atmosphere, Fugitive Gas, and Toxic Effluent manipulation. The embodiment of this EFSMP is one of a matrix of technologies in which in addition to Carbon Fiber, and Advanced Composite Materials, Advanced Ceramics, and Advance Carbons, Advanced Metals (e.g. Aluminum) is a product, and can be used for the production of Nanotechnology as well. Aluminum-Graphite composite, for example, for automobiles and engineering applications, metal coatings, and other forms of advanced materials all require the Carbon that is created as byproduct of the embodiment herein, and is produced herein as a saleable product. U.S. Pat. No. 4,946,647, incorporated herein by reference, is but one example of how to manufacture Aluminum-Graphite, but is limited, and as such, that limitation is not a detriment to the matrix of technologies of this embodiment.

Composite materials refer to a combination of several materials which provide unique combination of properties that cannot be realized by the individual components acting alone. Composite materials offer many improvements over the base materials, properties such as bearing, lubricating, damping and machineability can be appreciably enhanced.

As part of the EFSMP, described in the embodiment herein, the ability for the system self repair itself, by communicating in a machine to machine (MTM) manner with reports for such steps done autonomously and with the software that performs a functional Artificial Intelligence to act as a Sintering Repairman, so to say, in that the EFSMP detects issues of service and repair in as much as such detection is done fiber optically, or via some other detection product, method and device, where Carbon particles, such as, carbon fibrils and carbon nanotube molecules, may be assembled by the EFSMP into substantially pure aligned fibers or Composites and the like, as is needed by the structural demands and protocol of such EFSMP at the site of treatment and attention, and the like by dispersing the carbon particles within a curable liquid, aligning the carbon particles by flowing the mixture of curable liquid and carbon particles down a tapering tube, and curing the flowing mixture of curable liquid and carbon particles, creating a molecular fiber, so to say, in the general vicinity of the end of the tapering tube to form a fiber. The curable liquid may be cured using ultraviolet light, infra red, microwave, heat, air, gasses, cavitation, metamaterial energies, and the like, without limitation. The solidified mixture may be further processed by heating the fiber so as to cause the volatile elements of the solidified curable liquid portion to substantially dissipate from the fiber, twisting the fiber to increase its density, heating the fiber to sinter the carbon particles within the fiber, and cladding the fiber. The resulting fiber will serve as a temporary patch, repair, at the least, until such time additional permanent repairs can be performed in the event such immediate repair was and is unsatisfactory for economic viability and safety of the EFSMP.

Such slag refining is used for the in-house refinery products such as the lead materials found in lead/acid batteries and their recycling, zinc and zinc ores used in-house to make sulfuric acid, and for lithium and any/all other materials as found in the lithium batteries.

As stated before, there are a few well-known, large companies that do oil re-refining, and that re-package, and sell these oils back into the stream of commerce once again as lubricants. However, EPA guidelines and regulations restrict such operations from becoming full blown refineries in their current configurations or locations. The embodiment herein does not have such restrictions, and as a refinery, processor, and re-refinery, the EPA does not impose such limitations upon the present invention.

The present EFSMP will produce, process, and extract a stable supply of petroleum products, and proposes using oil feed stocks, including, but not limited to: hydrocarbon compounds, light oil, heavy oil, black oil, tank bottom oil, shale, oil sands, bitumen, coal, coil oil, coal pyrolysis, synthetic fuels derived from coal, coal pyrolysis and char combustion, char oxidation, biotreatment sludge's generated on site of the on-campus facility, interceptor sludge, waste water treatment sludge, contaminated oil, desalter sludge, oil spill debris, filter clay acid, tar rags, filter materials, packing, lagging, activated carbon, transformer oils, engine oils, oil filter, engine oil filter, pyrolysis, tire oil pyrolysis, rubber pyrolysis, pyrolysis sludge, used lubricant, used lubricant oil, refuse oil, and the like. By doing so, product loss is prevented, and increase profits by lowering costs of feed stocks by refining these materials, and adding them to either finished products, or feed stocks—either in a blended EFSMP, or as a separate feed. Forms of reverse osmosis, for feed lines, placed in different locations may be utilized as well, as a means of water filtration. Additionally, the EFSMP, through production, refinement, processing, molecular changing, atomization, and creation of feed streams, feedstocks, waste streams, gasses, fugitive gasses, liquids, effluents, sorbents, metals, powdered metals, atomized metals, and the like, with the inclusion of same, but not limited in any combination such products, at varying temperatures that are in the reactors, and exposed to such either in combination, parallel, hybrid, tandem, or stand alone, as is the desired methodology by the user, of such items as Carbon Black, Carbon, Advanced Ceramics, Ceramics, Clay, Advance Carbon, and Nanotubes, nanotechnology composites, and other medium, and the like, the embodiment is able to utilize such products for water filtration, by way of upgrading, refurbishing, recycled, regenerated, filtered, changing properties, and the like, of the medium in any permeation of the reactor, in such that sorbents are able to be created and reused in house, without the need to seek external sources of filtration media for processes taking place, and required by the EFSMP. Furthermore, the invention herein, and in the self sufficient manner in which materials are used and utilized in house, can separate water, to subatomic levels, wherein hydrogen is split off, and tanked, for either sale, or later use as core materials for water or acid, or any other use that each SMSA facility requires, or is requested to share amongst the overall corporate structure, based upon either user needs or system requirements. Impurities are then separated, and refined to create carbon black, or through the centrifugal configuration of white thin film processing, sorted into viable products.

Additionally, the embodiment herein, utilizes technologies that facilitate ultrapure water, as may be needed for the super critical boilers, and the reactors used in the power production in of the EFSMP herein, and where water of great purity is needed to clean semiconductor wafers, and the like, and where water used for external sale as a product, similar to that of quality used in chemicals, and drugs, or electronics, and the like, whereas such chemicals and drugs injected into the human body must also be ultrapure, the EFSMP filtrations system herein can purify liquid and water streams to meet user demands. Additionally, as there is a large and growing market for equipment and materials needed to meet the purity requirements, the EFSMP herein is situated to capture market requirements for production of such high quality water, in such that systems, components, piping, filters, degasifiers, and chemicals are used to facilitate the necessary standards. As such, the EFSMP utilizes reactors, thermal conversion units, plants, and other such technologies in such combination as, but is not limited to those of Reverse osmosis systems, Ion exchange systems, Instruments and controls, Degasification, Filtration, Pumps and valves, Storage and piping, Disinfection, Construction, Heaters, Distillation, Steam and Hot Water, Sludge treatment, and the like.

Further, the embodiment of the EFSMP herein utilizes technologies and apparatus for treating sludge, and other effluent, and sorbent streams and the like, and comprises a press for dewatering the sludge, a compaction device for receiving and compacting sludge dewatered by the press, a shredder for receiving and shredding sludge compacted by the compaction device, and a tube conveyor for conveying shredded sludge from the shredder. The press is controlled to vary the flow rate of the sludge in response to at least one sensed operational parameter of the press, such as the momentary power for operating the press, pressure in the sludge in the press, sludge concentration in the press, sludge feed flow to the press or separated water flow from the press.

Preparation of white mineral oil generally includes one or more upgrading steps for purifying the oil. Common upgrading steps include hydro treating, hydrogenation, filtering, solvent refining, and dewaxing.

Additionally, Thermal Super Reactor Feed Exposures of the embodiment herein can be either, Direct contact or Indirect contact, high pressure, low pressure, ambient pressure, low heat, high heat, ambient temperature, or a combination and hybrid of both/all, in any sequence, repetitively or in stream. The Embodiment of the EFSMP herein is for Carbon based petroleum products, and the material processing for in-house intra-supply serviceability therein for self sufficiency and being a closed loop facility for oil refining, and oil re-refining, and power generation.

With regard to waste water treatment, via processes such as desouring, the embodiment herein also includes an EFSMP Thermal Atomization Reactor using dissolved air flotation, venturi, protein skimmers, biological, optical, chemical, physical, mechanical, thermal, and waste recovery. Additionally, such filtration systems, such as Venturi system with a Protein Skimmer attached, in some embodiments, the intake of the Venturi System can be hooked up to utilize more than just air, and utilize gasses, other liquids, solids, metals, plasmas and the like. Metals for example, could be such as those of Aluminum (in various states), and or other chemicals, wherein if the feed is not directly from an aluminum source, the feed line could be come from the aluminum derived from the lubricant feed that enters into the EFSMP. Furthermore, in the embodiment of waste water treatment, our EFSMP is similar to the Chevron products; that are similar to the Sox from the Flexicoker, and/or LC Fining Unit; that are like the Marsulex ammonia-based, flue gas, and desulphurization technology, where in ammonia is a byproduct, used, and sold as is economically and commercially desired. Hydrogen sulfide water and hydrogen sulfide steam can be used as additional byproducts of the EFSMP, providing further, numerous economic advantages, methodologies, and combinations.

This embodiment of the EFSMP herein utilizes a matrix of vertically integrated technologies and thermal conversion atomization super reactors, whether individually, in combination, in hybrid form, in stand alone form, in parallel, and the like, wherein Methane, Hydrogen, Off gasses, from water treatment, coal gasification, coal processing, coal roasting, coal sintering, coal pyrolysis, fugitive gasses and the like, as well as the general functions of the EFSMP, and the like, are fed into the Power Generation of each location, as a matrix of feeds, that fuel burners, of which the heat energy is recaptured by steam turbines, or such gasses are used as feeds for fuel cells, and the like in order to reduce costs and being self contained and self sufficient and independent of needing to rely on the Public Utility Grid (similar to that of Florida Power and Light, Duke Power, and the like), thus reducing costs of production of materials, and reducing operating costs. Such Power Generation may also be sold back to the Utility as needed, in the event there is an excess capacity.

Additionally, the matrix of the embodiment utilizes various gasification principles, including, but not limited to fossil fuel reforming, and the like, and are defined herein as part of this invention, which can also produce hydrogen, methane, and as an application, and use of other gasses, from coal, oil, natural gas, and other resources and materials as included and described herein, an example of which, is illustrated as Hydrogen and Methane which can be produced from coal by gasification (e.g., partial oxidation), and is defined herein as similar to both a Klaus (aka Claus), Merox, Amine Treating with steam, Pyrolysis technologies, Flash Pyrolysis (incorporated herein by reference to U.S. Pat. No. 4,309,270), Pyrolic Oxidation, Sintering, Isamelting, Osomelting, Sonic Melting, Microwave technologies, laser, optical, chemical melts, Blast Furnace, Fire Assaying, electrostatic precipitation, distillation (and the like), vacuum distillation as is used for Dore, and Autoclave, and as is further described and disclosed herein as a Reactor. Such Reactors, depending upon their specific use, within different industry (Metallurgy, Coal, Mineralogy, Oil Refining, Chemical processing, Fuel Production, Mining, Ore processing, Re-refining, and the like) have different names, but are in essence the same equipment, and as such, such technologies are referred to herein as Thermal Conversion Atomization Reactors (whether in parallel, free-standing, isolated, in hybrid, combination, permeation, and the like). Such terms as those listed in this paragraph, and throughout this embodiment can, and will be, interchanged, without specific purpose or limitation. For purposes of illustration, by means of example, and included herein, as part of the embodiment of this application, Coal gasification works by first reacting coal with oxygen and steam under high pressures and temperatures to form synthesis gas, a mixture consisting primarily of carbon monoxide and hydrogen. The synthesis gas is cleaned of impurities and the carbon monoxide in the gas mixture is reacted with steam via the water-gas shift reaction to produce additional hydrogen and carbon dioxide. Hydrogen is removed by a separation system and the highly concentrated CO2 stream can subsequently be captured and sequestered. Furthermore, the EFSMP could handle the carbon dioxide produced in the hydrogen production process and bifurcate it for further capture, use, and processing by technologies now being developed in DOE's Carbon Sequestration Program and eventually demonstrated in other activities by the Office of Clean Coal.

The hydrogen from coal production include: advanced water-gas shift technologies, advanced hydrogen separation, development of polishing filters, advanced CO2 separations, advanced concepts, and demonstrations. Polygeneration will explore the concept of co-producing high-value chemicals and carbon products in hydrogen from coal plants.

The use of coal to produce hydrogen for the transportation sector can reduce America's total energy use and its reliance on imported petroleum while helping to create jobs through the creation of a domestic industry. The production of hydrogen from coal also offers environmental benefits when integrated with advanced technologies in coal gasification, power production, and carbon sequestration. The integration of these technologies facilitates the capture of multiple pollutants such as sulfur oxides, nitrogen oxides, mercury, and particulates, as well as greenhouse gases such as carbon dioxide. When hydrogen is used in efficient fuel Cell vehicles, emissions from the transportation sector can be nearly eliminated.

This embodiment of this invention utilizes water management principles such as water pinch analysis and water pinch analysis (WPA) originates from the concept of heat pinch analysis. WPA is a systematic technique for reducing water consumption and wastewater generation through integration of water-using activities or processes. WPA was first introduced by Wang and Smith. Since then, it has been widely used as a tool for water conservation in industrial process plants.

Techniques for setting targets for maximum water recovery capable of handling any type of water-using operation including mass-transfer-based and non-mass-transfer based systems include the source and sink composite curves and water cascade analysis (WCA). The source and sink composite curves is a graphical tool for setting water recovery targets as well as for design of water recovery networks. Reclaimed water, sometimes called recycled water, is former wastewater (sewage) that has been treated to remove solids and certain impurities, and then allowed to recharge the aquifer rather than being discharged to surface water. This recharging is often done by using the treated wastewater for irrigation. In most locations, it is only intended to be used for nonpotable uses, such as irrigation, dust control, and fire suppression, and there is controversy about possible health and environmental effects for those uses. In some locations, including Singapore and California's Orange County, it is given more advanced treatment and is used indirectly for drinking.

This generator uses, but is not limited to, salt, water and electricity, and the like, to make the water drinkable, when economical, or remain potable, as desired by the user or political requirements.

Furthermore, in the numerous areas of exhaust and heat exchange, scrubbers, and the like, the embodiment herein utilizes technologies, in combination, parallel, in situ, hybrid, or stand alone, in a reactor or other such technology, whereas such as those are of, but not limited to, those of LexCarb LLC, whereas it has been demonstrated that the water in the exhaust could be collected and purified to drinking water standards, which led to further work to understand the fundamental concepts and apply them to the development of an optimized system. The primary combustion products of diesel fuel are water and carbon dioxide:

C12H22+17.5O2→11H2O+12CO2

And whereas, for example, but without limitation, to recover water the exhaust gas is be cooled below its dew point, thus initiating condensation. The quantity of water collected is a function of the volume of air treated and the difference between the concentration of water in the exhaust gas and in the cooled saturated exhaust exiting the system. A heat exchanger, and the like, but without limitation, is then designed based on the calculations and preliminary measurements of temperature and flow of the exhaust gas.

Filtration, for example, can be of activated carbon fiber monolith (ACF), and the like, of the ACF being created from Carbon Black, and other Hydrocarbon products from the refinery, nanotubes, advanced nano technologies, and advanced ceramics, but not limited to such, and ion exchange resin. The ACF, and the like, can remove small organics, and the ion exchange material is effective in removing all inorganics, and the like. The ion exchange material also has a capacity to remove polar organics reduce TOC. The EFSMP can be used to optimize the water purification process. Additionally, atmospheric humidity is the most widely and evenly distributed source of water on earth. Additionally, an embodiment of this EFSMP creates Carbon Fiber, and or nanotubes, from Carbon generated as a product of the SMP's herein, and include such examples of Carbon fiber is mainly made from a polymer called polyacrylonitrile (PAN) by drawing/spinning a filament, passing through a specific oxidation heat treating, carbonizing heat treating and surface treatment process, with the spinning techniques, non mechanical water treatment, and the like, used in industry, but not limited to, are those such as wet spinning, sedimentation, centrifugation, evaporation technologies, dry spinning, air gap spinning and melt spinning. The various heating process steps include oxidation, pre-carburizing and carbonizing. The main surface treatment processes include electrolyte, washing and sizing, and the like. The other sources of the carbon fiber to produce from are petroleum or coal based pitch (pitch precursor) and rayon (cellulosic precursor), all of which are products created, or are byproducts of processing, within the EFSMP, and have been described herein. In addition to the previous description described herein, the EFSMP employs design and technology in Advanced in heating element design and insulation packages, which have greatly reduced energy consumption—like those of making Harpers International, carbon fiber LT, HT, and UHT furnace systems, as well as utilizing, but not limited to atmosphere purge chambers, where such chambers, individually, or in tandem, parallel, hybrid, and the like, improve product quality and extend the useful life of the insulation, and whereas such can also effectively stripping incoming material of entrained particulate.

Promising technologies under development by the Army and DARPA such as, humidity concentration using zeolite and chemically surface modified activated carbon combined with innovative low energy condensation concepts are incorporated herein by reference.

An additional form of the embodiment, without limitation, utilizes Coal Roaster Furnace Reactors, and the like, herein also known as, but not limited to, a Reactor and or Reactors, in such that the Coal produces Methane. Additionally, included herein are rotary reactor sealing systems, and the like, providing optimal rotary tube furnace atmosphere integrity with minimal gas consumption. And, wherein such Methane, or other gasses, according to ExxonMobil U.S. Pat. No. 7,659,437, and incorporated herein by reference, generates water in an EFSMP, wherein an effluent from the coal comprises methane, hydrogen, and other gasses and the like, and whereas hydrogen, and hydrogen derived and separated from the effluent and the methane, and the like further comprises: a) separating at least part of the hydrogen from the first effluent or b) reacting at least part of the hydrogen from the first effluent with oxygen-containing specie(s) to produce a second effluent having a reduced hydrogen content compared with the first effluent. The EFSMP is also connected to an Air Pump, typically used in the creation of Oxygen (O2) and is mixed together to create water. Such water can be used to refine oil, and the like, used for sale as a product, used internally for economic purposes (gain or minimize/reduce costs), put into the municipal system, and the like. Further, unused Methane can be containerized and sold as a product. An example of a Methane Product would be to the agricultural industry used in green houses to further along the maturing and ripening processes of crops. Where Methane is not sold, or economics determine, such Methane can be used internally for electricity and power generation, whereas such power, based upon utility and economics can sold, used to charge batteries, traded, and exchanged as determined by the operator.

Additionally, and without limitation, but included in the embodiment herein is an EFSMP whereas water treatment, which also processes effluents, is included in the embodiment, herein, and can incorporate API Separators technology, and policies, and is incorporated herein by reference. The combining hydrogen and oxygen feeds from plant systems to produce water additionally, in one embodiment, and permeation, a distillery, biosolid dryer, and the like, is utilized, in combination, parallel, hybrid, combination, and individually, using the heat from the ESFMP, (a reactor, tilt reactor, autoclave, blast furnace, and the like). Steam from the distillation filtration process can be directed for use in additional power generation. Gasses, Solids, and other wastes, and the like, regardless of temperature, still in the water are then rerouted back into Pyrolysis for reclamation, filtering, separation, and extraction, of which such solids, when no longer possible to filter or separate can be integrated into other products, such as Carbon Black, Asphalt, and the like, for further recovery.

The Embodiment herein of this EFSMP, finds that it is likely that the municipality (if in the United States) or some government body, or a secondary private body, will either request or require, access to such EFSMP for water filtration. The EFSMP envisioned, and proposed herein, employs several inward and outward bound connections to utilities such as electric, waste, power, fuel, gasses, and the like, of which the connections are used for more than just the transport of products from the EFSMP, and whereas, but not a limitation herein, is the use of Carbon Black, and other products generated at the EFSMP can be used for water filtration.

As part of the baseline feed stock introductory process (at a point where it will be possible to control the nature of the feed stock—taken from any of the above materials) used in the EFSMP, a desalting entry point is likely, as well as a hydrotreating point in which hydroconversion EFSMPs occur and/or where necessary, but not exclusively, and in any combination thereof, also include Hydrotreaters, of which, in principle, at least three reactions are taking place, but not all three at the same time, or in unison/tandem, or in hybrid form, at that site: hydro-demetallisation, hydrotreating/hydrogenation and hydrocracking. Removal of the metals from the residue feed predominantly occurs in the first reactor(s) and uses a low activity Co/Mo catalyst. Hydrotreating, hydrogenation and hydrocracking occur in the following reactor(s) where the quality is mainly improved by increasing the hydrogen-to-carbon ratio.

Additionally, in one form of the embodiment the present EFSMP uses any combination of a matrix of (either singularly or in combination thereof) fluidized bed pyrolysis, hydropyrolysis, catalytic pyrolysis, catalytic hydropyrolysis, atmosphere pyrolysis, fixed bed pyrolysis, copyrolysis, fluidized bed retorting pyrolysis, and Industry de-bottlenecking principals to maximize the production of products, using the smallest footprint, and most ecologically and environmentally sound and safe principles, structures, rules, using structured economics. Enhanced process controls, including robotics, and specialized software (the software is common to the Oil Refining Plant Operations at every facility. Most are off the shelf, with Halliburton, Foster Wheeler, KBR, Shlumberger etc, customizing certain portions) are also utilized in the EFSMP to maximize the efficiency and reduce human employee exposure to the processes, generating the greatest economic return and addressing social-environmental issues based upon compliance with regulatory standards. Other refining EFSMPs that can be used in stand alone, combination, vertically integrated SMPs, or joint plant component co-location—including clay acid refining—are that of crude atmospheric and vacuum stilling, hydrotreating, catalytic reforming, delayed coking, fluid catalytic cracking, hydrocracking, lube solvent refining, and lube hydroprocessing, lube hydro-isomerization, lube propane deasphalting and lube catalytic dewaxing.

The embodiment herein utilizes a matrix of Pinch Analysis and methodology, either in stand alone, single, parallel, hybrid, or any combination thereof, for utility management, energy cogeneration, energy generation, water reuse, minimize utility use and efficiency, increase economic independence, process integration, reduction in greenhouse gasses design, plant design, debottlenecking of critical areas in any given process, optimization of processes, optimization of hydrogen use, hydrogen management, catalytic reforming, hydrocracking, hydrotreaters, isomerization, catalytic reforming, and other equipment and or networks, and the like, whereas such hydrogen networks can be flexible, and non-flexible, and or be such as a Multi Period Hydrogen Network, and where such optimization could be one using a Mixed Integer Non-Linear Programming (MINLP), or some combination of other cross industry related vertical integration designs, and can account for assets such as equipment, equipment capacity, structures, structure capacity, pressures and utilization, and the like, non the least being, and included separately, and in conjunction with such other assets, but not limited to reactor design and operation improvements, waste minimization, investment cost reduction, site-wide analysis, determining areas for improvement, establishing working model SMP's and synthetic models to enhance current SMP's, and examples of which are used specifically, but not limited to Water, Hydrogen, and Energy, can be used, as one type as demonstrated in this embodiment in the ESFMP for minimizing energy consumption of chemical processes by calculating thermodynamically feasible energy targets (or minimum energy consumption) and achieving them by optimizing heat recovery systems, energy supply methods and process operating conditions. It is also known as process integration, heat integration, energy integration or pinch technology.

Additionally, but not limited to placements of technologies utilizing, but not limited to, Pinching Analysis, and the like, this EFSMP utilizes technologies and apperati, and reactors, in parallel, combination, hybrid, or separately, and the like, whereas heat used from power to dehydrate water biologics can be employed, and organics, for example, in the water processing plant—a series of equipment, and autoclaves can be used, or a reactor/s, to heat up flows, and direct heat where needed . . . thus reducing piping costs, and exposure of pipes to corrosions, whether internal or environmental, prevents precipitation from rotting out pipes, as well as reducing capital costs using Syngas to create power for autoclave reactor.

The process data can be represented as a set of energy flows, or streams, as a function of heat load (kW) against temperature degrees Celsius). These data can be combined for all the streams in the plant to give composite curves, one for all hot streams (releasing heat) and one for all cold streams (requiring heat). The point of closest approach between the hot and cold composite curves is the pinch temperature (pinch point or just pinch), and is where design is most constrained. Hence, by finding this point and starting design there, the energy targets can be achieved using heat exchangers to recover heat between hot and cold streams. In practice, during the pinch analysis, often cross-pinch exchanges of heat are found between a stream with its temperature above the pinch and one below the pinch. Removal of those exchanges by alternative matching makes the process reach its energy target.

The invention described herein is also a matrix of vertically integrated SMP's from various non-core petroleum industries, and is designed as self-contained modules set into our system can be a looped-flue gas system (EFSMP), a pressure relief recovery system, loop back scrubber system with metal and mineral reclamation, along with scrubbers and floor stacks to abate air emissions. The use of consequentially generated heat will provide for steam and/or turbine generated power for the site, as well as pressure-release turbine energy. Flare gas EFSMP recovery using scientific Pinch Algorithms, as described herein, and the like are also used for energy recovery. Process water, cooling water systems are not needed when a TARO Ammon Rain Compressor System (WAIS Patent), however, in this embodiment, a facility with a EFSMP that does not need a designated cooling system to promote refining, as described herein, is not needed. However, whereas in most refinery's, a Cooling System Module is enmeshed throughout the facility to lower processing temperatures of material and equipment, included herein are such modules where necessary due to the EFSMPs and the continuous endothermic reactions that take place, and where exothermic reactions are not recaptured back into energy, through closed loop flue gas EFSMPs and the like, and cooling of a specific module or EFSMP is beneficial to maximize the overall EFSMP of the embodiment of this application.

There are also technologies that are similar to a torpedo that blows out the chimney/line from pressure, but whereas the EFSMP has no vents, stacks, chimneys and the like, and this technology could be used in such EFSMP facilities and campuses, the present invention is a closed looped system (EFSMP) where such type of internal projectile could be used to clean out the internal clogging or debris that can accumulate. A similar form of technology is a commonly used systems for cleaning air vents in Air Conditioned Systems (also closed loop), that could be a spinning bow-tie type of EFSMP.

The embodiment herein of the invention also uses advanced communication systems and software for such a matrix of communication. Imperative in implementing and coordinating the interdependent technologies in the EFSMP embodiment is a communications system that can track-in real time-and notify refinery operators (or management) of system status, contemporaneously. A method for so doing is easily found in the U.S. Pat. No. 6,106,307 patent and related continuations. The same technology can be used as a basis for security, and for monitoring external conditions, including, but not limited to, weather, intruder/trespasser detection and deterrence, terrorist threats, site security breaches, counter measures; as well as establishing redundant communication between any EFSMP, the refinery EFSMP management, and outside bodies (police, fire, ambulance, hospitals, FEMA, government or industry-standard monitoring, off-site management, environmental management, utility management, service, safety, management, and security, performance monitoring and quality control, commodities/economics management, off site security, etc.) The integrated communications system within the refinery also include video, radio, voice, data, machine to machine communications, machine to operator, and other systems (not limited merely to communications) such as internal power.

Additional technologies in this embodiment are such as Sulfuric Acid Dialysis, and Diffusion Dialysis with membrane and semi-permeable construction, resin sorption, strip acid treatment, electrolytic refining, induction furnace SMP's, blast furnace SMP's, and the like, when and where necessary, either in stand alone form, or in any combination thought the embodiment herein.

Complementary technologies that are used in this EFSMP embodiment are horizontal well technology, and steam assisted gravity drainage, phase behavior, detailed composition analysis, x-ray view Cell technique, small angle x-ray scattering, direct visualization; additionally employed are and Nitrogen Sulfur recovery EFSMPs, amine treaters, Univiner and Platformers, Isomax, different Merox permutations, sour gas sweetening, LPG recovery and storage, heavy cut treatment, propylene recovery, corrosion Inhibitors, synthesis of lubricity additive for gasoil, mercaptans oxidation, alpha and gamma alumina production, HRH Units, indirect Alkylation units, diesel hydro-desulphurization units, CDU/RFCC LPG Merox process units, Amine Regeneration, Sulfur granulation units, TAME units for etherification, gasoline hydro-desulphurization process units, SCANfining and OCTgain Units.

As an alternative to Hydroconversion methods and EFSMPs, clay acid refining (clay) produces inexpensive yields, typically in excess of ninety-five percent. Disclosed herein is an EFSMP module, either individually or collectively, whereas the clay can either be regenerative or non-regenerative. Further, whereas regenerative clay uses H2SO4, an EFSMP is claimed where the embodiment of the invention uses a self-contained source of sulfuric acid modules used in the regeneration processes.

A past issue with clay is that the clay acid contains contaminants that are classified as environmental and bio-hazards. As such, most of the refineries around the globe have moved to hydrotreating processes, because disposal of the spent clay is difficult. Applicants disclose that the present EFSMP will use the waste minerals, chemicals, metals, fibers, etc., to be used in/for the production and sale of materials such as Additionally, the Advance Ceramics that can be created by the EFSMP can also be for quartz ceramics, quartz glass, and the like, and for adding other alkali or other minerals and chemicals, for ceramic composites, including such items produced as hydro silicates, bricks, and bearings, carbon fiber based ceramic products, sewage pipes, storm water pipes, highway and road barriers, sound barriers (as are found along roadways such as I-95 in S. Florida) and at Miami International Airport (MIA), Other common uses are possible, and the manufacturing industry is exploring less expensive alternative electrical and heat insulation materials, for which the clay demonstrates excellent properties. It could serve, as well, as an additive for strengthening materials and products that are either byproducts, or intentionally manufactured from the EFSMP in this embodiment. The clay acid EFSMP module can be any form of singular or tandem permutation of subsystem using thin film evaporation, evaporation, distillation, hydro-finishing, vaporization, de-asphalting, isomerization, thermal de-asphalting, and the like. Additionally, such clay can be non regenerative or regenerative.

As with the “WSEAS TRANSACTIONS on ENVIRONMENT and DEVELOPMENT,” (Yu-Lung Hsu, Cheng-Haw Lee, Victor B. Kreng; Vol. 5, Issue 3 at p. 298, March 2009,) the acid clay process is here described: concentrated sulfuric acid is added into dehydrated waste oil, wherein the foreign substances (e.g. additives and sulfides) will form sludge, enabling a 16˜48 hour decomposition and then separation from the waste oil. The foreign substances, colloid, organic acids, and waxy substances are removed by clay (porcelain clay or aluminum silicate) and decolored. Next, such oil is filtered to yield reusable base oil. The following sections describe permutations of module combinations of using thin film evaporation, vacuum gas oil, and thermal de-asphalting (TDA,) with mention of different suppliers/manufacturers for waste lubricant recovery (Hsu, Lee, Kreng; Section 6, p. 299, ibid) as KTI, CEP/Mohawk, Safety-Kleen, Agip Petroli/VISCOLUBE, IFP, SNAM PROGETTI, UOP DCH, and Meinken. The limitations of all of the referenced facilities herein is that they do NOT do oil refining, or gas separation, or generate any of the byproducts contained in the embodiment herein. Nor are any of the processes interconnected or sources of product anything other than an exclusively used source of feed-stock—specifically used lubricant oil, aka waste lubricant oil. Disclosed is an EFSMP that incorporates any hybrid combination of waste lubricant re-refinement, processing, and the like, in which the same EFSMPs are also found, but not limited to the purposes or architecture of a typical refinery.

In another embodiment of this EFSMP, the Clay utilized, and further described herein utilizes a process to isomerize hydrocarbon feed streams comprising: a) contacting a hydrocarbon feed stream with a steamed catalyst comprising a zeolite, and or a multidimensional medium pore zeolite, or a multidimensional zeolite, a unidimensional medium pore zeolite (hereinafter known as a zeolite), and the like, under hydroisomerization conditions including: a) temperatures above ambient room temperatures suitable for people to safely exist, and b) increased pressures above common barometric pressures; wherein the steamed catalyst is steamed under conditions such that the alpha value of the steamed catalyst does not exceed the alpha value of an unsteamed catalyst comprising the same unidimensional zeolite and where zeolites comprise at least one binder or matrix material selected from clays, silica, and alumina and the like.

The process includes zeolites wherein the zeolites are, for example, ZSM-22, ZSM-23, ZSM-35, ZSM-57, ZSM-48, ferrierite, a Group VIII metal, a Group VIII noble metal, and where zeolites comprise at least one binder or matrix material selected from clays, silica, and alumina and the like.

The present invention, and as part of the embodiment of a preferred matrix of technologies, is directed at an improved hydrocarbon isomerization process, wherein it is a suitable and possibly, if economics permit, and will prove, to be more beneficial to typical clay used for Clay Finishing. Such an EFSMP utilizes this technology, either in tandem, hybrid, combination, parallel, or individually, and by also be sectioned off in any preferred order, or stacked, and packed as desired. More particularly, the present invention is directed at an improved isomerization process for hydrocarbon feed streams through the use of a steamed catalyst.

The use of steamed catalysts in isomerization processes is described in the art and literature. For example, U.S. Pat. No. 5,166,112 claims and describes a steamed catalyst containing zeolite Beta and a Group VIII metal, and U.S. Pat. No. 5,082,988 claims the use of a similar catalyst in isomerizing a feed stream containing predominantly C5 to C7 hydrocarbons. U.S. Pat. No. 4,418,235 discloses the use of zeolites with a pore dimension greater than about 5 Angstroms, preferably 10-membered rings, with silica to alumina ratio of at least 12 and a constraint index of about 1 to about 12. These zeolites undergo a treatment with steam or water prior to use and are used in an acid catalyzed conversion process.

U.S. Pat. No. 4,374,296 discloses the use of zeolites with a pore dimension greater than about 5 Angstroms, preferably 10-membered rings, with silica to alumina ratio of greater than 12 and a constraint index of about 1 to about 12. The catalysts undergo a controlled treatment to enhance the acidity, expressed as alpha, to about 300. These catalysts are used in the hydroisomerization of a C.sub.4 to C.sub.8 paraffin.

Additionally, this invention embodiment, herein uses, but is not limited to Catalysts used in the present process comprise molecular sieves. Molecular sieves suitable for use in the present invention are selected from acidic metallosilicates, such as silicoaluminophophates (SAPOs), and unidimensional 10-ring zeolites, e.g. medium pore zeolites having unidimensional channels comprising 10-member rings. It is preferred that the molecular sieve be a zeolite. However, as the state of the art continues to advance, someone skilled in the relevant art will be able to utilize different permeations using the same methodologies described herein. And where the silicoaluminophophates (SAPOs) useful as the molecular sieve in the present invention can be any of the SAPOs known. Preferred SAPOs include SAPO-11, SAPO-34, and SAPO-41.

Furthermore, such zeolite freely sorbs molecules such as n-hexane, 3-methylpentane, benzene and p-xylene. Another common classification used for medium pore zeolites involves the Constraint Index test which is described in U.S. Pat. No. 4,016,218, which is hereby incorporated by reference. Medium pore zeolites typically have a Constraint Index of about 1 to about 12, based on the zeolite alone without modifiers and prior to treatment to adjust the diffusivity of the catalyst. Preferred unidimensional 10-ring zeolites are ZSM-22, ZSM-23, ZSM-35, ZSM-57, ZSM-48, and ferrierite. More preferred are ZSM-22, ZSM-23, ZSM-35, ZSM-48, and ZSM-57. The most preferred is ZSM-48.

It is preferred that the catalysts used herein contain at least one Group VIII metal, preferably a Group VIII noble metal, and most preferably Pt, as previously discussed. The catalyst may be steamed prior to or subsequent to adding the at least one Group VIII metal. It is preferred, however, that the catalyst be steamed subsequent to the incorporation of the at least one Group VIII metal.

It is preferred that the molecular sieves used herein be a zeolite. The zeolite can be combined with a suitable binder or matrix material. Such materials include active and inactive materials such as clays, silica, and/or metal oxides such as alumina. Naturally occurring clays that can be composited include clays from the montmorillonite and kaolin families including the subbentonites, and the kaolins commonly known as Dixie, McNamee, Ga., and Florida clays. Others in which the main mineral constituent is halloysite, kaolinite, dickite, nacrite, or anauxite may also be used. The clays can be used in the raw state as originally mixed or subjected to calcination, acid treatment, or chemical modification prior to being combined with the zeolite.

Additionally, the zeolite can also comprise a porous matrix or binder material such as silica-alumina, silica-magnesia, silica-zirconia, silica-thoria, silica-beryllia, or silica-titania. The zeolite can also comprise a ternary composition such as silica-alumina-thoria, silica-alumina-zirconia, silica-alumina-magnesia, and silica-magnesia-zirconia.

It is preferred that the porous matrix or binder material comprises silica, alumina, or a kaolin clay. It is more preferred that the binder material comprise alumina. In this embodiment, the alumina is present in a ratio of less than about fifteen parts zeolite to one part binder, preferably less than about ten, more preferably less than about five, and most preferably about two.

However, a majority of the traditional refineries, as listed herein, do not re-refine used oils, with known exception of Chevron. They are what are usually called an Original Equipment Manufacturer (OEM). They do not have clientele that are the secondary market of refining, or waste oil and/or used oil collection from external sources, similar to that of Waste Management's garbage collection, or battery collection, practices that are common in Florida. Degradative extrusion is another EFSMP that can be used converting waste-to-energy from oil, and used (or waste) oil. However, sulfuric acid is used in all refineries in the processing of crude, virgin oil. Sulfuric acid (H2SO4) is in such demand, that there is a supply shortage; which is where companies like DuPont fill in the gap.

The present invention, singularly, in different permutations, hybrid formats, combinations, and the like, includes a SPM that includes modular, integrated modular, and jointly used SPM to provide an energy efficient, closed loop, emission free, waste free, and toxic free refinery. The embodiments herein use best available techniques (on a case by case basis) processes, methods, equipment, technology, and constantly upgrade and update the EFSMP to be current with all economics, types of feed stock (e.g.: heavy or light oil, natural gas, gasoil, atmospheric residue, vacuum residue, shale oils, tar sands liquid and coal tar, refinery sludges, oil sands, bitumen, synthetic crude oil, and other heavy residues. etc.,) and regulations (International, Federal, State, and Municipal). As with any multifaceted facility, and in specifics a refinery using a series of EFSMPs is claimed, whether integrated modularly or on a modular by modular basis, the entire EFSMP requires and integrated refinery management system as well, for management such as Environmental management activities, utility management and overall refinery management (noise, odor, safety, maintenance.)

The present EFSMP can also produce specialized feeds that are/can be used in processes for easy decomposition for recycling into tires, similar to that of Nynas, and incorporated herein by reference (http://www.nynas.com/tyreoils/,) as well as films and oils, and feeds used for purposes of self decomposition such as biodegradation of film (e.g.; polypropylene and polyethylene) used in agricultural fields, mesh/netting, and other plastics, or for tires and other petrochemical feeds that are used for recycling. Additionally, the material may also be broken down via light and photonic and photolytic (light) exposure levels.

When additional hydrogen is needed, that which is not produced from the facility's energy plant utilizing fuel Cell technologies, can be collected: a hydrogen plant (EFSMP) will/can be added, where configurations are such that 99.9 percent hydrogen purity is guaranteed, and at the same time, if economically viable, high pressure steam is also created through the use of such technologies as steam/methane reforming. Hydrogen production EFSMP can consist of numerous processing steps, amongst which could be: a) feed gas hydrodesulfurization; b) steam-methane reforming; c) water-gas shift conversion; and d) Hydrogen purification.

As part of the fuel Cell technology component of the energy plant (also a EFSMP) configuration, and the needs of a stand alone EFSMP, as well as those of an integrated EFSMP with byproducts, Applicants disclose that in addition to using fuel that is generated by the EFSMP to power generators, as well as public utility electricity consumption, the EFSMP Texaco Gasification Power Systems (TGPS) may be used, heat integration, air separation units that power steam-driven compressors and turbines, and the like, either in a hybrid EFSMP format or stand-alone, depending upon economic needs (cost, sales, and by-products,) redundancy, capacity, and the like. Heat recovery steam generators, as part of the energy plant EFSMP, may also be utilized throughout the embodiment herein, and without limitation to any byproducts that may be generated, produced, or sold, in any form or capacity. This embodiment may also utilize Cogen generators, similar to the Jun. 22, 2007—exempted ones mentioned in the California Energy Commission brief, in which in addition to the generator, a series of cooling towers may be used in new hydrogen production.

In addition to fuel Cell technology, and the like, sulfuric acid can be regenerated by EFSMPs like that of a regeneration furnace or refractory, where the material is atomized and then used in supplemental acid production. Exothermic reactions generate heat that is recaptured in turbines to be used for energy reclamation, either in upstream or downstream processes. Water can be added, or removed, as is necessary to provide the optimum economy for acid reclamation, regeneration, and energy creation.

As economic profitability of the EFSMP in this embodiment is an obvious requirement, by integrating multiple EFSMPs, and seeing to it that they are all interconnected, by numerous EFSMP systems presents a synergy that is exclusive to this embodiment. By having integration for all EFSMP units, heat integration for efficient use of low level heat, common sulfur removal and acid gas removal EFSMPs, also will reduce and minimize required compressions costs for Hydrogen.

Since hydrogen is a main element consumed in refineries, for the refining, processing, and breaking down in subatomic useful components of oils, crude oil, acidic crude oil, black oil, coke, heavy oil and gasses, the fuel Cell energy unit EFSMP is a significant process that performs multiple tasks. As stated in the preceding language of this embodiment, the module and EFSMP reactor is—whether in hybrid, combination, or in stand alone form—an energy creating process. The EFSMP can also be used to capture exothermic energy in the form of turbines, nanotube water filtration and hydrogen extraction/separation, and the like from such process as hydrogen from catalytic reforming units, and methanation. Additionally where cooling is necessary for plant equipment or feed stocks, combinations of EFSMPs can perform such cooling (without limitation imposed by cooling towers, etc.,) or use steam reforming methods (also used for Hydrogen gas generation.) Steam/methane reforming technologies, supplemented by induced, substantial upward and downward variations in ambient temperatures can help maximize production of Hydrogen gas. In addition the preceding language, other forms of Hydrogen production are included in the embodiment herein, to be engineered in accordance with the specifications required for any given site. Examples exist industrially (though in this embodiment, EFSMPs are not limited to any combination, either singularly or in entirety,) e.g.: the co-project Air Products and Technip designed, as used by Marathon Petroleum Oil of: a) feed gas hydrodesulfurization; b) steam-methane reforming; c) water-gas shift conversion; and d) hydrogen purification. Nitrogen can be process-removed from an array of EFSMPs. The Nitrogen can then be marketed for use in fertilizers, and other common uses.

Fuel Cell technology reduces the need for refrigerators to cool down the H2SO4 slipstream before it is recycled, as the process is endothermic. Where there is an exothermic reaction (Heat) being radiated during the distilling, recycling, refining, and reconstituting of sulfuric acid, (from adding H2O to the residual sulfur trioxide produced by the fuel Cell system,) steam turbines will easily produce additional electricity.

While there are still needs for cooling systems throughout the EFSMP as determined by the different configurations, there will also be a probable need for additional energy to power such systems. The EFSMP hybrid/combination operations allow for an in-series application, as well as a stand alone. Other than exothermic-heat harnessing turbines, sources of generation for the power systems (energy) are refinery fuels—those generated from the different methods (as by-products) and via those specialized uses and purposes for any individual EFSMP location.

Additional methods of power generation, could be permutations of gas and steam cogeneration, integrated gasification combined cycles, etc. Additionally the Shell Gasification Process is the basis for an IGCC, which produces hydrogen in addition to power. A gas turbine combined cycle is the most efficient way to produce power from the syngas. The refinery steam network can be used for supplying steam to the existing steam turbines. As solar power, and wind energy (renewable energy) technology develops, such methods and EFSMPs can also be incorporated where and when necessary. Energy, electricity, and power can be obtained from Nuclear, Intra-Plant, Secondary, Tertiary, and other public and private source including, but not limited to companies like Duke Power and Energy, Florida Power and Light, where such energy can be purchased directly from the public utility, or brokered, traded, bought, and sold on the open market. Either a network grid, or wireless method of transmission can be utilized whether terrestrial or super-atmospheric in nature.

As stated in some of the preceding paragraphs, Oxygen and Hydrogen are by-products of fuel Cell technology methods in practice, and are part of the power plant EFSMP configuration. These gases, including syngas, can be cooled, compressed, and tanked for either open market resale, or reuse at the refinery. Likewise other methods of Hydrogen recovery that are claimed for incorporation would be updated forms of steam reforming, oxidation, pressure swing absorption, membrane recovery, cryogenics, and catalytic hydrotreating, and hydrogen recovery processes.

Additionally, the EFSMP embodiment herein discloses that an Autoclave and Autoclave technology/ies can be used in any process, or as part of the overall system, either as a stand alone unit, or in any hybrid or combination thereof, and the like. Such types of Autoclave technology are not limited to Microwave Autoclaving, Steam Reactors, Mixed Steam with I/R, Autoclaving with Super heated steam, composite autoclaves, Hydro Autoclaving, Radiant Tube heating, glass-laminating autoclaves, concrete autoclaves and or radiation, atomics, ultrasound, sound waves, light, slurry, sludge, ethenates, hydrogenates, other forms of heat, gases, solids, fluids, plasmas, and the like.

The embodiment herein includes a reactor, that can include, either as a standalone unit, a series of units, a combination of different reactors, where reactors, and someone of ordinary skill in the art, can further advance the technology to contain a series of combination of vertical or horizontal reactors, thermal reactors, atomization reactors, and the like, whereas such as to include blast furnaces, autoclaves, sintering plants, thermonuclear reactors, autoclave reactors, atomic reactors, hydrogen reactors, oil refining reactors, and the like, and where as such embodiments can include, either independently or in combination thereof, technology such as that Autoclaves, and the reactors in the embodiment herein, are pressure vessels in the form of cylinders (horizontal or vertical) or long horizontal tubes. To ensure complete mixing of feed, materials, and the like, including reagents, the reactors can be agitated. Methods of agitation vary; and include the injection of high-pressure steam, mechanical agitation, or rotation of the whole reactor. When used with corrosive media, part of the reactor, or the entire section of the reactor in as much resemble autoclaves are constructed of special steel alloys, advanced ceramics, nanotubes, titanium, and other high-grade materials. In some instances the interior surfaces are lined with glass, quarts, mineral, chemical, rubber or ceramic material.

In one embodiment of the reactor described herein, liquid oxygen is blown onto electrostatic precipitator for blast furnace then into wet gas cleaning, whereas one stream goes into blasting, and one stream goes into the gas.

Furthermore, such practices those used for, and in, but not limited to, and used either individually, or in combination, as part of the matrix of technologies described herein as those such those found in a electrolytic lead refinery, electro ceramics, Isa melting, slag fumers, slag fuming, as well as incorporating UV radiation, UV light, crucible furnace processing, ore roasting processes, drossing, CDF drossing, flash smelting, Smelting Matte, barton pot process, and Ball Mills, where Ball Mill—important for producing lead oxides, and the like. Furthermore, also incorporate hereinto is the reactor and EFSMP, Blast Furnace and those using Paddle Mixer—the present can use the spent oil, from the mixer, for a feed stock, wherein the effluent from this mixes with Coke, and the like, limestone, slag, and then liquid oxygen gets mixed in for super heating then onto the Isa melt for processing. The slog and dross go into sintering, then into matte, then back into sintering, and the matte is ladled for further processing, as well as other uses to be, and that have been, described herein the EFSMP. Then the feed goes for further processing to Proportionating and Mixing Tank—used in Sintering: cadmium and other items into go to sintering feed and lead bullion, zinc, sulfur gas (goes into wet gas cleaning then into Sulfuric Acid). While Britannia uses liquid oxygen, the embodiment herein also uses other forms of oxygen, other gasses, liquids, plasmas, and the like, either individually, or in hybrid, and or combination.

The embodiments herein can have sections that can be used for non-ferrous hydrometallurgy, as well as Nanograin Ceramic Powders, Polymer Fuel Cell Reclamation, and Clay from Clay Acid renewal. In certain embodiments described herein, such autoclave technology can be also be integrated in combination with or independently attached, in such fashion in that they are used in the Acid Matte Leach Process and the Nickel Laterite Acid Leach Process, because they allow high temperatures and pressures to be used. The reactors in this EFSMP can contain multiple compartments, each agitated with an electrically-driven turbine mixer, and the like from the top. The EFSMP is equipped with agitators to keep the fine solids in suspension and promote the best leaching action.

The EFSMP in this embodiment can contain such components of a horizontal acid leach autoclave, and the like, in such fashion, independently and in combination herein as a Motor Drive Assembly for Agitator, Compartment Divider, Agitator Shaft, Service Nozzles, Support Saddle, Carbon Steel Shell/Lead and Brick Line, and the like.

This embodiment of the invention EFSMP as a Sintering Furnace, Sintering Reactor, Sintering Plant, and its uses therein, either singularly, or in any combination thereof, uses both, and either Pyrex Lining, Shielding, Insulation, Piping, and the like and or heat in the form of IR, Radiation, Electricity, Thermonuclear energy, sonic waves, ultraviolet waves, CT Scan imaging waves, magnetic resonance (ex: MRI technology), Tesla technologies, and the like. And where the ESFMP, wherein the upstream contacting zone and/or downstream contacting zone comprises one, or more, and in any combination/s thereof, stacked bed reactors, either vertically or horizontally, and the like, and where the ESFMP, wherein the upstream contacting zone and/or downstream contacting zone comprises one or more ebullating bed reactors, and where the ESFMP, wherein the system further comprises a crude feed conduit coupled to the upstream contacting zone, the crude feed conduit being configured to convey a crude feed to the upstream contacting zone; a total product conduit coupled to the downstream contacting zone, the total product conduit being configured to convey the total product from the downstream contacting zone; and one or more gas conduits, at least one of the gas conduits is coupled to the upstream contacting zone, the gas conduits being configured to convey a hydrogen source and/or a carrier gas into the upstream contacting zone and/or downstream contacting zone, and where the ESFMP, wherein the system further comprises: an upstream separation zone coupled to the upstream contacting zone upstream of the upstream contacting zone, the upstream separation zone being configured to produce the crude feed; and an additional crude feed conduit coupling the upstream separation zone to the upstream contacting zone, the additional crude feed conduit being configured to convey the crude feed from the upstream separation zone to the upstream contacting zone. The embodiment of this ESFMP, wherein the system further comprises: a blending zone coupled to the downstream contacting zone downstream of the downstream contacting zone, the blending zone being configured to combine the crude product with one or more process streams and/or one or more crudes to produce a blend; a crude product conduit coupling the downstream contacting zone to the blending zone, the crude product conduit being configured to convey the crude product from the downstream contacting zone to the blending zone; and a blend conduit coupled to the blending zone, the blend conduit being configured to convey the blend from the blending zone; and wherein the ESFMP, wherein at least one of the crudes is a crude that is the same as or different from the crude feed. Moreover, the embodiment of this ESFMP, wherein the system comprises in addition a stream conduit coupled to the crude product conduit, the stream conduit being configured to convey one or more streams to the crude product conduit. Further, the embodiment of the ESFMP, wherein the system comprises in addition a stream conduit coupled to the blending zone, the stream conduit being configured to convey one or more streams to the blending zone. And where the ESFMP, wherein the system is positioned on or coupled to an offshore facility. The offshore facility can be either land based, subterranean, underwater, celestial, lunar, orbital, or non-land based.

As a typical refinery produces many tons per day of Sulfur, the reconstituting process, fuel cell, and energy reclamation systems make this a self-sufficient and clean system where typical tanker trucks are not clogging the arteries, roads, streets, and highways of local populated areas.

In the event that additional H2SO4 is needed, Zinc is brought onto the campus, also known as a refinery, and through common off the shelf technology (COTS), H2SO4 is made and the process of plant use, refining, reclamation, and energy is repeated. In addition to the process of creating H2SO4, the EFSMP also can be used to remove toxic metals from the feed stocks of the new Super Ultra Refinery, or of any refinery and module thereof. Types of metals and toxic chemicals could be Lead, Mercury, Arsenic, Gold, Silver, etc. (see chart). The embodiment herein uses either independently, in any combination thereof, or to the exclusion thereof, such methods of processing Zinc ore by means of Electrolysis Process, aka Hydrometallurgical Process, Roasting Leach Electrowin (RLE), Pyrometallurgical Process, Electrothermic Process and Top Submerged Lance (TSL), Thermal Conversion Atomization, and the EFSMP can use the same SMP's to process other materials, liquids, solids, plasma's, and matter as well.

Via the numerous possible combination of matrix refinement EFSMPs in place, and the various combinations of vertically integrated modules used, it is also possible to remove the 25 or so different additives blended into lubricant oil prior to sale and use. Since the EFSMP embodiment herein, does not need these additives, they can be separated, distilled, etc. and bifurcated into separate containers for sale into the market place, much like DuPont does with sulfuric acid and its byproducts. Additionally, as the state of the art of the technology continues to develop, it is a preferred embodiment of this invention (EFSMP) that the same additives can be used, on site, for incorporation as additives, blends, catalysts, and the like, into different fuels (as octanes, etc.).

Through a breakdown stage, like pyrolysis, plasma arcs, electric arc, spark plasma sintering, vacuum sintering, current pulses, electrical resistance heating, inductive heating, gas pressure sintering, microwave and sound wave bombardment, heat, cavitation, ablation, metamaterial magnetic energy, light, laser, radiation, thermonuclear heat, sintering, chemical, anaerobically, aerobically, either individually or jointly, petroleum products, petroleum derived products, petroleum effluents, lead, lead dross, dross, used clay, lithium fluff, lithium, oil sands, e-waste, ore and petroleum oil/s, tires and rubber can be broken down into components such as gases (light and heavy,) tire wire steel, tire fiber (polyester, nylon, rayon, etc. see chart), carbon black, diesel oil, diesel fuel, fuel oil. Through different methods they can continuously loop back. When and where needed, tires and rubber can be broken down into a slurry that is suitable for adding to the crude oil feed stock, or waste-lubricant oil, or waste lubricants, for processing and refining using methods found in refineries for coking, and producing typical refinery products. Applicants' embodiment herein also includes SMP's for adding effluents, made up of different petroleum and gas products (as described in Texaco patents)

In addition, FIG. 21A includes a flow-chart of another embodiment of a scintering plant. In this embodiment, “microsonic” IS to be defined as, and include: Radiation; Microwave; Ultrasound; Radio Frequency (RF); Infrared; Electro Magnetic Frequency (EMF); EMF Radiation; RF Radiation; Microsonic; Metamaterial Radiation, Sonic; and the like, without limitation—either in tandem, combination, individually, parallel, sequentially, and the like, depending upon user defined perameters. The strengths (aka wavelengths) and or exposure, and frequency, pulses and the like can and are, without limitation also user defined, and such parameters can fluctuate depending upon material, desired product, or any such parameter as the user has determined and requires, whether static or adjusting.

### Cell 22: Secondary Sulfuric Acid Plant

Cell 22 is depicted in FIG. 22 and can comprise a secondary sulfuric acid plant. In the EFSMP of the present invention, there could be a means of refining and cleaning the sulfuric acid using various technologies also found in fuel-Cell technology, where the sulfuric acid is broken down, for refining, cooled off where and if necessary through a series of heat exchangers, cooling towers, cooling EFSMPs, and the like—either in a single pass or multiple passes, and as the H2SO4 passes through the membrane of the fuel cell, Hydrogen (H2) is stripped off, and oxygen (O2) is stripped off, creating energy for the fuel Cell and the adjacent refinery. What remains is pure sulfuric trioxide (SO3). As soon as the SO3 is isolated it can be reconstituted back into H2SO4 simply by adding water (H2O,) where the mixture generates substantial exothermic (heat producing) energy that can be collected to further produce electricity for the refinery (by use of a steam turbine.)

In the event that additional sulfuric acid is needed, zinc is brought onto the refinery comprising the various Cells of the present matrix system and process, and through common off the shelf technology (COTS), sulfuric acid is made and the process of plant use, refining, reclamation, and energy is repeated.

### Cell 23: Precious Metal Recovery

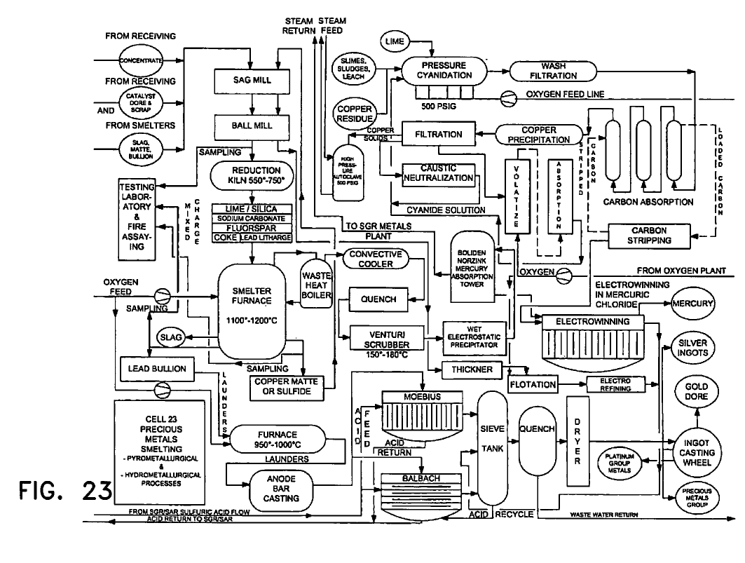

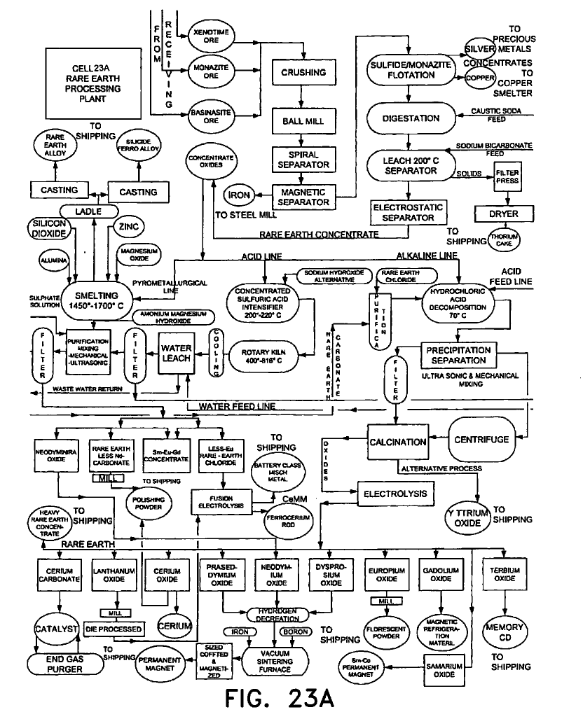

Cell 23 is depicted in FIG. 23 and embodies a module which can be part of the present matrix system and process and comprises a precious metals recovery plant module 2300. The precious metals recovery plant module 2300 provides a process to extract and recover metals including precious metals and to remove mercury from materials produced in other Cells of the present matrix system and process and which materials are recycled to the precious metals module 2300.

Cell 23 can employ technologies as can also be employed in reactors of variable lengths and widths, and capable of temperatures of up to about 3500 degrees Celsius, Excellent air flow uniformity, Easy internal access to facilitate maintenance, Coal, Electric or gas fired, Optimal temperature uniformity, Operator isolation from effluent, Highest Energy Efficiency, Fastest line speeds, Thermal Recovery Systems, Surface Treatment Systems, Multiple Sizing Agents, Multiple Electrolyte Solutions, Clean and Hygienic, Non Contact Drying, Flexible System Designs, Unique Gases (e.g.: Argon, Nitrogen), Large capacities (multiple muffle systems), Atmosphere Control, Reduced energy costs, Excellent temperature uniformity, with features, not limited to, but can include Multiple temperature control zones, Proven alternating cross flow design, Adjustable louvers and diffuser plates for precise temperature adjustment, Rigid roll stands, Integrated brush roll assemblies, Excellent float end seals for positive sealing, minimized infiltration of ambient atmosphere and improved temperature uniformity, Aluminized steel construction, Plug fans to facilitate maintenance, Carburization resistant muffle, Low profile muffle for gas flow control, Process gas distribution and sampling system, Proven purge chamber gas curtain technology and the like.

Cell 23 (and also Cells 19, 20, 21 and 25) embodies systems and processes for obtaining, metal, gold, silver, lead, zinc, nickel, copper, in different forms of purity in the EFSMP matrix system and process which is not limited to, but as an example of which oxygen, or enriched air, or air, or any other gas, is blown onto a melt, in a melting furnace (or reactor as defined herein) lined with refractory material, having a waste heat boiler set onto it, in order to oxidize contaminants, or change its form for collection, is contained in the melt and thereby remove them from the melt, and wherein a splash protection device through which fluid flows is provided above the ore melt, or metal melt, or (metal being defined as any element found in the Periodic Table, such as iron, carbon, gold, silver, copper, platinum, zinc, lead, and the like) on the inside wall of the melting furnace, which prevents copper, and the like, that splashes out of the melt (comprising any of the metals listed in the embodiment herein, either individually or in combination, regardless of the level of purity or impurity) from penetrating into the waste heat boiler. Boiling water, plasma, or any other fluid, or gas, can be used for cooling the splash protection device, protection device. Furthermore, precious metals such as gold, as well other elements categorized in this embodiment, can be extracted from a refractory ore, and petroleum streams using a conventional leaching step or a Super Reactor in which atomization is incorporated with thermal properties. The refractory ore, ores, metals, fluids, plasmas, feed stocks, and the like are also pretreated, when desired, by fine grinding and an initial leaching step, but is not limited to the restriction of such steps as to viability. Oxygen, also defined as gas, air, enhanced air, enhanced gasses, and the like, and is either individually or combined in any form, or in any pressure, or not under any pressure, is added to the initial leaching step and the conditions are carefully controlled to only partially oxidize the ground ore. Any step of the EFSMP can be carried out at any temperature or atmospheric pressures without limitation or restriction.

As in Cells 12, 13, 18, 19, 20, 21, 22, and 25, Cell 23 encompasses rotating anode furnaces located proximate to the converting or holding furnace, as the case may be, and are sized to accommodate the output from the converting and/or holding furnace. These furnaces, also known as thermal conversion super reactors, atomization reactors, and also known herein, and throughout, as super reactors, hearths, furnaces, kiln's, autoclaves, and the like, are typically of conventional design and operation, and are used in tandem with one another such that while one is in operation, or as is the case may be in this example, is fire-refining the blister to anode copper, zinc, lead, gold, silver, and/or the like, the other is filling—if tandem/parallel/combination reactors are indeed needed. The output from the anode furnaces is transferred to an anode casting device (of any conventional design) on which the anodes are formed and subsequently removed to electrolytic refining.

The Cell 23 module has an ore metals inlet bringing material from other Cells of the present matrix system and process to a smelter which then sends the material to cupellation unit and then to a electrolytic refining unit and the to a silver crystallizing unit resulting in the formation of pure silver. Dust slag and lead oxide are forwarded to an atomizing kiln. Anode slime is forwarded to a dryer then to a residual anode furnace then to wet chemical chlorination and then to zinc precipitation filtration and then to sulfuric acid digestion. After digestion the material is sent to a crucible melt furnace casting to provide pure gold. Part of the sulfuric acid digestion is forwarded to selenium reduction and vacuum distillation to form pure selenium.

In addition, the following reference is relevant to Cell 23 and is incorporated herein by reference: Continuance Improvement Program, Refinery Operation—Technical Review by the Royal Canadian Mint; see: http://www.mint.ca/store/dyn/PDFs/IBI%20technical%20report%20Final%20ENG.pdf.

### Cell 24: Nano Graphite Production Plant

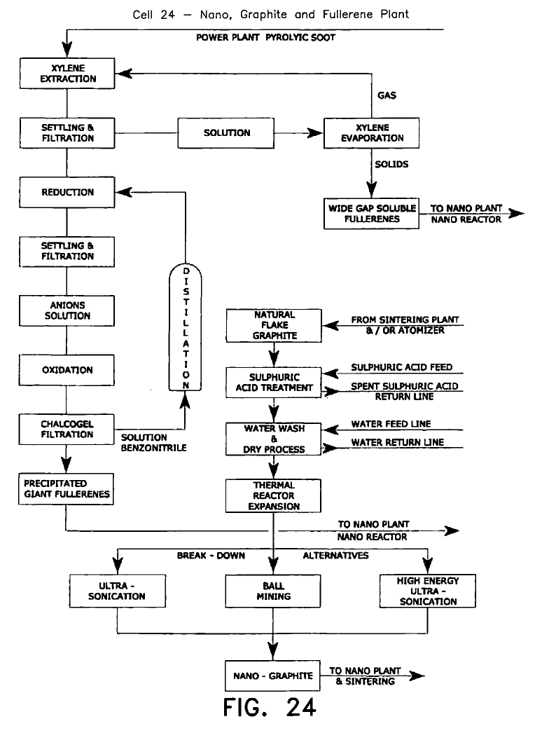

As an embodiment of the present invention, the EFSMP matrix can include a nano graphite production plant 2400 as shown in FIG. 24A, which can be a separate plant from the nano plant 300. FIG. 24B illustrates a detailed flow chart of the nano-graphite production plant 2400.

As shown in FIG. 24B, the natural flake graphite 2401 can be supplied from a vaporizing hearth and treated with a sulphuric acid in a sulphuric acid treatment process 2402. As such, the sulphuric acid treatment process 2402 can be provided with a sulphuric acid feed line and spent sulphuric acid return line as shown in FIG. 24B.

The treated graphite in the sulphuric acid treatment process 2402 can be washed with water and dried thereafter in a water wash and dry process 2403. Also, the water wash and dry process 2403 can be provided with a water feed line and a water return line as shown in FIG. 24B.

The dried graphite in the water wash and dry process 2403 can be heated in an expansion chamber of a thermal reactor 2404, which can be one of the continuous feed Tilt/Angled Thermal Conversion Reactor and Vertical Atomizing Batch Reactor. Someone of ordinary skill in the art would know the specifics of these reactors. However, these are not the same as the nano reactors. The heated graphite can be broken down by using one of an ultra-sonication process 2405, ball mining process 2406 and high energy ultra-sonication process 2407 into nano-particles in terms of customer's needs. The nano-particles can be delivered to the Nano Plant 300 for further processing.

Short fibers such as graphite (carbon) fibers may pose health risk to those who come in contact with them. Exposure to short fibers can happen during manufacturing, use, repair, and disposal. As an embodiment of the present invention, the above processes for making the nano-graphite in the nano graphite production plant 2400 are fiber-free because all the equipments used in the processes are enclosed. Also, there is no human contact with the nano-graphite because the processes are computerized, and robots are utilized in those processes.

### Cell 25: Metal Extraction

Cell 25 is an oil metal extraction module which can be part of the present matrix and system and process. The oil-metal extraction module has a waste water feed for separating skimmings, dross and clay matter output from other Cells of the present matrix system and process all of which are sent to an Ausmelt Tundish blending unit then to an atomizer unit.

Spent clay is pressed in a clay filter press and is forwarded to the Ausmelt Tundish blending unit and then to the atomizer. Spent oil, crude oil, pyrolic sludge, tank sludge oil and water waste oil sludge are forwarded to a secondary desalter unit and then this material is sent to pumps for pumping into the atomizer. The atomizer separates materials to atomized droplets which are sent to a screw feed extractor. Material passes through a screen and to screen oil residuum and the oil is sent to the storage area of Cell 1 for further pretreatment and eventually to the refinery module of the present matrix system and process.

### Atomization Reactor

A reactor, such as those described herein can be used at this point in the process, but one is not required. Now turning to one embodiment illustrated in FIG. 25, to the sides of the present embodiment, vertically disposed (the position of the tanks is for the drawing/rendering only, as placement and position are dependent upon configuration by the end user) tanks feed into the base of the reactor chamber where they are funneled to a plasma combustion zone 21. An oxygen tank 14 is shown to the right of the main chamber of the reactor and a hydrogen tank 13 is shown to the left side of the main chamber of the reactor. Both the hydrogen tank and the oxygen tank have flow streams (as part of the closed loop nature of the matrix. Hydrogen and Oxygen are byproducts of both the Power Plant from Solid Oxide Fuel Cells as the Sulfuric Acid is passed through, as well as gasses that are derived from the processing of Coal. Where necessary, Oxygen machines can be attached to this Water Reactor to provide additional Oxygen for the production of water that are inhibited by pass-through devices, including flow regulators 22 and intensifier pumps 24 as the gases are funneled from the tanks to the plasma combustion zone. The flow regulators 22 regulate the amount of each gas passing through to the main chamber plasma combustion zone 21; and the intensifier pumps 24 drive a single or multiple vortices in the upward direction by exerting a 40,000 PSI pressure, but is not limited to such, on the feed streams. However, in the present embodiment there is no central vortex above the blast zone as can be understood from further description of the present embodiment of the reactor. The intensifier pumps 24 increase pressure, which, inter alia, aids in the power production mechanism described herein.

The combustion streams of hydrogen and oxygen are pumped into the plasma combustion zone 21 to keep the combustion zone free of water and to prevent the buildup of hydrogen elsewhere in the reactor, so as to prevent a catastrophic explosion.

In a preferred embodiment, a Gatling gun (style) rapid fire plasma head, which is similar to that described in United States Patent Application Publication Number 20090078685 titled “Plasma Head and Plasma Discharging Device Using the Same” to Tsai, Chen-Der, et al. is incorporated herein by reference in its entirety. The abstract of the application states the following, in part:

The plasma-discharging device comprises a power supply with two electrode terminals. The plasma head comprises: an outer electrode having a chamber formed therein; an inner electrode, disposed inside the chamber; and a flow guiding structure, disposed inside the inner electrode; wherein the outer electrode and the inner electrode are connected respectively to the two electrode terminals of the power supply; and the flow guiding structure further comprises at least an inlet for introducing a working fluid into the inner electrode and at least an outlet being communicated with the chamber of the outer electrode to guide the working fluid to flow into the chamber of the outer chamber.

The “Gatling gun rapid fire plasma head” contains (1 or more), preferably 2 to 32 cathodes/anodes and is capable of firing 10,000 rounds per minute, the synchronization of which is controlled by a computer coordinated system. In addition, the use of over 7-firing barrels on a single head creates temperatures in the plasma combustion zone ranging from 10,000 to 20,000 degrees Kelvin. The anodes are recessed in the firing head, which protects the combustion zone from water being drawn in. The plasma arc created by the Gatling gun rapid fire plasma head can be in direct contact with the plasma combustion zone 21.

The Gatling gun (style) rapid fire plasma head creates a series of electrical arcs, which deliver high temperature impulses to the plasma combustion zone and therefore, dictate and/or control the rate of combustion. The firing pattern of the Gatling gun rapid fire plasma head is synchronized and can be totally controlled by a computer. When the impulse rapid fire plasma sends a high temperature electrical impulse to the plasma combustion zone, the hydrogen and oxygen fuse together forming water. This process can be analogized to the heat from a bolt of lightning forming a raindrop. The fusing of hydrogen and oxygen is a highly exothermic reaction, water is formed. Excess energy not used in every “fusion” process is removed, and collected, with an ionizer, grounding rod, and other static/ionized particle capturing technologies, for re-introduction back into the matrix electrical system, as electricity and power.

Because the firing mechanism is synchronized by a computer coordinate system, the rate of combustion is controlled through this structure. Further, the Gatling gun ignition control directs an alternating pattern of electrical arcs on the combustion head, to ignite the plasma, such that it allows for micro-second cooling of each anode/cathode. This micro-second cooling further serves to protect that firing head by redirecting the combustion shockwaves away from the firing head.

During the process of creating water, there could be excess hydrogen and oxygen that is created. The excess gases that are created will be recycled for storage and later use. The recycled hydrogen and oxygen that is separated from the water, including by the Chalcogel filters 5 moves back down the side of the reactor stream and can reenter the reaction chamber through the appropriate funnel.

The plasma firing mechanism described herein is similar to that described in U.S. Pat. No. 7,270,044 (hereinafter “the '044 patent) to Jebsen et al., titled “Plasma firing mechanism and method for firing ammunition,” which is incorporated herein by reference in its entirety. The '044 patent describes how the electrical arc is fired.

U.S. Pat. No. 5,824,988 (hereinafter “the '988 patent) to Tylko titled “Reactor and method for the treatment of particulate matter by electrical discharge” is also incorporated herein by reference in its entirety. The '988 patent describes another way in which the present reactor emits discrete electrical discharges to the plasma combustion zone 21.

As the flows of hydrogen and oxygen enter the combustion zone where they are ultimately “fired on” by the electrical arc of the Gatling gun rapid fire plasma head, the blast stream 19 is given off in the direction of the plasma combustion zone 21. The blast stream redirects blast waves toward the turbine and continuously cools the firing head to prevent overheating. In addition, the blast stream 19 is a high pressure water feed which cools the plasma head.

The impinging jet central vortex water feed has a large diameter for massive feed volume and force. The impinging jets pull the fluid through with high pressure and ionizes the plasma, creating an ultra-high velocity, thereby pre-heating the plasma prior to its entering the reactor chamber. The impinging jets create enough pressure in to power a standard turbine blade system 7. Additionally, a cupped blade can be used, which is known to be more efficient at harnessing energy as an advance, particularly in wind energy technology, such as is used in the famous Baker Wind Turbine, but can also be employed in water systems, such as the present invention. Water amplified shock waves ultimately power the turbine. The jets face inward towards the center of the main chamber, which provide direct arc contact for instant combustion; it prevents water from interfering with the complete combustion of the oxygen and hydrogen; firing heads are recessed to shield them from water. Dampening Devices, defined collectively and individually, are such as is commonly used in Japan and other global geographic regions, to minimize, reduce, and eliminate, the effect of earthquakes, tremors, seismic activity, sonic booms, and the like, are employed at around this and all of the reactors and facilities to minimize, reduce, and eliminate any vibration or seismic activity. Further, such dampening devices can also be technologies incorporated in vehicles—ex: providing comfort to passengers inside the cabin a comfort of physical and auditor (sound proof) nature.

The reaction chamber is completed submerged in water and the reaction chamber is explosion proof which can muffle the blast, dampen the vibration vortex, inter alia. The high pressure of the counter blast stream acts as a coolant on the high temperature zone range.

With respect to the top portion of the present embodiment, a ground level generator 1 is connected to the balanced turbine generator drive shaft 2, which extends in the downward direction directly below the ground level generator 1. However, placement of this generator, and or generators, is dependent upon configuration and design by the end user. To the right of the balanced turbine generator drive shaft exists an open utility access area 3, which allows for maintenance, for example, to be done with minimal disruption to the reactor and which is easily accessible at any time. The generator drive shaft is connected to the wicket gate 6 just above the impulse turbine blades 7.

It is noted that where placement is mentioned in any of the drawings, throughout this application, this is for artistic purposes only, and that throughout this application, such placement is only that of an artist's rendition. It may be more economical by design to have placements, and amounts of tanks, generators, etc. in different configurations and quantity, based upon end user design.

Power is supplied to the hydroelectric power and water production plant by a Fuel Cell 15, shown in the bottom left portion of FIG. 25C.

The Fuel Cell 15 provides direct power to the combustion head and the powered plasma arc system co-produces additional water streams through electrolysis.

The walls of the main chamber are blast hardened 12 walls so that they can withstand the constant combustion within the reactor.

A description of another embodiment of the atomization reactor is shown in FIG. 25B.

At the top left of FIG. 25B, the effluent moves from the collision chamber 251 to the heat amplifier or heat amplification device 252. The heat amplifier 252 is similar to that disclosed in U.S. Pat. No. 4,106,554 to Arcella, which is incorporated herein by reference in its entirety. In the heat amplifier 252, the effluent is heated and catalyzed prior to entering the main chamber 262.

The atomization reactor extracts metals based on molecular weight, mass and vaporizing point, which ultimately exits the main chamber 252 through the extraction ports 263 shown along each side.

The input streams include, but are not limited to, spent solvents, spent chemicals, spent catalysts, sludges, slimes and residues, which are shown entering from right to left at the top of FIG. 25B through a downward extending tube 253 entering the main chamber 262 at an approximately 45 degrees angle. The effluents enter a V-shaped tundish funnel 254, having a V-bowl combustion point. From the V-shaped tundish funnel 254 the input streams are fed into the jet impingement apparatus 255, which can be of a simple configuration.

Jet impingement mechanisms such as this are known in the art as a method to transfer heat efficiently and increase reactions by increasing the surface area of the reactants. U.S. Pat. No. 4,994,242 (hereinafter “the '242 patent”) titled “Jet Impingement Reactor” to Rae et al. is incorporated herein by reference in its entirety.

As in the '242 patent, FIG. 25B has a vessel with baffle. There are openings in the baffles through which the effluent passes as a jet. Neighboring openings are sufficiently close to allow impingement of the jets thereby allowing for reaction of the liquids. The particular benefit provided by the impinging jet system shown in FIG. 25B is the degree of agitation that is available, which ensures that the reaction rate and conversion efficiency of the reactor are high.

To the left and rights sides of FIG. 25B, there are two vertically disposed tanks 257. In a preferred embodiment, these tanks house catalysts, including but not limited to spent catalysts for the manipulation and removal of metals, including but not limited to rhenium, molybdenum, platinum, palladium, vanadium, iron, aluminum, etc. Any of the extracted metals, such as, for example aluminum, platinum and/or gold, once extracted can be sold in the market.

The system of impinging jets is similar to that of U.S. Pat. No. 5,622,046 (hereinafter “the '046 patent”) to Freay titled “Multiple Impinging Stream Vortex Injector,” which is incorporated herein by referenced in its entirety.

As the background of the '046 patent explains, impinging stream injectors can be directed towards one another at various impingement angles, which can be determined from a momentum balance of the incoming jets. The high velocity streams come in direct contact with one another, break up and mix, inter alia. The vortex injector 258, on the other hand, creates turbulence generated from high velocity, non-impinging streams injected tangentially into the contact area. The tangentially injected streams generate a highly turbulent vortex that mixes the streams. This is one mechanism by which the vortex in the present chamber is created. The center chamber 259 has a high velocity collision zone with up to 40,000 psi, (the range can be from minimal PSI to a maximum of 60,000 PSI) per effluent stream such that they are propelled at this critical pressure, as is well known to persons having ordinary skill in the art in the field of micro-fluidics.

Further, as the '046 patent describes in the summary, the multiple impinging stream vortex injector of this invention can combine both mixing schemes into single injector. Both impingement and turbulent mixing is accomplished by impinging momentum balanced, tangentially injected propellant streams onto one another. The impingement angles are calculated to yield a resultant stream vector that consists of only a tangential velocity component.

In a preferred embodiment, the impinging jets have baffles, shown as rectangular plates in FIG. 25B lying between the base on the impinging jets and the top of the vortex. Baffles 256 help to prevent clogging as is common with present technology by eliminating condensation, inter alia. Generally, baffles 256 deal with the concern of support and fluid direction in heat exchangers. Further, the baffles 256 provide a source for a source of heat that acts as a last source of heat to prevent condensation buildup. These baffles 256 can include, but are not limited to housing infrared, micro, and sonic waves.

Complete mixing and combustion of the effluent streams are achieved by the turbulent vortex created by the resultant stream. The impinging stream vortex injector can be utilized in any propulsion system that necessitates the use of gels and/or liquids.

The '046 background and summary help describe one mechanism by which the impingement jet streams mix with the four catalyst compartments shown in FIG. 25B.

The vortex can be at the high-pressure water atomization stage, wherein the effluents are exposed to temperatures ranging from below 4000 to over 4500 degrees Celsius. In addition to the vortex described in the '046 patent, the present invention includes a high speed centrifugal vortex surrounded by an electro-magnetic combustion zone. The electro-magnetic combustion zone is created by adjustable anode and cathode electrodes which can be placed anywhere in the reactor and in a preferred embodiment innervate the inner wall surrounding the vortex. The anode and cathode 260 can be vertically disposed.

Plasma arcs can also be used to atomize the effluents in the vortex chamber. Plasma arc melters have a high destruction efficiency; are robust; and can treat the effluents with minimal or no pretreatment. Further, they produce a stable waste form. The arc melter uses carbon electrodes to strike an arc in a bath of molten slag. The consumable carbon electrodes are continuously inserted into the chamber, eliminating the need to shut down for electrode replacement or maintenance. The high temperatures produced by the arc, convert the organic waste (or effluent of any kind) into light organics and primary elements, inter alia.

A plasma arc is used, wherein an electrical arc is struck between two electrodes. The high-energy arc creates high temperatures ranging from 3,000 to 7,000 degrees Celsius. The feed enters the chamber and the intense heat of the plasma atomizes the molecules.

Plasma is the phase of matter with its electrons stripped. In argon plasma, argon ions and electrons act as the conducting species. Three independent, yet not necessarily connected, examples of power sources are (Direct Current aka DC) dc-electric, radio and microwave frequency generators. The most advantageous is the radio or inductively coupled plasma (ICP) because of sensitivity and minimal interference. DC plasma source are simple and relatively inexpensive.

Flames can be used to atomize the effluents as well. Flame atomizers contain a pneumatic nebulizer, which converts the sample solution into a mists or aerosol. Two separate dc plasmas can have a single cathode. The overall plasma burns in the form of an inverted Y. Flame atomizers avoid much of the associated emissions.

Lasers can also be used to atomize the effluents, such as U.S. Pat. No. 4,482,375 (hereinafter the '375 patent) to Shankar et al. for “Laser Melt Spin Atomized Metal Powder and Process,” which is incorporated herein by reference in its entirety. The '375 patent describes a method of producing rapidly solidified metal powder utilizes a spinning metal source and a laser beam to melt the surface layer of the source and atomize it. The laser beam is directed at a glancing angle along the surface of the spinning metal source. The source spins at a high speed of 10,000-30,000 revolutions per minute. The atomized metal is solidified rapidly in an inert gas atmosphere. Very high cooling rates up to 106 degrees Celsius per second can be achieved. Very small and uniformly distributed particles of rapidly solidified metal can be obtained having a narrow particle size distribution from about 50-150 microns and typically having a high percentage of the particles at a particle size of below 100 microns. For example, Nickel begins to boil and vaporize at 2732 degrees Celsius as shown to the left of the main chamber, above the 2500 degrees Celsius point.

Laser-induced breakdown spectroscopy (LIBS) is a simple, rapid, real-time analytical technique based on the analysis of the spectral emission from laser-induced sparks or plasmas (FIG. 1). Pulsed laser radiation is focused to a small spot on a sample material. When power densities exceed hundreds of MW/cm2, a high-temperature, high electron density laser spark or microplasma is formed. The temperature of this plasma, initially, is very hot: 104 to 107 degrees Celsius. At such a high temperature, any sample material is broken down, vaporized, and ionized.

Along with plasmas, arcs and lasers, chemical vapor deposition (CVD) can be used to atomize the effluents. Metalorganic chemical vapor deposition (MOCVD) is a chemical vapor deposition process that uses metalorganic source gases. This method is known in the art. For example, MOCVD may use tantalum ethoxide (Ta(OC2H5)5), to create tantalum pentoxide (Ta2O5), or Tetrakis Dimethyl Amino Titanium(IV) (TDMAT) to create titanium nitride (TiN).

One may use Nickel Carbonyl metal organic to deposit pure Nickel at low temperatures (e.g.

140-250 degrees Celsius).

After leaving the vortex chamber, the effluent is passed through to the main chamber 262 through intensifier pumps 261, which speed up the reaction and the movement, resulting in a more efficient extraction process. In a preferred embodiment, four intensifier pumps can be used, which is unique to this invention, as previous embodiments have only used two intensifier pumps.

The main chamber is shown as a vertically disposed rectangle in FIG. 25B, although it can be of any shape or size. The temperatures in the main chamber range from approximately 3000 to below 500 degrees Celsius. As the temperature gradient gradually changes, the extraction ports for the corresponding metal vaporization points are shown to the left and right of the main chamber, at the approximate point where the respective metal is extracted.

The temperatures in the chambers can also be regulated by, but not limited to, any mechanism, including but not limited to, the following: ultrasonic waves, infrared waves, microwaves, convection, flames, light spectrum, light optics, laser, ionizing radiation, ultrasonic and vibrasonic technologies.

The effluent moves downstream from one zone to the next with the help of intensifier pumps retrofitted with velocity multipliers, which serve as a curtain technology to maintain different environments in different zones. These air curtains preserve the needed temperature zones for processing of the effluent at each temperature gradation. For example, one standard air curtain technology was described that has been used in gas desulfurization (FGD) reactors in “Effect of Near-Wall Air Curtain on the Wall Deposition of Droplets in a Semidry Flue Gas Desulfurization Reactor” by Jie Zhang, Changfu You, Changhe Chen, Haiying Qi, and Xuchang Xu, University of Tsingua, Beijing, China, 2007.

In a preferred embodiment, the extraction ports 263, shown all along the sides of the main chamber include polarized Chalcogel filtration capabilities.

Further, electrolysis can be used to magnetize the metals and aid in the extraction process. This technique is known to persons having ordinary skill in the art.

The extraction ports 263 can be set to extract specific metals based on their heats of vaporization. As the metals vaporize, they will be extracted at that point. Further, filter housings have a hinged, sealed rear door that allows for efficient filter replacement. Extraction gases are recycled at each Chalcogel filter exit port and at the bottom exit stream 264 shown at the bottom right in FIG. 25B. Further, all extraction metals that are known to refineries can be processed by the reactor shown in FIG. 25B, including sodium, potassium and phosphorus, gold, iron, copper, chromium, etc.

The effluent sent to the pyrolysis feed chamber can include, but is not limited to, micronized spent filters, filter cakes, powdered slag, matte, reside, skimmings, dore, fly ash and sweeping, and acid residue. Further, in a preferred embodiment, the feed streams can be saturated molecularly.

Hydroelectric energy is produced by the force of falling water. Hydroelectric energy can also be produced by the generators that are turning, as a result of the flow of water passing through, and within, and through the system; not only this Reactor, but the overall flows of feed stock, in the event that baffles are modified, to act as propellers, or wave technology generators). The capacity to produce this energy is dependent on both the available flow and the height from which it falls. Building up behind a high dam, water accumulates potential energy. This is transformed into mechanical energy when the water rushes down the sluice and strikes the rotary blades of turbine. The turbine's rotation spins electromagnets which generate current in stationary coils of wire.

In a preferred embodiment, the stationary coils that the turbines rotation generates electricity within can be modified to be those coils (e.g., copper and the like) currently known in the Rodin-Coil System for Pulse Direct Current (PDC) as is known to be used in ceiling fan technology, in addition to straight and common coil technologies as is familiar to someone of ordinary skill in the art. Using PDC in Ceiling Fans is up to 600% more efficient. If using the PDC for outbound flows, movement of electricity is 600% more efficient, then using the same design of the Rodin-Coil in generators will also increase efficiency accordingly.

In FIG. 25C, the mechanical energy from the reactor is generated in the form of steam and/or gas to power the turbines. The turbines can be low pressure (LP), intermediate pressure (IP) and high pressure (HP).

The impinging jet stream exerts high pressure on which causes the turbine to rotate and create power. The turbines can be a reaction turbine or an impulse turbine. Impulse turbine includes pelton wheel and cross-flow, for example. Reaction turbines include propeller, bulb, straflo, tube, kaplan, francis, and kinetic, for example. Compressors are located to the left and right sides of the chamber where the oxygen, hydrogen and water enter the main chamber. They serve to increase pressure in the direction of the turbine. The casing is attached to a single turbine via a shaft, which extends upwards between two flows of water. However, tandem, compound and cross compound turbines can be used. Single casing units are the most basic style where a single casing and shaft are coupled to a generator as in FIG. 25C. Tandem compound are used where two or more casings are directly coupled together to drive a single generator. A cross compound turbine arrangement features two or more shafts not in line driving two or more generators that often operate at different speeds.

Two Chalcogel filters can be seen at the top right and top left sides of the reactor where water exits the reactor. The Chalcogel filter is described elsewhere in this application and that description is incorporated herein by reference. Though the drawing shows two filters, one or more may be used, depending on configuration. A gas water separator is disclosed, similar to that disclosed in U.S. Pat. No. 4,723,970 (hereinafter “the '970 patent”) to Yokoyama titled “Gas-Water Separator” is incorporated herein by reference in its entirety.

The '970 patent describes, “gas and water [are separated] from each other by the action of centrifugal force induced by rotating fluid. In this type of gas-water separator, fluid is rotated at an upper portion within a casing and water drops contained in the gas are shaken out to the outside by the action of the resulting centrifugal force and thereby separated. The gas is passed to an outlet side, while the separated water drops are discharged to the exterior of the casing by a drain valve disposed in a lower portion within the casing.”

Further, at the top of FIG. 25C is the utility access area, which is located at the top of FIG. 25C on the right side. This utility access area is positioned in a maximally efficient manner.

### Cell 26: Fuel Preparation Plant (Pre-Pyrolysis/Pre-Power)

Cell 26 illustrates herein a system, method, and process (EFSMP) of an integrated, interconnected, hybrid, connected, parallel, closed loop, emission free Oil Refinery. The recycling system of Cell 26 allows the use of more than typical Crude Petroleum Oil Feedstocks of which the past and present industry is limited to, and which such is not a limitation for this invention, and can also be used. This EFSMP can be aggregated or standalone EFSMP, and use any combination of raw feed stock (Crude Oil variety), as well as Advanced Ceramics, Tungsten Carbide, Soft ferrites, Powdered Metals, Solid oxide fuel cells, Steatites, Phosphors. In addition to the other Systems, Methods, Processes, and Products that are derived and as part of the EFSMP in the invention herein.

The recycling system of Cell 26 provides for a system and process which is self sufficient, self contained, closed loop, with negative carbon emissions, and a zero carbon emissions, and is not limited to upgrades and modifications by someone skilled in the art, in that, for example, sulfuric acid can be filtered, refined, purified and created in the present integrated Matrix.

The recycling system exemplified in Cell 26 can be for Carbon based petroleum products, and the material processing for in-house intra-supply serviceability therein for self sufficiency and being a closed loop facility for oil refining, and oil re-refining, and power generation.

Cell 26 illustrates a recycling system which allows for a closed loop system, with zero emissions. The recycling and integration allows the present matrix system and process to be classified as a “green refinery” EFSMP, in that it can use the latest clean process technologies, producing ultra-low Sulphur fuels, gasolines, etc., where precuts can be sent out by truck, rail, pipeline, and tanker where available. Cleaner energy technology, fuel Cells using sulfuric acid, and an Integrated Gasification Combined Cycle (IGCC) using petroleum coke, are each identified “Green Energy” systems that are utilized by the EFSMP.

The recycling system as well as the integration feature of the present matrix system and process enables the removal of “contaminants,” for re-use and sale, from slurry, batteries, acid, oil, feed, gas, additives, lubricants can be done with an EFSMP module, alone, in hybrid form.

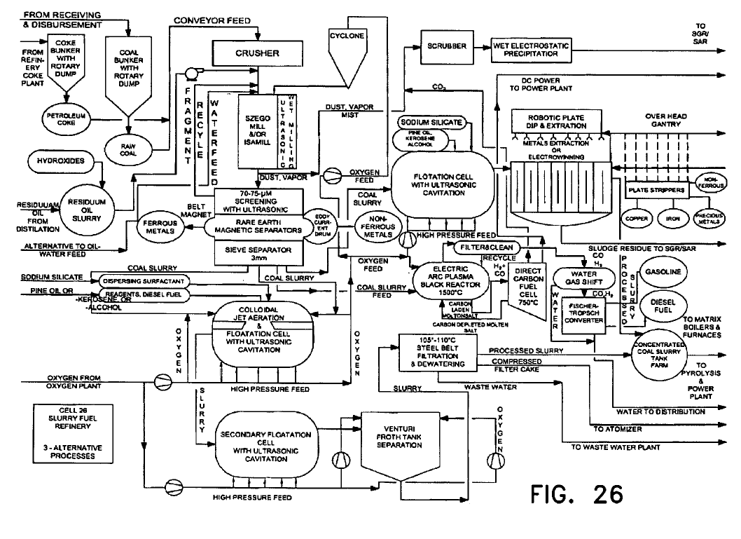

Now turning to FIG. 26, a pre-pyrolysis and pre-power processing of coal slurry is shown. The process demonstrates 3-alternative processing: flotation; electrowinning and rare earth magnetic metals extraction; and plasma black reactor fuel cell with Fischer-Tropsch water, gasoline and diesel production.

### Cell 27: Master Matrix

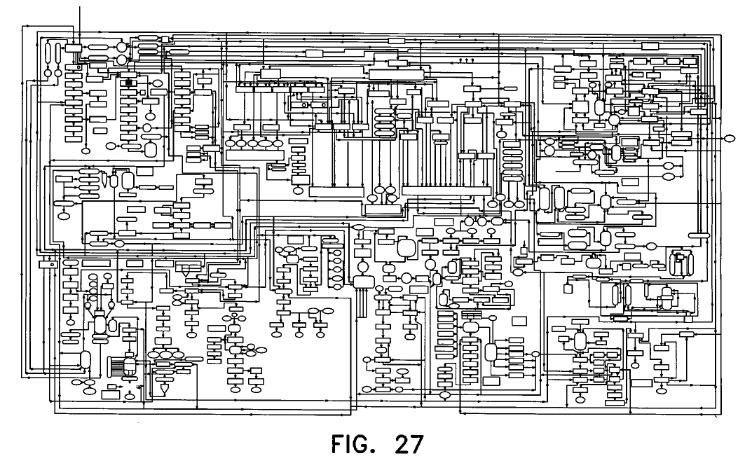

Cell 27 is depicted in FIG. 27 and embodies the pyrolysis module of the present system and method. Through a breakdown stage, like pyrolysis, plasma arcs, electric arc, spark plasma sintering, vacuum sintering, current pulses, electrical resistance heating, inductive heating, gas pressure sintering, microwave and sound wave bombardment, heat, light, laser, radiation, thermonuclear heat, sintering, chemical, anaerobically, aerobically, either individually or jointly, petroleum products, petroleum derived products, petroleum effluents. Impurities are then separated, and refined to create carbon black, or through the centrifugal configuration of white thin film processing, sorted into viable products.

### Cell 28: Foreign/Outside Collection Plant

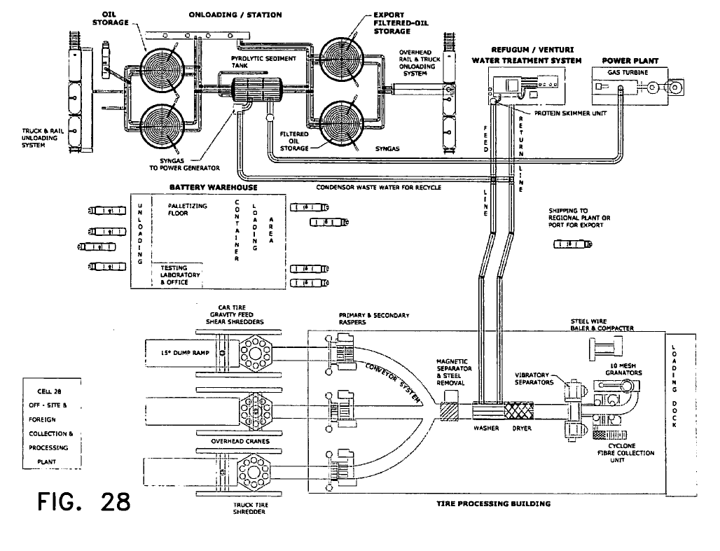

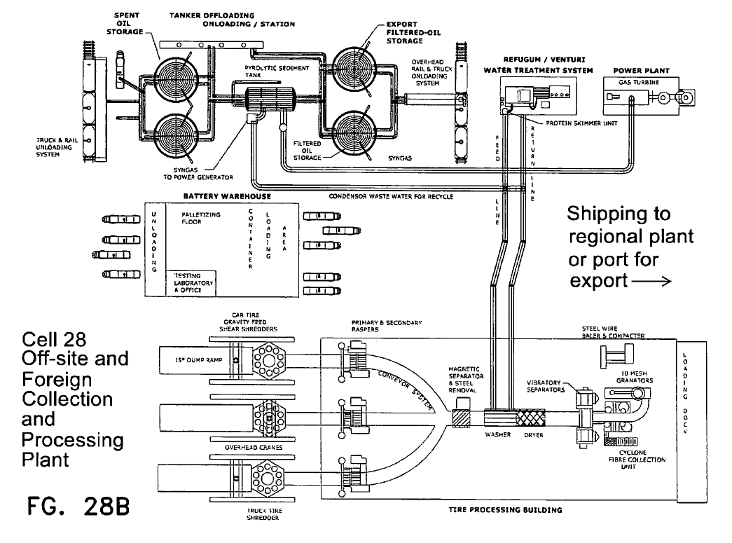

Cell 28 is depicted in FIG. 28 and represents the foreign spent tire, battery and waste oil collection and pre-processing plant for export to the parent Matrix operations of the present system matrix and process. Foreign is defined any off-site location facility beyond ten miles of any radius of any facility as defined in this embodiment. The plant will be self sufficient with its own power generation and water treatment system to allow for recycling without pollution to local water supplies. These plants are also to be located in minor markets within the host country to optimize hub refineries and power plant feed stocks utilizing the Matrix system.

Spent tires, rubber, batteries and waste oil can be route collected from local businesses such as auto, bus, train and truck repair shops, commercial farms, oil change businesses, along with established industrial, military, marine and residential drop areas. Collection can be done with a small fleet of trucks owned and operated by the local plant. The fleet will weekly cover a radius area ranging from fifty to one hundred and fifty plus miles from the plant. Interstate transporters will carry the materials from the foreign collection plants to the hub refinery or power plant.

The plant washes and bulk shreds the tires then loads the shreds into either enclosed pallets for container loading or direct bulk blow-in loading to tanker trucks for offloading directly into the ship's cargo hold. The chemical or cryogenic tire shredding technology is applicable in the offsite plants due to their smaller capacities.

Tire fluff can be palletized and banded for containerization. Batteries can be washed and brick stacked on pallets and then containerized for export. Due to the health hazards of the battery lead and electrolyte, it is better to do the processing at the Matrix plants.

Metal fragments from the shredded tires can be baled into cubes and containerized for export. Waste oil can be tested at an on-site laboratory to ensure that the quality of each load is checked prior to unloading into the tank farm to prevent any non-traditional or excessive contaminants from causing processing problems or customs entry clearance.

Numerous foreign collection plants can be situated in major market areas close to ports which can accommodate medium to large sized ocean oil tankers and container ships. Due to the renewable attributes of waste and pyrolic oils, the foreign plants are adding a natural resource into the acquiring country, and or community, for a continuous processing, consumer use and recycling system.

These plants are an integral part of the Matrix system and business strategy.

The metals from the tires can be sold on the open market as pig iron. Customers could also include the same clientele as the consumers of the lead production that will come from the recycling and removal, and smelting of the lead batteries. Fibers (rayon, nylon) such as those typically found in the tires are usually sold to the textile industry at established exchanges for such commodities. Such fibers can also be used on-site in an EFSMP module that creates composites and ceramic bearings.

The present vertically integrated ESFMP invention matrix discloses a metallurgy module that is a part of the EFSMP in which Lead, Zinc, Gold, Aluminum, Silver, Steel, Iron, Nickel, Zinc, Copper, and other metals are reclaimed and removed from oils, batteries, acids, feeds, flare stacks exhaust piping, pressure relief systems (EFSMP), bunkers, distillation towers, and other EFSMPs similar to that of Gemini Technologies, as well as those found in lead acid recovery facilities, Gold Refiners, and other precious metals and non-precious metals operations. Such metals are all sold on the open market when collected, as well as toxic metals being disposed of as required by local, state, federal, and international standards and law. The embodiment of the EFSMP herein also comprises a means of manufacturing of amorphous metal alloys, also called metal glasses, silicon carbide fiber, Carbon Foaming Ceramics, and means for Microwave Assist Technology.

The invention embodiment herein includes a method of refining that uses Clay Acid, Clay Acid Techniques, Clay Acid Technology, and Clay Acid SMP's where in the embodiment herein comprises a vertically integrated matrix of technologies for Recycling and reactivation clay used in the ESFMP can be done onsite within each Sintering Reactor chamber so as to remove the components found in the attachment herein, called Waste Minimization in the Oil Field, by the Railroad Commission of Texas.

Such Clay can be placed in the Sintering Plant and Sintering Furnace to remove such contaminants, and then heated to maximum temperatures from the ESFMP Matrix Reactor. Such composite/Advanced ceramic/s have many utility uses and can be readily sold into the marketplace. Such materials, and the like, that are also processed in the same function as Clay Acid, could be Functional Ceramics, Refractory Metals, Iron Sands, Composite Materials, Metals, minerals, intermetallics, and functionally graded materials. Furthermore, the embodiment herein, is able to re-activate the Clay Acid (aka Acid Clay) that is used in refining for further use in the refining process matrix.

In the event there is an abundance of Clay Acid, such material can be used to produce Carbon Black, Carbon for filtration, Asphalt, and the like, from other material combinations that are either produced from on-site, off-site, refining, or from materials (liquid, solid, plasmas, and gasses) that are brought onto the site, and the like. Such Ceramic manufacturing is not limited to on-site capacities, and can be sent elsewhere for production, either in part or in whole.

Waste-water treatment is an important part of any refinery and recycle business. To the extent that refineries usually operate, along with Lubricant re-refiners such as Evergreen, water from processing is treated and returned to the municipal sewage system for further treatment and processing. There are several well known methods that are used before water is fed back into municipalities. However, this embodiment includes a system that is entirely closed loop, where all methods of filtration are such that Waste Water treatment is a closed process. Water from the EFSMP will be used to reconstitute the SO3, after significant amounts of filtration and removal of contaminants (see chart) are done. Such contaminants can be trace metals, environmentally hazardous elements and the like (see chart). Filtration methods can range from straight clay processing, sand filtration, mud, reverse osmosis, Venturi systems, optical EFSMP, ultra violet, acid decomposition, activated carbon, and the like.

As part of the water treatment processes, and the advanced ceramics, as well as the creation of water from hydrogen feeds (as either a byproduct of refining, roasting, acid processing, energy creation, and the like) the embodiment herein, represents an EFSMP that is able to constantly reactivate carbon for purposes of filtering, and refining. Such reactivation of carbon is not limited to on-site capacities, and can be sent elsewhere for production, recycling, refinement, and the like, either in part or in whole.

The embodiment herein uses a matrix of vertically integrated technologies beyond the use of using I/R for straight oil refining, and oil re-refining, for the purposes of using in part, and the like, refractory lenses, for the ability to detect leaks via infrared. Such SMP in the embodiment can independently, in combination with, or co-dependently with, any A/I or software, or other hardware, repair, with any form of hardware, software, chemical, composite, material, and the like, any portion of the ESFMP that is in need of such repair, maintenance, or upgrade.

As a result of the amount of resources used for infrastructure development throughout the world today, there has been a substantial increase in the price of lead, metals, and other commodities. As domestic national infrastructure and development growth continues, there is always a concern that economic measures that took place during the rationing period of World War II. Through the process of conscription, the government appropriation of seized business, to serve the war effort, could be reinstated, as in the 1930 Smoot-Hawley Tariff Act in the United States that strangled global trade as other nations retaliated against the United States Those industries that suffered the most included agriculture, mining, and logging, as well as “durable goods”, like construction. Already there is a tariff that was recently imposed on automobile tire imports from China. Retaliatory economic tit-for-tat, and quid-pro-quo, measures are anticipated; therefore, economic isolationism is not an unexpected response. In that event, it will be necessary for production of fuel oil and hydrocarbon-originated products, (as a United States strategic, military and security focus,) to be nationally self-sufficient in order to maintain a working government and functioning society. As such, in addition to the metallurgy, refining, re-refining and EFSMPs that are taking place at each location, re-mining modules are incorporated herein. Such re-mining modules are not limited to the smelting, ingot production, and ceramics output of different commodities (regardless of form—bricks, bearings, pipes, etc.,) but are also used to combine different materials from on-site sources, (and, where necessary, externally sourced,) to be used as alloys and the like for sale—yet an additional revenue stream. Gold, Nickel, Lead, Iron, and high-tech ceramics are just a few of the EFSMP modules that can be interlaced in the EFSMP of this embodiment to accomplish desired goals.

Site location is of tantamount importance so as not to create negative attention to the type of industry that a community generally finds unwelcome in their back yard—the pervasive “NIMBY” (Not In My Back Yard) problem. To whatever extent possible it is envisioned that each and any United States location be a designated Super Fund site that has already been deemed as environmentally compromised. This has tremendous benefits as a typical designated Super Fund site is a now closed military base. Each facility has storage bunkers, rail/train sidings, connection infrastructure with public utilities (water, sewer, electric,) and is a maximally secured location, due to its previous use. Additionally, these locations are generally larger than what is needed for a typical refinery; therefore, the entire campus can easily accommodate growth for newer technologies as they develop advances in the art of the existing technology, capacity and on-site storage expansion, and overall expansion of any of the modular components to accommodate increased demands on the facility—including personnel. Furthermore, because the EFSMP of the embodiment herein is self contained, emission free, and closed loop, it is possible to create a subterranean structure/campus, etc., wherein the only above ground appearance, other than vehicular, and piping, are those structures that are built to accommodate rail, truck, and other vehicles to the facility. As an added benefit, such is likely to be impervious to inclement weather, acts of G-d, aerial surveillance, tornado's, snow storms, earth quakes, hurricanes, cyclones, civil insurrection, terrorism, acts of war, etc., and the like, nor is the environment, civilian, animal, populous, etc., and the like, likely to be compromised, or assaulted by such indescript and unobtrusive facilities.

Beside the environmental issues mentioned in the above sections, (especially considering refineries situated near residential areas,) nuisance abatement or attenuation has become an issue with both local authorities and with representatives of the local population—so-called neighborhood councils or other community groups.

Topics such as noise, light pollution, smoke emission (flaring,) and smell that directly impact proximate residents receive significantly more attention from these neighborhood councils than the above-mentioned ‘major’ emissions which tended to receive more attention historically from the media. Light pollution and nuisance-by-light can be caused via nocturnal flaring at refineries and petrochemical plants located near densely populated areas.

The remaining unused land at the site can be leased or sold as the case may be to complimentary businesses, or for land development—either commercial, recreational, military, government, environmental, ecological, or residential, or the like.

Basically, crude oil, liquid resources, and natural gas are mixtures of many different hydrocarbons and small amounts of impurities. The composition of those raw materials can vary significantly depending on their source. Petroleum refineries may be simple, yet complex plants, where the combinations of, and sequences of, processes is usually very specifically targeted to the characteristics of the raw material (crude oil) and the products intended. In a refinery, portions of the outputs from some processes are fed back into the same process, fed to new processes, fed back to a previous process, or blended with other outputs to form finished products. Most refineries are of different configuration, process integration, can use differing feed stocks, can have feed stock flexibility, and produce different products; product mixes, unit sizes, and can have unique design and control systems. Moreover, differences in an owner's strategy, market situation, location, as well as age of the refinery, its historic development, available infrastructure, and environmental regulation are amongst other reasons for the wide variations in refinery concepts, designs, and operational modes.

The production of a large number of fuels is by far the most important function of refineries and will generally determine the overall configuration and method of operation. Nevertheless, some refineries can produce valuable non-fuel products such as feed stocks for the chemical/petrochemical industries. Examples are mixed naphtha feed for a steam cracker; recovered propylene and butylene for polymer applications; and, aromatics manufacture. These are covered under the large volume organic chemical BREF. Other specialty products from a refinery include bitumen, lubricating oils, waxes, and coke variants. In recent years the electricity boards in many countries have been liberalized, thereby allowing refineries to feed surplus-generated electricity into the public grid at a profit. The electrical requirements and usage of the embodiment herein has the capacity, potential, ability, and the like, to be self sustaining, and a closed looped and self contained. The electrical power needs of the EFSMP herein can be independent or in combination of non-internally generated power, and can be further understood and integrated by someone skilled in the art, to produce a hybrid or combination, or stand alone, or solely foreign (non intra-generated power) electricity.

Part of the invention embodiment of the matrix described herein includes the EFSMP herein and incorporates a series of storage tanks, tank farms, and bunkers, and the like, in any sort of location-specific configuration, utilized for coker charge stocks and products, as well was traditional uses for a refinery. The modules can be rotated and altered in any sequence as economically desired, either for normal storage, rotated storage, and/or product feed during times of routine maintenance, repair, and economic need in accordance with the operator's determination of feasibility.

Removing “contaminants,” for re-use and sale, from slurry, batteries, acid, oil, feed, gas, additives, lubricants can be done with an EFSMP module, alone, in hybrid form. Or redundancy, using the following techniques for improved separation of catalyst from slurry, to decant oil from the slurry settler used in catcracker: a) One system incorporates high voltage electric fields to polarize and capture catalyst particles from decant oil; b) The amount of catalyst fines reaching the decant oil can be also be minimized by installing high-efficiency cyclones in the reactor to shift catalyst fines losses of the decant oil to the regenerator (where they can be collected by any particulate abatement technique.) Achieved environmental benefits decant oil sludge from the FCC can contain significant concentrations of catalyst fines. These fines often prevent the use of decant oil as a feed stock and require treatment that generates an oily catalyst sludge. Catalysts in the decant oil can be minimized by using a decant oil catalyst removal system. While these methods are commonly practiced, they are not done in tandem or hybrid form. In the invention embodiment herein, also disclose is a EFSMP that is hybrid and can also, (but not necessarily,) alone, with different types of feed stock, slurries, dross, black oil, Pyrolytic processed feeds, or reactor chamber, sintering chamber, furnaces of different types, and or in conjunction with magnetic fields, finning, Venturi, oxygenation, dehydration, laser, quench towers, wet scrubbing, scrubbing, dry scrubbing, semi-dry scrubbing, optical, microwave, and sonogramically can be economical as a cost (defined as material, energy and time) regardless of the single platform or permutation and/or combination thereof.

Products of this EFSMP, as with any refinery, are gasoline, jet fuel, aviation fuel, diesel, bunker fuel, Liquid Petroleum Gas, petroleum coke, propane, Syngas, and asphalt. Additionally, isodewaxing, hydrocracking, fluid catalytic cracking, slow coking, coking, hydraulic decoking, isomerization, continuous catalytic regenerative platformer units, polymerization, and other typical technologies also used (independently and/or jointly,) and as such lube hydroprocessing and variations thereof are attainable. Gasification purification and recovery, and UOPs similar technologies of Selexol, polysep membranes, polybed PSA systems, waste heat recovery, Claus-tail gasification, acid gasification, thermal reclaiming and purging, Texaco/cool water gasification, TVA/Muscle Shoals gasification, COS Hydrolysis, with production and collection of energy, Sulfur, urea, ammonia, Carbon, Nitrogen, Hydrogen, methanol, oxo-alcohols. Additionally, in combination with any of the technology principals outlined herein, and either in combination, stand alone, parallel or their equivalents, the EFSMP when used in conjunction as a matrix of technologies that are vertically integrated into a reactor and the like, is able to perform such Cracking technologies, but not limited to the Cracking Heavy Oil with REY Zeolite and Waste Plastics, as well as with other sorbents, and the like. The EFSMP can produce a range of products from Group I base oils to high-quality, low-aromatic, high VI group II/III base stocks Group II/II+ and oils, as well as the other, (but not limited thereto,) the descriptions found in the United States DEPT of LABOR OSHA list at http://www.osha.gov.pls/imis/sic_manual.display?id=627&tab=description.

The EFSMP can re-refine lubricant oil, as well as refine oil into lubricants and other refinery products of multiple grades of base oils within the Group II/II+ categories.

Additionally, as Coal, and Coals, are utilized not only as feed sources for this EFSMP, but are also used to produce electricity, and other gasses, and contain minerals, metals, and other products that can be extracted and sold, the embodiment herein also employs technologies form Fischer-Tropsch reactions, where such technologies creates hydrocarbon compounds called alkanes. Methane and ethane are examples of alkanes. Some of the alkanes created by Fischer-Tropsch are desirable for use as fuel, but others have low molecular weights that make them unsuitable. This EFSMP teaches, but is not limited to, converting Fischer-Tropsch materials to usable diesel fuels, and can be accomplished by a dual-catalyst system that allows low molecular weight alkanes, with between four and nine carbons in the chain and boost their weights up to a range appropriate for diesel fuel in the dual-catalyst system, whereas one catalyst removes hydrogen, converting the alkane to a new material that contains carbon-carbon double bonds, and the like, as is economically desired. Those double bonds can make the new materials, and the like, more reactive. Then, if economically required, or desired, a second catalyst, or more if necessary, scrambles the carbon bonds, creating compounds with higher molecular weights, and the like. The first catalyst then returns the hydrogen atoms to the rearranged compounds, yielding alkanes that are usable as fuel, and the like.

Additionally, most refugium is manmade synthetic microcosms of what the Florida Everglades, or Amazon Rain Forrest is for water filtration, in addition to elements of aquifors, calcium, limestone, and volcanic rock filtration, coupled with tidal and oceanic flows.

The waste water plant of Cell 28 in this embodiment contains a special Refugium system which is capable of absorbing organics and in-organics transforming the waste water into potable water. Further, such types of equipment, methods, processes, and systems, could be used individually, in tandem, parallel, in combination and the like, to further purify the water, where purification is defined as the removal, processing, and synthesis of desired natural, and manmade, commercial, proteins, enzymes, and synthetic materials and compounds, and elements, and products of any organic, or inorganic, metal, chemical compound, mineral, trace element, elements, amino acids, acids, pollutants, and the like, by aquatic flora and biologically engineered fauna, where such types have been previously defined, and are further defined as, but not limited to algae, photosynthetic microbes, snails, clams, mollusks, altered fish and bivalves in a open or closed loop environment. Furthermore, as genomic sciences is advancing, someone skilled in the art could easily genetically modify any of the microorganisms, biologics or algae's, to desired specifications for filtration, production, and other uses, in as much as it may be desirable for the user to do designing, synthesizing and assembling genes, nucleic acids, synthetic chromosomes and even whole genomes to produce bio-chemicals and other high value products, in addition to filtration of products from the water.

Where necessary, heaters and/or chillers, and the like, can be inserted within the facility, or inline, to cool the water, or heat the water, to preferred temperatures to facilitate desired filtration and maximize flow rates, while reducing any negative effects on the local environment. Moreover, as there is a biological and bacterium elements, and potentially a photosensitive chemical element to the filtration, lighting, metal halide lighting, including but not limited to ultraviolet, and infrared, can be utilized. Specialized lighting can also be used for photosynthesis, propagation, growth, and aquaculture of flora and algae's, to desired specifications by the user. Further, lighting wattage, exposure, time, etc., can be controlled either on site, or remotely, via timers, programs, computers, monitoring, and/or in combination of desired water conditions.

Additionally, filtration can be accomplished chemically, biologically, or mechanically, either in tandem, combination, individually, and the like. In addition to lighting, pumps may be utilized, in addition to creating, and adjusting flow rates, to also be utilized in such processes as protein skimmers, protein skim boxes, venturi filter pumps, vortex creating, synthetic tidal flows, reverse osmosis filtration, and the like.

Organic and inorganics that can be removed are Carbon, Carbon Dioxide, Petroleum, Ammonia, Nitrates, and Nitrites. Matter, organics, and inorganics, such as calcium, kalkwasser, iodine, iron, magnesium, strontium, phosphates, and trace elements, can all be removed, or added, and regulated as desired by the user.

Moreover, although the Filter Cake Making piece is included in the flow chart of FIG. 14, it is also relevant to this embodiment in Cell 28; as this also reflects the references included in these embodiments, where the Filter Cakes of Cell 28 are sent to the Master Facility for processing in the Atomizer, in order to recapture any/all materials therein.

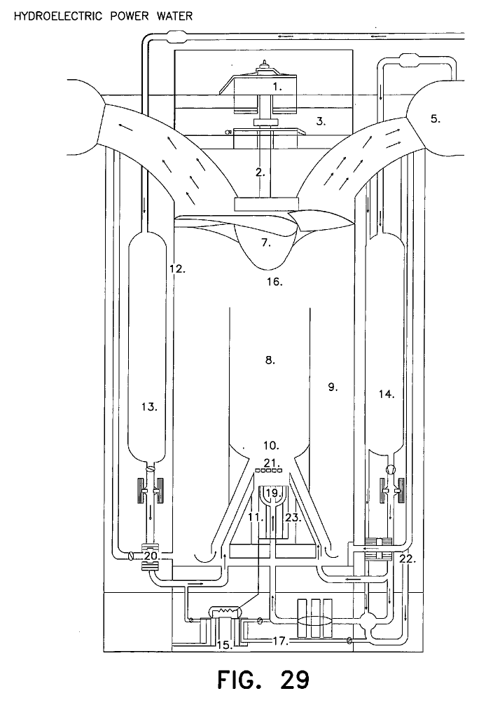

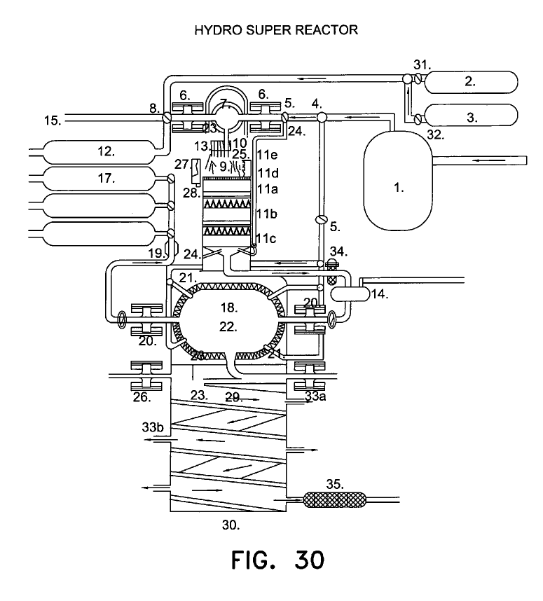

FIG. 29 is a diagram of a Hydroelectic Power Water Reactor. FIG. 30 is a diagram of a Hydro Super Reactor.

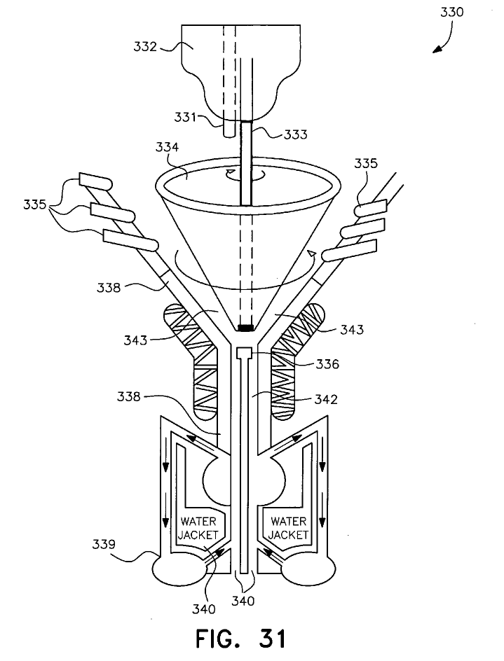

FIG. 31 is a diagram of another embodiment of a Nano Reactor.

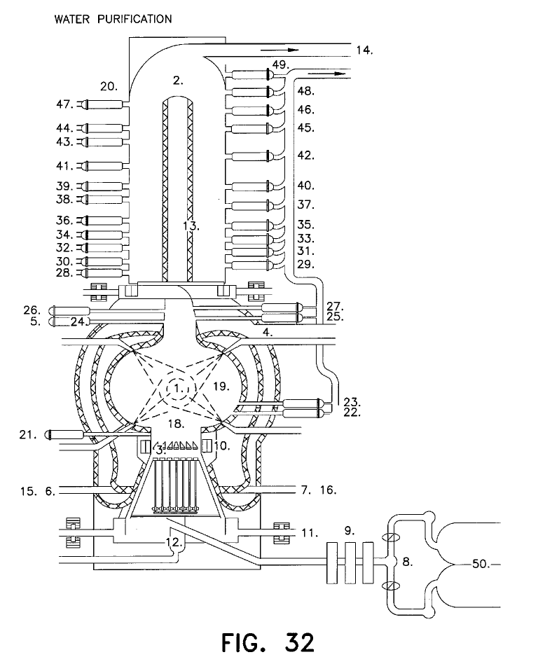

FIG. 32 is a diagram of a Water Purification Reactor.

### Additional Alternatives to Embodiments

Currently, a process termed hydrocracking is used to break down hydrocarbons with molecular weights too high for fuel use into lower molecular weight materials, but the process is not very selective, and is a limitation not encompassed in the embodiment proposed, herein. One of the proposed embodiments of the catalyst system included herein, either in stand alone, parallel, combination, or hybrid can combine very low molecular weight and very high molecular weight alkanes to produce alkanes in the diesel fuel range and, thus, may also prove useful for recovering value from high molecular weight materials, and the like.

Without limitation in the examples of feed stock and processes disclosed herein, the invention embodiment also utilizes the same EFSMPs, as well as those mentioned throughout the embodiments of this application. Furthermore, without limitation, as noted above, the present invention matrix and system can process, any petroleum oil, hydrocarbon, petroleum product, crude oil, including light oil, light sweet crude oil, light crude oil, bitumen, Peat, sintered oil, pyrolysis/pyrolic oil, coal oil, desulfured crude oil, light sulfur oil, shale oil, heavy oil, sour oil, Orimulsion oil, salt oil, presalt oil, sand oil, coal, fugitive emissions, mixed gasses, and the like, either as a primary feed stock, or as a combination and/or mixture of any of the above types of feed stocks, including such additional examples as North Dezful, Naftshahr, Maleh Kooh (Kerman,) Kashagan, et al., through the Reactor System, in either parallel, combination, singular component, multicomponent, matrix, or other vertically integrated technologies such as, for example, but not limited herein: Fluid Catalytic Crackers (FCC) FCC Maximum Olefin Mode LPG, Propolyne, and Butylene FCC Maximum Gasoline Mode FCC Maximum Distillate Mode As well as such feeds as, but not limited to: Vacuum Gas Oil Feed (VGO) VGO Hydrotreated VGO VGO mixed w/ VR.

And using such processes, as economically desired, but not limited to, and in any matrix, combination, and hybrid of:

Treatment Processes

### Amine

### Solvent

### Solvent De-waxing Hydro

### Desulfurization Sweetening

### Solvent De-Asphalting

### Crude Distillation

### Naphtha Hydrodesulphurizer

### Kerosene Merox Unit

### Gas Oil Hydrodesulphurizer Excess

### Naphtha Stabilizer Naphtha

Stabilizer Gas

### Sweetening

### Jarn Yaphour Crude Oil

Stabilization

### Unibon Unit Condensate Splitters

### Kerosene Sweetening

### Biogasificatioun

and Heavy and Extra Heavy Crude Oils, Coal, Coal streams, Mixed Waste Streams, and the like, can pass through the EFSMP for such treatments as:
Hydrogen and Steam to processing

### Coking

### Delayed Coking

### Biological Upgrading

### Naphtha Hydrotreater Isomerization

### Kerosene Hydrotreater Unit

### Gas Oil Hydrotreater

### Heavy Naphtha Catalytic Cracking

### Sulfur Recovery

### Amine Hydrotreating

### LPG Treating and Recovery

### and Carbon Rejection Technologies Fluid Coking Flexi Coking Visco-Reduction

### Solvent Extraction

### Thermal Cracking Delayed Coking Aqua-Conversion

### Metal Recovery

Where necessary, and/or required, where economics and feasibility permit and are desired, the embodiment of this EFSMP incorporates Hydrogen Addition Technology for Catalytic Reforming Unit for Hydrogen Creation, Production of Syngas where Hydrogen is separated, Oxygenates (Okadura type and Interline), Oxygenate MTBE (Methyl Tertiary Butyl Ether), Oxygenate TAME (Tertiary Amyl Methyl Ether), and the like—regardless of the matrix.

Refinery Configurations, of the reactor, reactors, and the like of this EFSMP, described in this invention also include, either jointly or severally, such applications as:

### Topping Refinery

### Cracking Refinery

### Coking Refinery

and such applications are utilized, either in matrix, jointly, individually, severally, combination, and the like, of:
Deasphalting (SDA Process) Slag from Degasification Hydroskimming—atmospheric distillation Coal Gasification Plasma Gasification Gasification Slagging Gasification Topping refinery Catalytic cracking Residue Fluid Catalytic Cracking FCC Feed Nozzles Lance's for air introductions FCC Feed Nozzles at Supersonic Speeds Isocracking Coking Refinery—entrance point Delayed Coking+++ (IGCC Integrated Gasification Combined Cycle) Fluid Coking Thermal Cracking Flexi-Coking (Carbon Rejection Process developed by Exxon) for Gasifying to produce gas, similar to Fluid Coking for Flexi Gas Thin/Wiped Film Evaporator Pipe Furnace Vaporizer Visco-Reduction Aqua-Conversion Solvent Extraction Advanced Separation Systems for FCC's as Clyclones LPG Merox Units Gasoline Desulphurisation Steam Methane Reformer/Reactor Furnace (SMR) and Desulphurization Units Mytol Process Oxidation/Internal Breakdown EFSMP.

This EFSMP incorporates several different Hydrogen Addition Technology practices in Cells 4 and 15. However, several commercial technologies that compete with Hydrocracking with bottom of the barrel of heavy and extra heavy crudes, like waste oils are also included:

### LC Fining Catalytic Pyrolysis Process Unit

### HDH Plus H Oil (Hydrogen Oil) Can Electrical Grid or Wire Mesh

### Met Reactor Pyrolysis

### Steam Cracking Ethane Cracker Catalytic

### Shell Hy Con Technology

### Distillation Catalytic Hydrotreating

### Selex-Asp Process

### Catalytic Hydrodesulfurization

### SDA (Solvent Deasphalting A?)

Ebullated-Bed—related to LC

### Finning

### Lummus (LC-Finning) Axens (H-Oil)

### Steam-Methane Reforming

### Water-Gas Shift Conversion

### Hydrogen Purification

### Hydro Desulfurization

### Induced Gas Flotation Unit

### (IGFU)

### Naphtha Hydrotreater Unit

### Pyrolysis Unit

as well as a Kerosene Hydrotreater Unit, for Rapid Thermal Processing. The foregoing can be incorporated in this EFSMP either in individual platforms, reactors, parallel reactors, parallel processing, matrices, in combination, or separately, and be either presented jointly or severally.

The invention embodiments incorporate Visbreaking, and as such a Vacuum-Flasher is and can be included in the matrix of technologies of this EFSMP, as well as Distillate Hydroforming, and in such additional practices, either in conjunction with, as part of the matrix of vertically integrated technologies, either jointly or severally, in combination, but not necessarily in its own reactor, hybrid, or in parallel, combination, or individually, and collectively, but without limitation are Residue Upgrading Technologies: De-asphalting; Microwave; HSC (High Conversion Soaker Cracking); Merox; Olgone (by ExxonMobil); Gas-Oil Hydrotreater; QSL; Induced Gas Flotation Unit (IGFU); Naphtha Hydrotreater Unit; Scrubbers; Flame Stacks with Steam Turbines; Clay and Kinetic Technology International (KTI); Water Capture Units from condensation and conversion; Waste Oil Sewage Sludge; Black Liquor; Orimulsion.

An eco-friendly system, method, and process (EFSMP) is presented by the embodiments of the present invention as an integrated, interconnected, hybrid, connected, parallel, closed loop (Cell 6), emission free Oil Refinery (Cell 6), also known as an reactor, as further described throughout the application, which uses more than typical Crude Petroleum Oil Feedstocks of which the past and present industry is limited to, and which such is not a limitation for this invention, and can also be used. This EFSMP can be an aggregated or standalone EFSMP, and can use any combination of raw feed stock (Crude Oil variety), as well as Advanced Ceramics, Tungsten Carbide, Soft ferrites, Powdered Metals, Solid oxide fuel cells, Steatites, Phosphors. In addition to the other Systems, Methods, Processes, and Products that are derived and as part of the EFSMP in the invention herein, this current embodiment further presents a EFSMP (Cell 25) that is integrated in different permutations. Other reactors can be modified, according to user requirements, to accommodate different feedstocks, effluents, metals, water, liquids, powders, clays, oil, lubricants, acids, gasses, fumes, fugitive gasses, and the like, in different phases, in such that the EFSMP is self sufficient, self contained, closed loop, negative carbon emissions, and a zero carbon emissions, and is not limited to upgrades and modifications by someone skilled in the art, in that: Sulfuric Acid is filtered; Sulfuric Acid is refined; Sulfuric Acid is purified; Sulfuric Acid is created; Ancillary Product Steams are created; Mixed Fuels are created; Precious Metals are extracted (Cells 23, 25, and 7).

Products from the EFSMP (Cell 19) are such as, by way of example, but not limited to, LPG, Asphalt (Cell 7), Gasoline, Diesel, ATK, Light Naphtha, Naphtha, Heavy Naphtha, Kerosene, Gas Oil, Petrochemical Feedstock, Lube Oil, Fuel Oil (Stricht and Cracked), Bitumen, Solvents, Wax, Coke, Asphalt, Gold, Aluminum, Graphite (Cell 24), Advanced Composites, Aluminum Graphite, Li-ion Graphite, Copper (Cell 20), Zinc (Cell 13), Steel (Cell 17), Precious Metals (Cells 23,25), Sulfur (Cell 11), and lead, as well as Advanced Ceramics, Tungsten Carbide, Soft ferrites, Powdered Metals, Solid oxide fuel Cells (Cell 9), Steatites, Phosphors, and as technology further develops also includes variations of picene, which becomes a superconductor when it is laced with potassium or rubidium and then chilled. Picene is an organic compound found in crude oil; it is made up of 22 carbon atoms and 14 hydrogen atoms.

It looks like five benzene rings—common organic molecules—fused together in a staggered line.

Cells 2, 4 and 27 relate to Tires and Rubber Feed Stocks with Pyrolysis, Radiation, microwaves, Ultrasound etc. Cell 2 relates to Dry Distillation of Spent Tires, and an example of the EFSMP schematic of the Direct Dry Distillation of Tires by Fujikasui Engineering is known to someone skilled in the art.

Goodyear's Devulcanization Process is another well known method that is encompassed as a module within the present inventive system and method.

Hydrogenation of Spent Tire Rubber in Cell 4 is a chemical synthesis process of this EFSMP, with effluent streams being petroleum based, as is described throughout this application.

Cells 4, 7 and 26 relate to asphalt from Tire and Rubber with Pyrolysis and the like, for example Synthetic asphalt recycled tire rubber emulsions and processes for making them in U.S. Pat. No. 7,547,356, incorporated herein by reference and all cross related prior art and references. Used Lubricant Oil can also be processed in this EFSMP, by example of U.S. Pat. No. 4,073,720, which is a method for reclaiming waste lubricating oils relating to an improved method for the refining of hydrocarbon oils. More specifically, the invention relates to an improved pretreatment method for the reclaiming of used lubricating oils by the removal of solid and liquid impurities contained therein. Such application is also incorporated hereinto this EFSMP.

Other types of feed stocks used, and EFSMPs for processing, and products created, used, either in combination, or individually, by the EFSMP are such as:

### Used Lubricants Refuse Oil Crankcase Oils Mixed Waste

### Streams

### Two Stroke Engine

### Oils

### Gas Engine Oils

### Preservative Cum

### Running-in Oils

### Gear Oils

### Automatic

### Transmission Fluids

### Shock Absorber Oils

### Calibration Fluids

### Automotive Greases

### Rail Road Oils

Turbine Oils Circulating and Hydraulic Oils (RandO type)

### Circulating and Hydraulic Oils (Anti-wear Type)

### Spindle Oils Machinery Oils Textile Oils

### (Scourable Type)

### Morgan Bearing Oils

### Compressor Oils

### Stationary Diesel

### Industrial Grease

### OIL Fields (Offshore, Inshore, Near Shore, On Shore, Inland) Pipe Lines (Export)

### Marine Oils

### Transformer Oil

### Coal

### Engine Oils

### Vacuum Pump Oils

### Machine Tool Way Oils

### Pneumatic Tool Oils

### Steam Cylinder Oils

### Sugar Mill Roll Bearing Oils

### General Purpose

### Machine Oils Flushing Oils Soluble Cutting Oils

### Neat Cutting Oils

### Aluminum Rolling Oils

### Steel Rolling Oils Quenching Oils Heat Transfer Fluids

### Rust Preventatives

### Rubber Process Oils

Agricultural spray Oils

### Carbon Black Acid Clay Spent Olgone Filter Media Sorbent's Diatomaceous

### Earth and or Sand

### Hazardous Waste

### Coal

### Refinery Gas

### Sand Oil

### Pre-salt Oil

### Ultra Deep Pre Salt Oil

### Synthetic

### Petroleum Oil

### Athabasca Oil

### Sands

### Canadian Oil Sands

### Oil Sands Bitumen Sulphur

Production, Sulfuric Acid Production, and Water Filtration as related to removal of Sulfur, etc. from effluent streams
Pipelines, Import Pipelines, Feed lines, transport, interior, network)

### Coal

### Coal Slag Coal Char Blue Powder Shale Oil

### Tar Sands

### Kerogen

### Natural Gas LNG Liquid Petroleum

### Gas (LPG)

### Heavy Oil

### Heavy Crude oil

### Acidic Oil

### Acidic Crude Oil Orinoco Heavy Oil Fuel Cell

### Lithium Battery Hydrogen Helium

Steam Hydrogen reclamation

### Oxygen

### Nitrogen

### Energy

### Independent

### Clay Regeneration

U.S. Pat. No. 4,469,805

### Ceramics, Composite Ceram

In addition to the previous feed stocks, mentioned herein, the invention detailed herein also includes such effluent streams, (Cells 5 and 12) but are not limited to feeds such as are also known as Mixed Waste, where such feeds are a direct result of processing oil, coal, in which the technologies utilized produce additional feed stocks, and effluent streams from such industries, but are not limited to those of pyrometallurgy, effluent streams, waste water stream (Cell 14), pyro hydro metal stream, filter cakes (liquid, dust, solid), metal extrapolation, feed streams, mercury extractions, lead extractions, oil extractions, and the like. The EFSMP in the invention embodiment meets and beats the targeted reduction goals, and best demonstrated available technology that is currently, but not limited to that of the United States EPA, the United States DOE, and other governmental (United States and non United States) Mixed Waste Integrated Program, the Mixed Low-Level Waste Program, such as those used with 3M-IBC Membranes, those of the Boliden-Norzinc Process.

Additionally, the invention embodiment herein also presents an EFSMP (Cell 6) of gases produced are also known as Fugitive Emissions and the like, and are further defined as to include, but without limitation, gases from coal, oil refining, Recycling Air Streams, as well as those that also result from liquid, metal, and gas, SMP technologies, and the like.

In other forms of the embodiment detailed in this EFSMP is that in the event that Crude Oil and the like become uneconomical, such EFSMP can also be used for commercial and private power generation by using such sources of feedstock as is internally produced, that would have been sold on the open market. Such feedstock could include, but is not limited to, in any permeation, combination, individual, single, and jointly, or compounded, products as Coal, bituminous Coal (Cell 24), Graphite, Shale, Oil Sands, Hydrogen, Methane, Ethane, Tulane, Gasses, Mixed Gasses, Heat Recapture for turbines, with placements based upon Pinching Analysis, and the like, exothermic reactions generated from Fuel Cells, sulfuric acid reconstitution, and other processes, and the like, as well as other products described and utilized in the present invention.

In addition, other types of furnaces and/or reactors include: Hearths, Blast Furnaces, Kilns, Smelting Furnaces, Carbon Fiber Furnaces, Pusher Tunnel Kilns for the electronics and advanced ceramics industries, Complete turnkey Carbon Fiber Lines, specialized furnace systems for solar Cell production and silicon melt furnaces, rotary kilns for the processing of refractory metals, and the calcining of specialty materials, Continuous Kilns, Roller Hearth Kilns, Mesh Belt Kilns, Car Tunnel Kilns, Walking Beam Kilns, Carpet Hearth Kilns, Harper Hearth Kilns and vertical gravity flow reactors, as well as a scope of supply for complete carbon fiber plants including: oxidation ovens, LT furnace system, HT furnace system, UHT furnace system if required, surface treatment, drying, incinerators, with optional tensioning stands and winders, and also different type, permeations, combinations, hybrids, parallel units, and like, that perform in a likewise manner. Moreover, many other furnaces and/or reactors that are made by foreign countries can also be implemented as the Reactors in the present embodiments.

It is noted that the foregoing examples of matrices and vertically integrated technologies, and SMP's have been provided merely for the purpose of illustration and explanation and are in no way to be construed as limiting of the present invention. While the present invention has been described with reference to an exemplary embodiments, it is understood that the words that have been used herein are words of description and illustration, rather than words of limitation. Changes may be made, within the purview of the appended claims, as presently stated and as amended, without departing from the scope and spirit of the present invention in its aspects. Although the present invention has been described with reference to particular means, materials and embodiments, the present invention is not intended to be limited to the particulars disclosed; rather, the present invention extends to all functionally equivalent structures, methods and uses, such as are within the scope of the appended claims. It is noted that all references, patents and citations which are cited in this document are expressly incorporated herein in their entirety by reference.

Water of the highest purity can be produced using ion-exchange processes or combinations of membrane and ion-exchange methods described herein. Cations are replaced with hydrogen ions using cation-exchange resins; anions are replaced with hydroxyls using anion-exchange resins. The hydrogen ions and hydroxyls recombine producing water molecules. Thus, no ions remain in the produced water. The purification process is usually performed in several steps with “mixed bed ion-exchange columns” at the end of the technological chain. An embodiment of this EFSMP creates Carbon Fiber, and or nanotubes, from Carbon generated as a product of the SMP's herein, and include such examples of Carbon fiber is mainly made from a polymer called polyacrylonitrile (PAN) by drawing/spinning a filament, passing through a specific oxidation heat treating, carbonizing heat treating and surface treatment process, with the spinning techniques, non-mechanical water treatment, and the like, used in industry, but not limited to, are those such as wet spinning, sedimentation, centrifugation, evaporation technologies, dry spinning, air gap spinning and melt spinning. The various heating process steps include oxidation, pre-carburizing and carbonizing. The main surface treatment processes include electrolyte, washing and sizing, and the like. The other sources of the carbon fiber to produce from are petroleum or coal based pitch (pitch precursor) and rayon (cellulosic precursor), all of which are products created, or are byproducts of processing, within the EFSMP, and have been described herein. In addition to the previous description, the EFSMP employs design and technology in advanced heating element design and insulation packages, which have greatly reduced energy consumption—like those of making Harpers International, carbon fiber LT, HT, and UHT furnace systems, as well as utilizing, but not limited to atmosphere purge chambers, where such chambers, individually, or in tandem, parallel, hybrid, and the like, improve product quality and extend the useful life of the insulation, and such can also effectively strip incoming material of entrained particulate. The water purification system is described in “Sour Water Plant Module” by Allen Kaplan and Randall Bradley, Docket No. V1291537, incorporated herein in its entirety by reference.

A pre-pyrolysis reactor comprises a continuous system and method in which a slurry (fuel applies to the same system utilized in the power generation plant) composition including: crushed coal, micronized tires (coal to tire/battery mix weight ratio, 1:1; micronized battery cases, 1:2; carbon black optionally, 1:3; under atmospheric pressure in a hydrogen, propane or mix environment, 1:4) and a residuum blanket oil for prevention of spontaneous combustion and for deasphalting and further pyrolysis processing into oil and/or syngas. The syngas is then sent to the syngas line, for use as internal fuel source, and/or processing into a finished fuel gas. The pre-treated slurry is passed through several reactor heat Cells as it passes from the feed entry port with a temperature of 100 to 270 degrees Celsius for moisture extraction and then to a vaporizing temperature of 270 to 350 degrees Celsius. Heat is provided by infrared, microwave or convection means. The slurry/vapors are filtered by vacuum extraction and capture of carbon soot and ash forming compounds such as quartz, mullite, pyrite, carbonate, phosphates, actinides, sulfur, moisture and metals in a Chalcogel or X-Aerogel filtration system. The slurry and vapors are continuously mixed and pushed toward the reactor exit port by an Archimedes screw running lengthwise through the center of the reactor with the assist of ultrasonic cavitation aiding desulfurization at 20,000 cps. Coal fines can be utilized in the pyrolysis process with this pre-treatment system. The purified slurry vapors are then vacuum pump extracted and can be forwarded into a pyrolysis chamber.

### Core Reactor and System

This embodiment of the present invention utilizes a core reactor which comprises a multistage single, dual, multi-directional or reversible flow system including at least: 1) a power generation stage; 2) a power amplification stage or stages; 3) apparatus feed and/or an internal processing system; and an optional flow recycle and/or propulsion stage. The core reactor can include the following interconnected components: 1) primary kinetic energy device(s); exhaust nozzles; 2) single or multilevel swirl chambers; 3) single or multiple conical vortex cones; and 4) modified vortex tubes(s) for cryogenic, sonic or extreme thermal heart generation streams. The first stage power generation can be, for example, primary kinetic power generation or primary thermal heat generation.

The present core reactor is capable of generating/storing electricity, electrical power and/or energy beams including, inter alia: 1) exothermic and endothermic heat; cryogenic cold; 3) sonic resonance; 4) luminosity; 5) thrust; 6) vacuum; and 7) electromagnetism. Included within the ambit of power amplification are, for example: 1) exhaust nozzle flow amplification; 2) centrifuge power amplification and first stage gas separation; 3) quantum MAGLEV levitated inner swirl chamber flow amplification; and induced flow merging convergent low conical vortex cone(s) including inner flow cone flow compression and outer vortex cone flow entrainment and amplification.

The apparatus feed and/or internal processing system may include, for example: 1) vortex tube system self-generating (internal systems) including an extreme thermal heat processing stream, an extreme magnetic, electromagnet or superconductive flux field or an extreme cryogenic cold processing system; and 2) central chambered pulse detonation tube(s) including; a) feed processing distribution cap to detonation tube; b) detonation compression; c) advanced separation nozzle system; and d) separated feed collection and removal. For the final propulsion phase, quadrapole detonation, compression and or/combined Penning Trap.

Optional flow recycle and/or propulsion can encompass, for example: 1) secondary processing (optional) including flow recuperation purification and system recycle and focused energy beam release; and 2) propulsion and system recuperator recycle (optional) including, e.g.: divergent propulsion nozzle thrust release and flow recuperator purification and system recycle.

The present core reactor can comprise, for example, the following elements: 1) primary kinetic energy device(s) including, inter alia, an inventive MAGLEV quantum trapping turbine and current art engine adaptable, quadrapole electric field, Penning Trap for subatomic particles; 2) exhaust nozzle(s) with thrust booster; 3) swirl chamber(s) which can be single or multi-level; 4) single or multiple conical vortex cones, such as, for example: a) flow compression (multiplier ring); b) flow expansion option; c) secondary layered option; or d) multiple layered option; and 5) modified vortex tube(s) for cryogenic and extreme heat generation streams including, for example: a) detonation compression tube adaptable including colloid subsystem thruster assist, dual polarity and pulsed measured detonation compression; b) gaseous diffusion chamber(s) option; c) asymmetrical separation chambers single line feed; d) advanced double deflection separation nozzle system; e) porous barrier separation and filter grid)(s); 6) hole size tailored to process feed(s); barrier feed separation classifying, and filtering of materials optionally include metal-based, substrated and/or templated: Chalcogenide, Chalcogels, organic, non-organic, crossed-linked, carbon, silica and metal-doped Aerogels colloids, foam metal, foam glass, Xerogel, metamaterials, microporous membranes and other porous, foam, composite, ceramic or advanced materials.

The present invention is further described in the detailed description which follows, in reference to the drawings by way of non-limiting examples of embodiments of the present invention, in which like reference numerals represent similar parts throughout the several views of the drawings. The particulars shown herein are provided by way of example and for purposes of illustrative discussion of the embodiments of the present invention only, and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making it apparent to those skilled in the relevant art how the several forms of the present invention may be embodied and used in practice.

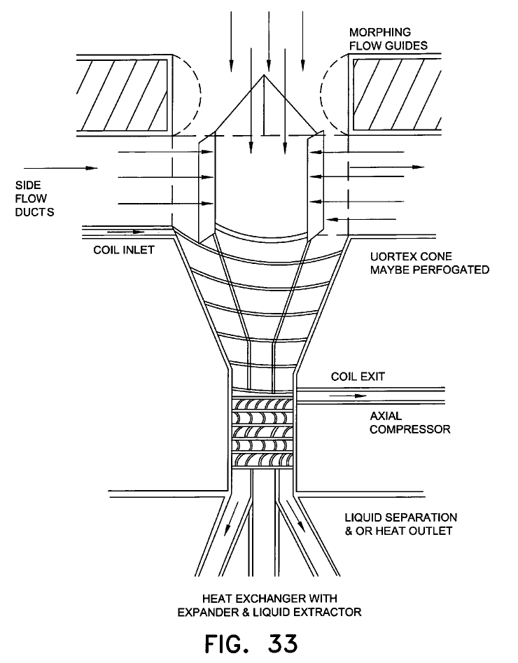

FIG. 33 shows a cross-sectional view of the present invention core reactor. The core reactor 10 has an outer wall 17 and a top and/or alternatively bottom apparatus ram air inlet as the system may be reversible 15. Provided are horizontal inlet ports 11 (which can be single or multiple). Within the core reactor 10 is a swirl chamber 18 and an inner compression vortex 16. Flow vanes 14 are provided within the reactor 10 as well as a Maglev axial compressor 13 and an outer vortex flow channel 12.

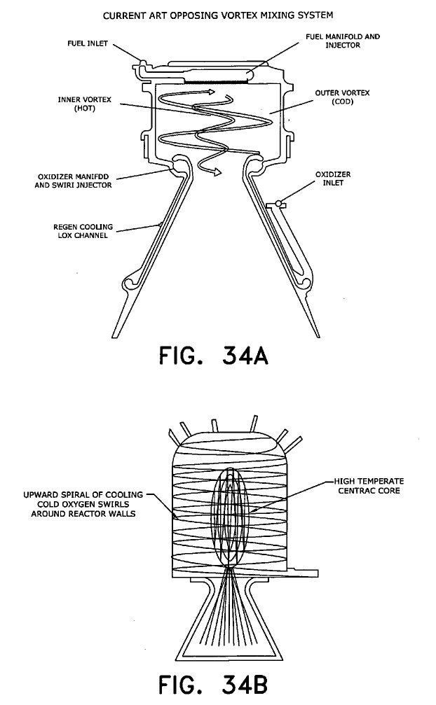

FIG. 34a. is a cross-section of the present core reactor 20 in the form of a cross-section of a vortex gun barrel as, for example, a propulsion unit. The unit has an outer wall 28 and fuel inlet 21 and oxidizer inlet 27. Seen within the unit are inner vortex 22 and outer vortex 26. A Regen cooling LOX channel 24 is provided with the unit wall 28 and also provided is an oxidizer manifold and swirl injector 23 and a fluid manifold and injector 25.

FIG. 34b. illustrates another view of the vortex reactor.

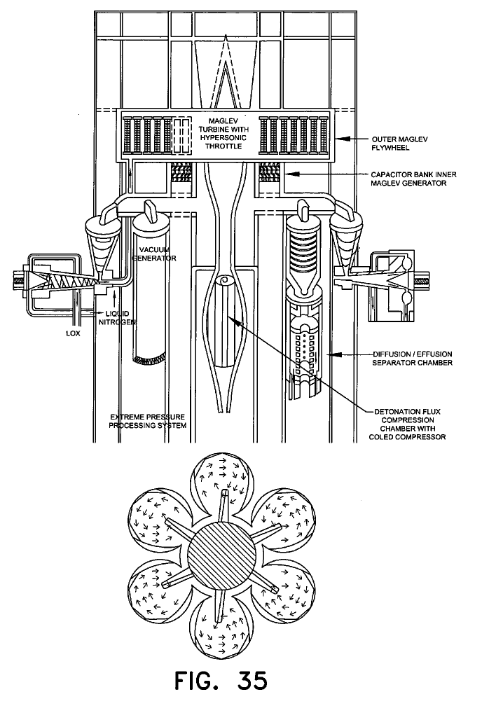

FIG. 35 is best described as a Vortex Accelerator. While it is possible to combine a powder vortex ram accelerator with the vortex gun, the device is best called a vortex accelerator. For the purposes of the application, the following description is for a gun. It is mainly a form of accelerator technology for flows. This example, and its simplicity make it the cheapest member of the vortex gun family of the present invention.

The dual vortex flow within an enclosed combustion chamber prevents the reactor walls from melting when deep thermal temperatures are reached in the combustion process. The outer vortex is typically a cryogenically cooled carrier gas and or fuel oxidant which allows for the slower mixing of fuel and prevention of a pre-detonation prior to such mixing being completed.

Additionally detonation flow accelerants can be injected and detonated anywhere along the core invention's system's vortex flow paths and as well as the other invention's variations in order to reach previously unattainable flow speeds, pressures, thrust levels, extreme thermal temperatures by the entrained voracically levels of compressed and amplified kinetic energy beams.

When the ignition and combustion is used primarily for propulsion you can induce the outer vortex with a pre-measured detonation that allows for the reactor wall protection during the primary fuel combustion. Use of the word “Pyrotechnics” in the present application is related to the packing techniques as it covers the gamut of technologies.

The mention of wings and the nose cone are related to the spiral vortex gun's internal sabot which includes 1.) a single, dual or multiple opposing shafts connected by a crossbar with each shaft having a blunt tip and or a nose cone, 2.) attached to each shaft are various rows of winglike flow guides which generate the helical gas flows and shock waves while maintaining a smooth laminar flow and reduce friction and turbulence, 3.) helical injection fins or ribbons which form pulsed counter flowing vortexes spiral barrel to create a rifling effect around each of the sabot wings and prevent premature ignition.

When detonation is used for internal processing, a pumped flux compression type generator may be used for extreme applications or by alternatively pyrotechnically packing the driving explosives in a manner to achieve the desired effects. The core reactor apparatus accommodates a basic system which can be a single or progressively amplifying system of mild to the next generation of compression, thrust, shock wave, shearing, and thermal heat generation.

The core reactor and system invention may, for example, utilize an initial single detonation or a series of detonations with a driving explosive, a transiting explosive, and/or explosive lens with each charge containing a progressive detonator tip. The progressive amplifying system is contained, but may alternatively work in a progressive “ring and finger” series which as the hollow ring detonates it encircles the reciprocating “finger” located downstream of the detonation. This type of progressive detonation allows for an optimized flow into the processing target and allows for the creation of a uniform horizontal directional, super compression thermal shock wave for extreme processing effect or horizontal propulsive thrust.

The vortex gun accelerator system may utilize a modifiable sabot assembly that includes such components as a deforamable compression piston or tetryl pellet, a compression projectile with an embedded flat metal plate face, a high density anvil, a pedal burst valve and smooth bore rifled barrel which leads to the processing chamber. The processing chamber may comprise a target anvil, die, other forming or shaping device and/or compression apparatus or, in propulsion, a divergent designed thrust nozzle, aerospike or Hall Thruster type or non-truncated toroidal aerospike of egress technology that accommodates the fuel being utilized. When utilizing the quadrapole or other multi-compression apparatus this system may be replicated for multiple chamber entry to reach higher velocities, pressures, thermal temperatures and optimize thrust at warp speed levels.

In this non-limiting example, a mixture of hydrogen and a fine powder of ammonium nitrate can be pumped through the accelerator. Helical ribbons produce vortex flow of the mixture and prevent premature detonation. The vortex generates a centrifugal force which keeps most of the powder away from the center of the accelerator. A thin, hot boundary layer forms on the nose cone of the projectile and its wings. Powder in the center of the tube burns in the boundary layer before impinging on the nose cone. The density of the mixture is lower in the center of the tube, so the aerodynamic forces may be strong enough to keep the projectile away from the walls of the tube. To prevent fast rotation of the projectile, the vortex alternates between clockwise and counterclockwise direction. The projectile compresses the mixture to the point of ignition and is propelled by vortex flow of the burning mixture. Several rows of flexible wings are attached to the projectile. They are feathered unless gas pressure deflects them.

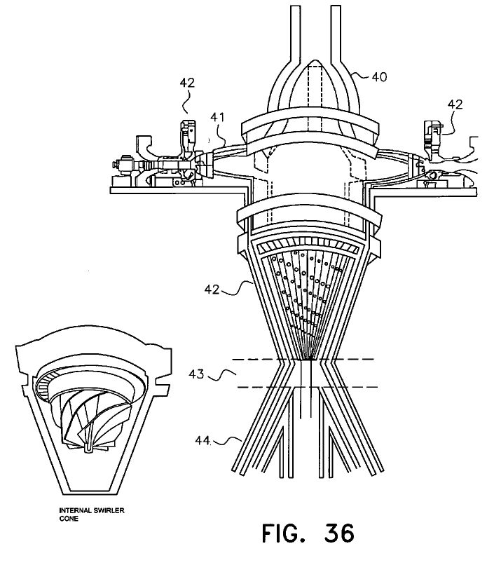

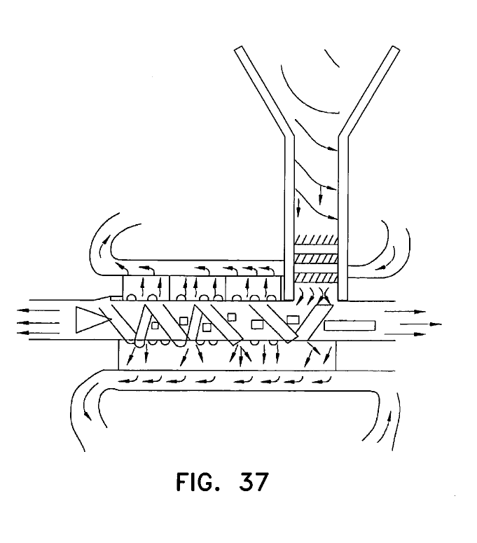

FIGS. 36 and 37 show an embodiment of the present core reactor. FIG. 36 shows a cross-sectional view while FIG. 37 shows a cross-sectional view of the present core reactor portion by which the present core rector may inter-connect to a reactor or functional unit so a to provide power or other functionality to the reactor or functional unit to which the present core reactor is interconnected. FIG. 36 shows the various sections of the present core reactor 40 including the first stage power generation section 41 which can comprise primary kinetic energy generation, primary thermal heat generation, etc. Shown in the figure is an exemplary power input 42 as a gas turbine generator. The second stage 43 is for power amplification such as for example: exhaust nozzle flow amplification; Centrifuge power amplification and first stage gas separation; Quantum levitated inner swirl chamber flow amplifier; Merging convergent flow conical vortex cone(s) including inner vortex cone flow compression with vortex cone flow entrainment and amplification. Third stage 43 comprises apparatus feed and or internal processing system including vortex tube system self-generating (internal systems) including, e.g., extreme thermal heat processing stream and extreme cryogenic cold processing stream or central chambered pulsed detonation tube(s) and Feed processing distribution cap to detonation tube including for example detonation compression, gaseous diffusion separation, advanced separation nozzle system, or separated feed collection and removal. The fourth stage 44 comprises optional flow recycle and or propulsion including a primary and/or secondary processing (option). For example, flow recuperator purification of ram air and dark matter flow and the secondary system recycle or focused energy beam release and propulsion and system recuperator recycle (option) including Divergent propulsion nozzle thrust release or flow recuperator purification and system recycle.

FIG. 37 shows the outlet portion of the core reactor shown in FIG. 4 which is interconnected with a generic reactor or functional unit.

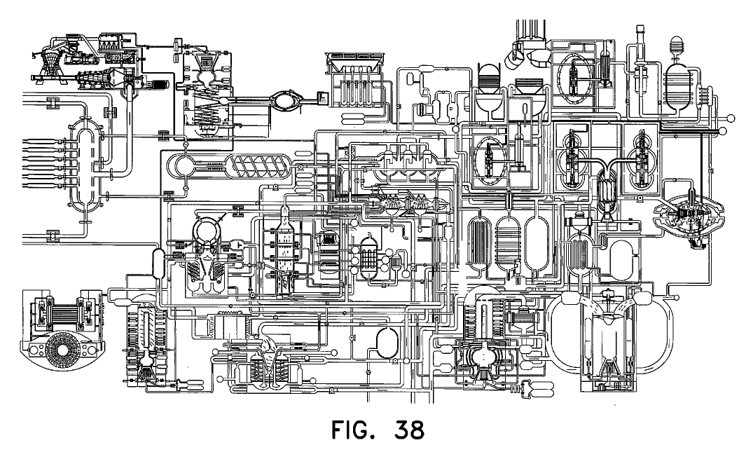

FIG. 38 shows a chart showing an embodiment of a matrix application in which the present core reactor can be employed. The Matrix application comprises a number of cells in which each cell can provide a particular function wherein the function takes place by the use of a reaction or function reactor. The present core reactor can be used to provide power or other needed actions to facilitate the reactors or functional unit of the cells. The cells and reactors of the cells are shown in FIG. 6 and the descriptions of the cells and functional units are described as follows:

### Invention Reactor System of FIG. 38

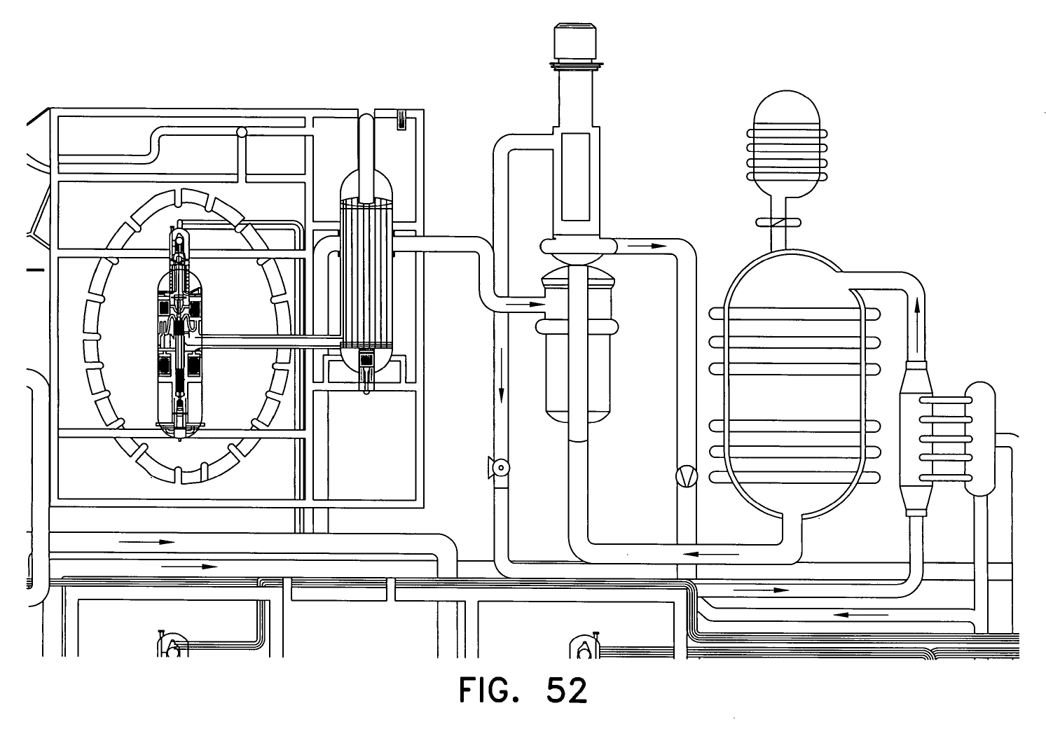

1. Pyrolyic Reduction System (pre-treatment reactor) (FIG. 52) comprising:

### A. Pretreatment Reactor,

B. Turbines with Power Generators,

### C. Molecular Reduction Reactor,

### D. Vortex Accelerator,

### E. Vortex Precipitator

F. Pyrolic Reduction Reactor with wipe film/short path evaporator Vortex Cone

### G. Vacuum Extraction Apparatus H. Extraction Scoop

### I. Flex Extraction Duct System

### J. Mobility Wheels or Treads

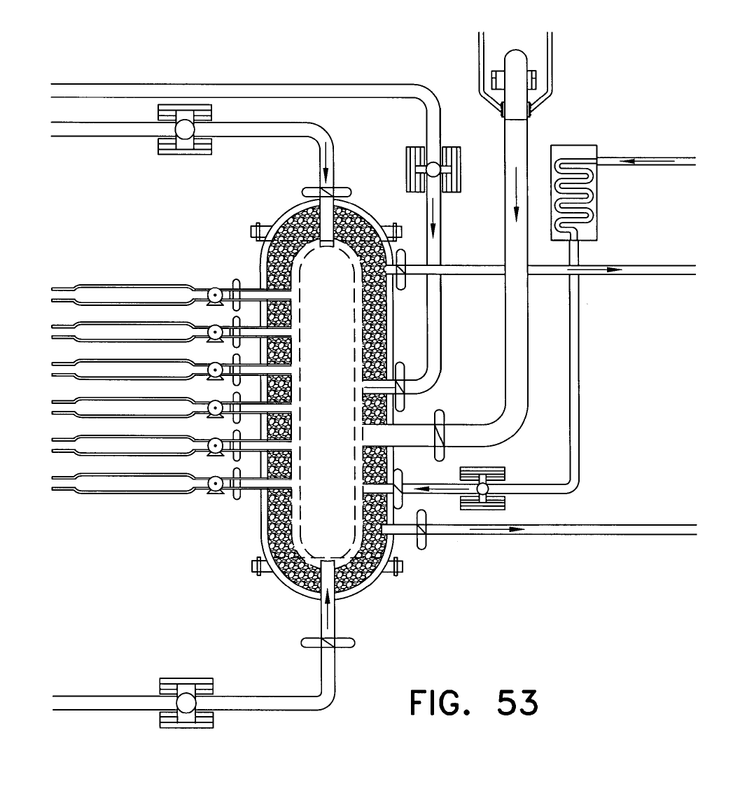

### 2. Slurry Treatment, Processing & Purification Reactor (FIG. 53)

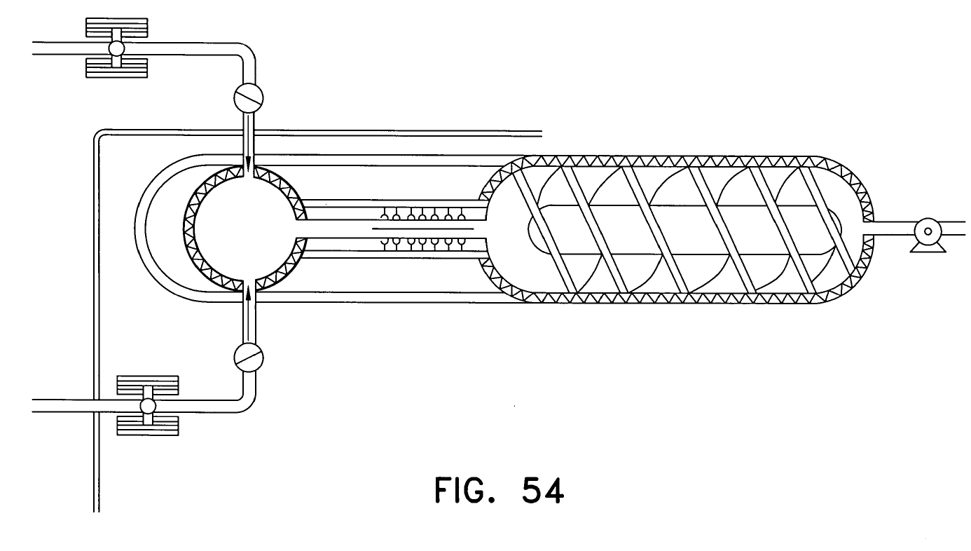

### 3. Multi-functional Pre-Treatment, Processing & Purification Reactor (FIG. 54)

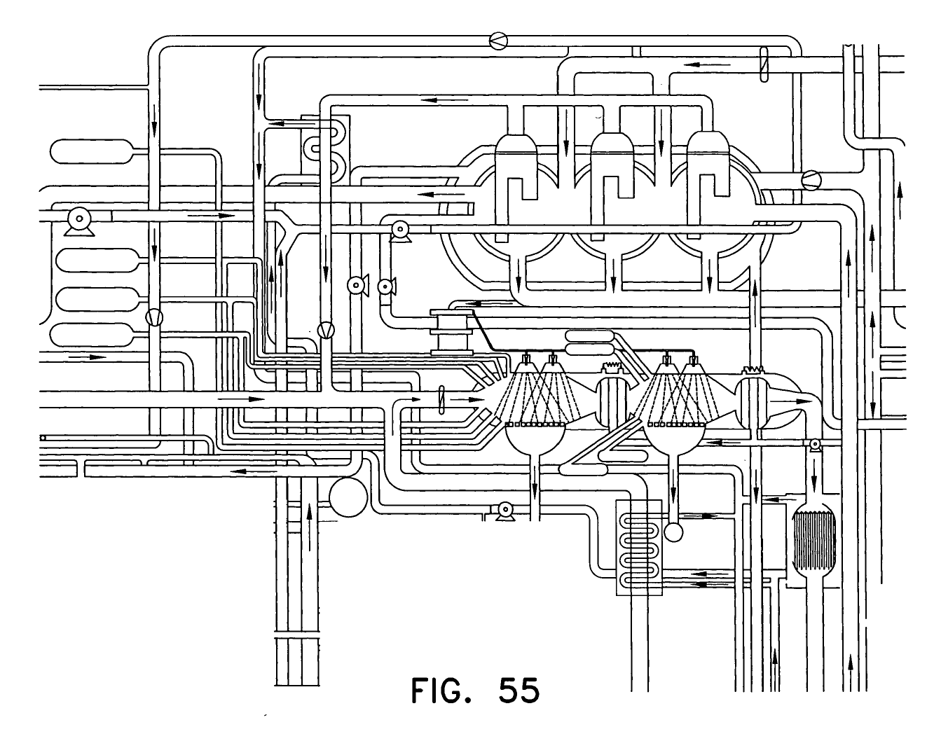

### 4. Pyrolyic Gasifier (FIG. 55)

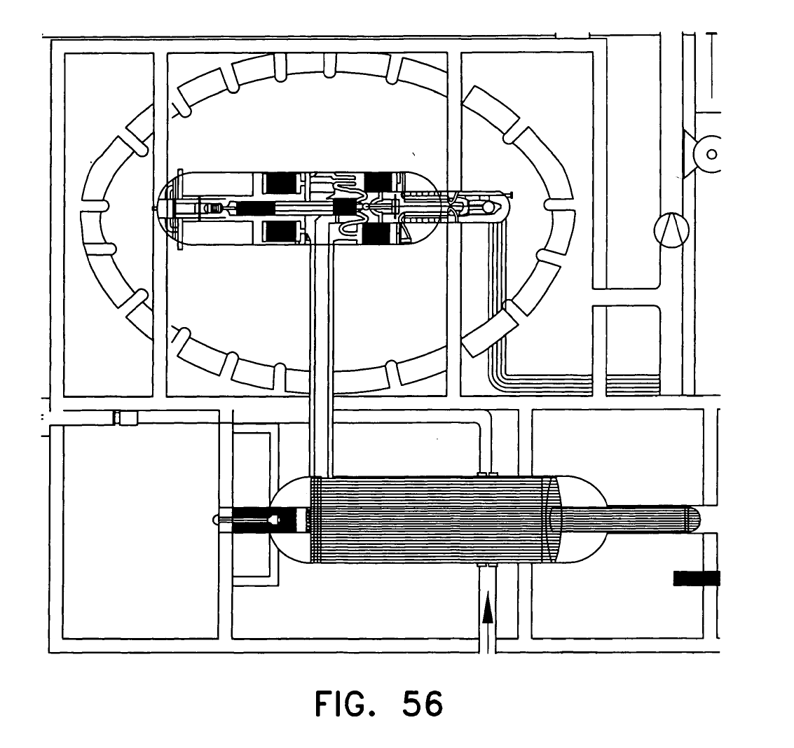

5. Distillation Reactor with Nautilus Packing System (FIG. 56)

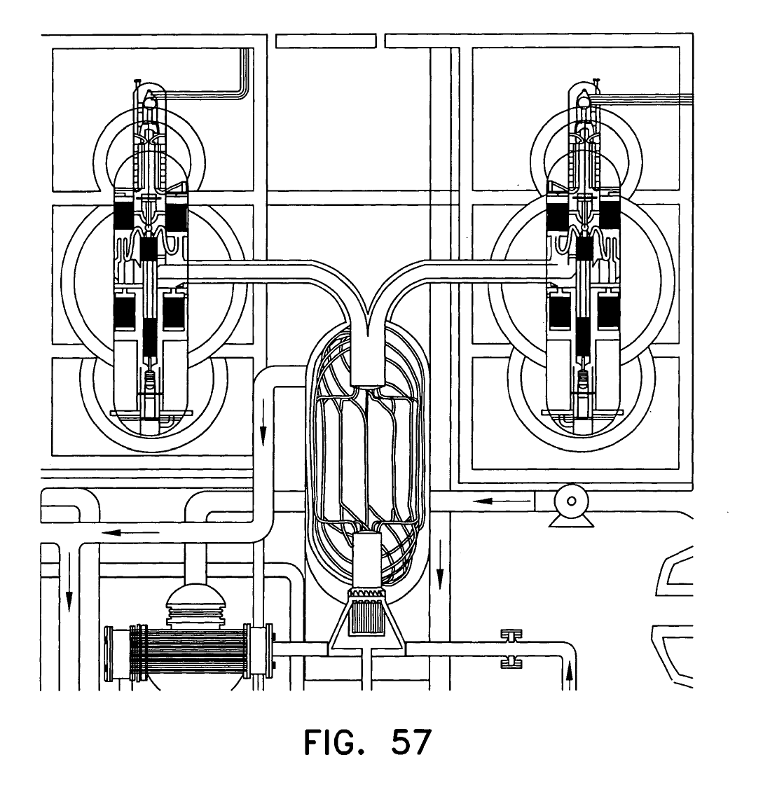

### 6. Side-Stream Advanced Hydrotreater (FIG. 57)

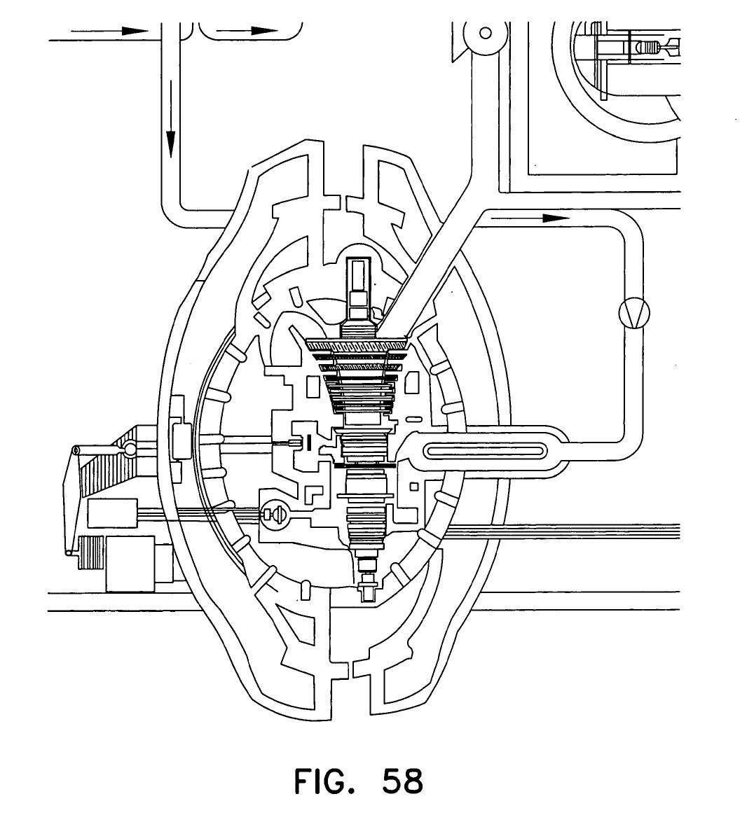

7. Hydrocracker with Secondary Purification Reactor (FIG. 58)

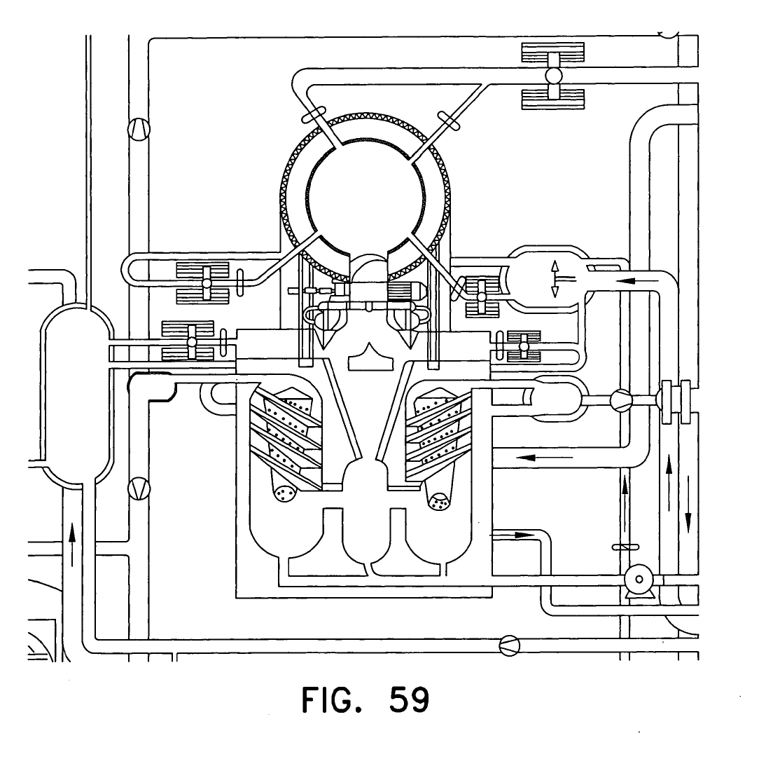

### 8. Advanced Hi/Low Temperature Fuel Processing Reactor (Advanced Fischer Tropsch Process) (FIG. 59)

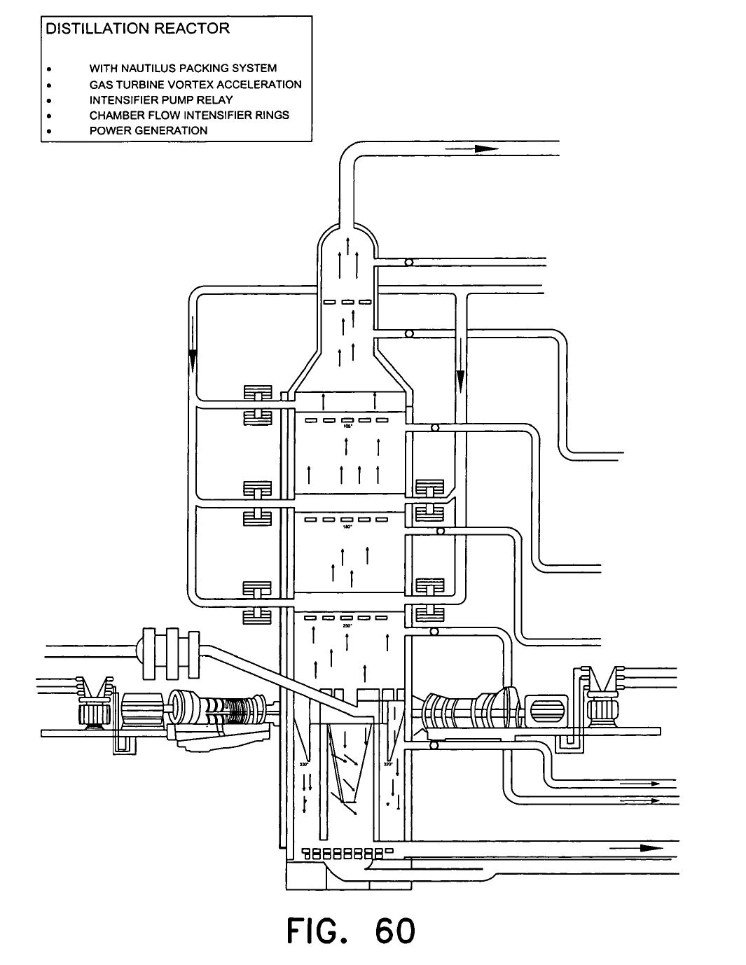

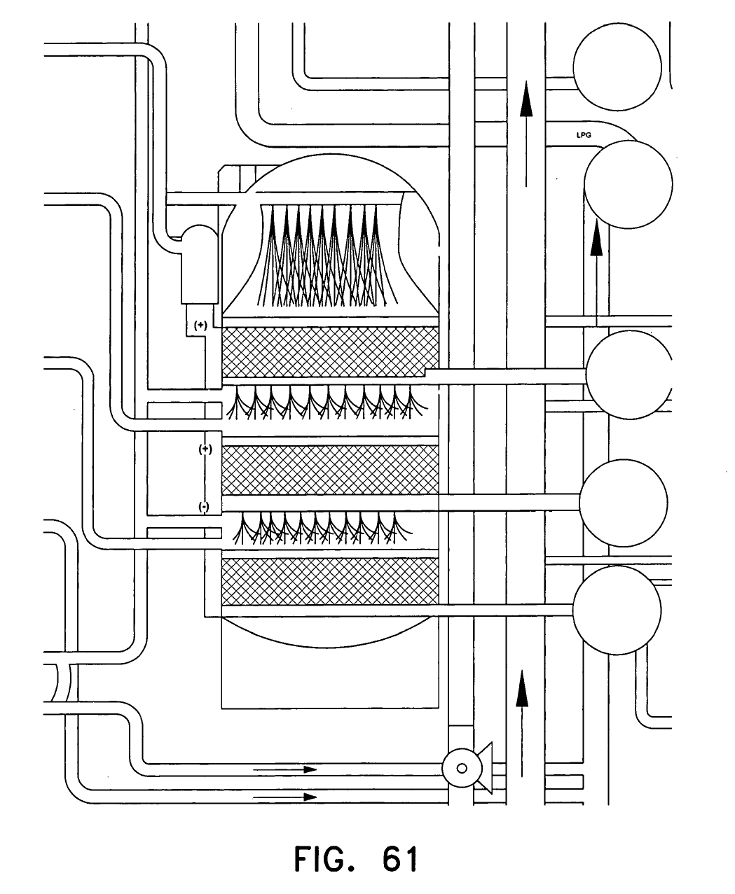

9. Advanced Metals & Carbon Processing Reactor with Degassers (FIG. 60)
10. Gas Purifier Reactor with Fuel Cell Power & Filtration Integration (FIG. 61)

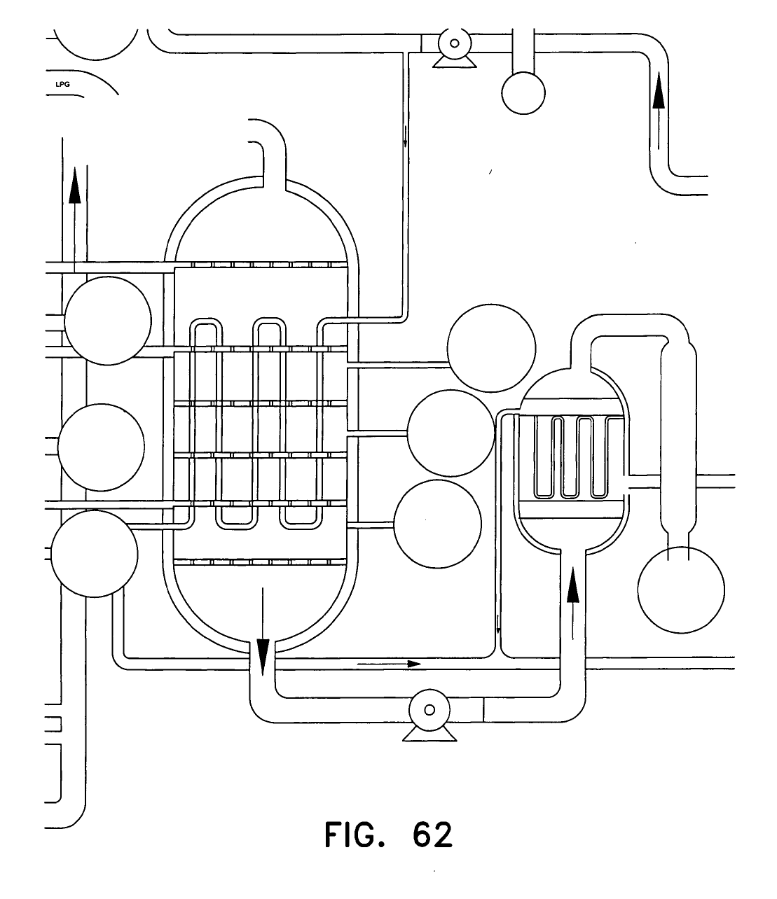

### 11. Atomizer Reactor (FIG. 62)

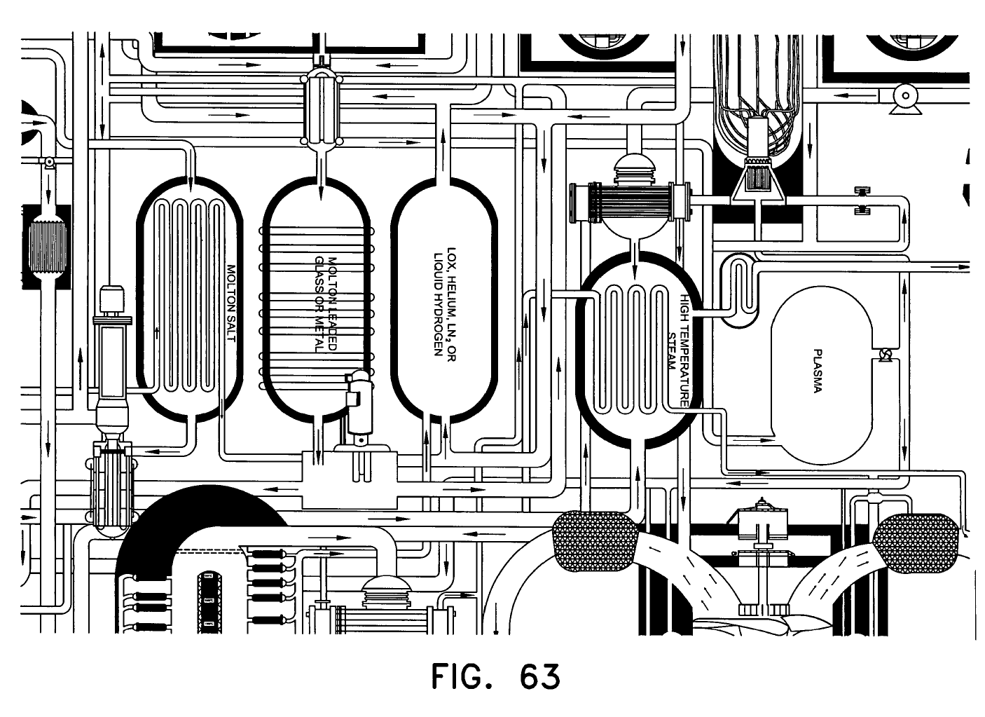

12. Nano Processing Reactor with Retractable and/or Gatling Gun Head & Growing Chambers (FIG. 63)

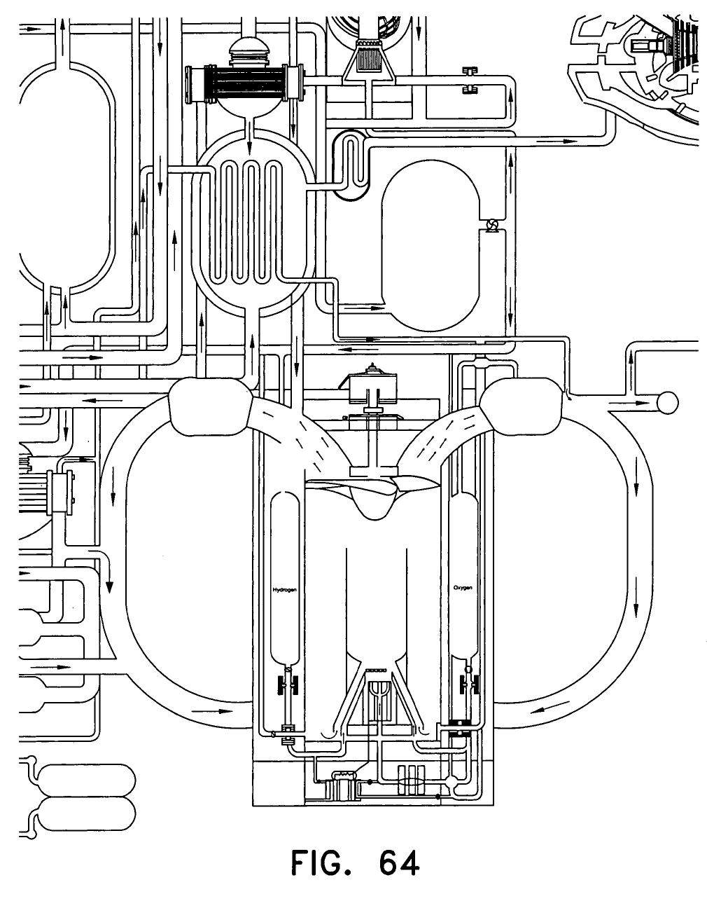

### 13. Zero Gravity Reactor (FIG. 64)

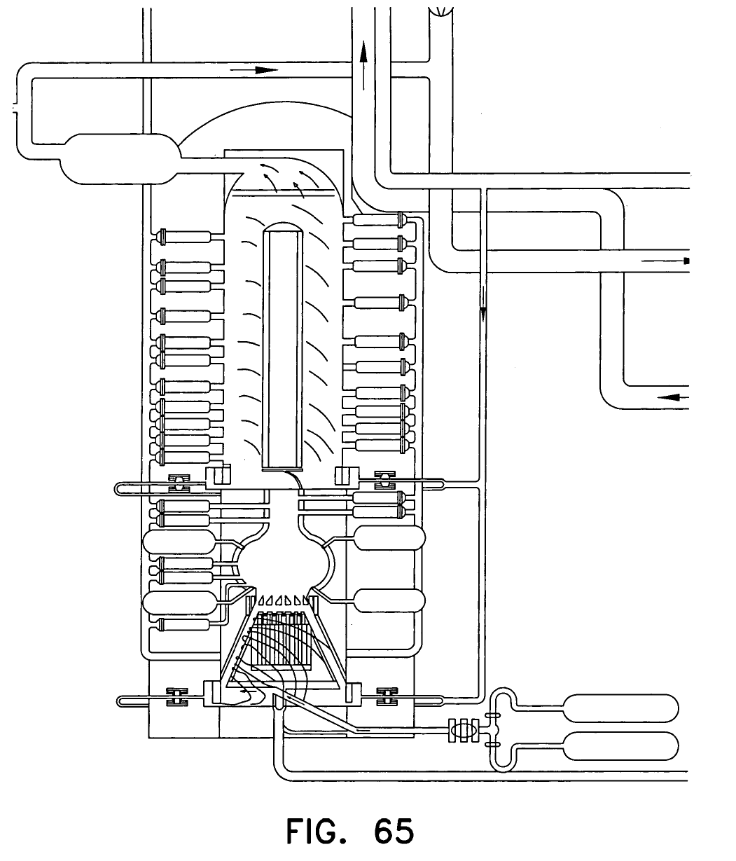

### 14. Waste Water Purification Reactor (FIG. 65)

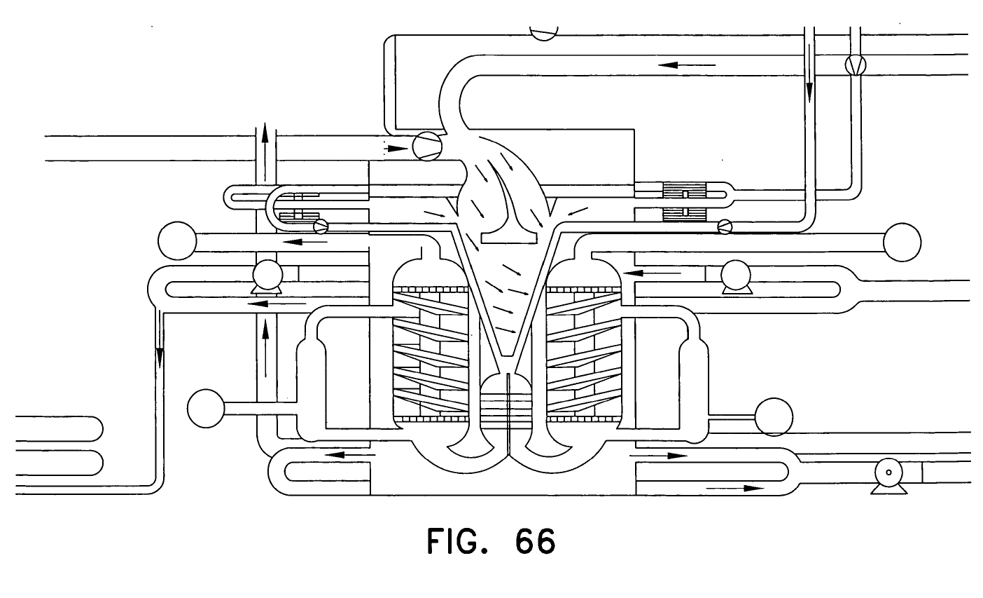

### 15. Hydroelectric & Water Manufacture System (FIG. 66)

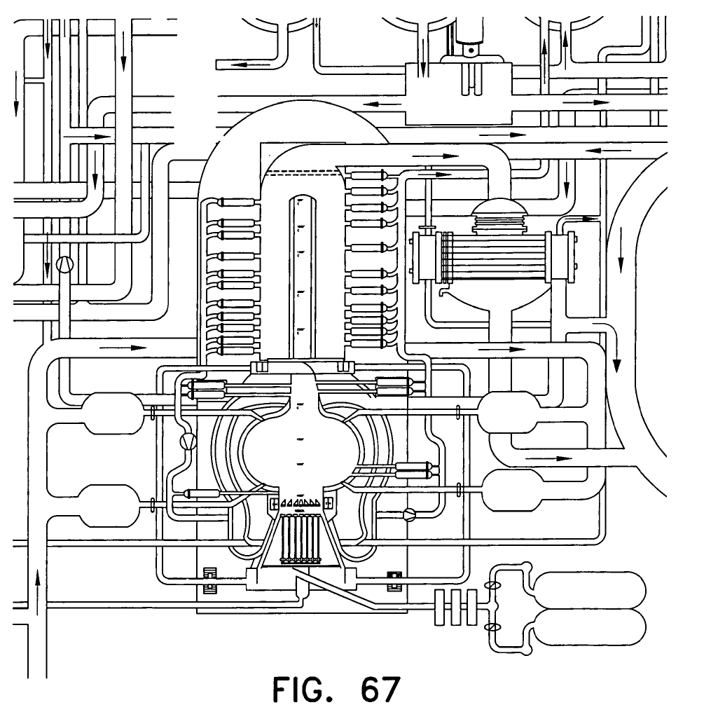

### 16. Molten Salt Distribution & Recycle Tank (FIG. 67)

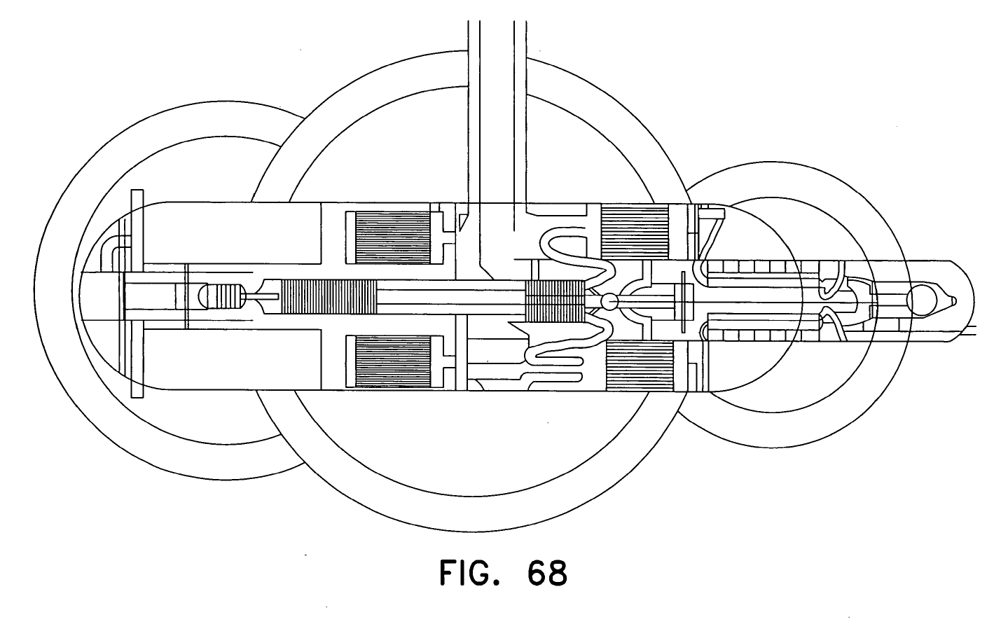

### 17. Molten Metal Distribution & Recycle Tank (FIG. 68)

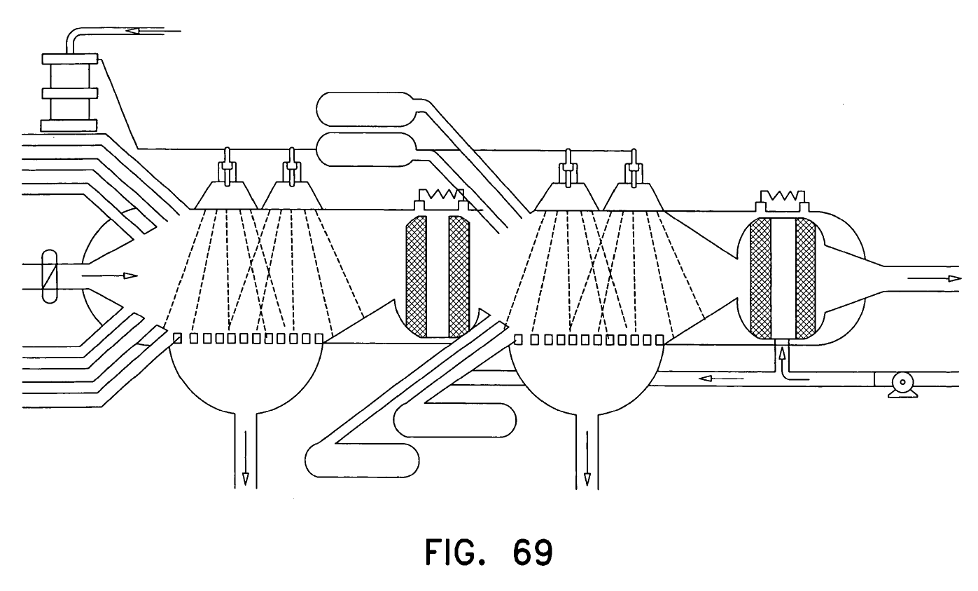

18. Helium Distribution & Recycle Tank (and/or Argon, carbon Dioxide, Hydrogen, Nitrogen, Air & Other Gas Alternatives) (FIG. 69)

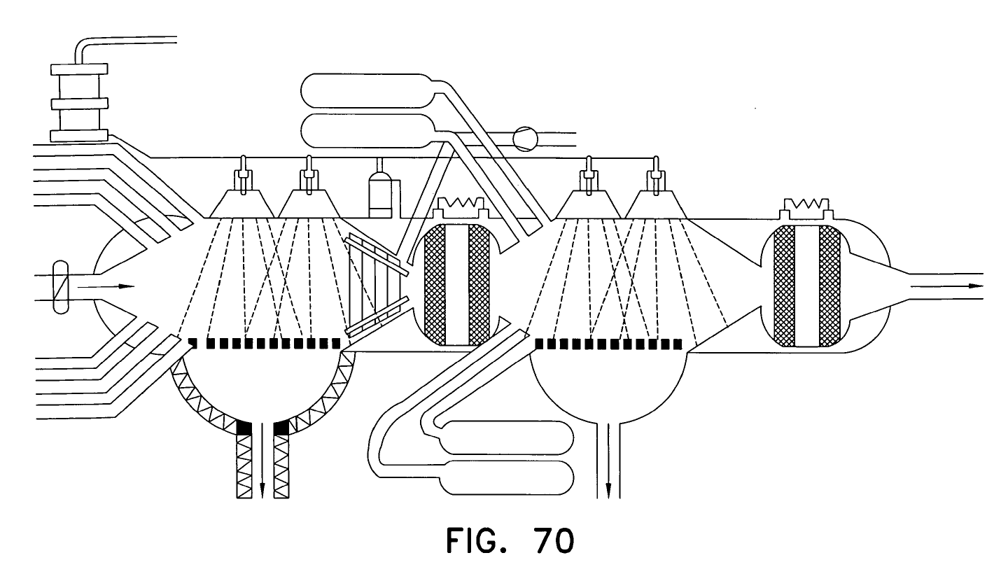

### 19. High Temperature Steam Distribution & Recycle Tank (FIG. 70)

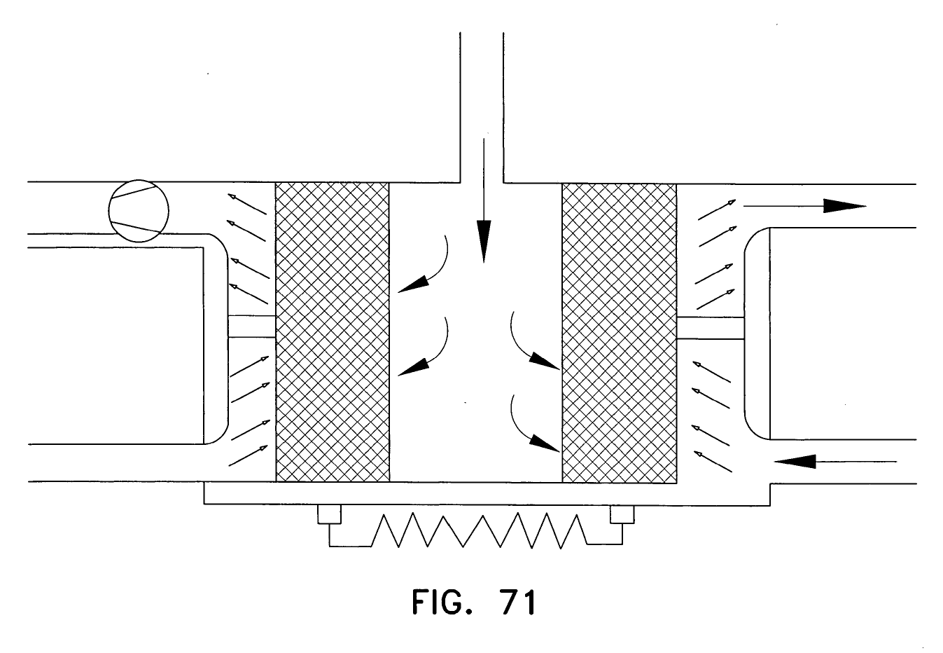

### 20. Plasma Distribution & Recycle Tank (FIG. 71)

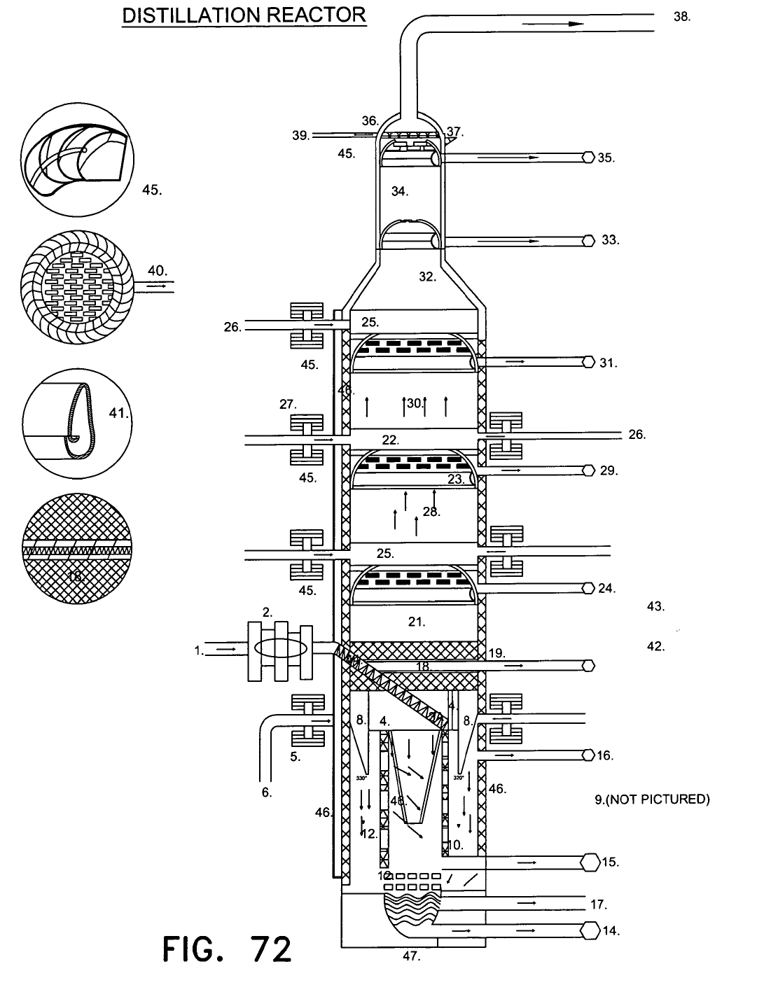

21. Molten leaded Glass Distribution & Recycle Tank (FIG. 72)

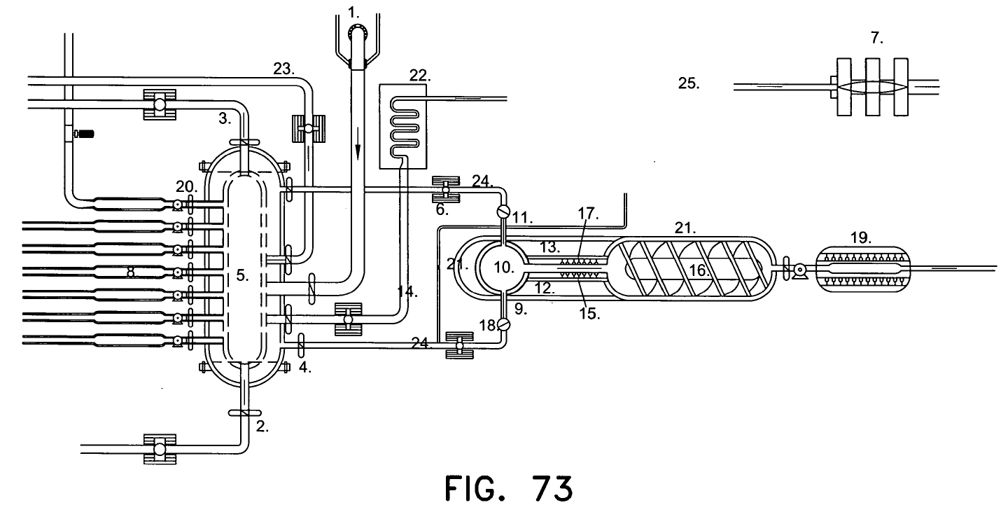

### 22. Oxygen Distribution & Recycle Tank (FIG. 73)

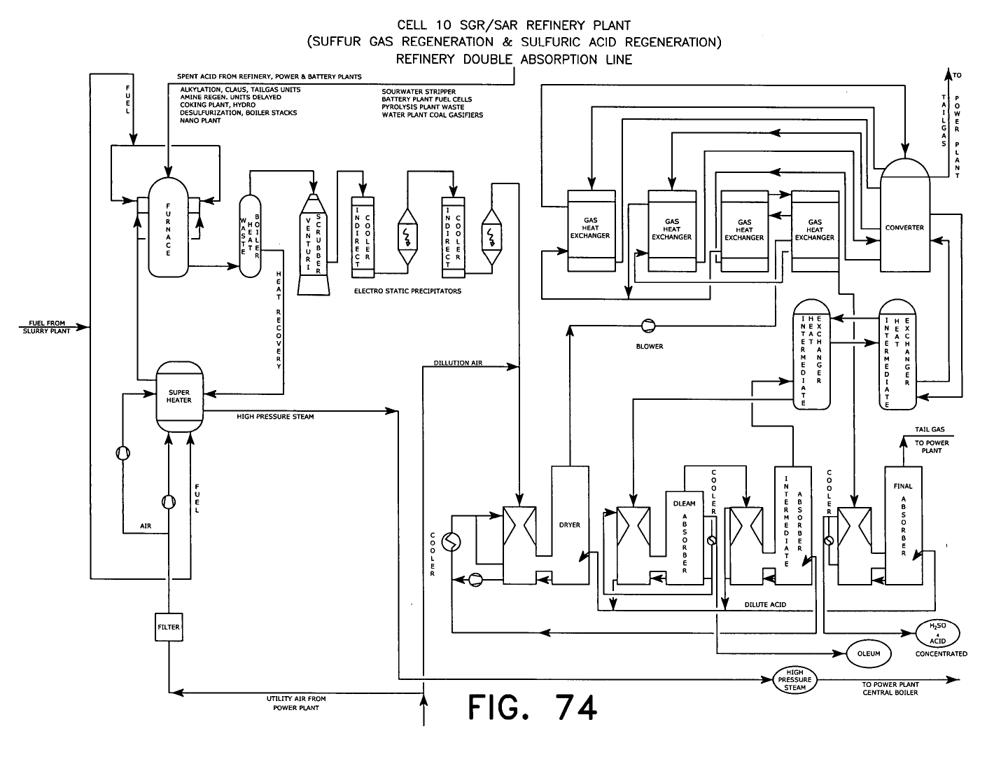

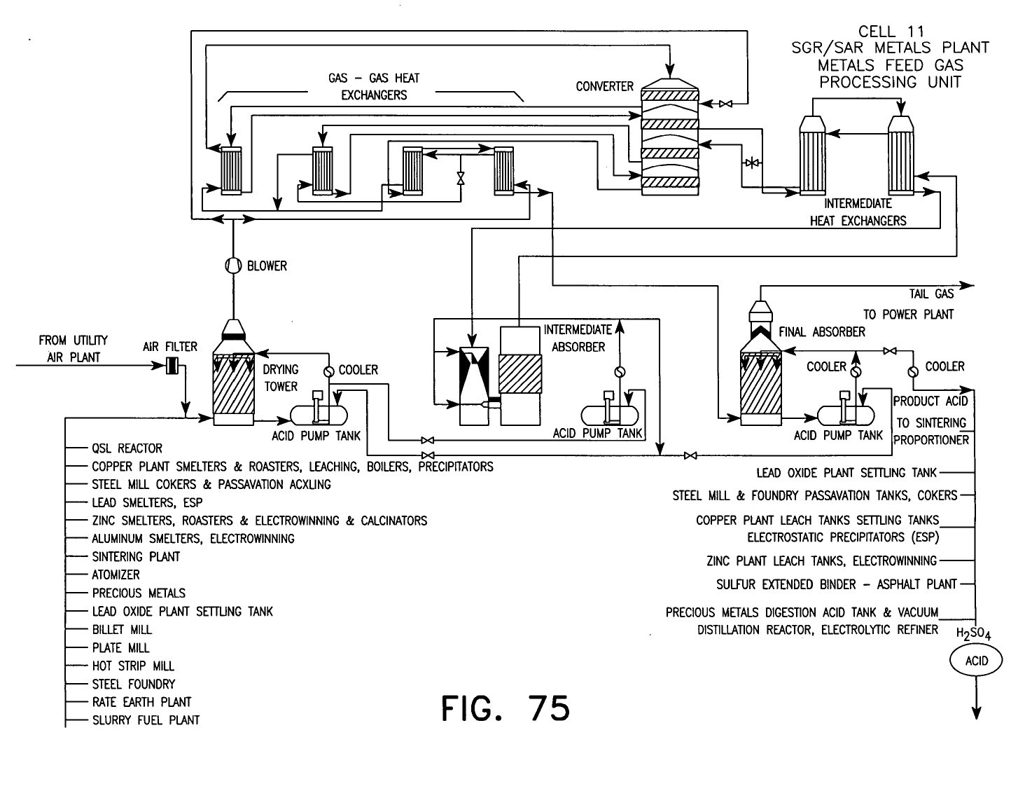

### 23. Helium Nuclear Reactor—Zero Gravity Chambered—Rankine, Brayton and Carnot (FIG. 74)

### 24. Plasma Arc Reactor—Zero Gravity Chambered—Rankine, Brayton and Carnot (FIG. 75)

### 25. Molten Leaded Glass Nuclear Reactor—Zero Gravity Chambered Rankine, Brayton and Carnot (FIG. 76)

### 26. Advanced Steam Turbine—Zero Gravity Chambered Advanced Rankine Cycle System (FIG. 77); and

### 27. Molten Salt Fuel Cell (FIG. 78).

Combinations of reactors can create or transfer metals on an isotropic, isotopic, atomic or elemental form; mercury, lead, silver into gold, for example; new elements like metal hydrogen, metal krypton, metal xenon, rare earth magnets of great density and power, exceptional combinations and new elemental rare earth composites.

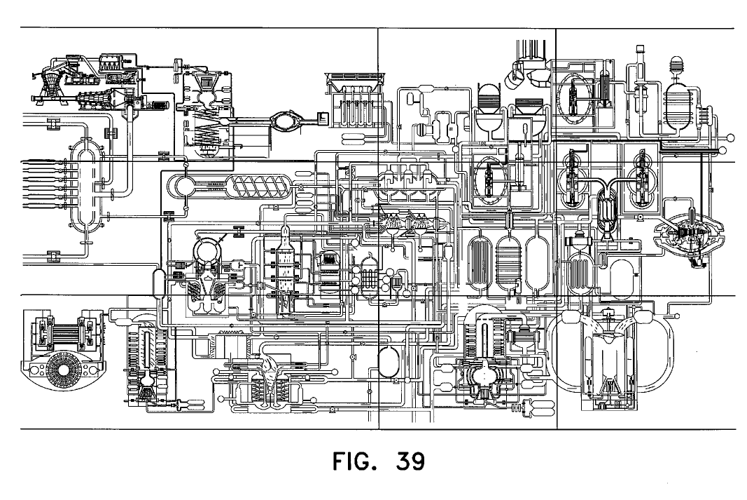

FIG. 39 shows the same embodiment as shown in FIG. 6 but in which the present core reactor K has been utilized as well as a mining system.

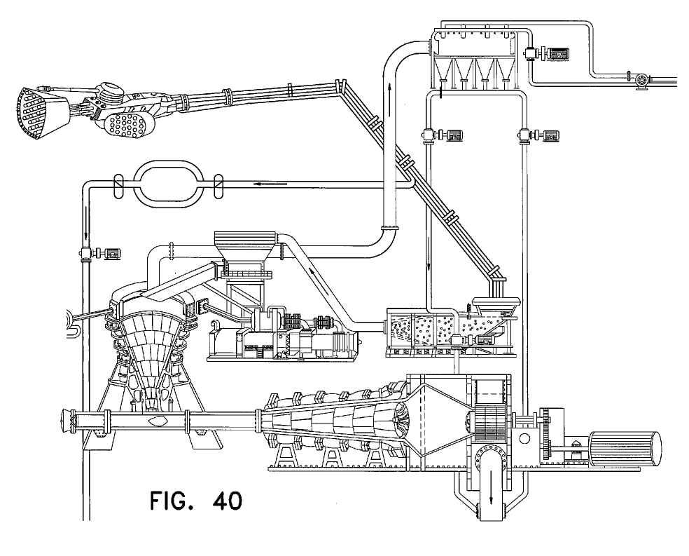

FIG. 39B shows the mining system. FIG. 40B shows a vacuum mining apparatus shown in FIG. 39. Element (1) is a vacuum extraction cone with telescoping cutting boom, 360° radius turret, 90° tilt floor to ceiling; surface high wall, tunnel, long wall, room and pillar and underground structure application. (2) is a long wall vacuum extraction scoop with mechanical shearer option—quarry, tunnel & long wall application. Element (3) is a continuous miner cutting head option—vacuum scoop system while the element (4) is a roadhead vacuum cutting head option—vacuum scoop system—(coal talc, salt, iron ore, bauxite, gypsum and others). (5) is an armored robotic crawler vehicle and (6) is an extending gas probe with vacuum gas extraction nozzle (50 foot extendable). (7) are fiber optic linked communication sensors and (8) is a gas probe turret and (9) is a lighting system. (10) is a sled mounted vacuum extraction piping system with ball and socket joint system while (11) is a mine gas vacuum extraction pipe. (12) is an ore vacuum extraction pipe-forward tunneling cone and (13) is an ore vacuum extraction pipe-long wall cutting cone(s). (14) is a probe sensor; (15) is an access hatch; (16) are hydraulic operated side panels; and (17) are pipe system bumper bars. (18) is a wet feed for continuous wet-head system and (19) is a hydraulic system to raise, lower and extend vacuum scoop apparatus with rotating cutter head. (20) is a side wall mechanical cutter vacuum scoop and (21) are cutting technology options in any combination or individually—hard rock and soft rock applications—Impact Laser-Plasma Arc-Plasma Arc (optional Hydrogen and Oxygen feed wet system)—Water Jet Cutter-hard rock-Supersonic I Hypersonic Cavitation (Vortex Reactor generated sonic boom)—Mechanical cutters (#4,18, and 20); and (22) is hydraulic cone extension system.

FIGS. 40A and 40B shows a multilevel flow diverter which demonstrates an alternative flow diversion from the primary ram air cowl into a primary swirl chamber and then into a secondary multiple flow chamber.

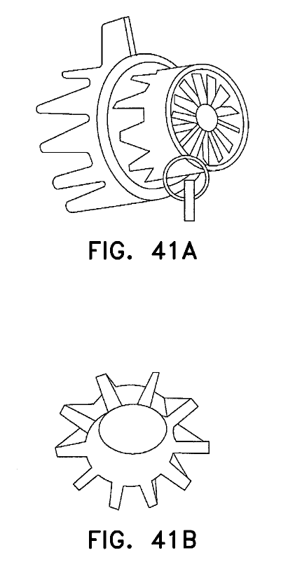

FIG. 41A shows a flow diverter which can be included in the present apparatus as a flow separating and classifying option.

FIG. 41B shows a wheel appearing apparatus and represents the MAGLEV generator when situated in a swirl chamber. The spokes would be flux lines and the outer wheel the electric power generator.

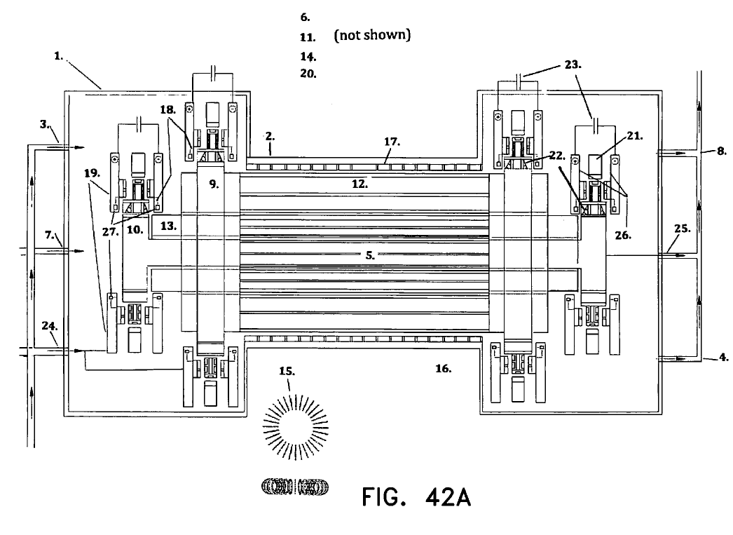

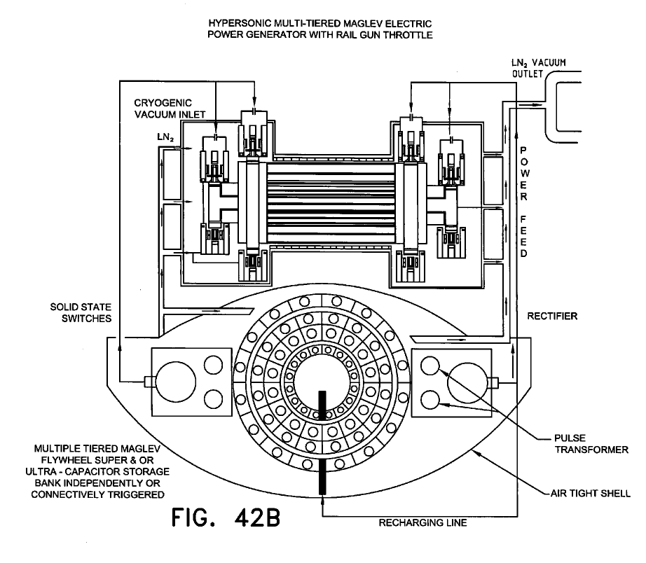

The numbered elements of FIG. 42 (Integrated MAGLEV Turbine Electric Power Generator System, Nested Maglev Turbine Assembly) are as follows:

1. Armored sealed outer generator shell with inner vacuum chamber
2. Thermal energy absorbing ducted recycle liner with independently vented between each PM with intake & downward spiraling Swirler fins leading to Cryocooler cold tip
3. Cryogenic atmosphere inlet
4. Cryogenic atmosphere outlet
5. Self-contained Cryocooler (internal drum mounted, not visible)
6. Getter Sublimation or Turbo-molecular Vacuum Pump (not shown)
7. Vacuum inlet
8. Vacuum outlet
9. Primary drive MAGLEV flywheel rotor (open-core, hubless motor & energy storage)
10. Second tier MAGLEV counter-rotating flywheel rotor (open-core, hubless motor & energy storage)
11. Third tier MAGLEV flywheel rotor (open-core, hubless motor & energy storage)(optional & not pictured)
12. Primary generator drum
13. Second tier counter-rotating generator drum
14. Third tier generator drum (optional & not pictured)
15. Generator drum mounted coils (second generation (2G) HTS bearings & single &/or double wound pancake coils) (Cutaway View)
16. Generator drum HTS (high-temperature superconducting) stability bearing
17. Generator drum Inductrack II permanent magnet HTS lift bearings
18. Armature guideway channel with “barrel” injection ports
19. Electrically conductive guide rails
20. Non-conductive molten metal induction crucible with pump
21. Augmenting upper track with opposite flowing current & inductance energy storage ability with laminated iron construction
22. Expanding/Contracting Armature Sabot with Plasma injection

### 23. Rail Gun Activation Switch

24. Capacitor Bank Power Inlet (electrostatic, electrolytic, battery, chemical double-layer)

### 25. Power Outlet

26. Thermal Insulator Layer Segments or Plate—resists 50,000 psi high shear, tensile stresses and plasma pressures

### 27. Rail Gun Armature Spark & Trailing Ionized Plasma Vacuum Containment & Evacuation Duct

FIG. 42 is an Integrated MAGLEV Turbine Electric Power Generator System having a nested MAGLEV turbine assembly comprising the elements as follows:

1. Armored and sealed outer generator shell with inner vacuum chamber;
2. Thermal energy absorbing ducted recycle liner
3. Cryogenic atmosphere inlet
4. Cryogenic atmosphere outlet
5. Cryocooler (internal drum mounted, not visible)
6. Getter Sublimation or Turbo-molecular Vacuum Pump (not shown)
7. Vacuum inlet
8. Vacuum outlet
9. Primary drive MAGLEV flywheel rotor (open-core, hubless motor & energy storage)
10. Second tier MAGLEV counter-rotating flywheel rotor (open-core, hubless motor & energy storage)
11. Third tier MAGLEV flywheel rotor (open-core, hubless motor & energy storage)(optional & not pictured)
12. Primary generator drum
13. Second tier counter-rotating generator drum
14. Third tier generator drum (optional & not pictured)
15. Generator drum mounted coils
16. Generator drum HTS (high-temperature superconducting) stability bearing
17. Generator drum permanent magnet HTS lift bearings
18. Armature guideway channel or “barrel” injection ports
19. Electrically conductive guide rails
20. Non-conductive molten metal induction crucible with pump
21. Secondary nested generator drum
22. Primary stator windings for levitation
23. Secondary stator windings for rotational force
24. Stator core
25. Gap sensor

### 26. Yolk

27. Thrust control coil
28. Levitation & guidance coil
29. Primary electrically conductive independent guide rails (optional; CEM shrink fit, CEM hydraulically pre-stressed, bolt together & or vertical-fiber hoop-wound structures) (high-modulus ceramic)
30. Sidewall insulators to resist 50,000 psi plasma pressures, high shear & tensile stresses
31. Augmenting upper iron plated rail
32. Air gap (horizontal & lateral)
33. Air gap (lifting & vertical)
34. Current guard plates
35. Pressure shell
36. Heat shield
37. Nested & segmented primary guide rails (suspension, lateral guidance, switching & propulsion)
38. Augmenting sub-rails
39. Buttress struts
40. Support magnets

### 41. Superconducting Stator Cables

42. Heat exchanger

### Generator Apparatus

### 43. Lift Magnet Superconductor Assembly

### 44. YBCO HTS Crystal Bearing Stator, Rotor & Support Brackets

### 45. Primary Drive Fixed Stator Laminated Permanent Magnet Outer Track in Hallbach Array

### 46. Primary Drive Inner Electromagnetic Rotor Drum/Cylinder in Hallbach Array

### 47. Secondary Drive Stator

### 48. Secondary Drive Rotor

### 49. Negative Conical Rail Gun Track

### 50. Positive Conical Rail Gun Track

51. Augmenting upper track with opposite flowing current & inductance energy storage ability
52. Expanding/Contracting Armature Sabot with Plasma injection

### 53. Armature Current

54. Magnetic Field from high-field NdFeB propulsion magnets

### 55. High Flux Density Gap

### 56. Electromagnetic Square Coil Winding Geometry

### 57. Flux-Trapping Conductor

### 58. Resister

### 59. Zener Diodes

### 60. Direct Current Capacitor Banks High-Energy Density

### 61. Pulse Forming Inductors

### 62. MOSFET's Semiconductors

### Ancillary Systems

### 63. Low Inductance Transmission Lines

### 64. Switching System

### 65. High Power Inverters

### 66. Vacuum Pump

67. Capacitor Bank (electrostatic, electrolytic, battery, chemical double-layer)
68. Conical MAGLEV power drive wheels (speeds of 4,500 mph to Mach 10)
a. Multiple flow thru holes to regulate ram air intake
b. Center & end spaced butting a fixed system of axial turbines
c. Axial turbine blades mated with inner housing fixed blades
d. A bearing-less, frictionless levitated (induction & or flux trapping) rotable system
   69. Multiple chambered axial compressor drum
a. Outer axial compression chamber
   i. Pulse detonated hypersonic rpm accelerator
   ii. Top chamber thrust duct
   iii. Bottom chamber pressure relief exit duct
   iv. Pressure relief tube recycle
b. inner axial compression chamber
   i. High RPM,
   ii. High pressure
      70. Outer parallel mounted detonation chamber(s) with thrust duct(s)
a. For peak demand output
b. LOX cooled chamber(s) & duct system
c. Blast pressure relief duct
d. Outer axial compression chamber linked

### MAGLEV Electric Power Generator System Background

The electric power utility, aerospace and defense industries have aggressively been competing to develop the next generation of electric power generation, transfer and storage apparatus in an effort to meet the escalating market demands. Further driving development is the matter of public safety with nuclear disaster in Japan, the now realized threat of global warming and national security concerns with terrorism and superpower tensions.

For decades electric power companies have relied on existing outdated power grids supplied by aging coal or nuclear fueled Rankine or Brayton Cycle systems. Carbon emissions, nuclear accidents and the threat of terrorist attacks have rendered such systems undesirable, inefficient and proven harmful to the environment. Recent developments between the superpowers have reignited the space race for control of earth's orbital highway and Russia's goal to dominating space exploration by securing a lunar base of operations. To accomplish such feats the superpowers have stepped up research and development efforts as both utility and aerospace electric power generation has now become an issue and priority for national security.

The invention apparatus has been developed to meet and exceed industry next generation goals by melding an advanced, compact MAGLEV, flux trapping and Inductrack levitation system with a hypersonic accelerator drive and power storage system. The MAGLEV motored electric power generator invention apparatus is a no-contact apparatus able to electromagnetically produce terawatt power without pollution or risk to the local community with its nested-rotor, open core flywheel architecture.

### MAGLEV Electric Power Generator System Summary

The invention apparatus is comprised of a high-field flywheel motor propulsion and energy storage system propelled by a combination of; MAGLEV induced levitation, a hypersonic speed mode generated by electromagnetic rail gun or coil gun activation and flux trapping High-temperature Superconducting (HTS) for high-power density, high-energy and efficiency electric power generation. Guidance coils affixed to the inner surfaces of opposing side rails and high-strength composite matrix flywheel construction materials ensure rotational stability when in rail gun acceleration mode at speeds of 3000 m/s, 6 kilometer per second to Mach 10. The nesting of multiple two rotor variants rotating in opposite directions helps to eliminate the net angular movement of the total operating system thus allowing for the hypersonic speeds. By adding a third rotor assembly and modifying the inner apparatus's height, width and thickness dimensions and or by rotating the 2-inner rotors in the same direction and the outer rotor in the opposite direction any net angular movement risk is eliminated.

A dual set of composite constructed MAGLEV flywheel motors rotating in unison provide the kinetic energy to drive the horizontally attached electric power generator drum(s) nested between them. The rotating flywheel/generator drum apparatus collectively comprises the system's shaftless induction levitated rotor assembly. The electric power generator mode creates voltage according to Faraday's law as the magnetic flux of the rotating permanent magnets (PM) passes the stator coils. The stator assembly consists of a flux trapping high-temperature superconducting (HTS) levitated YBCO (yttrium-barium-copper oxide or other materials where Y is replaced with other Rare Earth elements such as Nd, Eu, Gd) bearing assembly with an; armored sealed outer shell housing, an energy absorbing inner liner, an Inductrack II Hallbach array of permanent magnets and the independent MAGLEV stator Guideway rails.

Each of the independent electrically conductive rails has an internal vacuum-vented duct spanning the entire radius of the rail being designed to capture the arcing sparks created by the rail gun sabot and the highly ionized trailing plasma safely channeling them out of the reactor to an ancillary vortex tube reactor feed inlet. The inner rail wall also includes a grooved Guideway for the winged sabot to complete the circuit and drive the flywheels to a hypersonic speed for maximum power output. The guideway channel or “barrel” may include intermittent injection ports for injection into the channel gap of a plasma, electrically conductive liquid metal (700 degree Celsius to 2200 degrees Celsius or higher) of or other armature/guiderail support friction reduction solid, liquid, gas or supercritical material. The injection would be timed to be near the rear of the armature as it travels in the forward rotational direction.

The flywheel connected drum apparatus is mated to the armored outer shell's inner energy absorbing liner being separated only by a uniform but adjustable levitation gap. An Inductrack of permanent magnets is affixed to the inner liner over the drum apparatus in a manner to allow centrifugal forced heat to flow between the magnets into the liner which then directs the flow into an internally mounted Cryocooler for recycle thereby forming a looped cooling system. The external cryogenic system may also consist of an invention advanced type of vortex tube with a hypersonic scramjet feed of high pressure air created by a pulse detonation compression apparatus. The vortex tube system is able to produce either LOX or Liquid Nitrogen (LN2) at a ˜65K temperature and may be utilized as an alternative cryogenic atmosphere as advanced HTS bearings do not require a liquid cryogen.

The nested rotor drums are levitated with flux trapping high-temperature superconducting bearings and the flywheels are levitated by MAGLEV Inductrack induction and accelerated to hypersonic speed by rail gun pulsed inductive and resistive primary rail commutation. Kinetic energy is produced from a series of MAGLEV driven flywheels with attached electric power generating drums nested between them. Each rotor drum is lined with second generation (2G) high-temperature superconductor bearings and double wound YBCO pancake coils. The invention apparatus consolidates space by internally nesting a series of such systems which may rotate in opposite directions to optimize rotational speeds and power output.

The open-core flywheel architecture enables both high energy flux-field density and flywheel power storage ability to optimize output demand and store power between low and peak hours. The apparatus incorporates a rotor drum between each set of MAGLEV flywheels to which subsequent independently rotating sets are nested within to form a multilayered space saving high-output variable speed generator. Superconductor electric power generator and magnetic energy storage system with magnetized bulk REBaCuO coils.

To meet the peak power demands of a large grid system a type of railgun accelerator drives the flywheels into a hypersonic speed of 3,000 m/s and higher for optimum power output. A three-stage cooling system design is shown that interfaces with the external refrigeration system and minimizes hot spots in the magnet. The magnet cold mass can be held below 2 K even with a heat load of 1 kW. Internal convection with zero mass flow between the magnet laminations carries the heat radially outward from the center of the magnets to large coolant passages near the periphery. Cross flow is not required. Pressurized Helium (HeI) at 4 K or superfluid Helium (HeII) at 2 K are an option for added cooling to the system with the benefit of heat transport and internal convection effect.

Current art shaft motor/generator flywheel storage technology has been limiting due to the high velocity demands of the next generation of power production and material failure at such speeds. To address the flywheel construction and shaft and hub bearing issues the MAGLEV levitated flywheels are constructed from a matrix of graphite, carbon-fiber, advanced ceramics, alloyed steel, titanium, aluminum, copper, silica, carbon nanotubes, foam metals and various types of glass such as E-glass, S-glass and combinations thereof. Methods of manufacture include a proprietary pulse detonation drop forge apparatus which is able to molecularly compress and combine, weave, laminate and or layer the various materials, powders, fabrics to a tensile strength at or beyond 60 GPa.

The entire generator apparatus is housed in an outer armored housing with an inner energy absorbing containment liner sealed to contain a cryogenic vacuum atmosphere (cryostat or envelope) with both an external and internal cryogenic system of cooling. The armored housing is able to deflect galactic cosmic radiation, spectra and solar proton events and is a safety measure for atmospheric applications.

Permanent magnets may include flexible magnets made of FeBNd powder with neodymium iron boron, samarium cobalt, strontium hexaferrite and barium hexaferrite. The permanent magnets may be made with or without rubberization by rubber sheet matrix binder and oriented fibers. The operation of the apparatus could be considered a stealth system as it operates silently, without thermal heat release or vibration and is not affected by extreme climates such as is found in space.

### MAGLEV Electric Power Generator System Detailed Description

The present invention comprises a system for magnetically levitating (MAGLEV), propelling and electromagnetically generating, compressing, distributing and storing electric power. The system is described below in outline form.

I. Protective outer housing for atmospheric and space application
a. Armored outer shell
   i. Explosion proof construction
   ii. Cosmic ray, thermal & space radiation shield
   iii. Sealed system
   iv. Cryogenic & vacuum inlet and outlet connection lines
b. Inner energy absorbing liner
   i. Centrifugally absorbing released thermal energy
   ii. Independent slotted intake ducted system with downward spiraling flow guide-blades
   iii. Duct connected to the inner reactor Cryocooler
   iv. Conical Inductrack ring anchored to each vent bracket
c. Inlet/outlet ports
   i. Cryogenic vacuum looped regeneration system
   (A circulation system driven by the heat being removed then carries the heat axially through the 60 m long set of magnets. A heat exchanger/thermo mechanical pump module transfers the heat to the external refrigeration loop, permitting the external loop to be optimized without matching the flow rate required through the magnets)
      1. Getter sublimation or turbo-molecular pump generated vacuum atmosphere
      2. External cryogenic production reactor
      3. LOX, Liquid nitrogen & or helium processing & distribution
      4. System pressurization
   ii. Power transfer cable outlet port
d. Internal reactor Cryocooler
   II. Inner shell anchored stator assembly
a. MAGLEV fixed independent dual-beam cylindrical Guideway
   i. Positive rail beam with internal spark duct
   ii. Negative rail with internal spark duct
   iii. Top centered close-packed track circuit
   iv. LSM windings (linear synchronous motor)
b. Inductrack II fixed cylindrical ladder-like levitating dual arrays of close-packed shorted track circuits
   III. Levitated rotor assembly
a. Composite constructed opposing vertical flywheels
   i. FeBNd powder with neodymium iron boron, samarium cobalt, strontium hexaferrite and barium hexaferrite.
   ii. The permanent magnets may be made with or without rubberization by rubber sheet matrix binder and oriented fibers.
   iii. Detonation lamination constructed
   iv. Rail gun drop forge composite
b. Centrally attached generator drum
   i. Linear induction motor drive and braking system
   ii. Drum generator with alternative coil configurations
      1. Bulk trapped field magnets (NbTi) coils
      2. Second generation (2G) high-temperature superconductor bearings & double wound YBCO pancake coils
      3. Magnetized bulk REBaCuO coils
   iii. Nested single or series of like assemblies
   iv. Inductrack Hallbach arrays affixed to rotating drum

### Reactor/Module Walkthrough

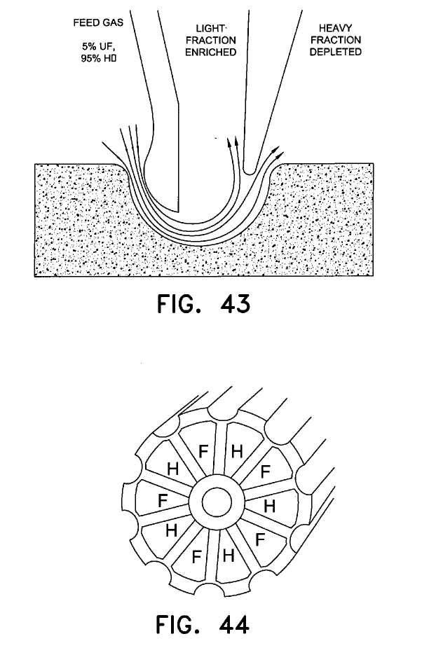

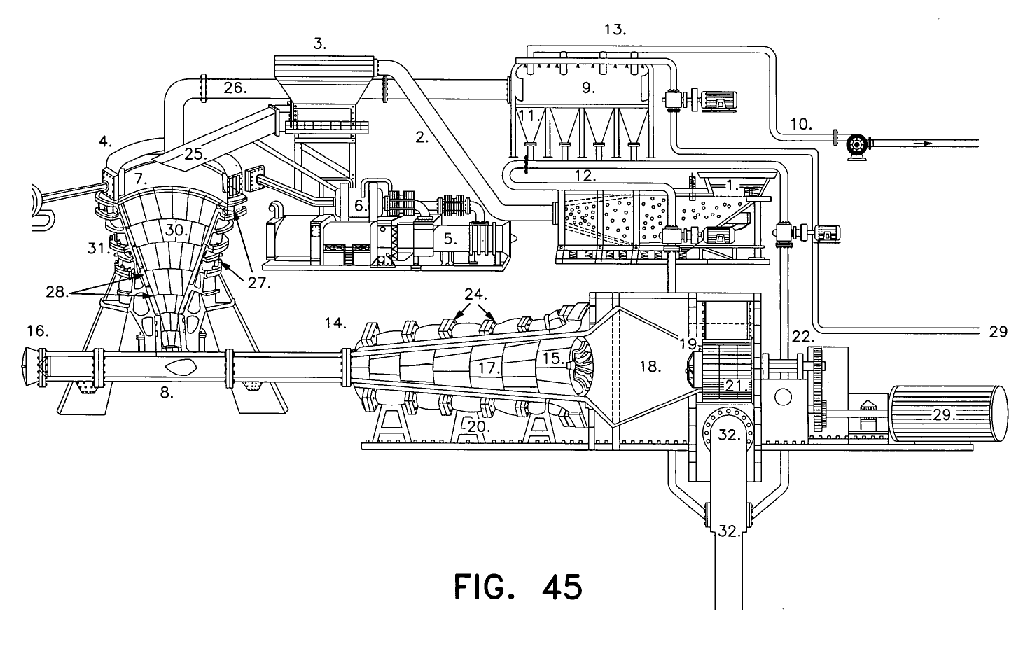

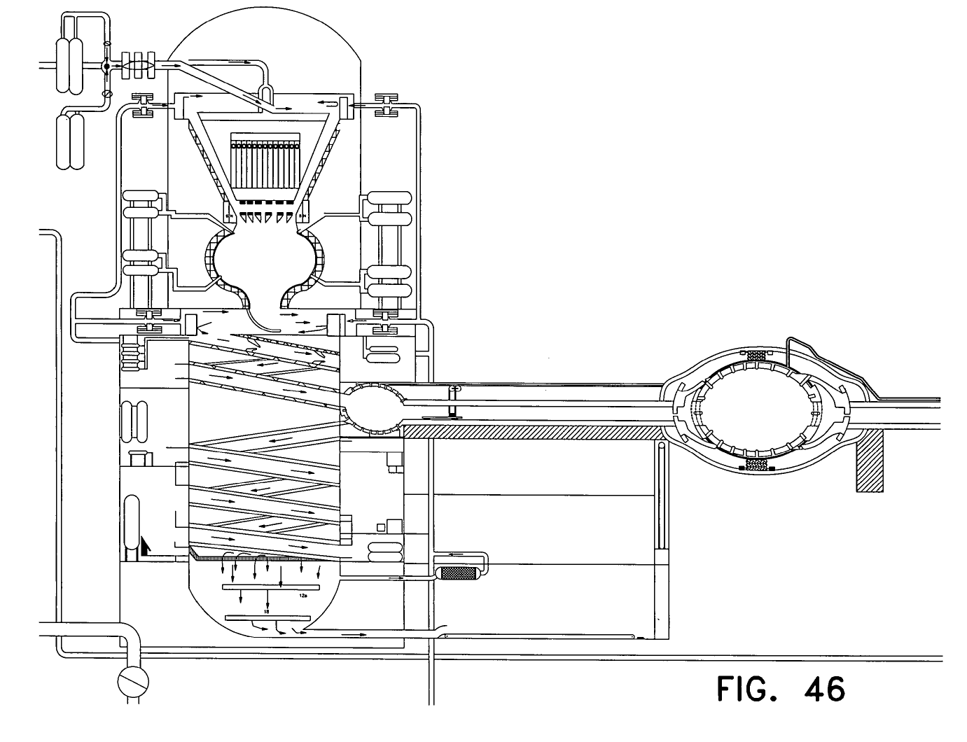

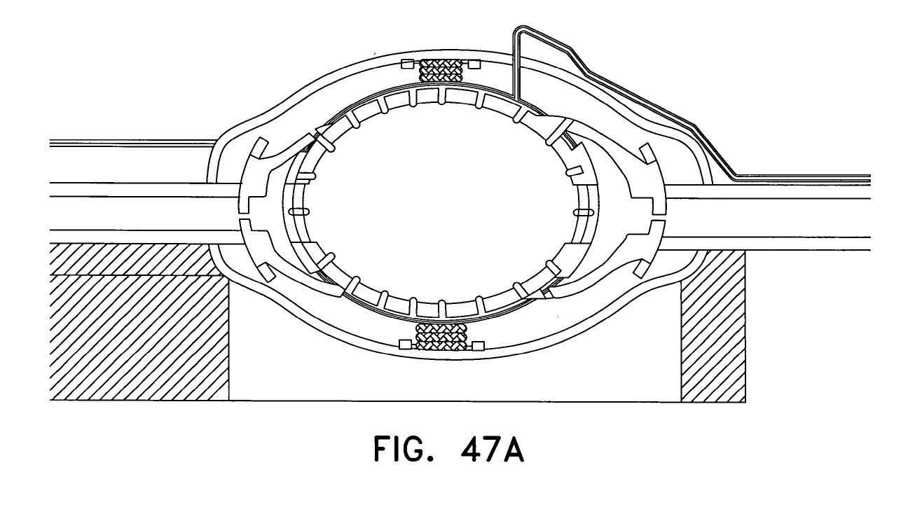

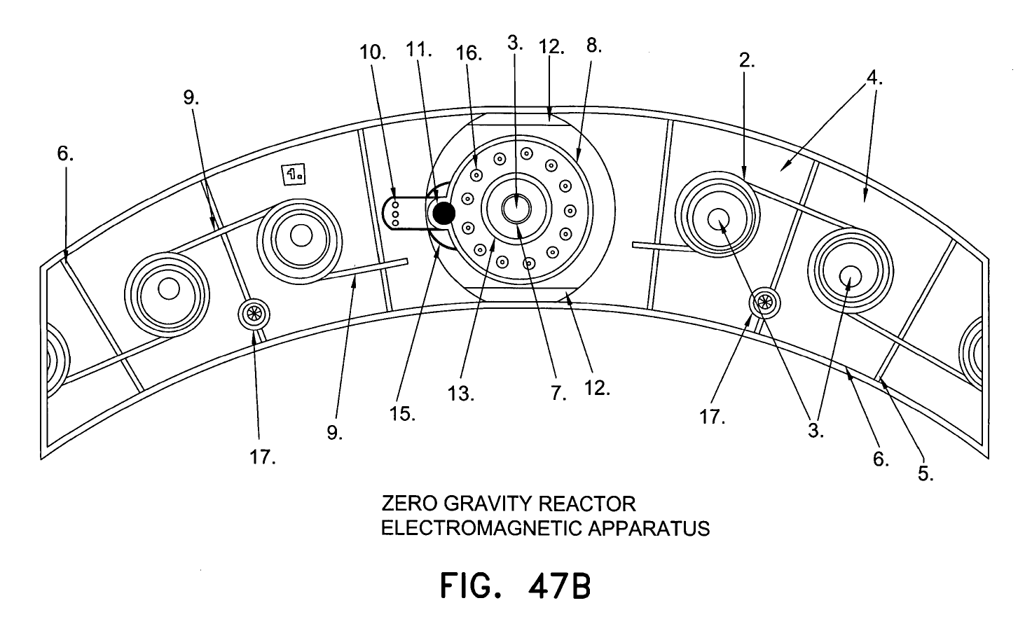

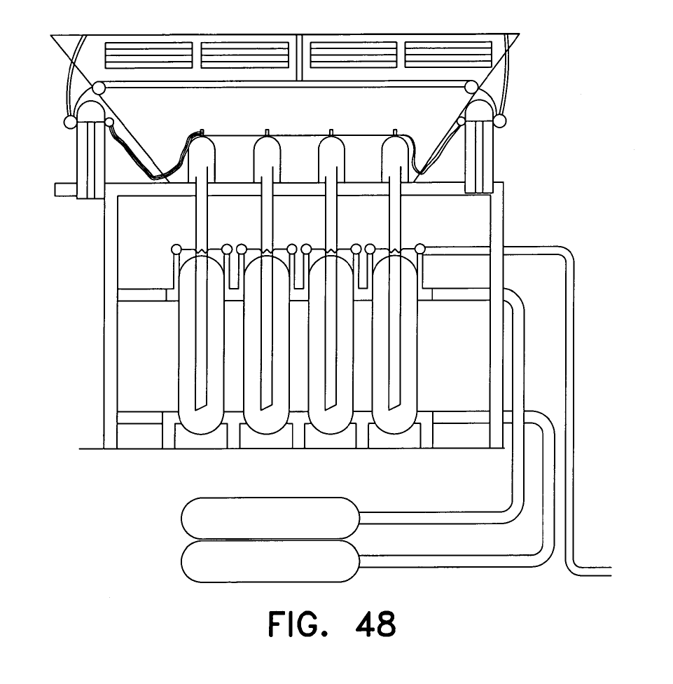

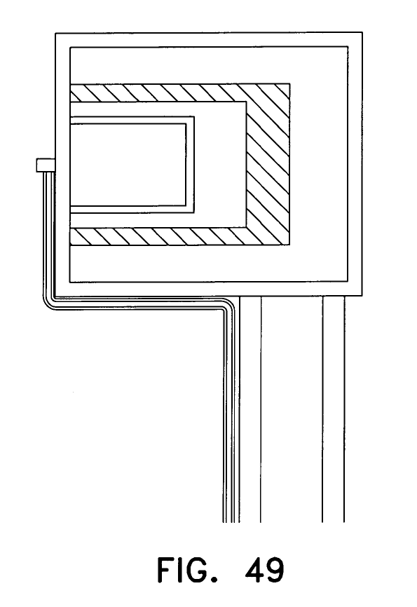

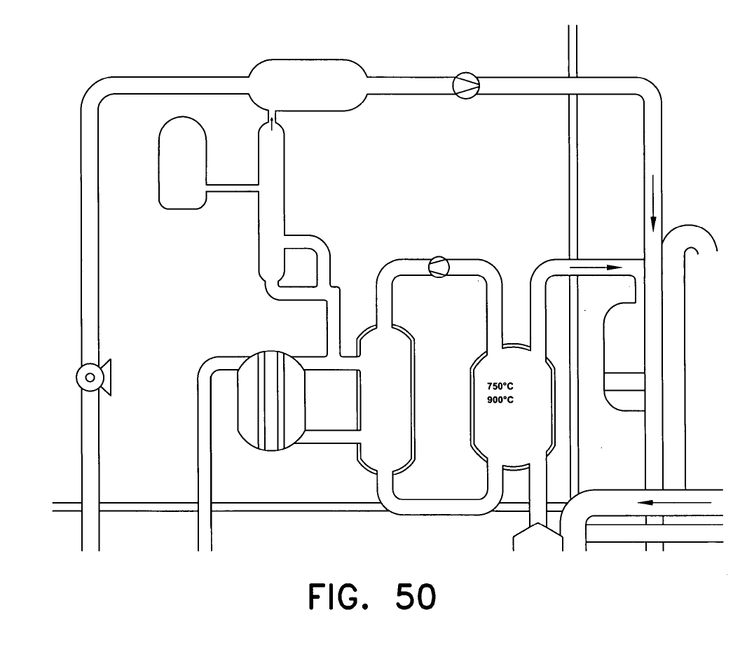

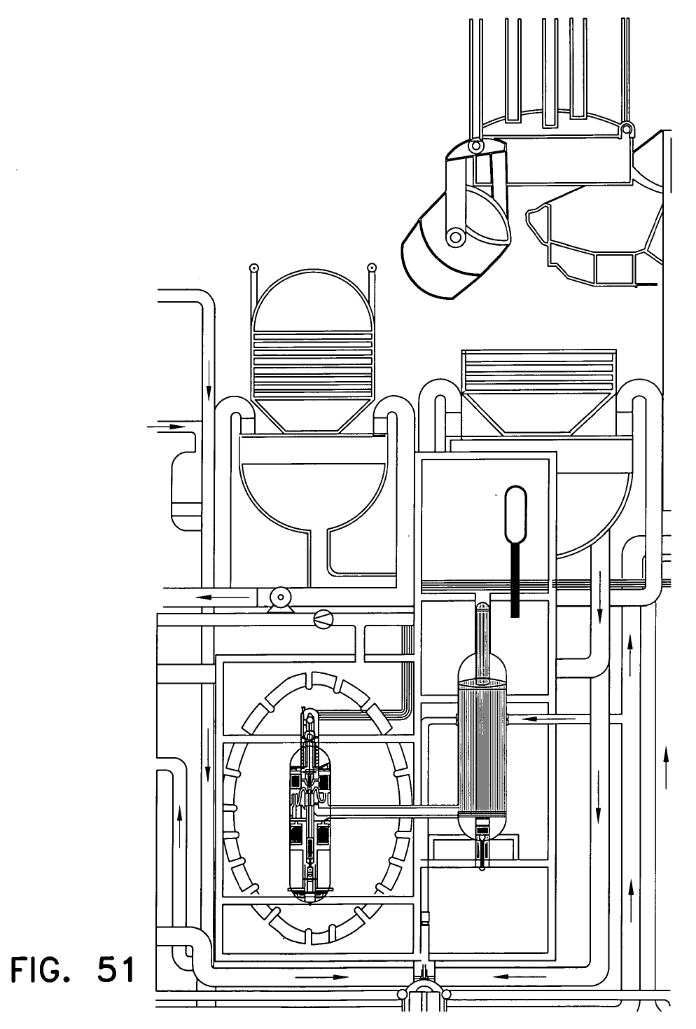

FIGS. 43-72 are diagrams of various Reactor example embodiments included in the present invention.

The primary thermal and kinetic energy options useful in the present core reactor include, for example: combustion thermal-kinetic energy generation; chemical reaction energy generation; hydro-generated energy; nuclear thermal and kinetic energy; magnetic and electric generated energy. Combustion thermal-kinetic energy can include, e.g., a turbine exhaust stream, an ionized plasma exhaust stream, a rocket engine exhaust stream, pulse detonation, hybrid turbo-electric, or combined pulse detonation and hybrid turbo-electric. The chemical reaction energy generation can include both catalytic or chemical reaction energy generation. The hydro-generated energy can be hydrothermal vent steam hydroelectric and/or ocean wave energy. Nuclear thermal and kinetic energy generation can be by fission or fusion. Electric generated energy can electromechanical or electromagnetic generation where electromagnetic generation can be, for example, magnetoplasmadynamic thruster, magnetogasdynamics, pulsed-plasma or travelling wave. The electric generation may also be electrochemical or electrolytic generated. Primary power source(s) for the present core reactor which are electric generator linked include system self-generated power by various methods. Such methods include, for example, electromechanical generators, electro-dynamic generators, magneto (rare earth magnetic) quantum trapping, Penning Trapping, fuel cells, hydro-mechanical generation, or osmotic/salinity gradient (either reverse electrodialysis or pressure retarded osmosis). Other self-generated power can utilize: photovoltaic; piezoelectric/stepping motors; ultrasonic motors; Quantum Trapping including Bose-Einstein condensate and Josephson junction with the Miessner effect and flux pinning from a Type-2 superconductor options; ionized plasma flow; armature and rotor type system (Copper superconductor), including photons, krypton, xenon, etc.; and zero gravity vortex.

System and auxiliary electric power generation include: space propulsion and extraterrestrial power sources; industrial plant-wide power production; mobile combat power generation; and power grid including primary generation and reserve peak demand auxiliary.

Secondary thrust acceleration and thermal heat amplification options useful in the present invention include, for example, a combustion turbine engine with inlet afterburner with fuel and oxygen injection (and any alternate gas) with either kinetic flow amplification or thermal heat amplification or a variable flow nozzle. Kinetic flows of energy can include quantum particles, “God Particles” as confirmed by CERN of the Higgs Boson principle. Other options include chemical and/or catalytic injection nozzles having reactive kinetic flow amplification or exothermic heat amplification, pulsed detonation tube or electric generated auxiliary booster with ionized injection or anode/cathode nozzle.

The present core reactor can have various alternative flow upper reactor exit/entry ports. These include, for example, upper reactor energy beam exit port(s) with a propulsion thrust nozzle option or a directed beam exit port option, primary or ancillary power inlet source such as power generation or downstream ram air, coolant feed inlet, vacuum energy beam inlet feed for reduction processing feed inlet or extraction material transport, or collecting and harvesting of electrons or harvesting other materials for fuels as photons, dark matter into dark energy, krypton, xenon, etc. and hydrogen; a coolant system inlet feed and exit recycle ports.

Side-reactor mounted primary power inlet port(s) can include single upper parallel level inlet port(s) for up-flow thermal kinetic flow or optional downstream or mixed flow or combo, lower parallel level inlet port(s) for up-flow thermal kinetic flow or optional downstream or mixed flow, middle parallel level inlet port(s) for up-flow thermal kinetic flow or optional downstream or mixed flow, multiple parallel level inlet port(s) which allow for multiple flow streams such as for example processing streams, propulsion thrust stream exhaust stream, heat exchanger stream, or reactor coolant stream and injection and feed inlets and exhaust outlets.

The central reactor processing/propulsion/power stage can be comprised of various elements. This stage can comprise an inner helical path annular swirl chamber which comprises a conical multiplier ring inlet slot(s) option the slots having an upward flow option (ascending), a downward flow option (descending) or a mixed flow option (ascending/descending) in which the mixed flow option may be at a primary power parallel level (to an inner flow chamber and/or to an outer low chamber), a single open-flow inner swirl chamber which can be outer swirl/vortex accommodating with an inner chamber combustion option or an inner mix and/or separation option, a dual opposing flow swirl/vortex option, a vane impeller insert (vanes, fixed or stationary) for cyclonic flow which can be a rotor impelled fan which is ion charged, mechanical or electro-mechanical, swirl flow propelled or afterburner propelled or is a fixed impeller.

Inner swirl chamber combustion/processing options include: 1) a pyrolytic liquification system; 2) a gasification system; 3) pulse detonation systems; 4) a nuclear reactor system; or 5) a secondary propulsion system (optionally the same as the primary). The pulse detonation systems can encompass water manufacture (propulsion or water separation processes), pre-treatment chamber, thermal cracking, reforming or furnace Tundish, or house the electric power generator, a nuclear reactor and in a reverseable system house the rocket detonation, combustion pulse thrust apparatus(es) and exhaust nozzle.

Inner and outer surrounding dual swirl chamber options include, for example: 1) conical multiplier ring feed inlet slot(s) or optionally with added laminar air flow guides; 2) single open flow outer swirl chamber; tri-chamber processing and cooling system and multiple chamber processing, entrainment flow amplifying and cooling systems. The mixed flow option can be at a primary power parallel level to an inner and/or outer flow chamber. The tri-chamber processing and cooling system can be an inner processing, electric power generator chamber or nuclear reactor chamber, a secondary opposing flow swirl vortex wall with coolant buffer to the reactor wall and fuel of oxidizer feed for combustion, an outer swirl chamber or an outer coolant jacket. The multiple chamber processing and cooling system can comprise, for example an inner processing or reactor chamber, a secondary opposing flow swirl vortex wall, a secondary swirl chamber or vortex stream, or an outer coolant jacket or vortex stream.

There are various swirl chambers with central processing area options. Such options include, for example, a secondary combustion processing chamber, a rankine cycle steam boiler, a second stage propulsion combustion chamber, a nuclear reactor core chamber, a treatment chamber, and a central chamber mixed flow digital vortex/vortices can be sustainable or alternating temperatures with or without material, or fixed or non-rotatable impellers, driven impeller. The secondary combustion processing chamber can be, e.g. a pyrolic/hydropyrolic chamber, a gasifier chamber, a hydrothermal processing chamber, or an atomizer chamber. The secondary stage propulsion combustion chamber can be a hydroelectric looped power generation or a rocket engine. The treatment chamber can be utilized for, inter alia, sintering, carbonizing, cryogenic tempering, or catalytic conversions, for creating new elements, mercury, lead, silver into gold, for example, new elements like metal hydrogen, metal kyrpton, metal xenon, rare earth magnets of great density and power, exceptional combinations and new elemental rare earth composites.

The central chamber mixed flow digital driven impeller can have extreme flow amplification options either as an electromagnetically driven impeller or a swirl chamber flow driven impeller or can be for vacuum beam and energy beam generation.

Central swirl chamber upper-chamber feed port(s) include, for example, combustion feeds, catalyst feed port(s), reagents and/or solvent feed port(s), raw processing feed port(s), or nuclear fuel rod access port(s). Combustion feeds can include, for example, fuels, hypergolic propellant(s) or non-hypergolic, oxidizer(s), working fluid(s) (fission), photon beam, or cavitation ultrasound.

Center vortex updraft with conical multiplier rings can comprise stacked descending rings with multiplier air/gas feed, stacked inner linked parallel rings, spiral descending with multiplier air/gas feed, or parallel spiral ring with multiplier air/gas feed. Middle vortex versatile can be down, up or mixed draft. The outer vortex up or downdraft can comprise inner swirl chamber directional flow guides or an inner chamber processing vortex cone optionally with an outer vortex coolant chamber, jacket opposing vortex.

The reactor secondary processing/propulsion stage comprises a compressor, accelerator, processor, and separator. The inner cone feed options include a single or multiple feed option with a conical multiplier ringed inner cone which can be downward flow angled or can have a perforated cone wall. The perforated cone wall can have multiplier makeup gas feed ports, an outer cone opposing vortex flow, an electromagnetic cone insert, or a rare earth magnet, advanced rare earth magnet, element, composite of an advanced superconductor nature and properties, cone insert. The conical multiplier ringed inner cone can also comprise an inner vortex flow compression stage and hypersonic flow. The inner cone feed options also can include a flow inlet distributor ring option with simultaneous inner and outer cone vortex flow creation and a perforated cone to allow feed separation.

A central reactor ion thrust accelerator vortex cone can be an ionized gas feed version and/or comprise flow amplification utility options. Such options include for example propulsion thrust, advanced energy beam, processing and advanced impact milling including, e.g., vortex and reverse vortex impacts and impact explosion and implosion.

Cryogenic impact separation can occur by induced embrittlement or liquid embrittlement with various materials such as, for example: nitrogen; argon; oxygen; carbon dioxide; nitrous oxide; helium; hydrogen (orthohydrogen or parahydrogen) methane; propane; kerosene; or ethylene.

Cryogenic gas/propulsion fuel injection options include, for example: pyrotechnic ignition; high pressure combustion; 10 ton thrust at 10 km. per second, (UDMH) nitrogen tetroxide-unsymmetrical dimethylhydrazine, (MNH) nitrogen teroxide and monomethyl hydrazine, or hydroxyl ammonium nitrate. Cryogenic gas/propulsion fuel injection options also include an electromagnetic vortex cone and an electrostatic vortex cone. The present core reactor may have secondary and third level mounted vortex processing cones. There may exist centripetal and centrifugal vortex forces and inner processing frusto-conical cone optional applications. Such optional applications may include, for example, primary flow compression, thrust acceleration, and cyclonic separation. Cyclonic separation may comprise, e.g., petroleum wiped film evaporator, implosive reduction and separation of solids and/or semi-solids, and hydrate flash melt and gas vaporization. Another possible optional application is as a nuclear hypersonic heat exchanger/radiator for, e.g. supercritical steam production.

Outer processing cone optional applications include a chambered/jacketed looped coolant system having a gas flow option using, for example, Helium, Argon, Xenon, Nitrogen, Propane, Carbon Dioxide, Oxygen, Hydrogen (fuel, processing), Krypton, Freon, and/or dry air. The chambered/jacketed looped coolant system can also comprise liquid jacket or coolant flow options utilizing water/steam, oil, liquid salts, light and heavy water, organic including, e.g. diphenyl or diphenyl oxide. The chambered/jacketed looped coolant system can also comprise molten liquid flow options, including, e.g., molten leaded glass and/or molten salts such as sodium or potassium salts, and fused salts, molten fluoride salt, and molten metal(s). Outer processing cone optional applications also include a perforated/non-perforated separation cone version utilizing a cyclonic centrifugal separator, a heated wiped film evaporator using liquids, gas, supercritical, semisolids, and nuclear.

The present core reactor comprises circumferential duct release outlet flow acceleration. There can be a central vortex positive ion energy beam option which accelerates the center vortex air, gas through a duct or which allows for the outer vortex flow to exit without slowdown. Thermal heat and thrust generation options include, for example: combustion; chemical; nuclear; geo-hydro mechanical; electrical; radiant; and sonic shock waves including, e.g. pulsed detonation and sonic amplifiers which can be ultrasound and/or scalar waves. Secondary thrust and thermal temperature amplification can comprise afterburner with variable nozzle and/or central inner vortex thermal flow. The central inner vortex thermal flow can comprise an ion vortex option via a center cone cathode or cone anodes. A nuclear vortex option can comprise, e.g., a nuclear thermal cone or a nuclear electro thermal cone. Opposing outer vortex coolant flow can comprise gas coolant either thermal or cryogenic, leaded glass coolant, molten salt coolant, and/or molten metal coolant. Internal reactor cooling system heat transfer options can comprise for example opposing outer vortex gas flow, or regenerative outer jacket including, for example molten leaded glass coolant, high temperature steam coolant, molten salt coolant, molten leaded salt, and/or molten metal coolant.

The present core reactor can comprise a cryogenic beam version. The cryogenic beam version can encompass, for example, cryogenic processing feed production, and/or cryogenic distillation. Cryogenic propulsion fuels include, for example, boron oxygen fluorine compounds, oxygen fluorine compounds, nitrogen fluorine formulations, fluorinated hydrocarbons, liquid fluorine difluride (OF₂), chlorine trifluoride (ClF₃), chlorine pentafluoride (ClF₅), hydrogen peroxide (H₂O₂), nitric acid and hydrazine fuel, nitrogen tetroxide (N₂O₄), and krypton. The cryogenic beam version can also comprise cryogenic hydrate gas liquid separation at sea level and/or subsea level. Additionally, this core version can comprise cryogenic cooling and effluent heat exchange, dewatering, entrained liquid and condensation removal with, for example, controlled condensate gas mix ratio, and a water degassing chamber.

The present core reactor can be used in various processes either stand-alone or system integrated or in a reversible or dual configuration such as the amplified inner vortex vacuum energy beam exiting one end of the reactor and at the opposite end the kinetic energy beam derived from the outer vortex flow. Amongst the processes in which the present core reactor invention can be used is propulsion. Amongst the high-hypersonic turbine apparatus versions of propulsion are: combustion propelled (carbon base fueled); detonation propelled; nuclear (thermal and/or detonation kinetic propulsion) including fission or fusion; electrically propelled including electromagnetically, electrostatic, electro thermal or magnetohydrodynamically propelled; cryogenically propelled; vortex energy beam propelled; sonic energy beam propelled; chemical reactive propulsion (catalytic); radiant energy propulsion (photovoltaic); plasma pulsed; and optionally—current art propulsion engines can be adaptable for core invention system integration.

The detonation chamber of the present core reactor and system may be also referred to as the “reaction zone”. Regarding the detonation technology of the present core reactor and system as reference to the apparatus explosive and implosive systems of propulsion, power and processing, the following are cited in relationship to the Brayton, Carnot and with slightly less frequently the Rankine Cycle: the Humphry Cycle (detonation process approximation by a constant volume process); the Fickett-Jacob cycle (one dimensional theory of Chapman-Jouguet theory of detonation); and the Zeldovich-von Neuman-Doring model of detonation (shock is considered a discontinuous jump and is followed by a finite exothermic reaction zone).

The present core reactor and system optionally includes: a quadruple linear implosive compression chamber with inert wave shapers; hyper-velocity shock tube for implosion or explosion application; colliding detonation wave compression; a sequential ring explosive system with or without a barrel; vapor shock wave compression refrigeration system which processes heat into cryogenic flows; and a valveless pulse detonation combustor.

Explosively pumped high-power electromagnetic pulse generation can be integrated into the invention's kinetic and thermal flows and/or its electric power energy storage system by its added; extreme current compression and amplification being able to create super electrothermal energy beams of over 100 MJ at 256 MA. Field strength can reach 2×10⁶ Gauss (200T); a pumped flux compression generator with high explosives and high power electromagnetic pulse by the super compressing magnetic flux and superconductor manufacture in order to generate extremely high-Hypersonic velocities and thrust; extreme compression for very high pressures and densities that produces millions of amps and tens of Terawatts exceeding the power of lightening; and extreme defensive or offensive energy beam applications.

Explosively pumped high-power electromagnetic pulse generation can also produce magnetic flux compression by a magneto-explosive generator; a hollow tube generator; a helical generator; or a disc electromagnetic generator (DEMG).

Related options which can be included in the present core reactor and system include: a quantum trapping, Penning Trap, combined and/or standalone hybrid MAGLEV turbine with advanced pulse detonation rpm supercharger acceleration; deflagration; pulse detonation; regenerative pulse detonation; an electromagnetic gun; or a ram accelerator.

The effects of detonation can be classified as hypervelocity accelerators, high dynamic pressure or gas dynamic expansion. All aspects fall within “shock and impact physics” covering flow density, velocity, pressure and enthalpy.

The detonation shock wave energy can be a primary power feed into the sonic energy beam chamber where it is further amplified to contribute in the creation of an intense sonic energy beam. The shock waves can alternatively be diverted into the thermal energy beam chamber as a method of amplifying a controlled, but extreme cavitation effect for thermal beam entrainment amplification.

The present core reactor and system energy beam invention's system of extreme velocity and centrifugal high pressure enables the creation of new and innovative vortex tube apparatus and processing applications. The categories of vortex tubes include: a counter-flow vortex tube; a uni-flow vortex tube; or a uni-flow vortex tube with cold air exit thru the concentrically located annular exit in the cold valve. This embodiment does not have a cold air orifice next to the inlet.

The invention Vortex Tube embodiments are distinguished by various modifications adapted to the desired utility and product. All invention versions have pre-compressed, filtered, humidified flows and enters the vortex tube through tangential inlets. An atmospheric air and space dark matter gas processing embodiment enables for the internal vehicle production of high yield, high purity liquefied oxygen, nitrogen, hydrogen, krypton and xenon amongst other gases, liquids and super critical feed. This vortex tube version separates and liquefies atmospheric gases thus serving as an internal self-generated fuel and operating system thermal and cryogenic energy source. The unique apparatus particulars can have tapered conical vortex cone geometry within a 2-phase counter-flow system having a minimum 3° to 7° diverging taper or more emulating outward from the tangential inlet port location. An internal adjustable cone valve seals the internal flow passage to vary the desired product yield. The external vortex tube shaft section is encased with a surrounding piped, ducted or jacketed chamber to regulate the vortex tube wall temperature with either a cryogenic gas flow or fluid. This allows any remaining processing gas(es) to condense and centrifuges it back out of the tube wall.

This apparatus can further have a contoured internal wall surface and the injection port side can be located on the converging end of the vortex tube for the exhaust. At the diverging end has been added an upstream MAGLEV axial compressor; regulated air cannon inlet nozzle(s); an inlet plane swirl generator; an automated pre-programmed and/or remote controlled adjustable internal cone valve; and two-opposing ball valve exit ports with integrated collection swirl chambers and flow exit ports to transport the cryogenically liquefied gases to either storage tanks or directly to the propulsion or processing pretreatment chambers. The exiting cryogenic stream is recycled back into the system

Cryogenic (current art) temperatures have been noted to max at 223°. However, with the present invention apparatus velocities, pressures and flow densities can achieve temperatures well below that average. The same applies to the thermal temperature (current art) average of 400° K outgoing flows to which the invention version also well exceeds.

The gaseous diffusion and effusion aerodynamic vortex tube embodiment can comprise an electron beam pre-filtering with foam metal substrated aerogel or Chalcogel filter; dual MAGLEV axial compressors to transmit parallel flow streams without mixing enhanced with a pulsed vortex gun detonated compression assist and a tangential high velocity, extreme compressed flow injection port.

The multi-level multiple cut system can comprise a tapered inner chamber vortex tube with stationary walled centrifuge, high-hypersonic pressure graduated diffusion primary separation chambers and vortex tube stacked secondary high-Hypersonic effusion separation chambers. The gaseous diffusion and effusion aerodynamic embodiment can also comprise upper level separated gas vacuum extraction port for transport to storage and/or injection chamber and a vortex tube process gas extraction port for transport to a recuperator for recycle. Additionally, this embodiment further comprises ancillary electromagnetic and/or magnetic separation, liquid thermal diffusion, and rotating inner cylinder centrifugation.

Metallized gases and “new” elements or combinations such as mercury, lead, silver into gold, for example; metal hydrogen, metal oxygen, metal kyrpton, metal xenon, rare earth magnets of great density and power, exceptional combinations and new elemental rare earth composites, can enable a tri-atmospheric vehicle to illuminate the current art heavy and bulky fuel and oxidizer tanks which limit cargo space and comprise non-productive energy consumption. The present core reactor and system can utilize metallic gases and combustible metals in a wire form which can be spool-feed as a corresponding fuel and oxidizer for combustive propulsion, thermal processing and detonation applications.

The hydrocarbon fuels comprise: air; chlorine; fluorine; nitric oxide; nitrogen dioxide; and oxygen. Primary dark matter gases include: krypton; xenon; hydrogen; helium; and interstellar subatomic particles (Cosmic ray protons, neutrinos (3° K deep cryogenic temperature for internal vehicle processing)), dust, and ionized metals.

Non-hydrocarbon fuels can include: acetylene; ammonia; arsine; butane; carbon monoxide; cyclopropane; ethane; ethylene; ethyl chloride; hydrogen; iso-butane; methane; methyl chloride; propane; propylene; dark matter gases yet to be realized; and silane.

Other fuels comprise explosives, vapors, gases, flammable liquids, solids, semi-solids and super critical materials and advanced metal composites.

Detonation compressed manufactured rare earth magnets and other products can create super conducting magnetic fields for use in the present core reactor and system, and can be manufactured with the core reactor and system. Likewise, these can be advanced composite rare earth magnets, even utilizing new elements such as mercury, lead, silver into gold, for example, metal hydrogen, metal oxygen, metal kyrpton, metal xenon, rare earth magnets of great density and power, exceptional combinations and new elemental rare earth composites.

The propulsion cowl of the present core reactor and system can comprise an adjustable flow guides which enable optimized ram air flows by atmospheric levels including take-off and landings, atmosphere re-entry and up to maximum ramjet levels. The flow guides include: a variable ram door; a secondary door; an engine bay vent door and a spill door. Cowls can also collect electrons and vacuum flows can act as a pulling effect like the physics of lift on airplane wings and propulsion of sails on a sailboat.

A space and orbital atmospheric embodiment can comprise an internal cowl, flow diverter transfer vane(s) linked to collection, separation, and dark matter processing apparatus. Primary cowl links flows for Casimir compression and related energy processing (“Dynamic Casimir Effect”).

With respect to power generation, the present core reactor is a high hypersonic generator apparatus. The present core reactor employs an advanced MAGLEV quantum trapped electric generator (or equivalents, to include Penning Traps or the like) as well as quantum levitated and propelled armature apparatus and is capable of producing high-Hypersonic RPM terawatt—petawatt output. The present core reactor can encompass kinetic power storage battery (secondary apparatus) as well as foam metal flywheels which can be cryogenically filled and MAGLEV propelled. The present invention power transport apparatus (delivery system) can comprise a cryogenic internal atmosphere and a high vacuum beam conduit grid. Current art electric generators can be made adaptable for integration with the present invention system.

Various processing and refining operations can be carried out utilizing the present core reactor and system. Amongst the procedures in which the invention system is useful is fractionation and separations. Distillation type apparatus with which the present core reactor and system can be used are atmospheric chamber, vacuum chamber, cryogenic optional atmosphere, azeotropic configuration or simple configuration.

A fractional invention jet nozzle cascaded packing system can include for example gaseous diffusion nozzle apparatus stacked etched foil separation nozzles, chip configured nozzle arrangement clamp cover plate secured, or assembly then flow tube packed light and heavy faction separation process. The system can comprise asymmetric cascading multiple-stream configuration central upward main flow tube encompassing downward tailing multiple flow stream tubes, light, intermediate and heavy fraction separation, extreme pressurized vacuum and atmospheric distillation chambers, laminar high-velocity gas flow, for example, raw carbon feed gas or injected processing gas(es).

The implosive vortex reduction reactor system can accommodate, inter alia, solid feeds, semisolids, liquids, gas, dark matter or supercritical materials. The extreme energy beam reactor of the present system can be employed either individually and/or as a combined version. The kinetic energy beam can be used for, for example, boring, drilling, solid impact fragmentation, propulsion, reduction or processing. The thermal energy beam (solid) of the invention can be used in, for example liquefaction, vaporization, gasification, dehydrating, Fracking, or processing. The Cryogenic beam of the present invention core reactor system can be utilized in, for example, Fracking, fragmenting, propulsion, cooling or processing. The present core reactor system (apparatus, processes and products) can comprise a vacuum energy beam or a sonic energy beam. The present invention core reactor system can be used in nuclear enrichment processing and atmospheric gas production into combustive and detonation fuels. Using the present core reactor, a hypersonic vortex uranium enrichment system could comprise a vortex fed, MAGLEV axial compressor which directly feeds into a single or cluster of tubular vortex tubes with internal multiple parallel interconnected effusion and diffusion chambers. The central flow tube may be fixed or rotating and the effusion level has a concentrated steam exit port for storage or combustion. Non-fuel or enrichment producting flows are routed back into the central flow for recycle from the diffusion processing level. Additionally, the system may serve as a vapor compressed refrigeration system working with or independently of the vortex tube cryogenic process, a modified vortex tube separator system, a cryogenic inert cooling system or laser diffuser (isotopically) selective irradiation. Conversions including decomposition and unification can be accomplished employing the present core reactor and system to provide processes such as, for example, pyrolysis, gasification, cracking (hydrogen, steam, or visbreaking), coking, reforming (catalytic) alkylation (catalytic), or isomerization (catalytic). The present core reactor and system can be used with treatment or blending processes. Such treatment or blending processes can be, for example, catalytic, hydrotreating, sintering, roasting, dehydration, sweetening, or mixing or blending. The present core reactor and system can be used with purification process including, inter alia, desulfurization, de-metallization, de-poisoning Ferro-, Para- and electro-magnetic capture and containment including rare earth magnetic. The present core reactor and system can be employed as an advanced filtration media for filtration and separations involving, for example, aerogels, Chalcogels, X-aerogels, sol-gels, substituted aerogels (including all of the above), advanced foam materials such as, for example, foam metals, foam composites, foam ceramics or foam carbon or graphite, advanced composite matrices, activated carbon, fuel cell filtered, molten salt filtration, E-beam bombardment and sonic energy beam. The advanced filtration media employable with the present core reactor and system include gaseous diffusion, aerodynamic process, integrated advanced vortex systems, or gas centrifuge. Products which can be produced using the present core reactor and system include electric power generation including, inter alia, DC current, AC/DC current, electric high voltage energy beam, or ionized electro-hydrodynamic power and thrust. An important use for the present core reactor and system is for water manufacture. Water such as, for example, fresh water, nano water, heavy water, produced water or super-critical water can be manufactured.

The present core reactor and system is useful in hydrogen and oxygen manufacture, and can be integrated into processes encompassed in the production of refined crude oil, fuels and re-refined oils such as crude oil, unconventional oil, carbon-based bio and pyrolic oils and waste oils. The present core reactor and system is useful in mining, extraction and mineral processing with respect to ores, minerals, metals, rare earth earths and precious metals. Fracking is another process in which the present core reactor and system can be employed. With the present core reactor Fracking can be carried out under extreme pressurizations, alternating thermal-cryogenic Fracking temperatures, extraction with looped recycle and processing of oil, gas and hydrates. The present core reactor and system can be employed with underground coal gasification, hydrate boring, extractions and processing as well as with gas boring, extraction and processing for, for example, natural gas, Syngas, LPG, propane, hydrogen, oxygen, methane (gas and hydrate), argon, helium, and coal mine gas including, raw gas (shaft mining and controlled burn, deep sea (hydrates, gas and oil) and deep well (hydrates, gas, and oil). Another area in which the present core reactor and system can be employed is mining and quarrying (minerals, ores, and metals). The transport and transport media of the present core reactor and system include MAGLEV, energy beam, vacuum beam, molten lead glass (thermal and kinetic) molten salt leaded glass, composite fiber optic (thermal and light), and levitation and zero gravity. The power resources generated using the present core reactor and system encompass an advanced matrix of apparatus and process technology spanning from the molecular to the mass industrial. Included, for example are exothermic and endothermic heat, cryogenic cold, sonic resonance, luminosity, thrust, vacuum and electromagnetism.

The present core reactors and processes include numerous terrestrial and extraterrestrial applications.

The present thermal beam and process can encompass extreme directed kinetic energy beam generation and distribution. The present invention comprises a propulsion engine which is as an aerospace chemical combustion engine which can comprise fixed-grid orbital track magnetic stators. The invention levitation turbine engine can comprise fixed-grid orbital track magnetic stators. The stators may be permanent, segmented magnet track top layered with grade 55 and/or 38 Neodymium-Iron-Boron (NdFeB), 12 mm cube magnets in Hallbach array, and/or Samarium Cobalt. Further, the stators may be single or multi-magnet width track with tracks segmented by a laminated sheet with etched uniformly spaced inductor slots, magnets placed at 90° axis grain angles relative from each other. The vane and rotors may be cast or formed, or constructed to form, dual opposing unibodies which being tightly aligned and integrated and rotationally governed by the fixed track electromagnetic propulsion generate optimum kinetic energy, compression and torque in a vacuum, cryogenic and frictionless chamber. The rotor and vane rotational speeds may be supercharged by pulse detonation to achieve rotational speeds never before realized without bearing or shaft wear, tear and speed restrictiveness. The operating system can function as an advanced shaftless homopolar with dipole, quadrapole and total encompassing detonated implosive directed magnetic fields. As the vanes and rotors move along the track, the attached permanent magnets induce a current through each rail, which induces a magnetic field opposing the field of the permanent magnets. A Linear Synchronous Motor (LSM) propels the vanes & rotors. It consists of copper wire powered by 3ø AC Power wrapped around slots cut in laminated iron. The iron is laminated to eliminate eddy currents. A high powered electromagnet iron central track mounting plate can comprise permanent and electromagnet combined flux fields, and rotating magnetic flux field generation with magnetic polarization. A circular magnet composite grid (option) can comprise individual circular shaped permanent magnets arranged in a mass grid to form a generator apparatus with magnetically axial spun, zero to high hypersonic speed or uniformly throttled. A vortex beam capable of generating free quantum electron creation or interplay of coaxial electrons and vector-vortices at a rotational rate of the Larmor cyclotron, or of a zero frequency. The present core reactor or system is capable of extreme power and voltage generation.

Single or multi-tier track levitated vanes and rotors can comprise quantum flux trapped and levitated body internal bundled sapphire superconductor and composite coating options such as, for example (YBa₂Cu₃O₇-x), or Bismuth, strontium, calcium copper oxide. There can be a gold-plated outer. A sandwiched substrate filled with cryogenic liquid or gas including a foam ceramic composite (option), or an Aerogel, Chalcogel, Sol-gel (option). Ceramic encapsulated bundle (vane ad rotors) can be non-conductive or of cryogenically activated superconducting construction. Zero to high-Hypersonic orbital rotation is achieved by speed actuation and control employing electromagnet transformer either speed throttle with load compensation control or a brake/reverse flow actuator. Multilevel flow paths (option) include opposing flow directional (AC power) or Staged unidirectional flow paths (DC power). Compression and expansion vortex chambers comprise a high compression stage and low pressure.

There can also be included a vortex tube generated Cryogenic atmosphere. This embodiment can also comprise propulsion, guidance, levitation and support. Staged thrust options include, for example, zero to high-Hypersonic speed, current art compatible engines including: turbine combustion engines, rocket engines, hybrid integrated power engines such as ramjets, scramjets and turbojets, or combined cycle.

Electric power generation and storage within the scope of the present core reactor and system can be described as an advanced power system. The present core reactor and system comprises an inventive megawatt to petawatt electric power system which includes a quantum levitation generator-electric motor. The quantum trapped MAGLEV levitation generator has a fixed magnetic stator track with an outer magnetic conducting surface using a permanent magnet option, a hybrid superconductor system option or an electro-magnetic option and an on-demand electric power storage mode which includes rotational speed acceleration by pulsed detonation or hypersonic flow air cannon which are enhanced by the quantum trapped cryogenic vacuum atmosphere with in the chamber enclosure. The generator can have a central mounting plate (e.g. an iron core), a bottom configuration with a dual opposing AC/DC current or a DC current option. The generator further can comprise levitated hypersonic traveling rotor. The rotor construction can be, for example, a non-conductive advanced ceramic encapsulating shell with outboard side pure copper plate surface or an inboard side advanced ceramic shell. The generator can further comprise, for example, a central Sapphire superconductor (option) comprised of, for example, yttrium, barium, copper oxide coated both sides or a gold sputter deposition sealed outer surface. A niobium-titanium or niobium-tin embodiment is a further option. The generator can further comprise a non-conducting inner packing comprised of, for example a Chalcogenide aerogel, or sol-gel oxide sandwich layering he conductor or porosity to contain the cryogenic fluid or gas to sustain a minimum about a 90° K temperature. A hypersonic rotor accelerator including, e.g. an air cannon can comprise an embodiment of this element of the core reactor which can operate in a cryogenic atmosphere (about 90° K or below).

The invention power storage apparatus can comprise, for example, a demand accelerator controlled generator or a spiral vortex power storage system. The thermoelectric converter can comprise, for example, a thermal-to-electrical converter designed for using multi-phase alternating currents to produce both radial and longitudinal moving magnetic fields, resulting in opposing twisting forces, and also for using multi-stage collectors with multidirectional energy flow, in order to facilitate generating electricity from thermal energy in a more efficient way. Primary power options include, inter alia, a current air turbine or a current art combustion engine. Secondary power generation can comprise, for example a levitation turbine apparatus. The present system can be directed energy beam powered or can comprise a secondary propulsion amplifier. Applications of the present reactor and system embodiment include, for example, an advanced power grid system, an aerospace self-generating system, marine power systems, or vehicle power systems. Invention electric power storage apparatus includes, inter alia, quantum levitated coils, or an ionized plasma vortex armature. The first stage thrust and exhaust powered apparatus can comprise heat amplification and thrust acceleration apparatus options including optional exhaust nozzle options with or without afterburner(s) (aerospike, plug, bell, cone, or expansion/deflection). Further elements can comprise a swirl chamber afterburner fuel and/or oxidizer injection element or an ancillary ram air or gas injection element which can comprise, for example a central high temperature steam boiler with an injection system. The second stage transonic to hypersonic speed element power generation options include, inter alia, magnetohydrodyamic power, an ion thruster, detonation or a plasma arc. A swirl chambered vortex generator can have a fuel injection intensification option and/or a central impeller flow intensifier option or an electric option. This embodiment can be multi-fuel capable with or without an oxidizer and can comprise an ionized vortex cone and power stream or a perforated cone wiped film evaporator. Third stage hypersonic to high-hypersonic speed thrust options and re-entry stage power generation is optional. Third stage thrust options include, for example, magnetohydrodyamic or pulse detonation.

Further embodiments of the present invention include a land and sea chemical combustion engine and aerospace thermonuclear propulsion. In the aerospace embodiment, current art thermonuclear reactors including molten salt (preferred) and high temperature gas cooled including the inventive molten leaded glass cooling system can be employed.

Another embodiment in which the present core reactor and system can be employed is in aerospace cryogenic propulsion. Fuel options in this embodiment include, for example, LOX and liquid hydrogen and bi-propellants LH-LOX. The present core reactor and system can be employed in processing force energy in a molecular to mass scale. Extreme deep cryogenic temperature generation can be used via vortex tube (invention), propulsion, processing treating and reduction utilities. A directed energy hypersonic impact beam can be used in utilities such as, for example, boring, Fracking, mining and extraction, solid mass, semi-solid, liquid or gas impact beam, vaporization and/or combustion or fracturing either reduction and/or destruction, compact linear collider reactor, projectile launcher and propelling apparatus. Further embodiments include extreme thermal kinetic energy beam and extreme cryogenic kinetic energy beam including a cryogenic looped Fracking system which is mobile or non-mobile. The cryogenic embodiment can comprise a cryogenic pulsed-energy beam boring head with surrounding outer extraction pipe and a rotating augur extraction or extreme vacuum removal. Dry ice pellets with a rail gun force energy beam bore action can be used for evaporation on impact. A looped system using no chemicals, water or causing pollution can comprise an access feed perforated bore hole, horizontal target extraction area, optional parallel drilled extraction exit bore, a main bore could serve as both feed and extraction exit and gas and oil separation for recycle and well head pretreatment processing. A four-stage fracturing and recycle process embodiment can comprise a first stage supercritical cryogenic gas hypersonic pressurized fracturing media which can be alternated with second stage to speed up extraction process and pressures can be adjusted and/or pulsed to allow liquid drainage. Second stage combined hypersonic thermal and sonic energy beam fracturing can employ horizontal pressurization and “thermal shock” fracturing extreme sonic beam fracturing assist. Third stage extreme vacuum extraction can encompass all process and any pocket gas (es) as well as all liquids for processing. A fourth stage can encompass hydro cyclone pyrolic gasification including gas and oil slurry separation vortex impact mill, solids reduction, wiped film evaporator filtration, dehydration and wellhead oil pre-treatment. An extreme vacuum beam generation system can be employed in the extraction (solid/semi-solid, liquid, gas and supercritical), transport, collection and processing, implosion mill, detonation, processing and propulsion shock suppression, electric power and/or thermal heat distribution and transport. Extreme exothermic ad/or endothermic temperature generation options include, for example, plasma, Nuclear (fission and/or fusion), chemical, catalytic, supercritical, and radiant photovoltaic (utility scale). Extreme high power thermal optical laser beam generation in extreme vacuum can be by an advanced optical system or advanced vacuum fiber optical transport media.

Extreme luminescent amplification resource options include, inter alia, thermo luminescence, incandescence, electro-chemiluminescence, electro-luminescence, crystallo-luminescence, mechano-luminescence, photo-luminescence and ionization, radio-luminescence or sonoluminescence. Extreme thermal sonic energy beam generation reactor can employ compression wave, detonation/combustion shock wave, ultrasonic waves, electronic beams, radio waves, or microwaves and cavitation.

A central plant thermal heat supply and distribution version can be employed in electric power generation including, for example, electric pulse generation, an ionized plasma generator, and a quantum trapping generator invention or a detonation power generator.

Pre-treatment/post treatment reactors are further embodiments in which the present core reactor system can be employed. Such reactors can be used for separation either thermally, cryogenically, catalytically or centrifugally. These reactors can be employed for purification by filtering, sieving or ultrasonically. Treatments can be chemical or thermal, for example and the reactors can be used in mixing operations. Upstream raw feed reactor variations include, for example liquid slurry feed, gas feed, hydrate feed, solid and semi-solid feeds, and supercritical feeds.

Downstream post treatment recycle feed variations include fuel processing, nuclear fuel reprocessing reactor(s), spent fuel purification and enrichment, or radiated waste leaded glass encapsulation.

The present core reactor and system can be employed with gasifier reactors, including, for example, a pyrolyic converter, a syngas (Fischer-Tropsch) converter, a raw wellhead gas gasifier, a hydrate converter gasifier or an underground gasifier system.

An additional embodiment in which the present core reactor system can be employed is with Molten Feed Treatment and an E-Beam Purification Reactor. Such embodiments can be used with liquid and/or molten liquid feeds, gas feeds, semi-solid feeds (metal and metal ores purified and degassed), or supercritical feeds.

A still further embodiment in which the present core reactor and system can for employed is with distillation reactors. The distillation reactors can be thermal vacuum and/or atmospheric distillation or cryogenic vacuum and/or atmospheric distillation.

A still further embodiment in which the present core reactor and system can for employed is with molten leaded glass reactors (nuclear and/or plasma reactors) including, for example, Molten or liquid nuclear fuel system including an operating radioactive safety shield, an emergency reactor melt-down system encapsulator, a Brayton Cycle application, a Rankin Cycle application or a Carnot Cycle application.

Still yet further embodiments with which the present core reactor and system can be use are: plasma reactors including atomizer and extreme high-temperature. processing reactors for mineral, metal, rare earth and precious metals ore or foundry melting and smelting furnaces, propulsion engines, ionized plasma propulsion and/or electric power generators, or extreme thermal ionized kinetic energy directed laser beams. Also possible embodiments include: zero gravity reactors with a manufacturing chamber, a processing chamber, a turbine operating chamber (bearing and rotable longevity) or a treatment chamber; hydro-electric power generation and water manufacture including hydrogen and oxygen plasma pulsed detonation reactors, detonation shock wave generated hydroelectric power, and utility scale mass water manufacture; and plasma generated high temperature steam production; water purification and recycle reactors including sour water, waste water, heavy water, and nano water; nano processing reactors; molten fuel cell reactor system including electric power generation and electric storage system, or molten salt electrolyte including filtration processing stream flow through and molten salt looped matrix system. Such systems can be molten leaded glass or molten glass insulated or an electro catalytic membrane fuel cell version.

Yet further embodiments which can employ the present core reactor and system are: an atomizer reactor with waste stream purification, separation and/or conversion; incineration; molecular vaporization separation, capture and recycle, powdered metal production, carbonization, or a refinery flare absorption chamber; or invention internal reactor components including, e.g. a Nautilus reactor packing system, Chalcogel substrated filtration (foam metal invention); aerogel insulted reactor walls, foam rare earth magnet purification filter, or water gas shift electrolyzer fuel cell reactor using hydrogen or oxygen.

Water of the highest purity can be produced using ion-exchange processes or combinations of membrane and ion-exchange methods described herein. Cations are replaced with hydrogen ions using cation-exchange resins; anions are replaced with hydroxyls using anion-exchange resins. The hydrogen ions and hydroxyls recombine producing water molecules. Thus, no ions remain in the produced water. The purification process is usually performed in several steps with “mixed bed ion-exchange columns” at the end of the technological chain. An embodiment of this EFSMP creates Carbon Fiber, and or nanotubes, from Carbon generated as a product of the SMP's herein, and include such examples of Carbon fiber is mainly made from a polymer called polyacrylonitrile (PAN) by drawing/spinning a filament, passing through a specific oxidation heat treating, carbonizing heat treating and surface treatment process, with the spinning techniques, non-mechanical water treatment, and the like, used in industry, but not limited to, are those such as wet spinning, sedimentation, centrifugation, evaporation technologies, dry spinning, air gap spinning and melt spinning. The various heating process steps include oxidation, pre-carburizing and carbonizing. The main surface treatment processes include electrolyte, washing and sizing, and the like. The other sources of the carbon fiber to produce from are petroleum or coal based pitch (pitch precursor) and rayon (cellulosic precursor), all of which are products created, or are byproducts of processing, within the EFSMP, and have been described herein. In addition to the previous description described herein, the EFSMP employs design and technology in advanced heating element design and insulation packages, which have greatly reduced energy consumption—like those of making Harpers International, carbon fiber LT, HT, and UHT furnace systems, as well as utilizing, but not limited to atmosphere purge chambers, where such chambers, individually, or in tandem, parallel, hybrid, and the like, improve product quality and extend the useful life of the insulation, and whereas such can also effectively stripping incoming material of entrained particulate.

A pre-pyrolysis reactor comprises a continuous system and method in which a slurry (fuel applies to the same system utilized in the power generation plant) composition including: crushed coal, micronized tires (coal to tire/battery mix weight ratio, 1:1; micronized battery cases, 1:2; carbon black optionally, 1:3; under atmospheric pressure in a hydrogen, propane or mix environment, 1:4) and a residuum blanket oil for prevention of spontaneous combustion and for deasphalting and further pyrolysis processing into oil and/or syngas. The syngas is then sent to the syngas line, for use as internal fuel source, and/or processing into a finished fuel gas. The pre-treated slurry is passed through several reactor heat Cells as it passes from the feed entry port with a temperature of 100-270 degrees Celsius for moisture extraction and then to a vaporizing temperature of 270 to 350 degrees Celsius. Heat is provided by infrared, microwave or convection means. The slurry/vapors are filtered by vacuum extraction and capture of carbon soot and ash forming compounds such as quartz, mullite, pyrite, carbonate, phosphates, actinides, sulfur, moisture and metals in a Chalcogel or X-Aerogel filtration system. The slurry and vapors are continuously mixed and pushed toward the reactor exit port by an Archimedes screw running lengthwise through the center of the reactor with the assist of ultrasonic cavitation aiding desulfurization at 20,000 cps. Coal fines can be utilized in the pyrolysis process with this pre-treatment system. The purified slurry vapors are then vacuum pump extracted and can be forwarded into a pyrolysis chamber.

### Distillation Reactor Module

This embodiment of the present invention relates to a combined apparatus and method for purifying mixed carbon based feeds within a refinery module, e.g., a Distillation Reactor. In particular, the combined apparatus and method relates to the ability to cyclonically purify mixed carbon based feeds while separating, capturing, containing and harvesting contaminants at the initial upstream processing location. The upstream processing allows for the apparatus to produce refined oils and fuels at a fraction of the cost by speeding up the processing cycle, product purity and illuminating numerous other processes and equipment found in current art. The combined apparatus includes: a desalt, pretreatment system integrated with the distillation reactor having a vacuum distillation chamber; an atmospheric distillation chamber; a central chamber flash zone with an upper filtration system; and a vortex processing zone.

The combined apparatus, including the distillation reactor module can be utilized with various types of operations and is adaptable for use in an integrated eco-friendly system, methods and processes (the “EFSMP” or “the integrated matrix system” or “the matrix”).

One or more objectives of the present invention is to consolidate current art refinery processing steps, accelerate processing cycle speeds and significantly raise daily production volumes through a simplified, standardized design all without moving parts or complex internal packing systems, yet being able to effectively operate under continuous or pulsed high-velocity flows.

A continuous pre-treatment process and method includes chemically formulating and mechanically combining a mix of varied carbon based liquid streams, high velocity colloidal blending, thermal flash vaporizing, compressing and subsonic separation and processing of the heavy from the light base oils for final refining into lubricating oils, products and or fuels. The system and apparatus may also me modified to pre-treat, pre-process and distill contaminated water back into a purified state.

The raw feed streams may include individually or as a mix light crude, heavy crude, shale oil, tar sands oil, waste oil, Pyrolyic oil, peat, bitumen, residuum and other carbons based liquids with thermal energy storage value.

The invention apparatus can include a central reactor flash zone where the pretreated feed stream is vaporized for separation of light from heavy oils directing the lights upwards through a filtration system into the atmospheric distillation chamber and the heavy downwards into the vacuum distillation chamber for processing.

The heavy oil vapors upon entering the vacuum distillation chamber are immersed within a processing gas atmosphere such as propane, butane, or ethane and/or various other gases injected individually or as a mixture to assist throughout the cyclonic fracturing, desalting, deasphalting and purification processes.

Alternatively, inert gases, such as helium or argon, may be utilized in conjunction with a thorough pretreatment process thus allowing for a single transport gas stream to be utilized throughout both the vacuum and atmospheric distillation processes.

The downward vaporized flow then enters into a multiple stage heavy oil vacuum distillation system inclusive of a primary central chamber located cyclone equipped with a heat inner cone surface which serves as a centrifugal forced wiped film evaporator, a secondary downstream cyclone or parallel series of cyclones and optionally additional downstream parallel cyclones or series of cyclones. All cyclones are aimed downwards with the narrow opening at the bottom. The vacuum distillation system operates at a high subsonic cyclonic flow rate to optimize the centrifugal fracturing force, the vortex flow compression and separation effect on heavy, tar sand, shale oil and contaminated oil streams.

Each of the various cyclonic stages work in conjunction with the processing atmospheres, temperature ranges and treatments all of which further refine out contaminants from the base oil until a 100% stream filtration is achieved. The vacuum distilled oils include light vacuum gas oil, heavy vacuum gas oil and residuum.

Water vapor is gravity desalted and condensed by a series of alternately layered electrode grid baffle plates located in the bottom section of the vacuum chamber. As the mixed vapors desalt they separate and condense into water and residuum droplets both of which drop into a bottom reactor collection pool where the lighter water floats on top of the heavier residuum sinks to allow for a simple, complete separation and independent extraction of each level for recycle. Any sediment will drop to the very bottom of the collection pool for extraction and special processing.

The water is extracted and forwarded to a filtration apparatus with an internal process system of 1) a glass fiber filter within a foam metal superstructure to withstand the high flow velocity, 2) a secondary activated wood based carbon filter bed, 3) an ion exchange resin column to remove nitrogen compounds followed by 4) an activated wood based carbon filter bed and a 5) an activated carbon aerogel filter with cast rare earth metallized magnetic superstructure. The final water purification level is below 0.1 ppm with metal concentration below detectable limits making it safe as a drinking water.

The oil vapors now free of sediment are now able to rise where the heavy vacuum oil and light vacuum gas oil can be side port extracted at a predetermined peak float level with the ultra-light oil vapors continue rising up into and through the primary and secondary vortex cones as an inner upward spiraling vortex flow. Upon the final processed light vapors reaching the Chalcogel filtration layer (#18) they mix with flash zone's light oil vapors and are final filtered before entering into the atmospheric distillation processing. The rising vapors are pulled through the Chalcogel filtration zone by the upper chamber's upward spiraling flows vacuum effect.

The filtered light vapors then enter the first of four or more ascending atmospheric processing chambers for fractionation, distillation and individual extraction of gas oil, diesel oil, jet fuel, kerosene, heavy naphtha, light naphtha and LPG gas. The vapors are relay propelled through the chambers by a series of high velocity air-foil processing fans. The fans are pressurized by intensifier pumps or other high velocity pumps and contain hydrogen and or other processing gases. The pressurized hydrogen atmosphere, in essence, hydrotreats as it fractionates, hydro-desulfurizes, and allows for a final hydro-finishing function for the light base oils. The hydrogen is also able to effectively control the base oil's final coloring while removing any odors typically found in spent oil or Pyrolyic feed stock.

The upward flowing vapors are propelled around the inner processing chamber's radius to a high-velocity flow upon entering the first atmospheric processing chamber by a series of relayed bladeless air-foil, high velocity processing fans. The fans are hydrogen pressurized by intensifier or other high velocity pump systems and flow speed regulated to meet daily production demand. The bladeless fans are systematically located just above each processing chamber's ceiling baffle plates, Nautilus ear shroud and corresponding oil extraction ports.

The chamber ceiling baffles serve as a processing flow compression mechanism as the pulsed high-velocity upward flow strike and mushrooms back downward it creates enough of a cross section flow to allow for a complete isolation and extraction of each specific oil vapor by its density and weight.

The process may be operated as a continuous or pulse timed flow rate thus allowing the refinery to customize the processing saturation requirements exactly to the feedstock consistency for a multitude of carbon based feedstock. The simultaneous opposing dual vortex flows within each of the atmospheric processing chambers is repeated until the vapors have been purified and extracted by weight and density with the light naphtha being extracted at the very top of the reactor dome.

The Distillation Reactor System can be operated independently from or incorporated into an integrated module or eco-friendly matrix system.

FIG. 73 shows an embodiment of the Distillation Reactor Apparatus of the present invention.

Pre-Treatment may vary depending upon the carbon feed stream or streams being utilized and include a single or mixed feed consisting of any type of light or heavy crude, waste, Pyrolyic, coal slurry, peat, shale, tar sands, bitumen or other carbon based oils. The reactor apparatus is designed to process any single or combined carbon stream whether it is externally or internally pre-treated and pre-heated for distillation.

Pre-treatment is achieved by the merging of various high pressure pipelines with each conveying an individual feed line of crude oil, (1) Pyrolyic oil and (3) spent oil with computer controlled metering for accurately (2) proportioning each feed stream into the continuous series of heated batch mixing tanks (5). The proprietary mixing formula can consist of various formulas to better adapt to any composition variances within each feed stream, but concerning recycle oil preferably consists of 45% pyrolyic oil, 45% spent oil and 10% crude oil mix.

Each mixing tank is preheated to a temperature range of 120° to 350° Celsius and for the best results between 145° and 285° Celsius. Alternatively, or in conjunction, the pre-heating may accomplished with pipe furnace feed lines into the mixing tanks and or entry into the distillation reactor. The combined heat, mixing action and additives begin the pre-fractionation process by loosening the bonds of contaminates and impurities from the base oil. Ultra-high frequency ultrasound has been added to the apparatus to optimize the effectiveness of the pre-treatment separation process.

Catalysts, hydroxides, surfactants, solutions, additives, chelating agents and reagents may be added individually or collectively to assist in the pre-fractionation process (8). Base oil additives such as alkali or alkaline hydroxides, which include sodium, potassium, calcium, magnesium, lithium and alumina, are used to neutralize acids and assist in flux separating impurities. Preferred are strong base oil additives such as sodium or potassium hydroxides formulated in aqueous solution in a ratio of 1% to 3% of pure basic mass for injection into each mixing tank.

Additional types of additives may include those which serve as downstream rust and corrosion inhibitors and solvents that remove undesirable aromatics from the crude oil such as methylpyrrolidone which works in unison with the hydrogen atmosphere of the vacuum distillation chamber.

Processing materials may be directly injected into the invention distillation reactor's gas injection port system and or the Chalcogel filtration system as a vapor, mist or in a supercritical state. All pre-treatment materials may be contained for recycle through the Chalcogel filtration system located within the invention reactor apparatus. The Chalcogel filters are removable through a side reactor exit door allow for them to be cleaned and reused.

Demulsifiers, nickel-molybdenum catalysts, diammonium phosphate aqueous solution, Toluene-alcohol and dodecane-alcohol (ethanol and 1-butanol), methyl ethyl ketone and reagents are optional. Bitumen based oils are diluted with naphthenic or paraffinic solvents to lower its viscosity and facilitate the separation process.

Target waste oil contaminants include trace metals, sulfur, nitrogen compounds, oxygen, water, fuel and oil additives, diesel fuel, chlorine, volatile and semi volatile polar and non-polar organics, soot particles, benzene, styrene, naphthalene, trichlorofluoromethane, 1,2,4 and 1,3,5-trimethyl benzene, acenapthylene, isophorone, 1-methyl-napthalene and 2-methyl-napthalene, phenantrene and exhaust condensate amongst others.

Once the individual mixing tanks have completed the computer timed treatment process the contents are vacuum released into a dual exiting pipe duct system to which each contain a section of rare earth high-powered magnets to assist in the extraction of both ferrous and non-ferrous trace metals from the stream prior to entering the colloidal chamber.

The opposing duct flows are then accelerated by intensifier pumps (6) to a high subsonic velocity which is computer controlled through a regulator located just downstream from each pump. The close proximity ensures that the two continuous flow streams are identical in volumetric flow rate and fluid viscosity so the two streams meet exactly in the central colloidal chamber (31) at optimum high-velocity and optimum colloidal impact force without interruption or flow deviation (38).

The high shear force (33) of the colloidal impact is able to loosen, fracture and or break the molecular bonds while thoroughly saturating the feed contents into a finely textured flow of slurry. The slurry is then forwarded as a continual flow through the transfer piping system (36) into the low pressure conveyance chamber (39) where it is flash vaporized before entering the impinging jet (7) or alternatively the turbine exhaust stream (not pictured) and conveyance piping system. The turbine exhaust flow power source combines kinetic energy with thermal pre-heat while the turbine(s) are simultaneously generating electric power. The turbine engine exhaust power is an integral part of this invention as all exhaust contaminants will be removed during the processing.

Shear rates of 107 s−1 with channel velocities of 400 m/s achievable in the colloidal process. Optionally, the low pressure transfer piping system can include an electro-cavitation apparatus with central chamber targeted metamaterial absorbing core plate or tube or rod (40). The centrally mounted core plate, tube or rod spans the length of the transfer pipe (39), which is predetermined by projected flow velocities and required processing time based on the flow duration and viscosity. The cavitation energy enables the molecular bonds to forcefully separate, thus adding to the demulsification of the hydrocarbons from water, natural surfactants and the contaminating substrates. The preferred cavitation pressure range is about 100 psi to 1,000 psi.

This process and apparatus enables a highly efficient ancillary separation method which can work in conjunction with chemical emulsifiers or in place of them. It also has the ability to balance and control the high ultrasonic energy cavitation effect on the Metamaterials and piping to prevent any damage to them.

The colloidal chamber (31) and low pressure outlet (39) are heated to maintain a vaporizing temperature between 316 degrees and 420 degrees Celsius. The heating allows for the full vaporization of the slurry and for the vapors to be transferred without condensation through the impinging jet or other vaporizing apparatus and for the flashing within the reactor flash zone. Heating may be provided by infrared, microwave, convection, induction coil, steam or hot oil jacket, turbine engine exhaust, heat exchanger, endothermic and or exothermic generating sources.

An embodiment of a slurry and treatment Reactor is shown in FIG. 74.

The Distillation Reactor Apparatus comprises three main processing chambers: 1) the vacuum distillation chamber; 2) the atmospheric distillation chamber; and 3) the central reactor flash zone, with 4) the inter-apparatus filtration system with Chalcogel filtration, ceramic membrane, activated charcoal or other individual or combinations of fillers within a foam metal substrate which alternatively may be of a rare earth magnet construction.

The reactor may be constructed with advanced materials to prevent vortex or cavitation erosion and thermal effects such as cracking or brittling of metals such as those used and being developed within the global Aerospace and Defense industries as of the date of this filing. System piping, processing chambers, pump housings and columns may be extruded or hydro-formed to eliminate seams and minimize joint connections and will have Aerogel insulation to minimize heat loss or outside climates to effect processing temperatures.

The distillation apparatus may be constructed as a single system being vertically or horizontally combined with a mutually shared pre-treatment, flash zone and filtration system as described herein, or as separate stand-alone systems, or as an interconnected stand-alone system depending on the desired size and production capability of the refinery. In a separated stand-alone version the filtration system on the vacuum distillation reactor will be top mounted as a final filter for light oil relay to the atmospheric reactor. The atmospheric distillation reactor has the filtration system mounted upstream at the bottom entry to the first processing reactor chamber.

The vacuum distillation reactor's initial processing chamber consists of a single inward flowing or progressive series of subsonic cyclone apparatuses to which the last in the series may be a nitrogen injected Cryovortactor cyclone. Each progressive series may consist of a single or multiple cyclones each of which have a downward spiraling outer vortex and an inner upward flowing vortex. Heavier vapors are thrust downwards aiding in the separation processing and the cyclonic cones may be constructed with thermal heat jackets which would serve to collect particles and vaporize them dropping any residues to the bottom for recycle. The light oil vapors would rise and be pulled into the center vortex within the cyclonic cones and propelled upwards into the final Chalcogel filtration system. The chamber is pressurized with propane, an inert gas and or a mixed butane/propane gas processing atmosphere.

The vacuum distillation reactor has one or more vacuum actuated product exit ports located at specific height levels which correspond to the factions or straight-run cuts determined by specific type of boiling point ranges. The extracted oil vapors are classified in order of increased volatility and include in ascending order residuum (14), water (17), heavy vacuum oil (15), middle distillates (not pictured, see the discussion in this application) and light vacuum gas oil (16). At the bottom of the sediment pit is an extraction trap door (13) for the removal of sand and other particles deposited from the processing of tar sands, bitumen, waste oils and shale oil.

An additional processing chamber may be added to provide ultra-deep Hydrotreating of the middle distillates by locating it just above the vacuum distillation Chalcogel filter system for an upflow feed. The chamber would enable consolidation of the Hydrotreating processes currently conducted as separate stand-alone processes. Such consolidated Hydrotreating tasks may include; Hydrodesulfurization, Hydronitrogenation, Hydroisomerization, Hydrocracking, Hydrofinishing, Hydroconversion, Hydrodearomatization and Hydrodeoxygenation. The Hydrotreating chamber could consist of a single or multiple hydroprocessing chambers depending on the product(s) specific requirements for being processed such as temperatures, pressures, catalysts, catalyst beds and others.

The vaporized feed stream's outer vortex exits at the downward directed narrowed tip where it then expanding centrifugally propelling the heavy vapors downward further breaking the bonds of oil from impurities. The light oil vapors upon rebounding from the bottom of the reactor continue to rise until they are vacuumed into the central upward spiraling vortexes within the progressive series of processing cyclones. Upon rising to the top of the cyclone cone they enter in to the Chalcogel filtration system (18) and then continue upwards into the first processing chamber of the atmospheric distillation reactor. Any processing gases accompanying the light oil vapors are extracted for recycle through the central filter exit port (19) with any remaining processing or inert gas dissipated within the hydrogen atmosphere of the first processing chamber. The Chalcogel filter system can be removed and reinstalled through a side reactor access door. The filter's trace metals can be harvested for recycle from the magnetized foam metal grid with any contaminants being plasma atomized in an ancillary process.

The atmospheric distillation reactor (43) consists of one to six pressurized processing chambers, but preferably five chambers (21, 28, 30, 32 and 34). Each chamber vertically adjoins with the next chamber being separated by an upward flowing high-velocity air foil bladeless fan (25 and 41) each being energized by intensifier pumps (27) and pressurized with hydrogen processing gas which also prevents fouling. Gas feeds are tangentially connected to each of the upward flow directed air foil fans (41). The fans create a steady upward flow on the inner diameter walls of the reactor leaving the center section with a less volatile center processing section to allow the vapors to separate and rise to the proper extraction levels.

Each of the atmospheric distillation reactor's processing chambers contain flow baffles mounted at each processing chamber's ceiling height (22) which slow rising flows for processing, cascading “cupped ear shaped” Nautilus extraction rings mounted just below the baffles (45) which guide extraction flows into the exit ports (24, 29, 31, 33, 35 and 38). Optionally each processing section may contain a Chalcogel inter-chamber filtration system (25) which filters impurities consistent with next processing chamber's specific processed gas requirement before entering that next processing chamber and the processing and inert gas extraction port (39) which connects to a looped system of purification, recharge and recycle.

Each of the processing chambers is temperature regulated to a degree level conducive with the exact boiling point of each of the oil cuts to be extracted. The thermal extraction system is based upon ascending flows with descending temperature plateaus which aid in attaining the proper extraction level and in the proper purified state. The thermal temperature can range from ambient to a 1,000 degree Celsius cracking level but preferable from a 300 degree Celsius range at the lowest chamber level with a graduated temperature descent down to 40 degrees Celsius at the very top of the reactor chamber.

Located just below the each air foil fan are a parallel series of vapor flow baffle plates (22) with an inward protruding “Nautilus ear” (40) shaped ring spanning the inner reactor wall radius (23). The ear shape protrudes in a manner as to cup and collect the upward ascending vapor when it reaches it maximum height and lingers which ensures the vapor is ready for extraction. Vapors which are still ascending beyond that level easily pass through the baffles rising upward into the next processing chamber.

The very top reactor processing chamber has an upper Chalcogel filtration system (36) to trap any remaining contaminants, separate and extract the processing gas(es) from the LPG thus allowing the purified LPG to flow through the top reactor exit port (38) for the next step in processing.

The Distillation Process begins with the oil slurry entering a heat pipe (44) which dually serves as a feed pre-heat and ancillary vaporizing apparatus prior to entering the impinging jet system. The impinging jet system pressurizes the pre-treated oil slurry and directs the flow to a injector pipe which is centrally mounted on the outer reactor wall and has a 20 degree to 65 degree injection trajectory, but preferably a 45 degree trajectory feed line into the reactor's flash chamber. The impinging jet propels the slurry at a high velocity to sustain a continuous flash vaporization process and maintain constant internal reactor pressurization.

The flash zone (3) is central reactor located and is surrounded by a Chalcogel filtration system (18) to filter the rising light oil gases before entering the atmospheric distillation chamber. As the vapors enter the flash zone they are centrifugally swept counterclockwise along the outer circumference of the flash zone walls where the flow is Swirler guided in a sharply downward spiraling direction into a tapering cyclonic cone (7) which also generates a counter swirling upwards flow inner vortex flow. The outward centrifugal force against the heated inner cone wall compresses and separates oil vapors from contaminants while incinerating heavy oil particles, volatile organics and other contaminants in an advanced wiped film evaporator manner. The high subsonic velocity of the flow is sustained by two to four or more intensifier pumps (5) which are parallel mounted to the flash zone's outer reactor wall. Each pump injects a continuous stream of processing and or inert gas(es).

Processing gases aid in the fractionation of heavy oils, additives and water and may include propane, butane, hydrogen and steam. Propane's ability to extract only paraffinic hydrocarbons and reject carbon residues allows for the rapid Deasphalting of heavy oils in the fast moving cyclonic flow of the apparatus. Butane when mixed with the propane in a mix range of 10% to 50% depending on the feed stream's asphalt and tar content to further promote metals separation at the molecular level.

The vacuum distillation processing gas could also include a single or multi-component mixture of n-propane, isopropane, n-butane, isobutane, ethane and some of the various butylenes, butane/propane mixtures (C3/C4 or B—P mix). The co-solvent can be propane, ethane, butane, propylene, 2-methylpropane, dimethylpropane, propadiene, diemethylether, chlorodifluro methane, diflouroromethane and methylfluoride. In addition to propane, organic solvents such as propanol and supercritical ethane can also be used.

The cyclonic vacuum distillation separation apparatus comprises an outer shell with inner upper central reactor located large cyclonic processing cone (7) upstream to a secondary, parallel series of smaller processing cyclonic cones (8) surrounding and downstream of the larger central cone. A third cyclonic separating cone is located downstream of the second series and optionally includes at least one third sized single cyclonic cone (not pictured).

The cyclonic cone system may include a heat jacketed cone which serves as an advanced art invention to the wiped film evaporator, thin film and short path systems due to its high processing speed of 100,000 G's of gravitational force or higher, no moving parts and thorough filtration efficiency.

The separation efficiency of each of the three successive cyclonic processing steps is controlled by the size of that particular series diameter of the inlet and outlet, the cyclone's diameter, body length, taper angle and the depth of the cylindrical inlet at the top of the cyclone. The feed stream is progressively purified within each series of cyclones with each series cyclone diameter progressively enlarging.

The downstream cyclonic processing flow begins with the smallest uniform sized cyclone or cyclones located within the outer radius of the reactor thus collectively comprising the first stage of the three stage series. The secondary processing cyclone or preferably eight cyclones (10) are uniform in size being slightly larger than the first series and also running parallel with each other, but positioned lower to the first stage series of cyclones, thus forming the secondary inner radius chamber.

The third and final processing stage is conducted in a large central cyclone (7) positioned lower than the first (8) or second series to which the central upward flowing vortex is Chalcogel filtered before entering the atmospheric distillation chamber (43) or alternately exited for further processing.

The outer annular chamber flow continues in a counterclockwise and downward spiral until it passes through the heat jacketed central inner wall's perforated passageways (10) and on into the secondary annular chamber. The inner wall with through-hole passageways is maintained at a constant 420 degree Celsius temperature on its outer surface to serve as a first stage wiped film or short path evaporator to destroy volatile or semi-volatile organics and vaporize any particles of dust and dirt from the vaporized streams.

The through-holes are rectangular shaped and contain cross-sections with width-to-height ratios in the range of 1.5:1 to 1:1.5 to prevent any larger particles from entering the inner secondary chamber. The rectangular cross section of the through-holes maximizes the limited available shroud space and produces a low pressure drop across the shroud.

As the flow enters the secondary chamber the outer vortex flows in a counterclockwise, down spiraling direction around the circumference of the inner chamber wall thus creating a secondary upward flowing vortex funnel. The upward flow then enters the small openings of the cyclonic cones to create both an outer centrifugal vortex of heavier vapor which is directed down into the primary central cyclonic cone and an inner smaller vortex funnel of light vapor oil which exits the top chamber plate through a single vortex finder opening.

The central cyclonic cone's (9) inner surface is heated to an outer preferred surface temperature of 425 degrees Celsius, although the temperature range may vary form 100 degrees to 500 degree Celsius or above, by an internal heat jacket filled with steam, hot oil, hot fuel, a molten liquid, infrared or induction coils, microwave, convection or other heat source. By adding a rough surface to the inner cyclonic cone surface it aids in the final capture and thermal destruction of any remaining contaminants. The high counterclockwise centrifugal force impact against the inner cone wall also aids in the final fractionation or impurities from the vaporized base oil.

When constructing the cyclonic cone system one must calculate each series of cones top diameter, bottom cone opening diameter, taper angle of the cone and surface condition to match the standard feed stream the system is being designed for.

Upon exiting the primary central cyclonic cone and third stage of the cyclonic process the feed stream vortex flows into a cylindrical atmospheric processing chamber which is permeated with a processing gas such as propane, butane or a mix of both.

Just above the bottom of the reactor are a series of electrode grid baffle plates (12) which provide electrostatic desalting and condensation of the descending heavy asphalt and residuum laden vapors to ensure that any remaining moisture is removed from the vapor stream prior to oil vapor extraction.

At the bottom of the vacuum distillation chamber just below the electrode grid baffles is a combined residuum, desalted water and particle collection pool (13) with a bottom pool cleanout door. As the desalted water and residuum drop into the pool the water floats on top of the residuum to allow for easy extraction and any sediment sinks to the very bottom. The water is extracted and forwarded to the water purification plant and the residuum is vacuum extracted and forwarded either to the fuel slurry plant for use as a coal slurry blanket, to the asphalt plant for asphalt production or to the deasphalting plant for further processing.

The atmospheric distillation feed stream first passes through a Chalcogel filtration system (18) which is constructed with a foam metal, rare earth magnetic and or electromagnetic conducting substrate to remove trace metals from the stream and for filter support and to withstand the high velocity flows. The filter system is able to capture by absorption or adsorption, separate, and contain contaminants for recycle including trace metals, minerals, volatile organics, contaminating compounds and gases such as nitrogen and oxygen. The filtration system is located in central reactor and serves as a divider between the vacuum and the atmospheric distillation reactor chambers. The filters may be electromagnetic or rare earth magnetized or ionized to assist in the capture and containment of vaporized metals and other stream poisoning materials and gas compounds.

A set of two to four or more intensifier pumps are parallel mounted and connected to each air foil fan to supply processing gas(es) and optionally processing catalysts into each of the processing chambers. The bladeless fans are relayed to one another with inner flows mushrooming processing vapors against the baffle plates and redirecting the vapor flows back into the processing cell for flow timed processing and final cut extraction.

The atmospheric distillation reactor is sub-divided into 2 and up to 6 or more successive, cylindrical walled processing chambers, but preferably into 5 chambers (21, 28, 30, 32 and 34). Upward spiraling internal chamber flows are controlled by a series of high pressure bladeless gas foil fans (25) which are gas fed through intensifier pumps (5) mounted to the outer reactor walls (11) parallel to the bottom of the chamber to be injected. The horizontally mounted fan system is able to amplify the inflowing gas stream around the entire inner circumference of the chamber walls leaving the center area in a low pressure manner similar to the center of a hurricane eye which allows the oil vapors to purify and be extracted in a continuous and rapid manner. Internal upward flow speeds are able to reach from 15 to 18 times with a Reynolds's number of 1615 and up to subsonic speeds with the intensifier pumps at peak speed. The fans operate under a laminar type gas flow with a Coanda effect method of entrainment.

At the top of each processing chamber mounted just below the next chamber's fan are multiple rows of alternating baffle plates (22) designed to slow upward flows so as to reach their exact boiling point with the targeted impurities removed and be extracted. The baffle plates may be heat generating to ensure each chamber maintains strict temperature controls. A Nautilus reactor packing system (40 top view and 45 side view) consists of a cup shaped ring mounted to the inner reactor wall and extending inwards so as to collect and transport the oil vapor cut to the extraction ports. Lighter oil vapors rise through the Nautilus ring center opening then through the next chamber's bladeless fan center into the next processing chamber. Each section repeats this process until only the LPG is left at the top of the reactor for extraction.

Temperatures in the atmospheric distillation reactor are controlled by a heat jacketed reactor wall system solely dedicated to each specific processing chamber's temperature requirements. The upper chamber baffle plates may also be heated for temperature control. Processing chamber temperatures range from ambient to cracking temperature of around 950 degree Celsius but preferably from 300 degrees and escalating downwards in each processing chamber to a final 40 degrees Celsius for the LPG processing. As the oil fractions are reacted with hydrogen a catalyst can be injected to produce high-value clean products. The operating conditions depend on the final application. For instance, temperatures could range between 350 and 390° C., and pressures between 60 and 90 bar for the production of ultra-low-sulfur diesel (<10 ppm).

Each extraction port is Nautilus “ear shaped” so as to cup and funnel the extracting vapors from the Nautilus ring into the outlet (24, 29, 31, 33, 35 & 38). The invention atmospheric distillation reactor combines various aspects of the initial process of Hydrotreating, hydro finishing and hydro desulfurization in an upstream location to expedite conversion into the finished refinery products.

A Chalcogel filtration system of the present invention provides both an initial and a transitional filtration system for a multitude of varied and mixed oil streams being processed in a combined vacuum and atmospheric distillation reactor system.

Specific processing substances which poison the processing of the multitude of types of crude and heavy oils include sulfur, mercury, cadmium, nickel, zinc, lead, cadmium, thorium, water, particles, metals and gases such as oxygen and nitrogen compounds along with an endless list of engine generated contaminants found in recycled oils.

The filter system consists of cross layered Chalcogel with a foam metal substrate to withstand high velocity flows, impacts, pressure and extreme heat and cold process flows along the ability for magnetization to capture trace metals. The substrate is packed with various filtering and absorbent materials such as ceramic membranes, aerogel or Chalcogel in which a single cubic centimeter holds 10,000 square feet of surface area. Types of applicable related materials include Aerogels, sol-gels, colloid, SEAgel, Xerogel, Nanogel and Chalcogel hydrogel solution individually or as a mixture with an advanced composite, carbon, graphite, silica, powdered metals, foam metals, magnetic rare earths and others. It also may be utilized as a catalyst, plasma spray, deposition, coating, impregnation or filler within a preformed substrate and or template filter system.

Other optional filtering materials include; glass fiber based filtering materials, absorbing carbon or graphite based composites, ion exchange resins, molten salt bath, liquid hydrogen vapor bath, Hydrophilic membrane fabric, fuel cell filtration and others.

The filter system can accommodate liquid, gas, supercritical, mist and vapor state flows. The outer layer is constructed with a larger foam metal pocket to hold more filtration element as the initial pass will be the most contaminated. A second and third layer will have progressively smaller pockets which being more compact will provide a thorough filter of any feed stream.

The filtering system consists of two or more internal reactor filters each spanning the full diameter of the reactor to ensure total filtration of process vapor streams. A central filter separates the vacuum distillation reactor from the atmospheric distillation reactor chamber or if the two reactors are constructed separately it would be located on the top of the vacuum distillation reactor and on the bottom or feed side of the atmospheric distillation reactor. A third Chalcogel filter is located at the very top of the atmospheric distillation reactor as a final LPG filter prior to exiting for further processing.

A central filter located gas ejection pipe network allows for the vacuum distillation processing gas(es) to be removed prior to the stream entering the atmospheric reactor's first processing chamber (18). The perforated pipe allows for the heavier processing gas to concentrate within the pipe system for vacuum extraction and recycle while allowing the light oil vapors to pass by and continue ascending upwards.

A Pre-Pyrolysis Reactor comprises a continuous system and method in which a slurry (fuel applies to the same system utilized in the power generation plant) composition including: crushed coal, micronized tires (coal to tire/battery mix weight ratio, 1:1; micronized battery cases, 1:2; carbon black optionally, 1:3; under atmospheric pressure in a hydrogen, propane or mix environment, 1:4) and a residuum blanket oil for prevention of spontaneous combustion and for deasphalting and further pyrolysis processing into oil and/or syngas. The syngas is then sent to the syngas line, for use as internal fuel source, and/or processing into a finished fuel gas. The pre-treated slurry is passed through several reactor heat Cells as it passes from the feed entry port with a temperature of 100-270 degrees Celsius for moisture extraction and then to a vaporizing temperature of 270 to 350 degrees Celsius. Heat is provided by infrared, microwave or convection means. The slurry/vapors are filtered by vacuum extraction and capture of carbon soot and ash forming compounds such as quartz, mullite, pyrite, carbonate, phosphates, actinides, sulfur, moisture and metals in a Chalcogel or X-Aerogel filtration system. The slurry and vapors are continuously mixed and pushed toward the reactor exit port by an Archimedes screw running lengthwise through the center of the reactor with the assist of ultrasonic cavitation aiding desulfurization at 20,000 cps. Coal fines can be utilized in the pyrolysis process with this pre-treatment system. The purified slurry vapors are then vacuum pump extracted and can be forwarded into a pyrolysis chamber.

A Zero Gravity (ZG) Reactor can be used with a specific purpose, or can have multi uses or versatilities. The ZG reactor can be used for manufacturing foam metals, for example. The ZG reactor can be for housing generators in a float zone to create electricity or can be used for fabricating components or for manufacturing foam glass. An embodiment of the present invention comprises a weightless environment reactor having atmospheric manipulation or the reactor can have no atmosphere. The present reactor can produce pressures similar to that of an autoclave, and can create a vacuum environment with negative pressure.

Metal Foams can be created under varied gravitational conditions ranging from microgravity to zero gravity, but zero gravity is preferred. In a zero gravity atmosphere, the gases being injected into the metal would diffuse evenly and completely without being squeezed out or collapsed by the weight of the base metal being processed. A zero gravity apparatus additionally has a viscosity-increasing effect making solid particles the dominant mechanism because of the illumination of the driving force for drainage from the solution. Metal foams produced in a zero gravity apparatus provide a method for creating a super alloy substrate with a controlled uniform, mixed or layered pore size, shape and dimension within a Chalcogel, Aerogel, Xerogel, Sol-gel or Nano colloid filter, being lighter and stronger than any prior art. When utilized with Nano it is possible to create a self-repairing membrane for use in microbial fuel cells, a method of bone graphing and pharmaceutical applications, and numerous other applications.

A Pre-Pyrolysis Reactor comprises a continuous system and method in which a slurry (fuel applies to the same system utilized in the power generation plant) composition including: crushed coal, micronized tires (coal to tire/battery mix weight ratio, 1:1; micronized battery cases, 1:2; carbon black optionally, 1:3; under atmospheric pressure in a hydrogen, propane or mix environment, 1:4) and a residuum blanket oil for prevention of spontaneous combustion and for deasphalting and further pyrolysis processing into oil and/or syngas. The syngas is then sent to the syngas line, for use as internal fuel source, and/or processing into a finished fuel gas. The pre-treated slurry is passed through several reactor heat Cells as it passes from the feed entry port with a temperature of 100 to 270 degrees Celsius for moisture extraction and then to a vaporizing temperature of 270 to 350 degrees Celsius. Heat is provided by infrared, microwave or convection means. The slurry/vapors are filtered by vacuum extraction and capture of carbon soot and ash forming compounds such as quartz, mullite, pyrite, carbonate, phosphates, actinides, sulfur, moisture and metals in a Chalcogel or X-Aerogel filtration system. The slurry and vapors are continuously mixed and pushed toward the reactor exit port by an Archimedes screw running lengthwise through the center of the reactor with the assist of ultrasonic cavitation aiding desulfurization at 20,000 cps. Coal fines can be utilized in the pyrolysis process with this pre-treatment system. The purified slurry vapors are then vacuum pump extracted and can be forwarded into a pyrolysis chamber.

A Zero Gravity (ZG) Reactor can be used with a specific purpose, or can have multi uses or versatilities. The ZG reactor can be used for manufacturing foam metals, for example. The ZG reactor can be for housing generators in a float zone to create electricity or can be used for fabricating components or for manufacturing foam glass. An embodiment of the present invention comprises a weightless environment reactor having atmospheric manipulation or the reactor can have no atmosphere. The present reactor can produce pressures similar to that of an autoclave, and can create a vacuum environment with negative pressure.

Metal Foams can be created under varied gravitational conditions ranging from microgravity to zero gravity, but zero gravity is preferred. In a zero gravity atmosphere, the gases being injected into the metal would diffuse evenly and completely without being squeezed out or collapsed by the weight of the base metal being processed. A zero gravity apparatus additionally has a viscosity-increasing effect making solid particles the dominant mechanism because of the illumination of the driving force for drainage from the solution. Metal foams produced in a zero gravity apparatus provide a method for creating a super alloy substrate with a controlled uniform, mixed or layered pore size, shape and dimension within a Chalcogel, Aerogel, Xerogel, Sol-gel or Nano colloid filter, being lighter and stronger than any prior art. When utilized with Nano it is possible to create a self-repairing membrane for use in microbial fuel cells, a method of bone graphing and pharmaceutical applications, and numerous other applications.

A Water Purification Reactor is shown in FIG. 32 in a cross-sectional view. Element (1) is a pyrolyic vaporization chamber adapted for central atomization and destruction of volatiles. A metals extraction chamber (2) has individual metal boiling point extraction ports while (3) is a plasma vortex vaporization zone which can operate at 10,000° to 20,000° K. Utility steam exits into main plant service feed line at (4) and (5) is a utility steam recycle intake feed line. (6) is a utility air recycle intake feed line and (7) is a heated utility air exit into plant service feed line and (8) is a high impact plasma mix zone and (9) is an impinging jet with pre-heat. (10) is an electromagnetic field to magnetize metals for enhanced extraction and (11) is an intensifier pump (4-per vortex intensification chamber, 40,000 psi each). (12) is a central combustion head cooling and inflow water repulsion while (13) is a heated controlled reactor inner wall system. (14) is a gas exit to recycle and (15) is a heat recovery intake line. (16) is a heat exit into plant redistribution service line and (17) is an Optional blade packing (in extraction chamber to assist metals extraction). (18) are four high velocity waste water colliding atomizer streams. (19) is a high temperature pyrolyic chamber which can operate at 4000° to 3000° C. (20) are Chalcogel filters for individual metal separation, capture and containment for recycle. Exit ports (21)-(50) are ports for removal of rhenium, molybdenum, platinum, vanadium, palladium, cobalt, gold, iron, nickel, chromium, copper, aluminum, gallium, silicon, tin, silver, manganese, antimony, lead, bismuth, calcium, lithium, tellurium, cadmium, Sulfur, zinc, mercury, Phosphorus, Nitrogen, and Plasma Gas Feeds respectively.

### The Matrix

One possible example embodiment of the Matrix included in the EFSMP of the present invention is shown in FIG. 77, for the sake of illustration only of a possible complex configuration and use of the plants, reactors and modules of the present invention.

What is claimed is:

1. A system comprising one or more matrix modules wherein the matrix modules are each configured to function together to achieve processing, separation and recovery, reforming, recycling and manufacturing and producing products, energy and feedstocks the system comprising modules adapted for receiving storage and routing of raw materials; modules adapted for processing; modules adapted for separation and recovery; modules adapted for reforming; and modules adapted for recycling and manufacturing and producing products, energy and saleable feedstocks.

2. A system according to claim 1, comprising an oil refinery module and one or more recycling and/or manufacturing modules wherein the matrix system is adapted to produce volume refined oil at a cost less than a prior art refinery.

3. The matrix system of claim 1, wherein the one or more modules include: a power generation module; metallurgy modules; a water generation and recycling module; feedstock vertical integration modules; and modules adapted for recycling spent oil, batteries, tired, off gases, sulfuric acid or zinc.

4. The matrix system of claim 1, wherein the system comprises a refinery module, at least one recycling module, at least one manufacturing module, at least one processing module and a power generation module.

5. The matrix system of claim 1, wherein at least one module of the matrix system comprises a super reactor system.

6. The matrix system of claim 1, which comprises at least one of a metal recovery process module, a contaminant extraction module, a mercury extraction process module, a clay/acid filtering and regeneration process, a ceramic firing process, a closed loop air and water system, a tank farm sediment collection and bottom tank processing system, a electric power generation module, or a nano plant.

7. The matrix system of claim 1, wherein the system is a closed loop vertically integrated system.

8. The matrix system of claim 1, wherein the system comprises at least one of a processing module, a separation and recovery module, a reforming module, a recycling module, and a manufacturing or production module.

9. The matrix system of claim 1, wherein the system comprises a refinery module and at least one of a receiving and routing module, a tire plant module, a pyrolysis module, a battery plant module, a sulfuric acid plant module, an oil-metal extraction module, an asphalt plant module, a steel foundry module, a least oxide module, a lead smelter module, an aluminum smelter module, a zinc smelter module, a copper smelter module, a sintering module, a precious metals recovery module, a waste water treatment module, a sour water stripper module, or a power generation module, a hydrogen plant module, an oxygen plant module, a nano plant module, a nano processing module or a tank farm module.

10. The matrix system of claim 9, wherein one or more of the modules comprise a super reactor system.

11. The matrix system according to claim 10, wherein the refinery module comprises a super reactor system.

12. A super reactor system adapted for the matrix system according to claim 1, wherein the super reactor system comprises progressive connected thermal conversion chambers which comprise one or more of an autoclave chamber for extraction, a pyrolysis chamber for extraction, a distillation chamber, a cracking and reforming chamber, an atomizing and extraction chamber, a gas and metal vaporization and extraction chamber, a sintering chamber, and a hearth chamber.

13. The super reactor system according to claim 12, wherein materials moving in the super reactor system are moved by a vortex propulsion system moving material from chamber of lower temperatures to the highest temperature chamber.

14. The super reactor system according to claim 112, wherein the super reactor system is adapted to comprise outlets along the wall of the super reactor system to allow egress of a separated stream from the materials moving through the super reactor system.

15. The super reactor system according to claim 12, wherein the super reactor system comprises multiple independent flow streams.

16. The super reactor system according to claim 12, wherein the super reactor system comprises indirect thermal contact flow sections.

17. The super reactor system according to claim 16, wherein indirect thermal contact flow sections in the super reactor system are one or more of infrared heating, microwave heating, convection heating, laser heating, sonic heating or optical heating.

18. The super reactor system according to claim 16, wherein the indirect thermal flow sections of the super reactor system comprise one or more of flash injection, steam, gas and/or fuel combustion or electric arc.

19. The super reactor system according to claim 12, wherein the super reactor system is robotically operated.

20. The super reactor system according to claim 12, wherein the super reactor system is a rotary system having tilt capability.

21. The super reactor system according to claim 12, wherein the super reactor system is bunker enclosed.

22. The super reactor system according to claim 12, wherein the super reactor system is fugitive vapor-proof and is a closed loop system.

23. The matrix system according to claim 1, wherein the system comprises one or more modules adapted for metals extraction.

24. The matrix system according to claim 23, where the metal extraction is from one or more of waste sludge, residues, mattes, slag, ore, spent filters, waste water, gasses, sweepings, coal, spent or waste oil, or soot.

25. The matrix system according to claim 1, wherein one or more modules of the system are adapted for shredding, granulation and/or micronization.

26. The matrix system according to claim 1, wherein the system is adapted for fugitive vapor extraction, capture, containment and reprocessing.

27. The matrix system according to claim 1, wherein the system is adapted for vertically integrated recyclable loped air, water and feedstock self-sufficiency.

28. The matrix system according to claim 1, wherein the system is adapted for water creation.

29. The matrix system according to claim 1, which comprises a process to extract and recover metals and to remove mercury.

30. The matrix system according to claim 1, wherein the system comprises flash atmospheric distillation for condensed lube oil fraction removal and/or extraction of residue bottoms, tars, carbon and soot.

31. The matrix system according to claim 1, wherein the system comprising finishing optionally by hydrotreating, clay acid treating, or alkaline hydroxide for rare metal extraction, extraction of halogen reacted with hydrogen, sulfur, oxygen or nitrogen.

32. The matrix system according to claim 1, wherein the system is adapted for metal extraction from spent reforming catalyst, spent isomerization chemicals and for precious metal recovery.

33. The matrix system according to claim 1, wherein the system is adapted for pretreatment and defouling of crude oil, dewatering of crude oil, fraction vacuum distillation of crude oil, atmospheric distillation of crude oil, hydrotreating of crude oil or fluid catalytic cracking of crude oil.

34. The matrix system according to claim 1, wherein the system is adapted for treatment of waste water for metals removal, phosphate removal, mercury removal, volatile organics removal or oil, sludge and residue removal.

35. The matrix system according to claim 1, wherein the system is adapted for the treatment of coal for metals removal, fly-ash and soot extraction, mercury extraction or syngas production.

36. The matrix system according to claim 1, wherein the system is adapted for the processing of spent tires and battery cases by metal belt removal, tire fiber and cord removal, battery sulfuric acid removal, soot extraction, optionally for fullerene production, fly ash removal or plastics gasification.

37. The matrix system according to claim 1, wherein the system is adapted for secondary metal recovery by precious metal removal and recovery, primary recycled metal, optionally lead and carbon steel removal and recovery, secondary melt metal removal and recovery or slag, sludge, matte, residue, sweeps, dross, process filters and skimming removal and recovery.

38. The matrix system according to claim 1, wherein the system comprises a nano reactor module wherein the nano reactor module comprises retractable robotically operated vaporizing heads located in an emissions free vaporizing chamber, an electro-magnetic field in surrounding vaporizing chamber walls for vapor deposition, a catalyst, water, carbon-gas and process-gas feedstock injection system, a freezing thawing compression separating chamber and an atmospherically controlled chemical vapor disposition mixing and processing chamber.

39. The super reactor system according to claim 12, where the super reactor system comprises a vaporization hearth adapted for metal extraction, gas extraction, carbon production or graphite production.

40. The super reactor system according to claim 12, wherein the super reactor system carries out atomizing including fuming and converting which is adapted for powdered metal production, spent clay-acid and/or sludge purification and including a slag-fuming chamber.

41. The super reactor system according to claim 12, wherein the super reactor system comprises a pyrolysis section adapted for coal liquefaction and gasification, crumb rubber to black oil production, crumb rubber to carbon black production, soot extraction to fullerene processing chamber or gas extraction (syngas to power plant).

42. The super reactor system according to claim 12, wherein the super reactor system comprises a sintering section adapted for mercury and/or sulfur removal.

43. The super reactor system according to claim 12, wherein the super reactor system comprises a pre-heat firing chamber adapted for concentrated heat recovery or flare gas recovery.

44. The nano plant module according to claim 6, wherein the nano plant module comprising a nano reactor comprising multiple reactor chambers adapted for micronizing, devilcanization and blending, a cryogenic micro shear chamber, adapted for single tube production, multi-wall production and/or nano-composites, a surround electro-magnetic field, an atmospheric vacuum controlled chamber and/or a fugitive vapor proof chamber.

45. The nano plant module according to claim 6, comprising multiple heads, multiple axis vaporizers, rotating heads, a DC-plasma arc, and/or laser ablation.

46. The nano plant module according to claim 6, wherein the nano plant module utilizes a continuous beam or pulse wave.

47. The nano plant module according to claim 6, wherein the nano plant module utilizes chemical vapor deposition as an aero spray feed or aerogel catalyst.

48. The nano plant module according to claim 6, wherein the nano plant module comprises a tunneled tornado vortex with adjustable fuel/feed gas.

49. The nano plant module according to claim 6, wherein the nano plant module comprises a V-bowl beam/wave concentrator apparatus.

50. The nano plant module according to claim 6, wherein the nano plant module comprises chambers adapted for mixing and forming and waste water purification chambers.

51. The nano plant module according to claim 50, wherein the purification chambers comprise an atomizer adapted for a waste separation process, a vaporization section adapted for metal extraction, an organic incineration and gas extraction section, and a filtration section adapted for filtration of activated charcoal, nano materials, carbon black and/or clay.

52. A power reactor module according to claim 6, comprising a section adapted for coal liquefaction and gasification and wherein fly ash and/or soot from the power module is forwarded to the nano plant module and wherein carbon black from the power module is forwarded to the water plant module for filtration and to the pyrolysis module for black oil conversion.

53. The power reactor module according to claim 6, wherein the power reactor module comprises a fuel Cell and reactor for combined power distribution.

54. The refining reactor module of claim 6, wherein the refining module comprises a distillation chamber and a reforming chamber adapted for thermal catalytic cracking and deasphalting.

55. The feedstock preparation module according to claim 6, wherein the feedstock preparation module is adapted for the preparation of coal, slag, tires or battery cases comprises one or more of a cryogenic chamber, a hammermill, a screen-separator unit, a ball mull and/or a stirred ball milling unit, a micronizer and a vacuum transport and feed system.

56. The feedstock preparation system according to claim 6, wherein the feedstock preparation module is adapted for treating crude oil and/or waste or spent oil and comprises a desalting unit, a chemical treatment unit for solvent mixing and/or solvent extraction, clay-acid filtration and/or wiped film evaporator unit and filter press residues.

57. The feedstock preparation module according to claim 6, wherein the feedstock preparation module is adapted for nano and/or graphite utilities comprises one or more units adapted for oxidation, acid treatment, annealing, ultrasonication, microfiltration, ferromagnetic separation, cutting, fractionation, mechanical milling, chromatography and/or polymerization.

58. The super reactor module according to 6, further comprising a separate or integrated filtration reactor module wherein the filtration module comprises a top chamber in a vacuum atmosphere of hydrogen and a layered system of chalcogel-based composite filters wherein the pores of the filters have pore diameters and shapes adapted to match a target contaminant

59. The super reactor module according to claim 58, wherein the pore diameters and shape allow for total micelles absorption and containment.

60. The super reactor module according to claim 58, wherein the chalcogel-based filter layers are located such that the filter with the largest pore size is on top and subsequent filers have placed in descending pore size order.

61. The super reactor module according to claim 60, wherein the chalcogel-based filters are separated by a sieved metal plated adapted for easy filter extraction and replacement.

62. The super reactor module according to claim 60, wherein the chalcogel-based filter layers are treated with at least one solvent so as to filtration by gas injection, liquid spray mist and/or prccoated substrate.

63. The matrix system according to claim 1, wherein a filter reaction module comprises a top chamber in a vacuum atmosphere of hydrogen and a layered system of chalcogel-based composite filters wherein the pores of the filters have pore diameters and shapes adapted to match a target contaminant can be utilized as part of or along with any module of the matrix system.

64. The filtration reaction module according to claim 63, wherein the target contaminants to be separated from a stream flowing through the filtration modules comprise one or more of oxygen compounds, nitrogen compounds, halogens and halogen compounds, metals, aromatics, alcohol and/or ether-bases fuel/oil additives, automotive fuels, benzene, toluene, hexane, mercaptans, and hydrocarbons.

65. The filtration reaction module according to claim 63, where the filtration material is injected and/or layered onto reactor packing in the module of the matrix.

66. A module adapted for use in the receiving, storing, dispensing and routing of materials from numerous locations to processing locations.

67. The module of claim 66, further comprising a pre-atomization or size reduction processes and apparatus configured to process larger materials for final product manufacture within matrix cells at processing locations.

68. The module of claim 66, wherein the module can be located at major consuming market locations being typically interconnected through a direct system of land, sea and air access media both nationally and internationally.

69. A tire plant method or system for processing used and wasted tires to produce useful products such as oil or grease, crumb rubbers, and fluff rayon nylon and polyester, the method and system being adapted to be integrated with other processes and methods to further process said useful products wherein the tire plant method or system comprises processes for cleaning used tires, reduction of the used tires, separation of various components of the reduced used tires and providing for processing uniformity of cleaned and reduced materials.

70. (canceled)

71. A nano plant adapted to receive raw or processed materials from other modules of an
integrated module matrix system to further process these raw or processed materials so as to provide useful nano products including single-wall and multi-wall nano tubes.

72. A pyrolysis plant module comprising a kiln, an oil separator, a magnetic separator, a condenser, buffer tanks, a precision filter, gas alkaline scrubbers and a desulphurization scrubber.

73. The pyrolysis plant module of claim 72, comprising a pyrolysis section adapted for coal liquefaction and gasification, crumb rubber to black oil production, crumb rubber to carbon black production, and soot extraction to fullerene processing chamber or gas extraction.

74. A battery plant module comprising a heavy hammer mill for rapid bulk loading and mass high impact breakage, a comprehensive separator system to sort the mix of PVC, fiberglass, Nano, carbon, ceramic, graphite and other similar internal battery construction materials from the lead, lead paste, plastics and rubber and electromagnetic sorting of the metal and non-magnetic aluminum case fragments from the spent fuel cells, wherein the separator system is equipped with a closed looped dust and vapor extraction and filtration system.

75. Sensor automated water jet battery case cutters and subsequent draining in an explosion proof work Cell equipped with a high velocity air filtration system to contain fugitive corrosive, toxic vapor emissions.

76. An asphalt plant module comprising an aggregate cold feed bin, a drying and heating process, a graduated screening including a primary screening process and a secondary screening process, a pug mill mixer, mineral filler, hot binder, and a dust collector.

77. A method and system of sulfur recovery which is adapted to use an end-product of an amine processing plant as the input product in a Claus Processing Plant, aiding in the overall extraction of sulfur from sour petroleum.

78. A sour water plant module adapted to remove hydrogen sulfide and ammonia from the water and reuses the water, hydrogen sulfide and ammonia as front-end products in other systems and processes.

79. A system and method for the regeneration of sulfuric acid and sulfur gas wherein a double absorption line mechanism operates in coordination with a waste heat boiler, catalytic converter and combustion furnace to significantly reduce resulting emissions.

80. A system and method for the production of sulfuric acid through chemical processing means designed to utilize a variety of metal inputs.

81. A novel system and method for the conversion of forms of lead into metallic lead while using outflows from other systems and methods as inflows to the system and method.

82. A novel system and method for the production of zinc, wherein all of the resulting byproducts of said intermediate processes are reused as products in other chemical and biological processes.

83. A novel system and method for treating water comprising a closed-loop, eco-friendly system adapted to recycling end-products from other systems and processes to facilitate the efficient treatment of water to yield ultra-pure water.

84. A hydrogen plant module comprising a hydrotreater, a desulfurizer, a chloride guard bed, a zinc oxide drum, a reformer furnace, a steam drum, a shift converter, a CO₂ stripper, a cold condenser separator, a hot condenser separator, a pressure swing absorber, a methanator, and a knock out drum, to perform water-gas shift technologies, advanced hydrogen separation, development of polishing filters and advanced CO₂ separations.

85. The hydrogen plant module according to claim 84, further comprising a hydro reactor with electron beam to perform desulfurization.

86. The hydrogen plant module according to claim 84, further comprising chalcogel filtration.

87. The hydrogen plant module according to claim 84, further comprising an integrated fuel cell reactor.

88. The hydrogen plant module according to claim 84, further comprising an aerogel piping and insulation system.

89. The hydrogen plant module according to claim 84, further comprising a nautilus reactor packing system.

90. An oxygen plant module for oxygen production, wherein the oxygen plant module being utilized as a standalone unit or can be integrated in an operating system which benefits from the presence of an oxygen plant module, to continuously produce oxygen to enable a self-sustaining, closed looped and emission-free processing of recycling by-products from a petroleum refining process.

91. An oxygen plant module for oxygen production, wherein the oxygen plant module is included in integrated module matrix eco-friendly system methods and processes (EFSMP).

92. The oxygen plant module according to claim 90, wherein an oxygen feed is generated to be provided to a SCR/SAR plant module, a sulfuric acid plant module, an FCC units/refinery module, a clause unit, a reforming reactor module, a nano reactor module, a steel mill module, a sintering module, a smelter module, a waste water treatment plant module, a water manufacture plant module, a power plant fuel cell, a pyrolysis reactor, a metals leaching and blast furnace, a slurry fuel plant module, an atomizer plant module, a precious metals plant module, for various applications including water production and oil refinery.

93. An integrated system for a steel foundry for recycling and producing steel by utilizing multiple temperature and atmosphere control zones.

94. A lead oxide plant module for lead oxide production, wherein the lead oxide plant module is included in integrated module matrix eco-friendly system methods and processes.

95. A lead oxide plant module comprising: a melting furnace, a Barton pot, a settling chamber, a cyclone, a bag house, and a ball mill, wherein red oxide, grey oxide, and litherage are produced to be sorted and packed.

96. The lead oxide plant module according to claim 95, further comprising a distillation reactor having a vacuum distillation chamber section for cyclonic separation.

97. The lead oxide plant module according to claim 96, further comprising chalcogel filtration.

98. The lead oxide plant module according to claim 96, further comprising an aerogel piping and insulation system.

99. The lead oxide plant module according to claim 96, further comprising an integrated fuel cell reactor.

100. An aluminum plant module for aluminum production, the aluminum plant module utilizing an EFSMP Thermal Conversion Atomization Reactor that performs at least one of atomization, electrowinning, Isothermal Melting Processes (ITM), or decoating metals using indirect-fired controlled atmosphere (IDEX) kilns.

101. The aluminum plant module according to claim 100, wherein the aluminum plant module is utilized as a standalone unit or can be integrated module matrix eco-friendly system methods and processes (EFSMP).

102. A copper plant module for copper production, the copper plant module utilizing at least one of a copper ore hydrometallurgical solvent extraction and electrowinning process or a pyrometallurgical process, or a combination thereof.

103. The copper plant module according to claim 102, wherein the copper plant module is utilized as a standalone unit or can be integrated module matrix eco-friendly system methods and processes (EFSMP).

104. A sintering plant module which can be integrated module matrix eco-friendly system methods and processes (EFSMP) in which waste products are processed to produce advanced matrix composites, rare earth magnets, advanced ceramic parts, etc.

105. The sintering plant module according to claim 104, comprising:
input stream of concentrates of bauxite ore, lead ore, iron ore, zinc ore, copper ore, which are processed by a premix tank for mixing the product prior to sintering, wherein the input stream proceeds to a green body preparation pre/sinter machining, pusher tunnel kiln, designed for processes that require precise control of the heat up rate, connective cooling, grind, surface treatment, polishing, and buffing.

106. A sulfuric acid plant module comprising one or more processes of oleum mixing, flue gas scrubbing, absorption, acid circulation, sulfuric acid storage, drying, sulfur burning, waste heat boiling, hot gas filtering, converting, super heating, sulfur melting, flue gas cooling, and filtration.

107. A precious metals recovery plant module comprising one or more processes of smelting, anode bar casting, fire assaying, cooling, reduction, electrowinning, wet electrostatic precipitation, absorption, caustic neutralization, copper precipitation, pressure cyanidation, wash filtration, carbon absorption, and high pressure autoclaving.

108. A Nano-Graphite & Fullerene plant module comprising one or more processes of xylene extraction, settling and filtration, reduction, anions solution, oxidation, chalcogel filtration, distillation, xylene evaporation, sulfuric acid treatment, water wash and dry process, thermal reactor expansion, ultra-sonication, ball mining, and high energy ultra-sonication.

109. An atomizer plant module comprising an atomizer reactor and one or more processes of atomizing, gas purification, evaporation, ultrasonic sieving, argon liquefying, wire titanium spooling, and gas jet plasma torching, filtration, compressing, vacuum pumping, and waste heat boiling.

110. A slurry fuel refinery module comprising one or more processes of ultrasonic cavitation, Venturi froth tank separation, crushing, ultrasonic wet milling, scrubbing, wet electrostatic precipitation, robotic plate dipping, extraction, metals extraction, electrowinning, plate stripping, Fischer-Tropsch converting, steel belt filtration, dewatering, colloidal jet aeration, floatation, rare earth magnetic separation, Archimedes screw mixing, and surfactant dispersing.

111. A foreign/offsite collection plant module comprising one or more processes of tire shredding, washing, drying, tire processing, tanker offloading, truck or rail unloading, magnetic separation, steel removing, rasping, waste water recycling, palletizing, power generation, and filtration.

112. A high-field flywheel motor propulsion and energy storage system propelled by a combination of MAGLEV induced levitation, a hypersonic speed mode generated by electromagnetic rail gun or coil gun activation and flux trapping High-temperature Superconducting (HTS) adapted for high-power density, high-energy and efficiency electric power generation.

113. The energy and storage system according to claim 112 comprising guidance coils affixed to inner surfaces of opposing side rails and high-strength composite matrix flywheel construction materials to ensure rotational stability when in rail gun acceleration mode.

114. The energy and storage system according to claim 112 wherein nesting of multiple two rotor variants rotating in opposite directions helps to eliminate the net angular movement of the total operating system thus allowing for the hypersonic speeds.

115. The energy and storage system according to claim 112 further comprising a third rotor assembly and modifying the inner apparatus's height, width and thickness dimensions or wherein the 2-inner rotors are rotated in the same direction and the outer rotor in the opposite direction.

116. The energy and storage system according to claim 112 wherein a dual set of composite constructed MAGLEV flywheel motors rotate in unison to provide the kinetic energy to drive horizontally attached electric power generator drum(s) nested between them.

117. The energy and storage system according to claim 112 wherein the rotating flywheel/generator drum apparatus collectively comprises a system's shaftless induction levitated rotor assembly.

118. The energy and storage system according to claim 112 wherein the electric power generator mode creates voltage according to Faraday's law as the magnetic flux of the rotating permanent magnets (PM) passes the stator coils.

119. The energy and storage system according to claim 112 wherein the stator assembly is comprised of a flux trapping high-temperature superconducting (HTS) levitated YBCO (yttrium-barium-copper oxide or other materials where Y is replaced with other Rare Earth elements such as Nd, Eu, Gd) bearing assembly with an; armored sealed outer shell housing, an energy absorbing inner liner, an Inductrack II Hallbach array of permanent magnets and the independent MAGLEV stator Guideway rails.

120. The energy and storage system according to claim 112 wherein each of the independent electrically conductive rails has an internal vacuum-vented duct spanning the entire radius of the rail being designed to capture the arcing sparks created by the rail gun sabot and the highly ionized trailing plasma safely channeling them out of the reactor to an ancillary vortex tube reactor feed inlet.

121. The energy and storage system according to claim 112 wherein the inner rail wall includes a grooved Guideway for the winged sabot to complete the circuit and drive the flywheels to a hypersonic speed for maximum power output.

122. The energy and storage system according to claim 112 wherein the guideway channel or “barrel” may include intermittent injection ports for injection into the channel gap of a plasma, electrically conductive liquid metal of or other armature/guiderail support friction reduction solid, liquid, gas or supercritical material.

123. The energy and storage system according to claim 112 wherein the injection can be timed to be near the rear of the armature as it travels in the forward rotational direction.

124. The energy and storage system according to claim 112 wherein the flywheel connected drum apparatus is mated to the armored outer shell's inner energy absorbing liner being separated only by a uniform but adjustable levitation gap.

125. The energy and storage system according to claim 112 wherein an Inductrack of permanent magnets is affixed to the inner liner over the drum apparatus in a manner to allow centrifugal forced heat to flow between the magnets into the liner which then directs the flow into an internally mounted Cryocooler for recycle thereby forming a looped cooling system.

126. The energy and storage system according to claim 112 wherein the external cryogenic system can further comprise an advanced type of vortex tube with a hypersonic scramjet feed of high pressure air created by a pulse detonation compression apparatus.

127. The energy and storage system according to claim 112 wherein the nested rotor drums are levitated with flux trapping high-temperature superconducting bearings and the flywheels are levitated by MAGLEV Inductrack induction and accelerated to hypersonic speed by rail gun pulsed inductive and resistive primary rail commutation.

128. The energy and storage system according to claim 112 wherein an open-core flywheel architecture enables both high energy flux-field density and flywheel power storage ability to optimize output demand and store power between low and peak hours.

129. The energy and storage system according to claim 112 wherein the system comprises a rotor drum between each set of MAGLEV flywheels to which subsequent independently rotating sets are nested within to form a multilayered space saving high-output variable speed generator.

130. The energy and storage system according to claim 112 wherein to meet the peak power demands of a large grid system a type of railgun accelerator drives the flywheels into a hypersonic speed.

131. The energy and storage system according to claim 112 wherein the entire generator apparatus is housed in an outer armored housing with an inner energy absorbing containment liner sealed to contain a cryogenic vacuum atmosphere (cryostat or envelope) with both an external and internal cryogenic system of cooling.
